(19) United States
(12) Patent Application Publication
(10) Pub. No.: US 2026/0219757 A1
(43) Pub. Date: Jul. 30, 2026

(54) Devices, Methods, and Graphical User Interfaces Based on User Interface Materials

(71) Applicant: Apple Inc., Cupertino, CA (US)

(72) Inventors: James J. Owen, San Francisco, CA (US); Bruno Canales, San Francisco, CA (US); Miquel Estany Rodriguez, San Francisco, CA (US); Chanaka G. Karunamuni, San Jose, CA (US); Shubham Kedia, Santa Clara, CA (US); William M. Tyler, San Francisco, CA (US); Vincent M. Lane, San Francisco, CA (US); Seyit Yilmaz, Santa Clara, CA (US); Nathan de Vries, San Francisco, CA (US); William A. Sorrentino, III, Kentfield, CA (US); Stephen O. Lemay, Palo Alto, CA (US); Alan C. Dye, San Francisco, CA (US); Mohammed N. Jisrawi, San Jose, CA (US); Gilbert R. Ladd, San Francisco, CA (US); Aditya Krishnadevan, Santa Clar, CA (US); Shao Chi Liang, Santa Clara, CA (US)

(21) Appl. No.: 19/342,021

(22) Filed: Sep. 26, 2025

Related U.S. Application Data
(60) Provisional application No. 63/749,415, filed on Jan. 24, 2025.
(60) Provisional application No. 63/808,532, filed on May 19, 2025.
(60) Provisional application No. 63/819,935, filed on Jun. 8, 2025.

(51) Int. Cl. G06F 3/0481

(52) U.S. Cl. CPC G06F 3/0481

(57) ABSTRACT

A computer system displays a first user interface that includes a first interactive element represented by a first platter. While displaying the first user interface that includes the first interactive element represented by the first platter, the computer system detects occurrence of a first event that meets navigation criteria, and in response, displays a second user interface that includes a second interactive element different from the first interactive element, wherein the second interactive element is represented by a second platter. If the first user interface satisfies respective criteria that are based on a spatial arrangement of the first interactive element with respect to a spatial arrangement of the second interactive element, the computer system displays the first platter morphing into the second platter. If the first interactive element does not satisfy the respective criteria, the computer system displays the second platter without morphing the first platter into the second platter.

### RELATED APPLICATIONS

This application claims the benefit of and priority to U.S. Patent Application No. 63/819,935 filed on Jun. 8, 2025, U.S. Patent Application No. 63/808,532, filed on May 19, 2025, and U.S. Patent Application No. 63/749,415 filed on Jan. 24, 2025, each of which is hereby incorporated by reference in its entirety.

### TECHNICAL FIELD

This relates generally to electronic devices with touch-sensitive surfaces, including but not limited to electronic devices with touch-sensitive surfaces that display user interfaces with user interface materials.

### BACKGROUND

The use of touch-sensitive surfaces as input devices for computers and other electronic computing devices has increased significantly in recent years. Example touch-sensitive surfaces include touchpads and touch-screen displays. Such surfaces are widely used to manipulate user interfaces and objects therein on a display. Example user interface objects include digital images, video, text, icons, and control elements such as buttons and other graphics.

Example manipulations include adjusting the position and/or size of one or more user interface objects or activating buttons or opening files/applications represented by user interface objects, as well as associating metadata with one or more user interface objects or otherwise manipulating user interfaces. Example user interface objects include digital images, video, text, icons, control elements such as buttons and other graphics. A user will, in some circumstances, need to perform such manipulations on user interface objects in a file management program (e.g., Finder from Apple Inc. of Cupertino, California), an image management application (e.g., Aperture, iPhoto, Photos from Apple Inc. of Cupertino, California), a digital content (e.g., videos and music) management application (e.g., iTunes from Apple Inc. of Cupertino, California), a drawing application, a presentation application (e.g., Keynote from Apple Inc. of Cupertino, California), a word processing application (e.g., Pages from Apple Inc. of Cupertino, California), or a spreadsheet application (e.g., Numbers from Apple Inc. of Cupertino, California).

But methods for performing these manipulations are cumbersome and inefficient, and user interface feedback is confusing and insufficient. For example, using a sequence of mouse based inputs to select one or more user interface objects and perform one or more actions on the selected user interface objects is tedious and creates a significant cognitive burden on a user. The insufficiency in visual feedback leads to more user errors and confusion. In addition, these methods take longer than necessary, thereby wasting energy. This latter consideration is particularly important in battery-operated devices.

### SUMMARY

Accordingly, there is a need for electronic devices with faster, more efficient methods and interfaces including user interface materials, such as adaptive materials. Such methods and interfaces optionally complement or replace conventional methods for displaying user interfaces and providing visual feedback. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method comprises: at a computer system that is in communication with one or more input devices and one or more display generation components: detecting occurrence of an event; and in response to detecting the occurrence of the event, displaying, via the one or more display generation components, a first user interface object in a user interface, the first user interface object having a first boundary that encompasses content of the first user interface object, wherein: the content of the first user interface object includes at least a first emissive element that is spaced apart from the first boundary of the first user interface object, the first emissive element is displayed concurrently with a virtual lighting effect that gives the appearance that the first emissive element is emitting virtual light in the user interface, and displaying the first user interface object includes displaying first simulated light interaction between the first emissive element and the first boundary of the first user interface object, resulting in a first altered appearance of the first boundary of the first user interface object.

In accordance with some embodiments, a method comprises: at a computer system that is in communication with one or more display generation components and one or more input devices: displaying, via the one or more display generation components, in a user interface, a first user interface element comprising first content embedded in a first simulated material, wherein: the first user interface element is displayed in a first state with an appearance that is based on a first modification to other content from the user; and the first modification to other content from the user interface is based on a first set of one or more values for a first set of one or more properties while the first user interface element is in the first state; while displaying the first user interface element in the first state with the appearance that is based on the first modification to other content from the user interface, detecting, via the one or more input devices, a first user input that interacts with the first user interface element; and in response to detecting the first user input that interacts with the first user interface element via the one or more input devices, updating the first user interface element from the first state to a second state through one or more intermediate states between the first state and the second state, including: displaying, via the one or more display generation components, the first user interface element in a respective intermediate state between the first state and the second state with an appearance that is based on a respective intermediate modification to other content from the user interface, wherein the respective intermediate modification to other content from the user interface is based on a respective intermediate set of one or more values for the first set of one or more properties that is different from the first set of one or more values for the first set of one or more properties; and after displaying the first user interface element in the respective intermediate state between the first state and the second state, displaying, via the one or more display generation components, the first user interface element in the second state with an appearance that is based on a second set of one or more values for the first set of one or more properties, wherein: the second set of one or more values for the first set of one or more properties is different from the first set of one or more values for the first set of one or more properties; and the second set of one or more values for the first set of one or more properties is different from the respective intermediate set of one or more values for the first set of one or more properties.

In accordance with some embodiments, a method comprises: at a computer system in communication with one or more display generation components and one or more input devices: displaying, via the one or more display generation components, a first user interface that includes a first interactive element represented by a first platter; while displaying the first user interface that includes the first interactive element represented by the first platter, detecting occurrence of a first event that meets navigation criteria; in response to detecting, via the one or more input devices, the occurrence of the first event that meets the navigation criteria, displaying, via the one or more display generation components, a second user interface that includes a second interactive element different from the first interactive element, wherein the second interactive element is represented by a second platter, and wherein: in accordance with a determination that the first interactive element in the first user interface satisfies respective criteria that are based on a spatial arrangement of the first interactive element with respect to a spatial arrangement of the second interactive element, displaying the second interactive element represented by the second platter includes displaying the first platter morphing into the second platter; and in accordance with a determination that the first interactive element in the first user interface does not satisfy the respective criteria that are based on the spatial arrangement of the first interactive element with respect to the second interactive element in the second user interface, displaying the second interactive element represented by the second platter includes displaying the second platter without morphing the first platter into the second platter.

In accordance with some embodiments, a method comprises: at a computer system in communication with one or more display generation components and one or more input devices: displaying, via the one or more display generation components, a first user interface, including a first user interface object that corresponds to a first function of the computer system, wherein the first user interface object is visually associated with a first user interface material with a first boundary. The method includes, while displaying the first user interface including the first user interface object, detecting, via the one or more input devices, a first user input; and in response to detecting the first user input, transforming the first user interface object into a second user interface object that is visually associated with the first user interface material with a second boundary that is different from the first boundary, wherein: the second user interface object corresponds to a second function of the computer system that is different from the first function of the computer system, and, transforming the first user interface object into the second user interface object includes, while maintaining display of the first user interface material, displaying animated changes of the first user interface material in a first dimension and a second dimension, wherein: the animated changes of the first user interface material include a first rate of change in the first dimension that is different from a second rate of change in the second dimension; and the difference between the first rate of change and the second rate of change causes a ratio between the first dimension and the second dimension to change over time as the animation progresses.

In accordance with some embodiments, a method comprises: at a computer system in communication with one or more display generation components and one or more input devices: displaying, via the one or more display generation components, a first user interface, including a first user interface object, wherein the first user interface object includes a first region. The method includes, while displaying the first user interface including the first user interface object, detecting, via the one or more input devices, a first user input directed toward the first user interface object; and in response to detecting the first user input: in accordance with a determination that the first user input included movement in a first input direction, stretching the first region in a first stretching direction and compressing the first region in a first compression direction, where the first compression direction is different from the first stretching direction; and in accordance with a determination that the first user input included movement in a second input direction that is different from the first input direction, stretching the first region in a second stretching direction that is different from the first stretching direction and compressing the first region in a second compression direction, where the second compression direction is different from the second stretching direction.

In accordance with some embodiments, a method comprises: at a computer system in communication with one or more display generation components and one or more input devices: displaying, via the one or more display generation components, a first user interface. The method includes, while displaying, via the one or more display generation components, the first user interface, detecting occurrence of a first event; and in response to detecting the occurrence of the first event, displaying, via the one or more display generation components, a respective animated transition corresponding to appearance of a first user interface object in the first user interface, wherein: the first user interface object has a first edge; the first edge has an appearance based on a simulated refraction of respective content in the first user interface that is within a threshold distance of the first edge; and the respective animated transition corresponding to the appearance of the first user interface object includes gradually increasing a visual intensity of the simulated refraction for the first edge over time as the respective animated transition corresponding to the appearance of the first user interface object progresses.

In accordance with some embodiments, a method comprises: at a computer system in communication with one or more display generation components and one or more input devices: displaying, via the one or more display generation components, a first user interface, wherein the first user interface includes a first background, and an indication of current time overlaying a first region of the first background, wherein the indication of current time has an appearance that is based on an appearance of the first region of the first background. The method includes while displaying the first user interface, detecting a respective event; and in response to detecting the respective event, updating the indication of current time, including: gradually removing, from the first region, a first portion of a representation of a first time value that represents the current time. The method includes gradually displaying, via the one or more display generation components, in the first region, a first portion of a representation of a second time value different from the first time value, including in a first portion of the first region previously occupied by the first portion of the representation of the first time value, wherein: the first portion of the representation of the first time value has an appearance that is based on an appearance of the first region of the first background, and the first portion of the representation of the second time value has an appearance that is based on the appearance of the first region of the first background.

In accordance with some embodiments, a method comprises: at a computer system in communication with one or more display generation components and one or more input devices: displaying, via the one or more display generation components, a first user interface, including a background, and a first user interface object overlaying a portion of the background that has a first spatial arrangement relative to the first user interface object while the background has a first background appearance, wherein, in the first user interface: the first user interface object is displayed concurrently with a first simulated shadow that is cast on a first portion of the background that has a second spatial arrangement relative to the first user interface object, the first simulated shadow is cast on the background based on a spatial arrangement of the first user interface object relative to the background, and the first user interface object is displayed with an appearance that simulates refraction of the portion of the background, with the first background appearance, that has the second spatial arrangement relative to the first user interface object, by a first portion of the first user interface object, without simulating refraction of the first simulated shadow cast on the first portion of the background that has the second spatial arrangement relative to the first user interface object. The method includes, while displaying the first user interface including the background and the first user interface object, detecting occurrence of an event that corresponds to a change in appearance of the background from the first background appearance to a second background appearance that is different from the first background appearance; and in response to detecting the occurrence of the event that corresponds to the change in appearance of the background from the first background appearance to the second background appearance, displaying an updated first user interface, in which the first user interface object overlays a portion of the background that has the first spatial arrangement relative to the first user interface object, wherein, in the updated first user interface: the first user interface object is displayed concurrently with a second simulated shadow that is cast on a portion of the background that has the second spatial arrangement relative to the first user interface object, the second simulated shadow is cast on the background based on a spatial arrangement of the first user interface object relative to the background, and the first user interface object is displayed with an appearance that simulates refraction of the portion of the background, with the second background appearance, that has the second spatial arrangement relative to the first user interface object, by the first portion of the first user interface object, without simulating refraction of the second simulated shadow cast on the portion of the background that has the second spatial arrangement relative to the first user interface object.

In accordance with some embodiments, a method comprises: at a computer system in communication with one or more display generation components and one or more input devices: displaying, via the one or more display generation components, a first user interface, wherein displaying the first user interface includes concurrently displaying, via the one or more display generation components: first content in a first region of the first user interface; and a first set of one or more user interface elements in the first region of the first user interface, wherein: the first content occupies a subset of the first region that is not covered by the first set of one or more user interface elements; and a first content deemphasis effect is applied to at least a portion of the first content that occupies the subset of the first region, and changes an appearance of the first content in a first manner that is determined based on one or more properties of the first content; and while displaying the first user interface, detecting an event corresponding to a change in appearance of content in the first region. The method includes in response to detecting the event corresponding to the change in appearance of content in the first region, concurrently displaying, via the one or more display generation components: second content in the first region of the first user interface, and the first set of one or more user interface elements in the first region of the first user interface, wherein: the second content occupies the subset of the first region that is not covered by the first set of one or more user interface elements; a second content deemphasis effect is applied to at least a portion of the second content that occupies the subset of the first region, and changes an appearance of the second content in a second manner that is determined based on one or more properties of the second content; and the second manner in which the second content deemphasis effect changes the appearance of the second content is different from the first manner in which the first content deemphasis effect changes the appearance of the first content.

In accordance with some embodiments, a method comprises: at a computer system in communication with one or more display generation components and one or more input devices: displaying, via the one or more display generation components, a first user interface object in a first user interface, wherein the first user interface object is displayed with a first appearance based on a first set of one or more values for one or more simulated parameters of a user interface material, wherein a respective set of one or more values for the one or more simulated parameters of the user interface material determine how visual elements in the first user interface impact an appearance of the user interface material. The method includes while displaying the first user interface object with the first appearance, detecting a first event; and in response to detecting the first event, displaying, via the one or more display generation components, a second user interface object with a higher input priority than an input priority of the first user interface object, wherein: at least a portion of the first user interface object is displayed concurrently with the second user interface object, with a second appearance based on a second set of values for the one or more simulated parameters of the user interface material, the second set of values is different from the first set of values, and the second appearance based on the second set of values is different from the first appearance based on the first set of values.

In accordance with some embodiments, a method comprises: at a computer system in communication with one or more display generation components and one or more input devices: displaying, via the one or more display generation components, a first user interface of a first application, wherein the first user interface includes content and a plurality of selectable user interface objects that are separate from the content and are associated with performing operations in the first application that are independent of the content, wherein the plurality of selectable user interface objects include: a first selectable user interface object associated with performing a first operation in the first application that is independent of the content; a second selectable user interface object, different from the first selectable user interface object, associated with performing a second operation in the first application that is independent of the content and is different from the first operation; and one or more additional selectable user interface objects, different from the first selectable user interface object and the second selectable user interface object. The method includes while displaying the first user interface, including concurrently displaying the content and the plurality of selectable user interface objects, detecting, via the one or more input devices, a user input that corresponds to a request to navigate through the content; and in response to detecting the user input that corresponds to a request to navigate through the content: shifting a first portion of the content that is visible in the first user interface; and ceasing to display at least a subset of the one or more additional selectable user interface objects, while maintaining concurrent display of the first selectable user interface object and the second selectable user interface object.

In accordance with some embodiments, a method comprises: at a computer system in communication with one or more display generation components and one or more input devices: displaying, via the one or more display generation components, a first user interface, including a first user interface object, wherein: the first user interface object includes first content and a first user interface material; the first user interface object has a first boundary that corresponds to a spatial extent of the first user interface material; the first content is located within the first boundary of the first user interface object; a portion of the first content that is within a threshold distance from the first boundary has a first content appearance; and the first user interface object is displayed with a first object appearance that simulates refraction of the portion of the first content with the first content appearance by the first user interface material in an edge portion of the first user interface material. The method includes, while displaying the first user interface including the first content and the first user interface object, detecting a first event that causes a change in content appearance of the portion of the first content that is within the threshold distance from the first boundary, from the first content appearance to a second content appearance different from the first content appearance; and in response to detecting the first event that causes the change in content appearance of the portion of the first content that is within the threshold distance from the first boundary, from the first content appearance to the second content appearance, displaying, via the one or more display generation components, the first user interface object with a second object appearance that is different from the first object appearance, wherein, the second object appearance simulates refraction of the portion of the first content with the second content appearance, by the first user interface material in the edge portion of the first user interface material.

In accordance with some embodiments, a method comprises: at a computer system in communication with one or more display generation components and one or more input devices: detecting an event; and in response to detecting the event, displaying, via the one or more display generation components, a first user interface, including concurrently displaying a first user interface object overlaying a background, wherein: the first user interface object includes a first user interface material; a spatial extent of the first user interface material corresponds to a spatial extent of an underlying portion of the background that is covered by the first user interface object; and displaying the first user interface object covering the underlying portion of the background includes displaying the first user interface object with an object appearance that is based on a background appearance of the underlying portion of the background, including representing a set of background colors of the background with a corresponding set of material colors of the first user interface material using a respective mapping that preserves a directional relationship of luminance values between pairs of colors in the background for corresponding pairs of colors in the first user interface material, including: in accordance with a determination that a characteristic value of a first visual property of a respective portion of the background that includes the underlying portion of the background meets first criteria, wherein the first criteria require that the characteristic value of the first visual property is above a first threshold value in order for the first criteria to be met, displaying, via the one or more display generation components, the first user interface material with an appearance determined using a first mapping as the respective mapping between background colors of the background and material colors of the first user interface material; and in accordance with a determination that the characteristic value of the first visual property of the respective portion of the background that includes the underlying portion of the background meets second criteria, wherein the second criteria require that the characteristic value of the first visual property is below the first threshold value, in order for the second criteria to be met, displaying, via the one or more display generation components, the first user interface material with an appearance determined using a second mapping as the respective mapping between background colors of the background and material colors of the first user interface material, wherein the second mapping is different from the first mapping.

In accordance with some embodiments, a method comprises: at a computer system in communication with one or more display generation components and one or more input devices: displaying, via the one or more display generation components, a first user interface, including a first user interface object that has an associated user-interface function for the first user interface, wherein the first user interface object includes a first region. The method includes while displaying the first user interface including the first user interface object, detecting, via the one or more input devices, a first user input directed toward the first user interface object. The method includes, in response to detecting the first user input: in accordance with a determination that the first user interface object has a first set of one or more values for a respective set of one or more visual parameters, changing an appearance of the first region in a first manner; and in accordance with a determination that the first user interface object has a second set of one or more values, different from the first set of one or more values, for the respective set of one or more visual parameters, changing an appearance of the first region in a second manner that is different from the first manner.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing adaptive materials, thereby increasing the effectiveness, efficiency, and user satisfaction with such devices. Such methods and interfaces may complement or replace conventional methods for providing adaptive materials.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5AG and 6A-6AP illustrate example user interfaces that include adaptive material, in accordance with some embodiments.

FIG. 7 illustrates a flow diagram of a process for displaying a simulated emissive user interface element in accordance with some embodiments.

FIGS. 8A-8B illustrate a flow diagram of a process for adjusting one or more visual properties responsive to user interaction in accordance with some embodiments.

FIG. 9 illustrates a flow diagram of a process for transitioning between displaying a first set of controls and a second set of controls in accordance with some embodiments.

FIG. 10 illustrates a flow diagram of a process for morphing a user interface element in accordance with some embodiments.

FIG. 11 illustrates a flow diagram of a process for animating a user interface element in accordance with some embodiments.

FIG. 12 illustrates a flow diagram of a process for displaying animated transitions for numerals in accordance with some embodiments.

FIG. 13 illustrates a flow diagram of a process for updating numerals displayed with a simulated user interface appearance in accordance with some embodiments.

FIGS. 14A-14B illustrates a flow diagram of a process for using layers used to generate a simulated user interface appearance of a user interface object in accordance with some embodiments.

FIG. 15 illustrates a flow diagram of a process for applying various levels of deemphasis to user interface objects while changing underlying content in accordance with some embodiments.

FIG. 16 illustrates a flow diagram of a process for visually emphasizing user interface objects that at least partially overlay one or more other user interface objects in accordance with some embodiments.

FIG. 17 illustrates a flow diagram of a process for displaying and/or condensing sets of controls in accordance with some embodiments.

FIG. 18 illustrates a flow diagram of a process for modifying internal content that is displayed in a user interface object that is visually associated with a simulated user interface appearance in accordance with some embodiments.

FIG. 19 illustrates a flow diagram of a process for adapting visual properties based on underlying content in accordance with some embodiments.

FIG. 20 illustrates a flow diagram of a process for adjusting one or more visual properties for different types of user interface objects responsive to user interaction in accordance with some embodiments.

### DESCRIPTION OF EMBODIMENTS

Simulated materials that provide substrates for content in a user interface and/or user interface object can be utilized to provide additional visual feedback responsible to user input and indicating the changes and potential changes in the internal state of the computer system, adaptive material that responds to various external conditions and internal conditions of the computer system are beneficial to improving efficiencies of the user interfaces and reducing operation mistakes, which in turn may save power and extend battery life of battery operated computer systems.

The methods, devices, and GUIs described herein use haptic feedback to improve user interface interactions in multiple ways.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

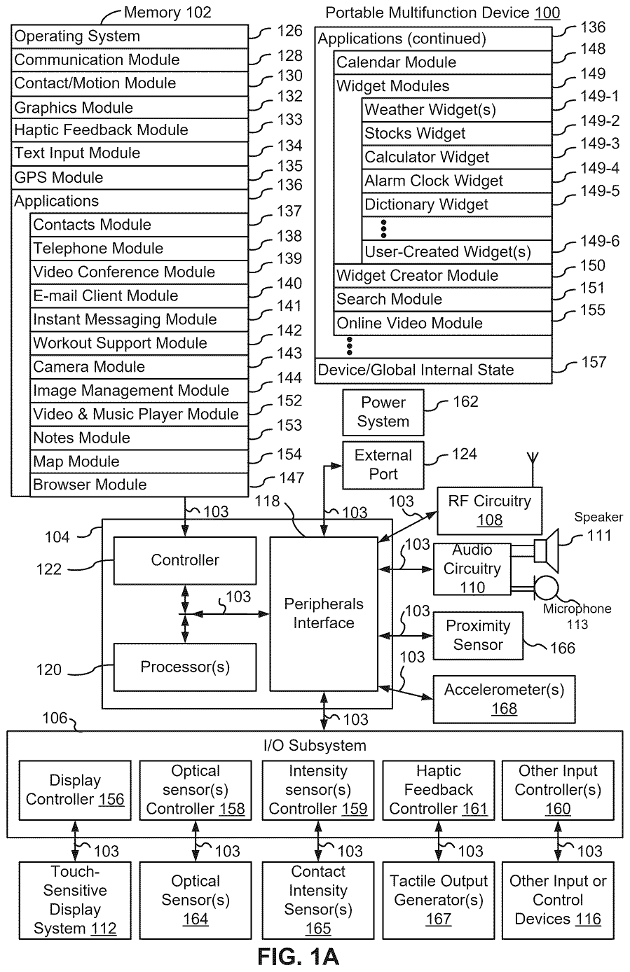

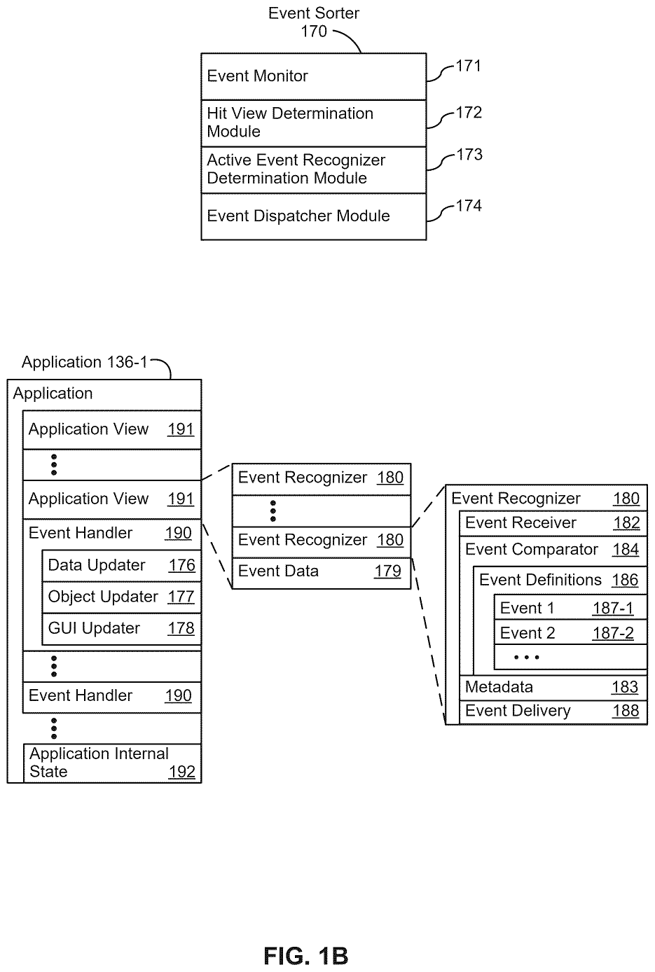

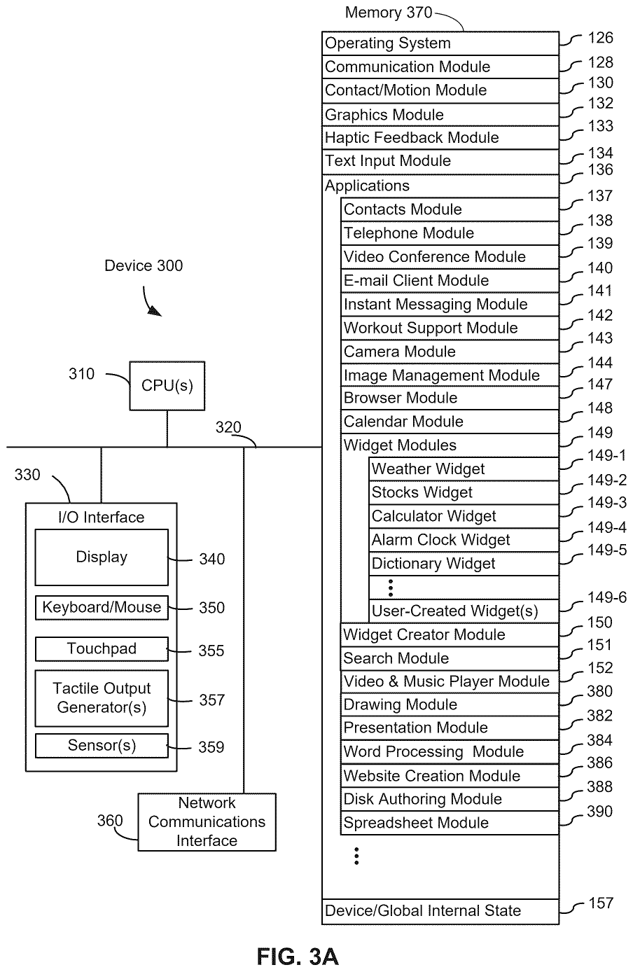

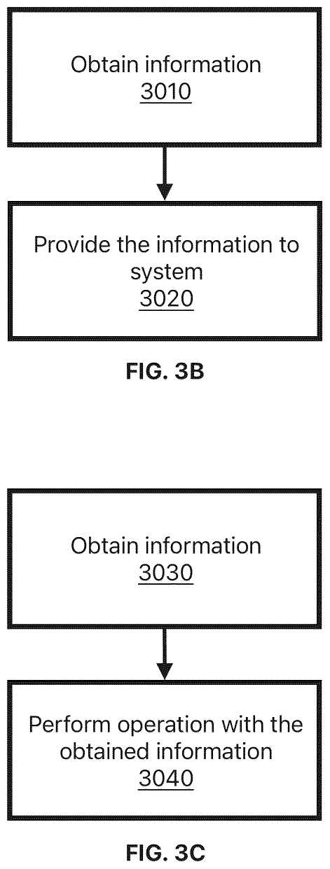

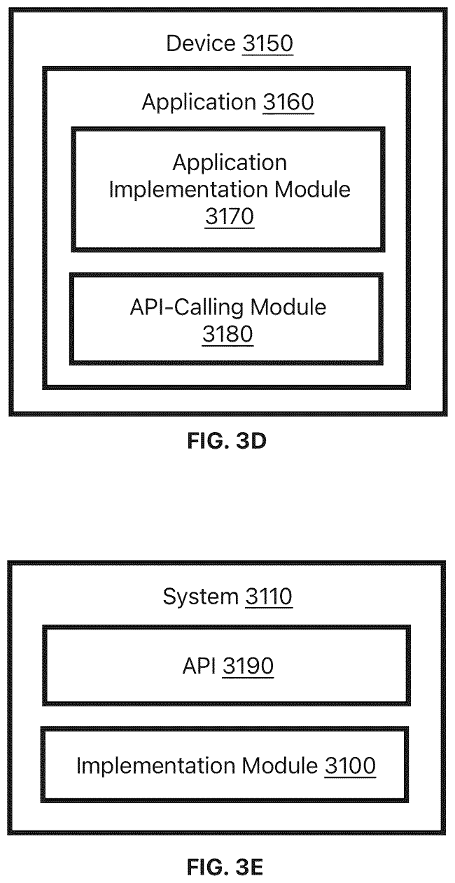

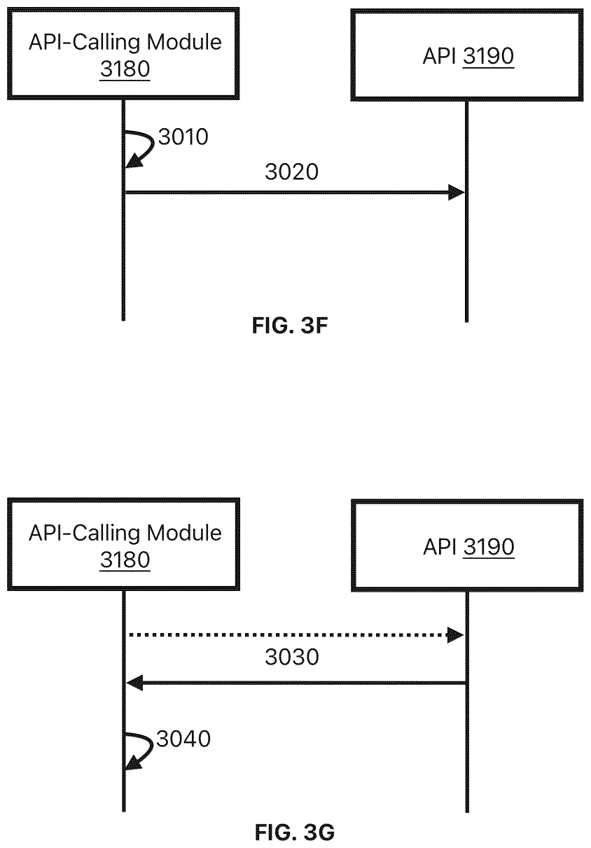

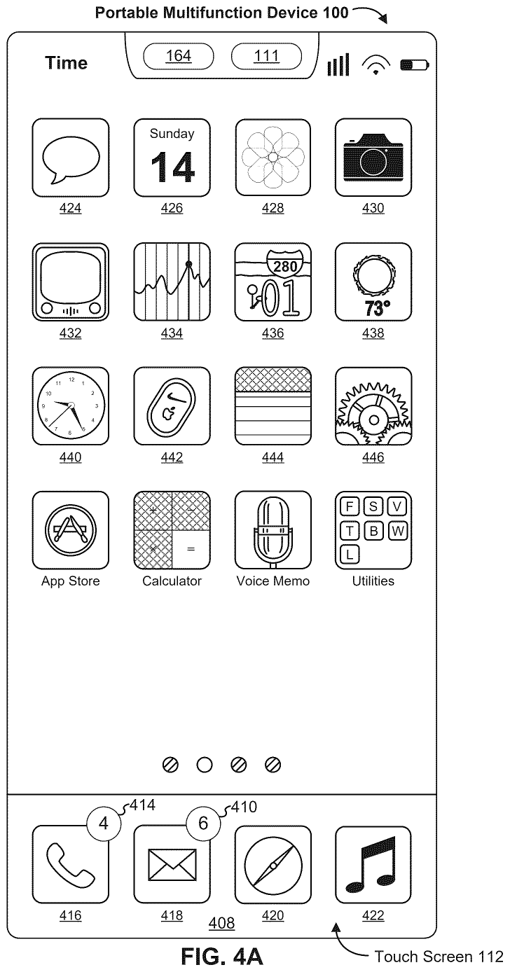

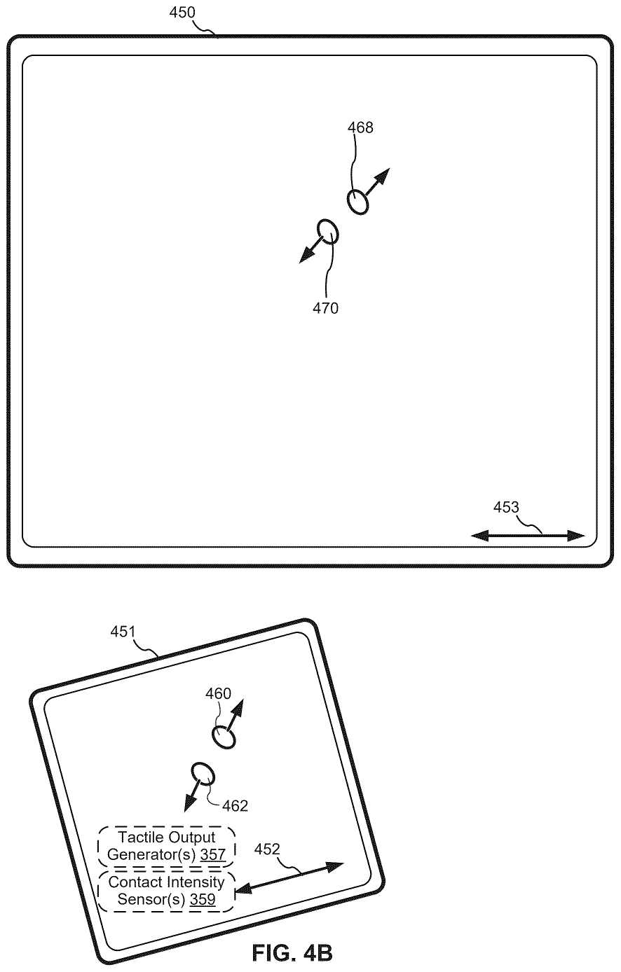

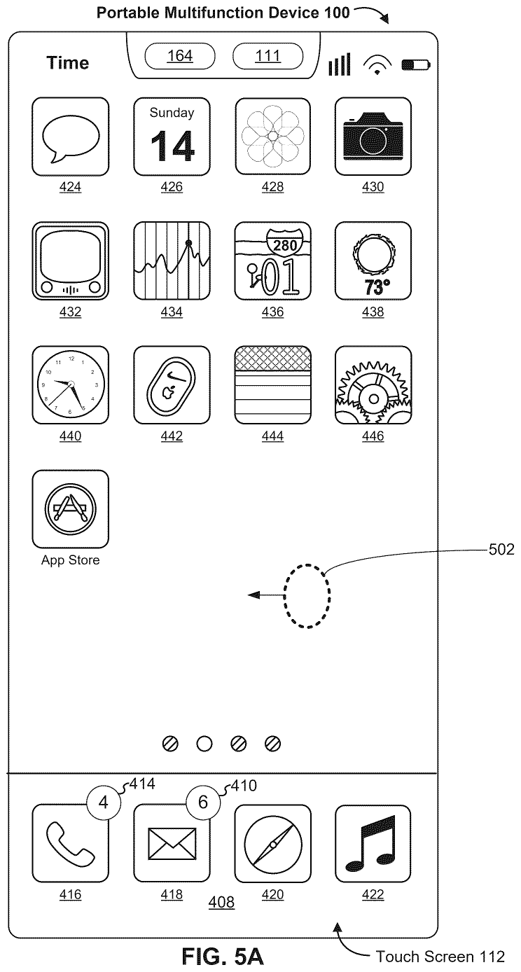

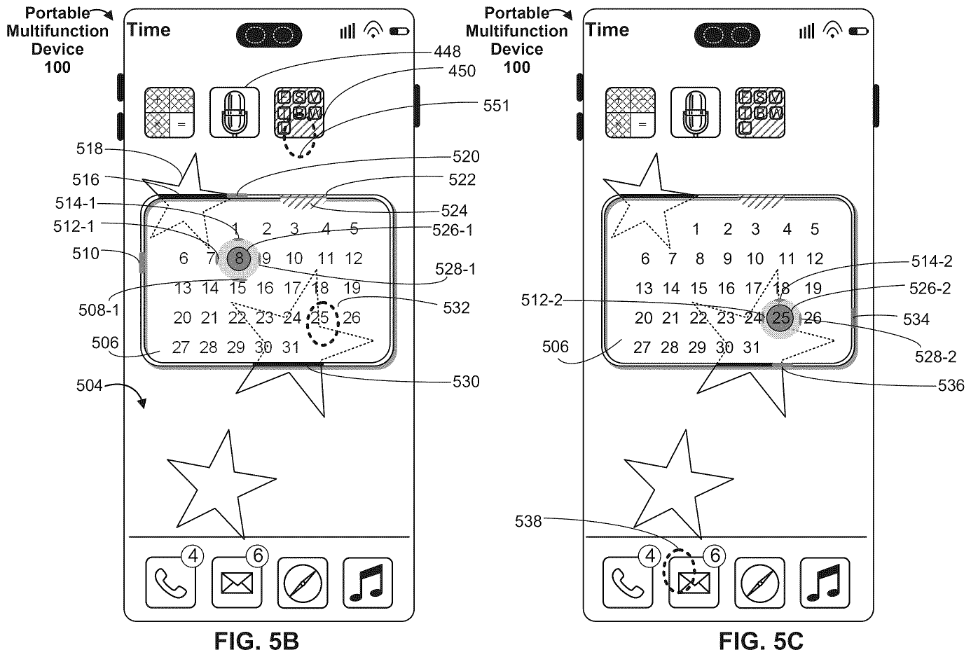

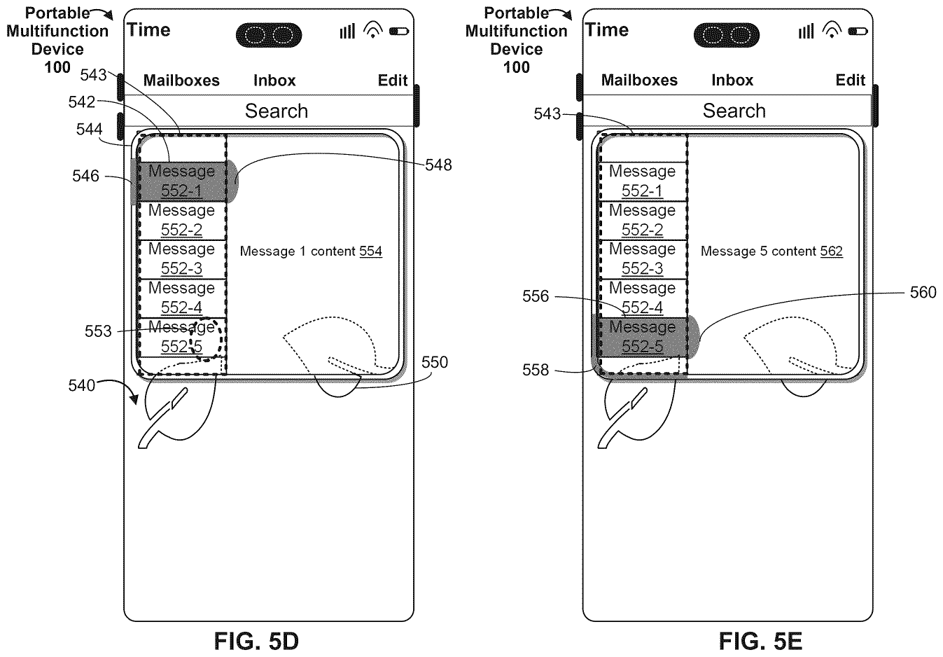

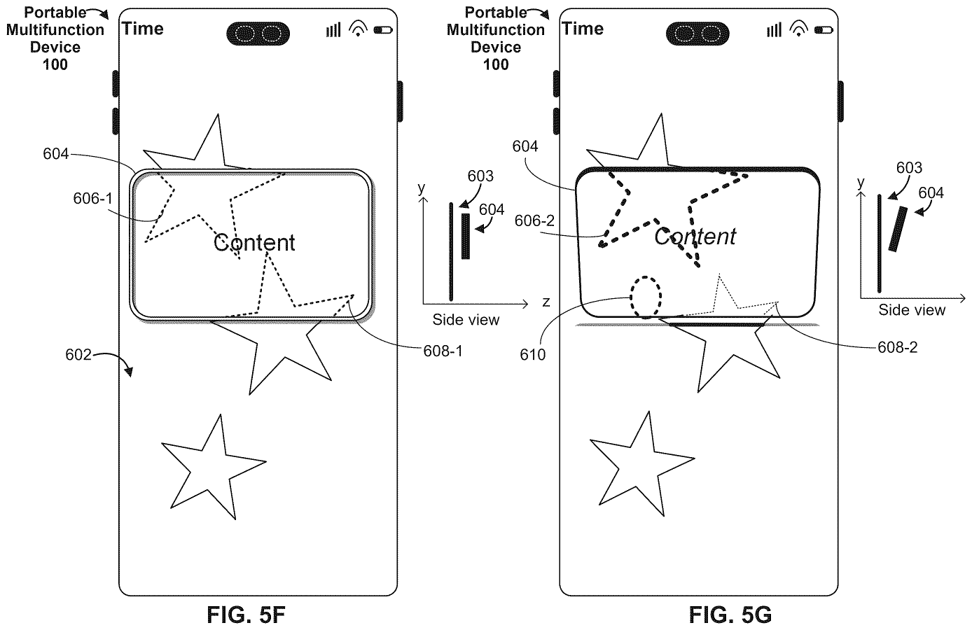

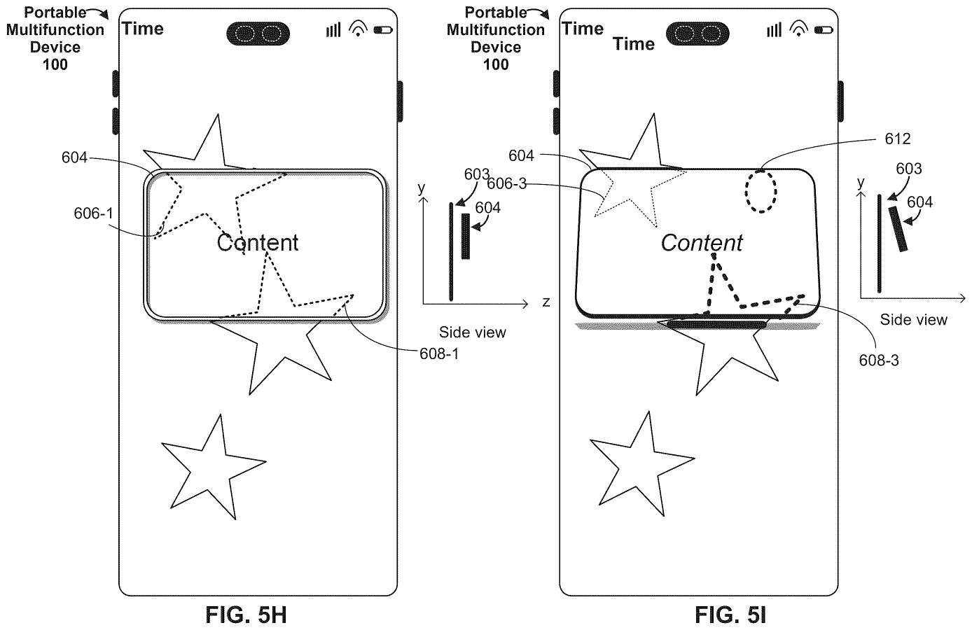

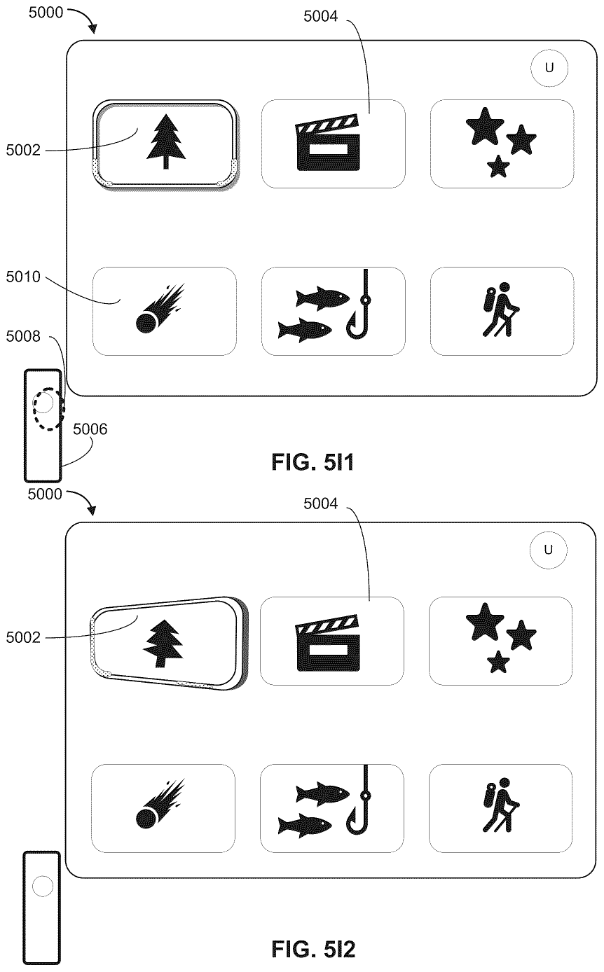

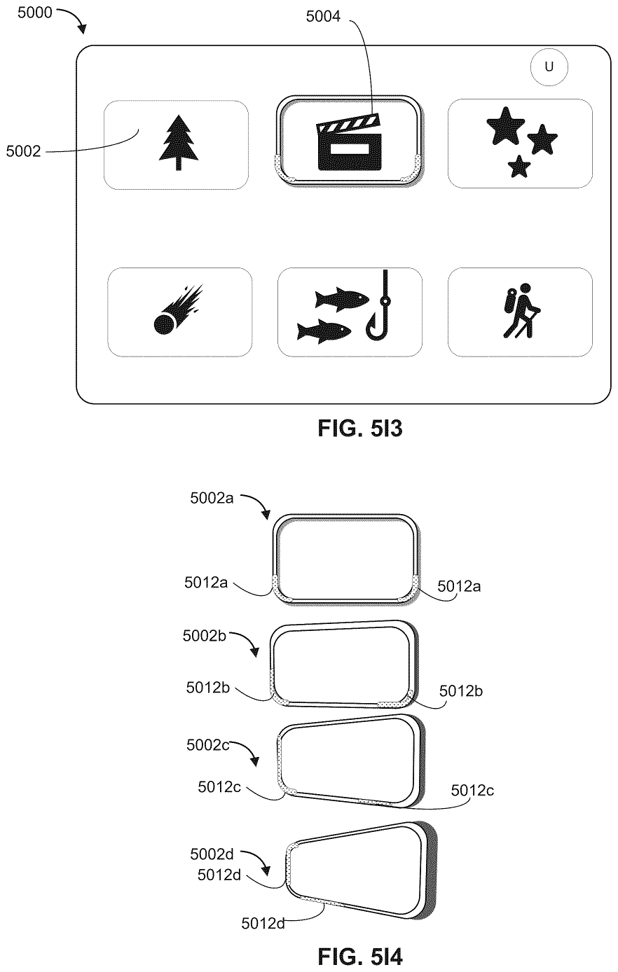

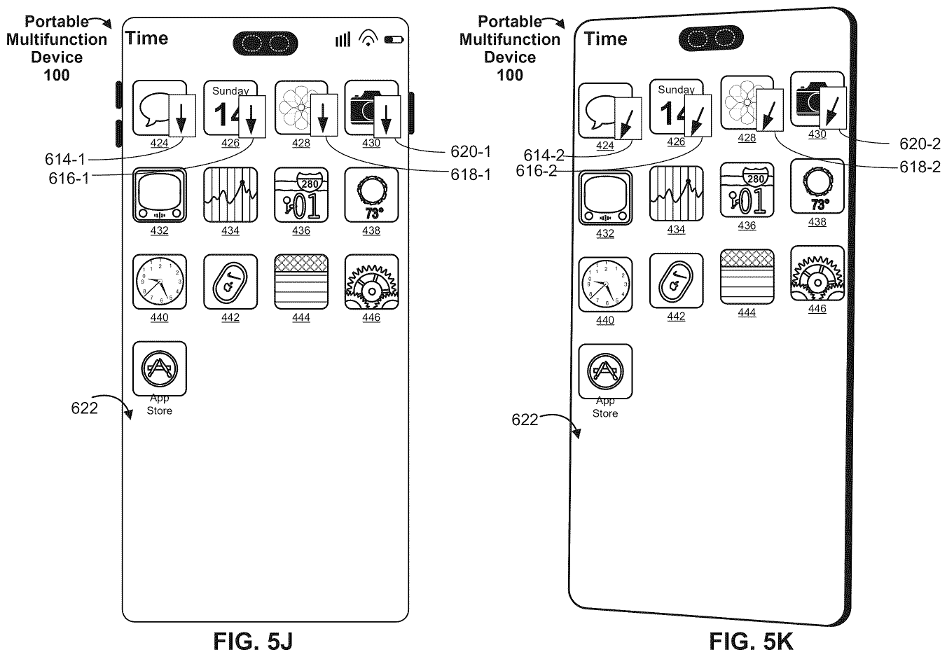

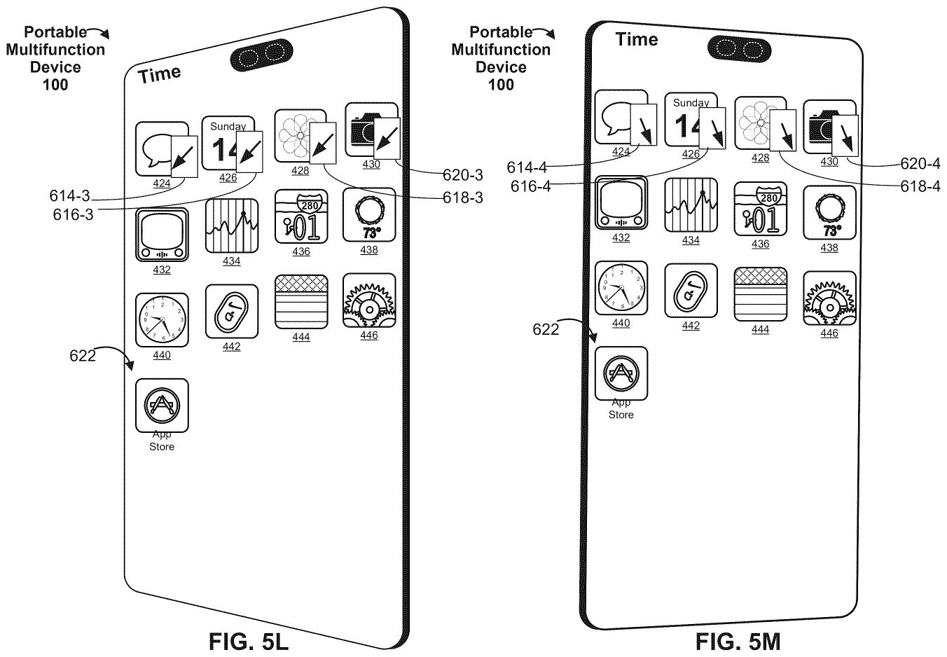

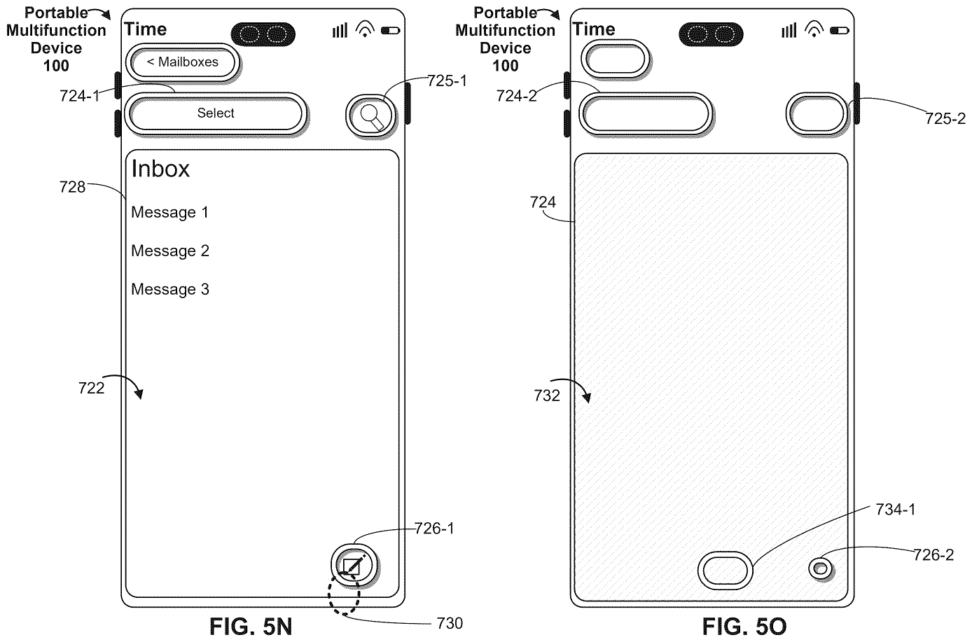

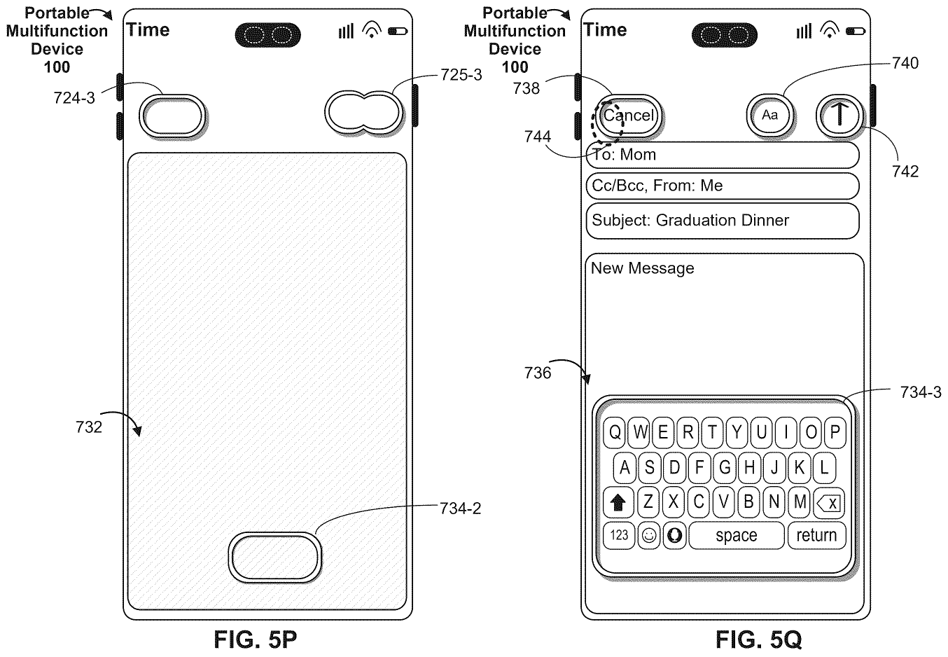

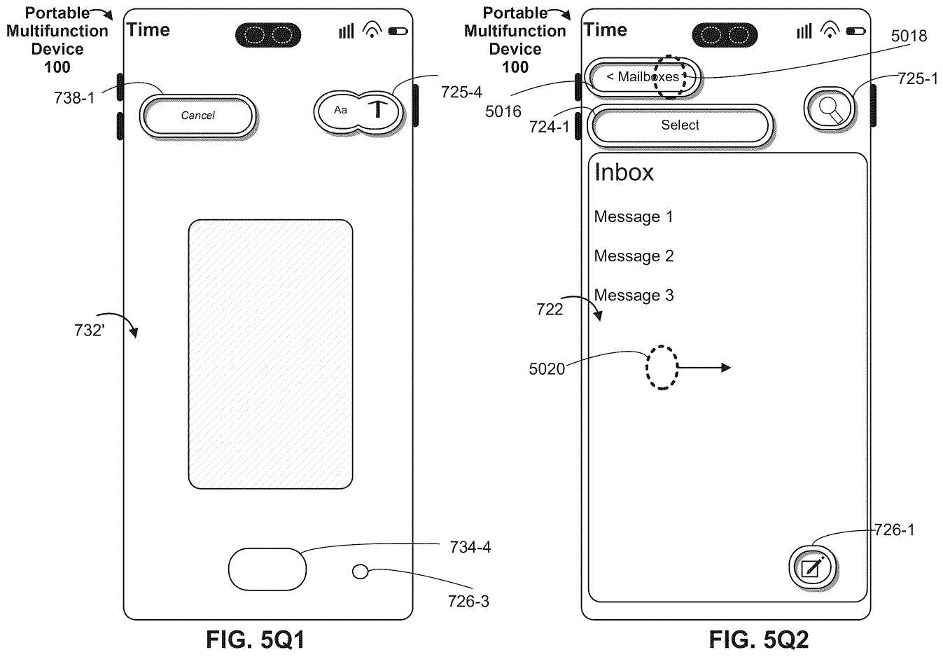

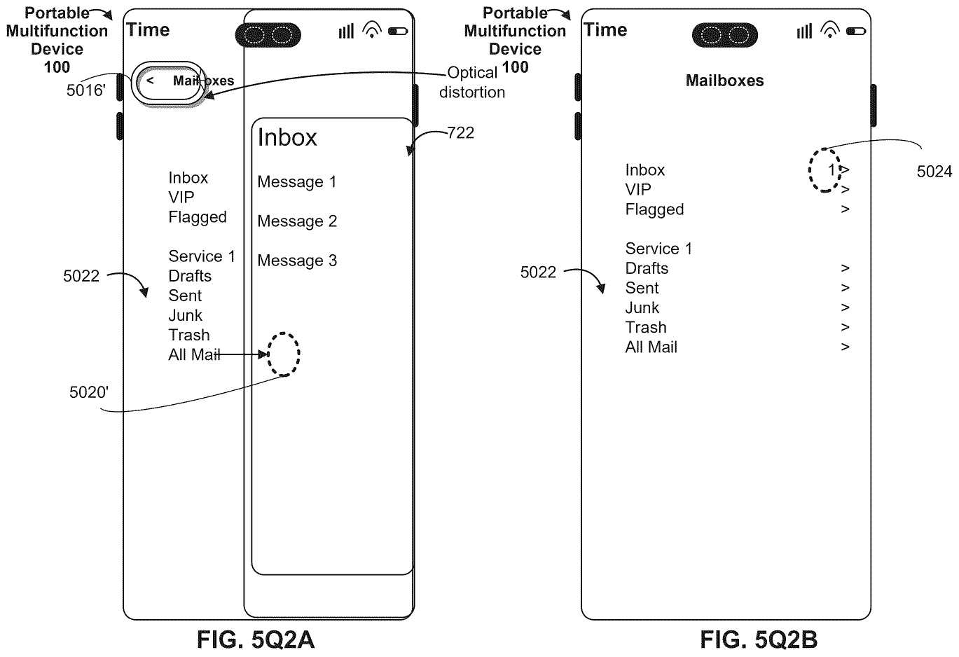

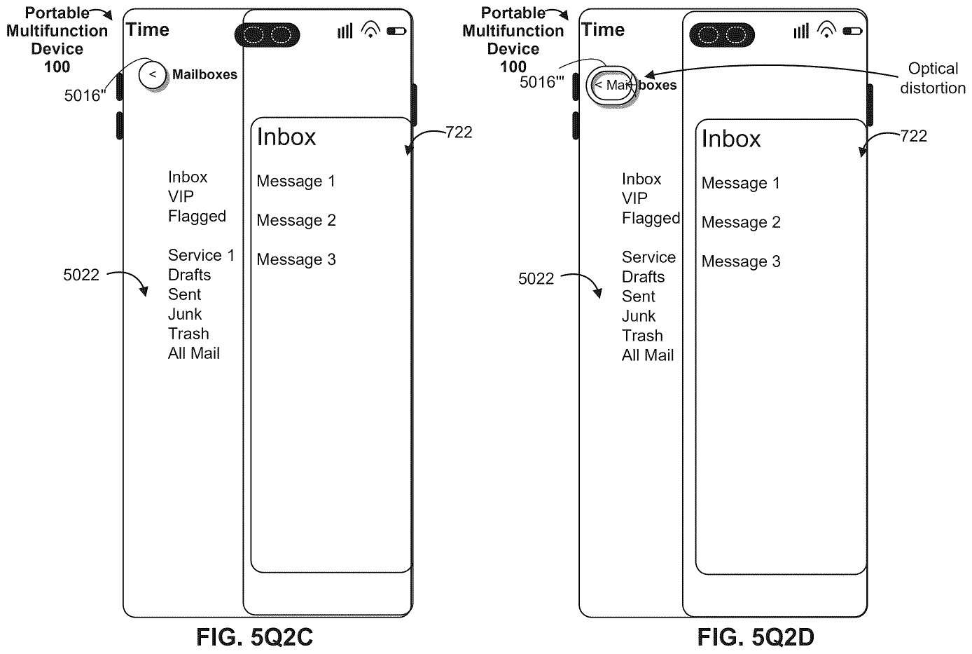

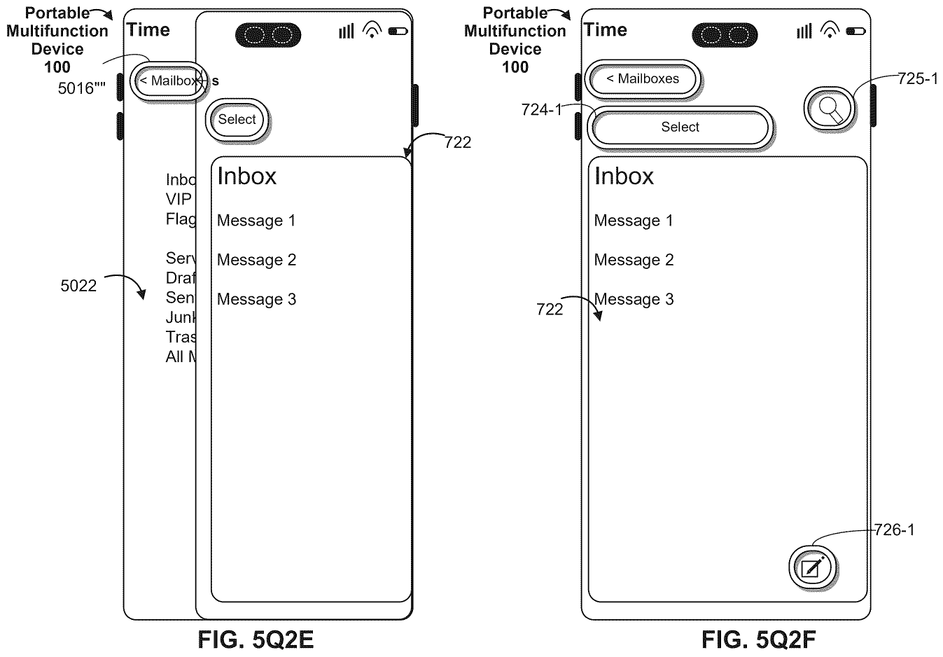

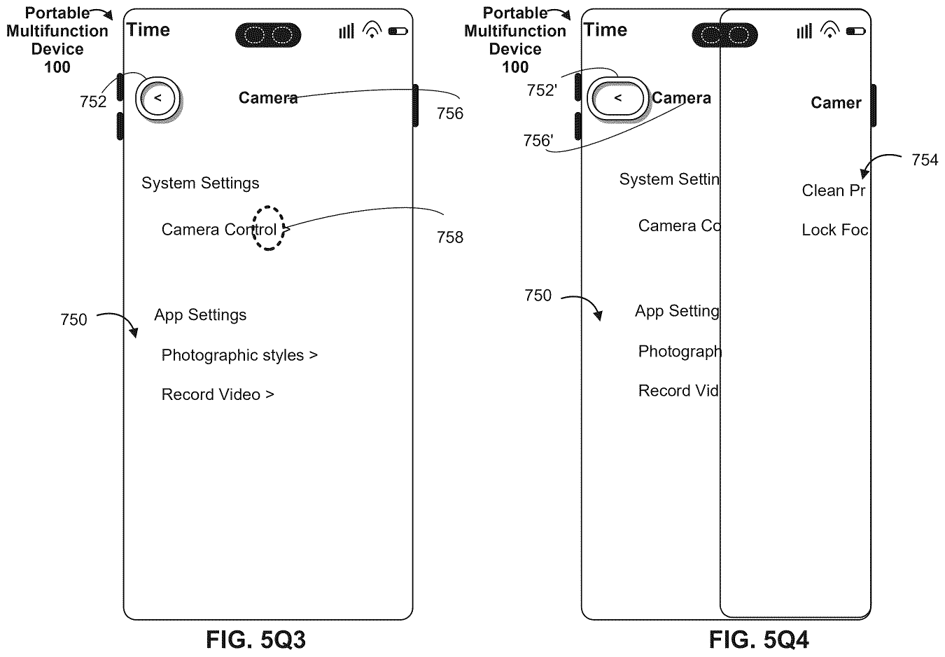

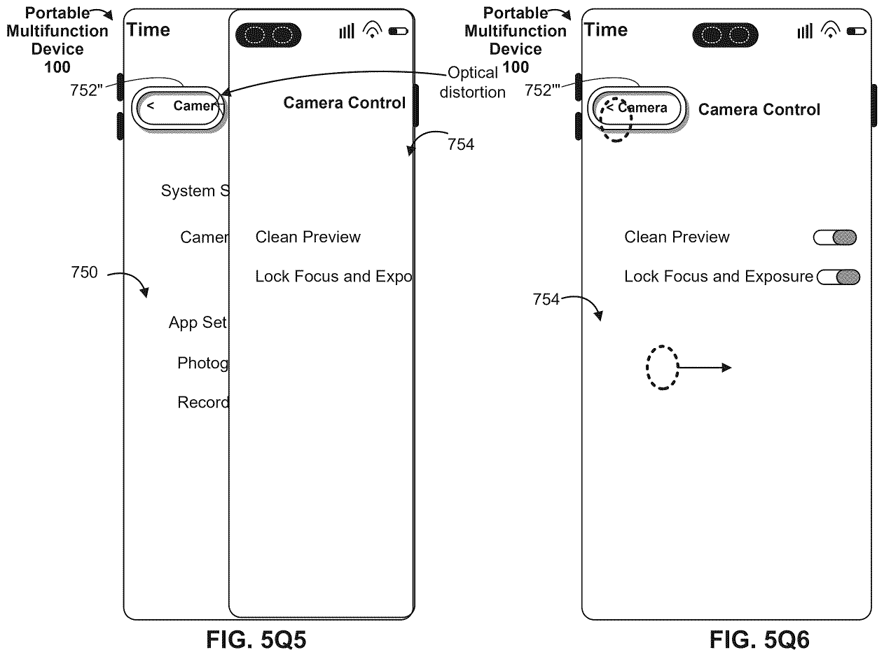

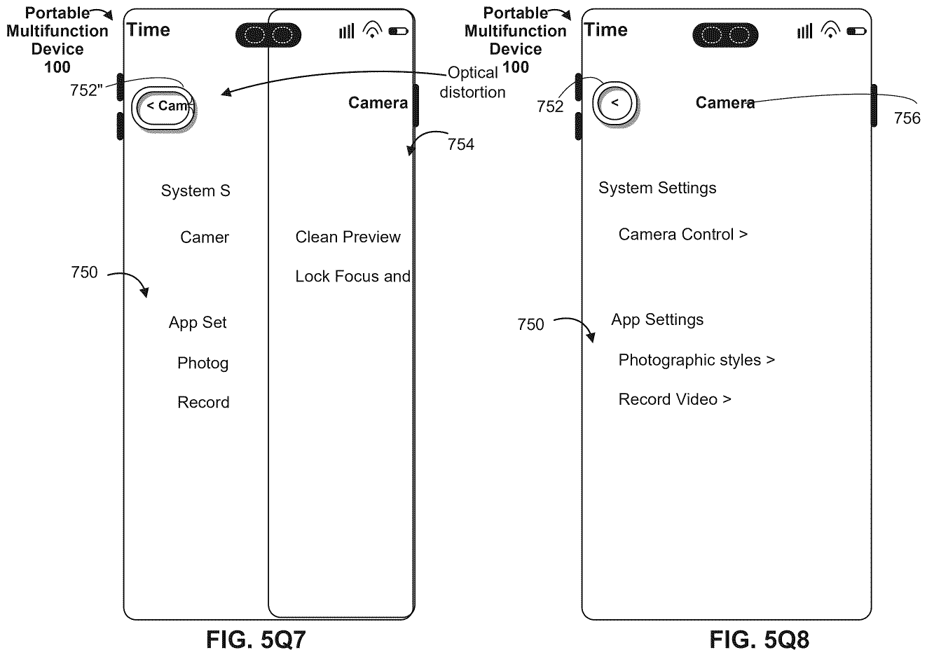

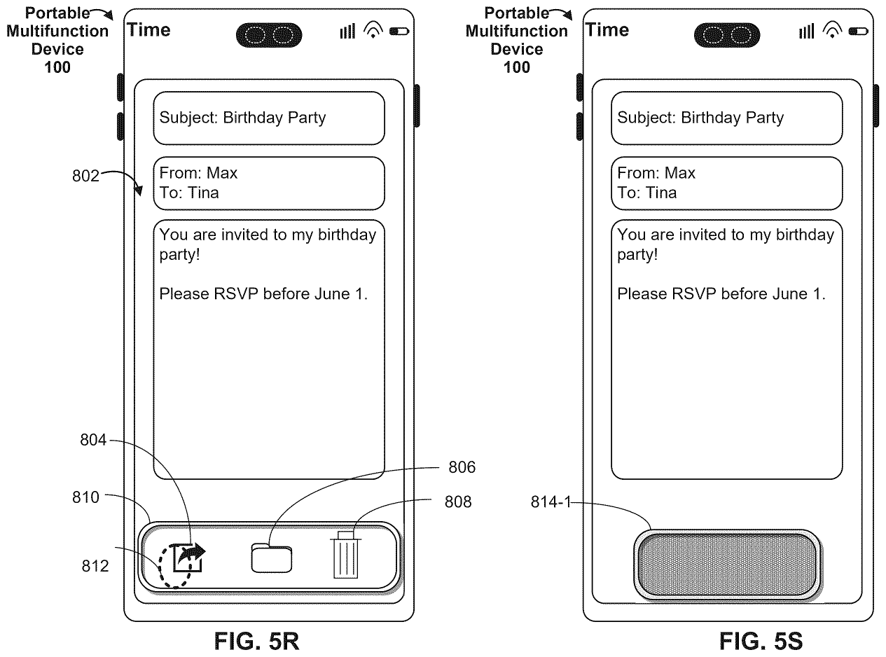

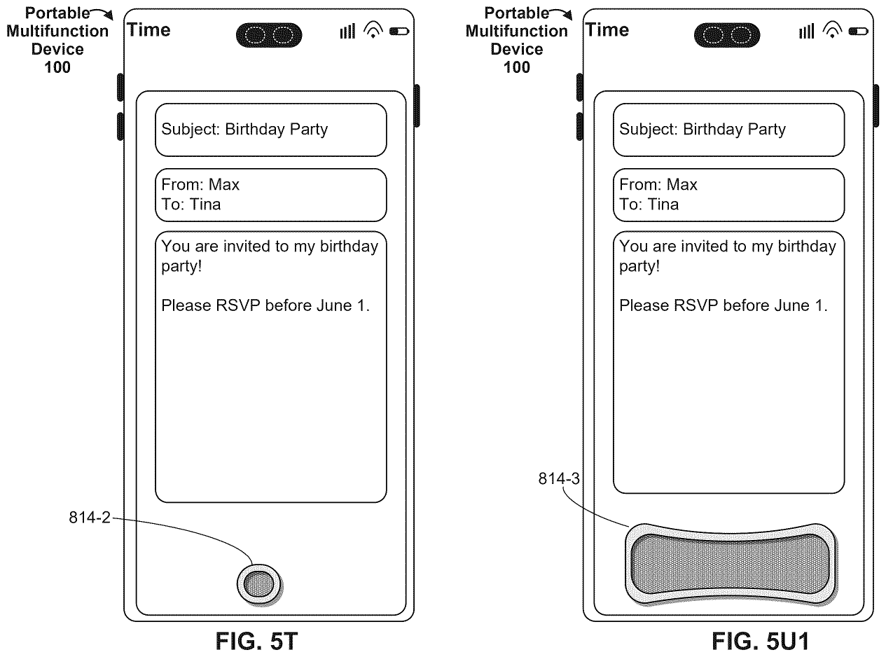

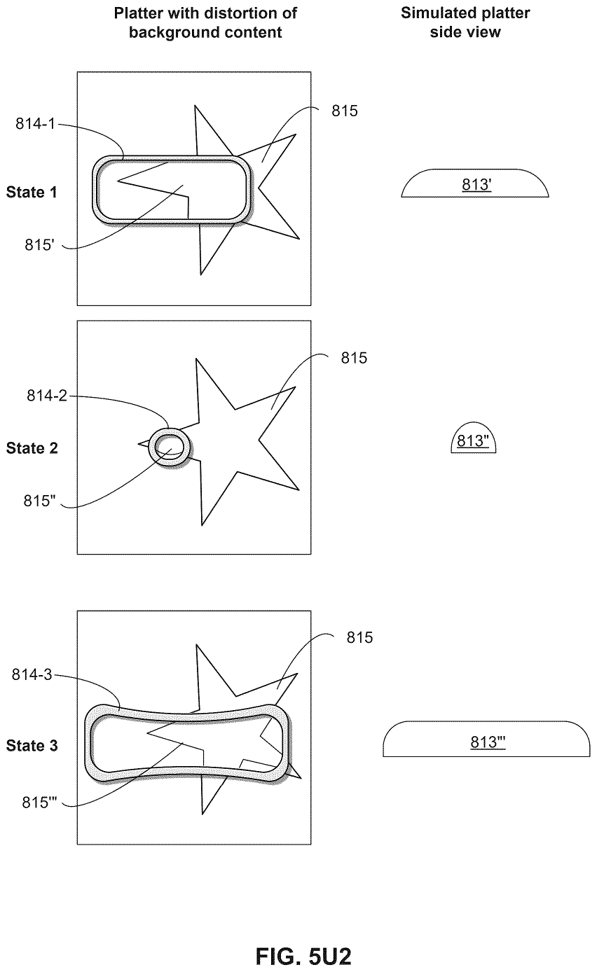

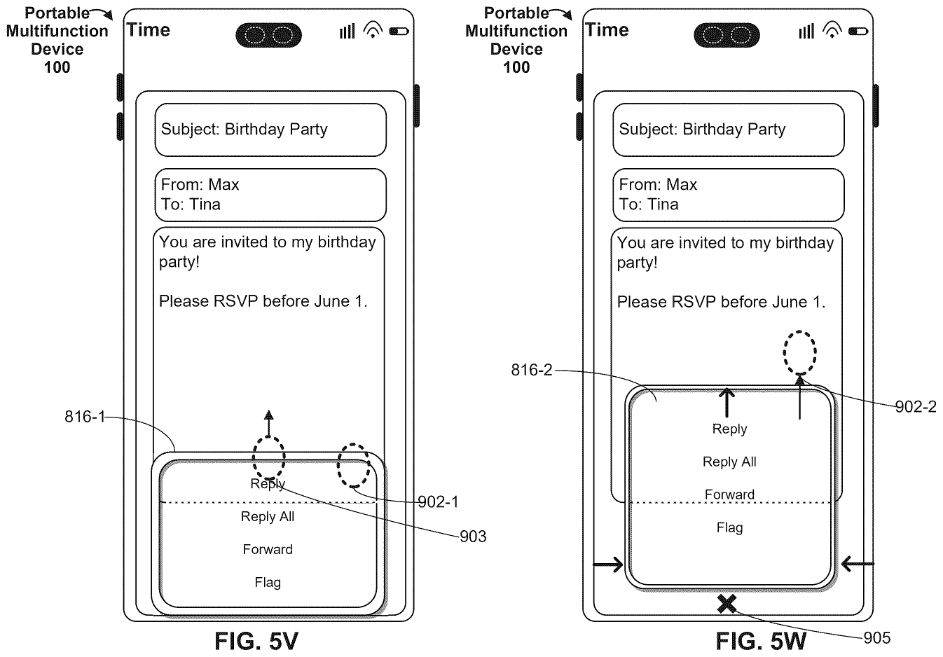

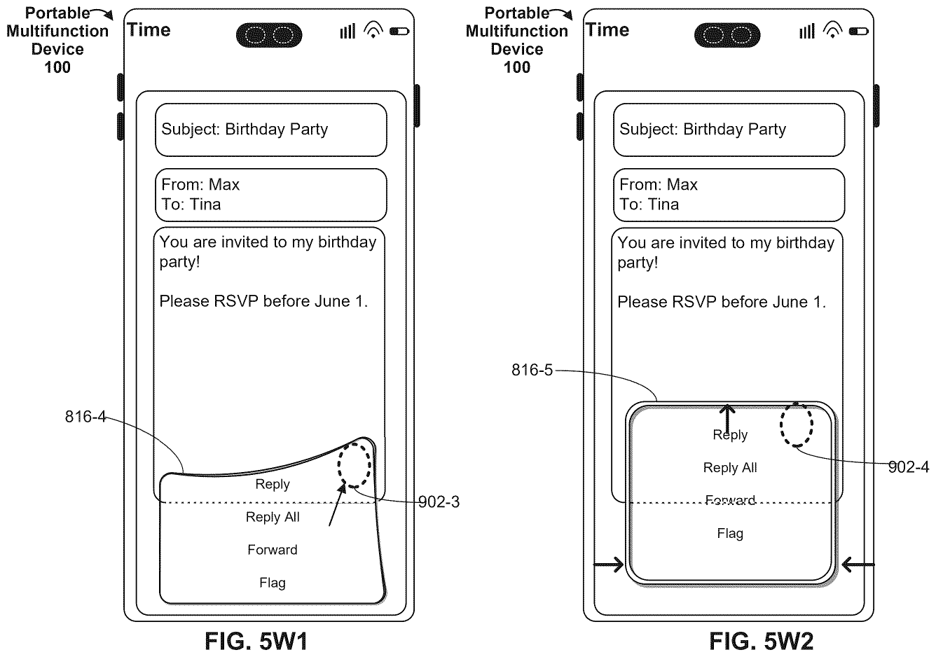

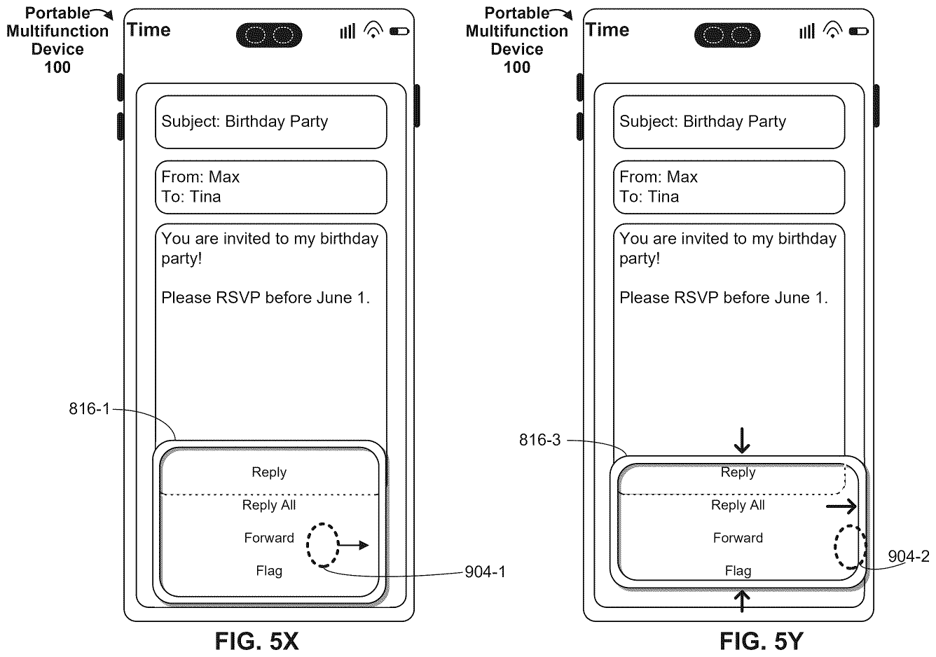

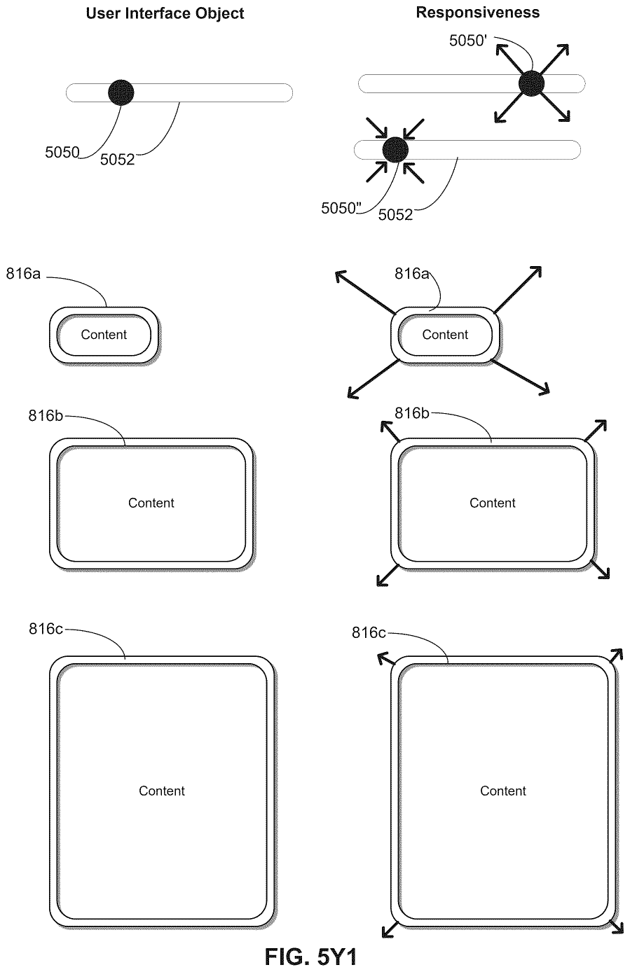

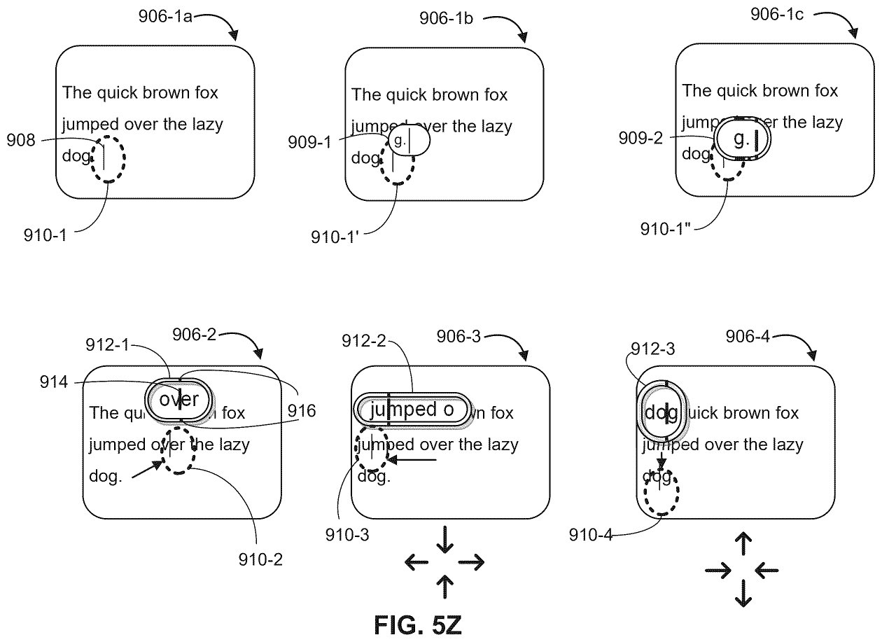

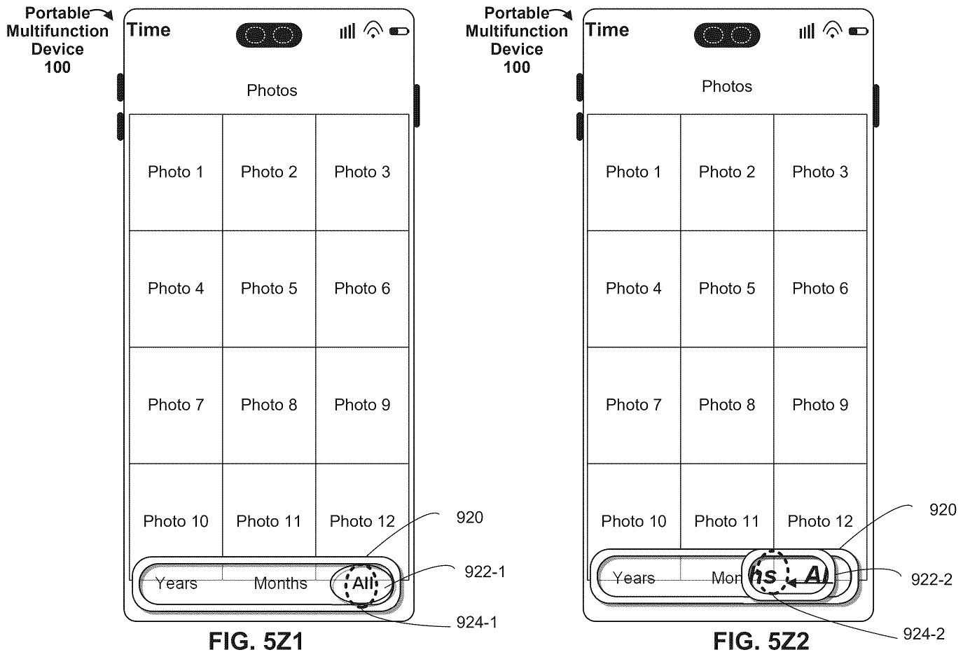

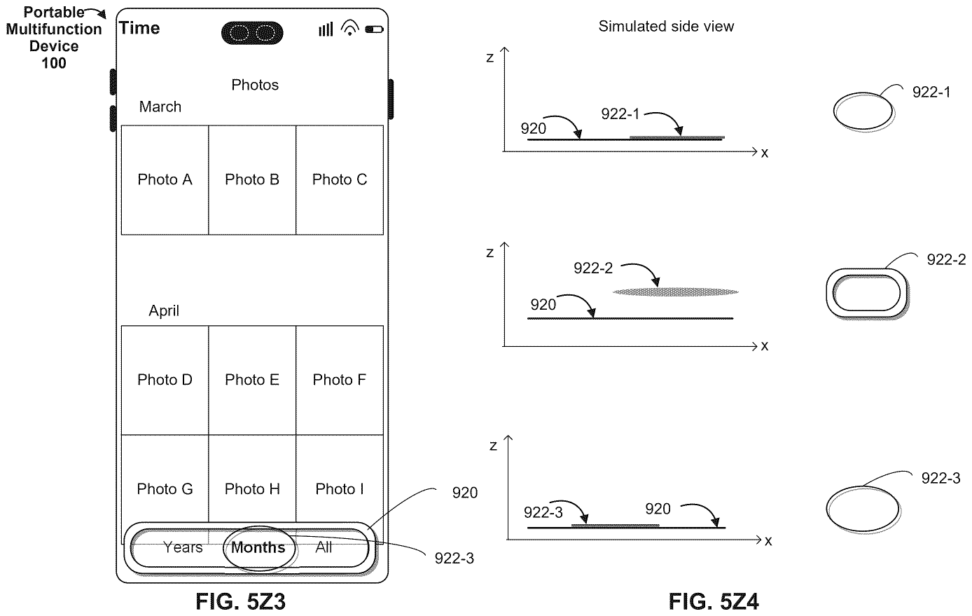

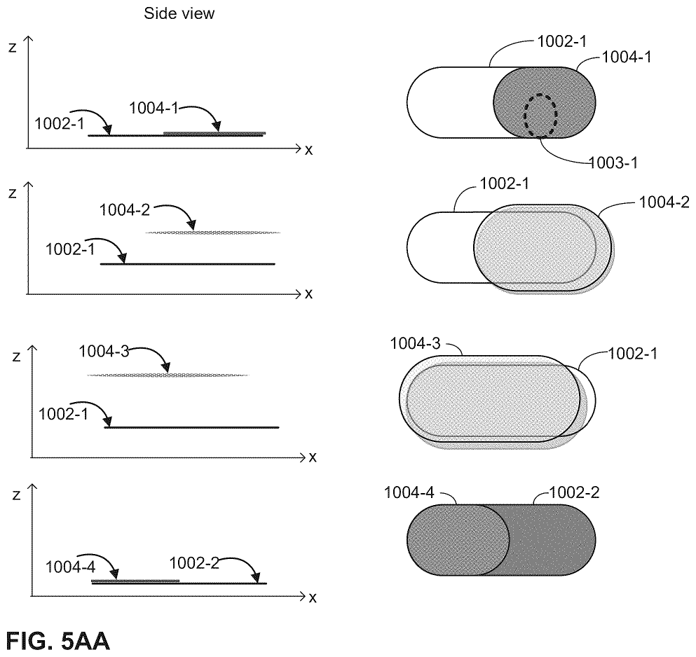

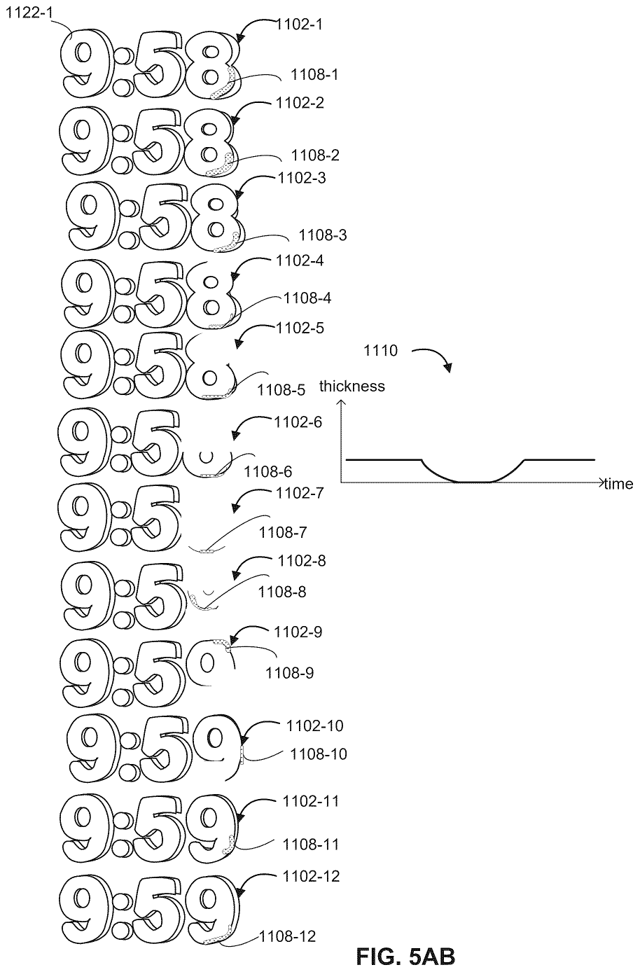

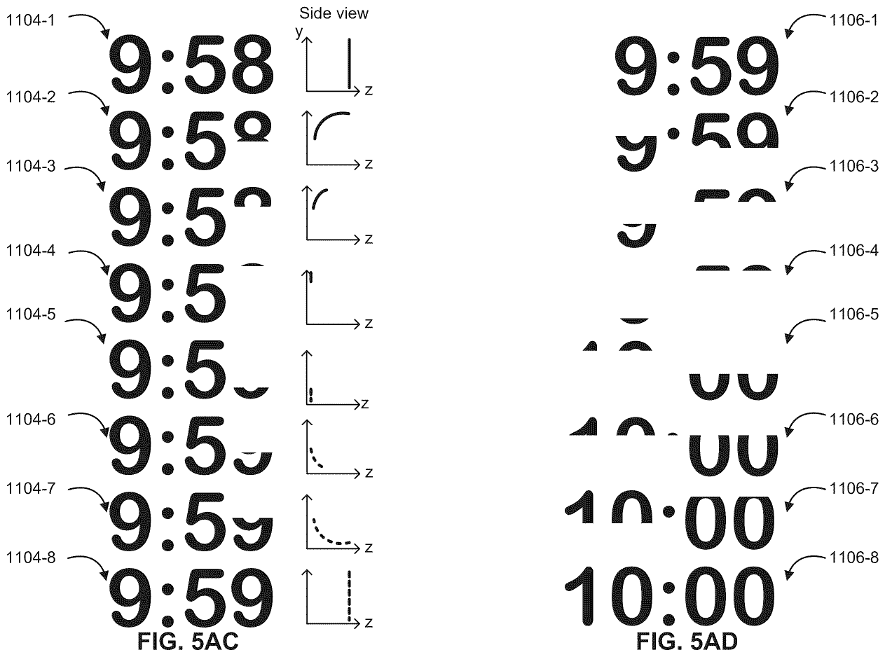

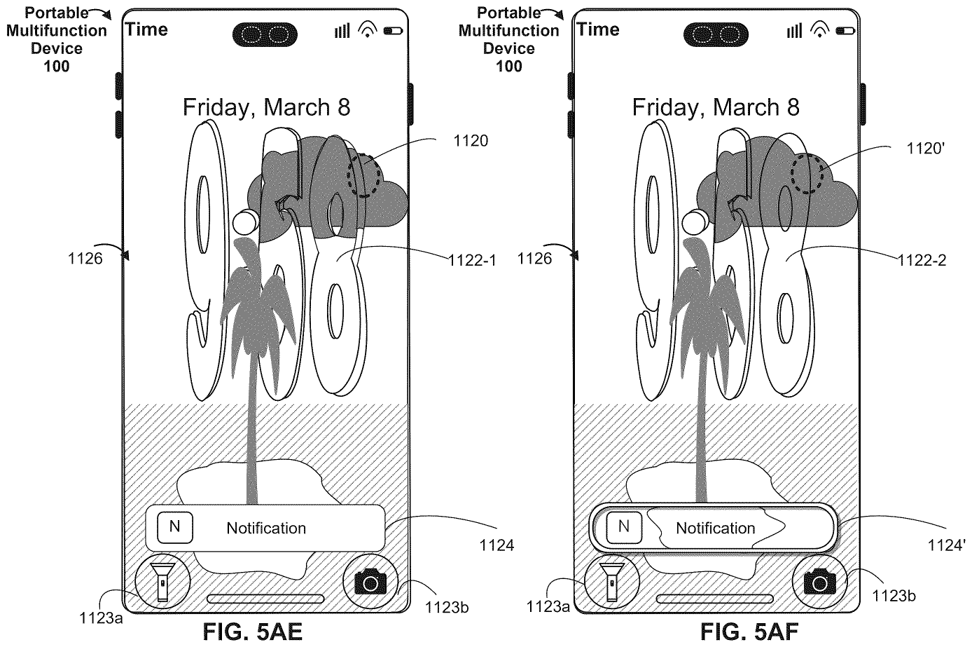

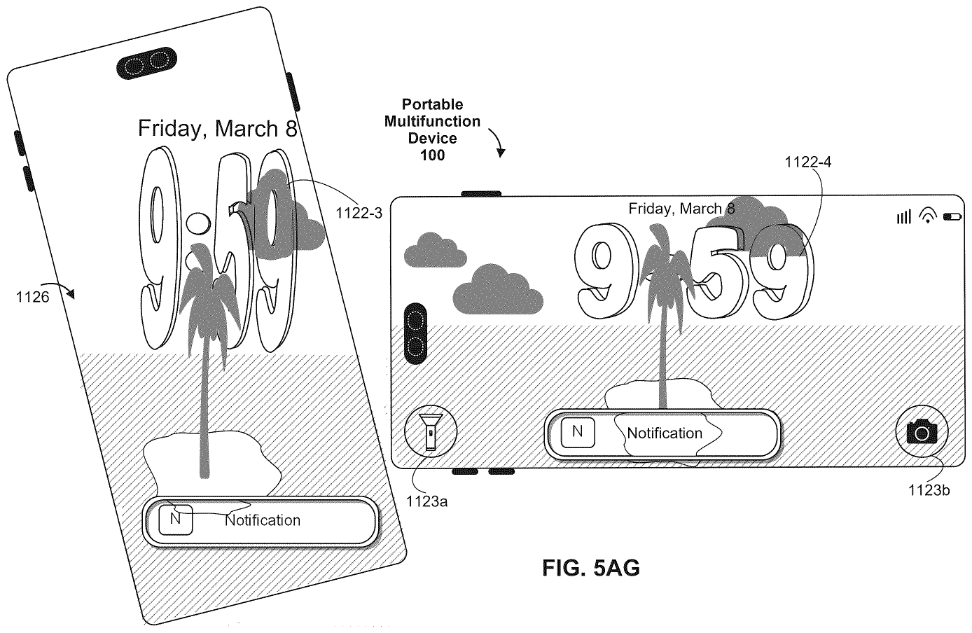

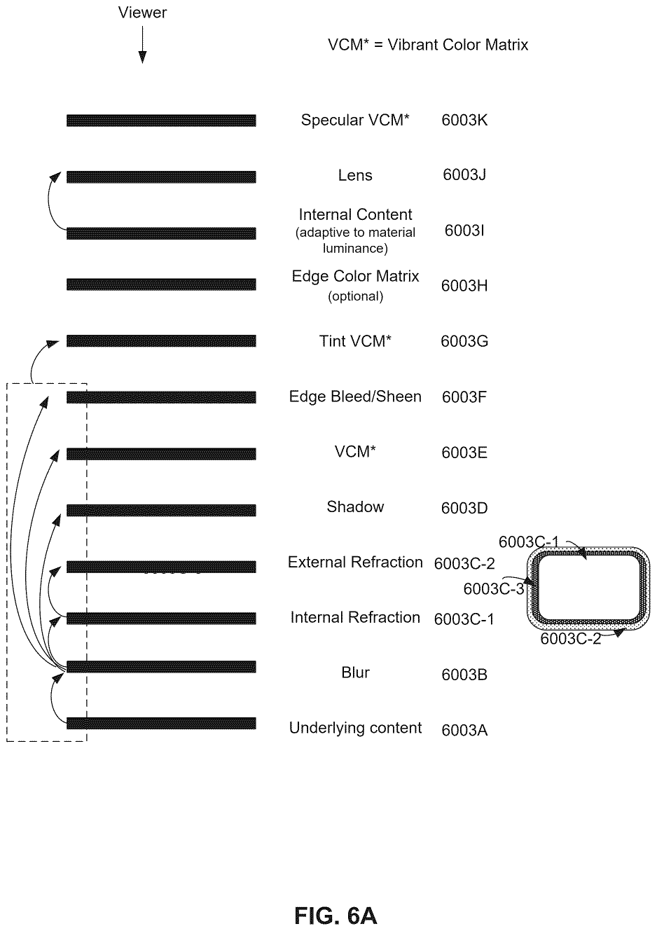

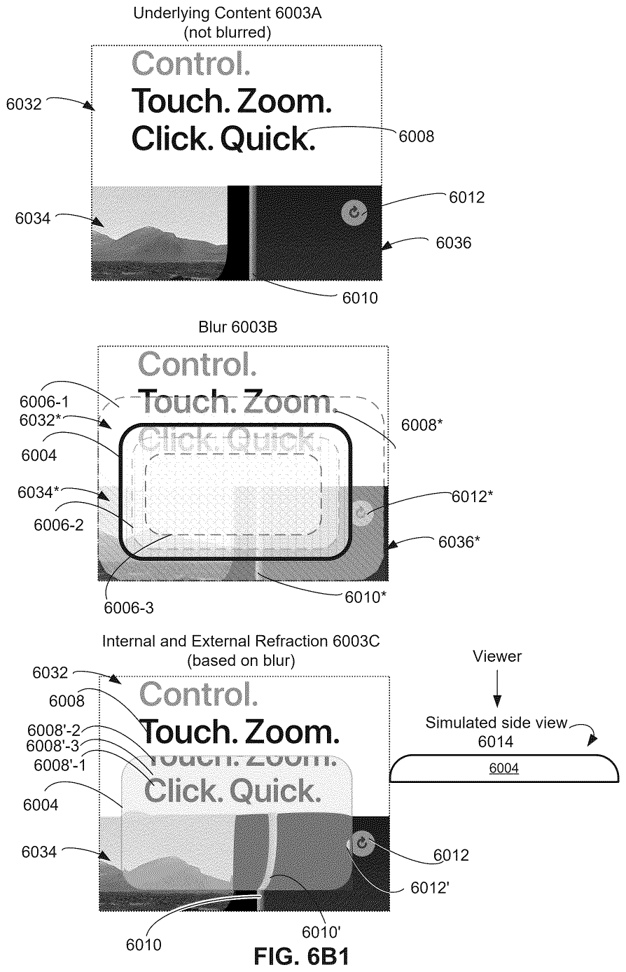

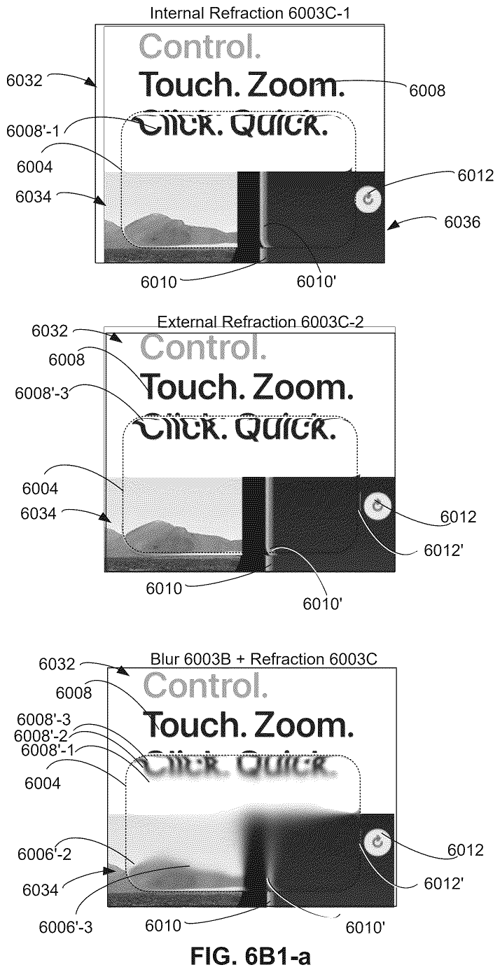

Below, FIGS. 1A-1C, 2, and 3A provide a description of example devices. FIGS. 3B-3G describe the use of Application Programming Interfaces (APIs) to perform operations. FIGS. 4A-4B illustrate example user interfaces that include adaptive simulated materials. FIGS. 5A-5E illustrate example user interfaces for displaying a simulated emissive user interface element in accordance with some embodiments. FIGS. 5F-5M illustrate example user interfaces for adjusting one or more visual properties responsive to user interaction in accordance with some embodiments. FIGS. 5N-5Q6 illustrate example user interfaces for transitioning between displaying a first set of controls and a second set of controls in accordance with some embodiments. FIGS. 5R-5V illustrate user interfaces for morphing a user interface element in accordance with some embodiments. FIGS. 5W-5Z illustrate example user interfaces for stretching and/or smashing a user interface element in accordance with some embodiments. FIGS. 5Z1-5AA illustrates animating a user interface element in accordance with some embodiments. FIGS. 5AB-5AD illustrate animated transitions for numerals in accordance with some embodiments. FIGS. 5AE-5AG illustrate updating numerals displayed with a simulated user interface appearance in accordance with some embodiments. FIGS. 6A-6C illustrate examples of layers used to generate a simulated user interface appearance of a user interface object in accordance with some embodiments. FIGS. 6D-6H illustrate applying various levels of deemphasis to user interface objects while changing underlying content in accordance with some embodiments. FIGS. 6I-6T illustrate visually emphasizing user interface objects that at least partially overlay one or more other user interface objects in accordance with some embodiments. FIGS. 6U-6AN illustrate a sequence for displaying and/or condensing sets of controls in accordance with some embodiments. FIGS. 6AO-6AP illustrate examples of modifying internal content that is displayed in a user interface object that is visually associated with a simulated user interface appearance in accordance with some embodiments.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

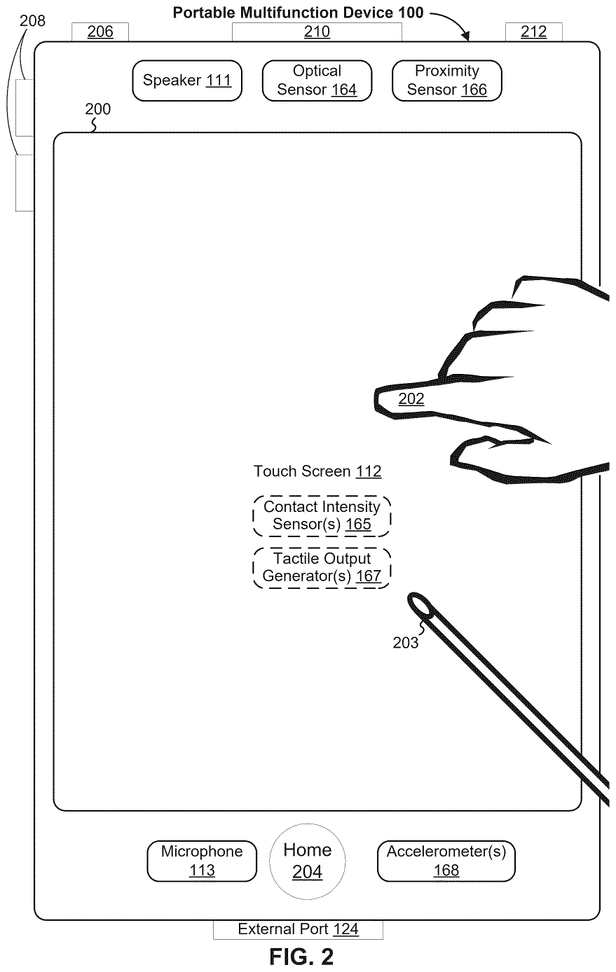

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (e.g., in FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized. FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (e.g., in FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (e.g., in FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the methods described herein by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 (e.g., home screen dock 6403) with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AD illustrate example user interfaces that include adaptive materials in accordance with some embodiments. The user interfaces in these figures are used to illustrate the processes described below. Although some of the examples which follow will be given with reference to inputs on a touch-sensitive surface 451 that is separate from the display 450, in some embodiments, the device detects inputs on a touch-screen display (where the touch-sensitive surface and the display are combined), as shown in FIG. 4A. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) posed, changing pose, and/or moving in physical space while a location or object is targeted, such as when the location of the hand(s) and/or finger(s) are on or near the object or the location or while a focus selector is on the location or object.

FIGS. 5A-5E illustrate example user interfaces for displaying a simulated emissive user interface element in accordance with some embodiments. FIGS. 5F-5M illustrate example user interfaces for adjusting one or more visual properties responsive to user interaction in accordance with some embodiments. FIGS. 5N-5Q6 illustrate example user interfaces for transitioning between displaying a first set of controls and a second set of controls in accordance with some embodiments. FIGS. 5R-5V illustrate user interfaces for morphing a user interface element in accordance with some embodiments. FIGS. 5W-5Z illustrate example user interfaces for stretching and/or smashing a user interface element in accordance with some embodiments. FIGS. 5Z1-5AA illustrates animating a user interface element in accordance with some embodiments. FIGS. 5AB-5AD illustrate animated transitions for numerals in accordance with some embodiments. FIGS. 5AE-5AG illustrate updating numerals displayed with a simulated user interface appearance in accordance with some embodiments. FIGS. 6A-6C illustrate examples of layers used to generate a simulated user interface appearance of a user interface object in accordance with some embodiments. FIGS. 6D-6H illustrate applying various levels of deemphasis to user interface objects while changing underlying content in accordance with some embodiments. FIGS. 6I-6T illustrate visually emphasizing user interface objects that at least partially overlay one or more other user interface objects in accordance with some embodiments. FIGS. 6U-6AN illustrate a sequence for displaying and/or condensing sets of controls in accordance with some embodiments. FIGS. 6AO-6AP illustrate examples of modifying internal content that is displayed in a user interface object that is visually associated with a simulated user interface appearance in accordance with some embodiments.

FIG. 5A illustrates a first page of a home screen user interface displayed via one or more display generation components of device 100. In some embodiments, the home screen user interface includes one or more application icons, as described with reference to FIG. 4A. In some embodiments, the device 100 detects a user input 502, such as a swipe user input, via touch screen 112. In some embodiments, in response to detecting the user input 502, the device 100 displays a second page of the home screen user interface 504, as illustrated in FIG. 5B.

In some embodiments, the second page of the home screen user interface 504 includes one or more application icons and/or one or more widgets. For example, the second page of the home screen user interface 504 includes application icon 448, application icon 450, and calendar widget 506. In some embodiments, a respective application icon is displayed to simulate multiple content layers within the application icon, such that the content within the application icon is perceived as three-dimensional having a non-zero depth, for example by displaying a first portion of content within the application icon as being simulated in a layer above a layer for a second portion of the content within the application icon. In some embodiments, content within one or more of the layers (or, optionally multiple layers, or all layers) is displayed as casting a virtual shadow on content within one or more underlying layers. In some embodiments, one or more layers (or optionally multiple layers, or all layers) is displayed with one or more virtual lighting effects (e.g., specular highlights), optionally including applying an independently determined virtual lighting effect to each layer (e.g., each layer is displayed with different specular highlights).

In some embodiments, one or more of the application icons and/or widgets displayed in the home screen user interface 504 include one or more emissive elements. For example, an emissive element is a user interface element that is displayed concurrently with a virtual lighting effect such that the emissive element appears to shine, reflect, highlight, or otherwise emit virtual light onto one or more other objects displayed in the user interface. In some embodiments, application icon 450 is an emissive application icon that is displayed with virtual lighting effect 524 that appears to shine light onto the calendar widget 506. In some embodiments, in response to detecting a user input 551, in accordance with a determination that user input 551 is a first type of input, such as a tap input or other selection input, directed to the application icon 450, a user interface for the application associated with the application icon 450 is displayed. For example, in response to detecting that user input 451 is directed to an email application icon for an email application, the device 100 displays an application user interface for the email application, such as user interface 540 in FIG. 5D (e.g., where FIG. 5D optionally follows FIG. 5B in sequence). In some embodiments, in accordance with a determination that the user input 551 is a second type of input, such as a tap and hold input, a swipe input, or another type of input, a quick actions menu for the selected application icon 450 (e.g., menu 6404 for a clock application described with reference to FIG. 6J, or another menu for the selected application icon) is displayed. In some embodiments, the virtual lighting effect 524 comprises one or more colors corresponding to one or more colors of the emissive application icon 450. For example, the application icon 450 is displayed with one or more colors, and a virtual lighting effect in the one or more colors is displayed as if produced by the application icon 450 and is simulated to shine on a portion of the calendar widget 506 that would glow in the physical world.

In some embodiments, one or more application icons and/or widgets are displayed as simulated glass material. As used herein, simulated glass material is a non-limiting example, and objects described herein as being displayed with the simulated glass material may be displayed with other user interface materials that have simulated optical, physical and/or virtual properties. In some embodiments, user interface elements, objects, buttons, platters, and/or other content that are described as being displayed with the simulated glass material are displayed with respective levels of one or more visual properties described with reference to FIGS. 6A-6B13 to generate the appearance of the simulated user interface material. For example, calendar widget 506 is displayed as a platter made out of simulated glass material such that portions of the user interface 504 that appear behind the calendar widget 506 are displayed with blur, magnification, refraction, or other simulated visual properties to simulate the appearance of being located behind a glass material. For example, the star 518 is included in the background of the user interface 504, sometimes referred to herein as a background layer. In some embodiments, user interface elements displayed with the simulated glass material are displayed in a glass layer that appears to be above the background layer (e.g., with a non-zero distance the z-axis). In some embodiments, content that is not displayed with the simulated glass material is displayed in the background layer (e.g., or is optionally displayed in a content layer that appears between (e.g., relative to the z-axis) the background layer and the glass layer).

In some embodiments, user interface elements (e.g., including application icons, widgets, and/or other user interface objects) displayed with the simulated glass material are displayed with one or more specular effects. For example, one or more specular effects are displayed that make the respective user interface element reflect and/or highlight portions of the respective user interface element (e.g., including edges of the user interface element) based on simulated virtual light source(s) (e.g., simulated reflection of simulated light on the simulated glass material).

In some embodiments, the edges of the calendar widget 506 appear as a bezel to simulate a thickness of the simulated glass material. For example, virtual lighting effects, including colors, lighting, shadows, refraction, and/or glow from content in the background layer and/or content within the glass layer (e.g., including from the calendar widget 506 itself), are applied to the edges of the calendar widget 506. In some embodiments, user interface objects displayed as simulated glass material are displayed concurrently with one or more shadows to simulate the user interface object as being positioned above other user interface objects (e.g., in a background of the user interface). For example, one or more colors of the star 518 appear to refract, magnify, and/or blur along the portion of the edge 516 of the calendar widget 506 that overlaps with the star 518 (e.g., and the portion of the edge 530 is displayed with virtual lighting effects based on visual properties of the star in the background layer underneath the portion of the edge 530). In some embodiments, one or more specular highlights and/or other virtual lighting effects (e.g., as described below with reference to FIG. 5AB) are displayed over one or more portions (e.g., along one or more edges) of the calendar widget 506.

In some embodiments, the portion of the star 518 that appears to be occluded by the simulated glass material of the calendar widget 506 (e.g., represented by the dashed lines of the star 518) appears distorted. For example, the portion of the star 518 that is displayed as underneath the calendar widget 506 is displayed with a first level of blurring, a first amount of refraction, a first amount of magnification, and/or respective first amounts of other visual properties, where the first amount of blurring, the first amount of refraction, the first amount of magnification, and/or the respective first amounts of other visual properties are determined based at least in part on a simulated depth between the background and the calendar widget 506. For example, as described below with respect to FIGS. 5F-5I, changing a simulated depth (e.g., and/or simulated angle) that separates the layer that includes the simulated glass material and the layer that includes the background of the user interface (e.g., the stars displayed in the background of the user interface) causes a change in the amount of blurring, the amount of refraction, the amount of magnification, and/or the amounts of other visual properties of the content (e.g., such that the content appears differently through the simulated glass material at the new simulated depth(s) and/or simulated angle(s)).

In some embodiments, the calendar widget 506 includes one or more emissive elements, such as emissive element 526-1. In some embodiments, the one or more emissive elements of a user interface object are defined by a designer and/or developer of the user interface object. For example, a designer and/or developer determines which portion(s) of the application icon 450 will be displayed with a virtual lighting effect to appear as though those portion(s) are emitting the light of the virtual lighting effect. In some embodiments, the virtual lighting effects appear to diffuse outward (e.g., the virtual lighting effect becomes less prominent at locations that are farther away from the respective emissive element).

In some embodiments, the calendar widget 506 includes user interface sub-elements corresponding to dates in a calendar. In some embodiments, the user interface sub-elements appear as simulated glass material that is in a layer above the simulated glass material of the calendar widget 506.

In some embodiments, the user interface sub-elements are selectable via one or more user inputs (e.g., to view additional details stored in a calendar application associated with the calendar widget 506). In some embodiments, the emissive element 526-1 corresponds to a currently selected date (e.g., automatically selected as the current date and/or selected by a user input). In some embodiments, the emissive element 526-1 (e.g., the user interface element corresponding to the “8”) is displayed with a first color, different from the color(s) of one or more other user interface sub-elements in the calendar widget 506 (e.g., the other user interface sub-elements corresponding to the other dates in the month). For example, the emissive element 526-1 is displayed with the color red (e.g., or another color) and the device 100 concurrently displays a virtual lighting effect with the color red (e.g., or another color) that appears to emanate from the user interface sub-element corresponding to the “8”. In some embodiments, the virtual lighting effect appears brightest close to the “8” and diffuses radially from the “8”. In some embodiments, the virtual lighting effect appears to interact with an edge of one or more other user interface sub-elements within the calendar widget 506 (e.g., the virtual lighting effect appears to hit a portion of the bottom edge 514-1 of the user interface element corresponding to the “1”, a portion of the right edge 512-1 of the user interface element corresponding to the “7”, a portion of the left edge 528-1 of the user interface element corresponding to the “9” and a portion of the top edge 508-1 of the user interface element corresponding to the “15”). In some embodiments, the virtual lighting effect appears to interact with one or more user interface sub-elements that are within a threshold distance of the emissive element 526-1 without interacting with one or more user interface elements that are not within the threshold distance (e.g., the virtual lighting effect does not interact with an edge of the user interface element corresponding to the “22”). In some embodiments, the virtual lighting effect interacts with the respective edges of the other user interface elements (e.g., that are displayed as simulated glass material) by refracting, magnifying, or otherwise emphasizing the portions of the respective edges where the simulated virtual lighting effect (e.g., that appears to originate from emissive element 526-1) hits the respective edges.

In some embodiments, the device 100 displays a virtual lighting effect that appears to originate from the emissive element 526-1 is applied to the edges of the calendar widget 506 at portion 520 and portion 510. For example, portion 520 and portion 510 are displayed with a color matching the color of the emissive element 526-1.

FIG. 5B further illustrates the device 100 detecting a user input 532 (e.g., a tap user input or other selection user input) selecting a user interface element corresponding to the “25”. In some embodiments, in response to detecting the user input 532, the device 100 selects the user interface element corresponding to the “25” in the calendar widget 506 as an emissive element (e.g., and optionally deselects the user interface element corresponding to the “8” as an emissive element, such that the user interface element corresponding to the “8” is no longer displayed with a virtual lighting effect that appears to originate from the “8”), as illustrated in FIG. 5C, where FIG. 5C follows FIG. 5B in sequence.

For example, in FIG. 5C, the device 100 concurrently displays a virtual lighting effect that appears to emanate from the user interface element 526-2 corresponding to the “25” in the calendar widget 506. In some embodiments, the virtual lighting effect appears to interact with the respective edges of the surrounding user interface elements (e.g., the virtual lighting effect appears to hit a portion of the bottom edge 514-2 of the user interface element corresponding to the “25”, a portion of the right edge 512-2 of the user interface element corresponding to the “24”, and a portion of the left edge 528-2 of the user interface element corresponding to the “26”). In some embodiments, the edges of the calendar widget 506 are also updated in accordance with the currently selected emissive element (e.g., portion 534 and portion 536 of the edges of the calendar widget 506 are displayed as interacting with the virtual lighting effect, and the portion 510 and portion 520 are no longer displayed with the virtual lighting effect), optionally based on a distance between the respective edges and the currently selected emissive element.

In some embodiments, the device 100 detects a user input 538 (e.g., a tap user input or other selection user input) directed to a mail application icon, and in response to detecting the user input 538 directed to the mail application icon, the device 100 displays a user interface 540 for a mail application corresponding to the mail application icon, as illustrated in FIG. 5D. In some embodiments, the user interface 540 optionally includes content (e.g., leaf 550 or other content, optionally including user-selectable content) in the background layer of the user interface. In some embodiments, the device 100 displays an inbox user interface object 544 in the glass layer. For example, the user interface object 544 is displayed as simulated glass material such that the edges of the user interface object 544 interact with other content (e.g., content in the background layer, content within the user interface object 544 and/or other content in the simulated glass layer).

In some embodiments, the user interface object 544 includes a message list portion that includes representations of messages, including messages 552-1 through 552-5. In some embodiments, the user is enabled to select a respective message (e.g., email or other message) from the message list (e.g., displayed in sidebar 543) in order to view content of the message. In some embodiments, the user interface object 544 includes a message content portion 554 for viewing the content of a selected respective message. In some embodiments, a currently selected message in the message list is selected as an emissive element. For example, in FIG. 5D, message 552-1 is selected (e.g., automatically by the mail application and/or via a user selection input), and while the message 552-1 is selected, the user interface element 542 corresponding to message 552-1 is displayed with a first color in the message list to indicate its status as currently selected. For example, user interface element 542 is displayed as the color blue (e.g., or another color), while the other messages in the message list are displayed with a different color (e.g., or with a simulated glass material that displays a distorted version of the content beneath the message list). In some embodiments, while the user interface element 542 is selected as the emissive element, a virtual lighting effect is concurrently displayed as emanating from the user interface element 542, including displaying the color blue as interacting with the portion 546 of the edge of the user interface object 544 and/or displaying a glow effect 548 (e.g., with the color blue or other color matching the color of the user interface element 542) overlapping with the message content portion 554 that displays the content of the message 552-1.

FIG. 5E follows in sequence from FIG. 5D and illustrates that, in response to detecting a user input 553 (e.g., in FIG. 5D) selecting message 552-5 in the user interface 540 (e.g., and deselecting message 552-1), user interface element 542 is no longer displayed as an emissive element and user interface element 556 is displayed as an emissive element (e.g., optionally with the same color and/or properties as described with reference to the emissive element of user interface element 542). For example, a virtual lighting effect is displayed as a glow effect 560 overlapping with the message content portion 562 that displays the content of the message 552-5 and as interacting with the portion 558 of the edge of the user interface object 544 (e.g., providing a blue outline along the lower left corner of the edge of the user interface object 544).

It will be understood that although the examples described above refer to one emissive element in an application icon, a widget or user interface object, more than one emissive element may be concurrently active within a respective application icon, widget, or user interface object, one or more (or multiple) emissive elements being displayed concurrently with one or more respective lighting effects that appear to emanate from the respective emissive element with visual properties (e.g., color, brightness, and/or other properties) based on the respective emissive element.

FIG. 5F illustrates device 100 displaying a user interface 602 that includes a user interface element 604 displayed as a simulated glass material in the glass layer and a background that includes a plurality of stars in the background layer. As described with reference to FIG. 5B above, in some embodiments, portions of the content displayed in the background layer (e.g., the stars in FIG. 5F) that appear underneath (e.g., overlap with) the simulated glass material of the user interface element 604 are displayed with one or more distorted visual properties. For example, the dashed portion of the star 606-1 and the dashed portion of the star 608-1 represent the portions of the background layer that appear underneath the simulated glass material of the user interface element 604, and are thus displayed with a first amount of blur, a first amount of refraction, a first amount of magnification and/or first amounts of other visual properties. As illustrated in the side view shown in FIG. 5F, the user interface element 604 is displayed to appear parallel to the background layer 603. In some embodiments, the appearance of the user interface element 604 is based at least in part on content that is not visible to the user, such as content in the user interface 602 that is covered by the user interface element 604 (e.g., underlying content that affects the appearance of the user interface element 604 based on the simulated glass material) and/or content that is not displayed within the user interface 602 (e.g., off-display content).

In some embodiments, in response to detecting a user input 610 (e.g., in FIG. 5G) directed to a bottom portion of the user interface element 604 (e.g., in FIG. 5F), the user interface element 604 is displayed as being pushed backward at a position corresponding to a position of the detected user input 610. In some embodiments, in accordance with a determination that the user input 610 is a first type of input, such as a tap input or other selection input directed to the user interface element 604, and the user interface element 604 is displayed as being pushed backward at a first rate of change (e.g., gradually pushing the user interface element 604 from its initial position in FIG. 5F to its position in FIG. 5G according to the first rate of change). In some embodiments, in accordance with a determination that the user input 610 is a second type of input, such as a tap and hold input or long press input directed to the user interface element 604, and the user interface element 604 is displayed as being pushed backward at a second rate of change (e.g., gradually pushing the user interface element 604 from its initial position in FIG. 5F to its position in FIG. 5G according to the second rate of change) different from the first rate of change. For example, the simulated glass material of user interface element 604 is displayed as behaving as a rigid surface such that the user input 610 appears to push down (e.g., in the z-direction) the lower part (e.g., in the y-direction) of the surface, causing the upper part (e.g., in the y-direction) of the surface to be pushed forward (e.g., in the z-direction). For example, in response to the user input 610, a simulated angle between the background layer 403 and the user interface element 604 (e.g., in the glass layer) is changed (e.g., from being parallel to an offset angle, as illustrated in the side view shown in FIG. 5G). In some embodiments, the amount of change in simulated angle between the background layer 403 and the user interface element 604 is based on a duration of the user input 610 (e.g., a longer user input 610 causes a larger change in simulated angle, and a shorter user input 610 causes a smaller change in simulated angle, or vice versa). In some embodiments, in response to detecting an initial portion of a user input (e.g., a user input that does not satisfy threshold input criteria), the device 100 displays a quick change in the simulated angle, and as the user input continues (e.g., makes progress towards satisfying the threshold input criteria), the simulated angle continues to change by a larger amount gradually over time.

In some embodiments, the change in simulated angle between the background layer 403 and the user interface element 604 causes a change in one or more visual properties of the content of the background layer that is visible through the simulated glass material of user interface element 604. For example, an amount of magnification of the star 606-1 is changed from the first amount of magnification (e.g., shown in FIG. 5F) to star 606-2 having a second amount of magnification different from the first amount of magnification (e.g., a larger amount of magnification) based on the updated simulated distance and/or angle between the background layer and the user interface element 604 in the glass layer. In some embodiments, one or more other visual properties of the simulated glass material of at least a portion of the user interface element 604 are updated (e.g., instead of or in addition to the amount of magnification) from the first amount to a second amount, such as the amount of refraction, the amount of blurring, and/or other visual properties, to cause the background content to appear with a different amount of magnification, refraction, blurring, and/or other distortion. In some embodiments, the star 608-1 is updated from having the first amount of magnification to a third amount of magnification (e.g., that is different from the first amount of magnification and/or different from the second amount of magnification). As such, the star 608-2 is displayed with a smaller amount of magnification (e.g., to simulate that the bottom portion of user interface element 604 (e.g., that overlaps with the star 608-2) is closer to the background layer in FIG. 5G than in FIG. 5F). Accordingly, the simulated glass material simulates physics as if the simulated glass material acts as a lens (e.g., with a respective amount of magnification, blurring, refraction, and/or other visual properties) and background content displayed behind the simulated glass material is updated as a simulated position (e.g., distance from the background layer) and/or angle of the simulated glass material changes. Additionally, the simulated glass material simulates physics by optionally casting one or more shadows on background content.

In some embodiments, in response to detecting an end of the user input 610 (e.g., liftoff of the user input), the change in simulated angle is reversed (e.g., optionally reversed at a faster rate than the rate at which the change in simulated angle was performed) and the one or more visual properties of the background layer under the user interface element 604 are returned to their initial states.

FIGS. 5H-5I illustrate another example of changing a simulated angle between the background layer and the user interface element 604. In some embodiments, in response to a user input 612 directed to a top portion of the user interface element 604, the user interface element 604 is displayed as being pushed backward at a position corresponding to a position of the detected user input 612. For example, the simulated glass material of user interface element 604 is displayed as behaving as a rigid surface such that the user input 612 appears to push down (e.g., in the z-direction) the upper part (e.g., in the y-direction) of the surface, causing the lower part (e.g., in the y-direction) of the surface to be pushed forward (e.g., in the z-direction). For example, in response to the user input 612, a simulated angle between the background layer 403 and the user interface element 604 (e.g., in the glass layer) is changed (e.g., from being parallel to an offset angle, as illustrated in the side view shown in FIG. 5G), thereby causing one or more visual properties of star 606-1 to be updated (e.g., from the first amount of magnification to a different amount (e.g., a smaller amount) of magnification) as illustrated by star 606-3 and one or more visual properties of star 608-1 to be updated as illustrated by star 608-3.

FIGS. 5I1-5I4 illustrate examples user interfaces of an animated transition for switching between selected user interface objects in accordance with some embodiments. For example, FIG. 5I1 illustrates a display area of device 5000 (e.g., a portable multifunction device, a television, a display, and/or a computing device) that includes a first user interface element 5002, a second user interface element 5004, user interface element 5010 and/or other user interface elements. In some embodiments, the user interface elements 5002, 5004 and 5010 are selectable user interface elements that represent content, for example the user interface element 5002 corresponds to a tile for a first content item and the user interface element 5004 corresponds to a tile for a second content item. In some embodiments, while the first user interface element 5002 is selected, the first user interface element 5002 is displayed with simulated glass material and one or more other selectable user interface elements (e.g., second user interface element 5004, user interface element 5010, and/or other user interface elements) are not displayed with simulated glass material or are displayed with a lesser degree of simulated glass material (e.g., a smaller simulated thickness of glass material, less blur, less simulated refraction, and/or lesser amount(s) of other visual properties of the simulated glass material described with reference to FIG. 6A). In some embodiments, while the first user interface element 5002 is the currently selected user interface element, one or more simulated virtual lighting effects are displayed as interacting with one or more edges of the first user interface element 5002. For example, specular highlights (e.g., as described in more detail below with respect to FIG. 5AB) are displayed on the first user interface element 5002.

In some embodiments, the device 5000 is communicatively coupled to an external input device 5008, such as a remote, keyboard, mouse, device 100, and/or another device. In some embodiments, the device 5000 includes a touch-sensitive surface that detects one or more inputs directed to the touch-sensitive surface. In some embodiments, in response to detecting a user input 5008, such as a click input, a scroll input, a tap input, or another user input directed to the input device 5008, corresponding to a request to change the currently selected user interface element, the device 5000 displays an animated transition to change a simulated angle of the currently selected user interface element (e.g., first user interface element 5002). In some embodiments, the user input 5008 includes movement in a first direction (e.g., left, right, up, down and/or a combination of these directions), and the change in simulated angle of the currently selected user interface element is based on the direction of movement of the user input 5008. For example, for a movement to the right, a right side of the user interface element 5002 is simulated as moving closer as the left side of the user interface element 5002 is simulated as being pushed back (e.g., similar to the animation described with reference to FIGS. 5F-5I), as illustrated in FIG. 512. In some embodiments, in response to detecting the user input 5008 has satisfied an input threshold (e.g., by continuing the input for a threshold amount of time and/or by performing a scrolling input for a threshold amount of movement, and/or another input threshold), the device 5000 displays the second user interface element 5004 as the currently selected user interface element (e.g., and user interface element 5002 is no longer selected), as illustrated in FIG. 513.

FIG. 5I4 illustrates an example of the progression of the animated transition of the user interface element 5002 (e.g., illustrated by the states of user interface elements 5002a through 5002d over time) in response to detecting a user input corresponding to a request to scroll and/or move the current selector of the user interface element 5002 to the right. For example, the user interface element 5002 is displayed with a plurality of states (e.g., as user interface elements 5002a through 5002d) that increases a simulated viewing angle of the right side of the user interface element while updating simulated optical effects such as the specular highlights 5012 (e.g., including specular highlights 5012a through 5012d) over time (e.g., to simulate virtual lighting that is reflecting by a different amount and/or at different positions based on a simulated angle between the user interface element 5002 and a simulated light source). In some embodiments, updating the simulate optical effects also includes changing an appearance of the user interface element based on simulated reflection, refraction, and or emissive elements, as described in greater detail elsewhere in this application. In some embodiments, the user interface element 5002 also responds to the user input by changing in size and or shape based on movement of the input and/or movement of the user interface element, as described in greater detail below with reference to methods 11000 and 20000.

FIGS. 5J-5M illustrate an example home screen user interface that includes one or more application icons that are displayed with a gradient effect (e.g., represented by the downward arrows). In some embodiments, the gradient effect changes in accordance with physical movement of the device 100. For example, in FIG. 5J the application icon 424 is displayed with a first level of gradient 614-1, application icon 426 is displayed with a first level of gradient 616-1, application 428 is displayed with a first level of gradient 618-1 and application icon 430 is displayed with a first level of gradient 620-1 while the device 100 is displayed at a first position having a first viewing angle relative to a viewpoint of the user. In some embodiments, in response to detecting a user interaction that causes a change in position and/or viewing angle between the device 100 and the viewpoint of the user, the application icons 424, 426, 428, and 430 are updated to display a change in the level of gradient. In some embodiments, the amount of change of the level of gradient is proportional to, or otherwise based on, an amount of the change in position and/or viewing angle of the device 100 relative to the viewpoint of the user. For example, in FIG. 5K, the device 100 is tilted by a first amount that causes the level of gradient displayed for each application icon to change by respective first amounts, and in FIG. 5L, the device 100 is tilted by a second amount that is greater than the first amount that causes a larger amount of change in the level of gradient displayed for each application icon.

In some embodiments, the gradients of the application icons are updated in accordance with a direction of the tilting of the device 100. For example, in FIG. 5M, the device 100 is physically tilted counterclockwise (e.g., relative to the y-axis), and the gradient 614-4 of application icon 424 is displayed as shifted to the right (e.g., with an angle based on the amount of tilt of the device 100), whereas in FIGS. 5K-5L, the device 100 is physical tilted clockwise (e.g., relative to the y-axis) and the gradient 614-2 of the application icon 424 is shifted to the left. In some embodiments, after the device 100 is tilted to a respective position and/or angle for a threshold amount of time (e.g., without further tilting or adjusting the device 100), the device 100 automatically, without additional user input, gradually adjusts the gradients of the application icons back to their initial state (e.g., as illustrated in FIG. 5J) even while the device 100 remains tilted.

By changing the gradients of the one or more application icons in accordance with a physical change in position and/or angle of the device 100 relative to the viewpoint of the user, the one or more application icons are perceived as three-dimensional objects that reflect light differently as the device 100 is physically tilted. For example, a virtual lighting effect, such as specular highlights, is displayed along one or more boundaries or edges of a respective application icon. As described below with reference to FIG. 5AB, specular highlights are based on one or more simulated external light sources, optionally including a light source of the physical environment in which device 100 is located. In some embodiments, the virtual lighting effect is updated as changing position, brightness, size and/or other properties as the device 100 is physically tilted to simulate movement of the device 100 relative to the simulated external light source(s).

FIGS. 5N-5Q illustrate a sequence of example user interfaces for transitioning one or more controls in a first set of controls in a first user interface to one or more controls in a second set of controls in a second user interface. For example, FIG. 5N illustrates a mail application user interface 722 that includes content 728 for displaying messages in an inbox of the mail application. The application user interface 722 further includes a first set of controls, including select button 724-1, search button 725-1, and compose button 726-1. In some embodiments, one or more of the buttons corresponds to their own platter and/or are displayed in separate platters. In some embodiments, the select button 724-1 is selectable by a user that enables the user to select one or more messages displayed in the inbox of the mail application, the search button 725-1 is selectable by a user to perform a search operation in the mail application, and the compose button 726-1 is selectable by a user that enables the user to compose a new mail message. In some embodiments, the select button 724-1, the search button 725-1, and the compose button 726-1 are displayed as being made of a simulated glass material.

The device 100 detects a user input 730 (e.g., a tap user input or other selection user input) directed to the compose button 726-1, and in response to detecting the user input 730, the device 100 initiates an animated transition (e.g., illustrated via the user interface 732 that replaces content 728 with transitional content 724) from the user interface 722 to a composition user interface 736 (e.g., in FIG. 5Q). In some embodiments, the user input 730 is a user input corresponding to a request to change the currently displayed user interface. For example, the user input 730 is a scrolling user input for scrolling the displayed user interface (e.g., replacing the displayed user interface with another portion of the user interface as the scrolling continues). In some embodiments, the user input 730 is a user input selecting a back button (e.g., or other navigation button) for navigating to a previously displayed user interface. It will be understood that other types of user inputs may be used that cause the device 100 to change the displayed user interface, and the animated transition described below may be applied to different controls displayed in various user interfaces.

In some embodiments, the animated transition includes updating the first set of controls through a plurality of states. In some embodiments, the animated transition for the first set of controls is based at least in part on a second set of controls (e.g., including the relative positions of respective controls in the second set of controls that are to be displayed in the user interface 736 relative to the positions of respective controls in the first set of controls that are displayed in the user interface 722). For example, cancel button 738 in user interface 736 is to appear in an upper left corner that satisfies distance criteria relative to select button 724-1 in the user interface 722. As such, the animated transition for displaying the cancel button 738 includes shrinking the select button 724-1 through a plurality of states, as illustrated by the transitional button 724-2 (e.g., in FIG. 5O) and transitional button 724-3 (e.g., in FIG. 5P). In some embodiments, the select button 724-1 gradually shrinks and the content displayed in the select button (e.g., the text “Select”) gradually ceases to be displayed during the transition (e.g., optionally by changing a blur and/or changing a size of the content). In some embodiments, changing the content within the button includes changing a position of the content (e.g., moving the text to the left and/or right) to appear as sliding on and/or off the button (e.g., the previous content slides off while the new content slides onto the button). In some embodiments, content within the button (e.g., text and/or glyphs) is displayed with a high dynamic range (HDR) effect (e.g., an effect that includes brightness that is outside of a standard range of brightness that is available to display content in the user interface) to improve the visibility of the content over bright content (e.g., in the background layer). In some embodiments, the transitional button 724-3 does not disappear completely before expanding to display the cancel button 738.

In some embodiments, the text size button 740 and the send button 742 (e.g., in FIG. 5Q) satisfy distance criteria relative to search button 725-1, such that the animated transition includes expanding and dividing search button 725-1 into the text size button 740 and the send button 742. For example, the distance criteria includes determining a relative location of the destination button(s) (e.g., text size button 740 and/or send button 742) compared to the initial button (e.g., search button 725-1), where the platter of the initial button is reused for the destination button(s) if the relative distance between the initial and destination buttons is within a threshold distance. In some embodiments, the criteria for reusing the platter of the initial button for the destination is based on a direction of the animated transition. For example, in some embodiments, the animated transition is performed in response to detecting a user input to change the user interface, including sliding a destination user interface (e.g., from right to left and/or top to bottom, or vice versa) over the initially displayed user interface, as described with reference to FIGS. 5Q3-5Q6 below.

In some embodiments, the criteria for reusing the platter of the initial button is based on the initial button and the destination button being displayed within a same simulated layer (e.g., both buttons displayed in the layer for the simulated glass material, the layer for underlying (e.g., background) content, and/or another layer). In some embodiments, the animated transition includes stretching the search button 725-1 into transitional button 725-2 before animating a gradual division (e.g., similar to a mitosis division) of transitional button 725-3 that results in the two separate buttons (e.g., the text size button 740 and the send button 742). In some embodiments, the shadows caused by the buttons displayed with the simulated glass material are maintained throughout the animated transition. In some embodiments, the animated transition includes merging two or more controls into a single control (e.g., by decreasing a distance between the two or more controls before gradually merging the controls together, similar to a reversal of the mitosis division animation illustrated in FIG. 5P).

In some embodiments, the compose button 726-1 does not satisfy distance criteria relative to user interface elements that are displayed in the updated user interface 736. As such, in some embodiments, the compose button 726-1 ceases to be displayed in the user interface 736 via an animated transition that includes gradually reducing a size of the compose button 726-1, as illustrated by transitional button 726-2 (e.g., in FIG. 5O), before ceasing to be displayed in FIG. 5P. In some embodiments, as described below, keyboard 734-3 is displayed in the user interface 736 without morphing from (e.g., without sharing a platter with) compose button 726-1 in accordance with a determination that the keyboard 734-3 does not satisfy location criteria with respect to the compose button 726-1.

FIGS. 5O-5Q further illustrate an animated transition for adding a user interface element (e.g., keyboard 734-3) in the user interface 736 that does not originate from another user interface element in the user interface 722 (e.g., there is no control that satisfies distance criteria displayed in the user interface 722). For example, the keyboard 734-3 is materialized by gradually transitioned into the user interface by displaying a circular transitional element 734-1 that gradually increases in size (e.g., in the x- and/or y-direction and in simulated material thickness (e.g., in the z-direction relative to a surface of the material)) to transitional element 734-2 before expanding into the keyboard 734-3. In some embodiments, the transitional element 734-1 is displayed with a smaller size and has a more rounded shape than the transitional element 734-2. In some embodiments, during the animated transition, the transitional element 734-2 is expanded in a first direction (e.g., along the x-axis) at a faster rate than in a second direction (e.g., along the y-axis). As such, the animated transition is not a uniform transition but instead appears to stretch with a first rate in a first direction and a second rate in a second direction. In some embodiments, the transitional elements 734-1 and 734-2, and the keyboard 734-3 are displayed with simulated glass material, and the shadow cast by the simulated glass material gradually increases throughout the transition. For example, the glass material of transitional element 734-1 is simulated to have a first thickness that causes a first level of shadow to be cast (e.g., or no shadow) on the background layer, and the transitional element 734-2 is simulated to have a second thickness (e.g., greater than the first thickness of transitional element 734-1) that causes a second level of shadow (e.g., greater than the first level of shadow) to be cast on the background layer. In some embodiments, the glass material of the keyboard 734-3 is simulated to have a third thickness (e.g., greater than the first and second thicknesses of the transitional elements) that causes a third level of shadow (e.g., greater than the first and second levels of shadow) to be cast. As such, the simulated glass material of keyboard 734-3 appears to increase in size and simulated thickness during the animated transition illustrated in FIGS. 5O-5Q.

FIGS. 5Q1-5Q2 illustrate a reversal of the animated transition described with reference to FIGS. 5O-5Q, optionally following in sequence from FIGS. 5O-5Q. In some embodiments, in response to detecting user input 744, such as a tap input, drag input, or other selection input, directed to the cancel button 738 (e.g., in FIG. 5Q), the device 100 ceases to display the user interface 736 and displays an animated transition to redisplay the user interface 722, as illustrated in FIGS. 5Q1-5Q2. For example, the animated transition includes morphing cancel button 738 to transitional button 738-1 (e.g., by stretching the cancel button 738 along an x-axis optionally without stretching the cancel button 738 along a y-axis, thus changing a width of the button without changing a height). In some embodiments, the animated transition includes moving button 740 and button 742 closer together and displaying a morphing animation that combines the two buttons as transitional button 725-4 (e.g., in FIG. 5Q1). In some embodiments, during the animated transition, the content displayed within the buttons is distorted, for example, blurred, faded, or otherwise visually deemphasized, while replacing the internal content of the respective button(s) with new internal content. In some embodiments, after displaying the animated transition, the device 100 redisplays the user interface 722, as illustrated in FIG. 5Q2.

FIGS. 5Q2-5Q2F illustrate navigating between a sequence of user interfaces in accordance with some embodiments. In some embodiments, the user interface 722 includes mailboxes navigation button 5016 for navigating to a mailboxes user interface 5022 (e.g., illustrated in FIG. 5Q2A). In some embodiments, in response to detecting a user input 5018, such as a tap input or other selection input, directed to the button 5016, the device 100 displays an animated transition (e.g., as illustrated in FIGS. 5Q2A-5Q2B) to replace the user interface 722 with the user interface 5022. In some embodiments, in response to detecting a swipe user input 5020, such as a rightward swipe, or another user input that includes movement, the device 100 displays an animated transition (e.g., as illustrated in FIGS. 5Q2A-5Q2B) to replace the user interface 722 with the user interface 5022, where a rate of the animated transition is based at least in part on a rate of movement of the user input 5020. For example, in FIG. 5Q2A, the user input 5020′ (e.g., a continuation of the user input 5020) continues to move rightward such that user interface 722 appears to slide to the right with the movement of the user input 5020′ (e.g., as if the user input 5020′ is dragging the user interface 722 to the right) and the user interface 5022 is partially displayed during the animation to simulate the user interface 722 being removed from covering the user interface 5022. In some embodiments, the animated transition includes gradually shrinking the button 5016′ (e.g., corresponding to a smaller version of the button 5016) and displaying the text within button 5016 as being pushed or moved out of the button 5016 (e.g., “Mailboxes” is moved to the right to travel from its initial position within button 5016 to a position as a header in the user interface 5022, as illustrated in FIG. 5Q2B). In some embodiments, in accordance with a determination that the user interface 5022 does not include a button or other user interface object at a position that is within a threshold distance of the position of button 5016 in user interface 722, the button 5016 is displayed as shrinking until it ceases to be displayed, optionally including simulating a decrease in simulated thickness of the simulated glass material of button 5016 as it shrinks and/or disappears. In some embodiments, the animated transition of shrinking the button 5016 is displayed while the user input 5020′ is detected, and the animated transition completes (e.g., where button 5016 ceases to be displayed upon completion of the animated transition and user interface 5022 is fully displayed) in response to detecting an end of the user input 5020′ (e.g., liftoff of the user input 5020′ and/or movement of the user input 5020′ past an edge of the display area). In some embodiments, as the content within button 5016 is simulated as passing below the simulated glass material of the button 5016′, optical distortion of the content is displayed along one or more edges of the simulated glass material of the button 5016′, as described in more detail below with respect to FIG. 5Q5.

In some embodiments, in response to detecting a user input 5024, such as a tap user input, a swipe user input, or other user input, corresponding to a request to display an inbox user interface 722, the device 100 displays an animated transition (e.g., as illustrated in FIGS. 5Q2C-5Q2E) between displaying the user interface 5022 and the user interface 722, such as an opposite animated transition to the animated transition described with reference to FIG. 5Q2A. For example, the user interface 722 appears to gradually move onto the display area to appear as though the user interface 722 is gradually covering the user interface 5022. In some embodiments, in accordance with a determination that a button is to be displayed in the user interface 722 at a position in which a user interface element was not displayed in the user interface 5022, the animated transition includes populating the button 5016″, including increasing a size of the button 5016″ (e.g., to button 5016′″) and simulating an increase in the simulated thickness of the button 5016″, where button 5016′″ appears to have a larger simulated thickness than button 5016′ as the button 5016′ increases in size. In some embodiments, simulating a change in thickness of the simulated glass material of a user interface object is described in more detail with respect to FIGS. 5Z1-5Z3. In some embodiments, the select button 724-1 is also animated as gradually appearing by increasing a thickness of the simulated glass material, as illustrated in FIGS. 5Q2E-5Q2F.

FIGS. 5Q3-5Q6 illustrate a sequence of user interfaces for incorporating a header into a button in accordance with some embodiments. In some embodiments, a settings user interface 750 is displayed for controlling one or more settings of a camera application, as indicated by header 756 “Camera”. In some embodiments, the settings user interface 750 includes a button 752 (e.g., a back navigation button for returning to a previous settings page) that is displayed as simulated glass material. In some embodiments, in response to detecting a user input 758, such as a tap input, a drag input, a scroll input, or another type of input that corresponds to a request to display a camera control user interface 754, the device 100 displays an animated transition that includes sliding the camera control user interface 754 onto the display area (e.g., from the right side) to replace display of the settings user interface 750. In some embodiments, the animated transition includes increasing a size of the button 752′ and moving header 756′ to appear as if header 756′ is being pushed off the display area (e.g., from right to left). In some embodiments, the size of the button 752′ is increased, gradually over time, to absorb the text of header 756, as illustrated in FIGS. 5Q5-5Q6. For example, the text of header 756′ appears to be absorbed or otherwise incorporated into button 752″. In some embodiments, as the text of header 756′ is animated as being incorporated into button 752″ (e.g., by sliding into the simulated glass material of button 752″), at the edges of the button 752″, a lensing virtual effect (e.g., as described with more detail below with respect to FIGS. 6A-6B4), indicated by the optical distortion in FIG. 5Q5, is applied to at least a portion of the text of header 756′ such that the text appears distorted as it passes through (e.g., under) a simulated edge of the simulated glass material of button 752″. In some embodiments, the header 756′ continues to change position (e.g., by shifting to the left) to get closer to the internal content (“<”) displayed in button 752″, until the button 752′″ includes the text of header 756, as illustrated in FIG. 5Q6. In some embodiments, the button 752′″ is displayed in the camera control user interface 754, and in response to detecting a user input selecting the button 752′″, the device 100 reverses the animated transition (e.g., removing the text of header 756 from the button 752′″ and sliding the user interface 754 in an opposite direction (e.g., to the right) off the display area)) to redisplay the setting user interface 750 (e.g., in FIG. 5Q3).

FIGS. 5R-5V illustrate a sequence of user interfaces showing an example of an animated transition between user interfaces that reuses a platter while changing the controls available in the platter. For example, FIG. 5R illustrates a user interface 802 for a mail application that includes platter 810 displayed with simulated glass material. In some embodiments, the platter 810 includes one or more controls, such as reply control 804, file control 806 and trash control 808. In some embodiments, in response to detecting a user input 812 (e.g., a tap user input or other selection user input) directed to the reply control 804, one or more visual properties of the reply control 804 (e.g., and/or platter 810) are updated to indicate that the reply control 804 has been selected. For example, the reply control 804 and/or platter 810 are displayed with the simulated glass material, where the simulated glass material appears to push back, change in simulated thickness, or otherwise react in response to the user input 812. In some embodiments, in response to detecting the user input 812, the device 100 transitions from displaying the controls in platter 810 to a menu of controls in platter 816-1 (e.g., in FIG. 5V). In some embodiments, the device 100 transitions from displaying the controls in platter 810 to a menu of controls in platter 816-1 (e.g., in FIG. 5V) in response to detecting a user input that is not directed to a control within platter 810 (e.g., in response to detecting a user input, such as a tap input, a long press input and/or another selection input, directed to the message portion displayed in the user interface 802). In some embodiments, the user input 812 is a first type of input, such as a tap input, a touch input, or another first type of input, and in response to detecting the first type of input, a first animated transition (e.g., illustrated in FIGS. 5S-5U1) that includes transitional platters 814 is displayed. In some embodiments, the user input 812 is a second type of input, such as a tap and hold input, a click input (e.g., detected via a mouse or other external input device), a click and drag input, or another second type of input that is different from the first type of input, and in response to detecting the second type of input, a second animated transition (e.g., including a second set of transitional platters) that is different from the first animated transition is performed. For example, the second set of transitional platters have different shapes, different visual properties of simulated glass material (e.g., different simulated thickness, different simulated amount of damping, or other display properties), are displayed with a different rate of change, or are otherwise different from the set of transitional platters 814 displayed for the first animated transition in response to the first type of input.

In some embodiments, the menu of controls in platter 816-1 reuses the platter 810 by transitioning to a new set of controls without ceasing display of at least a portion of the platter 810, where the controls available in the menu of controls 816-1 are different from the controls available in the platter 810 (e.g., in FIG. 5R). For example, the platter 810 is animated as decreasing in size (e.g., in a first direction (e.g., along the x-axis) at a first rate of change, optionally without decreasing in size, or decreasing at a different rate of change, in a second direction (e.g., along the y-axis)) and is displayed with one or more visual effects (e.g., a color (e.g., optionally a color that is intermediate between the color of the platter 810 and the platter 816-1), a glow effect, a blur effect, and/or another visual effect) as transitional platter 814-1. In some embodiments, the animation includes decreasing the transitional platter 814-1 in size and changing a shape of the transitional platter 814-1 into a rounded shape, as illustrated by transitional platter 814-2 (e.g., in FIG. 5T). In some embodiments, the transitional platter 814-2 in the rounded shape is then expanded into a less-rounded shape, as illustrated by transitional platter 814-3 (e.g., in FIG. 5U1) before the displaying the platter 816-1 (e.g., in FIG. 5V) that includes a menu of controls, such as Reply, Reply All, Forward, and Flag. In some embodiments, transitional platter 814-3 (e.g., in FIG. 5U1) is stretched relative to transitional platter 814-2 by different amounts (and/or different directions) along the x-axis and the y-axis. In some embodiments, the transitional platter 814-3 is stretched non-uniformly to display the transitional platter 814-3 with a simulated gel-like or amorphous appearance (e.g., to simulate physical inertia and/or damping of the transitional platter 814-3) during the animation for transitioning platter 810 to platter 816-1. In some embodiments, the amount of shadow cast by the simulated glass material of platter 810, transitional platters 814-1, 814-2 and 814-3, and platter 816-1 remains the same during the animated transition (e.g., simulating that a distance between the platters and the background layer remains constant).

FIG. 5U2 illustrates an example of a transition that reuses a platter that is displayed over background content. In some embodiments, the states 1-3 shown in FIG. 5U2 correspond to the transitional platter states described with reference to FIGS. 5S-5U1. For example, in FIG. 5U2, the platters 814-1 through 814-3 represent the transitional states between platter 810 (e.g., in FIG. 5R) and platter 816-1 (e.g., in FIG. 5V), where the platter 810 and/or platter 816-1 overlay background content (e.g., star 815). In some embodiments, as described above, the simulated thickness of the user interface material (e.g., simulated glass material) of the platters 814-1 through 814-3 does not change during the transitional states of the platter, but the change in size (e.g., height and/or width) and/or shape of the platter causes a different amount of distortion of the background content. For example, as described with reference to FIG. 6B1 below, based on a curvature of the simulated size view 6014, external content (e.g., the star 815 in FIG. 5U1) appears to be distorted by varying amounts, where a smaller size of a transitional state of the platter (e.g., platter 814-2) causes more distortion (e.g., due to more simulated curvature along the edges) than a larger size of a transitional state of the platter (e.g., platter 814-3) while maintaining a simulated thickness of the platter 814-2 and platter 814-3 (e.g., the platters have a same simulated thickness). For example, in FIG. 5U2, in state 1, the platter 814-1 is displayed with a first size (e.g., corresponding to simulated side view 813′) that is larger than the size of platter 814-2 in state 2 (e.g., corresponding to simulated side view 813″), thus the level of simulated refraction applied to portion of star 815′ in state 1 appears to be less than the level of simulated refraction applied to portion of star 815″. Similarly, the platter 814-3 in state 3 is displayed with a size that is larger than the platter 814-1, and the corresponding simulated side view 813′″ appears less rounded at the edges relative to the simulated side view 8113′ of platter 814-1, thus the level of simulated refraction applied to portion of star 815′″ that overlaps with the platter 814-3 is less than the level of simulated refraction applied to portion of star 815′.

FIGS. 5V-5Z4 illustrate examples of user interface elements displayed with the simulated glass material as being reactive to one or more user inputs by stretching, squishing, or otherwise amorphously changing shape. FIGS. 5V-5Y illustrate a sequence of user interfaces for manipulating a shape of the platter 816-1 in accordance with a user input, optionally following in sequence from FIGS. 5R-5V. For example, in FIG. 5V, in response to the device 100 detecting a user input 903, such as a drag input, a tap and hold input, or another user input that includes subsequent movement of the input 903, directed to a portion of the platter 816-1, the device 100 stretches the platter 816-1 to increase in height, as illustrated by platter 816-2 (e.g., in FIG. 5W), and optionally changes a position of the platter 816-2 to be moved away from an anchor point 905 (e.g., where platter 816-1 is anchored to the anchor point 905 along a bottom edge of the device 100 while the user is not dragging the platter 816-2 away from the anchor location 905). In some embodiments, the device 100 detects a user input 902-1, such as a drag user input or other user input directed to a portion of the platter 816-1 that includes subsequent movement of the input. For example, the user input 902-1 drags the top portion of the platter 816-1 upward, and in response to the user input 902-1, the platter 816-1 changes shape (e.g., by changing dimensions) into platter 816-2 according to the movement of the user input 902-1. In some embodiments, the movement of the user input 902-1 (e.g., a distance, velocity, jerk, and/or one or more other properties of the movement) causes a movement of the platter 816-1 (e.g., where the magnitude of movement of the platter 816-1 is calculated based on one or more properties of the movement of the user input 902-1), and the amount of reactivity of the platter 816-1 (e.g., an amount of stretching, compressing, resistance, and/or other simulated reaction that is based on approximated or simulated physics) is based on a magnitude of movement (e.g., distance, velocity, jerk and/or one or more other properties) of the platter 816-1. In some embodiments, the movement of the platter 816-1 is not based on the movement of the user input 902-1 (e.g., the platter 816-1 is moved independently from detecting the movement of the user input 902-1, optionally in a different direction than a direction of movement of the user input 902-1). In some embodiments, the amount of change in size (e.g., the amount of scaling) of the platter 816-1 is based on the movement of user input and/or based on the movement of the platter 816-1. In some embodiments, the dimensions of the platter 816-2 continue to change until movement of the user input 902-2 ceases (e.g., and/or until the velocity of the user input 902-2 has reached a threshold level). For example, in FIG. 5W, the platter 816-2 increases in height (e.g., in the y-direction) and decreases in width (e.g., in the x-direction), as indicated by the arrows in FIG. 5W. In some embodiments, a volume and/or area of the platter 816-2 is substantially maintained. In some embodiments, in response to detecting user input 902-2 has ceased to continue moving (e.g., and/or a velocity of the user input 902-2 has stabilized where the velocity of the user input 902-2 does not change by at least a threshold amount within a time period), the platter 816-2 continues to be displayed with its stretched dimensions (e.g., at a maximum scaled amount, defined based on a size of the platter 816-2 as described with reference to Table 1A). In some embodiments, in accordance with a determination that the user input 902-2 has stopped moving and/or has reached stabilized velocity, the platter 816-2 is not stretched further (e.g., or is stretched at a slower rate and/or by a smaller amount). In some embodiments, the platter 816-2 is optionally maintained at a position away from anchor point 905 while the user input 902-2 is maintained (e.g., even after the user input 902-2 ceases to move).

In some embodiments, in response to a user input grabbing a portion of the platter 816-1, the device 100 displays the platter 816-1 as jiggling to appear flexible (e.g., with a simulated reaction that is based on approximated or simulated physics that includes simulating resistance of changing shape and/or moving of the platter 816-1) and responsive to the user input (e.g., and optionally pinning the portion of the platter 816-1 under the detected input such that the pinned portion of the platter 816-1 follows movement of the input), for example, as illustrated in FIG. 5W1. In some embodiments, FIG. 5W1 illustrates an alternative user interface following the user interface in FIG. 5V in response to detecting a user input 902-1 that continues as user input 902-3; and FIG. 5W illustrates a user interface following the user interface in FIG. 5V in response to detecting a user input 903 and/or detecting user input 902-1 that continues as user input 902-2. In some embodiments, the animation of the platter in response to the user input depends on a position of the user input relative to the platter 816-1 and/or a direction of movement of the user input relative to the platter 816-1. For example, if the user input 903 (e.g., in FIG. 5V) is directed to a top center portion of the platter 816-1 and/or includes movement substantially straight upward, the top edge of the platter appears to stretch to increase the height of the platter (e.g., as illustrated in FIG. 5W), whereas if the user input 902-1 is directed to a corner of the platter 816-1 and/or includes movement diagonally away from the platter 816-1, the platter 816-4 (e.g., in FIG. 5W1) is displayed (e.g., where the corner of the platter 816-4 follows the user input 902-3), thereby changing a height of the top right corner of the platter 816-4 by a greater amount than the top left corner of the platter 816-4. As such, stretching the platter 816-2 in a first direction in response to the user input 903 (e.g., upwards in the y-direction) causes the platter 816-2 to shrink in a second direction (e.g., from left and right in the x-direction) different from the first direction. In some embodiments, the amount of stretching and/or shrinking of the platter 816-2 is dependent on one or more properties of the user input 902-1. For example, the amount of stretching upwards in the y-direction is based on a direction, magnitude, and/or a rate of movement (e.g., speed, acceleration and/or jerk) of the user input 903 and/or user input 902-1 in the y-direction. In some embodiments, the amount of stretching is based at least in part on a location of the user input 902-1 relative to a boundary of the platter 816-2. For example, in FIG. 5X, the user input 904-1 is detected as moving within the boundary of the platter 816-2, and the amount of stretching is less than the amount of stretching applied to the platter 816-2 in response to detecting a user input that travels outside of the boundary of the platter 816-2 (e.g., user input 902-2 moves outside of the boundary of the platter 816-2 and thus a greater amount of stretching is applied to the platter 816-2).

In some embodiments, the user input 902-3 is maintained as user input 902-4 in FIG. 5W2, where FIG. 5W2 follows in sequence from FIG. 5W1. In some embodiments, while the top right corner corresponding to a position of the user input 902-3 is initially stretched more than the top left corner of the platter 816-4, in some embodiments, over time, the top left corner catches up to the top right corner in stretching in the y-direction, for example as illustrated by the platter 816-5 in FIG. 5W2. In some embodiments, while the user input 902-4 is maintained, the platter 816-5 continues to be elongated in the y-direction and shrunk in the x-direction while optionally also being lifted away from an anchor point of the plater 816-1 along a bottom edge of the display. For example, the platter 816-5 is displayed at a position away from the anchor point and in accordance with a determination that the user input 902-4 has ceased, the platter 816-1 (e.g., in FIG. 5X, following FIG. 5W2) is displayed as snapping back to the anchor point (e.g., where a bottom edge of platter 816-1 is anchored to a bottom edge of the display area) and is redisplayed with its original aspect ratio (e.g., including optionally displaying a reversal of the animation described with reference to FIGS. 5V-5W2 to gradually, over time, change the platter 816-4 back to its original shape illustrated as platter 816-1).

In some embodiments, while the user input 902-1 is maintained (e.g., without lifting off) as user input 902-2 (e.g., optionally without additional movement of the user input 902-2), the platter 816-2 continues to be displayed with the morphed shaped illustrated in FIG. 5W (e.g., following in sequence after FIG. 5V). In some embodiments, the content displayed within platter 816-1 is displayed as moving within the platter 816-2 (e.g., appears to shift upward or otherwise change in position) based on the morphed shape of the platter 816-2 in FIG. 5W. In some embodiments, upon liftoff of the user input 902-2, the platter 816-2 returns to its initial shape, as illustrated by platter 816-1 in FIG. 5X.

FIG. 5X illustrates detecting a user input 904-1 in a direction different than the direction of the user input 902-1 (e.g., a drag user input or other selection user input directed to the platter 816-1 that moves to the right). In some embodiments, similarly to the behavior described above with reference to FIG. 5V-5W, the platter 816-1 is stretched to increase in width and decrease in height (e.g., into a morphed platter 816-3, FIG. 5Y) in accordance with a direction and/or rate of movement of the user input 904-1. In some embodiments, the morphed platter 816-3 is maintained while user input 904-2 (e.g., a continuation of user input 904-1) continues to be detected.

FIG. 5Y1 illustrates a slider 5052 that includes an indicator 5050 indicating a selected value of the slider 5052. In some embodiments, the slider 5052 is a directional user interface object where an increase in the value (e.g., moving the indicator 5050′ to the right) corresponds to a positive polarity and a decrease in the value (e.g., moving the indicator 5050″ to the left) corresponds to a negative polarity, and the indicator 5050 is stretched and/or compressed based on the polarity. For example, in response to detecting a user input in the direction of the positive polarity, the indicator 5050′ is stretched and in response to detecting a user input in the direction of the negative polarity, the indicator 5050″ is compressed. FIG. 5Y1 further illustrates a plurality of user interface elements that have different sizes, in accordance with some embodiments. In some embodiments, platter 816a is an example of a small variant user interface object, platter 816b is an example of an intermediate size user interface object, and platter 816c is an example of a large variant user interface object. In some embodiments, the platters 816a-816c are reactive to user inputs, for example, including the behaviors described with reference to platter 816 in FIGS. 5V-5Y. In some embodiments, an amount of the reactivity of the respective platters 816a-816c to a user input is based at least in part on the size of the platter, as indicated by Table 1A below. In some embodiments, an amount of reactivity (e.g., as indicated by a size of the arrows in FIG. 5Y1) of the small platter 816a is generally displayed as being more reactive to a user input than the amount of reactivity of the large platter 816c, while the amount of reactivity of the intermediate platter 816b is between the amounts of reactivity of the small platter 816a and the large platter 816c depending on the particular dimensions of the intermediate platter 816b (e.g., a larger intermediate platter is displayed with less reactivity than a smaller intermediate platter).

Table 1, divided into Table 1A and Table 1B below, illustrates a set of visual parameters that define the relative reactivity of a user interface object to various inputs and events. For a particular row, the reactivity listed in one column is relative to the corresponding reactivity listed in a different column in the same row. In some embodiments, different sizes and/or types of user interface objects (e.g., small variant, intermedia size, large variant, loupe, liquid lens, and menu) are displayed as modifying the set of parameters differently such that the different types of respective user interface objects are simulated as having different levels of reactivity in response to detecting a user input. Table 1 includes non-limiting examples of Figures that illustrate the respective type of user interface object. In some embodiments, during and/or after a user interaction, parameters of a user interface object are updated, for example, the user interface object is displayed with a different opacity (e.g., to indicate a selection state and/or attention of the user), is stretched and/or compressed (e.g., scaled in one or more dimensions), and/or is displayed as moving from an initial position to a settled position (e.g., a steady-state position that is achieved after an end of the user input), including optionally displaying the object as bouncing (e.g., overshooting the steady-state position) during and/or after the user input before being displayed at the steady-state position. Table 1A illustrates how parameters are modified for different sized user interface objects. For example, the size class is determined based on a height and width of the user interface object as small, intermediate, or large. In some embodiments, an opacity indicating a selection state of a user interface object (e.g., an opacity of selected user interface element 5002 in FIG. 5I1) while the user interface object is selected is increased by a greater amount for a small size user interface object than for a large size user interface object, and the opacity for an intermediate size user interface object is adjusted by an intermediate value (e.g., that is interpolated to a change in opacity at a level between the small variant and large variant based on the dimensions of the intermediate size user interface object). In some embodiments, the amount of scaling displayed in response to a user input for a small size user interface object is greater than the amount of scaling for a large size user interface object, such that the small size user interface object appears more reactive than the large size user interface object. In some embodiments, the bounciness of the user interface object (e.g., an amount of overshooting and/or oscillation of the user interface object before the object is displayed at a settled state) is dependent on the size and/or type of the user interface object. Table 1B illustrates how the parameters are adjusted in special use cases where the type of user interface object is a loupe (e.g., user interface element 912), a liquid lens, or a menu (e.g., where the size class of the respective use case indicates a size of the user interface object, but the parameters are adjusted in accordance with the values listed in Table 1B as opposed to following the size variant parameters outlined in Table 1A).

TABLE 1A

| Parameter | Small Variant | Intermediate size | Large Variant |
|---|---|---|---|
| Examples | FIGS. 5N-5P | FIG. 5Y1 | FIGS. 5B-5C and |
| | and 5Y1 | | 5Y1 |
| Size class (based on the | Small Size | Intermediate Value | Large Size |
| minimum of height and | (e.g., 44 pixels | (monotonically and/or | (e.g., 160 pixels |
| width) | or points or | linearly interpolate | or points or |
| | less) | between small and | more) |
| | | large parameters | |
| | | based on this | |
| | | dimension) | |
| Opacity of selection state | Higher Opacity | Intermediate Value | Lower Opacity |
| Opacity of indication of | Higher Opacity | Intermediate Value | Lower Opacity |
| attention in selection | | | |
| state | | | |
| Scaling on input start | Higher Scaling | Intermediate Value | Lower Scaling |
| Scaling based on | Higher Scaling | Intermediate Value | Lower Scaling |
| movement (of the input) | | | |
| Scaling based on velocity | Higher Scaling | Intermediate Value | Lower Scaling |
| or acceleration (of the | | | |
| object) | | | |
| Amount of scaling up on | Higher Scaling | Intermediate Value | Lower Scaling |
| selection/hover | | | |
| Minimum scale during | Smaller | Intermediate Value | Larger Minimum |
| movement | Minimum Scale % | | Scale % |
| Maximum scale during | Larger | Intermediate Value | Smaller |
| movement | Maximum Scale % | | Maximum Scale % |
| Bounciness before end of | Intermediate | Intermediate Value | Intermediate |
| input and/or during | Bounciness | | Bounciness |
| interaction | | | |
| Settling before end of | Intermediate | Intermediate Value | Intermediate |
| input and/or during | Settling | | Settling |
| interaction | | | |
| Bounciness after end of | Much Higher | Intermediate Value | Intermediate |
| input | Bounciness | | Bounciness |
| Settling after end of | Faster Settling | Intermediate Value | Intermediate |
| input | | | Settling |

TABLE 1B

| Parameter | Loupe | Liquid Lens | Menu |
|---|---|---|---|
| Examples | FIG. 5Z | FIGS. 5Z1-5Z4 and 6U | FIGS. 5V-5W |
| | | (e.g., user interface | |
| | | object 922-1 and | |
| | | selection indicator | |
| | | 6078) | |
| Size class (based on the | Small Size | Small Size | Large Size |
| minimum of height and | | | |
| width) | | | |
| Opacity of selection state | Higher Opacity | Higher Opacity | Lower Opacity |
| Opacity of indication of | Higher Opacity | Higher Opacity | Intermediate |
| attention in selection state | | | Opacity |
| Scaling on input start | Very Low | Very Low Scaling | Very Low |
| | Scaling | | Scaling |
| Scaling based on | Higher Scaling | Higher Scaling | Higher Scaling |
| movement (of the input) | | | |
| Scaling based on velocity | Lower Scaling | Lower Scaling | Intermediate |
| or acceleration (of the | | | Scaling |
| object) | | | |
| Amount of scaling up on | Much Higher | Higher Scaling | Much Lower |
| selection/hover | Scaling | | Scaling |
| Minimum scale during | Smaller | Smaller Minimum | Larger Minimum |
| movement | Minimum Scale % | Scale % | Scaling % |
| Maximum scale during | Larger | Larger Maximum | Smaller |
| movement | Maximum | Scale % | Maximum |
| | Scale % | | Scaling % |
| Bounciness before end of | Lower | Higher Bounciness | Higher |
| input and/or during | Bounciness | | Bounciness |
| interaction | | | |
| Settling before end of | Much Slower | Slower Settling | Faster Settling |
| input and/or during | Settling | | |
| interaction | | | |
| Bounciness after end of | Much Lower | Lower Bounciness | Intermediate |
| input | Bounciness | | Bounciness |
| Settling after end of input | Slower Settling | Slower Settling | Much Slower |
| | | | Settling |

Table 2 provides use cases for different types of user interface objects. The example column of Table 2 includes references to Figures that illustrate non-limiting examples of the respective type of the user interface object. As indicated in Table 2, each respective type of control is updated in response to detecting user interaction with the respective control according to the small/large variant parameters described in Table 1. For example, for a button type of control, the button behaves according to the small/large variant parameters outlined in Table 1A. For example, for a segmented control that includes a background portion (e.g., segmented control 920) and a selector portion (e.g., user interface object 922-1), the background portion behaves according to the small/intermediate/large variant parameters (e.g., columns 2-4) in Table 1A, while the selector portion behaves according to the liquid lens column in Table 1B. In some embodiments, a loupe type of user interface object is adjusted according to the parameters provided in the loupe column of Table 1B and a menu type of user interface object behaves according to the parameters indicated by the menu column in Table 1B.

TABLE 2

| | | Small/Large | | Liquid | |
|---|---|---|---|---|---|
| Use Case | Examples | Variant | Loupe | Lens | Menu |
| Segmented | FIGS. 5Z1-5Z4 (920, | Background | | Selector | |
| Controls | and/or 922) | (920) | | (922) | |
| Buttons | FIG. 5N-5Q (724, | x | | | |
| | 725, 726, 738, 740, | | | | |
| | 732, 5016, and/or 752) | | | | |
| Navigation bars | FIGS. 6D-6H (6200, | x | | | |
| | 6204, 6300, and/or | | | | |
| | 6304) | | | | |
| Toolbars | FIGS. 5R (810) and | x | | | |
| | 6AO-6AP (6800) | | | | |
| Sidebars | FIGS. 5D-5E (543) | x | | | |
| Tab bars | FIG. 6U-6AN (6074, | Background | | Selector | |
| | 6078, and/or 6730) | (6074) | | (6078, | |
| | | | | 6730) | |
| Menus | FIGS. 5V-5Y (816) | | | | X |
| Edit menus | Similar to FIGS. 5V- | x | | | |
| | 5W but with editing | | | | |
| | controls | | | | |
| Sheets | FIGS. 5F-5G, and/or | x | | | |
| | 6B | | | | |
| Popovers | FIGS. 6I-6J (6404) | x | | | |
| Alerts | FIG. 5AF (1124′) | x | | | |
| Text Loupe | FIG. 5Z (909 and/or | | x | | |
| | 912) | | | | |
| Controls | FIG. 5AA (1004) | | | x | |
| (Sliders/switches) | | | | | |
| Web Browser | | x | | | |
| (custom buttons) | | | | | |
| Messages | | x | | | |
| (custom buttons, | | | | | |
| tapback bubbles) | | | | | |
| Passcode UI | | x | | | |
| System Control | FIGS. 6K-6R | x | | | |
| User Interface | (displayed controls) | | | | |
| Phone dial pad | | x | | | |
| Buttons in media | | x | | | |
| player | | | | | |
| Picture in | | x | | | |
| Picture (custom | | | | | |
| buttons) | | | | | |

FIG. 5Z illustrates stretching and squishing behavior of a user interface element 912 (e.g., including user interface element 912-1, user interface element 912-2, and user interface element 912-3). In some embodiments, a user interface 906-1a includes text and an indictor 908 that indicates a current cursor position in the user interface 906-1a. In some embodiments, user interface 906-1b follows, in sequence, user interface 906-1a and includes displaying a user interface element (e.g., loupe 909-1) with a first set of simulated visual properties. For example, the loupe 909-1 appears as a flat user interface object that overlays the text illustrated in user interface 906-1b. In some embodiments, the user interface 906-1c follows, in sequence from, user interface 906-1b and illustrates that loupe 909-1 is displayed as gradually increasing in a simulated thickness as loupe 909-2. For example, in some embodiments, the sequence of user interfaces 906-1a through 906-1c illustrates an animated transition in which the loupe 909-2 is displayed as increasing in thickness to be displayed with a simulated glass material with non-zero thickness (e.g., whereas loupe 909-1 optionally is not displayed with a simulated thickness). In some embodiments, the user interface element 912 is a loupe that is used to magnify portions of the text corresponding to the current cursor position. For example, a user input 910-1 (e.g., a touch and hold input or other selection input) is detected as being directed to the indicator 908, and in response to detecting the user input 910-1, the current cursor position moves in accordance with movement of the user input 910-1. For example, the user input 910-1 continues as user input 910-2, including moving the indicator 908 (e.g., and the cursor position) to the portion of the text between the “v” and the “e” in “over.” In some embodiments, the user interface element 912-1 is displayed to include a magnified version of the portion of the text around the current cursor position. For example, in the user interface 906-2, the word “over” is displayed and a magnified indicator 914 that indicates the current cursor position are displayed within the user interface element 912-1. In some embodiments, the user interface element 912 is displayed with a simulated glass material that refracts background content (e.g., text and indicator 908) that is positioned under the user input 910-2. For example, the edges of the user interface element 912-1 include refracted portions 916 of the indicator 914.

In some embodiments, a shape of the user interface element 912 is distorted based on a direction, velocity, acceleration and/or jerk of the user input. For example, in the user interface 906-3, the user input 910-3 moves to the left (e.g., as a continuation of the user input 910-2), and the user interface element 912-2 is stretched (e.g., increases in size) in the horizontal direction and squished (e.g., decreases in size) in the vertical direction, as indicated by the arrows shown below the user interface 906-3. In some embodiments, as illustrated in the user interface 906-4, the shape of the user interface element 912-3 is distorted by stretching in the vertical direction and squishing in the horizontal direction, as indicated by the arrows below the user interface 906-4, in response to the user input 910-4 moving in the vertical direction (e.g., user input 910-4 moves downward as a continuation of the user input 910-3). As such, the distorted shape of the user interface object 912-3 is based on the direction of the input 910-4. It will be understood that in some embodiments, an amount of distortion is based on a velocity, acceleration and/or jerk of the user input (e.g., with a greater amount of distortion (e.g., more stretching and/or squishing) of the user interface object for a user input with a greater velocity, acceleration and/or jerk (e.g., the second derivative of velocity with respect to time) movement, or vice versa). In some embodiments, the user interface element 912 is stretched and/or compressed based at least in part on the direction of movement of the user input and/or a language setting of the device 100. For example, for a language setting in a language that reads from left to right, a user input that includes movement from left to right causes the user interface element 912 to stretch in the horizontal direction, while a user input that includes movement from right to left causes the user interface element 912 to compress (e.g., or to stretch by a lesser amount than the amount of stretching in response to the left to right movement) in the horizontal direction. Similarly, if the language setting of the device 100 is set to a language that reads from right to left, a user input that includes movement from right to left causes the user interface element 912 to stretch in the horizontal direction, while a user input that includes movement from left to right causes the user interface element 912 to compress (e.g., or to stretch by a lesser amount than the amount of stretching in response to the left to right movement) in the horizontal direction. In some embodiments, the behaviors described with reference to FIG. 5Z are used for selecting text (e.g., highlighting portions of text), for example, instead of displaying a single loupe, at least two selection endpoint pins are displayed within the user interface element 912. For example, in some embodiments, in accordance with a determination that the user input 910-1 is a drag user input or another type of user input that includes movement, the device 100 selects a portion of the text based on the movement of the user input 910-1.

FIGS. 5Z1-5Z3 illustrate a sequence of user interfaces for changing a selected object in a menu. In some embodiments, a menu, such as segmented control 920, is displayed with a simulated glass material that appears to overlay content in the user interface. For example, in FIG. 5Z1, the segmented control 920 includes options for organizing photos in a photos application according to Years, Months, or All photos. In some embodiments, the currently selected option is visually distinguished from the other possible options in the segmented control 920, for example, while “All” is selected, “All” is displayed with a different color, size, and/or otherwise visually emphasized relative to the other options (e.g., “Years” and “Months”). In some embodiments, the device 100 displays a user interface object 922-1 with a simulated material, for example, a simulated glass material that appears to overlay the “All” option while “All” is the selected state. In some embodiments, in response to detecting a user input 924-1, such as a tap input, a tap and hold input, a drag input (e.g., continued as user input 924-2), or other selection user input that is directed to the user interface object 922-1, the device 100 displays a change in the simulated thickness of the user interface object 922-1 and/or a change in shape of the user interface object (e.g., where user interface object 922-2 is morphed based on a direction of the user input 924-1, as described with reference to platter 816 in FIGS. 5V-5Y), as illustrated by user interface object 922-2 (e.g., in FIG. 5Z2). In some embodiments, displaying a change in the simulated thickness of the user interface object 922-1 includes changing a visual intensity that simulates a strength of simulated refraction applied to content that appears behind the user interface object 922-2. For example, the underlying content under the user interface object 922-2 appears to be warped or otherwise distorted by a greater amount to simulate a thicker simulated material of the user interface object 922-2 relative to the thickness of the simulated material of the user interface object 922-1. In some embodiments, a size of the user interface object 922-1 is increased, for example, by changing a boundary of the user interface object illustrated as user interface object 922-2 to cover a larger portion of the background content.

In some embodiments, the user input 924-2 continues to move to the left to change the selection state from “All” to “Months,” as illustrated in FIG. 5Z3 following the user interface in FIG. 5Z2. In some embodiments, in response to detecting an end of the user input 924-2, such as liftoff of a contact corresponding to the movement and/or detecting that the user input 924-2 has ceased moving, the “Months” option is selected and the user interface object 922-3 is displayed to appear with a thinner simulated material (e.g., the level of warping and/or distortion of the underlying content “Months” results in the user interface object 922-3 appearing thinner than the user interface object 922-2). In some embodiments, the selection of a respective selection state is snapped into position in accordance with a determination that the user interface object 922-3 has moved to within a threshold distance of the “Months” option. In some embodiments, after the user interface object 922-3 has snapped to the selection state of “Months,” in response to detecting a user input with a larger amount of movement than the user input 924-2 (e.g., in an opposite direction than the user input 924-2), the user interface object 922-3 moves to the right to reselect “All” by snapping back into position over the “All” option. In some embodiments, if the user input does not include a larger amount of movement than the user input 924-2, the user interface object 922-3 does not move to snap to the “All” option (e.g., it requires a greater amount of movement of a user input to return to the “All” selected state after changing the selection state from “All” to “Months” than the amount of movement of the user input to change the selection state from “All” to “Months”).

FIG. 5Z4 provides an example of a simulated side view of the user interface object 922 as the user interface object 922-1 is updated to user interface object 922-2 and user interface object 922-3, as illustrated by the sequence of user interfaces in FIGS. 5A1-5Z3. For example, the z-axis represents a level of simulated depth of the user interface object 922 relative to the segmented control 920. In some embodiments, in addition to increasing a simulated depth of the user interface object 922-2 (e.g., to appear as a thicker version of the simulated user interface material), the user interface object 922-2 optionally is also simulated as being situated farther away from (e.g., increasing a simulated z-distance from) the segmented control 920, as illustrated in FIG. 5Z4, before the user interface object 922-3 is displayed with the simulated thinner version of the user interface material that appears closer (e.g., in z-distance) to the segmented control 920.

FIG. 5AA illustrates an example of transitioning content from a background layer (e.g., also referred to herein as a content layer) to a glass layer that appears to be situated above (e.g., relative to the z-axis) the background layer. In some embodiments, a toggle 1002-1 is displayed in a user interface. For example, toggle 1002-1 is a selectable user interface element that is used to turn an option on and/or off. In some embodiments, toggle 1002-1 includes a switch 1004-1 that moves left and/or right (e.g., corresponding to turning toggle 1002-1 on and/or off). In some embodiments, in response to detecting a user input 1003 directed to the switch 1004-1, the device 100 updates the switch 1004-1 to a simulated glass material switch 1004-2 that appears to have a first distance (e.g., in the z-direction) between the underlying toggle 1002-1 and the switch 1004-2, and the simulated glass material of switch 1004-2 casts a simulated shadow on the background layer (e.g., including on toggle 1002-1). In some embodiments, the device 100 displays an animated transition that increases a size of the switch 1004-2 (e.g., illustrated with the increased size as switch 1004-3), including increasing a size of the switch along the x- and y-axes and optionally increasing a simulated thickness of the switch 1004-2, and increases the simulated distance between the underlying toggle 1002-1 and the switch 1004-3 to a second distance (e.g., in the z-direction) that casts a larger simulated shadow (e.g., to reflect the larger distance between the background layer and the simulated glass material). In some embodiments, the animated transition continues by shrinking the switch down to switch 1004-4 and pushing the switch 1004-4 back into the background layer (e.g., where switch 1004-4 is no longer displayed with the simulated glass material).

FIG. 5AB illustrates an animated transition that includes gradually reducing and/or increasing a thickness of simulated glass material in accordance with some embodiments. In some embodiments, a time indication 9:58 is displayed as simulated glass material in a wake screen user interface. In some embodiments, upon a change in time, the device 100 displays an animated transition for updating the time to the current time (e.g., from 9:58 to 9:59). In some embodiments, the animated transition includes gradually fading out the 8, including reducing a thickness of the top left corner of the 8 (e.g., at step 1102-2 through 1102-3) without reducing a thickness of the remaining portion of the 8. In some embodiments, the thickness of the simulated glass material is reduced to infinitesimally small such that the top left portion of the 8 disappears from display. In some embodiments, this animated reduction in thickness of the simulated glass material gradually moves down the 8, for example in step 1102-5 and 1102-6, a thickness of the lower portion of the 8 decreases in size before disappearing in step 1102-7.

In some embodiments, an animation for materializing the 9 is displayed by gradually increasing a thickness of simulated glass material in the shape of the 9. In some embodiments, the animation begins at a middle position of the 9, as illustrated in step 1102-8, where the 9 appears to be drawn in (e.g., from the center into a clockwise circle before moving downward to create the 9 shape). In some embodiments, the thickness of the middle position of the 9 increases over time and the rest of the 9 appears to be drawn in. In some embodiments, the animation for removing the 8 is performed gradually following a path in which drawing in the 8 would occur (e.g., or in an opposite path of a stroke to draw in an 8).

In some embodiments, the animated transition of the 8 disappearing and the 9 materializing at least partially overlap. For example, although the example shown in FIG. 5AB illustrates that the 8 disappears before the 9 begins to materialize, in some embodiments, the 8 is in progress of disappearing while the 9 begins to materialize (e.g., step 1102-6 overlaps with step 1102-8).

FIG. 5AB further illustrates a thickness of the simulated glass material over time represented by steps 1102-1 through 1102-12. For example, the 8 is displayed with a first thickness of simulated glass material before the transition begins and the thickness gradually decreases along the curve until the thickness of the simulated glass material is zero (e.g., the 8 disappears completely) and the thickness of the simulated glass material gradually increases along the curve (e.g., to materialize the 9) until the thickness of the simulated glass material returns to the first thickness for displaying the 9. It will be understood that this decrease and increase in thickness is not uniformly applied to the 8 and/or 9. For example, the change in thickness is applied to a top right portion of the 8 without changing a thickness of the top left portion and/or the bottom portion of the 8 in step 1102-2, and over time, the change in thickness (e.g., that follows the pattern provided by the graph) is applied to the top left portion and further down the 8 (e.g., in steps 1102-5 and 1102-6).

In some embodiments, one or more other visual effects are applied to the simulated glass material, such as a simulated light effect (e.g., specular highlights 1108-1 through 1108-12). In some embodiments, the specular highlights 1108-1 through 1108-12 appear to travel along an edge of the 8 and/or 9 as the 8 and/or 9 are transitioned to disappear and/or appear.

In some embodiments, the visual effect of specular highlight(s) simulates light from other content displayed in the user interface reflecting from the edges of the time numeral (e.g., 8 and/or 9 in FIG. 5AB). In some embodiments, the specular highlight(s) are based on one or more simulated light sources and/or one or more physical light sources in a physical environment surrounding the device 100. In some embodiments, the device 100 changes the simulated lighting effect by changing position, orientation, size, brightness, and/or other visual property of the simulated lighting effect. In some embodiments, the specular highlights are updated based on a change in the time numeral(s). For example, the specular highlights appear to travel around an edge of the time numeral as the time numeral appears and/or disappears. For example, as the 9 numeral appears, the specular highlights appear to travel along the edge of the 9 in a path that follows the path of the simulated glass material that appears.

FIG. 5AC illustrates an example of an animated transition for changing the time indication from 9:58 to 9:59 (e.g., a minute-based transition) over time represented by steps 1104-1 through 1104-8 that changes a thickness of the simulated glass material of the numerals, as described above with reference to FIG. 5AB. In some embodiments, the thickness of the simulated glass material is displayed view the side view illustrated in FIG. 5AC. For example, at step 1104-1, the entirety of the 8 is displayed with a first amount of thickness. At step 1104-2, a bottom portion of the 8 that has disappeared is displayed with no amount of thickness, and the remaining part of the 8 is displayed with a varying amount of thickness that varies according to the curve shown in the side view (e.g., the top most portion of the 8 remains with the greatest amount of thickness whereas the middle portion of the 8 that is about to disappear has a smaller amount of thickness). Similarly, the 9 materializes gradually such that the initial lower portion of the 9 in step 1104-5 is displayed with a small amount of thickness that gradually increases in thickness as more of the 9 materializes. In some embodiments, changing a simulated thickness of a simulated glass material changes the various properties such as blur, refraction, reflection, and/or specular highlights. When the simulated thickness gradually changing also causes gradual changes to blur, refraction, reflection and/or specular highlights that vary spatially as the simulated thickness varies spatially.

FIG. 5AD illustrates an example of an animated transition for changing the time indication from 9:59 to 10:00 (e.g., an hour-based transition) over time represented by steps 1106-1 through 1106-8. In some embodiments, the animated transition includes changing the hour numeral(s) concurrently with changing the minute numeral(s). In some embodiments, the transition of the hour numeral(s) is completed in an opposite direction (e.g., up, down, left and/or right) from the transition of the minute numeral(s). In some embodiments, a direction of the transition of the time numerals is based on whether the time numerals are counting upward or downward (e.g., counting up from 9 to 10 causes the time numeral to removed starting from a bottom portion of the numeral(s) and counting down from 59 to 00 causes the time numeral(s) to be removed starting from a top portion of the numeral(s)). For example, the minute numeral(s) appear to disappear starting from the bottom and materialize from the bottom, while the hour numeral(s) are displayed as disappearing and materializing from the top. In some embodiments, the time separator (e.g., “:”) is animated to disappear and materialize with the hour numeral(s). In some embodiments, the time separator (e.g., “:”) disappears with one or more of the minute numerals and reappears with one or more of the hour numeral(s). In some embodiments, the time separator (e.g., “:”) disappears with one or more of the hour numeral(s) and reappears with one or more of the minute numerals. In some embodiments, the time separator continues to be displayed whether the time transition is a minute-based transition or an hour-based transition.

In some embodiments, a method is performed at an electronic device (e.g., device 300, FIG. 3A, or portable multifunction device 100, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in the described method are, optionally, combined and/or the order of some operations is, optionally, changed.

FIGS. 5AE-5AG illustrate a sequence of user interfaces that include a time indication that is displayed with a simulated glass material. In some embodiments, the time indication 1122-1 is displayed with the simulated glass material described with reference to FIG. 5AB. In some embodiments, the time indication 1122-1 performs transitions to update the time according to the animations described with reference to the time represented by steps 1102-1 through 1102-12 in FIG. 5AB.

FIG. 5AE illustrates detecting a user input 1120, such as a tap and hold input, a drag input, or another type of user input, directed to the time indication 1122-1. In some embodiments, in response to detecting the user input 1120, a portion of the time indication 1120 that corresponds to a position of the user input 1120 is updated such that the simulated glass material of the user input 1120 appears to flatten (e.g., to appear to decrease in simulated thickness at the portion of the time to which the user input 1120 is directed, optionally without flattening other portions of the time). For example, the lower part of the 8 in time indication 1122-2 continues to be displayed with a same simulated amount of thickness as the lower part of the 8 in the time indication 1122-1, while the top right portion corresponding to the detected input 1120′ appears to have a smaller amount of simulated thickness. In some embodiments, the smaller amount of simulated thickness of the top portion of the 8 in the time indication 1122-2 is achieved by applying a smaller amount of refraction of the background content that is displayed under and/or near the time indication 1122-2. For example, the portion of the cloud that is refracted in FIG. 5AE appears with a greater level of refraction and/or distortion than the portion of the cloud that is refracted in FIG. 5AF, such that the portion of the cloud in the 8 appears with a smaller level of refraction. As such, adjusting the level of refraction applied to the content that appears through the simulated glass material of the time indication 1122-1 compared to the level of refraction applied to the content that appears through the simulated glass material of the time indication 1122-2 results in the portion of the 8 in time indication 1122-2 to have a smaller simulated thickness of the simulated glass material. In some embodiments, the levels of one or more other optical properties applied to the simulated glass material, such as blur level, tint level, edge bleed level, and/or levels of other properties (e.g., described with reference to FIGS. 6A-6B4), are altered to result in the appearance of the simulated glass material of at least a portion of the time indication 1122-2 appear to have a decreased thickness in FIG. 5AF compared to FIG. 5AE. In some embodiments, portions of the time indication 1122-2 that do not correspond to the position of the user input 1120′ are not altered to appear with a different simulated glass material (e.g., with a different thickness) as compared to the time indication 1122-1 (e.g., the simulated glass materials of the 5 and the lower portion of the 8 do not change in simulated thickness).

In some embodiments, in response to detecting the continuance of user input 1120 as user input 1120′, the portion of the time indication 1122-2 corresponding to the position of the user input 1120′ appears to spread out or bulge (e.g., as if pressing on the simulated glass material causes the glass material to expand outward optionally as it flattens). For example, the time indication follows the stretch and/or squish behavior described with reference to platter 816-1 through 816-5 and/or user interface element 912-1 through 912-3 (e.g., in FIGS. 5V-5Z). For example, the portion of the time indication 1122-2 that appears to spread out is displayed with a fluid and/or gel-like appearance that is displayed as increasing in area as the perceived thickness of the time indication 1122-2 is decreased (e.g., the area increases to maintain a perceived volume of the simulated glass material of the time indication 1122-2). In some embodiments, in response to detecting an end of the user input 1120′ (e.g., ceasing to detect the user input 1120′, such as in response to detecting liftoff of a contact corresponding to the user input 1120′), the device 100 displays a gradual animation that returns the simulated glass material of the time indication to have the visual properties (e.g., perceived thickness and/or shape) of the original simulated glass material (e.g., from the “8” with simulated glass material illustrated in FIG. 5AF to the “8” with simulated glass material illustrated in FIG. 5AE).

FIGS. 5AE-5AF illustrate a sequence of user interfaces for detecting arrival of a notification 1124 and increasing a simulated thickness of the simulated glass material of the notification 1124 over time. In some embodiments, the notification 1124 is initially displayed as being made with a simulated glass material having a first set of optical properties (e.g., a first level of distortion) that changes over time, for example, as illustrated by the updated notification 1124′ in FIG. 5AF. In some embodiments, the notification 1124 is initially not displayed with the simulated glass material (e.g., the notification 1124 appears to be in the content layer without applying one or more optical properties to make the notification 1124 appear to be simulated glass material). In some embodiments, the notification 1124′ is displayed as turning into the simulated glass material (e.g., and/or appearing to increase in simulated thickness of the simulated glass material). For example, in FIG. 5AF, adjusting the level of distortion (e.g., external refraction), level of blur, or other levels of visual properties, causes the notification 1124′ to appear with a thicker simulated glass material than the notification 1124. In some embodiments, the device 100 increases the simulated thickness of the simulated glass material of notification 1124 to a simulated thickness that is thicker than the steady-state (e.g., final) simulated thickness of the notification 1124′. For example, the notification 1124 is displayed as gradually increasing, from a first simulated thickness (e.g., to appear flat or close to flat) to a second simulated thickness (e.g., greater than the first simulated thickness), before gradually decreasing in thickness to a third simulated thickness (e.g., less than the second simulated thickness and greater than the first simulated thickness), where the notification 1124′ is maintained with the third simulated thickness until the notification 1124′ is dismissed or otherwise ceases to be displayed.

FIGS. 5AF-5AG illustrate a sequence of detecting that an orientation of the device 100 is changed from a portrait orientation to a landscape orientation. For example, in response to detecting (e.g., using one or more accelerometers 168 and/or gyroscopes) a change in a physical position (e.g., a change in orientation relative to gravity) of the device 100 that changes the orientation of the device 100, the device 100 displays an animated transition for rotating the wake screen user interface 1126. In some embodiments, the wake screen user interface 1126 includes one or more wake screen controls, such as flashlight control 1123a and/or camera control 1123b. In some embodiments, in response to detecting a user input (e.g., a tap input, a tap and hold input, and/or another selection input) directed to a respective wake screen control, the device 100 performs an operation associated with the selected respective wake screen control (e.g., in response to detecting a user input selecting the camera control 1123b, the device 100 displays a camera capture user interface, in response to detecting a user input selecting the flashlight control 1123a, the device 100 turns on a light on the device to use as a flashlight). In some embodiments, the animated transition includes maintaining the time indication 1122-3 and the time indication 1122-4 at relative positions that align to the horizon of the content displayed in the wallpaper of the wake screen user interface 1126.

FIG. 5AG illustrates that the time indication 1122-4 is displayed with a different size than the time indication 1122-3 (e.g., smaller in height and optionally in width) while the device 100 is in the landscape orientation. In some embodiments, the position of the time indication 1122-4 is maintained relative to the horizon of the content (e.g., and/or relative to a subject, a portion of a landscape, or another portion of the content) displayed in the wallpaper. For example, the bottom of time indication 1122-4 is displayed above the horizon line in FIG. 5AG, and the bottom of time indication 1122-3 is displayed at a same relative position to the horizon line in FIG. 5AF. In some embodiments, the time indication 1122-3 is stretched gradually into time indication 1122-4 (e.g., and/or vice versa), over time, in a manner that simulates physical properties, such as stretching the time indication with some resistance, inertia, deformation, and/or elasticity (e.g., as described above with reference to FIG. 5U1 where platter 814-3 is stretched non-uniformly based on one or more simulated material properties of the simulated glass material).

FIGS. 6A-6C (including FIGS. 6A, 6B1, 6B1-a, 6B1-b, 6B2, 6B2-a, 6B2-b, 6B3, 6B4, 6B4-a, 6B5-6B13, and 6C) are illustrative representations, rules, parameters, examples, and variations of an exemplary process for generating an appearance of a user interface object that is visually associated with a user interface material (e.g., user interface object 6004, user interface object 6036, and/or another user interface object that is visually associated with a user interface material, as described in this disclosure) that simulates optical interactions with internal content, external content, and/or the environment, in accordance with some embodiments. In some embodiments, the exemplary process is used to generate the appearance of the user interface object that also simulates spatial properties and/or material properties of the user interface material as they impact the simulated optical properties and simulated spatial properties of the user interface material. In some embodiments, the appearance of the user interface object is adjusted to simulated changes in the simulated spatial properties, simulated optical properties, and/or simulated material properties, to provide visual feedback to changes in system states, user inputs, and/or to provide information, indications, visual cues, and/or guidance to the user regarding the system states, available operations, and/or required inputs of the computer system in association with the user interface object.

In the examples used in FIGS. 6A-6C, the user interface material has a so-called “glassy” appearance that simulates transmission, refraction, diffusion, absorption, and/or reflection of light and illumination from the physical environment and/or from internal content, external content, and/or nearby virtual environment, in accordance with various embodiments. In some embodiments, the term “glassy” refers to a property of the user interface material that allows the appearance of the underlying content to influence the appearance of the user interface material, as if the user interface material is fully or partially transparent to light. In addition, in some embodiments, the “glassy” material also deforms underlying content and internal content to simulate a change in refraction in the user interface material that appears to bend light that pass through the simulated surfaces of the user interface material. In some embodiments, the simulated refraction in the user interface material is not only based on the appearance of a portion of the underlying content that directly underlies the user interface material (e.g., via simulated internal refraction), but also based on the appearance of a portion of the underlying content that is outside of the simulated surface of the user interface material but within a refraction-threshold distance from the simulated surface of the user interface material (e.g., via simulated external refraction). In some embodiments, in additional to simulated refraction of underlying content located outside of the user interface material, the appearance of the user interface material also simulates refraction of internal content that is located within the user interface material. In some embodiments, the simulated internal refraction is based on the appearance of the internal content and includes deformation and color separation of a portion of the internal content that is near the edge portion of the user interface material where the user interface material has a curvature or change in simulated thickness. In some embodiments, the appearance of the user interface material further simulates other optical effects, such as transmission of virtual and/or physical light and/or illumination through a tinted translucent or transparent material (e.g., via a tint of the user interface material), specular reflection of virtual and/or physical light from outside of the user interface material (e.g., via one or more specular highlights), diffusion and reflection of virtual and/or physical light from outside of the user interface material (e.g., via a simulated sheen and/or simulated edge bleed), diffusion and internal reflection of virtual light from within the user interface material (e.g., via simulated edge bleed), and/or blockage of virtual and/or physical light from outside of the user interface material (e.g., via a simulated shadow). In some embodiments, the parameters used to adjust the appearance of the user interface material include opacity, blur radius, dimming, color saturation, luminance boost, luminance reduction, maximum luminance cutoff, minimum luminance cutoff, and/or other parameters used in the various visual effects, and these parameters are adjusted (e.g., changed in value) to change how the user interface material responds (e.g., magnitudes of response as well as types of response) to changes in the appearance of the underlying content, internal content, and/or the environment. In some embodiments, the changes in the parameter values used in generating the visual effects are used to produced different types and/or variants of the user interface material (e.g., clear glass, tinted glass, frosted glass, dark glass, and/or other types of variations of the user interface material). Additional details regarding the various parameters of the user interface material are provided in Tables, 1, 2, and 3, and accompanying descriptions.

It is to be understood that, although the “glassy” appearance of the user interface material appears to simulate a physical process of light interaction between physical objects and materials, the usage of the “glassy” appearance of the user interface material in a user interface utilizes a familiar physical experience of the user to convey the spatial relationships between user interface objects within the displayed user interface, to provide efficient and intuitive visual feedback to the user regarding effects of user inputs, and/or to provide guidance regarding impending changes that would occur in light of the current state of the computer system and/or the user interaction that has been detected by the computer system.

It is to be understood that, the various parameters that are involved in the changing appearance of the user interface material, in some instances, have physical counterparts in the real world, and in many cases, are visual parameters that are designed to respond automatically to changes in conditions related to external inputs and internal states of the computer system (e.g., real-time changes, near-real-time changes, and/or cumulative changes over a period of time, in characteristic values of user inputs and/or in contextual conditions of the computer system). In some embodiments, the parameters are adjusted differently for different use case scenarios in order to provide better balance between competing concerns and benefits in the different use case scenarios. Various examples of relative parameter values are described in Tables 1, 2, and 3 and accompanying descriptions.

In some embodiments, the features described with respect to FIGS. 6A-6C are applicable to user interface materials and user interface objects that are visually associated with user interface materials, that are described with respect to other examples in the present disclosure. Although, sometimes not explicitly linked back to the user interface material described with respect to FIGS. 6A-6C, it is to be understood that, these features are fully available and can be combined with other features, e.g., features that are described with respect to simulated materials, user interface material, glassy materials, simulated optical interactions, simulated material interactions, and/or user interface objects and interactions therewith, as described in other examples and embodiments the present disclosure, unless explicitly stated otherwise.

In some embodiments, the process for generating the appearance of the user interface material and corresponding the appearance of the user interface object includes applying a plurality of image processing procedures, optionally, in a respective ordered sequence or in two or more parallel sequences, with corresponding sets of processing parameters for the plurality of image processing procedures, and, optionally, with modifications, exceptions, thresholding, and adjustments applied under various conditions. In some embodiments, the outputs of the different image processing procedures are combined (e.g., by augmenting the output of another procedure, by overlapping and adding together the outputs of two procedures in portions corresponding to the same location, by overlaying and overriding the output of another procedure in portions corresponding to the same location, and/or by cutting out a portion of the output of one procedure at a location corresponding to the material and stitching the remaining portion of the output of the procedure to a portion of the output of another procedure that corresponds to the location of the material).

In some embodiments, unless explicitly stated, the example processes, rules, parameters, examples, and variations described with respect to FIGS. 6A-6C include procedures, rules, parameters, examples, and variations that are optional, and may include additional procedures, rules, parameters, examples, and variations, combination of procedures, rules, parameters, examples, and variations, sub-procedures of a described procedure, and/or modifications and variants of a described procedure, rule, parameter, example, and variation, depending on the requirements of various use case scenarios.

In some embodiments, one or more procedures described herein include adaptive parameters (e.g., blur radius, dimming, opacity, spatial distortion, color value, color separation, and/or boost and reduction in luminance, saturation, and/or specular response) that change parameter values based on an evaluation of the changes in one or more properties of the external environment and/or relevant content (e.g., underlying content, internal content, content directly underlying the user interface object, underlying multiple related user interface objects, and/or other portions of the user interface), and in turn produce gradual changes in the appearance of the user interface material that are not only based on the change in the appearance of the external environment and/or relevant content, but also based on the change in the parameter values of the image processing procedures used to generate the appearance of the user interface material. Additional details regarding relative values of the adaptive parameters of the user interface material are provided with respect to FIGS. 6B5-6B13, Tables 3A-3F, and method 19000.

In FIG. 6A, an exemplary stack 6108 of image processing procedures for generating the appearance of an exemplary user interface material (e.g., a “glassy” appearance, and/or another type of appearance that is based on simulated optical and/or material interactions between a user interface material and nearby content) is shown. The bottom-up order of the stack 6108 is indicative of the order that the image processing procedures is applied, in some embodiments. However, such an order may be subject to modification under some conditions, in some embodiments. In some embodiments, the different layers in FIG. 6A (e.g., underlying content 6003A, blur layer 6003B, internal refraction layer 6003C-1, external refraction layer 6003C-2, shadow layer 6003D, color matrices layer 6003E, edge bleed and sheen layer 6003F, tint VCM* (vibrant color matrix) layer 6003G, edge color matrix 6003H, internal content layer 6003I, lens layer 6003J, specular VCM* (vibrant color matrix) layer 6003K) may refer to a spatial distribution of pixel values that spans the size of the underlying content, beyond the immediate vicinity of the user interface object, may be used as an input for another procedure in the stack, may be defined by a set of parameters for a set of one or more image filters that are applied to an input that includes an entirety or a subset of another layer, may be reduced to a subset of a distribution of pixel values that corresponds to a respective location, and/or may be displayed directly as part of the appearance of the user interface object. More details of these different aspects of individual layers are provided below.

In some embodiments, the basis of the appearance of the user interface material includes the appearance of external content, including content that is directly behind the user interface material from the viewpoint of the user and content that is outside (e.g., adjacent and/or near) the edge of the user interface material. This content is referred to as “underlying content” or “underlying content layer” 6003A in FIG. 6A. The appearance of the user interface material simulates “refraction” of the underlying content 6003A caused by the simulated “glassy” property of the user interface material.

In some embodiments, underlying content 6003A includes various types of content that are potentially visually obscured by the presence of the user interface material due to the spatial arrangement between the region occupied by the user interface material and the region occupied by the underlying content, from the viewpoint of the user. For a two-dimensional user interface or pseudo-three-dimensional user interface, the underlying content is displayed in a display layer that underlies or is behind the display layer of the user interface material, and overlaps with the user interface material at the lateral location of the user interface material. For a three-dimensional environment, the underlying content is behind the user interface material and visually obscured by the user interface material from the current viewpoint of the user (e.g., along the line of sight of the user). In some embodiments, the underlying content includes text, images, user interface objects, controls, windows, pop-ups, wallpaper, video content, user interfaces, and/or other types of visible content. In some embodiments, the underlying content includes a view of a three-dimensional environment that includes content displayed at different depths from the viewpoint of the user. In some embodiments, the underlying content includes a representation of a physical environment of the computer system (e.g., a passthrough view, such as an optical passthrough view or camera passthrough view of the physical environment).

In some embodiments, the underlying content 6003A is based on a spatial distribution of pixel values that defines the appearance of the underlying content. In some embodiments, the pixel values for a pixel and/or a group of pixels at a respective location in the underlying content include a set of color values (e.g., RGB values, HEX values, HSL values, and/or HSLA values) and/or luminance values (e.g., brightness, gray values, luminance in RGB color space, and/or Y value in YIQ or YUV color spaces), for the pixel and/or group of pixels. In some embodiments, the pixel values of the underlying content for a respective location relative to the user interface material change in magnitudes when the underlying content changes appearance due to automatic progress animated transition and/or content playback, when the underlying content is scrolled, resized, and/or shifted relative to the display and/or the user interface material, and/or when the user interface material is resized, reshaped, and/or moved.

In an illustrative example, the underlying content 6003A, as shown in FIG. 6B1, includes three main regions—a light colored top portion 6032 (e.g., white background, or a background with high luminance values), a medium lower left portion 6034 (e.g., patches of different shades of gray, or other colors with various medium level luminance values), and a dark lower right portion 6036 (e.g., dark background, or a background with low luminance values). In some embodiments, the underlying content 6003A includes colored content, such as various shades and tints of reds, yellows, blues, greens, and/or other secondary and tertiary colors (e.g., as shown in the example in FIGS. 6B1-b, 6B2-b, and 6B4-a). In addition, in some embodiments, the underlying content includes text, image, and user interface elements overlaying the different main regions (e.g., text 6008 overlaying portion 6032, image of mountain overlaying portion 6034, and control 6012 overlaying portion 6036). In this example, the underlying content 6003A appears to be in a single display layer and in the same user interface. In some embodiments, the underlying content optionally includes content from different display layers and/or different visual and/or virtual depths from the viewpoint of the user, and is, optionally, flattened into a single layer to serve as the basis of the subsequent image processing procedures (e.g., blur layer 6003B, or another layer).

Referring back to FIG. 6A, in some embodiments, when generating the appearance of the user interface material, the computer system first generates a blur layer 6003B based on the spatial distribution of raw pixel values of the pixels and/or groups of pixels in the underlying content 6003A. This blur layer 6003B includes a spatial distribution of modified pixel values of the pixels and/or groups of pixels in the underlying content 6003A, where the spatial distribution of modified pixel values is obtained by applying a gradient blur 6006 to the spatial distribution of raw pixel values of the underling content 6003A, in some embodiments. For example, as shown in FIG. 6B1, a user interface object 6004 is visually associated with the user interface material (e.g., the appearance of the user interface material is used to indicate the spatial extent of the user interface object, and the boundary of the user interface object 6004 is used to define the spatial extent of the user interface material). In FIG. 6B1, the outline of the user interface object 6004 is a rectangle with rounded corners and straight edges, against the backdrop of the underlying content 6003A. In some embodiments the gradient blur 6006 has intensity contours (e.g., contours of constant blur radii, and/or contours of constant reduction of opacity) with shapes that correspond to the outline of the user interface object 6004 against the underlying content 6003A. In some embodiments, intensity contours of the gradient blur 6006 have faster changes of intensity (e.g., are spaced closer together) near the outline of the user interface object 6004 to simulate faster changes in simulated thicknesses of the user interface material near the edge of the user interface object 6004. In some embodiments, a respective intensity contour and a region that is associated with the respective intensity contour corresponds to a respective blur radius, and the respective blur radius is used in blurring the portion of the underlying content 6003A that falls within the region associated with the respective intensity contour. In some embodiments, the result of the blurring procedure applied to the underlying content 6003A includes the spatial distribution of the modified pixel values for pixels and groups of pixels in the blur layer 6003B. In some embodiments, the intensity or blur radius of the blurring procedure gradually increases from an interior region of the user interface object 6004 toward the edge of the user interface object 6004 (e.g., reaching a local maximum at the outline of the user interface object 6004), and then gradually decreases going farther away from the edge of the user interface object 6004. For example, in some embodiments, the blur radius corresponding to intensity contour 6006-1 is greater than the blur radius corresponding to an intensity contour right outside of the edge of the user interface object 6004, the blur radius corresponding to intensity contour 6006-2 is smaller than the blur radius corresponding to an intensity contour right inside of the edge of the user interface object 6004. The blur radius corresponding to intensity contour 6006-3 is smaller than the blur radius corresponding to intensity contour 6006-2. It is to be understood that, although several separate intensity contours (e.g., 6006-1, 6006-2, and 6006-3) are shown in FIG. 6B1, the change in blur radius in the gradient blur is gradual and the transitions between the regions corresponding to different blur radii are, optionally, gradual transitions.

In some embodiments, the gradient blur 6006 is applied to the underlying content 6003A with a gradual change in opacity of the blur layer 6003B that reduces the visibility of the underlying content 6003A (e.g., to simulate a “frosted” look of the user interface material). In some embodiments, a gradient of opacity change is applied to the underlying content 6003A instead of the gradient blur 6006 to obtain the blur layer 6003B. In some embodiments, the change in opacity in the blur layer 6003B also has intensity contours that mimic the intensity contours of the change in blur radius. In some embodiments, the opacity has the greatest value (e.g., 100%, 95%, or another high value) along the outline of the user interface object 6004, and the opacity gradually decreases with increasing distances from the outline of the user interface object 6004. In some embodiments, the blur radius is zero or substantially zero at the center of the user interface object 6004. In some embodiments, the blur radius is a finite non-zero value in the interior region of the user interface object 6004 (e.g., within the intensity contour 6006-3). In some embodiments, the opacity is zero or substantially zero at the center of the user interface object. In some embodiments, the opacity is a finite non-zero value in the interior region of the user interface object 6004 (e.g., within the intensity contour 6006-3). In some embodiments, the change in the opacity and/or the change in the blur radius corresponds to the change in simulated thickness of the user interface material in the depth dimension of the user interface (e.g., greater simulated thickness corresponds to greater blur radius and/or greater obscuring strength of the opacity filter).

In some embodiments, the blur layer 6003B has a finite spatial extent outside of the outline of the user interface object 6004. In some embodiments, the shapes of the intensity contours, the spatial extent of the blur filter and/or opacity filter, the values of blur radius, the strengths of the opacity filter, the rate of change in blur radius, and/or the rate of change in the strength of the opacity filter, are adjustable parameters of the blur layer, and are adjustable based on changes in external lighting, orientation and/or movement of the computer system relative to the environment, characteristics of the underlying content (e.g., overall luminance and/or average luminance under the user interface material, and/or another characteristic luminance for a relevant portion of the underlying content), and/or relevant use case scenarios (e.g., the role played by the user interface object, such as being a control, an indicator, interactive content, non-interactive content, moving, remaining stationary, and/or other relevant factors, such as those listed in Tables 1, 2, and 3).

In the example shown in FIG. 6B1, on the outside of the outline of the user interface object 6004, a portion of the underlying content (e.g., the text “Control.” and the outer edges of the mountain image and the dark background) that is more than a threshold distance (e.g., blur-threshold distance) away from the outline of the user interface object 6004 is not blurred (e.g., the blur radius is zero at this distance); a portion of the underlying content (e.g., the lower portions of the text “Touch. Zoom.” and the lower portion of the mountain image, and a portion of the circular control 6012 and its nearby dark background) that is within the threshold distance away from the outline of the user interface object 6004 is blurred and made less visible (e.g., through application of a blur filter and/or opacity filter). Similarly, within the outline of the user interface object 6004, the underlying content is blurred to different degrees and/or obfuscated to different degrees by a blur gradient and/or an opacity gradient (e.g., increasing blur and/or opacity with increasing distance from the outline of the user interface object 6004). For example, the text “Click. Quick.” is blurred by a greater degree and make less visible in the lower portion, closer to the center of the user interface object 6004, as compared to the upper portion, farther away from the center of the user interface object 6004. In FIG. 6B1, the portion of the blur layer that corresponds to a blurred portion of the text 6008 is denoted as text 6008*; the portion of the blur layer that corresponds to a blurred portion of the region 6032 is denoted as region 6032*; the portion of the blur layer that corresponds to a blurred portion of the region 6034 is denoted as region 6034*; the portion of the blur layer that corresponds to a blurred portion of the region 6036 is denoted as region 6036*; and the portion of the blur layer that corresponds to a blurred portion of the vertical bar 6010 is denoted as bar 6010*.

In some embodiments, the blur layer 6003B shown in FIG. 6B1 is used as basis for several visual effects, including the simulated refraction layers 6003C (e.g., internal refraction layer 6003C-1 and/or external refraction layer 6003C-2), the simulated shadow layer 6003D, and/or the simulated edge bleed and sheen layer 6003F. In some embodiments, the blur layer 6003B as a whole and/or cropped portions of the blur layer 6003B (e.g., at locations corresponding to the user interface material, and/or at locations corresponding to the simulated shadow) are provided as input to the layers corresponding to additional visual effects, and used to generate the intermediate and/or final appearances of the user interface material. In some embodiments, the appearance of the blur layer 6003B is not directly displayed as part of the user interface object 6004. In some embodiments, the computer system displaying the user interface object 6004 may not have the capability to display the “glassy” appearance of the user interface material as described herein, and/or is configured to forgo displaying the “glassy” appearance when certain conditions are met (e.g., conditions based on power usage configuration, device condition, and/or other usage scenarios), and the appearance of the blur layer 6003B is optionally used (e.g., with or without adjustment in terms of blur radius, opacity, color saturation, and/or luminance) as a simpler substitute for the “glassy” appearance of the user interface material. In some embodiments, the appearance of the blur layer 6003B simulates transmission and diffusion of the underlying content 6003A by the user interface material of the user interface object 6004.

Referring back to FIG. 6A, after the blur layer 6003B is generated based on the underlying content 6003A, the spatial distribution of modified pixel values in the blur layer 6003B is used to generate simulated refraction of the underlying content 6003A. In some embodiments, the simulated refraction 6003C includes different amounts of spatial displacement of the pixel values at different locations within and/or near (e.g., outside of and adjacent to) the outline of the user interface object 6004. In some embodiments, the amount of spatial displacement of the pixel values corresponds to an intensity of simulated refraction (e.g., simulating the change in simulated refractive index of the user interface material and/or the change in the power of the user interface material to “bend” light). In some embodiments, the intensity of simulated refraction is indicative of a rate of change in simulated thickness of the user interface material (e.g., increasing rate of change in simulated thickness near the edge of the user interface object 6004). As shown in FIG. 6B1, the simulated side view 6014 of the user interface material corresponding to the user interface object 6004 shows that the simulated thickness of the user interface material gradually tapers off in an edge region of the user interface material, with increasing rate of change in simulated thickness, which corresponds to an increasing change of simulated refraction, closer to the bottom edge of the user interface material. This increase in intensity of the simulated refraction is visually illustrated in FIG. 6B1 by the amount of warping applied to the portion of the vertical bar 6010 within the outline of the user interface object 6004, with a greater amount of warping (e.g., shown in the refracted representation 6010′ of the vertical bar 6010) near the outline of the user interface object 6004, and a smaller amount of warping away from the outline of the user interface object 6004.

Referring back to FIG. 6A, in some embodiments, the simulated refraction 6003C includes three parts, respectively labeled as internal refraction region 6003C-1, external refraction region 6003C-2, and combination region 6003C-3. In some embodiments, the internal refraction region 6003C-1 is based on a portion of the blur layer 6003B that is included entirely within the outline of the user interface object 6004, up to the outline of the user interface object 6004; the external refraction region 6003C-2 is based on a portion of the blur layer 6003B that is entirely outside the outline of the user interface object 6004, up to the outline of the user interface object 6004; and the combination region 6003C-3 includes an overlap region of a small width of several pixels (e.g., 3 pixels, 5 pixels, 10 pixels, or another small number of pixels) between the internal refraction region 6003C-1 and external refraction region 6003C-2 along the outline of the user interface object 6004. In some embodiments, the appearance of the internal refraction region 6003C-1 is entirely based on the appearance of a portion of the underlying content 6003A that is within the outline of the user interface object 6004, and completely behind the user interface material of the user interface object 6004. In some embodiments, the appearance of the external refraction region 6003C-2 is entirely based on the appearance of a portion of the underlying content 6003A that is outside the outline of the user interface object 6004, and has a visible representation outside of the user interface material of the user interface object 6004. In some embodiments, the appearance of the combination region 6003C-3 is based on the appearance of some portion of the underlying content 6003A that is within the outline of the user interface object 6003A and some portion of the underlying content 6003A that is outside the outline of the user interface object 6004 (e.g., due to the mixing effect of the gradient blurring used to generating the blur layer 6003B near the outline of the user interface object 6004).

Referring back to FIG. 6B1, the simulated refraction 6003C of the underlying content 6003A (e.g., applied to blur layer 6003B), has changing intensities near the outline of the user interface object 6004 (e.g., increasing intensities to simulate increasing rate of change in simulated thickness, and/or decreasing intensities to simulate decreasing rate of change in simulated thickness), and results in varying amounts of spatial displacement of pixel values in the portion of underlying content near the outline of the user interface object 6004 (e.g., warpage of straight lines in the underlying content, such as in warped bar 6010′, warped boundary between the upper portion 6032′ and lower left portion 6034 of the underlying content 6003A, warped boundary between the upper portion 6032 and lower right portion 6036 of the underlying content 6003A).

In some embodiments, as shown in FIG. 6B1, a portion of the simulated refraction 6003C is based on a portion of the underlying content that is located entirely outside of the outline of the user interface object 6004. For illustrative purposes, the lower portion of the text 6008 (e.g., the text “Touch, Zoom.”) in the upper portion 6032 of the underlying content 6003A has a corresponding refracted representation 6008′-2 (e.g., a simulated external refraction of the portion of the text 6008) within the outline of the user interface object 6004. This refracted representation 6008′ is generated by displacing the locations of the pixel values of the portion of the underlying content that is within a refraction-threshold-distance from the outline of the user interface object 6004, which pulls the portion of the underlying content into the outline of the user interface object (e.g., into the external refraction region 6003C-2) as well as warping the portion of the underlying content. It is to be understood that the amount of displacement and/or strength of the external refraction is exaggerated, and in a typical embodiment, the refraction-threshold distance would be smaller than that shown in FIG. 6B1, and more in line with the example shown in FIGS. 6B1-a and 6B1-b.

In some embodiments, as shown in FIG. 6B1, a portion of the simulated refraction 6003C is also based on a portion of the underlying content 6003A that is located entirely within the outline of the user interface object 6004. For illustrative purposes, the interior portion of the underlying content 6003A that includes a portion of the text 6008 (e.g., the text “Click. Quick.”), the interior portions of the boundaries between the portions 6032, 6034, and 6036, the top of the mountain image in the portion 6034, has corresponding refracted representations (e.g., representation 6008′-1, and refracted representations of interior portions of the regions 6032, 6034, and 6036) within the outline of the user interface object 6004. These refracted representations are generated by displacing the locations of the pixel values of these portions of the underlying content, which optionally includes stretching the portions of the underlying content toward the interior of the outline of the user interface object 6004 (e.g., within the internal refraction region 6003C-2) as well as warping some of the portions of underlying content within the edge portion of the user interface object 6004.

In some embodiments, as shown in FIG. 6B1, a portion of the simulated refraction 6003C is based on a combination or mixture of a portion of the underlying content that is located within the outline of the user interface object 6004 and a portion of the underlying content that is located outside of the outline of the user interface object 6004. For illustrative purposes, a portion 6008′-3 of the refracted representation of the portion of the background 6032 that is between the text “Touch. Zoom” and the text “Click. Quick.” is based on both pixels within the outline of the user interface material and pixels outside the outline of the user interface material (e.g., is within the combined refraction region 6003C-3). For illustrative purpose, a portion of the control 6012 near the right edge of the user interface object 6004 has a refracted representation (e.g., representation 6012′) within the outline of the user interface object 6004. These refracted representations are generated by displacing the locations of the pixel values of the blur layer 6003B at these locations, which optionally pulls the portions of the underlying content into the outline of the user interface object 6004 (e.g., into the combined region 6003C-3) as well as warping some of the portions of underlying content within the edge portion of the user interface object 6004.

In some embodiments, the intensity of simulated refraction 6003C (e.g., as reflected in the amount of displacement of modified pixel values in the blurred layer 6003B) is independent of the intensity of blur (e.g., corresponding to the magnitude of blur radius and/or strength of simulated diffusion of the simulated material) and/or the intensity of opacity filter (e.g., corresponding to the simulated transmissivity or transparency of the simulated material) used to generate the blur layer 6003B. In some embodiments, the intensity of simulated refraction is used to indicate a rate of change in simulated thickness of the user interface material, which may be greater near the edges of the user interface material and less toward the center of the user interface material. In some embodiments, the intensity of simulated refraction is greater in regions that is blurred less and/or that is more transparent (e.g., created with a low opacity filter or without an opacity filter on the underlying content or the blurred underlying content), to simulate a “clear glass” appearance of the user interface material. In some embodiments, stronger simulated refraction is implemented in the simulated refraction layers 6003C, by distorting the content appearance of the underlying content by greater amounts, to simulate a higher refractive index of the user interface material (e.g., to indicate a different object type of the user interface object 6004, to indicate an overall increase in simulated thickness of the user interface material, to provide visual feedback to user input directed toward the user interface object, and/or to reduce visual distraction of the underlying content).

In some embodiments, the output of the simulated refraction of the underlying content is cropped based on the outline of the user interface object 6004, to produce the spatial distribution of pixel values and/or intermediate pixel values (e.g., pixel values to be used as input for additional layers of the stack) for the appearance of the user interface material within the user interface object 6004. In some embodiments, the underlying content 6003A includes a cutout region corresponding to the user interface object 6004, and the spatial distribution of pixel values corresponding to the user interface material is filled into or overrides the cutout region to produce the overall appearance of the user interface containing the underlying content 6003A and the user interface object 6004, optionally, subject to modifications of additional visual effects described herein.

FIG. 6B1-a shows an example analogous to that shown in FIG. 6B1. In FIG. 6B1-a, the top row shows the effect of simulated internal refraction 6003C-1 applied to the background 6003A (e.g., without applying a blur first), in accordance with some embodiments. This illustrates that the internal fraction displaces underlying pixel values spatially away from the outline of the user interface object 6004, toward the center of the user interface object, where a greater amount of displacement corresponds to a greater rate of change in simulated thickness of the user interface material (e.g., near the edge of the user interface object 6004, as shown in the side view 6014 in FIG. 6B1). The different degrees of displacement also warp line 6010 (e.g., represented by refracted representation 6010′) near the edge of the user interface object 6004.

In FIG. 6B1-a, the middle row shows the effect of simulated external refraction 6003C-2 applied to the background 6003A (e.g., without applying a blur first), in accordance with some embodiments. This illustrates that the external fraction displaces underlying pixel values near the outline of the user interface object 6004, toward the interior of the user interface object 6004, such that a nearby portion of the background 6004 that is visible outside of the outline of the user interface object 6004 also has a refracted representation within the outline of the user interface object 6004. For example, at least some portion of the control 6012 that are located outside of the outline of the user interface object 6004 is also represented (e.g., represented by the refracted representation 6012′) within the outline of the user interface object 6004. Some portions of the text “Click. Quick” that is located outside of the outline of the user interface object 6004 is also pulled within the outline of the user interface object 6004, and has a refracted representation 6008′-3.

In FIG. 6B1-a, the bottom row shows the combined effect of simulated internal refraction 6003C-1, simulated external refraction 6003C-2 applied to the blurred version 6003B of the background 6003A, in accordance with some embodiments. This illustrates that the displacement of pixel values for both areas directly underlying the user interface object 6004 and displacement of pixel values for areas near the outline of the user interface object 6004. In addition, in the area that is near the outline of the user interface object 6004, the combined internal and external refraction region combines the effect of internal refraction 6003C-1 and the effect of external refraction 6003C-2, to provide the refracted representation 6003C-3 (e.g., representation 6008′-3) for the background near the outline of the user interface object. In the combined effect, the internal refraction (e.g., representation 6008′-1 for a portion of text 6008 within the outline of the user interface object 6004), the external refraction (e.g., representation 6008′-2 for a portion of the text 6008 that is outside of the outline of the user interface object) are both included within the outline of the user interface object 6004. At least some portion of the control 6012 that is located outside of the outline of the user interface object 6004 is also represented (e.g., represented by the refracted representation 6012′) within the outline of the user interface object 6004. In addition, the visual features of the background 6003A are blurred out with the application of the blur layer 6003B, with a greater amount of blur farther away from the outline of the user interface object 6004 in the interior of the user interface object 6004, and a lesser amount of blur close to the outline of the user interface object 6004 in the interior of the user interface object 6004 (e.g., the refracted representation 6006′-2 of a portion of the mountain closer to the outline of the user interface object 6004 is less blurred, as compared to the refracted representation 6006′-3 for another portion of the mountain that is farther away from the outline of the user interface object 6004). The refracted representation 6010′ of line 6010 is also a blurred version of that shown in the top and middle row of FIG. 6B1-a, with greater amount of blur near the center of the user interface object 6004, and smaller amount of blur near the outline of the user interface object 600.

FIG. 6B1-b provides the same example as that shown in FIG. 6B1-a, except that the gray values of the pixels are replaced by various colors with corresponding luminance values, in accordance with some embodiments.

Referring back to FIG. 6A, in some embodiments, displaying the user interface object 6004 with an appearance that simulates refraction of the underlying content 6003A (e.g., the appearance includes simulated refraction 6003C that is generated based on the blur layer 6003B), the user interface object 6004 is also displayed with a simulated shadow 6018 (e.g., produced from the simulated shadow layer 6003D). In some embodiments, the simulated shadow 6018 (e.g., produced from the simulated shadow layer 6003D) of the user interface material is not uniformly dark and/or uniformly opaque, because the user interface material is translucent (e.g., has a “glassy” appearance). In some embodiments, creating a simulated shadow that takes into account the simulated optical properties of the user interface material, as well as the simulated spatial dimensions (e.g., sizes in both the lateral dimensions and the depth dimension of the user interface) of the user interface material, allows the computer system to utilize the user's experience of the real world to grasp the visual changes in the user interface and understand the effects of user inputs quickly. In some embodiments, the simulated shadow 6018 that takes into account the simulated optical properties of the user interface material may reduce confusion caused by unrealistic visual effects and reduce visual distractions when the user interacts with the user interface.

Referring to FIG. 6B2, continuing with the example of FIG. 6B1, in some embodiments, the simulated shadow 6018 is displayed in a region of the user interface that is outside of the outline of the user interface 6004. In some embodiments, the simulated shadow 6018 is a thin dark region (e.g., with varying pixel values in different portions of the simulated shadow 6018 that overlay different portions of the underlying content that have different local content appearances) that extends along one or more edges of the user interface object 6004. In some embodiments, the width of the simulated shadow 6018 is based on the simulated thickness of the user interface material and the direction of the light source (e.g., virtual light source and/or physical light source in the environment). In some embodiments, the simulated shadow 6018 and/or the simulated shadow layer 6003D is generated based on the blur layer 6003B, and has a spatial distribution of pixel values (e.g., colors and luminance) that is generated by darkening the spatial distribution of pixel values in the blur layer 6003B (e.g., applying a luminance filter that reduces the luminance of the pixel values (e.g., optionally by different degrees depending on the local pixel values), applying a color filter to reduce color saturations of the pixels (e.g., optionally, by different degrees depending on local pixel values), and/or further blurs the spatial distribution of pixel values). In some embodiments, darkening the pixel values to generate the simulated shadow layer 6003D includes reducing the color saturation and/or reducing the luminance values of the pixel values of the blur layer 6003B. In some embodiments, the computer system applies an additional amount of blur to the blur layer 6003B, before darkening the pixel values in the spatial distribution of the further blurred blur layer.

In some embodiments, due to the process described above with respect to the generation of the simulated shadow 6018, the simulated shadow 6018 appears to have a spatial distribution of darkened colors that are based on the colors of a portion of the underlying content that is located near the outline of the user interface object 6004. In some embodiments, due to the blurring effects (e.g., blurring of the original underlying content 6003A in the blur layer 6003B, and additional blurring of the blur layer 6003B) applied to the underlying content 6003A, the appearance of the simulated shadow 6018 hints at the appearance of the underlying content 6003A under the simulated shadow 6018, without letting through too much of the characteristics of the appearance of the underlying content 6003A (e.g., the left portion and the right portion of the simulated shadow 6018 have slightly different luminance values, but not as much as the difference between the left portion 6034 and the right portion 6036 in the underlying content 6003A).

In some embodiments, the simulated shadow 6018 is extracted from the simulated shadow layer 6003D and does not include the region within the outline of the user interface object 6004 (e.g., the shape of the simulated shadow 6018 is extracted out of the simulated shadow layer 6003D and overlaid on the underlying content 6003A right outside of the user interface object 6004 in the user interface). In some embodiments, the spatial extent of the simulated shadow 6018 goes beyond the portion (e.g., external refraction region 6003C-3) of the underlying content that is used to generate the external refraction of the user interface material. In some embodiments, at least a portion of the simulated shadow 6018 overlays a portion of the underlying content 6003A that is not used in generating the simulated refraction of the user interface material (e.g., the portion of the underlying content is outside of the refraction-threshold distance from the outline of the user interface object 6004, but within the shadow-threshold distance from the outline of the user interface object 6004). In some embodiments, the spatial range of the portion of the underlying content that is used in generating the simulate shadow 6018 of the user interface object 6004 is greater than the spatial range of the portion of the underlying content that is used in generating the simulated refraction of the user interface object 6004.

In some embodiments, when displaying the simulated shadow (e.g., simulated shadow 6018) with the user interface object (e.g., user interface object 6004) that is visually associated with the user interface material (e.g., the “glassy” material, or other user interface materials described herein), the simulated shadow is overlaid on a portion of the underlying content 6003A at a location outside the outline of the user interface object (e.g., replacing display of the portion of the underlying content at the location of the simulated shadow), while the simulate refraction 6003C is overlaid on a portion of the underlying content 6003A at a location within the outline of the user interface object (e.g., replacing display of the portion of the underlying content at the location of the simulated refraction). Additional details regarding the generation and display of simulated shadow with simulated refraction of a user interface object that is visually associated with a user interface material are provided with respect to FIG. 6C and accompanying descriptions.

FIG. 6B2-a shows an example analogous to that shown in FIG. 6B2. In FIG. 6B2-a, the top row shows the background overlaid with the user interface object 6004 with an appearance based on the blur layer 6003B and refraction layers 6003C, and overlaid with the simulated shadow 6018 from the shadow layer 6003D applied to the blurred background 6003B, in accordance with some embodiments. The shadow layer is located in different portions of the background along the outline of the user interface object 6004, and corresponds to a darkened, blurred, and/or desaturated appearance of the background. FIG. 6B1-b provides the same example as that shown in FIG. 6B1-a, except that the gray values of the pixels are replaced by various colors with corresponding luminance values, in accordance with some embodiments.

Referring back to FIG. 6A, before the simulated refraction layer 6003C is used to produce the appearance of the user interface material within the outline of the user interface object 6004, and/or before the simulated shadow layer 6003D is used to produce the appearance of the simulated shadow outside of the outline of the user interface object 6004, additional modifications based on one or more color matrices 6003E (e.g., one or more vibrant color matrices, and/or other color filters that modify the color values and/or luminance values by various amounts specified by the color filters) are made to the spatial distribution of pixel values corresponding to the simulated refraction (e.g., the simulated refraction layer 6003C, such as layers 6003C-1, 6003C-2, and/or 6003C-3) and/or the spatial distribution of pixel values corresponding to the simulated shadow (e.g., the simulated shadow layer 6003D).

In some embodiments, the one or more color matrices 6003E applied to the simulated refraction layer 6003C is different from the one or more color matrices 6003E applied to the simulated shadow layer 6003D (e.g., different in terms of parameter values of the color matrices and/or different in terms of clamping values after the application of the color matrices). In some embodiments, one or more color matrices 6003E are applied to the simulated refraction layer 6003C, and the simulated shadow layer 6003D is not further modified by one or more color matrices. In some embodiments, the one or more color matrices 6003E that are applied to the simulated retraction layer 6003C have one or more parameters that are based on the visual properties of the underlying content 6003A (or, optionally, based on the visual properties of the blur layer 6003B and/or based on the visual properties of the simulated refraction layer 6003C). In some embodiments, the visual properties that affect the one or more parameters of the one or more color matrices 6003E include a characteristic luminance (e.g., average luminance, cumulative luminance, variation in luminance, and/or other characteristic values based on luminance) of the underlying content 6003A (or, optionally, the blur layer 6003B or the simulated refraction layer 6003C) or a relevant portion thereof. In some embodiments, the characteristic luminance used for generating the parameters of the color matrices of the simulated refraction is based on the luminance of a portion, less than all, of the underlying content 6003 that spatially corresponds to the user interface object (e.g., entirely within the outline of the user interface object, within a threshold distance from the outline of the user interface object, and/or within an outline of a platter supporting the user interface object and other similar or related user interface objects). In some embodiments, the characteristic luminance used for generating the parameters of the color matrices of the simulated shadow is based on the luminance of a portion, less than all, of the underlying content 6003 (or, optionally, the blur layer 6003B) that spatially corresponds to the simulated shadow (e.g., entirely outside the outline of the user interface object, and/or within a threshold distance from the outline of the user interface object).

In some embodiments, the one or more color matrices that modify the spatial distribution of pixel values of the simulated refraction layer 6003C map the pixel values to corresponding pixel values within a respective pixel value range, such as a respective range of luminance values. In some embodiments, the respective pixel value range has a maximum luminance threshold and a minimum luminance threshold (e.g., also referred to as luminance clamping values or luminance clamping thresholds).

In some embodiments, for the simulated refraction, the maximum luminance threshold of the respective range of luminance values is above the characteristic luminance of the portion of the underlying content 6003A (or, optionally, the portion of the blur layer 6003B) that corresponds to the location of the user interface object 6004 (e.g., the portion that is entirely within the outline of the user interface object, the portion that is within a threshold distance from the outline of the user interface object 6004, or the portion that is within a platter of the user interface object 6004 and one or more other related and/or similar user interface objects). In some embodiments, the brightest value in the simulated refraction is brighter than the brightest value in the underlying content of the simulated refraction. In some embodiments, the brightest value in the simulated refraction is darker than the brightest value in the underlying content of the simulated refraction. In some embodiments, the minimum luminance threshold of the respective range of luminance values is below the characteristic luminance of the portion of the underlying content 6003A (or the portion of the blur layer 6003B) that corresponds to the location of the simulated refraction. In some embodiments, the darkest value in the simulated refraction is darker than the darkest value in the underlying content of the simulated refraction. In some embodiments, the darkest value in the simulated refraction is brighter than the darkest value in the underlying content of the simulated refraction. In some embodiments, the maximum and/or minimum luminance values of the respective luminance range of the simulated refraction are chosen based on a characteristic luminance value of the underlying content, an object type of the user interface object, a material type of the user interface material, and/or a characteristic light level of the environment.

In some embodiments, for the simulated shadow, the maximum luminance threshold of the respective range of luminance values is below the characteristic luminance of the portion of the underlying content 6003A (or the portion of the blur layer 6003B) that corresponds to the location of the simulated shadow. In some embodiments, the brightest value in the simulated shadow is darker than the brightest value in the underlying content of the simulated shadow. In some embodiments, the minimum luminance threshold of the respective range of luminance values is the same as or is below the characteristic luminance of the portion of the underlying content 6003A (or, optionally, the portion of the blur layer 6003B) that corresponds to the location of the simulated shadow. In some embodiments, the darkest value in the simulated shadow is darker than the darkest value in the underlying content of the simulated refraction. In some embodiments, the maximum and/or minimum luminance values of the respective luminance range of the simulated shadow are chosen based on a characteristic luminance value of the underlying content, an object type of the user interface object, a material type of the user interface material, and/or a characteristic light level of the environment. In some embodiments, the maximum and/or minimum luminance values of the respective luminance range of the simulated shadow are chosen independent of a characteristic luminance value of the underlying content, an object type of the user interface object, a material type of the user interface material, and/or a characteristic light level of the environment.

In some embodiments, depending on whether the characteristic luminance of the portion of the underlying content corresponds to “light” content or “dark” content (e.g., characteristic luminance above a first threshold luminance is determined to be “light” content” and characteristic luminance below a second threshold luminance is determined to be “dark” content), the maximum and minimum luminance thresholds of the respective luminance range to which the pixel values of the simulated refraction layer 6003C are mapped, are established differently based on the characteristic luminance of the portion of the underlying content (or, optionally, the blur layer) that corresponds to the user interface object. In some embodiments, depending on whether the characteristic luminance of the portion of the underlying content corresponds to “light” content or “dark” content, the maximum and minimum luminance thresholds of the respective luminance range to which the pixel values of the simulated shadow layer 6003D are mapped, are established differently based on the characteristic luminance of the portion of the underlying content (or, optionally, the blur layer) that corresponds to the simulated shadow, and/or the user interface object. In some embodiments, the respective luminance range to which the pixel values of the simulated shadow layer 6003D are mapped, remain unchanged whether the characteristic luminance of the portion of the underlying content corresponds to “light” content or “dark” content.

In some embodiments, for the one or more color matrices used to modify the simulated refraction layer 6003C, when the characteristic luminance of the underlying content corresponds to “light” content, the maximum luminance threshold of the respective range of luminance values to which the pixel values of the simulated refraction layer 6003C are mapped, is calculated based on a reduction of the characteristic luminance of the relevant portion of the underlying content (or, optionally, the blur layer), and the minimum luminance threshold of the respective range of luminance values is calculated based on a boost of the characteristic luminance of the relevant portion of the underlying content (or, optionally, the blur layer). In some embodiments, the respective range of luminance is clamped between 0 and a high luminance value above 1 (e.g., 1.03, 1.05, or another HDR value).

In some embodiments, for the one or more color matrices used to modify the simulated refraction layer 6003C, when the characteristic luminance of the underlying content corresponds to “dark” content, the maximum luminance threshold of the respective range of luminance values to which the pixel values of the simulated refraction layer 6003C are mapped, is calculated based on a reduction (e.g., a different, optionally, greater, reduction amount, as compared to the “light” content case) of the characteristic luminance of the relevant portion of the underlying content (or, optionally, the blur layer), and the minimum luminance threshold of the respective range of luminance values is calculated based on a boost (e.g., a different, optionally, smaller, boost amount, as compared to the “light” content case) of the characteristic luminance of the relevant portion of the underlying content (or, optionally, the blur layer). In some embodiments, the respective range of luminance is clamped between a low luminance value (e.g., 0.1, 0.2, or another low luminance value) and a high luminance value below 1 (e.g., 0.8, 0.9, or another off white value).

In some embodiments, when mapping the actual luminance values of the pixels in the simulated refraction layer 6003C to the respective luminance range corresponding to the “light” content scenario, the actual luminance values are boosted (e.g., by a percentage ranging between 20%-40% or another percentage range) toward higher luminance values, to increase the visibility of the user interface material against the underlying content. In some embodiments, when mapping the actual luminance values of the pixels in the simulated refraction layer 6003C to the respective luminance range corresponding to the “dark” content scenario, the actual luminance values are reduced (e.g., by a small percentage) toward darker luminance values, to increase the visibility of the user interface material against the underlying content. In some embodiments, the actual luminance values of the pixels in the simulated refraction layer 6003C are not changed, and are, instead, subject to (e.g., only subject to) the clamping of the maximum and minimum luminance thresholds of the respective luminance range corresponding to the “dark” content scenario.

In some embodiments, for the simulated shadow layer 6004D, whether the relevant portion of the underlying content is “dark” content or “light” content, the luminance values of the pixels in the simulated shadow layer 6003D are mapped to a respective luminance range (e.g., with a reduction of 40%-18%, or another range of reductions) corresponding to a darkened shadow layer. In some embodiments, if the luminance value of a pixel value of the simulated shadow is above a threshold luminance that corresponds to “white” or “brightest color” (e.g., with a luminance above 0.95, 1, or another high luminance value), the luminance value of a pixel value of the simulated shadow is set to a fixed reduction (e.g., 5%, or another small percentage).

Referring back to FIG. 6B1, the effect of the color matrices on the simulated refraction layer includes different amounts of modifications to the “light” content (e.g., in portion 6020′) and the “dark” content (e.g., in portion 6020″), and “medium” content (e.g., in portion 6020) of the underlying content 6003A (or the blur layer 6003B, or the simulated refraction layer 6003C), optionally within the outline of the user interface object 6004. In some embodiments, because the user interface material of the user interface object 6004 is a continuous material, a respective set of color matrices (e.g., a set of mapping relationships and luminance thresholds) are applied to all pixels within the outline of the user interface object. However, in some embodiments, as the underlying content 6003A changes (e.g., due to content changing, user interaction, and/or due to relative movement of the user interface object and the underlying content), if the characteristic luminance of the relevant portion of the underlying content 6003A (or, optionally, the blur layer 6003B and/or the simulated refraction layer 6003C) meets the threshold for a different variant of the user interface material (e.g., the threshold characteristic luminance for switching from qualifying as “light” content to qualifying as “dark” content, or the threshold characteristic luminance for switching from qualifying as “dark” content to qualifying as “light” content), the respective set of color matrices is switched to another set of color matrices (e.g., corresponding to another set of mapping relationships and luminance thresholds, different from those used for the respective set of color matrices), and the new set of color matrices are then applied to the spatial distribution of pixels within the outline of the user interface object.

Additional details regarding the operation of the color matrix 6003E are provided with respect to FIGS. 6B5-6B13, method 14000, method 19000, and Tables 1, 2, and 3.

FIG. 6B2-a shows an example analogous to that shown in FIG. 6B2. In FIG. 6B2-a, the middle row shows the effect of the vibrant color matrix 6003E applied to the appearance of the user interface object 6004 that is based on internal refraction 6003C-1 and blur 6003B. Compared to the appearance shown in the 6B1-a, the appearance modified with the vibrant color matrix enhances some colors while making other colors less vibrant and more subdued, and more even across the spatial extent of the user interface material within the outline of the user interface object 6004. FIG. 6B1-b provides the same example as that shown in FIG. 6B1-a, except that the gray values of the pixels are replaced by various colors with corresponding luminance values, in accordance with some embodiments.

Referring back to FIG. 6A, an edge bleed and sheen layer 6003F is generated from the underlying content 6003A (e.g., from the blur layer 6003B). In some embodiments, the underlying content 6003A includes emissive elements that “emit” virtual light. In some embodiments, the underlying content 6003A has high luminance objects with highly saturated colors and/or high luminance values. In some embodiments, the edge bleed layer 6003F includes a simulated edge bleed effect that shows the colors of the nearby objects bleeding into (e.g., expanding spatially into, with decreasing intensities) the interior of the outline of the user interface object. The simulated edge bleed effect is visually illustrated by the dark elements 6022 (e.g., 6022-1. 6022-2, and 6022-3) that expand out various portions of the outline of the user interface object 6004, and that gradually decrease in color intensity and/or visibility with increasing distance from their origins along the various portions of the outline of the user interface object. In an example, the appearance (e.g., color, luminance, and/or spatial extent) of the dark text “Touch. Zoom.” outside of the outline of the user interface object 6004 is used as basis for the appearance (e.g., color, luminance, and/or spatial extent) of the simulated edge bleed effect 6022-1 on the upper edge of the outline of the user interface object 6004. In some embodiments, a greater length or width of the external object (e.g., the text “Touch. Zoom”, or another object with an emissive element and/or high luminance content) results in a greater length or width of a corresponding simulated edge bleed effect along an edge of the outline of the user interface object 6004 that is adjacent to the external object. In some embodiments, a smaller length or width of the external object (e.g., the text “Touch. Zoom”, or another object with an emissive element and/or high luminance content) results in a smaller length or width of a corresponding edge bleed effect along an edge of the outline of the user interface object 6004 that is adjacent to the external object. In some embodiments, the color of the external object (e.g., the text “Touch. Zoom”, or another object with an emissive element and/or high luminance content) results in a corresponding edge bleed effect of the same or similar color (e.g., shades and/or tints of the same color, optionally with reduced opacity and/or saturation). In some embodiments, a greater luminance of the external object (e.g., the control 6012, or another object with an emissive element and/or high luminance content) results in a greater luminance and/or color saturation of a corresponding edge bleed effect (e.g., 6022-3), and/or a greater spatial extent from an edge of the outline of the user interface object 6004 that is adjacent to the external object toward the interior of the outline.

In some embodiments, external objects (and/or, optionally, high luminance content that has visible boundaries) that cause display of corresponding edge bleed effects (e.g., simulated edge bleed 6022-2 are based on content outside of the portion of the underlying content currently shown in FIG. 6B2) within the outline of the user interface object 6004, in the edge bleed and sheen layer 6003F, include an external object that is located within an edge-bleed threshold distance from the outline of the user interface object 6004. In some embodiments, the edge-bleed threshold distance is greater than the external refraction threshold distance that is used to determine the spatial extent of the portion of the underlying content used in generating the simulated refraction 6003C of the user interface object. In some embodiments, the edge-bleed threshold distance is greater than the shadow-threshold distance that is used to determine the spatial extent of the portion of the underlying content used in generating the simulated shadow 6003D of the user interface object.

In some embodiments, the simulated edge bleed and sheen layer 6003F includes a simulated “sheen” that is blended with the simulated refraction and edge bleed effect within the outline of the user interface object 6004. The simulated sheen has an appearance (e.g., color and/or mixture of colors) that is based on the underlying content (or, optionally, a corresponding portion of the blur layer 6003B) that is outside of the outline of the user interface object 6004, but includes a portion of the underlying content (or, optionally, the corresponding portion of the blur layer 6003B) that is even farther away from the user interface object than the portion of the underlying content (or the corresponding portion of the blur layer 6003B) used to generate the simulated edge bleed effect, and/or the portion of the underlying content (or the corresponding portion of the blur layer 6003B) used to generate the simulated refraction of the user interface object 6004. For example, if the underlying content surrounding the user interface object has a blue tint or includes large areas of bluish green colors, the simulated sheen has a color that has a blue or blue green tint.

In some embodiments, the simulated sheen is blended with the modified appearance of the simulated refraction (e.g., as modified by the color matrices 6003E) within the outline of the user interface object 6004, using a blending method that is more additive to the input pixel values (e.g. coexisting with and augmenting, as opposed to inverting, transforming, and/or mapping, the input values) as compared to the blending method used for adding the simulated shadow to the underlying content outside the outline of the user interface object. In the shadow blending method, the shadow is created by blurring, dimming, mapping to a new luminance range, and/or extreme value clamping, of the input pixel values (e.g., of the portion of the blur layer that corresponds to the region of the underlying content that is overlaid by the simulated shadow). In some embodiments, the blending method used to add the simulated sheen on top of the simulated refraction is configured to reduce the influence of dark colors in the simulated refraction layer, as compared to the blending method used to create the simulated shadow based on the blur layer. In some embodiments, the simulated sheen is created by increasing the color saturation of the blur layer. In some embodiments, the simulated shadow is generated by increasing the color saturation of the blur layer by a smaller amount of increase, as compared to the simulated sheen. In some embodiments, the simulated shadow does not increase the color saturation of the blur layer.

FIG. 6B2-a shows an example analogous to that shown in FIG. 6B2. In FIG. 6B2-a, the bottom row shows the background overlaid with the user interface object 6004 with an appearance that includes a simulated sheen and edge bleed effect produced in layer 6003F, in accordance with some embodiments. The edge bleed from the control 6012 is indicated by portion 6022-3 that takes on the color (e.g., red, or another color) of the control 6012 and spreads from the portion of the edge of the user interface object 6004 near the control 6012, toward the interior of the user interface object 6004. The nearby content outside the outline of the user interface object also causes the user interface object 6004 to take on a simulated sheen, such as a blue sheen in the lower right portion of the user interface object (e.g., under the simulated influence of the blue content in the lower right portion of the background 6003A, outside of the outline of the user interface object 6004), a gray sheen 6022-1 in the top portion of the user interface object (e.g., under the simulated influence of the black content in the upper portion of the background 6003A, outside of the outline of the user interface object 6004), as shown in the bottom row FIG. 6B2-a. 6B1-b provides the same example as that shown in FIG. 6B1-a, except that the gray values of the pixels are replaced by various colors with corresponding luminance values, in accordance with some embodiments.

Referring back to FIG. 6A, after the simulated edge bleed and sheen layer 6003F is generated from the blur layer 6003B, the composite of the stack of layers is used as input for a tint color matrix (e.g., Tint VCM 6003G). In some embodiments, the user interface material has an intrinsic tint (e.g., as opposed to being colorless itself). In some embodiments, the intrinsic tint of the user interface material is added to the user interface material and reflected in the final appearance of the user interface material via the application of the tint color matrix 6003G on the composite of the underlying layers of the user interface material. The composite includes blurred underlying content within the outline of the user interface object, with the simulated refraction within the outline of the user interface object, with the simulated shadow outside the outline of the user interface object, with the simulated refraction (and, optionally, the simulated shadow) modified by one or more color matrices to balance clarity of the user interface material and sufficient visual saliency of the user interface material, and with the simulated edge bleed effect and simulated sheen blended in on top. In some embodiments, the tint color matrix 6003G adds a tint across the spatial extent of the user interface material within the outline of the user interface object uniformly. In some embodiments, the tint color matrix applies a gradient of tint color across the spatial extent of the user interface material within the outline of the user interface object. In some embodiments, when the user interface material is stretched, compressed, and/or reshaped in an animated transition, from the shape of a first object to the shape of a second object, the tint color matrix of the first object and the tint color matrix of the second object are combined in one or more intermediate color matrices that transition the color layer of the user interface material through multiple gradient color points that move in a respective direction, as the animated transition progresses. In FIG. 6B3, the tint layer 6003G of the tint of the user interface material is shown, and the tint is applied within the outline of the user interface object 6004.

In some embodiments, the outline of the user interface object 6004, optionally, has an edge effect that visually sets the user interface material off against the underlying content 6003A. In some embodiments, the edge effect is generated based on an edge color matrix 6003H applied to a narrow region of the underlying content around the outline of the user interface object 6004. In some embodiments, the edge color matrix 6003H creates visual contrast of the edge of the user interface object 6004 against the underlying content by blurring and inverting the pixel values of the narrow region in the blur layer 6003B, the composite of the underlying stack of layers, the simulated refraction layer 6003C, or another subset of the underlying layers; and then the narrow region of pixels 6026 is added on top of the tint layer 6003G. In some embodiments, the edge effect produces an edge portion that is lighter on dark underlying content, and darker on light underlying content. In some embodiments, the pixel values of the edge effect are clamped to eliminate extreme dark values and/or extreme light values (e.g., clamped between 0.2 to 0.9 luminance, or another reduced sub-range of a full luminance range or HDR range). In some embodiments, the threshold clamping values are set independent of the visual characteristics of the underlying content.

In some embodiments, the basis of the appearance of the user interface material includes the appearance of “internal” content, including content that is part of the user interface object and that is within the boundary of the user interface material. In some embodiments, the appearance of the user interface object simulates refraction of the internal content, as well as refraction of the underlying content. In some embodiments, the simulated refraction of internal content is optionally disabled unless the internal content changes appearance within the user interface object, and/or moves with a threshold distance of the outline of the user interface object (e.g., into a region of the user interface object in which the simulated thicknesses and/or radius of curvature of the edge region change). In some embodiments, the internal content includes controls, application icons, glyphs, text, and/or other types of content. In some embodiments, the user interface object is a menu (e.g., a share sheet, or user interface including sharing options for sharing content) and the internal content includes icons that correspond to different contacts of communication and/or applications for communication. In some embodiments, the user interface object is a tool bar (e.g., a tool bar with drawing tools in a drawing application, or a tool bar that includes icons corresponding to a plurality of different functions) and the internal content includes icons that correspond to tools and/or functions. In some embodiments, the user interface object is a control (e.g., a back button, a navigation control, and/or another type of control) and the internal content includes text or glyphs that indicate the current function of the control. In some embodiments, the simulated refraction of internal content changes the appearance of the user interface object when the internal content changes and/or move relative to the boundary of the user interface material. In some embodiments, the internal content includes a spatial distribution of pixel values for pixels and groups of pixels that define the appearance of the internal content without the simulated refraction and/or other visual effects applied to it. In FIG. 6A, the internal content layer 6003I is on top of the layers associated with the simulated refraction, simulated shadow, and/or the edge bleed and sheen, optionally, modified by the vibrant color matrices, tint color matrices, and/or edge color matrices.

In the illustration in FIG. 6B4, the internal content layer 6003I includes internal content 6030 (e.g., a plurality of icons or objects that do not have the glassy appearance of the user interface object 6004) and 6030′ (e.g., text). In some embodiments, the internal content of the user interface object 6004 is confined fully within the outline of the user interface object 6004 and/or is cut out by the outline of the user interface object 6004 as the internal content moves past a portion of the outline of the user interface object 6004 in a direction exiting the outline.

In FIG. 6A, in some embodiments, the simulated refraction of internal content 6003I is produced in a lensing layer 6003J. In some embodiments, the lensing layer 6003J includes a first visual effect to simulate the “bending” and/or “spatial displacement” of the pixel values in the spatial distribution of pixel values corresponding to the internal content (e.g., objects 6030 and text 6030′ in FIG. 6B4). In some embodiments, the “bending” and/or “spatial displacement” of the pixel values occur when there is a change in the intensity of simulated refraction across a spatial extent, such as the change in intensity of simulated refraction that corresponds to a change in the simulated thickness of the user interface material in an edge region of the user interface material (e.g., see the simulated side view 6014 of the user interface object 6004 in FIG. 6B1). In some embodiments, the first visual effect used to simulate refraction of internal content is referred to as a “lensing effect.” Visually, the appearance of the user interface object 6004 includes the internal content bending and warping with greater amounts going toward the outline of the user interface object, as illustrated by the warped shape of the object 6030 in the lensing layer 6003J.

In some embodiments, the simulated refraction of the internal content includes a second visual effect that simulates chromatic aberration that occurs in the edge portion of the user interface material. In some embodiments, the simulated chromatic aberration 6028 in the lensing layer 6003J includes separating the color of a pixel into multiple color channels of the color, and spreading them out spatially by an amount that corresponds to a change in simulated thickness and/or a change in the radius of curvature of the user interface material in the edge portion of the user interface material. In some embodiments, the intensity of the simulated chromatic aberration, e.g., as reflected in the number of color channels and the spatial spread of the color channels, increases with decreasing distance from the nearest curved portion of the outline of the user interface object 6004. As illustrated in FIG. 6B4, the spread of color channels and the number of color channels near the curved portions of the outline of the user interface object are greater than the spread of color channels and the number of color channels farther away from the curved portions of the outline of the user interface object.

Referring back to FIG. 6A, in some embodiments, the computer system adds one or more specular highlights to the edge of the user interface object 6004, based on the physical light in the environment and/or virtual light emitted from nearby objects toward the user interface object 6004. In some embodiments, the specular highlights change their colors, luminance, shapes, spatial extents, and/or relative positions to the outline of the user interface object, in response to changes detected in device orientation, ambient lighting, movement of the computer system, and/or other sensor data indicative in the change in spatial relationship between the computer system and the physical environment and/or change in ambient lighting.

In some embodiments, the specular highlights include a narrow region of high luminance pixels overlaid on the edge region of the user interface object. In some embodiments, the specular highlights have luminance values in the HDR range (e.g., above 100% luminance allowed for the underlying content or above 100% of the brightness or luminance a standard dynamic range for standard content in the user interface). In some embodiments, the specular highlights have color and/or luminance values that adapts to the changes in the pixel values of the underlying content (or another layer of the stack that is produced based on the underlying content).

In some embodiments, the parameters used in generating a respective layer in the stack of layers shown in FIG. 6A are adjustable based on various conditions, some of which are user-configurable, and some of which are established by the application for individual user interface objects that are visually associated with the user interface material. In some embodiments, some of the parameters are adjusted dynamically during user interaction, based on characteristics of the user inputs and/or during dynamic visual feedback provided via the user interface material. In some embodiments, parameters that are adjustable include opacity, blur radius, dimming, translucency, refraction intensity (e.g., amount of spatial distortion), color splitting (e.g., number of color channels and spacing between separated colors), luminance mapping relationships, luminance boosting amounts, luminance reduction amounts, luminance clamping thresholds, and/or other parameters. In some embodiments, the parameter values of one or more parameters are based the size and/or shape of the user interface object, and optionally are adjusted in real-time based on changes in the size and/or shape of the user interface object. In some embodiments, one or more parameters that are used in the generation of one or more of the layers are changed based on changes in the size and/or shape of the user interface object. In some embodiments, the parameter values of one or more parameters, and one or more parameters of the layers are based the object type of the user interface object (e.g., based on whether the user interface object is a control, a platter, an indication, an icon, and/or another type of object of a plurality of different object types).

FIG. 6B4-a shows an example analogous to that shown in FIG. 6B4 for the specular highlights layer 6003K. In FIG. 6B4-a, the top row shows the background overlaid with the user interface object 6004 with an appearance that includes the effects of the blur layer 6003B, the refraction layer 6003C, the shadow layer 6003D, the vibrant color matrix layer 6003E, the sheen and edge bleed layer 6003F, and the specular highlights layer 6003K, in accordance with some embodiments. The specular highlight 6034 is shown around the outline of the user interface object, with high luminance values. The second row of 6B4-a provides the same example as that shown in the top row of FIG. 6B4-a, except that the gray values of the pixels are replaced by various colors with corresponding luminance values, in accordance with some embodiments.

In some embodiments, as described with respect to FIGS. 6A through 6B4-a above, the object appearance of a user interface object and/or material appearance of the user interface material that is visually associated with the user interface object are generated based on the background appearance of a respective portion of the background that includes a underlying portion of the background that is covered by the user interface object, and, optionally, additional portions of the background that are outside of the outline of the user interface object on the background.

In some embodiments, the user interface material is a “transparent” material in the sense that the colors of the underlying portion of the background is visible in the material appearance of the user interface material, and the “directional relationship” between two background colors in a pair of background colors from the background is preserved in the two material colors corresponding to the two background colors, in the material appearance of the user interface material. For example, if a first background color has a lower luminance than a second background color in a respective pair of background colors (e.g., any and all pairs) from the full color range of the background (e.g., also referred to as “background color palette” with a “background luminance range”), a first material color corresponding to the first background color also has a lower luminance than a second material color corresponding to the second background color, in a full color range of the user interface material (e.g., also referred to as “material color palette” with a “material luminance range”). By preserving the directional relationships of luminance values for respective pairs of background colors before and after the respective pairs of background colors are converted to their corresponding pairs of material colors, the material is given a simulated “transparent” or “translucent” appearance, in some embodiments.

In some embodiments, the user interface object includes internal content that appears to reside within the user interface material, and visual saliency of the internal content is impacted by the “refracted” appearance of the underlying portion of the background that is visually represented in the material appearance of the user interface material. Therefore, in some embodiments, it is advantageous to not only adjust the material appearance based on a change in the background appearance (e.g., to, optionally, simulate a level of transparency of the material), but also to adjust how the material appearance is generated from the background appearance, based on the change in the background appearance, such as by varying one or more parameters (e.g., value transformation matrices and/or multipliers, and/or thresholds of value ranges) used in the mapping from the background colors to the material colors, and/or by supplementing with additional visual effects (e.g., adding black, white, and/or other colors, optionally with variable levels of opacity that depends on the visual properties of the background).

In some embodiments, the computer system distinguishes between “light” background and “dark” background, and use different sets of mappings between background luminance and material luminance when mapping background colors to corresponding material colors, where the background is categorized as “light” or “dark” based on the visual properties of a relevant portion of the background that includes at least a portion of the background covered by the user interface material. In some embodiments, the computer system varies the mapping relationships between background luminance and material luminance when mapping background colors to corresponding material colors, where the mapping relationships are selected based on a characteristic value of a characteristic visual property (e.g., an average input luminance, and/or another characteristic visual property that indicates a brightness level) of the relevant portion of the background that includes at least a portion of the background covered by the user interface material.

FIGS. 6B5-6B13 are illustrative of the various mapping relationships between background point luminance values for the background and corresponding material point luminance values for the user interface material, in accordance with some embodiments. FIGS. 6B14-a through 6B14-c includes a Tables 3A-3F (e.g., collectively referred to as “Table 3”) that illustrate how various types of user interface materials are utilized and/or how the various parameters used in the generation of the user interface materials are adjusted to achieve different variants of the user interface material in various usage case scenarios. It should be noted that the specific numbers used by way of example are merely for the purpose of clearly illustrating one example of the general principles involved. Values could be shifted up or down from the illustrated examples without departing from the general principles explained herein and described in greater detail with reference to method 19000.

In FIG. 6B5, the graph 6102-1 includes illustrative mapping relationships (e.g., mappings 6104a-6104h, and 6106a-6106h) for a set of “light” material variants, and a set of “dark” material variants, where the set of “light” material variants corresponds to a set of average input luminance (AIL) values in a “light” average input luminance (also referred to as “AIL” or “AIL*”) range, and the set of “dark” material variants corresponds to a set of AIL values in a “dark” AIL range, in accordance with some embodiments. In some embodiments, the AIL of a background is used as a measure of how “light” or “dark” a relevant portion of a background is for a user interface object that is visually associated with a user interface material. In some embodiments, the AIL of the background is calculated based on the luminance values (e.g., luminance is used as an example of a first visual property of the background) of the pixels (e.g., based on original pixel values in the underlying content 6003A, or blurred pixel values in the blur layer 6003B, described in FIG. 6A) in a respective portion of the background that is relevant to the user interface object that is visually associated with the user interface material. In some embodiments, the respective portion of the background that is relevant to the user interface object that is visually associated with the user interface material includes not only the portion of the background that directly underlies and is covered by the user interface object, but also additional portions surrounding the underlying portion of the background covered by the user interface object. In some embodiments, an additional portion of the background is included in the respective portion of the background (e.g., treated as being “relevant” to the selection of the material for the user interface object) if the additional portion of the background is within a threshold distance (e.g., a refraction-threshold distance, and/or another threshold distance greater than the refraction threshold distance) from the outline of the user interface object. In some embodiments, an additional portion of the background is included in the respective portion of the background if the additional portion of the background is within the outline of a platter and/or container object that includes and/or supports the user interface object (e.g., alone or along with one or more other user interface objects). In some embodiments, an additional portion of the background is included in the respective portion of the background if the additional portion of the background is spatially associated with another user interface object that is related to the user interface object (e.g., “related” by way of being included in the same container object, and/or sharing the same spatial arrangement, color scheme, and/or functional group).

In the illustrative example in FIG. 6B5, the “light” AIL range is between a lower threshold luminance of 0.7 and a higher threshold luminance of 1, corresponding to “light” backgrounds with higher average luminance values in a relevant portion of a respective background; and the “dark” AIL range is between a higher threshold luminance of 0.7 and a lower threshold luminance of 0. It is to be understood that, although many of the examples give particular values for parameters and thresholds, these particular values are not meant to exclude other possible values from being used for the same parameters and/or thresholds in various contexts and embodiments, unless they prove to be contrary to the purpose and feasibility of these parameters in these contexts and embodiments. In some embodiments, other higher and/or lower threshold luminance values can be used to define the “light” AIL range and the “dark” AIL range. In some embodiments, the “light” AIL range and the “dark” AIL range respectively correspond to two different sets of mappings (e.g., having two different parameter values for a respective parameter of the two sets of mappings) between background point luminance values and material point luminance values. In some embodiments, as shown in FIG. 6B5, the “light” AIL range and the “dark” AIL range overlap in an intermediate range with an upper threshold luminance of 0.7 and a lower threshold luminance of 0.3, and the computer system uses either the mappings for the “light” variants of the material, or the mappings for the “dark” variants of the material, depending on additional factors other than the AIL of the relevant portion of the background.

In FIG. 6B5, only a subset of the mappings used for the “light” variants of the material and a subset of the mappings used for the “dark” variants of the material are shown. For example, in FIG. 6B5, for the “light” variants of the material, the representative mappings for the AIL values 0.95, 0.9, 0.8, 0.7, 0.6, 0.5, 0.4, and 0.3 are shown as mapping 6104a (AIL=0.95), 6104b (AIL=0.9), 6104c (AIL=0.8), 6104d (AIL=0.7), 6104e (AIL=0.6), 6104f (AIL=0.5), 6104g (AIL=0.4), 6104h (AIL=0.3), spanning the AIL range of [0.3-1], in accordance with some embodiments.

In FIG. 6B5, for the “dark” variants of the material, the mappings for the AIL values 0.05, 0.1, 0.2, 0.3, 0.4, 0.5, 0.6, and 0.7 are shown as mapping 6106a (AIL=0.05), 6106b (AIL=0.1), 6106c (AIL=0.2), 6106d (AIL=0.3), 6106e (AIL=0.4), 6106f (AIL=0.5), 6106g (AIL=0.6), 6106h (AIL=0.7), spanning the AIL range of [0-0.7], in accordance with some embodiments.

It is noted that, in the intermediate range of AIL=[0.3-0.7], the material can be either a “light” variant of the material or a “dark” variant of the material (e.g., corresponding to “light” mappings 6104d, 6104e, 6104f, 6104g, and 6104h, or “dark” mappings 6106-d, 6106e, 6106f, 6106g, and 6106h, respectively, or other mappings in this AIL range). For the AIL range [0-0.3], only the “dark” variants of the material are used; while for the AIL range [0.7-1], only the “light” variants of the material are used, in some embodiments. It is to be understood that the lines corresponding to the different mappings in FIG. 6B5 are illustrative of some of the characteristics of the mappings, but the actual mappings used in different embodiments may have shapes and/or slopes other than those shown in FIG. 6B5, and the lines in FIG. 6B5 are not meant to provide precise values for each background point luminance and material point luminance pair in the different mapping relationships.

In some embodiments, one of the parameters that are used to distinguish between the “light” variants of the material from the “dark” variants of the material is a respective offset value used to obtain a respective end value (e.g., the upper threshold luminance, and/or the lower threshold luminance) of a luminance range of the material point luminance values (e.g., the vertical axis in FIG. 6B5). In some embodiments, a respective end value of the luminance range of the material point luminance values is determined based on a respective offset from the average input luminance (AIL) of the relevant portion of the background. In some embodiments, the respective offset used for the upper threshold luminance of the luminance range of the material point luminance values is different from (e.g., greater than, or smaller than) the respective offset used for the lower threshold luminance of the luminance range of the material point luminance values. In some embodiments, the respective offsets used for the upper threshold luminance of the luminance range of the material point luminance values are different for the “light” variants of the material and the “dark” variants of the material. In some embodiments, the respective offsets used for the lower threshold luminance of the luminance range of the material point luminance values are different for the “light” variants of the material and the “dark” variants of the material.

As shown in FIG. 6B5, for the “dark” variants of the material (e.g., “denoted as “dark glass”, but can refer to other dark user interface materials described herein), the example AIL range is [0-0.7], the upper luminance threshold of the output point luminance (OLR) range is AIL+0.25 (e.g., the offset is 0.25 in this example), the lower luminance threshold of the output luminance range (OLR) is AIL−0.2 (e.g., the offset is −0.2 in this example). In some embodiments, the output luminance range (OLR) is capped in the range [0.1-0.8], if the range calculated based on the offsets and AIL exceeds this range, as illustrated in FIG. 6B5.

As shown in FIG. 6B5, for the “light” variants of the material (e.g., “denoted as “light glass”, but can refer to other light user interface materials described herein), the example AIL range is [0.3-1], the upper luminance threshold of the output point luminance (OLR) range is AIL+0.45 (e.g., the offset is 0.45 in this example), the lower luminance threshold of the output luminance range (OLR) is AIL−0.15 (e.g., the offset is −0.15 in this example). In some embodiments, the output luminance range (OLR) is capped in the range [0-1.03], if the range calculated based on the offsets and AIL exceeds this range. It is noted that, even though the upper luminance threshold for the background may be 1 (e.g., 100% white in the normal available luminance range for the background), the upper luminance threshold for the material may be above 1 (e.g., at 1.03, or another value above 1), as illustrated in FIG. 6B5.

It can be seen from the plots shown in FIG. 6B5, that the mappings 6104a-6104h for the “light” variants of the material, and the mappings 6106a-6106h for the “dark” variants of the material have positive slopes and do not invert the luminance values of the colors in the background; and as a result, the pair-wise comparison of luminance for a respective pair of colors in the background have the same “directional relationship” as the pair-wise comparison of luminance for a corresponding pair of colors in the material. For example, progressively darker colors in the background have corresponding colors in the material that are progressively darker, while progressively lighter colors in the background have corresponding colors in the material that are progressively lighter, in accordance with some embodiments.

In some embodiments, as shown in FIG. 6B5, for a given AIL value in the intermedia background AIL range of [0.3-0.7], the mapping for the “light” variant of the material have higher output material luminance values than the “dark” variant of the material, across the entire range of background point luminance values (e.g., the horizontal axis). For example, the mapping 6104d for AIL of 0.7 is located entirely above the mapping 6016h for AIL of 0.7; the mapping 6104e for AIL of 0.6 is located entirely above the mapping 6016g for AIL of 0.6; the mapping 6104f for AIL of 0.5 is located entirely above the mapping 6016f for AIL of 0.5; the mapping 6104g for AIL of 0.4 is located entirely above the mapping 6016e for AIL of 0.4; and the mapping 6104h for AIL of 0.3 is located entirely above the mapping 6016d for AIL of 0.3. It indicates that, for the same AIL value of the relevant portion of the background, the material colors of the “light” variant is generally “lighter” than the corresponding material colors of the “dark” variant.

In FIG. 6B5, it is also noted, that for the “light” variants of the material, the material point luminance is capped above at 1.03 for multiple mappings with higher AIL for the relevant portion of the background (e.g., AIL=0.95, 0.9, 0.8, 0.7, and 0.6, respectively, in this example), in accordance with some embodiments. It is also noted, that for the “dark” variants of the material, the material point luminance is capped above at 0.8 for multiple mappings with relatively high AIL for the relevant portion of the background (e.g., AIL=0.6 and 0.7, respectively), in accordance with some embodiments. It is also noted, that for the “dark” variants of the material, the material point luminance is capped below at 0.1 for multiple mappings with lower AIL for the relevant portion of the background (e.g., AIL=0.05, 0.1, 0.2, and 0.3, respectively, in this example), in accordance with some embodiments.

In some embodiments, even though the mappings between background point luminance and material point luminance do not invert the directional relationship between a pair of background colors in the background luminance range when the pair of background colors are mapped to their corresponding pair of material colors in the material luminance range, the luminance values of the respective material colors in the pair of material colors may be respectively greater, the same as, or lesser, optionally by different amounts, as compared to the luminance values of their corresponding background colors.

In FIG. 6B5, a reference line 6105 is used to indicate a reference mapping where the luminance value of a respective background color remains the same as the luminance value of a corresponding material color of the respective background color. For a respective mapping (e.g., mappings 6104a-6104h, mappings 6106a-6106h, and/or other mappings between background point luminance and material point luminance that do not invert the relative luminance of a respective pair of background colors when converted to their corresponding pair of material colors) between background point luminance and material point luminance, the intersection point between the respective mapping and the reference mapping 6105 corresponds to a background color that does not change luminance when converted to a corresponding material color. The portion of the respective mapping that is above the reference mapping 6105 (e.g., the portion to the left of the intersection point) corresponds to a set of background colors that have increased luminance values when converted to their corresponding material colors. The portion of the respective mapping that is below the reference mapping 6105 (e.g., the portion to the right of the intersection point) corresponds to a set of background colors that have reduced luminance values when converted to their corresponding material colors.

As shown in FIG. 6B5, for backgrounds with lower AIL values (e.g., the mappings that are in the lower portion of the graph 6102-1, such as mappings 6106a, 6106b, 6106c, 6106d, and 6106e), their corresponding mappings are mostly below the reference mapping 6105, which illustrates that, for a darker background (e.g., indicated by the lower AIL values), the material is generally made lighter than the background for most background colors, except for the very dark background colors (e.g., with background point luminance close to 0, and/or less than 0.1 or other low values, for example), in some embodiments.

As shown in FIG. 6B5, for backgrounds with lower AIL values (e.g., the mappings that are in the lower portion of the graph 6102-1, such as mappings 6106a, 6106b, 6106c, 6106d, and 6106e), their corresponding mappings have a lower cutoff (e.g., capped below at material point luminance of 0.1, or another lower threshold luminance value), which puts the corresponding portions of the mapping (e.g., the left most portions of the mappings 6106a, 6106b, 6106c, 6106d, and 6106e) above the reference mapping 6105. This illustrates that, for a darker background (e.g., indicated by the lower AIL values for the relevant portion of the background for a user interface object), the material is made lighter than the background for the very dark background colors, in some embodiments.

As shown in FIG. 6B5, for backgrounds with higher AIL values (e.g., the mappings that are in the upper portion of the graph 6102-1, such as mappings 6104a, 6104b, 6104c, and 6104d), their corresponding mappings are above the reference mapping 6105, which illustrates that, for a lighter background (e.g., indicated by the higher AIL values for the relevant portion of the background for a user interface object), the material is made lighter than the background for all background colors, in some embodiments.

In some embodiments, for backgrounds with lighter AIL values (e.g., the mappings that are in the upper portion of the graph 6102-1, such as mappings 6104a, 6104b, 6104c, and 6104d), their corresponding mappings have a higher cutoff (e.g., capped above at material point luminance of 1.03, or another higher luminance threshold value), which illustrates that, for a lighter background (e.g., indicated by the higher AIL values for the relevant portion of the background for a user interface object), the material may have colors that are made lighter than the lightest color available in the background (e.g., the material color is in the HDR range, and lighter than the white color and/or lightest color in the background luminance range), in some embodiments.

As shown in FIG. 6B5, for the medium AIL values (e.g., the mappings that are in the middle portion of the graph 6102-1, such as mappings 6104e, 6104f, 6106g, and 6106f), the mappings for the light material are higher than the mappings for the dark material with corresponding AIL values (e.g., mapping 6104e is higher than mapping 6106g for AIL of 0.6, mapping 6104f is higher than mapping 6106f for AIL of 0.5), which indicates that the material color of the light material is lighter than the material color of the dark material, for a given background color in the background luminance range.

As shown in FIG. 6B5, even though there is no lower cutoff (e.g., value is not capped below) explicitly implemented for the light variants of the material, because there is no dark variant of the material with AIL below 0.3 (e.g., 0.3 in this example, and may be another lower AIL threshold value other than 0.3 in other embodiments), the lowest material point luminance is above 0.3-0.15=0.15 (e.g., 0.15 is the downward offset for the light material, and 0.15 is also the lower end value of the material luminance range in this mapping for AIL of 0.3), which illustrates that the material colors of the light variants of the material are lighter than the background colors, even for the darkest background colors (e.g., with background point luminance of 0 to another value close to 0, such as 0.15).

As shown in FIG. 6B5, in addition to a lower cutoff (e.g., value is capped below at 0.1 for the dark materials), there is also a higher cutoff (e.g., value is capped above at 0.8) for the dark variants of the material, the highest material point luminance is 0.8 (e.g., mappings 6106h and 6106g are both capped above at luminance of 0.8), which illustrates that the material colors of the dark variants of the material are kept relatively dark (e.g., with material point luminance below 0.8 in this example), even if some of the background colors are very light (e.g., with background point luminance of 1 or close to 1).

In some embodiments, the mapping from the background colors of the underlying portion of the background to the material colors of the user interface material within the outline of the user interface object is accomplished at least in part in the color matrix layer 6003E in the stack of layers 6108 (e.g., the layers shown in FIGS. 6A-6B4). In some embodiments, the color matrix layer 6003E is applied to the blur layer 6003B. In some embodiments, the color matrix layer 6003E is applied to the underlying content layer 6003A. In some embodiments, the color matrix layer 6003E is applied to the external refraction layer 6003C. In some embodiments, the output of the color matrix layer 6003E is used as input for the edge bleed/sheen layer 6003F and/or the tint layer 6003G, when generating the object appearance and/or material appearance of the user interface object based on the background appearance of the underlying content 6003A.

In some embodiments, as shown in FIGS. 6B6, in addition to the mapping from the background colors to their corresponding material colors in accordance with the mappings shown in FIG. 6B5, the computer system also further injects an additional color to the light variants of the material, such an additional white color, to increase the brightness of the material and even out the appearance of the user interface material. In some embodiments, the injection of the additional color is performed by application of a color matrix, with an adjustable opacity parameter that changes based on the AIL of the relevant portion of the background.

As shown in FIG. 6B6, the graph 6110 shows an example adjustable opacity parameter (e.g., labeled “fill opacity”) that changes based on the value of the average input luminance (AIL) of the relevant portion of the background, in accordance with some embodiments. The horizontal axis of the graph 6110 is the average input luminance (AIL), and the vertical axis of the graph 6110 is fill opacity of the additional color that is injected into the material colors of the light variants of the material, in accordance with some embodiments.

As shown in FIG. 6B6, in the curve 6118 (e.g., optionally, having straight and/or curved portions in various embodiments), for AIL values less than 0.35 (e.g., 0.35 is the threshold value used in this example, and may be another value different from 0.35 that separates darker background AIL values and higher background AIL values in various embodiments), the fill opacity is 0, which means that the material colors are not changed for darker backgrounds with AIL less than 0.35, in some embodiments. In the curve 6118, for AIL values greater than 0.35 (e.g., between 0.35-1), the fill opacity gradually increases from 20% to 40% (e.g., 20%-40% is the range used in this example, and may be other ranges of opacities), which means that the material colors (e.g., all material colors with the whole range of material point luminance values) are “lightened” by the injection of the additional color by increasing amounts for lighter backgrounds with AIL greater than 0.35. In some embodiments, the effect of injecting an additional color with increasing fill opacity for lighter backgrounds of (e.g., with AIL greater than 0.35 or another threshold AIL value) includes increasing visual saliency of the material against a light background, as it is harder to see a light material over a light background, without utilizing color inversion (e.g. a common technique for increasing visual saliency).

In some embodiments, the injection of the additional color is also implemented in the color matrix layer 6003E, where the fill opacity is used as a multiplier or coefficient in the color matrix 6003E applied to the blur layer 6003B or the underlying content 6003A. In some embodiments, the injection of the additional color is also implemented in the color matrix layer 6003E, where the fill opacities are used as an additional matrix applied to an intermediate output of the color matrix 6003E that was applied to the blur layer 6003B or the underlying content 6003A.

In some embodiments, as described with respect to FIGS. 6A-6B4, the computer system generates a simulated shadow in the shadow layer 6003D based on the blur layer 6003B and/or the underlying content layer 6003A. In some embodiments, the portion of the underlying content that provides the basis for the simulated shadow includes a portion of the underlying content that is within a shadow-threshold distance from the outline of the user interface object. In some embodiments, the shadow colors are generated from the background colors using a set of mappings that are similar to those shown in FIG. 6B5, where the mappings correspond to a reduction of the background point luminance of a respective background color when the respective background color is converted to its corresponding shadow color.

In some embodiments, the simulated shadows are generated by injecting an additional dark color (e.g., black color, and/or a color of ambient light) into the background colors. In some embodiments, as shown FIG. 6B7, the injection of the additional dark color for the simulated shadow includes different techniques in three ranges of average input luminance (AIL) values (e.g., AIL of the relevant portion of the background that includes the portions underlying the user interface object, the simulated shadow, and/or within a shadow-threshold distance from the outline of the user interface object). In the graph 6112 in FIG. 6B7, the horizontal axis is the average input luminance of the relevant portion of the background, and it has a value range of 0 to 1. The vertical axis is the fill opacity of the dark color (e.g., black or another dark color), and the full opacity range is 0-100%. In some embodiments, for the low AIL range (e.g., AIL is less than 0.3 or another AIL threshold for very dark backgrounds), the fill opacity is 0, which indicates that for very dark background, the simulated shadow is almost invisible and/or is omitted for display efficiency purposes. In some embodiments, for the medium AIL range (e.g., AIL is between 0.3-0.95 in this example), the fill opacity is between 40% to 18% (or, optionally, another suitable range between 5% and 100%) and decreases with increasing AIL values, which indicates that for medium luminance backgrounds, the shadows get less dark when the AIL increases (e.g., making the shadow only a little darker than the background). In some embodiments, for the higher AIL range (e.g., AIL is above 0.95 or another threshold for very light background), the fill opacity is a constant value (e.g., 5%, or another low fill opacity value) that is spaced apart from the low end of the fill opacity for the medium backgrounds (e.g., 18%, in this example), which indicates that, for very light backgrounds, the shadow is a very slight and constant dimming of the background colors. This implementation of shadow color fill for the very light background improves display efficiency without severe compromise on shadow appearances. In some embodiments, the shadow color fill is implemented in the shadow layer 6003D in the stack of layers 6108 (e.g., the layers shown in FIGS. 6A-6B4).

In some embodiments, the relevant portion of the background that is used to calculate the AIL of the background for the purposes of determining the fill opacity of the simulated shadow is the same as the relevant portion of the background that is used to calculate the AIL of the background for the purposes of determining the fill opacity of the material and/or the AIL of the background for the purposes of determining the mapping between background point luminance and material point luminance of the material. In some embodiments, the relevant portion of the background that is used to calculate the AIL of the background for the purposes of determining the fill opacity of the simulated shadow is different from the relevant portion of the background that is used to calculate the AIL of the background for the purposes of determining the fill opacity of the material and/or is different from the AIL of the background for the purposes of determining the mapping between background point luminance and material point luminance of the material. In some embodiments, the relevant portion of the background that is used to calculate the AIL of the background for the purposes of determining the fill opacity of the simulated shadow includes the portion of the background that is covered by the simulated shadow. In some embodiments, the relevant portion of the background that is used to calculate the AIL of the background for the purposes of determining the fill opacity of the simulated shadow includes the portion of the background that is covered by the simulated shadow and the portion of the background that is covered by the material. In some embodiments, the relevant portion of the background that is used to calculate the AIL of the background for the purposes of determining the fill opacity of the simulated shadow includes the portion of the background that is covered by the simulated shadow, the portion of the background that is covered by the material, and, optionally, additional portions that are outside of the areas covered by the material and the simulated shadow (e.g., areas that are in the container object containing the user interface object).

FIGS. 6B8-6B13 provide a more detailed example of how background colors of a background are mapped to the material colors of the user interface material, when the background changes appearance, and in particular, when the average input luminance (AIL) of a relevant portion of the background changes, in accordance with some embodiments.

In FIG. 6B8, an example background appearance 6124 is shown. The example background appearance 6124 is an appearance of a background 6128 (e.g., including variants 6128-1 through 6128-5 in FIGS. 6B9-6B13) that includes a user interface, an image, textual content, video content, animated content, a window, a container object, a desktop, a platter, a view of a virtual environment, a view of a three-dimensional environment (e.g., an augmented reality environment with a representation of a physical environment and/or optical passthrough view of the physical environment), and/or a combination of different types of content and/or user interface objects, in various embodiments.

In some embodiments, the background appearance 6124 changes (e.g., moves, animates, resizes, and/or switches to another state) in response to changes of device state and/or application state, due to changes in contextual conditions (e.g., time of day, location, facing direction, device orientation, elapse of time, activation of operation mode, receipt of updates and/or alerts, and/or other changes that occur without detecting a direct user input), and/or due to detection of one or more user inputs that interact with the computer system (e.g., interaction with displayed user interface objects, content, and/or applications; interaction with hardware affordances; activation of various types of sensors of the computer system, and/or interaction with various input devices). In some embodiments, the background appearance 6124 changes over multiple states (e.g., the different states shown in 6124a-6124e in FIG. 6B9) over an extended period of time.

In this example, the left portion of FIG. 6B8 shows the background appearance 6124 without being covered by a user interface object that is visually associated with a user interface material. The right portion of FIG. 6B8 shows the background overlaid with a material with material appearance 6122, with the background appearance 6124 as that shown in the left portion of FIG. 6B8. In the right portion of FIG. 6B8, the background is covered by a user interface object (e.g., user interface object 6136) that is visually associated with a user interface material (e.g., a user interface material described with respect to FIG. 6B5, and/or elsewhere in the present disclosure). In FIG. 6B8-6B13, the background displayed with material appearance 6122 (e.g., material appearances 6122a-6122d) is used as examples where the material is a light variant of the material, and a material appearance 6126 (e.g., material appearance 6126a-61266) is used as examples where the material is a dark variant of the material.

In this illustrative example, the user interface object 6136 is a share sheet that is displayed in response to a user input (e.g., user input 6140, or another user input that causes display of the user interface object 6136) directed to a portion of the background 6124 (e.g., a user interface object 6135 associated with the “share” function of the currently displayed user interface or content). In some embodiments, the background 6128 is overlaid with one or more other user interface objects (e.g., user interface object 6138 or other user interface objects and/or content).

In some embodiments, the user interface object 6136 is overlaid on the background 6128 and is visually associated with the user interface material, and the object appearance of the user interface object 6136 is confined within an outline of the user interface object which corresponds to a boundary of the user interface material against the background 6128. As shown in FIG. 6B8, the outline of the user interface object 6136 and/or the boundary of the user interface material visually set the user interface object 6136 apart from the background 6128. The portion of the background 6128 that directly underlies the user interface object 6136 is covered by the user interface material of the user interface object 6136, and is not directly displayed with the rest of the background not covered by the user interface material. In some embodiments, the object appearance and/or material appearance (e.g., denoted as 6122 and 6126 in FIGS. 6B8-6B13) displayed within the outline of the user interface object are generated based on the processes described with respect to FIGS. 6A-6B7. In particular, the relevant portion of the background 6128 that is used to determine the average input luminance (AIL) that is then used to determine which mapping is used to map the background colors to their corresponding material colors, includes at least the portion of the background 6128 that is within the outline of the user interface object 6136 (e.g., directly underlies the user interface object 6136/or is covered by the user interface object 6136). In some embodiments, the relevant portion of the background further includes other portions that are not covered by the user interface object 6136 and not within a refraction-threshold distance from the outline of the user interface object 6136, such as portions of a container object that includes the user interface object and, optionally, one or more other user interface objects. For example, in some embodiments, the materials of individual objects that share a common supporting platter and/or included in the same container object have the same AIL that is calculated based on the portion of the background that is included in the platter and/or container object, rather than different AILs that are calculated based on different portions of the background covered by the different objects. In this example, the relevant portion of the background includes the portion of the background 6128 that is covered by the user interface material of the user interface object 6136, and optionally additional portions that are not covered by the user interface object 6136 but are within the refraction-threshold distance from the outline of the user interface object 6136 (e.g., because the user interface object 6136 does not share the same platter or container object with another related object).

In some embodiments, the user interface object 6136 includes internal content, such as objects 6137a-6137h, where the internal content is content within the user interface material that is, optionally, subject to simulated internal refraction (e.g., lensing effect, chromatic aberration, and/or other visual effects) of the material (e.g., as described with respect to FIGS. 6A-6B4, and elsewhere in the present disclosure). In some embodiments, the objects 6137a-6137h include icons corresponding to different sharing methods (e.g., application icons for various communication applications, such as texting, SMS, social networking, file transfer, and/or other applications with content sharing capabilities), icons corresponding to different sharing destinations (e.g., avatars of various contacts, usernames, file storage locations, and/or other sharing destinations), and/or selectable options for performing operations related to sharing the content included in the background 6122.

In the illustrative examples of FIG. 6B8-6B13, the background 6128 includes various regions that have different background colors, from very light colors corresponding to higher background point luminance values to very dark colors corresponding to lower background point luminance values; correspondingly, the material of the user interface object 6136 shows the corresponding material colors for these different background colors, based on a corresponding mapping that is selected based on the AIL of the relevant portion of the background 6128, in accordance with various embodiments.

For illustrative simplicity and clarity, the AIL of the relevant portion of the background is varied by changing the color of a larger portion of the background 6128 (e.g., the image of three buildings captured at different times of day), which corresponds to decreasing AIL of the relevant portion of the background, which corresponds to the indication 6129 (e.g., the background 6128 having decreasing AIL values when the indication 6129 changes from being the Sun 6129a, white clouds 6129b, dark clouds 6129c, moon 6129d, to being the stars 6129e in different background appearances 6124a-6124e of the background 6128 in FIGS. 6B9-6B13).

In these illustrative examples, the three buildings 6134 in the background 6124 each include black outlines and a black bar 6132 at the bottom, to indicate the background color of black (e.g., with background point luminance of 0). The three buildings 6134 also include six columns of windows 6130 (e.g., represented by six columns of three rectangular boxes 6130a, 6130b, 6130c, 6130d, 6130e, and 6130f, within the outlines of the buildings 6134). With the exception of the background 6128-1 for the example with AIL=0.9, where all six columns of windows 6130 are white windows, representing the background color of white (e.g., with background point luminance of 0), examples with AIL below 0.9 are shown with only the first and last columns 6130a and 6130f as white windows, while other columns have colors with decreasing background point luminance values (e.g., increasingly darker grays from column 6130b to 6130e). This distribution of background colors for the windows 6130 does not vary in the examples with AIL from 0.7 to 0.1 in FIGS. 6B9-6B13 (e.g., with background appearances 6124b-6124e), even as most of the background 6128 (e.g., building color and color of the empty space outside of the buildings 6134) changes color to adjust the AIL values in these examples. In addition, in all examples of AIL from 0.9-0.1, the outline of the windows 6130 have the same color, which has an intermediate background point luminance that is the same as the background point luminance of the fifth column of windows 6130e. In FIGS. 6B9-6B13, the portion of the background 6128 that is covered by the user interface object 6136 does not change in appearance, even though the material appearance changes due to the change in the value of AIL from 0.7 to 0.1 (e.g., through the background appearances 6124b through 6124e), in accordance with some embodiments.

In FIG. 6B8, the material appearance shown within the outline of the user interface object 6136 further includes the injection of the additional color (e.g., white, or another light color corresponding to the color of the ambient light) with varying fill opacity, in accordance with some embodiments. The injection of the additional color with a fill opacity selected based on the AIL of the relevant portion of the background is indicated by the white crosshatching marks 6139 overlaid on the user interface object 6126, and the number of crosshatching marks is used to indicate the magnitude of the fill opacity that is used for the current AIL.

As shown in FIG. 6B8, the material appearance 6122 in the user interface object 6136 includes a spatial distribution of material colors that corresponds to the spatial distribution of background colors in the background (e.g., the locations of the six columns of windows 6130a-6130f, the outlines of the three buildings 6134, and the locations of the three black bars 6132 are discernable in the material appearance of the user interface material within the outline of the user interface object 6136). In some embodiments, the spatial displacement of the background colors is used to simulates refraction of the background colors by the user interface material, and is implemented in the internal refraction layer 6003C-1 and external refraction layer 6003C-2 (e.g., described in more detail with respect to FIGS. 6A-6B4). In some embodiments, the refracted representations of the visual features in the background underlying and/or immediately adjacent the user interface object are larger, deformed, shifted, and/or more blurred as compared to the visual features in the background 6128. For example, in FIG. 6B8, the outlines of the three buildings 6134 and the windows 6130 indicated in the material are more blurred and/or spread out than the outlines in the original background 6128, in some embodiments. In FIG. 6B8, the shapes of the windows are changed and/or distorted in the refracted representations of the windows in the material (e.g., the top row of the windows is squished vertically by a greater amount because it is closer to the top edge of the user interface object, as compared to the second row of the windows). In FIG. 6B8, portions of the background that is not covered by the user interface object 6136 are represented in the appearance of the material within the user interface object 6136, to simulate external refraction of the portion of the background that is close to the edge of the user interface material (e.g., the top portions of the first row of windows 6130 are not covered by the user interface object 6136, but have corresponding refracted representations within the material of the user interface object 6136 as part of the complete refracted representations of the first row of windows 6130), in accordance with some embodiments. Additional details regarding how the refracted appearance of the underlying content is generated are provided with respect to FIGS. 6A-6B4, in accordance with various embodiments.

Now referring to the illustrative examples shown in FIG. 6B9. FIG. 6B9 includes three columns of images, with the middle column corresponding to the original background appearances 6124 that are not covered by the user interface object 6136. The five rows of the middle column respectively correspond to the background appearance 6124a for AIL of 0.9, background appearance 6124b for AIL of 0.7, background appearance 6124c for AIL of 0.5, background appearance 6124d for AIL of 0.3, and background appearance 6124e for AIL of 0.1. The left column of FIG. 6B9 corresponds to respective material appearances 6122 of the material of the user interface object 6136 overlaying the background with respective background appearances 6124 shown in the same row, when the materials of the user interface object 6136 are the “light” variants of the user interface material, in accordance with some embodiments. The right column of FIG. 6B9 corresponds to respective material appearances 6126 of the material of the user interface object 6136 overlaying the background with respective background appearances 6124 shown in the same row, when the materials of the user interface object 6136 are the “dark” variants of the user interface material, in accordance with some embodiments.

In FIG. 6B9, the first row of the images, the background appearance 6124a in the middle column has an AIL of 0.9, which does not have a corresponding dark variant of the material, and only has a light variant of the material shown in the left column of the first row. In FIG. 6B9, the last row of the images, the background appearance 6124e in the middle column has an AIL of 0.1, which does not have a corresponding light variant of the material, and only has a dark variant of the material shown in the right column of the last row.

In some embodiments, when the computer system choses a “light” variant of the material when the AIL of the relevant portion of the background is above 0.7, and uses a “dark” variant of the material when the AIL of the relevant portion of the background is below 0.3. In some embodiments, if the computer system is using a “light” variant of the material (e.g., a “light” variant shown in the second, third, and/or fourth row of the left column, or other light variants corresponding to AIL above 0.3), and detects that the AIL of the relevant portion of the background has dropped below 0.3, the computer system switches from using the “light” variant of the material to using a “dark” variant of the material. In some embodiments, if the computer system is already using a “dark” variant of the material (e.g., a “dark” variant shown in the second, third, and/or fourth row of the right column), and detects that the AIL of the background has dropped below 0.3, the computer system continues to use a “dark” variant of the material corresponding to the newly detected AIL of the background. In some embodiments, if the computer system is using a “dark” variant of the material (e.g., a “dark” variant shown in the second, third, fourth, and/or fifth row of the right column, or other dark variants corresponding to AIL below 0.7), and detects that the AIL of the background has risen above 0.7, the computer system switches from using the “dark” variant of the material to using a “light” variant of the material. In some embodiments, if the computer system is already using a “light” variant of the material (e.g., a “light” variant shown in the second, third, and/or fourth row of the left column), and detects that the AIL of the background has risen above 0.7, the computer system continues to use a “light” variant of the material corresponding to the newly detected AIL of the background. It is to be noted that, the threshold ranges for exclusively using “light” materials, exclusively using “dark” materials, and for choosing between “light” and “dark” materials based on various factors other than AIL of the relevant portion of the background, can be shifted (e.g., upward toward higher luminance values and/or lower toward lower luminance values) for different usage scenarios, such as different interaction states, object types, object sizes, and/or other factors listed in the Tables 1, 2, and 3.

It can be seen in the left column and the right column of FIG. 6B9 that, overall, the material colors of the user interface object 6136 are darker for darker background colors, and lighter for lighter background colors, for a respective background image (e.g., background colors are not inverted by the mappings in FIG. 6B5 when converted to the corresponding material colors). For example, the relative luminance order of the first five columns of windows 6130a-6130e (e.g., decreasing luminance from left to right) is maintained in the material appearances shown in each of the images for background appearances 6124b-6124e, and in the material appearances shown in each of images 6126a-6126d, in accordance with some embodiments. Additional details of these images are described with respect to FIGS. 6B10-6B13 below.

In FIG. 6B10, the graph 6102-2 shows a subset of the mappings that were shown in graph 6102-1 in FIG. 6B5. Specifically, the graph 6102-2 shows the mapping 6104b for a light variant of the user interface material corresponding to AIL of 0.9, and the mapping 6106b for a dark variant of the user interface material corresponding to AIL of 0.1, in accordance with some embodiments. The mapping 6104b is a representative of a light material mapping that does not have a counterpart dark material mapping for the same AIL, because the AIL is greater than the higher threshold AIL for the dark variants of the user interface material (e.g., 0.7 in this example, or another higher AIL threshold value in various embodiments), in accordance with some embodiments. The mapping 6106b is a representative of a dark material mapping that does not have a counterpart light material mapping for the same AIL, because the AIL is smaller than the lower threshold AIL for the light variants of the user interface material (e.g., 0.3 in this example, or another lower AIL threshold value in various embodiments), in accordance with some embodiments.

As shown in FIG. 6B10, the mapping 6104b has an output material luminance range of [0.75 to 1.03] on the vertical axis of the graph 6102-2, which is a result of shifting the AIL upward by an offset of 0.45, and capping it above at 1.03, and shifting the AIL downward by an offset of −0.15. The center of the output material luminance range is 0.75+ (1.03−0.75)/2=(0.75+1.03)/2=0.89, and is offset from the AIL by 0.9−0.89=0.01. The slope of the mapping 6104b is a positive slope, which means for input background colors of increasing luminance values, the corresponding output material colors also have increasing luminance values. The entirety of the mapping 6104b is above the reference mapping 6105, so the input background colors have corresponding output material colors that have higher luminance values than their input background colors.

This is visually illustrated in the pair of the background appearance 6124a and background appearance overlaid with material appearance 6122a. On the left, the background appearance 6124a has an AIL of 0.9 for the relevant portion of the background for the user interface object 6136a. The background 6128-1 with the background appearance 6124a is mostly white which has a luminance value of 1. The three buildings 6134 and the six columns of windows 6130a-6130f are also white with a luminance value of 1. The three bars 6132 at the bottom of the buildings are black with a luminance of 0. The outlines of the windows and the buildings are of various colors with the same medium luminance value that is between 0 and 1. The relevant portion of the background for determining the AIL includes the portion that is going to be covered by the user interface object 6136a and, optionally, a surrounding portion that is within a refraction-threshold distance from the outline of the user interface object 6136a, and the AIL comes out to be 0.9 for illustrative purposes. It is emphasized that these particular values of luminance are chosen for ease of illustration and are not meant to limit broader application of these principles illustrated by these examples.

To the right of the image with the background appearance 6124a, the background appearance 6124a is overlaid with the user interface object 6136a. The user interface object 6136a has the material appearance 6122a that is determined based on the mapping 6104-b. Most of the regions of the material over the white portions of the background 6128-1 are ultra-white (e.g., with a luminance of 1.03, or another higher capping threshold luminance value above 1). As a result, the material is visually set off from the white portions of the background 6128-1 surrounding the user interface object 6136a. The regions 6132* of the material over the black bars 6132 are lightened substantially (e.g., with a luminance value of 0.75, in this example). The outlines of the buildings and windows (e.g., in regions 6134* and regions 6130a*-6130f*) are also lightened, resulting in a material color that is lighter than the material color corresponding to the black bars (e.g., in regions 6132*), because the outlines and windows 6130 are lighter than the black bars 6132 in the original background 6128-1). The material appearance within the user interface object 6136a is further modified with addition of a white fill, where the magnitude of the fill opacity is selected based on the AIL of the relevant portion of the background 6128-1, and is a value close to 40% in this example. The white fill is indicated by indication 6139a.

As shown in FIG. 6B10, the mapping 6106b has an output material luminance range of [0.1 to 0.35] on the vertical axis of the graph 6102-2, which is a result of shifting the AIL upward by an offset of 0.25, and shifting the AIL downward by an offset of −0.2 and capping it below at 0.1, in accordance with some embodiments. The center of the output material luminance range is 0.1+(0.35−0.1)/2=0.225, which is offset by a value of 0.225−0.1=0.125 from the AIL of 0.1. The slope of the mapping 6106b is a positive slope, which means, for input background colors of increasing luminance values, the corresponding output material colors also have increasing luminance values. Most of the mapping 6106b is below the reference mapping 6105, except for background point luminance of less than 0.1, so most of the input background colors have corresponding output material colors with lower luminance values than their input background colors, except for the really dark colors with luminance values less than 0.1 (e.g., black or very dark blues, purples, reds, and/or browns). It is to be emphasized that these particular values are provided for ease of illustration and clarity of explanation, and are not meant to limit the application of the principles illustrated herein to these particular values, in various embodiments. The usage of the mapping 6106b is visually illustrated in the pair of the background appearance 6124e and background appearance overlaid with material appearance 6126d (e.g., in the second row of images in FIG. 6B10).

On the left of the second row of images in FIG. 6B10, the background appearance 6124e has an AIL of 0.1 for the relevant portion of the background 6128-5 for the user interface object 6136h. Most of the background 6128-5 with the background appearance 6122e is very dark with a luminance value less than 0.1. The three buildings 6134 are also very dark with a luminance value less than 0.1. The six columns of windows 6130a-6130f include two columns of white windows 6130a and 6130f, and increasingly dark windows from 6130b-6130e. The windows 6130a-6130f represent various material point luminance values from 0.1 to 1. The three bars 6132 at the bottom of the buildings 6134 are black with a luminance of 0. The outlines of the windows and the buildings are of various colors with the same medium luminance value that is between 0 and 1, and the same as that of the windows 6130e. The AIL of the relevant portion of the background 6128-5 comes out to be 0.1 for illustrative purposes. On the right of the second row of images in FIG. 6B10, the background 6128-5 with background appearance 6124e is overlaid with the user interface object 6136h. The user interface object 6136h has the material appearance 6126d determined based on the mapping 6106b. The really dark colors from the background 6128-5 (e.g., luminance values less than 0.1) all have corresponding material colors with similar material luminance values close to 0.1 and are slightly brighter than their background colors (e.g., above the reference mapping 6105 in the range with background point luminance less than 0.1, and material point luminance close to 0.1). For example, most of the regions of the material over the background portions outside the buildings (e.g., with a background point luminance less than 0.1) are slightly lighter than the original appearance of the background 6128-5 (e.g., with a material point luminance of 0.1). As a result, the material is visually set off from the very dark portions of the background 6128-5 surrounding the user interface object 6136h. The regions 6132* of the material over the black bars 6132 (with a background point luminance of 0) are also lightened (e.g., with a material point luminance value of 0.1, for example). The outlines of the buildings 6134 and windows 6130 are mapped to respective material colors that have reduced luminance values (e.g., regions 6134* appearing darker than their counterparts in the original background appearance 6128-5). For example, the regions 6130a*-6130f* corresponding to the six columns of windows 6130a-6130f are all darker compared to the remaining top portions of the six columns of windows 6130a-6130f that are not covered by the user interface object 6136h. The portions 6130a*-6130f* that correspond to these windows 6130 are also lighter when compared to the regions 6132* of the material that correspond to the black bars 6132, because the windows 6130a-6130f are all lighter than the black bars 6132 in terms of luminance in the original background appearance 6124e. The material appearance within the user interface object 6136h is not further modified with the addition of a color fill, because the color fill is applied to the “light” variants of the material, and not applied to the “dark” variants of the material, in accordance with some embodiments.

In FIG. 6B11, the graph 6102-3 shows a subset of the mappings that were shown in graph 6102-1 in FIG. 6B5. Specifically, the graph 6102-3 shows the mapping 6104d for a light variant of the user interface material, and the mapping 6106h for a dark variant of the user interface material, both of which correspond to AIL of 0.7, in some embodiments. The mapping 6104d is a representative of a light material mapping that has a counterpart dark material mapping for the same AIL, because the AIL is at the higher threshold AIL for the dark variants of the user interface material (e.g., 0.7 in this example, or another higher AIL threshold value in other embodiments), in accordance with some embodiments. The mapping 6106h is a representative of a dark material mapping that has a counterpart light material mapping for the same AIL, because the AIL is greater than the lower threshold AIL for the light variants of the user interface material (e.g., 0.3 in this example, or another lower AIL threshold value in other embodiments), in accordance with some embodiments.

As shown in FIG. 6B11, the mapping 6104d has an output material luminance range of [0.55 to 1.03] on the vertical axis of the graph 6102-3, which is a result of shifting the AIL upward by an offset of 0.45, and capping it above at 1.03, and shifting the AIL downward by an offset of −0.15. The center of the output material luminance range is 0.55+ (1.03−0.55)/2=(0.55+1.03)/2=0.79, and is offset from the AIL by 0.79−0.7=0.09. The slope of the mapping 6104d is a positive slope, which means, for input background colors of increasing luminance values, the corresponding output material colors also have increasing luminance values. The entirety of the mapping 6104d is above the reference mapping 6105, so the input background colors have corresponding output material colors that have higher luminance values than their input background colors.

This is visually illustrated in the pair of the material appearance 6122b and material appearance 6126a, overlaid on the same background appearance 6124b (e.g., from the second row of images in FIG. 6B9). In FIG. 6B11, on the left, the background appearance 6124b has an AIL of 0.7 for the relevant portion of the background 6128-2 for the user interface object 6136b. The background portion 6128-2 of the background appearance 6124b is fairly light with a range of luminance values below 1. The three buildings 6134 have the same luminance value as the background of the buildings 6134, but optionally with different background colors from the background of the buildings 6134 (e.g., three red buildings on a blue background, with the same luminance value). The first and sixth columns of windows 6130a and 6130f are white with a luminance value of 1. The second through the fifth columns windows 6130b-6130e have increasing lower luminance values below 1 (e.g., getting darker from left to right). The three bars 6132 at the bottom of the buildings are black with a luminance of 0. The outlines of the windows and the buildings are of various colors with the same medium luminance value that is between 0 and 1. The relevant portion of the background 6128-2 for determining the AIL includes the portion that is going to be covered by the user interface object 6136b and, optionally, a surrounding portion that is within a refraction-threshold distance from the outline of the user interface object 6136b, and the AIL comes out to be 0.7 for illustrative purposes.

In FIG. 6B11, on the left, the background 6128-2 with the background appearance 6124b is overlaid with the user interface object 6136b. The user interface object 6136b has a material appearance 6122b that is determined based on the mapping 6104-d. Most of the regions of the material over the background 6128-2 are ultra-white (e.g., with a luminance of 1.03, or another higher luminance capping value above 1). As a result, the material is visually set off from the background portions of the background 6128-2 surrounding the user interface object 6136b. The regions 6132* of the material over the black bars 6132 are lightened substantially (e.g., with a luminance value of 0.75 in this example). The outlines of the buildings 6134 and windows 6130 are also lightened, resulting in a material color that is lighter than the material color corresponding to the black bars 6132 (e.g., because the outlines of the buildings and windows are lighter than the black bars in the original background 6128-2). The material appearance within the user interface object 6136b is further modified with addition of a white fill 6139, where the magnitude of the fill opacity is selected based on the AIL of the relevant portion of the background, and is a value close to 30% (e.g., based on the graph 6118 in FIG. 6B6) in this example. The white fill is indicated by indication 6139b.

As shown in FIG. 6B11, the mapping 6106h has an output material luminance range of [0.5 to 0.8] on the vertical axis of the graph 6102-3, which is a result of shifting the AIL upward by an offset of 0.25 and capping it above at 0.8, and shifting the AIL downward by an offset of −0.2. The center of the output material luminance range is 0.5+(0.8−0.5)/2=0.65, which is offset by a value of 0.7-0.65=0.05 from the AIL of 0.7, smaller than the offset of 0.09 for the light variant of the material with the same AIL. The slope of the mapping 6106h is a positive slope, which means, for input background colors of increasing luminance values, the corresponding output material colors also have increasing luminance values. The right portion of the mapping 6106h is below the reference mapping 6105, while the left portion of the mapping 6106h is above the reference mapping 6105 (e.g., with the transition at the interception of around background point luminance of 0.6 in this example), so the input background colors that are relatively light have corresponding output material colors that are slightly darker than their input background colors, while input background colors that are relatively dark have corresponding output material colors that are slightly lighter than their input background colors, in some embodiments.

This is visually illustrated in the pair of the material appearance 6124b and background appearance overlaid with material appearance 6126a (from the second row of images in FIG. 6B9). In FIG. 6B11, on the right, the background appearance 6124b has an AIL of 0.7 for the relevant portion of the background 6128-2 for the user interface object 6136c. Most of the background 6128-2 with the background appearance 6124b is relatively light with a luminance value less than 1. The three buildings 6134 are also relatively light with a luminance value less than 1. The six columns of windows 6130a-6130f includes two columns of white windows 6130a and 6130f, and increasingly dark windows from 6130b-6130e. The windows represent various material point luminance values from 0.1 to 1. The three bars 6132 at the bottom of the buildings are black with a luminance of 0. The outlines of the windows and the buildings are of various colors with the same medium luminance value that is between 0 and 1, and the same as that of the windows 6130e. The AIL of the relevant portion of the background 6128-2 comes out to be 0.7 for illustrative purposes. In FIG. 6B11, on the right, the background is overlaid with the user interface object 6136c with material appearance 6126a. The material appearance 6126a is determined based on the mapping 6106h. The really dark colors from the background (e.g., luminance values less than 0.1 or other very small luminance values) have corresponding material colors with material luminance values around 0.5 (e.g., the lower capped value in this example) and are significantly brighter than their corresponding background colors (e.g., above the reference mapping 6105 in the range with background point luminance less than roughly 0.6 in this example). The regions 6132* of the material over the black bars 6132 (e.g., with a background point luminance of 0) are lightened (e.g., with a material point luminance value of 0.5 in this example). The outlines of the buildings 6134 and windows 6130 are mapped to respective material colors that have higher luminance values (e.g., appearing lighter than their counterparts in the original background appearance 6128-2). Most of the regions of the material over the background portions outside the buildings 6134 (e.g., with a background point luminance close to 0.7 in this example) are only slightly darker than the original appearance of the background 6128-2 (e.g., with a material point luminance slightly below the interception with the reference mapping 6105). Some of the regions 6130a*-6130f* corresponding to the six columns of windows 6130a-6130f (e.g., region 6130e* corresponding to the darkest column of windows 6130e) are lighter compared to the remaining top portions of the six columns of windows 6130a-6130f that are not covered by the user interface object 6136c, while some of the regions 6130a*-6130f* (e.g., region 6130a* and 6130f* corresponding to the lightest columns of windows) are darker compared to their corresponding background colors. The portions 6130a*-6130f* that correspond to these windows 6130a-6130f are also lighter when compared to the regions 6132* of the material that correspond to the black bars 6132, because the windows 6130 are all lighter than the black bars 6132 in terms of luminance in the original background appearance 6124b. The material appearance 6126a within the user interface object 6136c is not further modified with addition of a color fill, because the color fill is applied to the “light” variants of the material, and not applied to the “dark” variants of the material, in accordance with some embodiments.

In FIG. 6B12, the graph 6102-4 shows a subset of the mappings that were shown in graph 6102-1 in FIG. 6B5. Specifically, the graph 6102-4 shows the mapping 6104f for a light variant of the user interface material, and the mapping 6106f for a dark variant of the user interface material, both of which correspond to AIL of 0.5. The mapping 6104f is a representative of a light material mapping that has a counterpart dark material mapping for the same AIL, because the AIL is below the higher threshold AIL for the dark variants of the user interface material (e.g., 0.7 in this example, or another higher AIL threshold value in other embodiments), in accordance with some embodiments. The mapping 6106f is a representative of a dark material mapping that has a counterpart light material mapping for the same AIL, because the AIL is greater than the lower threshold AIL for the light variants of the user interface material (e.g., 0.3 in this example, or another lower AIL threshold value for other embodiments), in accordance with some embodiments.

As shown in FIG. 6B12, the mapping 6104f has an output material luminance range of [0.35 to 0.95] on the vertical axis of the graph 6102-4, which is a result of shifting the AIL upward by an offset of 0.45, and shifting the AIL downward by an offset of −0.15. The center of the output material luminance range is 0.35+(0.95−0.35)/2=(0.35+0.95)/2=0.65, and is offset from the AIL by 0.65−0.5=0.15. The slope of the mapping 6104f is a positive slope, which means for input background colors of increasing luminance values, the corresponding output material colors also have increasing luminance values. Most of the mapping 6104f is above the reference mapping 6105, except for the portion corresponding to relatively high input background point luminance values (e.g., 0.7-1 in this example, or another high luminance portion in other embodiments), so the input background colors have corresponding output material colors that have higher luminance values than their input background colors (e.g., for most input background point luminance values in the low and medium ranges of values), except for the input background colors with the highest luminance values.

This is visually illustrated in the pair of the background appearance 6124c and background appearance overlaid with material appearance 6122c (e.g., in the third row of images in FIG. 6B9). In FIG. 6B12, on the left, the background appearance 6124c has an AIL of 0.5 for the relevant portion of the background for the user interface object 6136d. The background 6128-3 with the background appearance 6124c is of medium brightness. The three buildings 6134 has the same luminance value as the background of the buildings, but optionally with different background colors from the background of the buildings (e.g., three red buildings on a blue background, with the same luminance value). The first and sixth columns of windows 6130a and 6130f are white with a luminance value of 1. The second through the fifth columns windows 6130b-6130e have increasingly lower luminance values below 1. The three bars 6132 at the bottom of the buildings are black with a luminance of 0. The outlines of the windows 6130 and the buildings 6134 are of various colors with the same medium luminance value that is between 0 and 1. The relevant portion of the background 6128-3 for determining the AIL includes the portion that is going to be covered by the user interface object 6136d and, optionally, a surrounding portion that is within a refraction-threshold distance from the outline of the user interface object 6136d, and the AIL comes out to be 0.5 for illustrative purposes. In FIG. 6B12, on the left, the background 6128-3 with the background appearance 6124c is overlaid with the user interface object 6136d. The material appearance 6122c of the material in the user interface object 6136d is determined based on the mapping 6104f. Most of the regions of the material over the background portions of the background 6128-2 are lighter than the underlying background (e.g., because this portion of the background is not very bright and the mapping 6014f boosted the luminance values of the material colors in this input luminance range). As a result, the material is visually set off from the background portions of the background 6128-3 surrounding the user interface object 6136d. The regions 6132* of the material over the black bars 6132 are lightened (e.g., with a luminance value of 0.35 in this example, according to the example mapping 6104f). The outlines of the buildings 6134 and windows 6130 are also lightened, resulting in a material color that is lighter than the material color corresponding to the black bars (e.g., because the outlines are lighter than the black bars in the original background 6128-3). The regions 6130a* and 6130f* that correspond to the white windows 5130a and 6130f appear darker than their original background colors, because the mapping 6104f reduces the luminance for the brightest background colors (e.g., in the range of 0.7 to 1 in this example, or another highest luminance range in other embodiments). The regions 6130b*-6130e* are fairly close in luminance to their original background colors in the second through the fifth columns windows 6130b-6130e (e.g., the mapping 6104f is fairly close to the reference mapping 6105 in the medium background luminance range), and still have increasingly lower luminance values below 1 (e.g., the mapping 6104f does not invert luminance of background colors or change the directional relationship of the background colors when converting background colors to material colors). The material appearance 6122c within the user interface object 6136c is further modified with addition of a white fill 6139, where the magnitude of the fill opacity is selected based on the AIL of the relevant portion of the background, and is a value close to 25% in this example (e.g., according to the curve 6118 in FIG. 6B6). The white fill is indicated by indication 6139c.

As shown in FIG. 6B12, the mapping 6106f has an output material luminance range of [0.3 to 0.75] on the vertical axis of the graph 6102-4, which is a result of shifting the AIL upward by an offset of 0.25, and shifting the AIL downward by an offset of −0.2. The center of the output material luminance range is 0.3+(0.75−0.3)/2=0.525, which is offset by a value of 0.525−0.5=0.025 from the AIL of 0.5, smaller than the offset of 0.15 for the light variant of the material with the same AIL. The slope of the mapping 6106f is a positive slope, which means, for input background colors of increasing luminance values, the corresponding output material colors also have increasing luminance values. The entire right portion of the mapping 6106f is below the reference mapping 6105, while most of the left portion of the mapping is above the reference mapping 6105 (e.g., with the transition at the interception of around background point luminance of 0.4 to 0.5, in this example), so the input background colors that are relatively light have corresponding output material colors that are darker than their input background colors, while input background colors that are relatively dark have corresponding output material colors that are lighter than their input background colors.

This is visually illustrated in the pair of the background appearance 6124c and background appearance 6124c overlaid with material appearance 6126b (e.g., in the third row of images in FIG. 6B9). In FIG. 6B12, on the right, the background appearance 6124c has an AIL of 0.5 for the relevant portion of the background 6128-3 for the user interface object 6136e. Most of the background 6128-3 with the background appearance 6124c has a medium luminance. The three buildings 6134 are also of the same medium luminance. The six columns of windows 6130a-6130f include two columns of white windows 6130a and 6130f, and increasingly dark windows 6130b-6130e. The windows 6130 represent various material point luminance values from 0.1 to 1. The three bars 6132 at the bottom of the buildings 6134 are black with a luminance of 0. The outlines of the windows 6130 and the buildings 6134 are of various colors with the same medium luminance value that is between 0 and 1, and the same as that of the windows 6130e. The AIL of the relevant portion of the background 6128-3 comes out to be 0.5 for illustrative purposes. In FIG. 6B12, on the right, the background 6128-c with background appearance 6124c is overlaid with the user interface object 6136e. The user interface object 6136e has the material appearance 6126b that is determined based on the mapping 6106f. The really dark colors from the background 6128-3 (e.g., luminance values less than 0.1 or another low value) have corresponding material colors with material luminance values above 0.3 (e.g., due to the lower capping value for the dark materials) and are brighter than their background colors (e.g., above the reference mapping 6105 in the range with background point luminance less than 0.45 in this example). The regions 6132* of the material over the black bars 6132 (with a background point luminance of 0) are lightened (e.g., with a material point luminance value of 0.3 in this example). The outlines of the buildings 6134 and windows 6130 are mapped to respective material colors that have higher luminance values (e.g., appearing lighter than their counterparts in the original background appearance). Most of the regions of the material over the background portions outside the buildings (e.g., with a background point luminance close to 0.7 in this example) are close to or slightly darker than the original appearance of the background (e.g., with a material point luminance slightly below the interception with the reference mapping 6105, in this example). The regions 6130a*-6130f* corresponding to the six columns of windows 6130a-6130f are all darker compared to the remaining top portions of the six columns of windows 6130a-6130f that are not covered by the user interface object 6136c. The portions 6130a*-6130f* that correspond to these windows 6130 are also lighter when compared to the regions 6132* of the material that correspond to the black bars 6132, because the windows 6130 are all lighter than the black bars 6132 in terms of luminance in the original background appearance 6124c. The material appearance within the user interface object 6136e is not further modified with addition of a color fill, because the color fill is applied to the “light” variants of the material, and not applied to the “dark” variants of the material, in accordance with some embodiments.

In FIG. 6B13, the graph 6102-5 shows a subset of the mappings that were shown in graph 6102-1 in FIG. 6B5. Specifically, the graph 6102-5 shows the mapping 6104h for a light variant of the user interface material, and the mapping 6106d for a dark variant of the user interface material, both of which correspond to AIL of 0.3. The mapping 6104h is a representative of a light material mapping that has a counterpart dark material mapping for the same AIL, because the AIL is below the higher threshold AIL for the dark variants of the user interface material (e.g., 0.7 in this example, or another higher AIL threshold value in other embodiments), in accordance with some embodiments. The mapping 6106d is a representative of a dark material mapping that has a counterpart light material mapping for the same AIL, because the AIL is greater than or at the lower threshold AIL for the light variants of the user interface material (e.g., 0.3 in this example, or another lower AIL threshold value in other embodiments), in accordance with some embodiments.

As shown in FIG. 6B13, the mapping 6104h has an output material luminance range of [0.15 to 0.75] on the vertical axis of the graph 6102-5, which is a result of shifting the AIL upward by an offset of 0.45, and shifting the AIL downward by an offset of −0.15. The center of the output material luminance range is 0.15+(0.75−0.15)/2=(0.15+0.75)/2=0.45, and is offset from the AIL by 0.45−0.3=0.15. The slope of the mapping 6104d is a positive slope, which means for input background colors of increasing luminance values, the corresponding output material colors also have increasing luminance values. Only the left-most portion of the mapping 6104h is above the reference mapping 6105, while the right portion of the mapping 6104h is below the reference mapping 6105. Thus, most of the input background colors have corresponding output material colors with lower luminance values than their input background colors (e.g., for most input background point luminance values except for the very small background point luminance values).

This is visually illustrated in the pair of the background appearance 6124d and background appearance 6124d overlaid with material appearance 6122d (e.g., in the fourth row of images in FIG. 6B9). In FIG. 6B13, on the left, the background 6128-4 with background appearance 6124d has an AIL of 0.3 for the relevant portion of the background 6128-4 for the user interface object 6136f. Most of the background 6128-4 with the background appearance 6124d is of relatively low luminance. The three buildings 6134 has the same luminance value as the background of the buildings, but optionally with different background colors from the background of the buildings (e.g., three red buildings on a blue background, with the same luminance value). The first and sixth columns of windows 6130a and 6130f are white with a luminance value of 1. The second through the fifth columns windows 6130b-6130e have increasingly lower luminance values below 1. The three bars 6132 at the bottom of the buildings are black with a luminance of 0. The outlines of the windows 6130 and the buildings 6134 are of various colors with the same medium luminance value that is between 0 and 1. The relevant portion of the background 6128-4 for determining the AIL includes the portion that is going to be covered by the user interface object 6136f and, optionally, a surrounding portion that is within a refraction-threshold distance from the outline of the user interface object 6136f, and the AIL comes out to be 0.3 for illustrative purposes. In FIG. 6B13, on the left, the background 6128-4 with the background appearance 6124d is overlaid with the user interface object 6136f. The user interface object 6136f includes a light material with the material appearance 6122d that is determined based on the mapping 6104h. Most of the regions of the material over the background portions of the background 6128-4 are lighter than the underlying background (e.g., because this portion of the background is very dark and the mapping 6016h boosted the luminance values of the material colors in this input background luminance range). As a result, the material is visually set off from the background portions of the background 6128-4 surrounding the user interface object 6136f. The regions 6132* of the material over the black bars 6132 are lightened (e.g., with a luminance value of 0.15 in this example, based on the mapping 6104h). The outlines of the buildings 6134 and windows 6130 are also lightened, resulting in a material color that is lighter than the material color corresponding to the black bars 6132 (e.g., because the outlines are lighter than the black bars in the original background 6128-4). The regions 6130a* and 6130f* that correspond to the white windows 5130a and 6130f appear darker than their original background colors, because the mapping 6104h reduces the luminance for the brightest background colors (e.g., in the range of 0.3 to 1 in this example, or another higher luminance range in other embodiments). The regions 6130b*-6130e* are also darker than original background colors in the second through the fifth columns windows 6130b-6130e (e.g., the mapping 6104h is below the reference mapping 6105 in the medium to high background luminance ranges), and still have increasingly lower luminance values below 1 (e.g., the mapping 6104h does not invert luminance of background colors or change the directional relationship of the background colors when converting background colors to material colors). The material appearance within the user interface object 6136d is not further modified with addition of a white fill 6139, because the fill opacity is zero for AIL less than 0.35 in the example curve 6118 shown in FIG. 6B6.

As shown in FIG. 6B13, the mapping 6106d has an output material luminance range of [0.1 to 0.55] on the vertical axis of the graph 6102-5, which is a result of shifting the AIL upward by an offset of 0.25, and shifting the AIL downward by an offset of −0.2, and capping below at 0.1. The center of the output material luminance range is 0.1+(0.55−0.1)/2=0.325, which is offset by a value of 0.325−0.3=0.025 from the AIL of 0.3, smaller than the offset of 0.15 for the light variant of the material with the same AIL. The slope of the mapping 6106d is a positive slope, which means for input background colors of increasing luminance values, the corresponding output material colors also have increasing luminance values. Most of the mapping 6106d is below the reference mapping 6105, except for the left most portion of the mapping (e.g., with the transition at the interception of around background point luminance of roughly 0.15 in this example), so most input background colors have corresponding output material colors that are darker than their input background colors, except for the darkest background colors.

This is visually illustrated in the pair of the background appearance 6124d and background appearance overlaid with material appearance 6126c (e.g., in the fourth row of images in FIG. 6B9). In FIG. 6B13, on the right, the background appearance 6124d has an AIL of 0.3 for the relevant portion of the background 6128-4 for the user interface object 6136g. Most of the background 6128-4 with the background appearance 6124d has a low luminance value. The three buildings 6134 are also of low luminance. The six columns of windows 6130a-6130f includes two columns of white windows 6130a and 6130f, and increasingly dark windows from 6130b-6130e. The windows represent various material point luminance values from 0.1 to 1. The three bars 6132 at the bottom of the buildings are black with a luminance of 0. The outlines of the windows and the buildings are of various colors with the same medium luminance value that is between 0 and 1, and the same as that of the windows 6130e. The AIL of the relevant portion of the background 6128-4 comes out to be 0.3 for illustrative purposes. In FIG. 6B13, on the right, the background 6128-4 with the background appearance 6124d is overlaid with the user interface object 6136g. The user interface object 6136g has a material with the material appearance 6126c that is determined based on the mapping 6106d. The really dark colors from the background (e.g., luminance values less than 0.15 in this example, according to example mapping 6106d) have corresponding material colors with material luminance values above 0.1 (e.g., the lower capped value of mapping 6106d in this example) and are brighter than their background colors (e.g., above the reference mapping 6105 in the range with background point luminance less than 0.15 in this example, according to the example mapping 6106d). The regions 6132* of the material over the black bars 6132 (with a background point luminance of 0) are lightened (e.g., with a material point luminance value of 0.1 in this example, according to the example mapping 6106d). The outlines of the buildings 6134 and windows 6130 are mapped to respective material colors that have lower luminance values (e.g., appearing darker than their counterparts in the original background appearance). Most of the regions of the material over the background portions outside the buildings (e.g., with a background point luminance close to 0.7) are close to or slightly lighter than the original appearance of the background (e.g., with a material point luminance slightly above the interception with the reference mapping 6105). The regions 6130a*-6130f* corresponding to the six columns of windows 6130a-6130f are all darker compared to the remaining top portions of the six columns of windows 6130a-6130f that are not covered by the user interface object 6136g. The portions 6130a*-6130f* that correspond to these windows 6130a-6130f are also lighter when compared to the regions 6132* of the material that correspond to the black bars 6132, because the windows 6130 are all lighter than the black bars 6132 in terms of luminance in the original background appearance 6124d. The material appearance within the user interface object 6136g is not further modified with addition of a color fill, because the color fill is applied to the “light” variants of the material, and not applied to the “dark” variants of the material, in accordance with some embodiments.

The examples provided with respect to FIGS. 6A-6B13 are merely illustrative, and there are many possible variations of the parameters mentioned in these examples. Tables 3A-3F below provides some additional examples, where the parameter values of various parameter used in the generation of material appearances of user interface objects are varied based on different considerations. In some embodiments, the set of rules and/or parameter values used to generate the material appearance of an object change based on material types selected for the user interface object (e.g., “regular” or “blurry” glassy material vs. “clear” glassy material), to provide material appearances that is translucent or highly transparent to background content. In some embodiments, the set of rules and/or parameter values used to generate the material appearance of an object change based on interactive states of the object (e.g., whether the user interface object is in a selected state and/or have input focus, an unselected state and does not have input focus, or in a subdued state and cannot be selected). In some embodiments, the set of rules and/or parameter values used to generate the material appearance of an object change based whether the object is overlaid on top of another object that has the glassy material. In some embodiments, the set of rules and/or parameter values used to generate the material appearance of an object change based on the object type of the object (e.g., different types of objects, such as keyboard, notifications, controls in control center, controls in media player, application icons, home screen dock, and/or other object types, have different rules and parameter values for the generation of the material appearances). In some embodiments, the computer system provides some special categories of user interface objects that have dynamic behavior and appearances when they are subject to user interaction. For example, in some embodiments, a selection indicator in a segmented control can change appearance, and takes on a glassy appearance when the user interacts with a portion of the segmented control that corresponds to a control function. In some embodiments, a switch or slider that does not have a glassy appearance can transform to include a portion that has a glassy appearance when a user interacts with the switch or slider control. In some embodiments, the switch or slider can have a reduced glassy appearance when it is displayed without user interaction, and transforms to have a more prominent glassy appearance when user interacts with the switch or slider control. In some embodiments, a text selection loupe or other types of user interface objects that are transparent to content underlying the user interface objects, are displayed with material appearances that are generated with yet another set of rules and parameter values for various processing steps applied to the background content of the user interface objects. In some embodiments, the computer system further modifies how the material appearance of a user interface object is generated based on whether an accessibility mode is turned on for the computer system to increase contrast or reduce transparency of the material of the user interface objects. The second row of Tables 3A-3F identifies various example user interface objects and their appearances and behaviors are illustrated in various portions of the present disclosure. The columns in Tables 3A-3F provide example sets of rules regarding how relative parameter values of different process procedures (e.g., the blur variation in the blur layer 6003A, the internal refraction layer 6003C-1, the external refraction layer 6003C-2, the shadow layer 6003D, the vibrant color intensity in VCM 6003E, the adaptive behavior of the VCM, the behavior with regard to light and dark display modes of the computer system, the edge bleed and sheen layer 6003F, the tint color matrix 6003G, the edge color matrix 6003H, the lensing layer 6003J, and the specular highlights layer 6003K, and optionally other visual effects and modifications to material appearances) can be varied in different usage cases, in accordance with some embodiments. Additional details are provided with respect to methods 14000 and 19000, in accordance with various embodiments.

TABLE 3A

| | | | Inactive or |
|---|---|---|---|
| User Interface Material Type | Regular | Clear | Subdued |
| Examples | (e.g., baseline | FIG. 5AA | FIG. 6J (444, 446), |
| | for materials | (1104), 6AC | 6M (controls in |
| | unless otherwise | (6730) | 6401), and/or 6S |
| | noted) | | (6606) |
| Blur Amount (6003A) | Standard | Reduced | Increased |
| Blur Variation (6003A) | Varies spatially | Does not vary | Varies spatially |
| | | spatially | |
| Internal Refraction (6003C-1) | Standard | Increased | Reduced or None |
| External Refraction (6003C-2) | Standard | Increased | Reduced or None |
| Shadow (6003D) | Standard | Reduced or | Reduced or None |
| | | None | |
| Vibrant Color Matrix Intensity | Standard | Standard | Darker or more |
| (6003E) | | | opaque |
| Vibrant Color Matrix Adaptive | More adaptive | Less adaptive | More adaptive (e.g., |
| (6003E) | (e.g., as | or not | as described in |
| | described in | adaptive | method 19000) |
| | method 19000) | | |
| Dark/Light Mode | NA (Adaptive) | No | NA (Adaptive) |
| Edge Bleed/Sheen (6003F) | Standard | Reduced or | Reduced or None |
| | | None | |
| Tint Vibrant Color Matrix | Standard | Standard | Standard |
| (6003G) | | | |
| Edge Color Matrix (6003H) | Standard | Increased | Reduced or None |
| Lens (6003J) | Standard | Standard | Standard |
| Specular (6003K) | Standard | Increased | Reduced or None |

TABLE 3B

| | UI Elements on | | Notifications and |
|---|---|---|---|
| User Interface Material Type | Glass Material | Keyboard | Wake Screen Controls |
| Examples | FIGS. 6U, 6W- | FIG. 5Q | FIGS. 5AB (1122), |
| | 6AA (6708), | (734) | 5AE-5AG (1122, |
| | 5Z1-5Z4 (922-1, | | 1123a, 1123b) |
| | 922-3) | | |
| Blur Amount (6003A) | Standard | Increased | Reduced |
| Blur Variation (6003A) | Varies spatially | Varies | Does not vary |
| | | spatially | spatially |
| Internal Refraction (6003C-1) | Reduced or | Standard | Increased |
| | None | | |
| External Refraction (6003C-2) | Reduced or | Reduced or | Increased |
| | None | None | |
| Shadow (6003D) | Standard | Reduced or | Reduced or None |
| | | None | |
| Vibrant Color Matrix Intensity | Darker or more | Darker or | Reduced, Not |
| (6003E) | opaque | more opaque | adaptive |
| Vibrant Color Matrix Adaptive | Less adaptive or | Less adaptive | Less adaptive or not |
| (6003E) | not adaptive | or not | adaptive |
| | | adaptive | |
| Dark/Light Mode | Yes | Yes | Yes |
| Edge Bleed/Sheen (6003F) | Standard | Reduced or | Reduced or None |
| | | None | |
| Tint Vibrant Color Matrix | Standard | Standard | Standard |
| (6003G) | | | |
| Edge Color Matrix (6003H) | Reduced or | Increased | Increased, Brighter |
| | None | | |
| Lens (6003J) | Standard | Standard | Standard |
| Specular (6003K) | Reduced or | Increased | Increased, Brighter |
| | None | | |

TABLE 3C

| | | Media Player | |
|---|---|---|---|
| User Interface Material Type | Control Center | Controls | App Icons |
| Examples | FIGS. 6K-6R2 | FIGS. 6U- | App icons and or |
| | (displayed | 6AN (6720) | widgets shown in |
| | controls) | | FIGS. 5I1-5I2, 5J- |
| | | | 5M, and/or 6I-6J, |
| | | | 6Q-6R2 |
| Blur Amount (6003A) | Reduced | Reduced | Reduced |
| Blur Variation (6003A) | Varies spatially | Does not vary | Does not vary |
| | | spatially | spatially, Varies |
| | | | based on size |
| Internal Refraction (6003C-1) | Increased | Increased | Increased, Varies |
| | | | based on size |
| External Refraction (6003C-2) | Increased | Increased | Increased, Varies |
| | | | based on size |
| Shadow (6003D) | Reduced or | Reduced or | Reduced or None |
| | None | None | |
| Vibrant Color Matrix Intensity | Standard | Standard | Standard |
| (6003E) | | | |
| Vibrant Color Matrix Adaptive | Less adaptive or | Less adaptive | Less adaptive or not |
| (6003E) | not adaptive | or not | adaptive |
| | | adaptive | |
| Dark/Light Mode | Yes | No | Yes |
| Edge Bleed/Sheen (6003F) | Reduced or | Reduced or | Reduced or None |
| | None | None | |
| Tint Vibrant Color Matrix | Standard | Standard | Standard |
| (6003G) | | | |
| Edge Color Matrix (6003H) | Increased | Increased | Increased |
| Lens (6003J) | Standard | Standard | Standard |
| Specular (6003K) | Increased | Increased | Increased |

TABLE 3D

| | | | Selection Indicator |
|---|---|---|---|
| | Home Screen | | for Segmented |
| User Interface Material Type | Dock | Camera | Control or Tab Bar |
| Examples | FIGS. 6I-6L | | FIGS. 5Z1-5Z4 |
| | (6403) | | (922-2) and 6U |
| Blur Amount (6003A) | Reduced | Standard | Reduced or None |
| Blur Variation (6003A) | Does not vary | Varies | Does not vary |
| | spatially | spatially | spatially |
| Internal Refraction (6003C-1) | Increased | Standard | Increased, with |
| | | | Chromatic |
| | | | Aberation |
| External Refraction (6003C-2) | Increased | Reduced or | Increased |
| | | None | |
| Shadow (6003D) | Reduced or | Reduced or | Increased |
| | None | None | |
| Vibrant Color Matrix Intensity | Standard | Standard | Standard |
| (6003E) | | | |
| Vibrant Color Matrix Adaptive | Less adaptive or | More adaptive | Less adaptive or not |
| (6003E) | not adaptive | (e.g., method | adaptive |
| | | 19000) | |
| Dark/Light Mode | Yes | NA | Yes |
| | | (Adaptive) | |
| Edge Bleed/Sheen (6003F) | Reduced or | Standard | Reduced or None |
| | None | | |
| Tint Vibrant Color Matrix | Standard | Standard | Standard |
| (6003G) | | | |
| Edge Color Matrix (6003H) | Increased, | Standard | Increased |
| | Thicker | | |
| Lens (6003J) | Standard | Standard | Standard |
| Specular (6003K) | Increased, | Standard | Increased |
| | Thicker | | |

TABLE 3E

| | Switch or Slider | Switch or Slider | |
|---|---|---|---|
| | Input Elements | Input Elements | |
| | (During | (Without | Text Selection |
| User Interface Material Type | Interaction) | Interaction) | Loupe |
| Examples | FIG. 5AA | FIG. 5AA | FIG. 5Z (909 |
| | (1104-1 and/or | (1104-2 and/or | and/or 912) |
| | 1104-4) | 1104-3) | |
| Blur Amount (6003A) | Reduced or | Increased | Reduced or None |
| | None | | |
| Blur Variation (6003A) | Does not vary | Varies spatially | Does not vary |
| | spatially | | spatially |
| Internal Refraction (6003C-1) | Increased, with | Reduced or | Increased, with |
| | Chromatic | None | Chromatic |
| | Aberation | | Aberation |
| External Refraction (6003C-2) | Increased | Reduced or | Increased |
| | | None | |
| Shadow (6003D) | Increased | Reduced or | Increased |
| | | None | |
| Vibrant Color Matrix Intensity | Standard | Darker or more | Standard |
| (6003E) | | opaque | |
| Vibrant Color Matrix Adaptive | Less adaptive or | Less adaptive or | Less adaptive or |
| (6003E) | not adaptive | not adaptive | not adaptive |
| Dark/Light Mode | Yes | Yes | Yes |
| Edge Bleed/Sheen (6003F) | Reduced or | Reduced or | Reduced or None |
| | None | None | |
| Tint Vibrant Color Matrix | Standard | Standard | Standard |
| (6003G) | | | |
| Edge Color Matrix (6003H) | Increased | Reduced or | Increased |
| | | None | |
| Lens (6003J) | Standard | Standard | Standard |
| Specular (6003K) | Increased | Reduced or | Increased |
| | | None | |

TABLE 3F

| | | |
|---|---|---|
| | Modifications to increase | Modifications to reduce |
| | contrast (can be applied | transparency (can be |
| User Interface Material Type | to any material) | applied to any material) |

Examples

| | | |
|---|---|---|
| Blur Amount (6003A) | | None, Use Average Color |
| Blur Variation (6003A) | | None |
| Internal Refraction (6003C-1) | | None |
| External Refraction (6003C-2) | | None |
| Shadow (6003D) | | |
| Vibrant Color Matrix Intensity | Increased Contrast | Increased Contrast |
| (6003E) | | |
| Vibrant Color Matrix Adaptive | | |
| (6003E) | | |
| Dark/Light Mode | | |
| Edge Bleed/Sheen (6003F) | | |
| Tint Vibrant Color Matrix | | |
| (6003G) | | |
| Edge Color Matrix (6003H) | Inverted | |
| Lens (6003J) | | |
| Specular (6003K) | Inverted | |

Table 3F includes modifications that can be made based on one or more computer system settings to one or more of the user interface materials described herein (e.g., the user interface materials shown in Tables 3A-3F). These modifications are optionally made to multiple different user interface materials that are used in different contexts in user interfaces of the computer system (e.g., different user interface materials that are displayed separately or sequentially in different applications or operating system user interface and/or are concurrently displayed). These modifications can provide improved legibility and/or performance in certain situations. In some embodiments, the modifications to increase contrast are applied (e.g., to one or multiple different user interface materials) without applying the modifications to reduce transparency. In some embodiments, the modifications to reduce transparency are applied (e.g., to one or multiple different user interface materials) without applying the modifications to increase contrast. In some embodiments, the modifications to increase contrast are applied (e.g., to one or multiple different user interface materials) concurrently with applying the modifications to reduce transparency.

FIG. 6C illustrates the spatial relationship between the portions of the underlying content that are used to generate the appearance of the simulated refraction (e.g., the simulated refraction 6008′, 6012′, and 6010′ of underlying content, in the simulated refraction layer 6003C in FIGS. 6A-6B13, and/or simulated refraction 6048-1′, 6048-2′, 6048-3′, 6040′, 6044′ and 6066′ in FIG. 6C), and the portions of underlying content that are used to generate the appearance of the simulated shadow 6052 (e.g., the simulated shadow 6018 in the simulated shadow layer 6003D in FIGS. 6A-6B13, and/or simulated shadow 6052-1″, 6052-2″, 6052-3″, 6044″ and 6046″ in FIG. 6C), in accordance with some embodiments.

In the example shown in FIG. 6C, the outline of the user interface object 6004 is shown in dashed lines in three states (e.g., state 1, state 2, and/or state 3) illustrated in the left column of FIG. 6C. The underlying content 6048 that is concurrently displayed with the user interface object 6004 includes a first object (e.g., a triangle 6040) and a second object (e.g., circle 6042), where the first object further includes a first internal object (e.g., the higher line 6044 in the triangle 6040) and a second internal object (e.g., the lower line 6046 in the triangle 6040). The internal objects 6044 and 6046 are used to illustrate different portions of the internal content of the first object 6040 that are located in different subregions of the first object 6040. It is to be understand that the first object 6040 and the second object 6042 can represent any type of content underlying and/or are concurrently displayed with the user interface object 6004 in a user interface and/or display area provided via one or more display generation components, including but not limited to windows, icons, platters, controls, buttons, sliders, control modules, icons, application icons, menus, text, documents, wallpaper, images, representation of a physical environment in an augmented reality environment, a representation of a virtual three-dimensional environment, video content, animated content, distributions of lines and colors, textures, patterns, virtual keyboards, and/or other types of content.

In the left column of FIG. 6C, the three different states correspond to different spatial relationships and/or arrangements between the user interface object 6004 and the underlying content 6048 (e.g., including the first object 6040, the second object 6042, and the background of the first object 6040 and the second object 6042). In addition, the three different states also correspond to a scenario where the appearance of the portion of the content 6048 (e.g., denoted as content 6048-1, 6048-2, and 6048-3, respectively) that directly underly the user interface object 6004 and the appearance of the portion of the content 6048 that is adjacent and/or near the outline of the user interface object 6004 have changed over time through the three different states.

In some embodiments, the spatial arrangement between the user interface object 6004 and the underlying content 6048 changes when the user interface object 6004 is moved relative to the underlying content 6048 (e.g., the user interface object is dragged, resized, animated, and/or scrolled in a user interface containing the user interface object 6004 and the underlying content 6048), and/or when the user interface object 6004 changes dimensions as visual feedback to external input directed toward the user interface object 6004 (e.g., a tap input causes the user interface object 6004 to bounce, lift up, and/or temporarily changes size and shape). In some embodiments, the spatial arrangement between the underlying content 6048 and the user interface object 6004 changes when the underlying content 6048 (e.g., the first object 6040 and the second object 6042) is moved relative to the user interface object 6004 (e.g., the first object 6040 and/or the second object 6042 are dragged, resized, animated, and/or scrolled in a user interface), and/or when the underlying content 6048 (e.g., the first object 6040 and/or the second object 6042) changes dimensions as visual feedback to external input directed toward the underlying content 6048 (e.g., a swipe input causes the first object 6040 or second object 6042 to bounce, lift up, and/or temporarily changes size and shape). In some embodiments, the user interface object 6004 can change size, position, and/or shape as part of a transition from a first type of object to a second type of object different from the first type of object, and/or from corresponding to a first function to corresponding to a second function different from the first function (e.g., the user interface material changes shape and size, and/or the internal content indicating the function of the user interface object). In some embodiments, the first object 6040 and/or the second object 6044 can change sizes, positions, and/or shapes as part of an animated transition that occurs in the underlying content 6048. In some embodiments, the internal content of the first object 6040 and/or the second object 6044 can change appearances, sizes, positions, and/or shapes relative to the outlines of the first object 6040 and/or the second object 6044, and have the changes reflected in the simulated refraction and/or simulated shadow of the user interface object 6004.

As described with respect to FIGS. 6A and 6B1-6B3, the appearance of the user interface object 6004 is based on the appearance of a first portion of the underlying content (e.g., content 6048-1, 6048-2, 6048-3, respectively) that is located directly behind the user interface object 6004 (e.g., within the outline of the user interface object 6004) and a second portion of the underlying content that is located outside of the user interface object and near the outline of the user interface object (e.g., without a refraction-threshold distance for simulated refraction, and/or within a shadow-threshold distance for simulated shadow). The appearance of the user interface object 6004 simulates refraction of the first portion of the underlying content and the second portion of the underlying content. In some embodiments, the second portion of the underlying content 6048 that is located outside of the user interface object 6004 and near the outline of the user interface object 6004 includes a portion of the underlying content that is within a refraction threshold distance from the outline of the user interface object (e.g., within the external refraction region 6003C-2 in FIG. 6A).

In some embodiments, the appearance of the simulated shadow 6052 displayed outside of the user interface object 6004 along the outline of the user interface object 6004 is based on the appearance of a third portion of the underlying content that is located outside of the user interface object 6004 and that is within a shadow threshold distance from the outline of the user interface object 6004. In some embodiments, the shadow threshold distance is greater than the refraction threshold distance, so at least a portion of the underlying content that provides the basis for the simulated shadow 6052 is not included in the second portion of the underlying content that provides the basis for the simulated refraction within the user interface object 6004. In some embodiments, the simulated shadow 6052 is displayed outside of a portion of the outline of the user interface object based on the direction and intensity of the light source (e.g., below the bottom edge, off to right of the right edge, and/or off to the left of the left edge, depending on the direction of the light source and/or the orientation of the computer system). In some embodiments, at least part of the second portion of the underlying content that is used as the basis for the simulated refraction is not included in the third portion of the underlying content that provides the basis for the simulated shadow 6052 (e.g., 6052-1, 6052-2, and 6052-3, respectively). However, at least a portion of the second portion of the underlying content that is used to provides the basis for the simulated refraction within the outline of the user interface object 6004 is also used to provide the basis for the simulated shadow 6052, and the second portion of the underlying content (e.g., all or a subset of the portion outside of the outline of the user interface object and within the refraction-threshold distance from the outline of the user interface object 6004) partially overlaps with the third portion of the underlying content (e.g., all or a subset of the portion outside of the outline of the user interface object and within the shadow-threshold distance from the outline of the user interface object) in a first region of the underlying content (e.g., a non-zero region that is a subset of the second portion and a subset of the third portion of the underlying content).

As described in FIG. 6A, in some embodiments, the simulated refraction layer 6003C is generated independently from the simulated shadow layer 6003D, from a blur layer 6003B that is generated based on the underlying content 6003A; and therefore, in some embodiments, the simulate shadow overlays a portion of the underlying content that is used to generate the simulated refraction (e.g., the first region of the underlying content), while the simulated refraction is generated without taking into account of the appearance of the simulated shadow 6052 overlaying that portion of the underlying content.

In the illustrative example in FIG. 6C, the right column shows the simulated shadow 6052 and the simulated refraction associated with the user interface object 6004, in each of the three states in the left column. In the first row of FIG. 6C, the underlying content 6048 is in state 1 (e.g., with a subset of the content 6048-1 within the outline of the user interface object 6004), the simulated shadow 6052-1 is overlaid on a portion of the underlying content 6048 that includes the middle portion of the triangle 6040 (including the higher line 6044, but not the lower line 6046) and the top half of the circle 6042. Correspondingly, the appearance of the simulated shadow 6052-1 is based on the appearance of the portion of the underlying content 6048 that includes the top of the triangle 6040 (e.g., including the higher line 6044, but not the lower line 6046) and the top half of the circle 6042. More specifically, the appearance of the simulated shadow 6052-1 includes a darkened representation 6044″ of the middle portion of the triangle 6040 including the higher line 6044, and a darkened representation 6042″ of the top half of the circle 6042.

As shown in FIG. 6C, in the first row, the simulated refraction is included within the outline of the user interface object 6004, and is based on both the portion of the underlying content that is completely within the outline of the user interface object 6004 (e.g., the top of the triangle 6040) and the portion of the underlying content that is outside the outline of the user interface object 6004 but within the refraction-threshold distance from the outline of the user interface object 6004 (e.g., including the middle portion of the triangle 6040, including the higher line 6044). The appearance of the simulated refraction within the user interface object 6004 includes refracted representation 6040′ of the top portion of the triangle 6040 and the refracted representation 6044′ of the middle portion of the triangle 6040 with the higher line 6044, but the appearance of the refracted representation 6044′ is not based on the darkened representation 6044″ of the middle portion of the triangle 6040 including the higher line 6044, but based on the original appearance (e.g., without influence of the simulated shadow 6052-1) of the top portion of the triangle 6040 and the middle portion of the triangle 6040 with the higher line 6044.

In the second row, in state 2, the relative positions of the underlying content 6048 and the user interface object 6004 have changed, compared to that shown in the state 1. In state 2, the top of the circle 6042 has moved to be directly behind the user interface object 6004, and the top and middle portions of the triangle 6040 are also directly behind the user interface object 6004. Most of the bottom half of the circle 6042 and most of the bottom portion of the triangle 6040 (optionally including the lower line 6046) are overlaid by the simulated shadow 6052-2. The simulated shadow 6052-2 is overlaid on a portion of the underlying content including most of the lower half of the circle 6042, and most of the bottom portion of the triangle 6040.

In the second row, the appearance of the simulated shadow 6052-2 is based on the appearance of most of the lower half of the circle 6042, and most of the bottom portion of the triangle 6040, and includes a darkened representation 6042″ of most of the lower half of the circle 6042 and a darkened representation 6040″ of most of the bottom portion of the triangle 6040 (including a darkened representation 6046″ of the lower line 6046).

In the second row, the simulated refraction included within the outline of the user interface object 6004 is based on the portion of the underlying content that is directly underlying the user interface object 6004 (e.g., including the top half of the circle 6042, and the top and middle portion of the triangle 6040, including the higher line 6044), and a portion of the underlying content that is outside of the outline of the user interface object 6004 (e.g., part of the lower portion of the triangle 6040 including the lower line 6046). The appearance of the simulated refraction within the user interface object 6004 includes the refracted representation 6042′ of the circle 6042, the refracted representation 6040′ of the top portion of the triangle 6040, the refracted representation 6044′ of the middle portion of the triangle 6040 with the higher line 6044, and the refracted representation 6046′ of most of the lower portion of the triangle 6040 with the lower line 6046′, but the appearance of the refracted representations are not based on the darkened representation 6046″ of the lower portion of the triangle 6040 including the lower line 6046, but based on the original appearance (optionally, without influence of the simulated shadow 6052-2) of the lower portion of the triangle 6040 with the lower line 6046.

In the third row, in state 3, the relative positions of the underlying content 6048 and the user interface object 6004 have changed again, compared to those shown in the state 1 and state 2. In state 3, the top of the circle 6042 is located directly behind the user interface object 6004, and the triangle 6040 is rotated relative to the user interface object 6004, with more of the left side of the triangle 6004 moved into the outline of the user interface object 6004, and less of the right side of the triangle 6004 remaining within the outline of the user interface object 6004. As shown in the third row in FIG. 6C, the top portion of the circle 6042 is within the outline of the user interface object 6004, the top portion of the triangle 6040 is within the outline of the user interface object 6004. The middle portion of the triangle 6040 (e.g., including the entirety of the upper line 6044) on the left side of the triangle is also directly behind the user interface object 6004. Most of the bottom portion of the triangle 6040 (optionally including the lower line 6046) is located outside of the outline of the user interface object, but are within the refraction-threshold distance from the outline of the user interface object 6004. A lower right portion of the triangle is outside of the shadow-threshold distance from the outline of the user interface object 6004. Most of the bottom half of the circle 6042 and most of the bottom portion of the triangle 6040 (optionally including the lower line 6046) are overlaid by the simulated shadow 6052-3. The simulated shadow 6052-3 is overlaid on a portion of the underlying content including most of the lower half of the circle 6042, and most of the bottom portion of the triangle 6040.

In the third row, the appearance of the simulated shadow 6052-3 is based on the appearance of most of the lower half of the circle 6042, and most of the bottom portion of the triangle 6040, and includes a darkened representation 6042″ of most of the lower half of the circle 6042 and a darkened representation 6040″ of most of the bottom portion of the triangle 6040 (including a darkened representation 6046″ of the lower line 6046). The appearance of the simulated shadow 6052-3 is different from the simulated shadow 6052-1 and 6052-2 because the appearance of the portions of the underlying content underlying the simulated shadows 6052-1, 6052-2, and 6052-3 are different from one another.

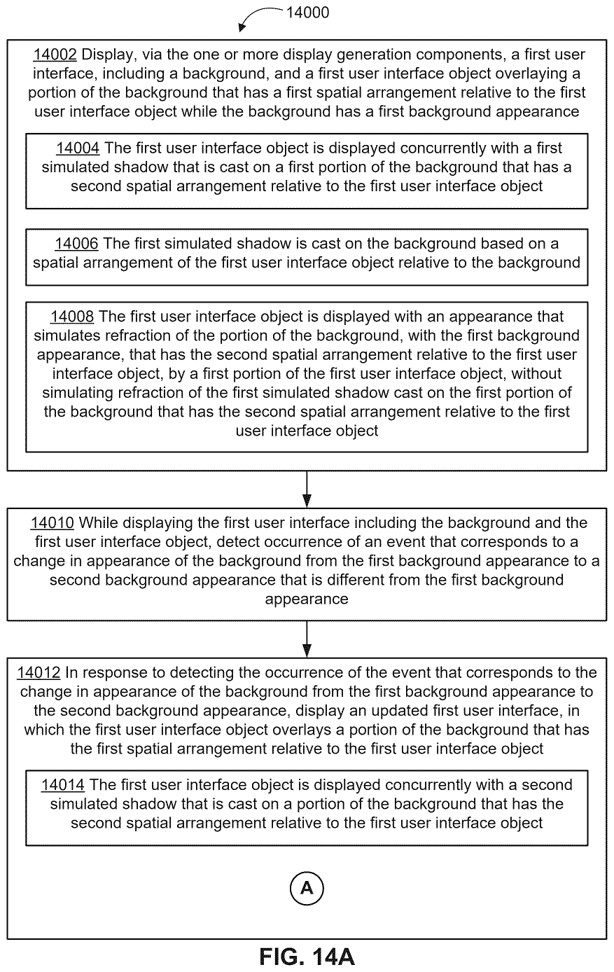

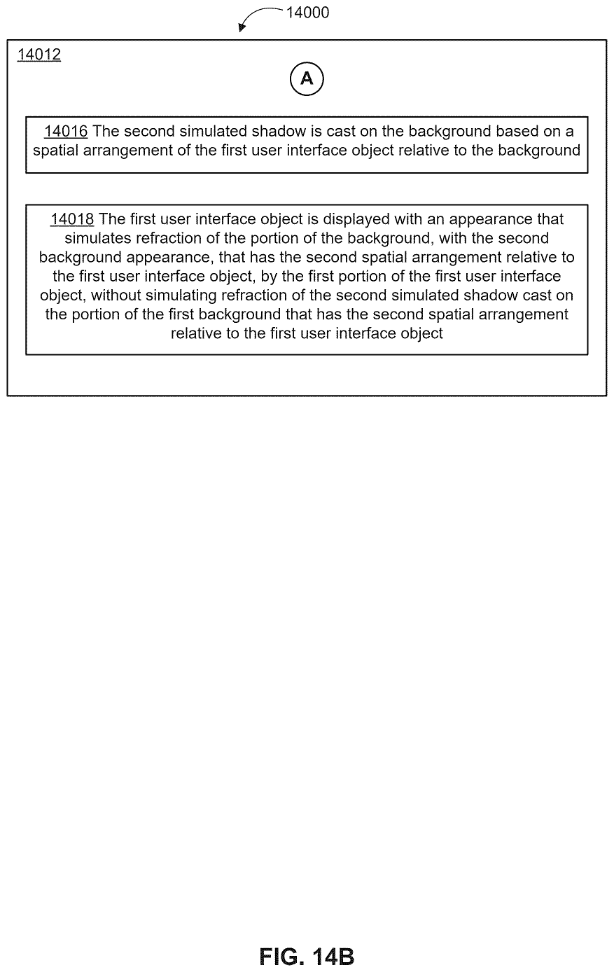

In the third row, the simulated refraction included within the outline of the user interface object 6004 is based on the portion of the underlying content 6048 that is directly underlying the user interface object 6004 (e.g., including the top half of the circle 6042, and the top and middle portion of the triangle 6040, including the higher line 6044), and a portion of the underlying content that is outside of the outline of the user interface object 6004 (e.g., part of the lower portion of the triangle 6040 including left part of the lower line 6046). The appearance of the simulated refraction within the user interface object 6004 includes the refracted representation 6042′ of a portion of the circle 6042 (e.g., including the top portion of the circle within the outline of the user interface object and part of the middle portion of the circle overlaid by the simulated shadow 6042″), the refracted representation 6040′ of the top portion of the triangle 6040, the refracted representation 6044′ of the middle portion of the triangle 6040 with the higher line 6044, and the refracted representation 6046′ of most of the lower portion of the triangle 6040 with the left part of the lower line 6046′, but the appearance of the refracted representations are not based on the darkened representation 6040″ of the lower portion of the triangle 6040 including the darkened representation 6046″ of the lower line 6046, but based on the original appearance (without influence of the simulated shadow 6052-3) of the lower portion of the triangle 6040 with the lower line 6046. The example shown in FIG. 6C is merely illustrative and additional features and details are provided with respect to the method 14000 in FIGS. 14A-14B.

FIGS. 6D-6H illustrate example user interfaces for deemphasizing content within a header portion, also referred to as a header region or first region, of a display area. In some embodiments, the header portion of the display area corresponds to a top portion (e.g., as illustrated in FIGS. 6D-6H) of the display area of device 100. In some embodiments, the header portion of the display area corresponds to a bottom portion and/or a side portion of the display area (e.g., different portion(s) of the display area may behave with the properties described herein with reference to the header portion displayed at a top portion of the display area of device 100). In some embodiments, content in the user interface that is scrolled or otherwise displayed as moving within the header portion is displayed as being visually deemphasized within the header portion (e.g., to appear as though the content is scrolled below or otherwise obscured by the header portion).

FIG. 6D illustrates a user interface that includes a text header 6202 (“Inbox”) and a plurality of message previews that include content, such as content 6208, content 6208′ and content 6208″. In some embodiments, the device 100 displays control 6200 with the simulated glass material and control 6204 with the simulated glass material. In some embodiments, in response to detecting a user input 6206, such as a swipe user input, a scroll user input, a drag user input or another user input that includes movement that continues as user input 6206′, the device 100 scrolls the user interface, including moving the position of content 6208, content 6208′ and content 6208″ upward in accordance with the user input 6206. In some embodiments, in response to detecting the user input 6206, the header 6202 is scrolled upward, without moving or scrolling the header portion, and, in accordance with a determination that the text header 6202 has reached the header portion of the display area, the text header 6202 is replaced and/or repositioned as header 6202′ (e.g., in FIG. 6E). In some embodiments, the header 6202′ is displayed with a blur area surrounding the text of header 6202′ while the header 6202′ is within the header portion of the display area. For example, in accordance with a determination that header 6202′ is positioned within the header portion, a visual deemphasis effect similar to the visual deemphasis effects corresponding to the blur areas around the controls in the header portion is generated in an area surrounding the header 6202′ (e.g., optionally without displaying the header 6202′ as simulated glass material).

In some embodiments, content that is scrolled within the header portion of the display area is visually deemphasized (e.g., such that the content appears to scroll beneath the header portion of the display area). For example, a blur visual effect is applied within the header portion of the display area such that content scrolled through the header portion appears blurred as it is simulated as passing under the header portion. In some embodiments, a fading, dimming, and/or other visually deemphasizing visual effect is applied to the header portion (e.g., in addition to or instead of the blur visual effect). For example, as the content is moved within the header portion, the content is blurred, faded, dimmed or otherwise visually deemphasized. In some embodiments, the visual deemphasis is applied over one or more virtual lighting effects, such as refraction and/or reflection, that are applied to content that is optionally displayed with a simulated glass appearance as the content moves within the header portion (e.g., such that the simulated refraction and/or reflection appear blurred, dimmed, faded, or otherwise visually deemphasized).

In some embodiments, a level of visual deemphasis and/or the type(s) of visual deemphasis that are applied to content in the header portion are based at least in part on one or more visual properties of the content. For example, an average luminance of the content within the header region is determined. In some embodiments, a luminance of a background of the content and a luminance of a foreground of the content is determined and the level and/or type of visual deemphasis is based on a comparison between the foreground luminance and background luminance of the content. For example, for a greater amount of difference between the foreground luminance and the background luminance, the visual deemphasis includes a higher level of fading the content (e.g., and/or a lower level of dimming the content) and vice-versa. In some embodiments, the visual deemphasis that is applied to content in the header portion is not uniformly applied within the header portion. For example, a gradient of visual deemphasis that varies (e.g., along the y-axis and/or in other direction(s)) is applied within the header portion such that a different level of blurring, fading, dimming and/or other visual deemphasis is applied within a first subregion of the header portion (e.g., a greater level of visual deemphasis is applied to a subregion at the top edge of the header portion than the level of visual deemphasis applied to a subregion at the bottom edge of the header portion). In some embodiments, the gradient follows a concave shape (e.g., that is flat along the top edge of the display area and curves to a concave shape that extends to the right and/or left edges of the display area such that content closer to the horizontal center of the display area is visually deemphasized before content at the far right and/or left of the display area when scrolling the content upward). In some embodiments, the gradient of visual deemphasis varies in a non-linear manner, for example, the visual deemphasis varies according to a concave shape and/or according to contours of one or more shapes that correspond to the shape(s) of user interface elements (e.g., control 6200 and/or control 6204) that are displayed within the header region (e.g., as described below, each control within the header portion is associated with a visual deemphasis that extends from the respective control).

In some embodiments, controls that are displayed within the header portion of the display area are displayed as punched out from the header portion (e.g., such that the controls are not affected by the blur visual effect and/or other visual deemphasis). For example, the area of the display corresponding to a respective control creates a pocket within the header portion where the visual deemphasis does not apply (e.g., or applies by a lesser amount). In some embodiments, controls within the header portion do not scroll with the content and remain at their fixed respective positions within the header portion of the display area. In some embodiments, each control is displayed with the simulated glass material, such that the content that is scrolled under the controls appears distorted (e.g., the content is treated as underlying content and the visual effects described with reference to FIGS. 6A-6B13 are applied to the underlying content to generate the simulated glass material of the control). In some embodiments, each control within the header portion is associated with a blur effect (e.g., in addition to the blur effect that is applied to the header portion) that extends from the respective control. For example, control 6200 is associated with a first blur effect 6210 that extends to an area outside of the control 6200 and creates a blur gradient (e.g., with different levels of blurring applied at different blur radii) and control 6204 is associated a second blur effect 6212. In some embodiments, a shape of the blur effect follows (e.g., matches or is otherwise based on) the shape of the control. As such, each control is associated with a separate blur effect that is applied to the content scrolled in the header portion that appears to pass below (e.g., simulated in the z-direction) the controls and respective blur effects. In some embodiments, fading, dimming, and/or another visually deemphasizing visual effect is applied in addition to or instead of blur effect 6210 (e.g., each visual effect optionally being applied at different levels according to a respective visual effect radius and/or other gradient).

In some embodiments, as illustrated in FIGS. 6E-6E2, the header 6202′ is displayed as appearing in a center of the header portion between control 6200 and control 6204 (e.g., optionally at a position in the header region so as to not overlap with the blur effects generated by control 6200 and/or control 6204) via an animated transition. In some embodiments, the animated transition of the header 6202′ includes displaying the header 6202′ as gradually sliding upward (e.g., as indicated by the arrow pointing upward in FIG. 6E1 indicating y-travel of the header 6202′ in a first direction) from a lower position within the header portion to a highest position (e.g., illustrated in FIG. 6E1) before sliding back downward (e.g., as indicated by the arrow pointing downward in FIG. 6E2 indicating y-travel of the header 6202′ in a second direction) to its final position within the header portion. For example, the animated transition includes a bounce animation resulting from displaying the header 6202′ as overshooting its final position before sliding back downward. In some embodiments, the header 6202′ that is moved to a position within the header portion is associated with its own blur effect to blur the content that appears to scroll beneath (e.g., simulated in the z-direction) the header 6202′. In some embodiments, movement of the header 6202 to header 6202′ is based at least in part on one or more properties of the user input 6206. For example, for a faster scroll speed (e.g., faster movement of the user input 6206), the header 6202′ is displayed as transitioning quickly with a faster rate of the animated transition, with reduced y-direction travel, and/or with reduced amount of bounce.

Although the header portion is illustrated as extending from a top edge of the display area, in some embodiments, the header portion is generated at other locations in the user interface, such as extending from a bottom edge of the display area, extending from a left and/or right edge of the display area, and/or within a user interface object. In some embodiments, two or more header portions are concurrently maintained in a same user interface, where content is independently scrollable beneath each of the header portions (e.g., in response to a scroll input toward first content that is scrolled under a first header portion, second content that is positioned to be scrolled under a second header portion different from the first header portion is unaffected). For example, each scrollable area is associated with a separate header portion.

In some embodiments, for a same scrollable area, two or more header portions are provided (e.g., on the top, bottom, left and/or right of the scrollable area). For example, a first header portion is present at a top of the scrollable area and a second header portion is present along a right edge of the scrollable area such that scrolling in a first direction (e.g., up and/or down) applies a visual deemphasis to the scrolled content that according to the first header portion without a visual deemphasis of the second header portion affecting the scrolled content (e.g., because the underlying content is not scrolled to the left and/or right). As such, horizontal scrolling causes the scrolled content to be affected by a different header portion than vertical scrolling.

FIGS. 6F1-6F3 illustrate a zoomed-in view of a portion of the user interface for the messages application and the header portion of the display area that deemphasizes content as the content is scrolled in the header portion. In some embodiments, FIG. 6F1 illustrates the behavior of deemphasizing content in accordance with a determination that the user input 6206″ includes movement that is below a first threshold speed (e.g., a slow rate scroll user input).

In some embodiments, portions (a) of FIGS. 6F1-6F3 represent an alternative method of deemphasizing content as compared to portions (b) of FIGS. 6F1-6F3. For example, portions (a) of FIGS. 6F1-6F3 illustrate changing an area covered by a blur radius (e.g., and/or other visual deemphasis) based on the speed of the user input 6206, and portions (b) of FIGS. 6F1-6F3 illustrate changing a level or amount of blur (e.g., and/or other visual deemphasis) that is applied (e.g., without changing the blur radius) based on the speed of the user input 6206. For example, the blur area 6210a in FIG. 6F1 (a) is larger than the blur area 6210b in FIG. 6F2 (a), which is larger than the blur area 6210c in FIG. 6F3 (a), illustrating that the blur area around the control 6200 decreases as the scrolling speed increases (e.g., and the blur level increases as the scrolling speed decreases). The opacity of blur area 6210a′ is darker (e.g., indicating a greater amount of blur applied) than the blur area 6210b′ which is darker than the blur area 6210c′ in FIGS. 6F1 (b), 6F2 (b) and 6F3 (b), indicating that the blur level applied decreases as the scrolling speed increases (e.g., and the blur level increases as the scrolling speed decreases). In some embodiments, FIG. 6F2 illustrates the behavior of deemphasizing content in accordance with a determination that the user input 6206′″ includes movement that is between the first threshold speed and a second threshold speed (e.g., a medium rate scroll user input). In some embodiments, FIG. 6F3 illustrates the behavior of deemphasizing content in accordance with a determination that the user input 6206″ includes movement that is above the second threshold speed (e.g., a fast rate scroll user input). For example, a smaller amount of blur level is applied to the blur areas in accordance with a determination that the user input 6206″″ cause a fast scrolling speed.

FIGS. 6F1-6F3 further illustrate that underlying content that is scrolled behind the header portion appears distorted through the controls 6200 and 6204. For example, the control 6200 is displayed with the simulated glass material such that a distorted portion 6216a corresponding to a portion of the underlying external content 6208 is displayed (e.g., to simulate the glass user interface material of the control 6200 refracting, blurring, and/or otherwise distorting the portion of the underlying content 6208 as it moves behind the control 6200).

FIG. 6G illustrates a graph that represents adjusting a blur level based on an amount of change to the underlying object (e.g., underlying content that passes below the blur area(s)). For example, the amount of change to the underlying objects that pass below the blur area(s) increases as scroll speed increases and the amount of change to the underlying objects that pass below the blur area(s) decreases as scroll speed decreases. As such, while the underlying object is changing by a lesser amount and/or at a slower rate, a larger amount of blur is applied, whereas while the underlying object is changing by a greater amount and/or at a faster rate, a lesser amount of blur is applied (e.g., since the underlying objects already appear to be blurred or otherwise distorted by moving quickly).

FIG. 6H illustrates an example of applying a blur effect to a portion of the user interface, including applying a blur effect to system-level content (e.g., section headers such as subheading 6306) in accordance with a determination that a respective section header is at a position that is near (e.g., within a threshold distance from) the header portion of the user interface. In some embodiments, within the header portion illustrated in FIG. 6H (a), the amount of visual deemphasis that is applied to the area within the header portion changes spatially (e.g., where a greater amount of deemphasis is represented by the solid black bar and a lesser amount of deemphasis is represented by the patterned bar that extends to the right and left edges of the display area). In some embodiments, the visual deemphasis applied to the header portion overall is different from the visual deemphasis that is caused by the controls 6300 and 6304 and/or header 6302. For example, a visual deemphasis is applied to the entirety of the header portion, and additional blur areas that surround the control 6300 and control 6304 cause a separate (e.g., additional) visual deemphasis to content that is scrolled under the blur areas. As such, content that is scrolled within the header portion that is outside of the blur areas of control 6300 and control 6304, and header 6302 (e.g., content between the blur area of header 6302 and the blur area of control 6300) is displayed with less visual deemphasis (e.g., due to the overall header portion visual deemphasis represented by the solid black bar and patterned bar) than the content that overlaps (e.g., is scrolled beneath) the blur areas of control 6300 and header 6302.

In some embodiments, as described above with reference to FIGS. 6D-6G, one or more controls associated with the application (e.g., a contacts application), including control 6300 and control 6304 are positioned within the header portion. In some embodiments, control 6300 and control 6304 are displayed with a simulated glass material. In some embodiments, control 6300 and control 6304 do not scroll with the application content (e.g., content 6308) and remain displayed as “punched out” from the header portion. In some embodiments, header 6302 “Contacts” is displayed in the header portion in a region that does not overlap with the blur area (e.g., illustrated by the patterned areas surrounding control 6300) for control 6300 and/or the blur area (e.g., illustrated by the patterned areas surrounding control 6304) for control 6304. In some embodiments, in response to detecting user input 6310 corresponding to a request to scroll the content, subheading 6306 and content 6308 are scrolled upward in the user interface. In some embodiments, as illustrated in FIG. 6H (b), in accordance with a determination that the subheading 6306 is within a threshold distance from header portion, a blur area 6312 is created for subheading 6306, where blur area 6312 includes the properties described above with reference to blur area 6210 and 6212 (e.g., in FIGS. 6D-6F). As such, a visual deemphasis is applied to content that is scrolled beneath blur area 6312, despite being outside of the display area that corresponds to the header portion.

In some embodiments, the gradient of visual deemphasis changes based on the shape(s) of the controls in the header portion changing. For example, the shape of control 6300 is more pill-like and/or oval shaped as compared to the shape of control 6200 such that the gradient of the visual deemphasis applied to the underlying content based on the visual deemphasis area associated with the control 6300 follows the contour of the shape of control 6300. As such, a change in shape of one or more controls that are positioned within the header portion causes a different contour area for the gradient of the visual deemphasis.

In some embodiments, in response to detecting a user input 6310′ corresponding to a request to scroll the content downward, the header 6302 is repositioned and/or resized as header 6302′, where the header 6302′ is no longer positioned within the header portion and the blur area surrounding header 6302 is removed (e.g., as illustrated in FIG. 6H). In some embodiments, in response to detecting the user input 6310′ and in accordance with a determination that the subheading 6306 is no longer proximate to the header portion (e.g., subheading 6306 is scrolled downward away from the header portion), the device 100 ceases to display a visual deemphasis via the blur area 6312 (e.g., the subheading 6306 is treated as content in the user interface rather than being displayed as part of the simulated glass layer). For example, in FIG. 6H (b), the subheading 6306 behaves as part of the simulated glass layer where content in the user interface (e.g., content 6308) is simulated as passing underneath the subheading 6306, with a visual deemphasis applied to the portion of content 6308 that overlaps with blur area 6312; in FIG. 6H (c), the subheading 6306 behaves as part of the content layer (e.g., has been removed from behaving in the simulated glass layer).

FIGS. 6I-6T illustrate example user interfaces for deemphasizing content that is at least partially occluded by other content. For example, FIGS. 6I-6P illustrate a sequence of user interfaces that cause display of content to overlay background content. In some embodiments, for example, as illustrated in FIG. 6I, the device 100 displays a system user interface that includes a plurality of application icons, including an application icon 440 for a clock application. In some embodiments, in the system user interface, the application icons are displayed with a simulated glass material. In some embodiments, in response to detecting a user input 6402, such as a tap and hold input or other selection input, the device 100 updates display of the system user interface to display a menu 6404 for the clock application associated with selected icon 440. In some embodiments, the menu 6404 is displayed with the simulated glass material, and is displayed with a size larger than the size of icon 440. Accordingly, the menu 6404 appears to overlay or otherwise occlude one or more application icons displayed in the system user interface, such as icons 442, 444, and 446. In some embodiments, the icons that are overlaid by the menu 6404 are visually deemphasized, for example by simulating a decrease in thickness of the simulated glass material of the application icons 442, 444 and 446. In some embodiments, as described with reference to FIGS. 6A-6B13, the simulated glass material of the menu 6404 refracts underlying content (e.g., application icon 442 and App Store), which are thus partially visible in a distorted manner (e.g., blurred, refracted, reflected, and/or otherwise visually modified). In some embodiments, one or more application icons that are not directly under the menu 6404 are also visually deemphasized, for example by simulating a decreased thickness in the glass material of the icons 444 and 446, and/or by dimming, blurring, and/or otherwise visually deemphasizing the icons 444 and 446 that are within a threshold distance of menu 6404 (e.g., without being occluded by the menu 6404).

FIGS. 6K-6P illustrate a sequence of user interfaces following the sequence shown in FIGS. 6I-6J that includes displaying a control user interface 6401. In some embodiments, as illustrated in FIG. 6K, the control user interface 6401 is displayed in response to detecting a user input 6406, such as a swipe input, a drag input, or another input that is optionally initiated from an edge (e.g., a top right corner) of the device 100. In some embodiments, displaying the control user interface 6401 includes displaying the control user interface 6401 as gradually sliding downward overlaying the previously displayed user interface (e.g., the system user interface illustrated in FIGS. 6I-6J). In some embodiments, the application icons that are hidden by the control user interface 6401 are displayed as decreasing in simulated thickness (e.g., the simulated glass material of the application icons 416, 418, 420 and 422) while overlaid by the control user interface 6401. In some embodiments, the control user interface 6401 displays one or more controls, each control displayed with the simulated glass material.

In some embodiments, the control user interface 6401 includes a platter 6412 of connectivity controls, a focus mode control 6441, a flashlight control 6418, a timer control 6448, a low power mode control 6450 and/or other controls for performing operations. For example, in response to detecting a user selection directed to a respective control, the device 100 performs an operation associated with the respective control. In some embodiments, the device 100 detects a user input 6410 (e.g., in FIG. 6L), such as a tap and hold user input, a tap user input, or another selection input directed to platter 6412 of connectivity controls. In some embodiments, in response to detecting the user input 6410 directed to platter 6412, the device 100 displays an expanded platter 6414 that includes additional and/or alternative connectivity controls, optionally displayed with the simulated glass material (e.g., where the simulated glass material of the one or more controls are simulated to overlay the simulated glass material of the platter 6414), as illustrated in FIG. 6M. In some embodiments, morphing platter 6412 into platter 6414 (e.g., by increasing the size of platter 6412 into the size of platter 6414) includes performing an oscillating animation that includes adjusting the size of platter 6412 to a smaller size before increasing in size and/or adjusting platter 6414 to increase in size to assize larger than its final size (e.g., its destination or steady-state size). In some embodiments, FIGS. 6M-6P are illustrated without showing the application icons from the system user interface that are optionally displayed behind the glass user interface material of the controls in the control user interface 6401 to improve legibility in the Figures. In some embodiments, the application icons remain partially visible (e.g., through the control user interface 6401) in FIGS. 6M-6P.

In some embodiments, the platter 6414 is displayed with the simulated glass material, and controls in the control user interface 6401 are displayed with a decreased simulated thickness. In some embodiments, while platter 6414 is displayed, the device 100 displays a blur visual effect within blur area 6422 and/or displays a dimming visual effect within dimmed area 6424. In some embodiments, the blur area 6422 is different from the dimmed area 6424, optionally with the dimmed area 6424 expanding to the edges of the display area, while the blur area 6422 covers a portion, less than all, of the display area at a position based at least in part on the expanded platter 6414 (e.g., the area surrounding expanded platter 6414 is blurred). In some embodiments, the blur area 6422 is a variable blur area that includes a gradient that applies less blur at a farther distance from a center of the blur area (e.g., and/or from a position nearest the platter 6414). In some embodiments, the dimmed area 6424 uniformly dims the area 6424 without regard to the position of the platter 6414. In some embodiments, in response to detecting a user input 6426, such as a tap input or other selection input, that is directed to a portion of the user interface that is outside of the blur area 6426, the device 100 ceases display of the platter 6414 (e.g., by reducing the size of platter 6414 and transitioning to display the platter 6412 of connectivity controls). In some embodiments, in response to detecting a user input 6416 directed to a control for managing a hotspot connection displayed in the platter 6414, the device 100 turns on and/or off a setting for joining a hotspot, and optionally displays one or more options of available hotspots to be joined. In some embodiments, in response to detecting a user input 6420 (e.g., in FIG. 6L) directed to flashlight control 6418, the device 100 toggles a flashlight of the device on and/or off (e.g., as indicated in FIG. 6N as the flashlight control 6418 is toggled on following the user input 6420 in FIG. 6L). In some embodiments, in response to detecting a user input 6420′ directed to the flashlight control 6418 while the flashlight control 6418 is displayed within the blur area 6426 (e.g., in FIG. 6M), the device 100 forgoes toggling a flashlight of the device on and/or off. As such, the device 100 responds to user inputs directed to areas outside of the platter 6414 that are directed outside of the blur area 6422, without performing operations in response to user inputs directed to areas within blur area 6422. In some embodiments, controls that are displayed as at least partially beneath the platter 6414 cannot be selected by a user input.

In some embodiments, in response to detecting the user input 6420 (e.g., in FIG. 6L), the flashlight control 6418 is toggled on (e.g., in FIG. 6N) and is displayed with a visual effect, such as specular highlights, a glow, an increase in brightness and/or other visual emphasis of the flashlight control 6418, as indicated by the fill pattern of flashlight control 6418 illustrated in FIG. 6N. In some embodiments, in response to detecting user input 6420 to activate flashlight control 6418, the flashlight control 6418 is displayed as lifting away from the background (e.g., by changing one or more visual properties to simulate an increase in a gap and/or distance between flashlight control 6418 and the background of control user interface 6401). In some embodiments, while the device 100 displays the flashlight control 6418 with the visual effect, the flashlight control 6418 acts as an emissive element (e.g., as described above with reference to FIGS. 5B-5E). one or more other controls proximate to the flashlight control 6418, for example, light and/or color from the flashlight control 6418 appears to reflect and/or refract as element 6428a on focus control 6441, element 6428b on timer control 6448, and/or as element 6428c on low power control 6450c, as illustrated in FIG. 6N following in sequence from FIG. 6M. Similarly, in some embodiments, other controls in the control user interface 6401 correspond to emissive elements that cause one or more visual effects to be displayed on controls proximate to the emissive element(s). For example, a value bar of the brightness control 6428 is displayed as an emissive element that is displayed a simulating emitting light via element 6440 on the volume control in the control user interface 6401, and emitting light via element 6440 on a top portion (e.g., proximate to the brightness control 6438) of calculator control 6444.

In some embodiments, in response to detecting a user input 6442 (e.g., illustrated in FIG. 6M), such as a swipe input, a drag input, or another selection user input, corresponding to a request to change a value of the brightness (e.g., by adjusting the value bar), the device 100 displays a change in size of the value bar corresponding to the value of the brightness, and optionally additional virtual lighting elements are displayed in accordance with the new size of the value bar (e.g., of brightness control 6438′ acting as an emissive element). For example, in FIGS. 6N-6P, the element 6400 increases in size as element 6440′ and further increases in size as element 6440″ based on the value of the brightness control increasing. In some embodiments, element 6440c on the screen mirroring control 6446 is displayed once the height of the value bar for the brightness control 6438″ is within a threshold distance from the control 6446. For example, as the value bar of the brightness control increases in size, the element 6440c will increase in size to extend along the right edge, such that the value bar of the emissive element corresponding to brightness control 6438″ is updated as the brightness value is changed. In some embodiments, while the user input 6442 is maintained, the virtual lighting elements (e.g., elements 6440′ and 6440a) appear brighter or otherwise more prominent (e.g., and optionally, the value bar of the brightness control appears more prominent with an increased size and/or level of brightness during the user input 6442), and upon detecting an end of the user input 6442, the virtual lighting elements are maintained (e.g., based on the new brightness value) but with less prominence (e.g., a lower brightness level) than while the user input 6442 is ongoing.

In some embodiments, FIGS. 6P1-6P2 illustrate a sequence of user interfaces that are optionally displayed in sequence between FIG. 6O and FIG. 6P. In some embodiments, while detecting a continuation of user input 6442 (e.g., illustrated as user inputs 6442′ and 6442″), the shape of the value bar within the brightness control 6438″ is updated. For example, while the input 6442′ is detected, the top edge of the value bar increases in curvature. In some embodiments, the curvature of the top edge of the value bar increases as the value bar is moved closer to a top edge of the brightness control 6438″. For example, the value bar illustrated in FIG. 6P2 has a greater radius of curvature of the top edge than the value bar illustrated in FIG. 6P1. In some embodiments, while the user input 6442′ is detected, the one or more controls displayed in the controls user interface, other than the selected brightness control 6438″, cease to be displayed, while displaying the system user interface and/or application user interface that was obscured by the controls user interface. As such, the user is enabled to view changes to the brightness of the underlying system user interface and/or application user interface, that results from changing the value of the brightness control 6438″. In some embodiments, the system user interface and/or application user interface is optionally displayed with a visual deemphasis while the user input 6442″ is detected to update the value of the brightness. In some embodiments, in response to detecting an end of the user input 6442″, the device 100 displays the user interface illustrated in FIG. 6P, including displaying the value bar of the brightness control 6438″ with a lesser curved top edge than when the user interacts with the brightness control 6438″. As such, the curvature of the value bar of the brightness control 6438″ appears more curved while a user input is detected than the curvature of the value bar before and/or after detecting the user input.

FIGS. 6Q-6R illustrate an example device (e.g., optionally different than device 100) that displays the control center user interface 6401 as overlaying a portion, less than all, of the system user interface (e.g., home screen user interface). In some embodiments, the device displays a control center overlay 6423 that includes one or more controls (e.g., similar to control user interface 6401), that is displayed as partially overlaying a system user interface that includes a plurality of application icons. In some embodiments, the control center overlay 6423 is displayed in response to detecting a user input 6406′, such as a swipe input, a drag input, an edge swipe input, or another type of user input, while displaying the system user interface that includes the plurality of application icons. In some embodiments, while displaying the control center overlay 6423, the device applies a dimming effect, indicated by a dimmed area 6424′ over the system user interface. In some embodiments, the control center overlay 6426 is displayed with a simulated glass material. In some embodiments, while the control center overlay 6426 is displayed, the application icons in the system user interface are displayed with a visually deemphasized a simulated glass material (e.g., by simulating a reduction in thickness of the application icons) as compared to the simulated glass material of the application icons in the system user interface while the control center overlay 6423 is not displayed. In some embodiments, a blur area 6422′ (e.g., corresponding to blur area 6422) is displayed over a smaller area than the dimmed area 6424′. In some embodiments, blur area 6422′ is optionally not displayed, but each control in the control center overlay 6426 is darkened, dimmed, or otherwise visually emphasized (e.g., to increase legibility of the controls over the background content that includes application icons in the system user interface).

In some embodiments, in response to detecting a user input 6425, such as a tap input or other selection input, directed to the “+” button in the control center overlay 6426, the device displays an editing user interface for the control center overlay 6426. In some embodiments, the editing user interface 6429 for the control center overlay includes displaying the controls with a resize option and/or a remove option. For example, in response to detecting a user input 6433, such as a tap input or other selection input, directed to a remove control displayed for a camera control, the camera control is removed from the control center overlay 6426. In some embodiments, in response to detecting a user input 6435, such as a drag input, a swipe input, or another user input, directed to the resize option for the calculator control (e.g., as illustrated in FIG. 6R), in accordance with a determination that the user input 6435 includes movement (e.g., continues as user input 6435′, FIG. 6R1), the device 100 displays an animation for resizing the calculator control that includes displaying a merging of one or more placeholders 6431 that are positioned at a location in which the expanded calculator control is to be displayed. For example, as illustrated in FIG. 6R1, the calculator control 6437 is displayed as increasing in size by merging the three placeholders together (e.g., optionally using the stretching animation described with reference to FIGS. 5Q-5Q2 where transitional button 725-4 is created by merging button 740 and button 742 into button 725-1) to generate the larger calculator control 6437′ illustrated in FIG. 6R2. In some embodiments, the editing user interface 6429 displays placeholders 6431 that indicate available positions to which additional controls may be added. In some embodiments, in response to detecting a user input directed the “add a control” option, the device displays a platter that includes a plurality of control options that are available to be added to the control center overlay 6426. In some embodiments, while the editing user interface is displayed, the blur area 6422″ increases in size, optionally to extend to cover the placeholders 6431 that indicate available positions to which additional controls may be added, as illustrated in FIG. 6R.

FIGS. 6S-6T illustrate a computing system 6600 that is communicatively coupled to one or more input devices, such as a mouse, trackpad, keyboard and/or another external input device. In some embodiments, the computing system 6600 displays a user interface that includes an application window 6604 and an application window 6606. In some embodiments, the application window 6604 is a currently selected application window that, in some embodiments, at least partially occludes application window 6606 (e.g., a background application window that is not currently selected). In some embodiments, the currently selected application window is displayed with one or more visual properties to emphasize the currently selected application windows relative to other application windows and/or other content displayed in the user interface. For example, the currently selected application window is displayed with a simulated glass material with properties to make the selected application window appear thicker (e.g., by increasing a distance and/or size of a shadow cast by the application window and/or changing a level of distortion of underlying content). In some embodiments, in response to detecting a user input 6602, such as a click user input or other selection input via the one or more input devices, that is directed to the application window 6606, the computing system selects the application window 6606′ as the currently selected application window, and displays the application window 6606′ with one or more visual properties to emphasize the currently selected application windows relative to other application windows and/or other content displayed in the user interface. In some embodiments, in response to detecting the user input 6602, the computing system 6600 updates one or more visual properties of application window 6604′ to visually deemphasize the application window 6604′ while it is not the currently selected application window.

FIGS. 6U-6AN illustrate a sequence of user interfaces that display a set of media player controls in a media player user interface for a media player application. It will be understood that although the behaviors of the sets of controls described with reference to FIGS. 6U-6AN are described with reference to a media player application, sets of controls that are displayed for other applications, such as a mail application, a news application, a web browser application, and/or other applications, have the properties described with reference to the media player controls in the media player application.

FIG. 6U illustrates a home user interface 6700 for a media player application. In some embodiments, the home user interface 6700 includes representations of a plurality of content items A-H. In some embodiments, the home user interface 6700 includes a first set of media player control options, including a media playback bar 6702 that includes information about a currently playing media item (e.g., Song, Artist, and/or a visual representation, such as cover art) and includes one or more media playback controls, such as a pause control, a skip forward control, a volume control, and/or other media playback controls for controlling the currently playing media item. In some embodiments, the first set of media player control options further includes a page menu 6704 (also referred to herein as a tab bar) that includes indications of different pages of the media player application for navigating to the different pages of (e.g., navigating between a home user interface 6700, a new user interface, a radio user interface, and/or a library user interface). In some embodiments, the representations of the available pages in the media player application are displayed with text indicating each page (e.g., “home,” “new,” “radio,” and “library”). In some embodiments, a representation of the currently selected page (e.g., home user interface 6700) is indicated by visually emphasizing the selected page in the page menu 6704, such as by changing a color, highlighting, displaying a selection indicator and/or otherwise visually emphasizing the representation of the current page. For example, in FIG. 6U, a selection indicator 6708 is displayed as a simulated glass material that overlays the home indicator. In some embodiments, the first set of media player control options includes a search control 6706 for initiating a search session within the media player application. In some embodiments, the first set of media player control options is displayed as a stack (e.g., media playback bar 6702 is displayed as stacked above (e.g., in the y-direction) the page menu 6704 and/or the search control 6706. In some embodiments, the first set of media player control options is displayed with a simulated user interface material, such as a simulated glass material, where content that appears below (e.g., in the y-direction) is partially visible (e.g., distorted based on the simulated user interface material as described with reference to FIGS. 6A-6B13) beneath the control options.

In some embodiments, in response to detecting a user input 6770, such as tap input, a tap and hold input, or another selection input, directed to a portion of the media playback bar 6702, optionally where the portion does not correspond to one of the media playback controls displayed in the media playback bar 6702, the device 100 displays a currently playing user interface that includes additional information about the media item that is currently playing back. For example, the home user interface 6700 is replaced with the currently playing user interface.

In some embodiments, in response to detecting a user input 6712, such as a swipe input, a drag input, or another scroll input, that corresponds to a request to scroll the home user interface 6700, the device 100 scrolls the user interface to display a different set of representations for a plurality of content items, such as content items C-J and the device 100 automatically, without further user input, collapses the first set of media player control options into a second set of media player control options, as illustrated in FIG. 6V. In some embodiments, the device 100, in the second set of media control options, ceases to display text labels that are displayed in the first set of media player control options (e.g., to further reduce the size of the control options in the second set of media control options relative to the first set of media control options). For example, the second set of media player control options for the media player application includes a collapsed, or minimized, version of the page menu 6704′, a collapsed version of the media playback bar 6702′ and a smaller version of the search control 6706′. In some embodiments, the respective sizes of the respective controls in the second set of media player control options are smaller than the respective sizes of the respective controls in the first set of media player control options. For example, the search control 6706′ is smaller (e.g., in height and/or width) than search control 6706 and the collapsed page menu 6704′ is smaller (e.g., in height and/or width) than the page menu 6704. In some embodiments, displaying the second set of media player control options further includes ceasing to display the stack of controls displayed for the first set of media player control options. For example, the media playback bar 6702 that was displayed as stacked above the page menu 6704 and/or the search control 6706 in FIG. 6U is moved to be displayed in a same row (e.g., a single row and/or a shorter stack) in FIG. 6V. As such, additional portions of the content near the bottom of the home user interface 6700 (e.g., representations of content I and J) are more visible to the user by collapsing and/or reducing the size of the set of media player control options in response to the user input 6712.

In some embodiments, the media playback bar 6702′ includes less information and/or fewer control options than media playback bar 6702. For example, the media playback bar 6702′ includes an indication of the song and a pause control, optionally without displaying an artist, cover art, and/or other control options (e.g., a skip forward control, volume control, skip backward controls and/or other controls that are optionally displayed in the media playback bar 6702).

FIG. 6V further illustrates detecting a user input 6714 and optionally in accordance with a determination that the user input is a first type of input, such as a tap user input or other selection user input directed to a pause control, and in response to detecting the user input 6714, the device 100 pauses playback of the media item. In some embodiments, in accordance with a determination that the user input 6714 is a second type of input, such as a tap and hold input or other type of user input, directed to the pause control or directed to another portion of the media playback bar 6702′, in response to the user input 6714 (e.g., or another user input), the device 100 redisplays the first set of media player control options (e.g., expands the collapsed version of the controls in the second set of media player control options to the first set of media player control options).

In some embodiments, as illustrated in FIG. 6W following FIG. 6V, in response to detecting a user input 6716, such as a swipe input, a drag input, or another scroll user input, corresponding to a request to scroll the home user interface 6700, in accordance with a determination that the home user interface 6700 has been scrolled to a bottom of the home user interface 6700 (e.g., represented by displaying representations of content items Y and Z), where additional content is not available past the bottom of the home user interface 6700, the device 100 redisplays the first set of media player control options (e.g., expands the collapsed version of the controls in the second set of media player control options to the first set of media player control options).

FIG. 6X illustrates the device 100 detecting a user input 6718, such as a tap input, a tap and hold input, or another selection user input, directed to the pause control in the media playback control bar 6702. In some embodiments, in response to detecting the user input 6718, the device 100 performs an operations associated with the selected control, for example, pausing playback of the media item. In some embodiments, in response to detecting the user input 6720 directed to a skip forward control in the media playback control bar 6702, the device 100 skips to a next media item.

FIGS. 6AA-6AB illustrate a sequence of user interfaces as described with reference to FIGS. 6U-6V, including collapsing the first set of media player control options to the second set of media player control options in response to detecting a user input 6722 (e.g., corresponding to a scroll user input in a first direction (e.g., scroll downward)). In some embodiments, while the second set of media player control options is displayed, the device detects a user input 6724, such as a swipe input, a drag input, or another scroll input, corresponding to a request to scroll the home user interface 6700 in a second direction different from the first direction (e.g., a scroll upward input opposite the direction of the user input 6722). In some embodiments, movement of the user input 6724 in a downward direction corresponds to a scroll upward user input and movement of the user input 6722 in an upward direction corresponds to a scroll downward user input (e.g., or vice-versa). In some embodiments, in response to detecting the user input 6724, the device 100 scrolls the content in the home user interface 6700 upward while continuing to display the second set of media player control options (e.g., without expanding the second set of media player control options into the first set of media player control options). As such, scrolling in one direction (e.g., downward scrolling) causes the device 100 to automatically collapse the first set of media player control options into the second set of media player control options, while scrolling in another direction (e.g., upward scrolling) optionally does not cause the device 100 to automatically expand the second set of media player control options.

FIG. 6AB further illustrates detecting a user input 6726, such as a tap and hold user input, a tap user input, or another selection user input, directed to the collapsed page menu 6704′. In some embodiments, in response to detecting the user input 6726, the device 100 expands the collapsed page menu 6704′ into page menu 6704 (e.g., in FIG. 6AC) to display the representations of available pages (e.g., and optionally displays expanded media playback bar 6702 and/or expanded search control 6706). For example, the device 100 redisplays the first set of media playback control options to enable the user to quickly switch between different pages in response to detecting the user input 6726. For example, the user input 6726 optionally continues as user input 6726′ (e.g., or user input 6726′ is a separate and different input from user input 6726), for example user input 6726′ includes movement (e.g., a drag user input or a swipe user input) for navigating to other pages. For example, in FIG. 6AC, the radio user interface 6701 is displayed as the user input 6726′ moves the selection indicator 6730 over the representation of the radio user interface in the page menu 6704. In some embodiments, selection indicator 6730 is displayed as a simulated glass material that optionally increases in perceived thickness relative to selection indicator 6708 (e.g., in FIG. 6U), for example, using the behavior described with reference to changing a selected object in a menu in FIGS. 5Z1-5Z4.

In some embodiments, the device 100 displays a library user interface 6703, as illustrated in FIG. 6AD following FIG. 6AC, in accordance with a determination that the user input 6726′ selects (e.g., by detecting an end of the user input 6726′, such as a liftoff of a contact corresponding to the user input 6726′ and/or ceasing to detect movement of the user input 6726′) the representation of the library page, as illustrated in the collapsed page menu 6704″. In some embodiments, in response to detecting an end of the user input 6726′, the device 100 automatically collapses the first set of media playback control options into the second set of media playback control options, as illustrated in FIGS. 6AC-6AD, where the collapsed page menu 6704″ includes an indication of the currently selected page (e.g., library user interface 6703).

FIGS. 6AD-6AN illustrate a sequence of user interfaces for providing a search session within the media player application. In some embodiments, in response to detecting a user input 6732 (e.g., in FIG. 6AD), such as a tap input, a tap and hold input, a swipe input, or another selection user input, directed to the search control 6706′, the device 100 initiates a search session and concurrently displays a search user interface 6705 that includes a plurality of recommended search options, such as different genres, playlists, albums, or other recommendations, with a third set of control options, including a search bar 6706″ and an option to cancel 6736 the search session, as illustrated in FIG. 6AE. In some embodiments, third set of control options further includes expanded media playback bar 6702 and page menu 6704″ that indicates a most recently displayed page (e.g., library user interface 6703) prior to displaying the search user interface 6705. For example, in some embodiments, the third set of control options is displayed with a stacked layout as described with reference to the first set of control options in FIG. 6U. In some embodiments, in response to detecting a user input 6734 corresponding to an input to scroll the search user interface 6705 in the first direction (e.g., upward movement of the user input 6734 corresponding to a request to scroll down in the user interface 6705), the device 100 continues to display the third set of control options without collapsing the control options (e.g., in FIG. 5AF) (e.g., as compared to the device 100 collapsing the first set of control options into the second set of control options described with reference to FIGS. 6U-6V in response to a scroll user input 6712). As such, the search session stays active to enable a user to easily access the search bar 6706″ by continuing to display search bar 6706″ even as the user scrolls the search user interface 6705.

In some embodiments, in response to detecting a user input 6737, such as a tap input or other selection input, directed to a recommended search option (“Recommended 2”) in the search user interface 6705, the device 100 displays a user interface 6707 for the recommended search option, as illustrated in FIG. 6AG following FIG. 6AF. In some embodiments, while displaying the user interface 6707, the device 100 detects a user input 6738 corresponding to a request to scroll the user interface 6707, and in response to detecting the user input 6738, the device 100 scrolls the user interface 6707 and collapses the third set of media playback control options into the second set of media playback control options, as illustrated in FIG. 6AH. In some embodiments, the search option 6706′ is visually emphasized (e.g., displayed with a different color, highlighted, increased in size, or otherwise emphasized relative to the other control options) to indicate that the user is in a search session, where user interface 6707 corresponds to search results for the recommended search option “Recommended 2.” In some embodiments, in response to detecting a user input 6740, such as a tap input or other selection input, directed to a back option, the device 100 redisplays the search user interface 6705 and the third set of media playback control options, as illustrated in FIG. 6AI.

In some embodiments, in response to detecting a user input 6742 directed to search option 6706′, the device 100 redisplays the third set of media playback control options, including the search bar 6706″, as illustrated in FIG. 6AI, and optionally displays the search user interface 6705 (e.g., or continues to display the user interface 6707 with the third set of media playback control options). In some embodiments, in response to detecting a user input 6744 (e.g., in FIG. 6AI) directed to search bar 6706″, the device 100 displays a recent searches user interface 6705′ that includes a keyboard 6748 for inputting a search query, as illustrated in Figure AJ. In some embodiments, the recent searches user interface 6705″ includes indications of one or more historical search queries and/or selected search results. In some embodiments, the search bar 6706″ is expanded to search bar 6746 optionally displayed above the keyboard 6748 in the user interface 6705′ to enable the user to easily view a search query input by the user in the search bar 6746. For example, in response to detecting a user input 6749 directed to the “A” in keyboard 6748, the search bar 6746 is updated to include the “A”; as such, the user inputs a search query via inputs to the keyboard 6748 and/or via a voice command. In some embodiments, the device 100 optionally displays the collapsed page menu 6704″, media playback bar 6702′ and/or option to cancel 6736 the search session with the keyboard 6748 and search bar 6746. In some embodiments, the device 100 does not display the collapsed page menu 6704″, media playback bar 6702′ and/or option to cancel 6736 the search session with the keyboard 6748 and search bar 6746.

FIG. 6AK illustrates a search result user interface 6705″ for an entered search query of “Artist 1” provided in the search bar 6706″ (e.g., in FIG. 6AK). In some embodiments, FIG. 6AK follows FIG. 6AJ in sequence after the user has entered the query “Artist 1” and selects a “return” or “enter” option to initiate the search. In some embodiments, the search result user interface 6705″ includes a plurality of search results that match the search query entered in the search bar 6706′″. In some embodiments, in response to detecting a user input 6750 corresponding to a request to scroll the user interface 6705″ (e.g., to scroll downward), the device 100 automatically collapses the third set of media playback control options into the second set of media playback control options, as illustrated in FIG. 6AL, and scrolls the user interface 6705″. In some embodiments, in response to detecting the user input 6752, such as a tap input or other selection input, directed to Result 6, the device 100 displays a user interface corresponding to Result 6 (e.g., to provide additional information related to Result 6) and/or initiates playback of the content item corresponding to Result 6. In some embodiments, in response to detecting a user input 6754, such as a tap input or other selection input, directed to search option 6706′, the device 100 redisplays the third set of media playback control options, as illustrated in FIG. 6AM.

In some embodiments, the search bar 6706′″ includes a clear option (e.g., “x”) displayed within the search bar 6706″ to clear the query that is entered in the search bar 6706′″. For example, in response to detecting a user input 6756 directed to the clear option, the device 100 updates the search bar 6706″ to remove the text “Artist 1” (e.g., to clear the search bar of a query), without ending the search session. In some embodiments, in response to detecting a user input 6758 directed to the option to cancel 6736 the search session, the device 100 exits the search session and redisplays the previous user interface (e.g., library user interface 6703) that was displayed before initiating the search session (e.g., displayed in FIG. 6AD before the search session is initiated in response to detecting the user input 6732). In some embodiments, in response to detecting a user input, such as a tap input or other selection input, directed to the page menu 6704″, the device 100 exits the search session and redisplays the user interface represented in the page menu 6704″ (e.g., library user interface 6703). In some embodiments, ending the search session includes replacing display of the third set of media playback control options with the first set of media playback control options, as illustrated in FIG. 6AM-6AN, including displaying selection indicator 6708 over the representation of the currently selected page (e.g., library user interface 6703). In some embodiments, ending the search session includes replacing display of the third set of media playback control options with the second set of media playback control options.

FIGS. 6AO-6AP illustrate an example user interface object 6800 displayed with a simulated user interface material (e.g., simulated glass material or other material as described with reference to FIGS. 6A-6B13) that at least partially distorts content that overlaps with the user interface object 6800 (e.g., as illustrated in FIG. 6AP, “Note content” that appears behind the user interface object 6800 is visually distorted according to the simulated user interface material).

In some embodiments, the user interface object 6800 includes internal content object a, object b, object c, object d, object e, and/or object f. In some embodiments, the user interface object 6800 is scrollable such that internal content objects a-f are scrolled horizontally (e.g., causing object f to be displayed in the user interface object 6800 while scrolling object a off of the user interface object 6800. In some embodiments, the user interface object 6800 includes one or more straight edges and/or one or more curved edges. In some embodiments, within the user interface object 6800, a simulated internal area 6801 of the user interface object 6800 is defined, where the simulated internal area is created by a simulated boundary that follows the boundary (e.g., border) of the user interface object 6800. In some embodiments, within the simulated internal area created between the simulated boundary and the boundary of the user interface object 6800, the device 100 simulates distortion of internal content of the user interface object 6800 that is positioned within the simulated internal area. In some embodiments, the simulated internal area simulates a curved edge (e.g., as described with reference to simulated side view 6014, FIG. 6B1) of the user interface object 6800 that creates a lensing effect of background content in addition to a lensing effect of internal content displayed within the user interface object 6800.

In some embodiments, the simulated internal area simulates different levels of distortion of the internal content based on a curvature of the boundary at a respective position. For example, for portions of the simulated internal area that are positioned along the curved portions of the boundary, a greater level of distortion is applied (e.g., including a greater level of distortion corresponding to a larger amount of curvature), whereas for portions of the simulated internal area that are positioned along a straight portion of the boundary, a lesser level of distortion (e.g., or no distortion) is applied. In some embodiments, the boundary of the simulated area 6801 gradually changes in curvature, for example, a lower left corner of the simulated area 6801 gradually increases in curvature from the straight bottom portion of the boundary to the maximum curvature of the boundary on the left side. In some embodiments, an amount of distortion applied at a respective portion of simulated area 6801 is based at least in part on the degree of curvature of the boundary proximate to and/or enclosing the respective portion; for example, a greater amount of distortion is applied to areas proximate to a portion of the boundary with a large degree of curvature.

In some embodiments, distorting the internal content within the simulated internal area includes applying a lensing effect that displaces and/or warps content (e.g., as described above with respect to lens effect 6003J, FIG. 6B4). In some embodiments, distorting the internal content includes causing chromatic aberration of internal object a (e.g., by separating color channels of object a). In some embodiments, a level of chromatic aberration increases as the internal content moves closer to the boundary of user interface object 6800 (e.g., a greater amount of separation between color channels is displayed closer to the boundary of user interface object 6800 than the amount of separation between color channels on an interior boundary of the simulated area 6801). In some embodiments, a blur effect is applied over the chromatic aberration such that the split color channels are not individually visible to the user due to the blur effect. In some embodiments, distorting the internal content within the simulated internal area includes refracting the internal object a (e.g., where the straight edge of object a appear curved and/or warped to simulate refraction of the object a within the simulated internal area).

In some embodiments, in response to detecting a user input 6806, such as a swipe input, a drag input, or another scroll input that corresponds to a request to scroll the internal content within the user interface object 6800 to the left, the device 100 scrolls through the internal object, including moving object a to the left, thereby causing object a to be positioned partially within the simulated internal area and scrolling objects b-e to the left in accordance with a speed, magnitude and/or direction of the user input 6806. In some embodiments, additional content (e.g., object f) is displayed in the user interface object 6800 in response to detecting the user input 6806 (e.g., by scrolling object f in from the right side of the user interface object 6800). In some embodiments, in response to detecting the user input 6808, such as a swipe input, a drag input, or another scroll user input, corresponding to a request to scroll the internal content of the user interface object 6800 to the right, the device 100 shifts objects a-f to the right in accordance with a speed, magnitude and/or direction of detected user input 6808. In some embodiments, as object f is shifted to the right to scroll the internal objects a-f, the object f is visually deemphasized by the area 6804. In some embodiments, the area 6804 includes a straight edge (e.g., the left vertical edge illustrated in FIG. 6AO). In some embodiments, visually deemphasizing objects that appear to pass below the area 6804 includes blurring, fading, and/or applying other visual deemphasis to the objects (e.g., object f is blurred and/or faded). In some embodiments, object f is visually deemphasized before object f reaches the simulated area 6801 on the right side of the user interface object 6800; thus, object f is not distorted by the simulated area 6801 corresponding to the curved boundary on the right side of user interface object 6800.

FIG. 6AP illustrates an example user interface 6810 that includes user interface object 6800. In some embodiments, the user interface object 6800 corresponds to a writing toolkit, such as a pencil palette, that includes a plurality of selectable writing tools (e.g., pencil, pen, ruler, highlighter, eraser, and/or other writing tools). In some embodiments, the user input 6806 scrolls through various writing tools to be displayed in the writing toolkit. In some embodiments, in response to detecting a user input directed to a respective writing tool, the respective writing tool is selected such that user inputs directed to the user interface 6810 apply the selected respective writing tool (e.g., when the pencil is selected, user inputs such as drag inputs cause the device 100 to display writing using the pencil according to the user inputs). It will be understood that other types of user interface objects take on the distortion behaviors described herein with respect to user interface object 6800. For example, a share sheet platter that includes a plurality of contacts and/or a plurality of recommended applications for sharing content is displayed with the properties described with reference to user interface object 6800 (e.g., where scrolling through the plurality of contacts and/or recommended applications causes distortion along a curved boundary of the share sheet platter). In some embodiments, buttons, such as button 724-1 (e.g., in FIG. 5N), button 725-1 (e.g., in FIG. 5N), button 752 (e.g., in FIG. 5Q3) and/or other controls described herein are displayed with the properties described with reference to user interface object 6800.

In some embodiments, the user interface material is an adaptive glass material. In some embodiments, the user interface material is a transparent material (e.g., a glassy material as described herein, or another type of transparent material, optionally with a tint). In some embodiments, when displaying a user interface object that is visually associated with the transparent material (e.g., a button, control, a header, a platter, and/or other types of user interface object that appears to enclose the transparent material) over some content (e.g., underlying content in a user interface containing the user interface object), where the transparent material remaps luminance values of the content in an underlying region that is at least partially under the material to a different range of luminance values, if the characteristic luminance under the user interface object (e.g., average luminance within the outline of the user interface object, or within an outline of a platter supporting the user interface object and one or more other related user interface objects) is in a first range (e.g., between 0.7 and 1 average luminance), the computer system uses a first remapping (e.g., for the light material) for the luminance values of the underlying content (e.g., implemented in color matrices 6003E, applied to the blur layer 6003B or refraction layer 6003C in FIGS. 6A-6B13); and if the characteristic luminance under the user interface object (e.g., average luminance within the outline of the user interface object, or within an outline of a platter supporting the user interface object and one or more other related user interface objects) is in a second range (e.g., between 0 and 0.3 avg luminance), the computer system uses a second remapping (e.g., for the dark material) for the luminance values of the underlying content (e.g., implemented in color matrices 6003E, applied to the blur layer 6003B or refraction layer 6003C in FIGS. 6A-6B13).

As described below, the methods described herein provide improved visual feedback, reduces the number of inputs needed to perform an operation, provides additional control options without cluttering the user interface with additional displayed controls, and/or performs an operation automatically when a set of conditions has been met without requiring further user input.

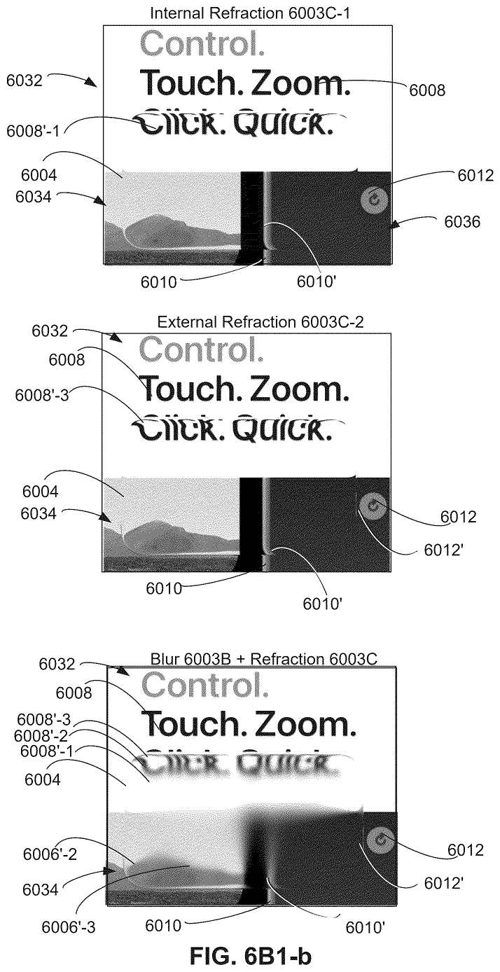

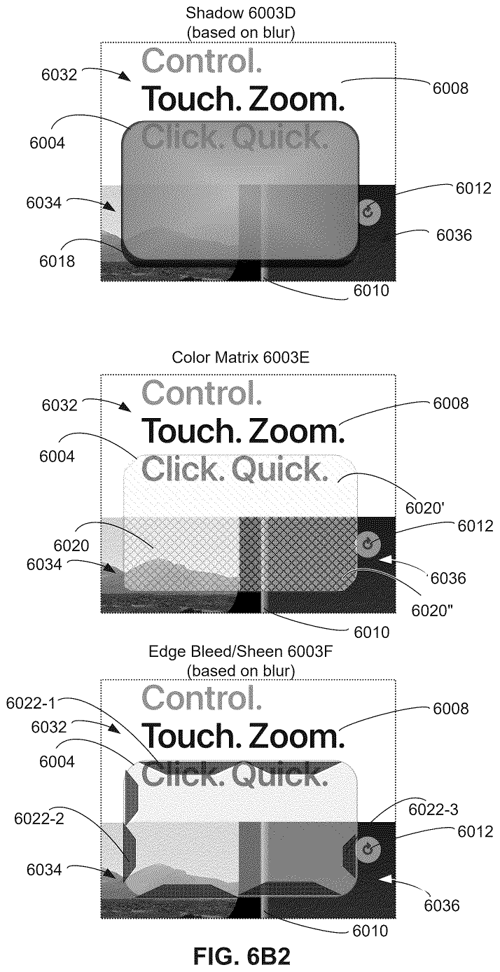

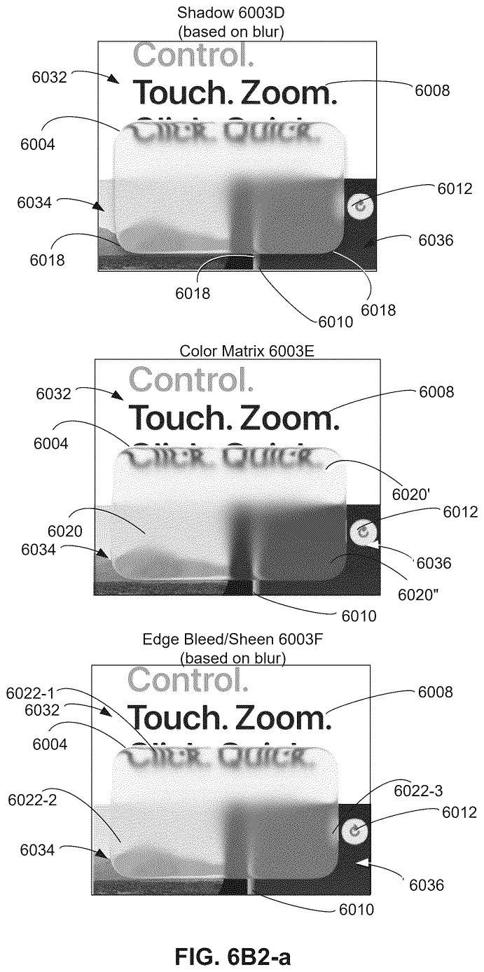

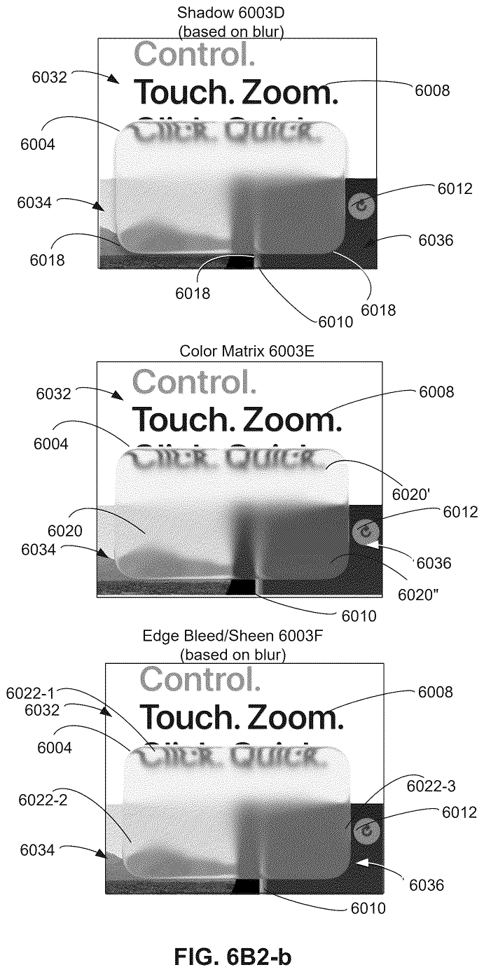

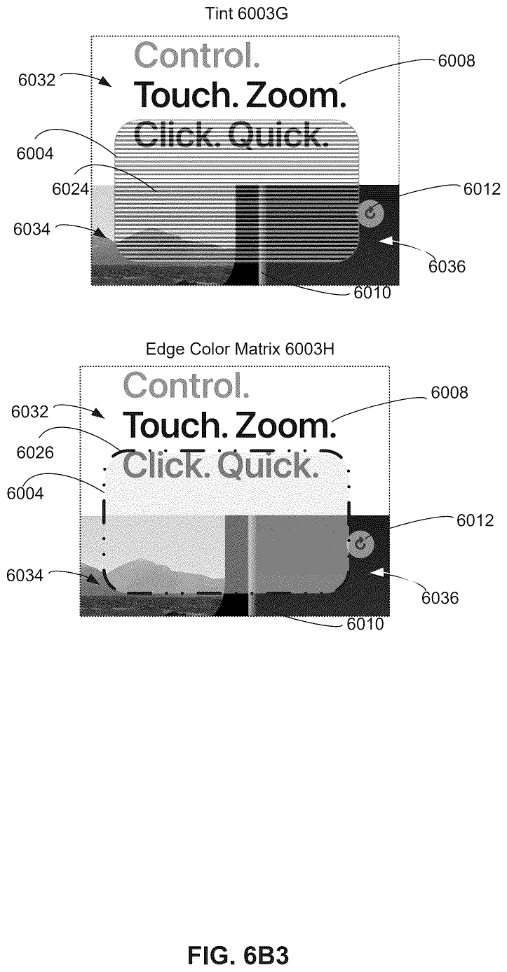

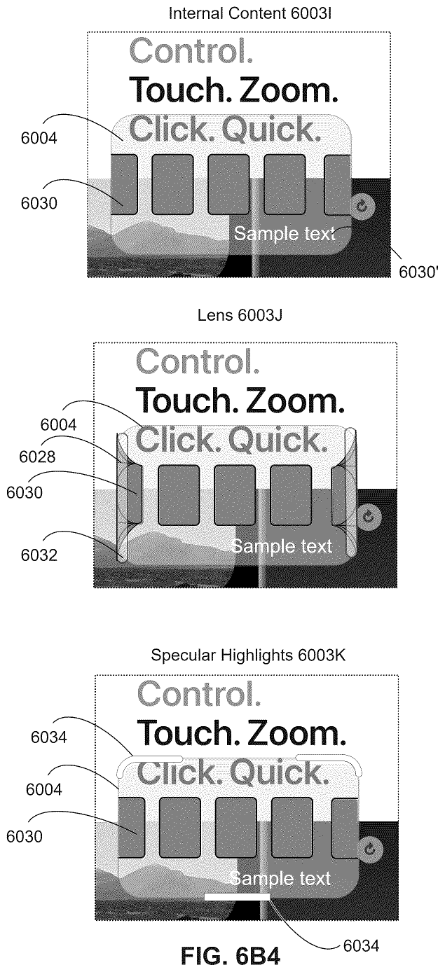

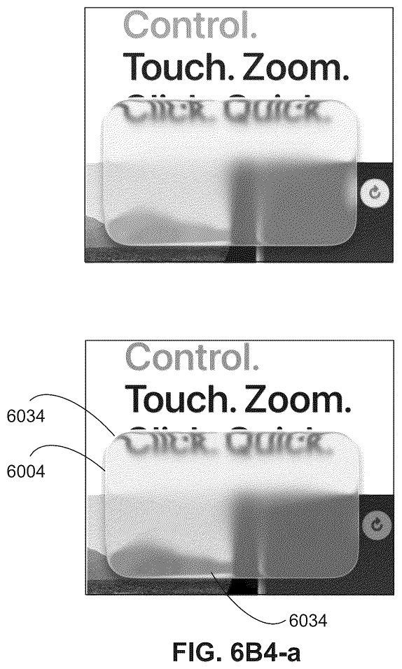

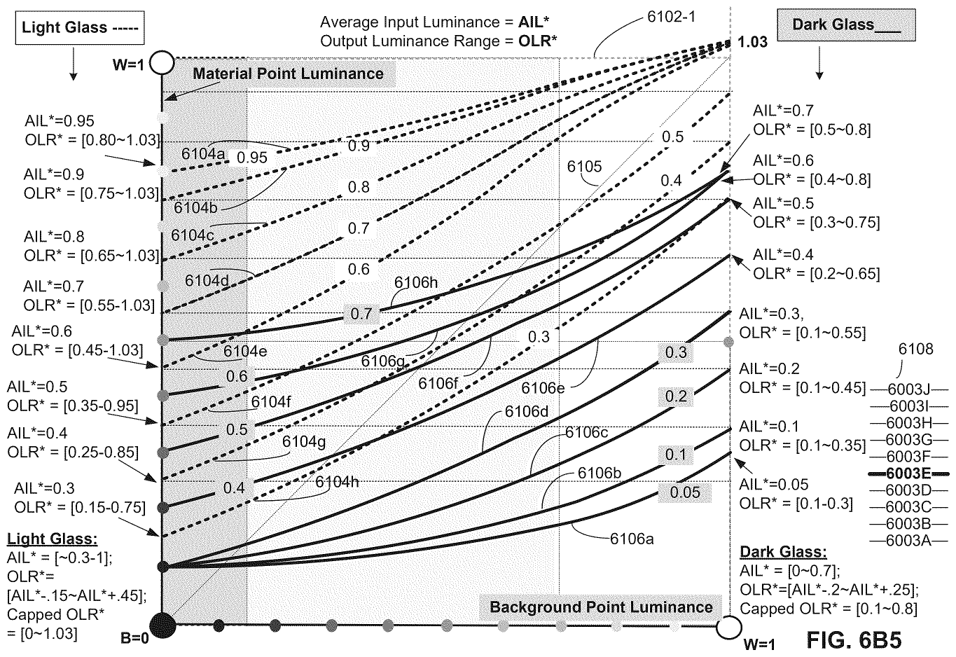

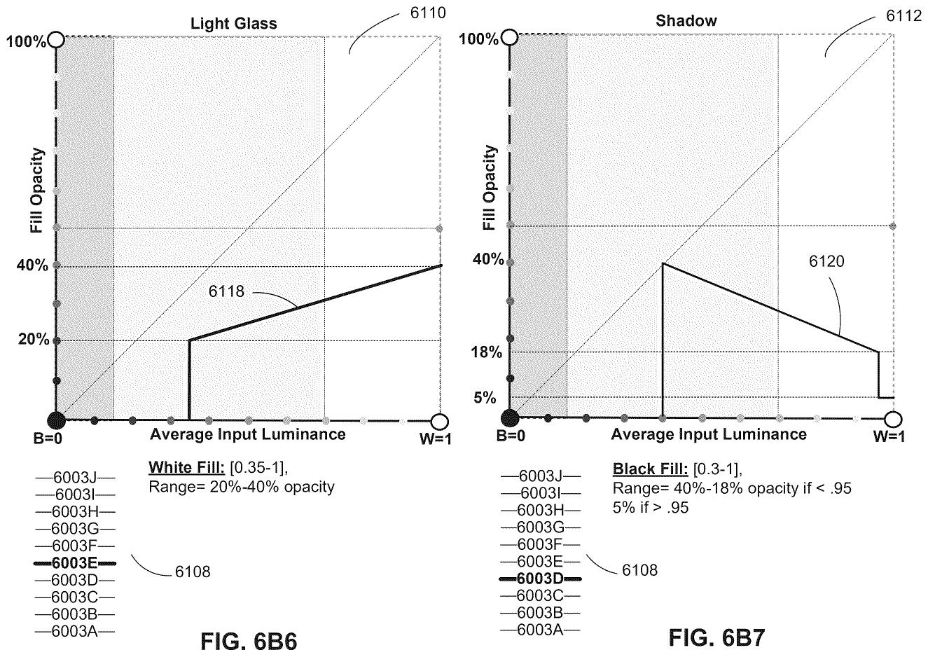

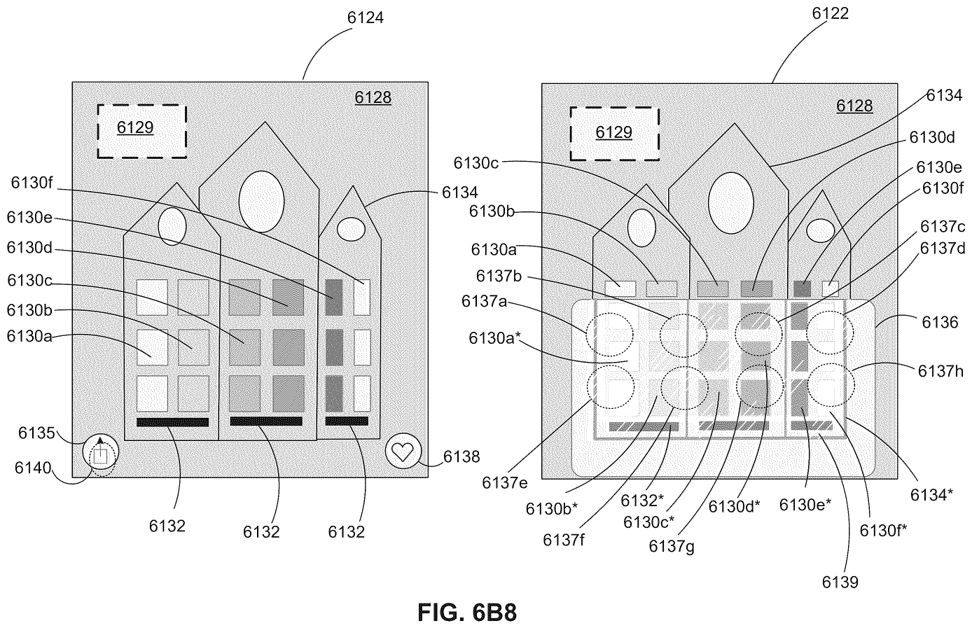

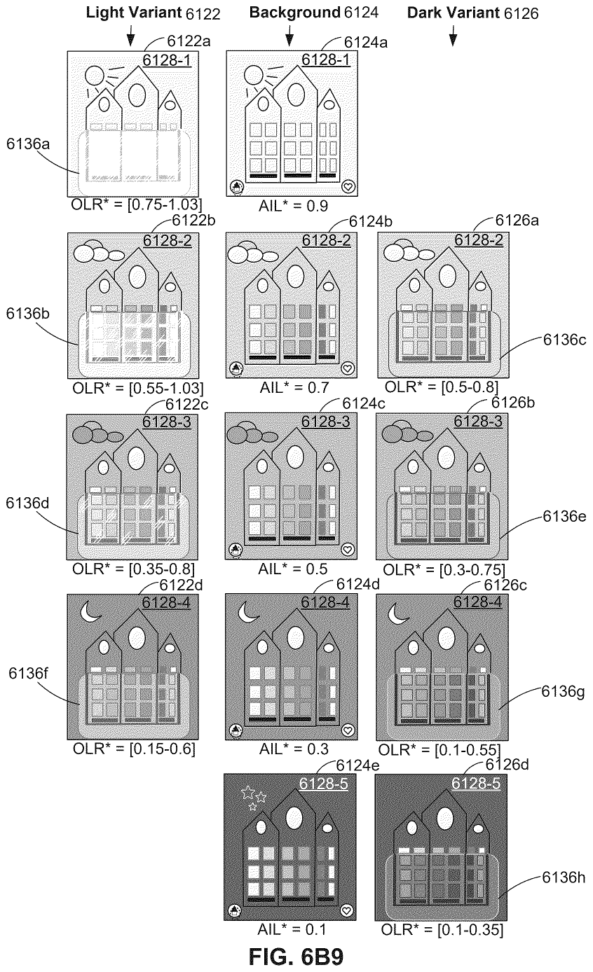

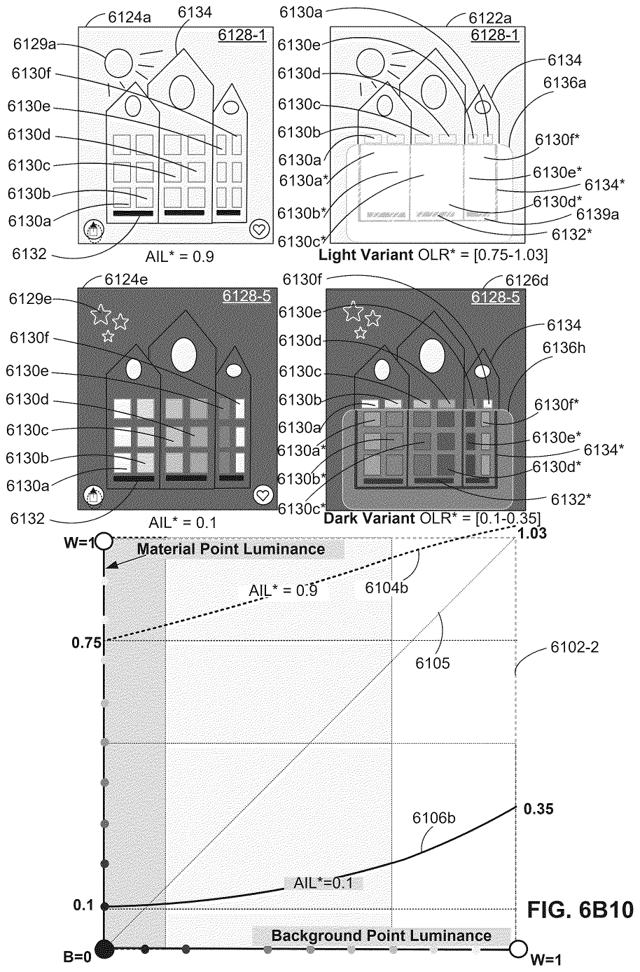

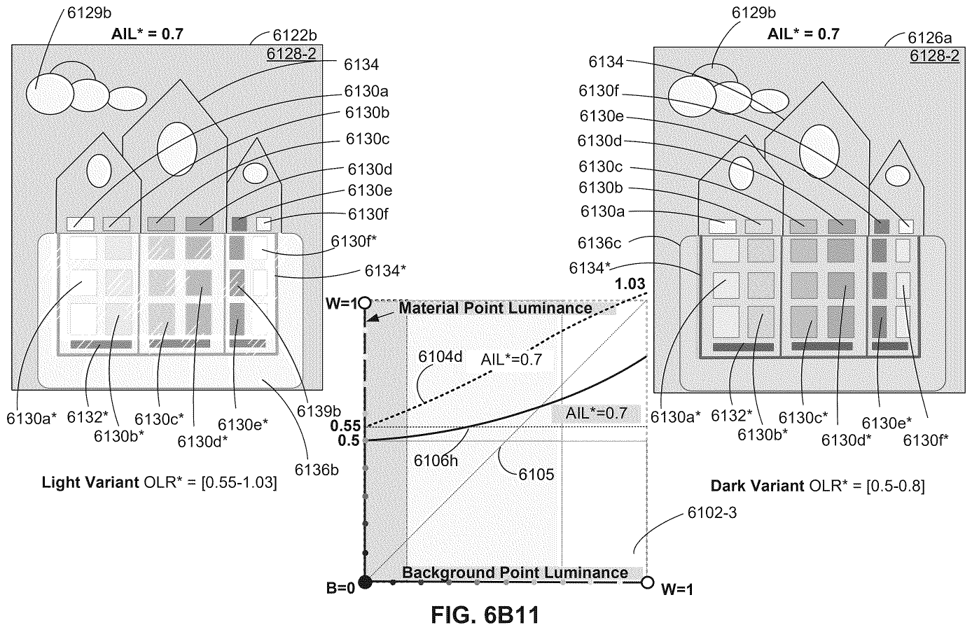

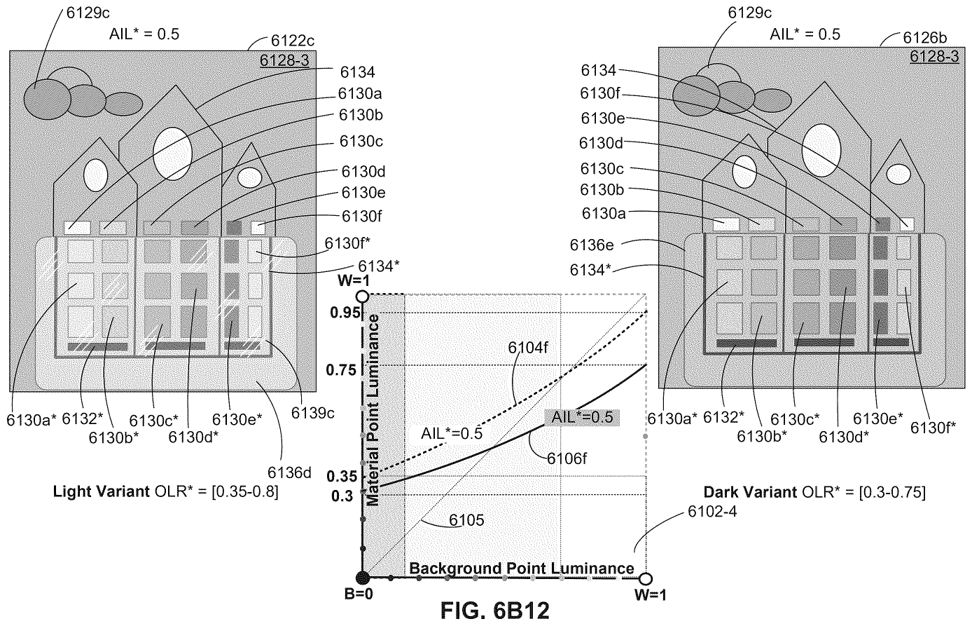

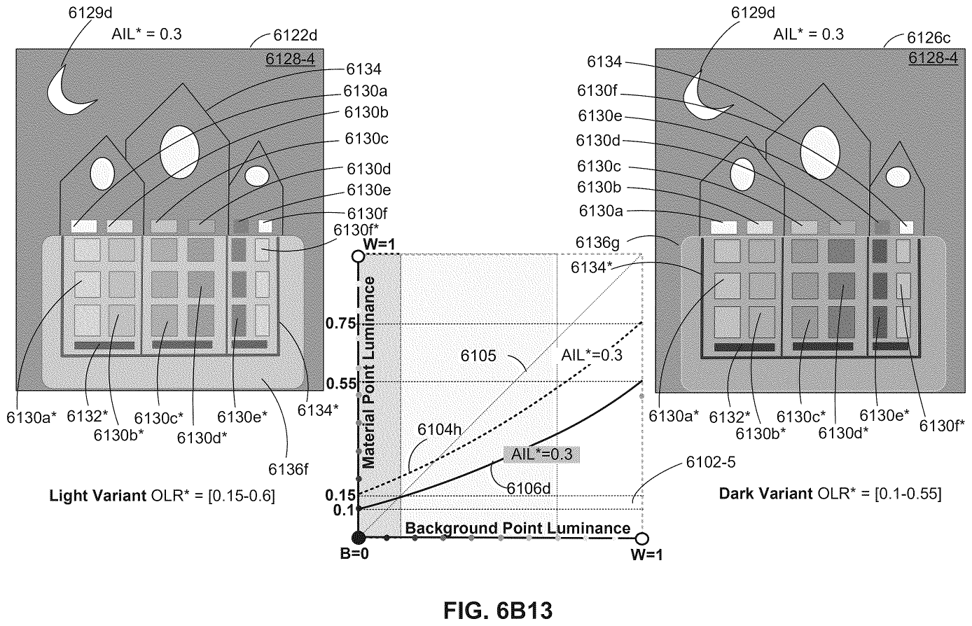

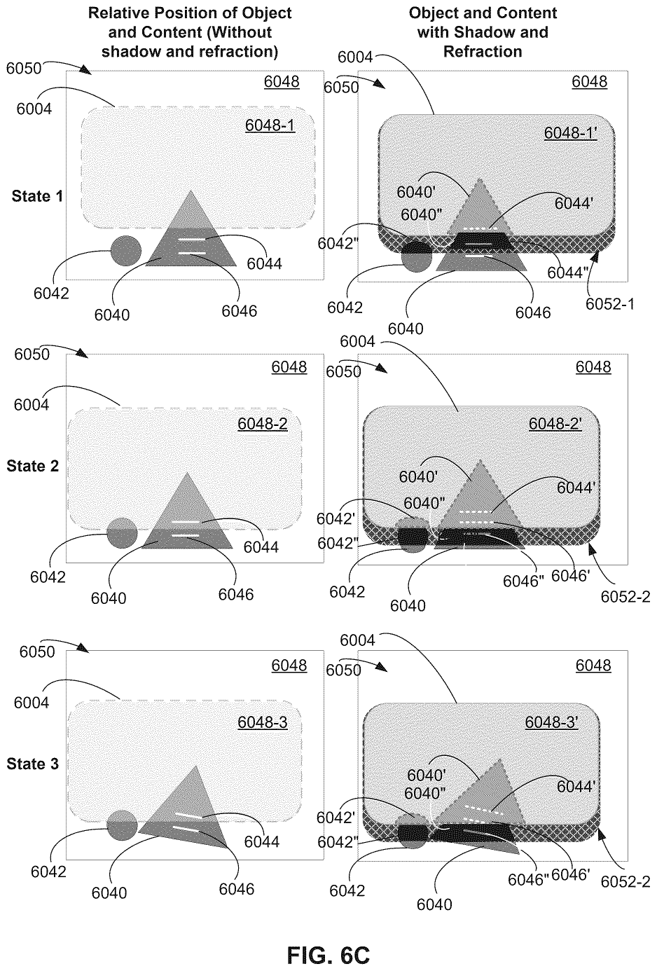

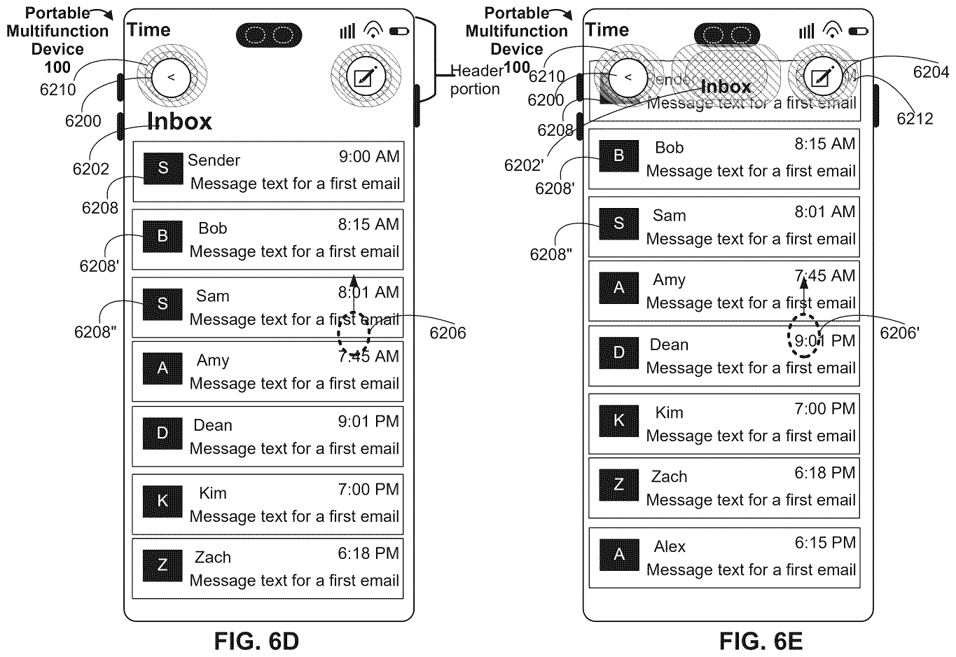

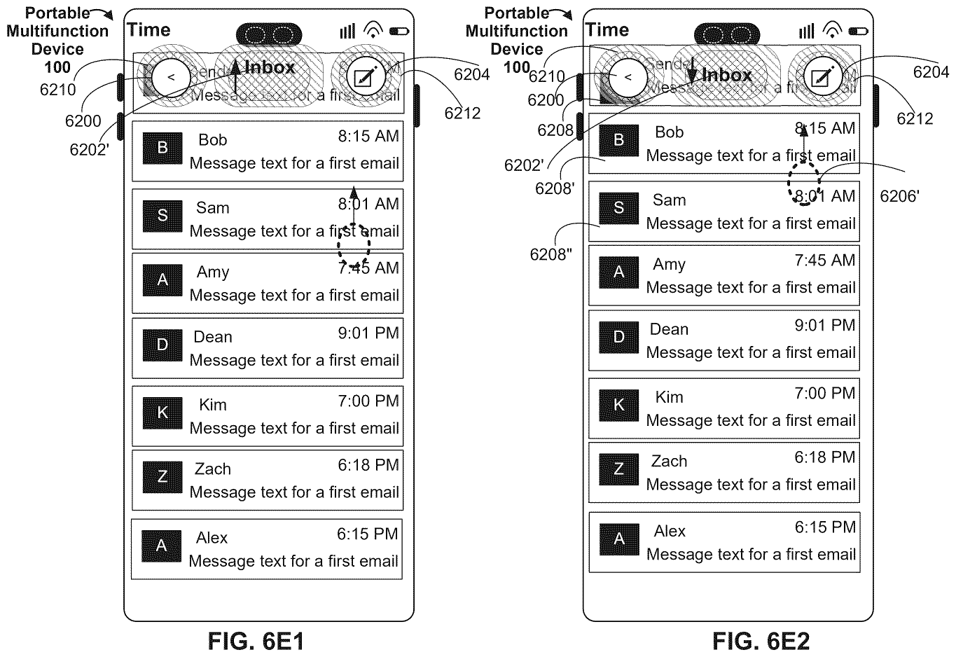

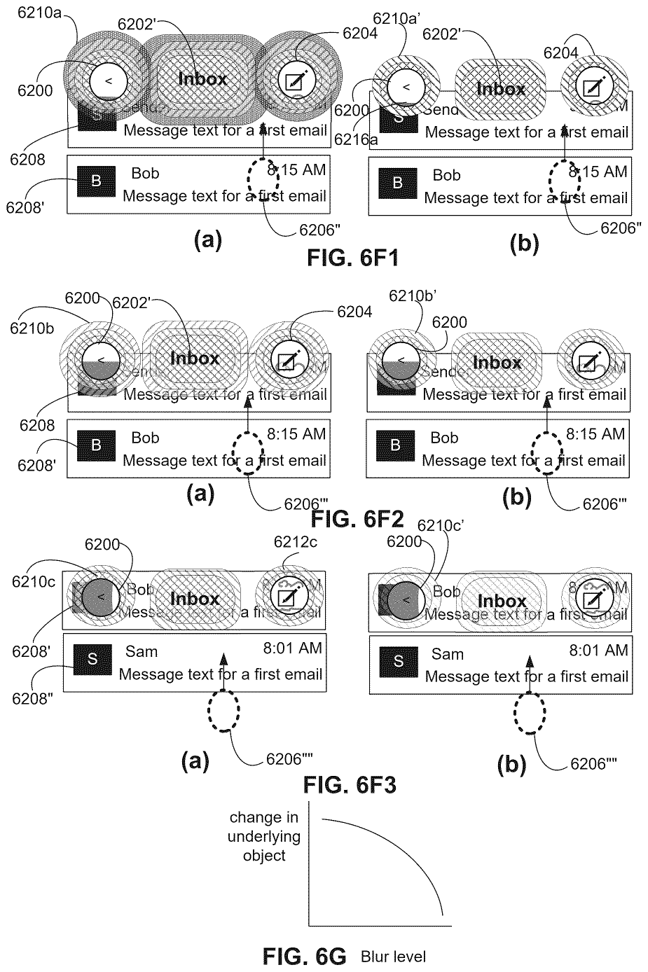

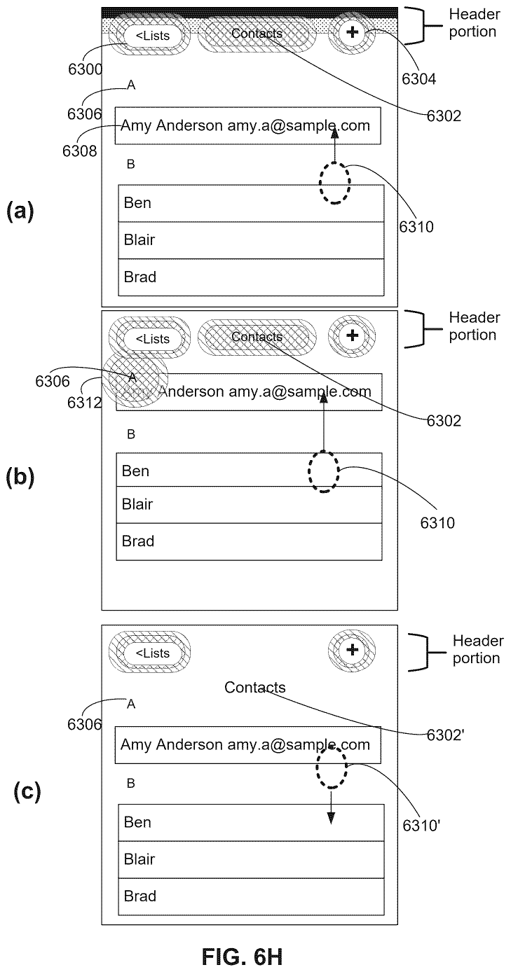

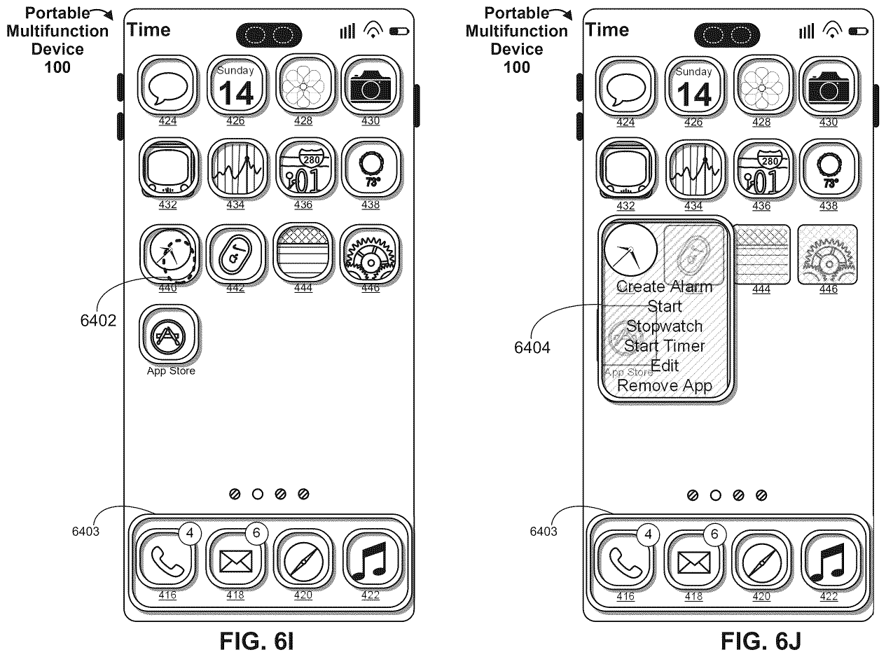

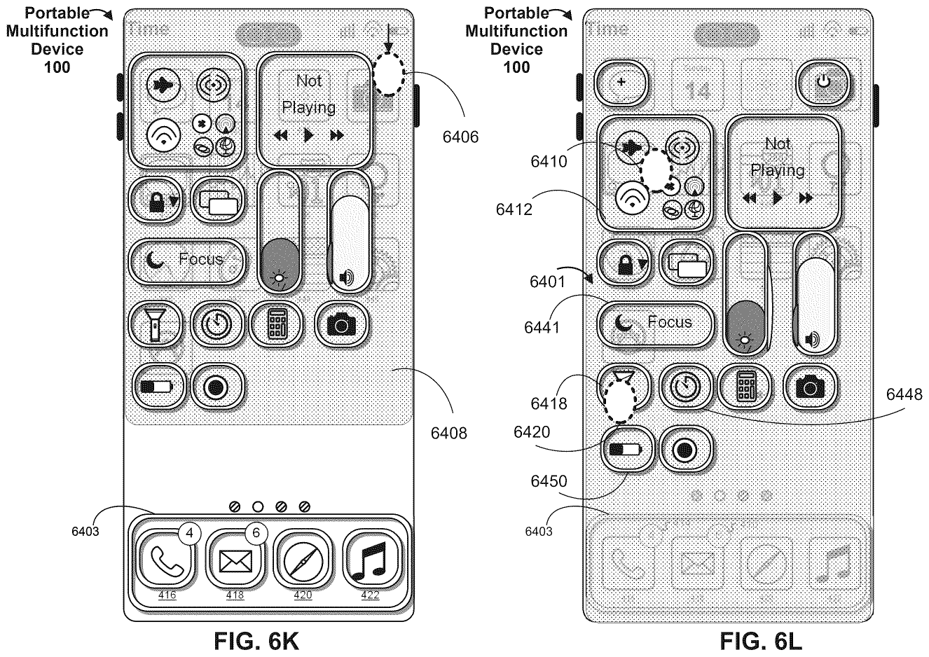

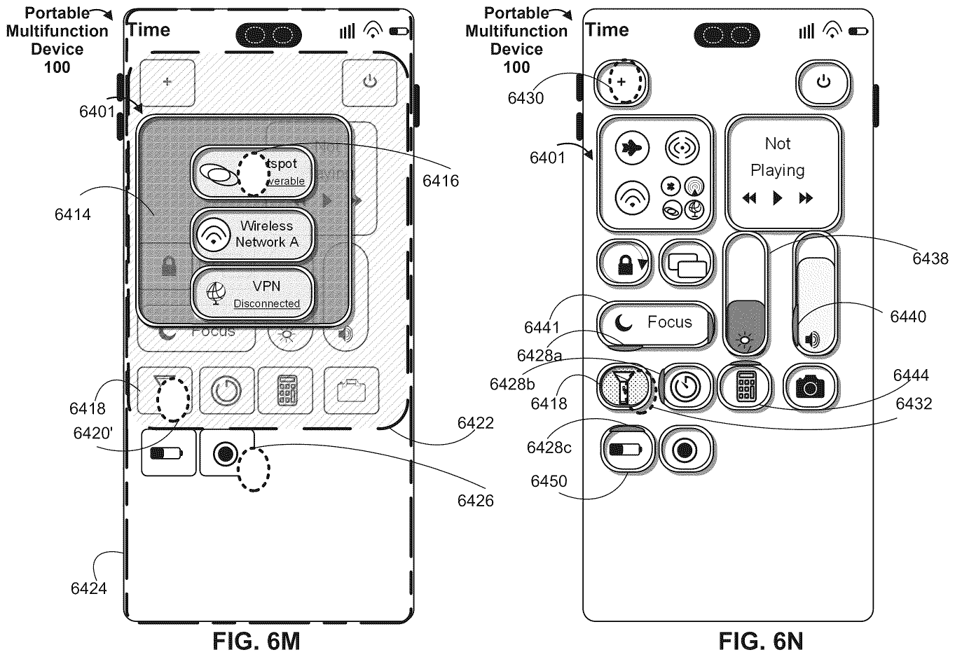

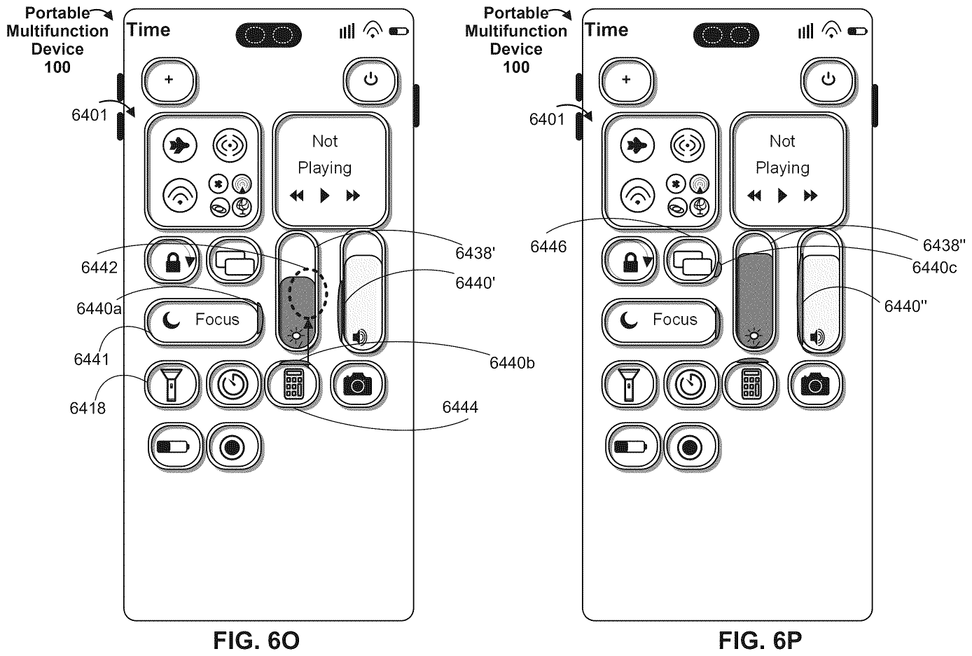

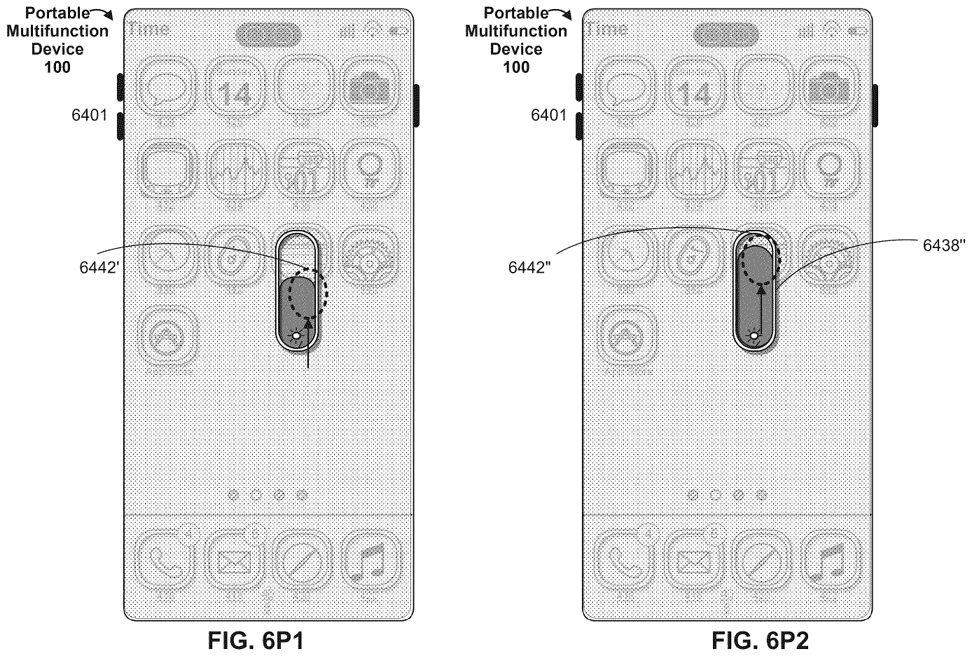

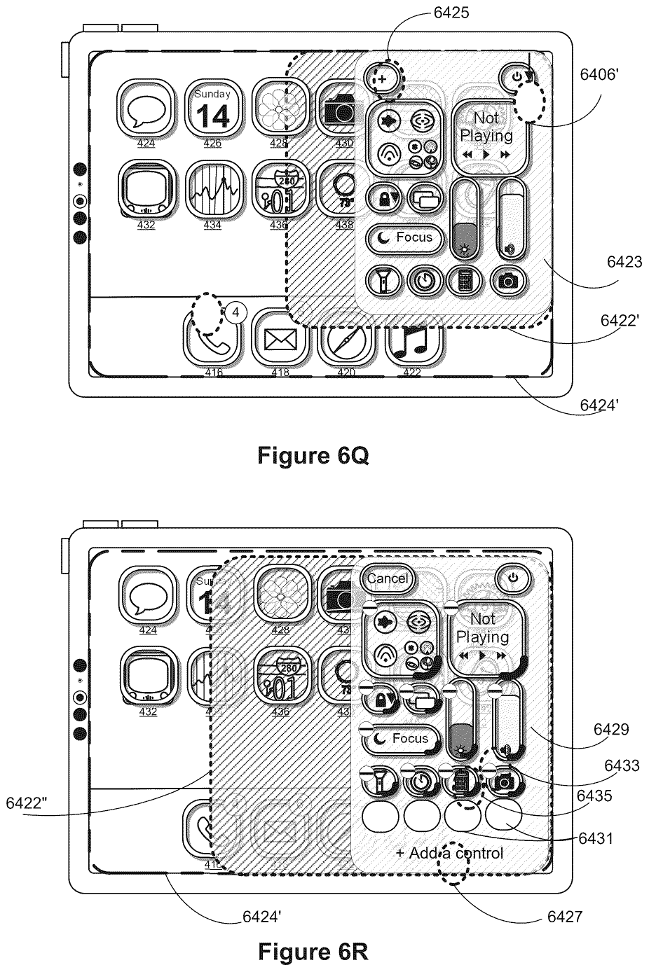

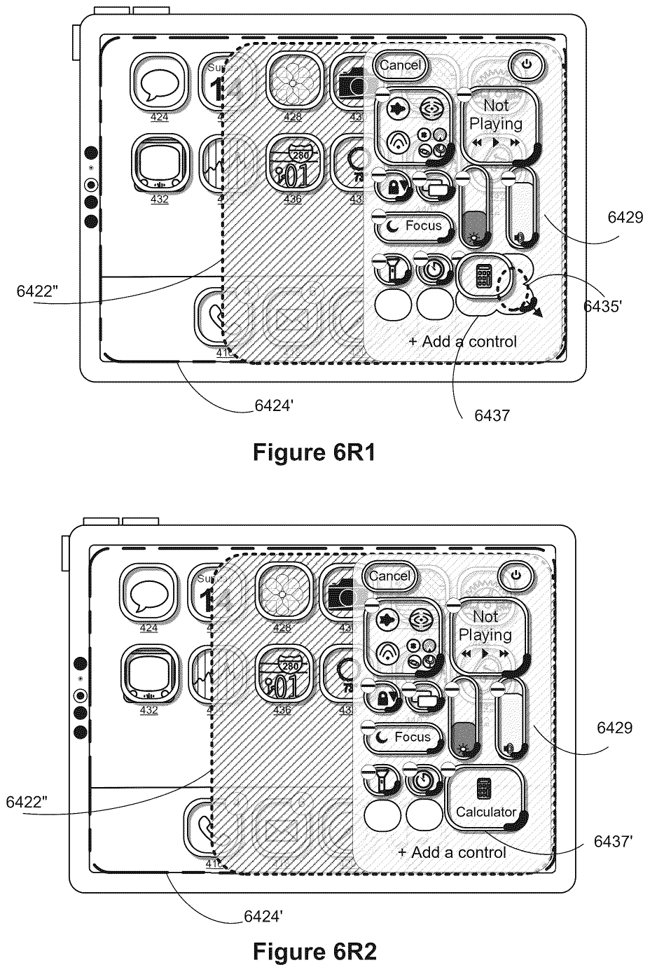

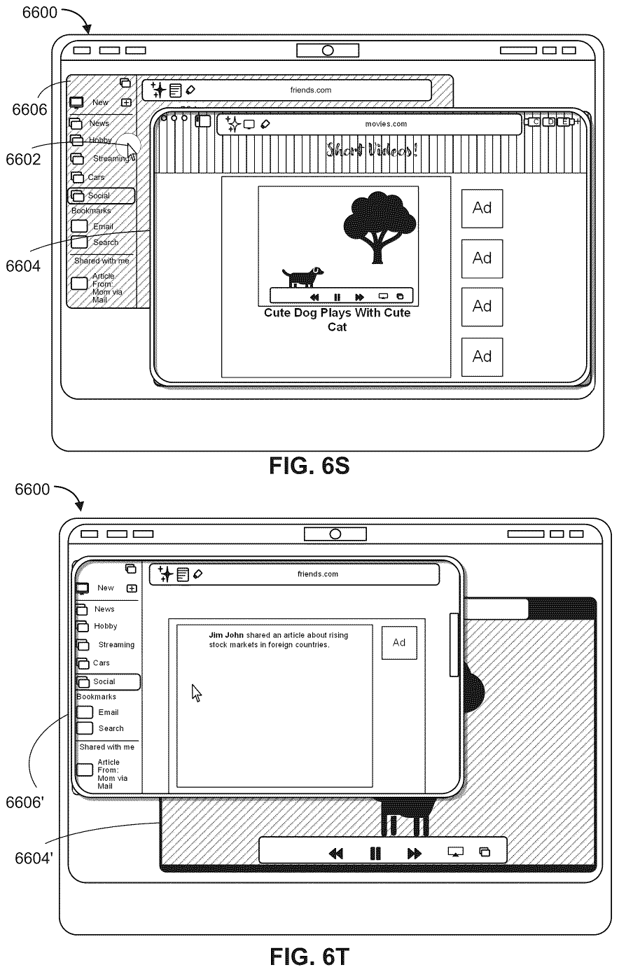

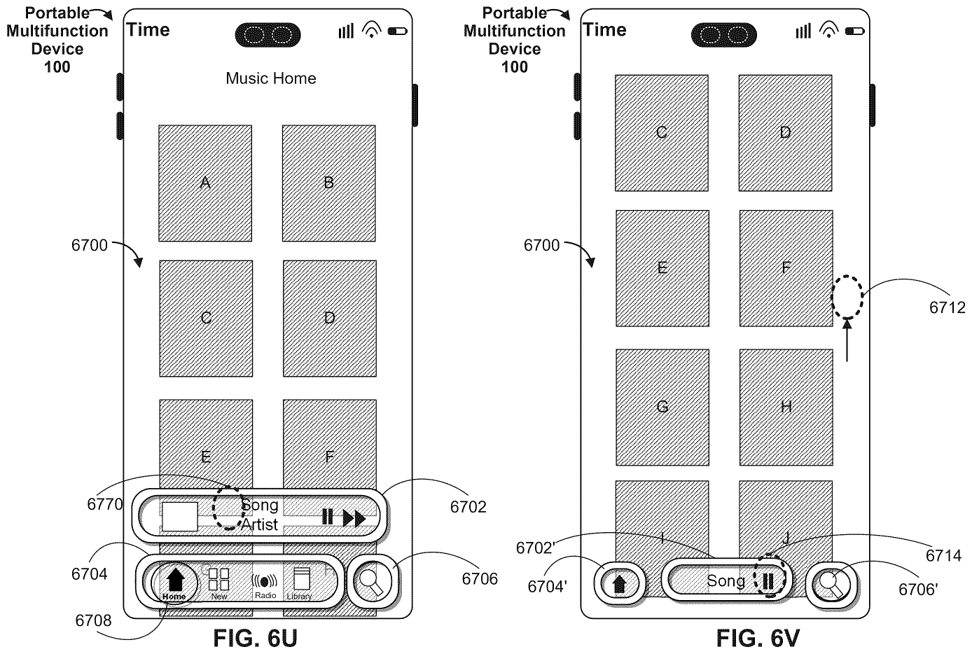

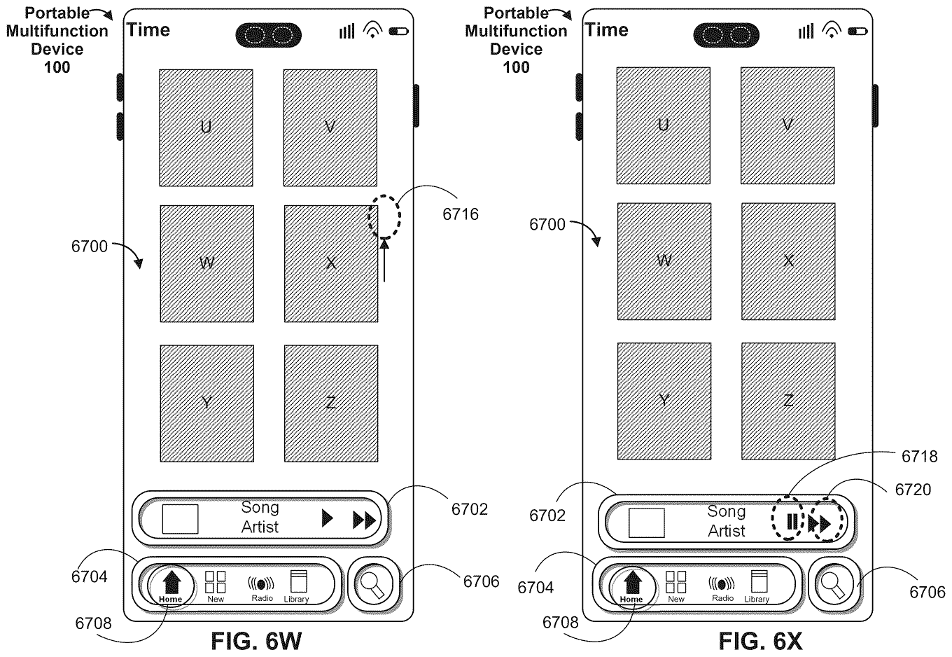

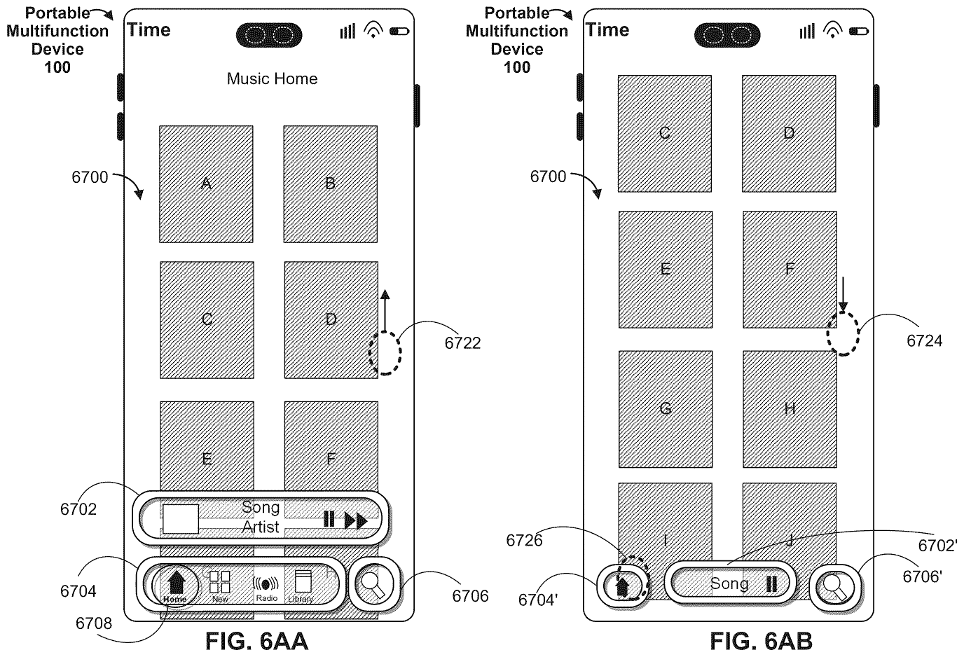

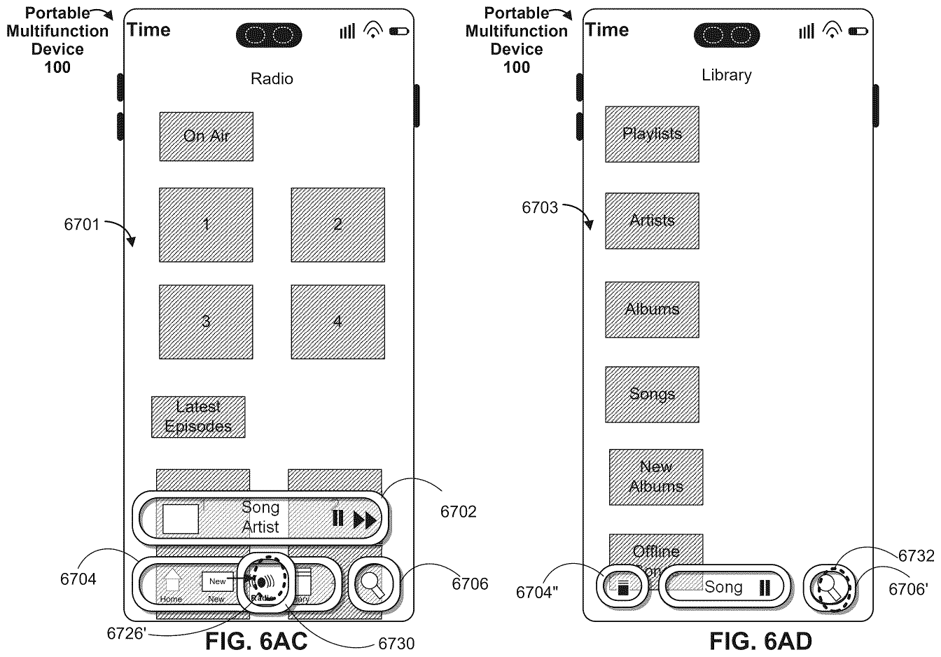

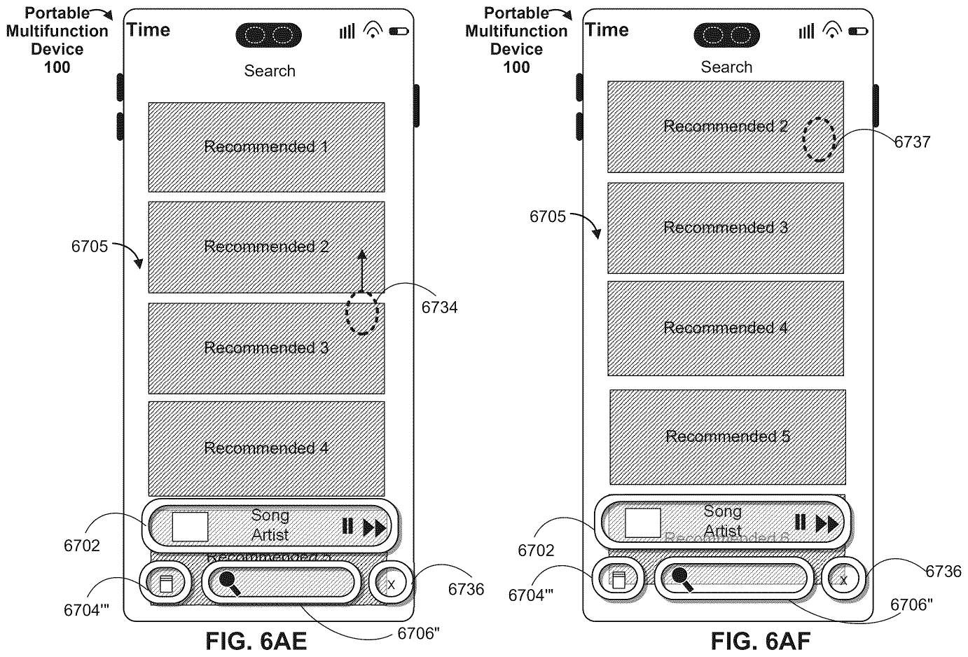

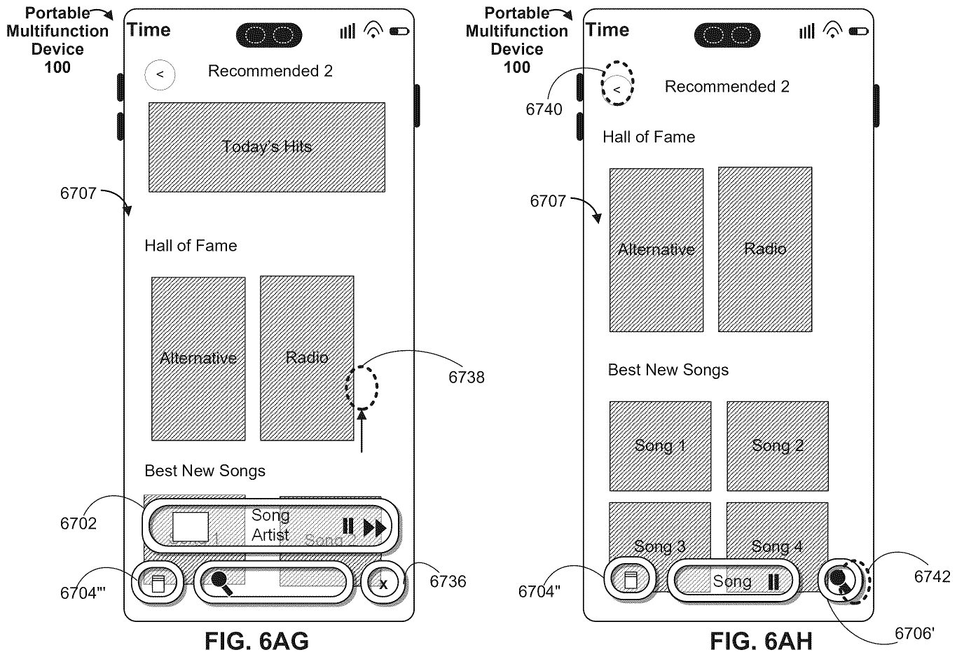

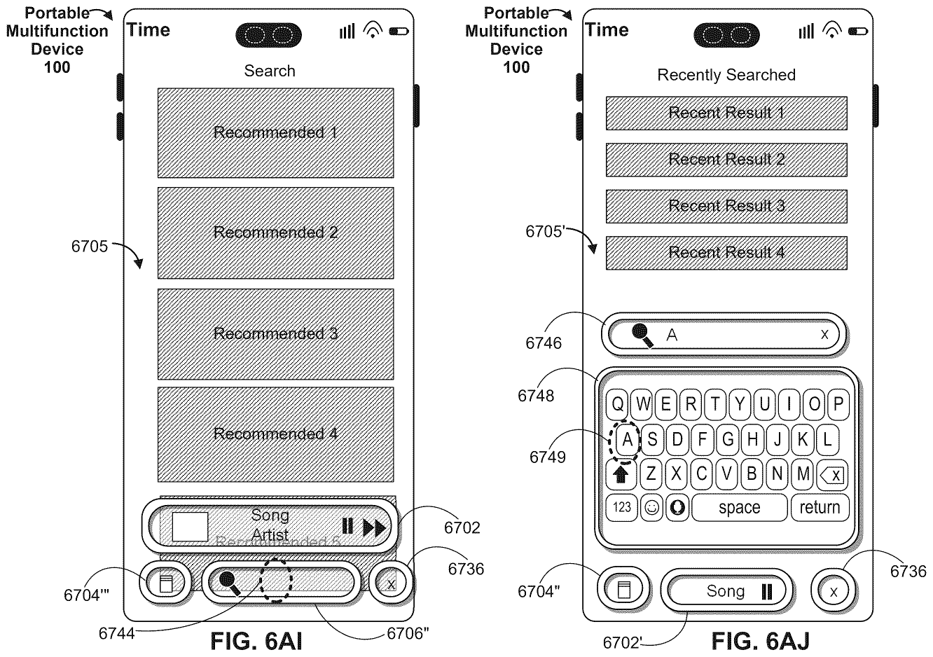

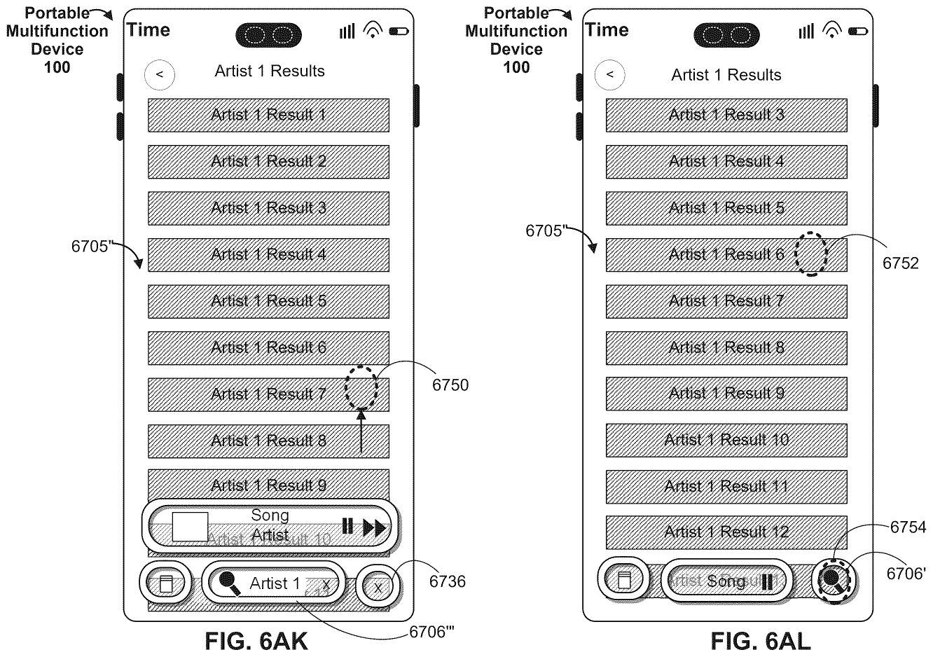

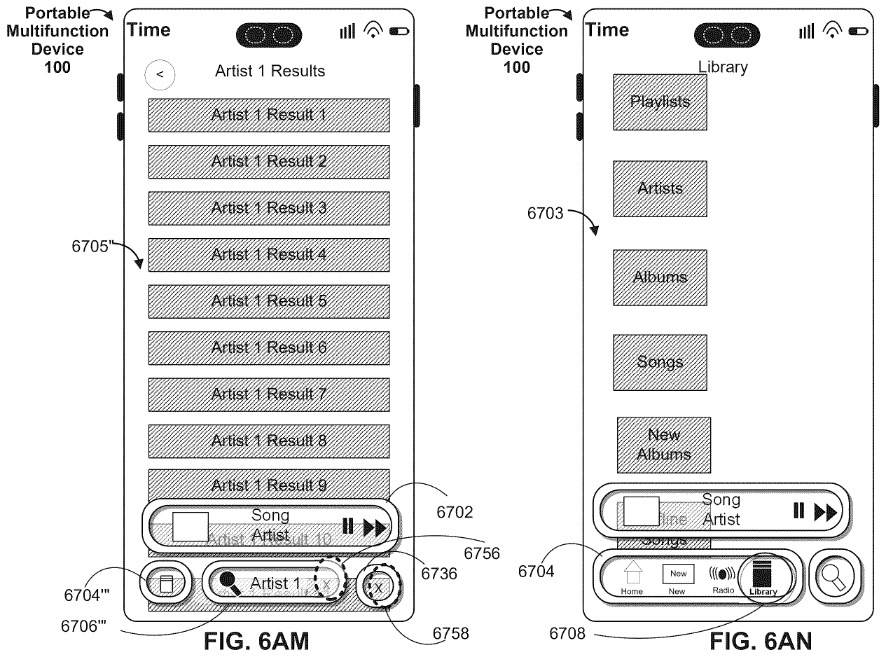

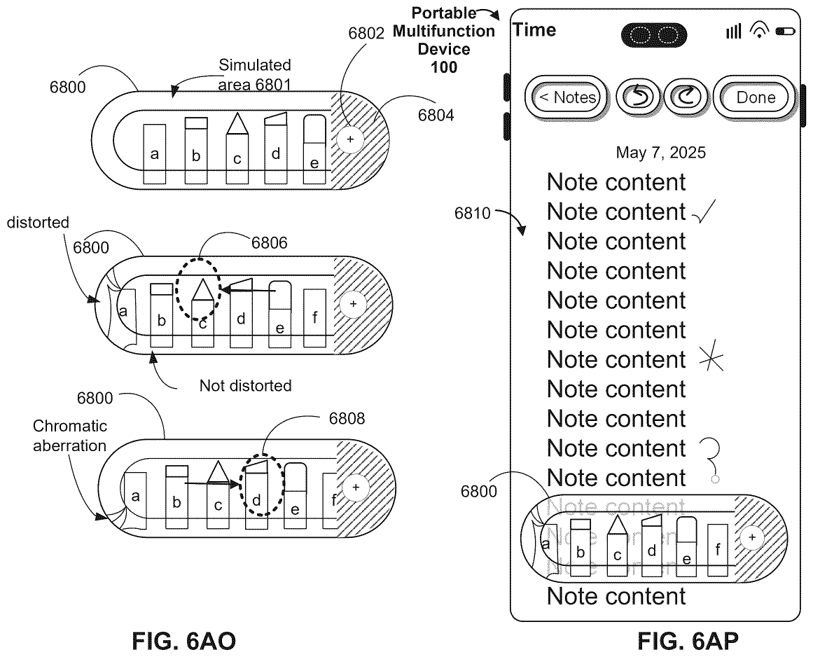

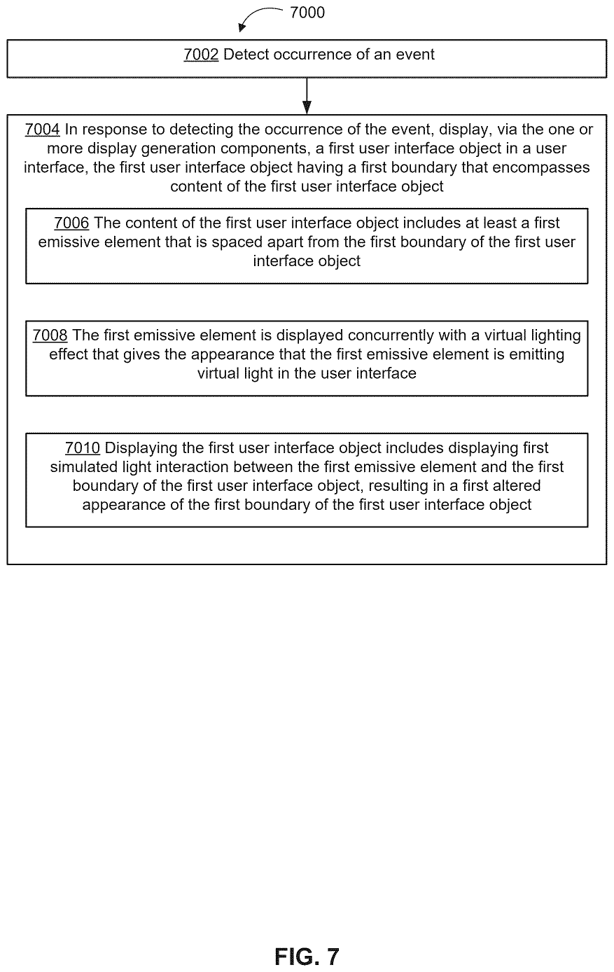

FIG. 7 is a flow diagram illustrating a method 7000 of displaying a simulated emissive user interface element in accordance with some embodiments. The method 7000 is performed at an electronic device (e.g., device 300, FIG. 3A, or portable multifunction device 100, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in method 7000 are, optionally, combined and/or the order of some operations is, optionally, changed. In some embodiments, the method 7000 is performed at a computer system that is in communication with one or more input devices and one or more display generation components. In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

Displaying virtual lighting effects as emanating from an emissive user interface element provides the user with information about the spatial relationships between the user interface elements, and provides visual feedback regarding the effect of user input, informs the user about the change in the state of the computer system and application, and guides the user about how to use his/her input to change the system state and/or application state. Displaying virtual lighting effects that affect other user interface elements in a user interface, and updating the virtual lighting effects in response to user selections and interactions with content, improves the responsiveness of user interface elements to inputs, which enables a user to use a device for shorter periods of time, which saves energy and improves battery life. Automatically changing an appearance of user interface elements (e.g., changing the virtual lighting effects) when one or more criteria are met reduces the number of inputs (e.g., navigating through settings user interfaces and menus to set the values for parameters to adjust the virtual lighting effects) that would otherwise be required to generate a similar effect, which saves energy and improves battery life.

The computer system detects (7002) occurrence of an event. In some embodiments, the event includes a device wake event, such as: a change in a charge state, receiving a notification, reaching a time set for an alarm, and/or reaching the end of a timer. In some embodiments, the event includes satisfaction of conditions (e.g., based on changes in an external environment that are detected via one or more input devices and/or changes in the internal state of the computer system) for displaying an alert, changing a currently displayed user interface to another user interface, updating content in the currently displayed user interface, based on prior configuration and/or setting of the operating system and/or application. In some embodiments, the event includes detection of a user input, such as: a button press, knob rotation, voice input, touch input, and/or air gesture, via the one or more input devices.

In response to detecting the occurrence of the event, the computer system displays (7004), via the one or more display generation components, a first user interface object in a user interface (e.g., a window, a three-dimensional environment, a pseudo-three-dimensional environment that provides partial depth information and/or incomplete three-dimensional spatial information for objects within the environment, a background platter, and/or another user interface object), the first user interface object having a first boundary that encompasses content of the first user interface object (e.g., the first boundary is an edge and/or border of the first user interface object that separates the content of the first user interface object from other user interface objects and/or other content in the user interface). For example, the calendar widget 506 includes edges (e.g., including portion of the edge 530 as well as other portions of outer edges of the widget 506) that create a boundary of the widget.

The content of the first user interface object includes (7006) at least a first emissive element that is spaced apart from the first boundary of the first user interface object (e.g., a portion of a background of the first user interface object and/or unoccupied region is visible between the first emissive element and the boundary of the first boundary of the first user interface object). For example, as described with reference to FIG. 5B, calendar widget 506 includes emissive element 526-1 that is separate from the edges of calendar widget 506.

The first emissive element is displayed (7004) concurrently with a virtual lighting effect that gives the appearance that the first emissive element is emitting virtual light in the user interface (e.g., the virtual light is shown as color and brightness variations that appear to emanate from the first emissive element to its immediate surrounding regions, including occupied or unoccupied regions, producing virtual reflections, virtual illuminations, and/or virtual shadows, based on the color, brightness, geometry, emissive direction(s), and location of the first emissive element), For example, as described with reference to FIG. 5B, emissive element 526-1 appears to emit a virtual lighting effect as applied to portion 520 and portion 510 of the edges of the calendar widget 506.

Displaying the first user interface object includes (7010) displaying first simulated light interaction between the first emissive element and the first boundary of the first user interface object, resulting in a first altered appearance of the first boundary of the first user interface object. In some embodiments, the first altered appearance of the first boundary is generated in accordance with a first spatial relationship between the first emissive element and the first boundary of the first user interface object. In some embodiments, the virtual lighting effect applies to the first user interface object itself (e.g., to content within the first boundary of the first user interface object) and optionally applies to content in the user interface that is outside of the first boundary that encompasses the first user interface object (e.g., other user interface objects and/or backgrounds displayed in the user interface). In some embodiments, the virtual lighting effect corresponds to a color determined by a color of the first emissive element (e.g., a red emissive element causes the virtual lighting effect to be displayed with a red color). In some embodiments, the first emissive element may include different sub-elements having different colors and intensities, and the sub-elements may have different individual impacts that contribute to the overall change in appearance of the first user interface object. In some embodiments, the virtual lighting effect from the first emissive element is displayed as interacting with the first boundary of the user interface element, based on the spatial relationship between the first emissive element and the first boundary, based on based on the relative and/or absolute geometric sizes of the first emissive element and the first boundary, and/or based on the shapes of the first emissive element and the first emissive element and the first boundary (e.g., virtual light having stronger virtual reflection and/or virtual refraction at portions of the first boundary of the first user interface object that are closer to the location of the first emissive elements, and/or the portions that have the sharpest corners and curves). In some embodiments, the virtual lighting effect that is displayed on at least a portion of the first boundary comprises specular highlighting at a portion of the first boundary of the first user interface object, simulating a virtual internal reflection and/or refraction at the first boundary that separates the interior region of the first user interface element and the region outside of the first user interface element). In some embodiments, the portion of the first user interface object that lies between the first boundary and the first emissive element is also displayed with some virtual lighting effect of the first emissive element, however, the virtual lighting effect in this portion of the first user interface simulates transmission of the virtual light, which results in less alteration in appearance as compared to the amount of alteration when the virtual light reaches the first boundary. In some embodiments: the simulated light interaction has a color based on the color of the emissive element (e.g., having the same color and/or having tints and shades of the color of the emissive element). In some embodiments, the simulated light interaction changes based on a simulated brightness of the emissive element (e.g., a greater change in the appearance of the boundary for a greater simulated brightness of the emissive element, and a subtler change in the appearance of the boundary for a lesser simulated brightness of the emissive element). In some embodiments, the simulated light interaction changes based on a distance between the simulated emissive element and the portion of the first user interface object that changes in appearance based on the simulated emissive element (e.g., a greater change in appearance for a portion of the first user interface object that is closer to the emissive element, and/or a smaller change in appearance for a portion of the first user interface object that is farther away from the emissive element). In some embodiments, the simulate light interaction between the emissive element and other elements, e.g., boundary, internal portions, and/or content of the first user interface object, is based at least in part on simulated reflective and/or simulated refractive properties of the other elements. For example, as described with reference to FIG. 5B, emissive element 526-1 alters the appearance of the boundary of calendar widget 506, including portion 520 and portion 510.

In some embodiments, displaying the first simulated light interaction between the first emissive element and the first boundary of the first user interface object includes, in accordance with the first emissive element having a first spatial relationship (e.g., first distance and/or first angle relative to) to a first portion of the first boundary (e.g., a first corner, first linear segment, first curved segment, and/or first edge), displaying a first change in appearance in the first portion of the first boundary (e.g., displaying a first specular highlight, first simulated refraction of underlying and/or internal content, first amount of blurring, and/or first color change). In some embodiments, displaying the first simulated light interaction between the first emissive element and the first boundary of the first user interface object includes, in accordance with the first emissive element having a second spatial relationship (e.g., second distance and/or second angle relative to), different from the first spatial relationship, to the first portion of the first boundary (e.g., the first corner, first linear segment, first curved segment, and/or first edge), displaying a second change in appearance (e.g., displaying a second specular highlight, second simulated refraction of underlying and/or internal content, second amount of blurring, and/or second color change), different from the first change in appearance, in the first portion of the first boundary. In some embodiments, the first user interface element has a geometric shape with a simulated non-zero thickness, and the first simulated light interaction between the first emissive element and the first boundary includes simulated reflection and/or simulated refraction that occur at the edges of the first user interface object, where the amount of reflection and/or the amount of refraction are based on the curvatures, thicknesses, simulated transmissivities, colors, and textures, at different portions of the first boundary, in addition to the color, brightness, geometry, emissive direction(s), and location of the first emissive element. For example, as described with reference to FIG. 5B, the emissive element 526-1 causes a virtual lighting affect to appear at portion 520 and portion 510 of the edges of the calendar widget 506. For example, as described with reference to FIG. 5C, portion 534 and portion 536 of the edges of the calendar widget 506 are displayed as interacting with the virtual lighting effect in accordance with the emissive element 526-2.

In some embodiments, displaying the first user interface object includes displaying simulated light interaction between the first emissive element and one or more interior portions of the first user interface object located between the first emissive element and the first boundary of the first user interface object (e.g., simulated reflection, simulated refraction, blurring, and/or color changes), resulting in an altered appearance of the one or more interior portions of the first user interface object. In some embodiments, based on the location of the first emissive element within the first user interface object, different sets of interior portions of the first user interface object are located between the first emissive element and the first boundary of the first user interface object, and take on altered appearances based on the virtual light that appears to emanate from the first emissive element. In some embodiments, the first user interface element has a geometric shape with a simulated non-zero thickness, and the simulated light interaction between the first emissive element and the interior portions of the first user interface object includes simulated reflection and/or simulated refraction that occur at the edges of internal regions and inside the internal regions, where the amount of reflection and/or the amount of refraction are based on the curvatures, thicknesses, simulated transmissivities, colors, and textures, at different portions of the first user interface element, in addition to the color, brightness, geometry, emissive direction(s), and location of the first emissive element. For example, as described with reference to FIGS. 5B-5C, the virtual lighting effect associated with the emissive element 526-1 is displayed as interacting with one or more user interface sub-elements within the calendar widget 506.

In some embodiments, the first user interface object is an application icon, and the first emissive element is an internal element of the application icon. In some embodiments, the first emissive element is a sub-element of an icon within the application icon, such as the moving hand(s) of a clock icon within the application icon of a clock application, or an image of the Sun partially covered by an image of a cloud within the application icon of a weather application. In some embodiments, the image of the Sun may become a full sun not covered by the cloud if the actual weather changes from cloudy weather to sunny weather. In some embodiments, the first emissive element is an entire foreground image within an application icon, overlaying a background of the application icon. In some embodiments, the first emissive element produces different specular highlights and simulated refraction on different portions of the edges of the application icon, and different amounts of simulated illuminations on different portions of the background within the application icon. In some embodiments, the application icon is displayed in a home screen user interface, a dock, search results for a system-wide search, an application library, a notification, and/or a control user interface. For example, as described with reference to FIG. 5B, application icon 450 includes an emissive element.

In some embodiments, the first user interface object is a widget (e.g., a weather forecast widget, a media player widget, an exercise widget, a stock widget, and/or other widgets corresponding to different applications; and/or another type of user interface objects that provide a subset of function and/or content from a corresponding system process or application) that includes status information (e.g., associated with a system process or an application) that changes over time (e.g., based on changes in state and/or content from the corresponding system process or application). In some embodiments, the first emissive element is an internal element of the widget (e.g., a user interface control, an icon, and/or a graphical element within the widget). In some embodiments, the first emissive element changes its appearance over time based on the updates made to the application content within the widget. For example, in one embodiment, the emissive element in a weather widget includes the graphical elements indicating the current weather, and the graphical elements change its appearance over time based on the change in current weather obtained from the weather application. In one example, the emissive element in an exercise widget includes the graphical elements indicating the current progress of different types of exercises, and the graphical elements change their appearances (e.g., color, size, and/or length) based on the changes in the exercise information obtained from the exercise application. In some embodiments, the widget includes other content that are not emissive elements, and may change their appearance as the result of simulated light interaction between the emissive element and the other content (e.g., as simulated transmission, refraction, illumination, shadow, and/or refraction of the virtual light from the emissive element). In some embodiments, the first emissive element produces different specular highlights and simulated refraction on different portions of the edges of the widget, and different amounts of simulated illuminations on different portions of the background and/or other application content within the widget. In some embodiments, the widget is displayed in a home screen user interface, a widget interface, a wake screen user interface, search results for a system-wide search, and/or a control user interface. For example, as described with reference to FIGS. 5B-5C, the calendar widget 506 includes an emissive element 526-1 and/or emissive element 526-2.

In some embodiments, the first user interface object is a selectable object (e.g., an email item in a listing of emails; a notification in a listing of notifications, a selectable user interface control, and/or other types of selectable object). While displaying, via the one or more display generation components, the first user interface object in the user interface, the computer system detects, via the one or more input devices, a selection input that is directed to the first user interface object. In response to detecting the selection input that is directed to the first user interface object, the computer system performs an operation that corresponds to selection of the first user interface object. In some embodiments, the selection input includes an input that meets selection criteria with respect to the first user interface object. In some embodiments, the selection input includes a tap gesture, a light press input, a double tap gesture, a long press input, and/or another type of touch gesture meeting selection criteria, by one or more contacts at a location corresponding to the first user interface object. In some embodiments, the selection input includes an air tap gesture, an air pinch gesture, an air pinch and hold gesture, and/or another type of air gesture that is detected in conjunction with user's attention being directed to the first user interface object and/or while the first user interface object has input focus. In some embodiments, the selection input includes other types of input such as actuation of a hardware button, a voice command, and/or movement of a switch or selection wheel, while the user's attention is directed to the first user interface object and/or while the first user interface object has input focus. In some embodiments, the first user interface object is not merely providing visual information based on its internal content, the first user interface object also provides access to functionality of the computer system that is beyond the visual information. In some embodiments, performing the first operation in response to detecting the selection input directed to the first user interface object includes opening an application corresponding to the first user interface object (e.g., when the first user interface object is an application icon or a widget of the application). In some embodiments, performing the first operation includes displaying additional information that was not included in the first user interface object prior to detecting the selection input directed to the first user interface object (e.g., when the first user interface object is a notification, an email item in a listing of emails, a message in a listing of messages, a notification in a stack of coalesced notifications). In some embodiments, performing the first operation includes navigating to another user interface that is different from the user interface containing the first user interface object and/or displaying visual feedback indicating success or failure of performance of the operation, optionally in addition to changing the internal state of the computer system and/or other peripheral systems (e.g., turning on/off a peripheral device, a hardware functionality, a DND mode, and/or other functionalities). For example, as described with reference to FIGS. 5D-5E, in some embodiments, a user interface element 546 is a selectable message 552-1 that acts as an emissive element.

In some embodiments, the computer system displays, via the one or more display generation components, additional content of the user interface (e.g., background, other user interface objects, other emissive elements that are part of the user interface), concurrently with the first user interface object, within the user interface. The computer system displays, via the one or more display generation components, simulated light interaction between the first emissive element and the additional content of the user interface (e.g., simulated light transmission, reflections, refractions, illumination, shadows, and/or internal reflections), resulting in an altered appearance of the additional content in the user interface. In some embodiments, the altered appearance of the additional content is generated in accordance with a spatial relationship between the first emissive element and the additional content in the user interface. In some embodiments, the simulated light interaction has a color determined by a color of the first emissive element (e.g., a red emissive element causes simulated light interaction to be based on a red light). In some embodiments, the simulated light interaction between the additional content in the user interface and the first emissive element is based on the spatial relationship between the first emissive element and the different portions of the additional content in the user interface, based on based on the relative and/or absolute geometric sizes of the first emissive element and the different portions of the additional content in the user interface, and/or based on the shapes of the first emissive element and the different portions of the additional content (e.g., virtual light having stronger virtual reflection and/or virtual refraction at portions of the additional content that are closer to the location of the first emissive elements, and/or the portions that have the sharpest corners and curves). In some embodiments, the simulated light interactions between the first emissive element and the additional content in the user interface include specular highlighting at one or more boundaries of the additional content, virtual internal reflections and/or refractions at one or more boundaries of other interface objects in the user interface that are located outside of the first user interface object. For example, as described with reference to FIG. 5B, the application icon 450 causes a virtual lighting effect that interacts with the calendar widget 506.

In some embodiments, the additional content includes a background of the user interface (e.g., a platter, a wallpaper, and/or other blank material supporting and underlying the user interface objects of the user interface). In some embodiments, and displaying the simulated light interaction between the first emissive element and the additional content of the user interface includes displaying an altered appearance of one or more portions of the background based on simulated virtual light interactions between the first emissive element and the background of the user interface. For example, in a home screen user interface that includes a wallpaper and a plurality of application icons, the yellow virtual light emanating from the image the Sun in the application icon of a weather application alters the appearance of portions of the wallpaper (e.g., portions in the same row and column as the application icon, and immediately surrounding the application icon are displayed with greater brightness and a yellow tint). In some embodiments, if multiple application icons included in the home screen user interface include emissive elements, the wallpaper would have different alterations to its appearance at different portions of the wallpaper based on the locations of these emissive elements and their individual visual characteristics. For example, in FIGS. 5D-5E, the user interface element 546 that acts as an emissive element causes a virtual lighting effect that impacts a background portion of the user interface that displays message 1 content 554.

In some embodiments, the additional content includes one or more other user interface objects different from the first user interface object (e.g., application icons, widgets, user interface controls, and/or content, that are of the same object type as the first user interface object, and/or that are of different object types from the first user interface object), and displaying the simulated light interaction between the first emissive element and the additional content of the user interface includes displaying altered appearances of the one or more other user interface objects based on simulated virtual light interactions between the first emissive element and the one or more other user interface objects in the user interface. For example, a home screen user interface or a wake screen user interface may include multiple application icons and/or widgets, when at least one of the application icons and/or widgets include an emissive element, the virtual light emanating from the emissive element of one application icon and/or widget can alter the appearances of other application icons and/or widgets that are located nearby in the same user interface. For example, the yellow virtual light emanating from the image the Sun in the application icon of a weather application not only alters the appearance of portions of the wallpaper (e.g., portions in the same row and column as the application icon, and immediately surrounding the application icon are displayed with greater brightness and a yellow tint), but also illuminates one or more nearby application icons and/or widgets, and optionally produces specular highlights, refractions, and/or other virtual lighting effects on the application icon(s) and widget(s). In some embodiments, the application icons and/or widgets that are located farther away from the emissive element, and/or are separate from the emissive element by other object(s), do not undergo a change in appearance due to the presence of the emissive element. For example, as described with reference to FIG. 5B, the application icon 450 causes a virtual lighting effect that interacts with the calendar widget 506.

In some embodiments, the additional content includes a first subset of content located in a first region of the user interface (e.g., the first subset of content includes a first set of application icons, widgets, and/or user interface objects, located in a first region of a home screen, wake screen, and/or another user interface). In some embodiments, the additional content includes a second subset of content located in a second region of the user interface (e.g., the second subset of content includes a second set of application icons, widgets, and/or user interface objects, located in a second region of the home screen, wake screen, and/or another user interface). In some embodiments, the first region of the user interface has a first spatial relationship to the first user interface object. In some embodiments, the second region of the user interface has a second spatial relationship to the first user interface object that is different from the first spatial relationship. In some embodiments, displaying the simulated light interaction between the first emissive element and the additional content of the user interface includes displaying, via the one or more display generation components, a first set of changes to the first subset of content located in the first region of the user interface based on the first spatial relationship between the first region and the first user interface object (e.g., the first set of changes includes stronger simulated light interactions for a set of user interface objects that are located closer to the first user interface object and/or the first emissive element). In some embodiments, displaying the simulated light interaction between the first emissive element and the additional content of the user interface includes displaying, via the one or more display generation components, a second set of changes to the second subset of content located in the first region of the user interface based on the second spatial relationship between the second region and the first user interface object (e.g., the first set of changes includes weaker simulated light interactions for a set of user interface objects that are located farther away from the first user interface object and/or the first emissive element), wherein the first set of changes differs from the second set of changes (e.g., differ in the amounts of virtual illumination, virtual reflections, virtual refractions, and/or shadows caused by the virtual light emanating from the first emissive element) based on a difference between the first spatial relationship to the first user interface object and the second spatial relationship to the first user interface object. In some embodiments, the first user interface object is displayed at different positions in the user interface based on various conditions being met and/or in response to user input moving the first user interface object relative to other user interface objects in the user interface. For example, in some embodiments, when the application icon of an automatically recommended application (e.g., weather application, exercise application, and/or another application with an emissive element) is displayed in a first slot of a dock and/or application recommendation widget in a first context of the computer system, the emissive element of the application icon affects the appearances of a first set of surrounding objects, such as the automatically recommended application icon in the second slot and, optionally, the automatically recommended application icon in the first slot in an adjacent row, to a greater extent, as compared to the objects that are farther away from the application icon with the emissive element (e.g., as compared to the application icon in the third and fourth slots in the same row, and the second, third, and fourth slots in the adjacent row). In some embodiments, the first user interface object with the first emissive element is moved within the user interface in an animated transition, and/or in accordance with a movement of the user input that drags the first user interface object from one location to another location in the user interface; and as a result, different sets of user interface objects are shown to have stronger simulated light interactions with the first user interface object based on the current location of the first user interface object. For example, when a calendar widget that includes an emissive element (e.g., the current date, or a next scheduled event) is moved from a first location of a home screen or wake screen user interface to a second location of the home screen or wake screen user interface, the emissive element produces virtual illumination and causes virtual reflections, refractions, and/or shadows on different sets of other application icons, widgets, and/or content in the home screen or wake screen user interface, based on the current location of the calendar widget. In some embodiments, the emissive element changes its positions within the first user interface object and emitting directions over time (e.g., due to a change in context of the device and/or one or more events or changes in state associated with the application or system process associated with the user interface object), and as a result, different sets of user interface objects exhibit stronger simulated light interactions based on the current position and/or light emitting direction of the first emissive element within the first user interface object. For example, in some embodiments, the moving second hand of a clock face in a clock widget and/or clock application icon is an emissive element that emit red light; and the red light causes different portions of its surrounding content, such as different portions of the clock face, different portions of the edges of the application icon and/or widget containing the clock face, and different sets of other application icons, widgets, portions of wallpaper, and/or other content, surrounding the clock application icon/widget, to exhibit stronger virtual light interactions with the red light emanating from the red second hand of the clock, over time during the movement of the red second hand of the clock. For example, as described with reference to FIGS. 5B-5C, the emissive element in calendar widget 506 interacts with different sub-elements that are close to the emissive element and optionally causes a less prominent virtual lighting effect on sub-elements that are farther away from the emissive element e.g., the sub-element corresponding to the “22” is displayed with a lesser amount of virtual lighting effect that appears to emanate from the emissive element 526-1 than the sub-element corresponding to the “15” (e.g., that is closer to the emissive element 526-1 than the “22”).

In some embodiments, the first user interface object includes a first interior portion and a second interior portion other than the first user interface object. In some embodiments, displaying the first user interface object includes displaying, via the one or more display generation components, simulated light interaction between the first emissive element and the first interior portion of the first user interface object based on a spatial relationship between the first emissive element and the first interior portion of the first user interface object (e.g., a set of stronger simulated light interactions for a set of content in the first user interface object that is located closer to the first emissive element). In some embodiments, displaying the first user interface object includes displaying, via the one or more display generation components, simulated light interaction between the first emissive element and the second interior portion of the first user interface object based on a spatial relationship between the first emissive element and the second interior portion of the first user interface object (e.g., a set of weaker simulated light interactions for a set of content in the first user interface object that is located farther away from the first emissive element). For example, the month view of a calendar widget includes an emissive highlight on the current date relative to other dates in the calendar; depending on the current date, the emissive highlight is located on different dates, and producing stronger simulated light interactions with different sets of dates in the calendar widgets (e.g., casting a colored hue, increasing brightness, and/or casting virtual shadows, causing reflections and/or refractions on those dates). In some embodiments, the emissive element changes its positions within the first user interface object and emitting directions over time, and as a result, different interior portions of the first user interface objects exhibit stronger simulated light interactions based on the current position and/or light emitting direction of the first emissive element within the first user interface object. For example, in some embodiments, the moving second hand of a clock face in a clock widget and/or clock application icon is an emissive element that emit red light; and the red light causes different portions of its surrounding content, such as different portions of the clock face, different symbols around the clock face, and/or different portions of the edges of the application icon and/or widget containing the clock face, to exhibit stronger virtual light interactions with the red light emanating from the red second hand of the clock, over time during the movement of the red second hand of the clock. For example, the emissive element 526-2 in FIG. 5C moves to the user interface sub-element corresponding to the “25,” which causes a different set of user interface sub-elements to be displayed as being affected by the virtual lighting effect.

In some embodiments, while displaying the first user interface object in the user interface and displaying the first simulated light interaction between the first emissive element and the first boundary of the first user interface object, the computer system detects, via the one or more input devices, a user input that is directed to the first user interface object. In some embodiments, the user input that is directed to the first user interface object includes a touch gesture performed by a contact on a touch-sensitive surface, an air gesture captured by one or more cameras, a hover input detected by a proximity sensor, a click input detected by a mouse, a voice input captured by a microphone, and/or another type of input detected by one or more input devices. In some embodiments, the user input is said to be directed to the first user interface object when the location of the user input (e.g., location of the contact, location of a gaze or user attention, location of a focus selector, location of the current input focus, and/or another type of targeted location for a currently detected user input) is on, in proximity to, corresponds to the location of the first user interface object, as opposed to another user interface object or the environment. In response to detecting the user input that is directed to the first user interface object, and in accordance with a determination that the user input meets first criteria (e.g., the user input that meets the first criteria is a tap gesture, an air pinch gesture, a first voice command, a single mouse click, and/or another type of user input that meets selection criteria with respect to the first user interface object), the computer system performs a first operation corresponding to the first user interface object (e.g., opening an application corresponding to the first user interface object, displaying application content corresponding to the first user interface object in an application corresponding to the first user interface object, and/or performing another operation that is associated with normal selection of the first user interface object). In response to detecting the user input that is directed to the first user interface object, and in accordance with a determination that the user input meets second criteria different from the first criteria (e.g., the user input that meets the second criteria is a long-press gesture, a light press gesture, a pinch and hold air gesture, an air flick gesture, a second voice command, a double mouse click, a click and hold input, a hard click input, and/or another type of user input that meets enhanced selection criteria with respect to the first user interface object), performing a second operation corresponding to the first user interface object, wherein the second operation is different from the first operation (e.g., displaying a contextual menu corresponding to the first user interface object, such as a quick action menu including selectable options corresponding to different operations associated with the first user interface object; displaying expanded content corresponding to the first user interface object without dismissing the first user interface object, and/or performing another operation that is associated with enhanced selection of the first user interface object). In some embodiments, the first user interface object does not have an operation associated with enhanced selection of the first user interface object, and the computer system forgoes performing the second operation, and instead generates an output indicating that the first user interface object does not have a corresponding object-specific operation associated with the enhanced selection input. For example, as described with reference to FIG. 5B, in response to detecting user input 551 directed to an application icon, if the user input 551 is a first type of input, such as a tap input, the device 100 displays a user interface for an application associated with the application icon and if the user input 551 is a second type of input, such as a tap and hold input, the device displays a quick actions menu associated with the application icon.

In some embodiments, the first user interface object includes at least a first subset of content, including the first emissive element, in a first content layer having a first position in a set of content layers (e.g., having a first display depth relative to a top layer of the first user interface object). In some embodiments, the first user interface object includes a second subset of content different from the first subset of content, in a second content layer having a second position in the set of content layers that is different from the first position in the set of content layers (e.g., having a second display depth relative to the top layer of the first user interface object, where the second display depth is different from the first display depth). In some embodiments, the second display depth is further from the top layer of the first user interface object than the first display depth. In some embodiments, the second display depth is closer to the top layer of the first user interface object than the first display depth. In some embodiments, display depth of a user interface element refers to the simulated absolute distance between the viewer's viewpoint and the user interface element, and/or the relative distance between the user interface element and a reference point in the user interface (e.g., the background platter of the user interface, and/or the surface of the display). In some embodiments, content having a smaller display depth is overlaid on top of content having a greater display depth, if they have the same display positions on the display. In some embodiments, the content in a display layer that is closer to the viewer and having smaller visual depth may be embedded in a translucent material, and partially obscure the content that is in an underlying display layer having the greater display depth. In some embodiments, the translucent material of the upper display layer partially reveals the appearance of the content having the greater display depths through the simulated transmission, internal reflection, and/or refraction undergone by the translucent material. In some embodiments, content having a smaller display depth exhibits a smaller amount of simulated parallax effect, compared to content having a greater display depth, thereby conveying the relative display depths and display priorities of the display layers. For example, as described with reference to FIG. 5B, one or more application icons and/or widgets are displayed as simulated glass material that is displayed in a simulated layer that is perceived to be above a simulated underlying content layer.

In some embodiments, displaying the first user interface object includes displaying, via the one or more display generation components, a first simulated shadow of an object from the first subset of content on a portion of the second subset of content in the second content layer, and/or displaying, via the one or more display generation components, a second simulated shadow of an object from the second subset of content on a portion of the first subset of content in the first content layer. In some embodiments, based on the virtual light from the first emissive element in the first display layer and/or the ambient light in the environment, one or more objects in the first display layer, the second display layer, and/or another display layer, can cast shadow(s) on adjacent objects in the same display layer and/or adjacent objects in a different display layer. In some embodiments, there may be other emissive element(s) in the second display layer, virtual light from these emissive elements and/or the ambient light in the environment may cause one or more objects in the first display layer, the second display layer, and/or another display layer to cast virtual shadow(s) on other objects in the first display layer, the second display layer, and/or another display layer. In some embodiments, graphical elements displayed in different display layers may cast simulated shadows on one another, based on the virtual light emanating from emissive elements from the same object and/or other user interface objects, and/or based on physical light from the external environment of the computer system. In some embodiments, the virtual shadows have different positions, display layers, colors, shades, sizes, and/or shapes, based on the spatial relationships between respective emissive element(s) and non-emissive objects in the first user interface object, the spatial relationships between user interface objects having emissive elements and user interface objects that do not have emissive elements, and/or the spatial relationships between the ambient light sources in the physical environment and the user interface objects and the non-emissive internal elements thereof. For example, as described with reference to FIG. 5B and FIGS. 6A-6B13, one or more application icons and/or widgets are displayed as simulated glass material, the simulated glass material including virtually casting a simulated shadow (6003D).

In some embodiments, displaying the first simulated light interaction between the first emissive element and the first boundary of the first user interface object includes displaying simulated specular effects (e.g., visual effects indicating a higher level of reflections of virtual light, such as that from a shiny, smooth, highly reflective surface) in one or more regions along the first boundary of the first user interface object. For example, in some embodiments, the first user interface object is an object comprising a translucent or transparent virtual material with a finite, non-zero thickness (e.g., a virtual gel, liquid, and/or glass material), where the virtual light emanating from the first emissive element of the first user interface object, the virtual light emanating from another emissive element outside of the first user interface object, and/or ambient light from a light source in the physical environment, cause display of one or more specular highlights on one or more portions of the edges of the first user interface element (e.g., corners, protrusions, and/or other changes in geometries and material boundaries), optionally, in accordance with simulated reflective properties of the virtual material, geometries of the first user interface object, and/or simulated optical laws. For example, as described with reference to FIGS. 5AB and 6A-6B13, objects displayed with simulated glass material include specular highlights (e.g., specular highlights 1108-1 and/or specular highlights displayed and/or other simulate lighting effects, including displaying calendar widget 506 (e.g., in FIG. 5B) with one or more specular highlights.

In some embodiments, displaying the simulated specular effects (e.g., visual effects indicating a higher level of reflections of virtual light, such as that from a shiny, smooth, highly reflective surface) in one or more regions along the first boundary of the first user interface object includes, in accordance with a determination that a first set of ambient light conditions (e.g., a first set of colors, intensities, color temperatures, light source locations, and/or other properties of ambient light) is present, displaying, via the one or more display generation components, a first set of one or more specular effects in a first set of regions along the first boundary of the first user interface object. In some embodiments, displaying the simulated specular effects (e.g., visual effects indicating a higher level of reflections of virtual light, such as that from a shiny, smooth, highly reflective surface) in one or more regions along the first boundary of the first user interface object includes, in accordance with a determination that a second set of ambient light conditions (e.g., a second set of colors, intensities, color temperatures, light source locations, and/or other properties of ambient light), different from the first set of ambient light conditions, is present, displaying, via the one or more display generation components, a second set of one or more specular effects in a second set of regions along the first boundary of the first user interface object, wherein the first set of one or more specular effects in the first set of regions along the first boundary of the first user interface object is different from the second set of one or more specular effects in the second set of regions along the first boundary of the first user interface object (e.g., the first set of specular effects differ from the second set of specular effects in terms of color, shape, size, intensity, and/or locations along the first boundary, based on the differences in the colors, intensities, color temperatures, light source locations, and/or other properties of ambient light that is present). For example, as described with reference to FIG. 5AB, in some embodiments, specular highlight(s) are based on one or more simulated light sources.

In some embodiments, displaying the simulated specular effects (e.g., visual effects indicating a higher level of reflections of virtual light, such as that from a shiny, smooth, highly reflective surface) in one or more regions along the first boundary of the first user interface object includes, in accordance with a determination that a first set of virtual objects is present between a light source (e.g., a virtual light source, such as an emissive element or object that emit virtual light; and/or a physical light source in the physical environment) and the first user interface object, displaying, via the one or more display generation components, a first set of one or more modified specular effects along the first boundary of the first user interface object based on the light source and one or more characteristics (e.g., positions, sizes, and simulated optical properties) of the first set of virtual objects (and, optionally, based on the spatial relationship between the light source, the properties of the light emanating from the light source, and/or the simulated optical properties of the first user interface object). In some embodiments, displaying the simulated specular effects (e.g., visual effects indicating a higher level of reflections of virtual light, such as that from a shiny, smooth, highly reflective surface) in one or more regions along the first boundary of the first user interface object includes, in accordance with a determination that a second set of virtual objects, different from the first set of virtual objects, is present between the light source (e.g., a virtual light source, such as an emissive element or object that emit virtual light; and/or a physical light source in the physical environment) and the first user interface object, displaying, via the one or more display generation components, a second set of one or more modified specular effects along the first boundary of the first user interface object based on the light source and one or more characteristics (e.g., positions, sizes, and simulated optical properties) of the second set of virtual objects (and, optionally, based on the spatial relationship between the light source, the properties of the light emanating from the light source, and/or the simulated optical properties of the first user interface object). In some embodiments, in accordance with a determination that no virtual object is between the light source and the first user interface object, the computer system displays an original set of specular effects along the first boundary of the first user interface object based on the spatial relationship between the light source, the properties of the light emanating from the light source, and/or the simulated optical properties of the first user interface object. In some embodiments, the first set of modified specular effects and/or the second set of modified specular effects indicate reduced amount of reflection from the first user interface object, due to the presence of the first set of virtual objects and the second set of virtual objects that reduce and/or deflect the light of the light source from fully reaching the first user interface object. For example, as described with reference to FIG. 5AB, in some embodiments, specular highlight(s) are based on one or more simulated light sources.

In some embodiments, the first user interface object includes one or more elements in a first display layer and one or more elements in a second display layer different from the first display layer. The computer system concurrently displays one or more simulated specular effects (e.g., visual effects indicating a higher level of reflections of virtual light, such as that from a shiny, smooth, highly reflective surface) in one or more regions along respective boundaries of the one or more elements in the first display layer, and one or more simulated specular effects (e.g., visual effects indicating a higher level of reflections of virtual light, such as that from a shiny, smooth, highly reflective surface) in one or more regions along respective boundaries of the one or more elements in the second display layer. For example, in some embodiments, the first user interface object may include sub-elements in different display layers and having respective boundaries, and specular effects are shown along the respective boundaries of these sub-elements in different displayers, based on the properties of the light source (e.g., location, color, brightness, color temperature, and/or directions), the optical properties (e.g., locations, reflectivity, translucency, geometries, and/or surface textures) of the different sub-elements, and the simulated optical laws (e.g., simulated laws of reflection, refraction, propagation, and/or transmission). For example, in some embodiments, application icon 450 is displayed with a plurality of simulated layers, each layer including a different specular effect.

In some embodiments, in accordance with a determination that a first component object of the first user interface object has a first configuration value for a first configurable property of the first component object (e.g., a flag and/or a numerical value indicating a non-zero emissivity of the component object), the computer system displays the first component object as an emissive element of the first user interface object (e.g., the first emissive element, and/or another emissive element of the first user interface object), and in accordance with a determination that a second component object of the first user interface object has a second configuration value, different from the first configuration value, for the first configurable property of the second component object (e.g., a flag and/or a numerical value indicating zero emissivity of the component object), the computer system forgoes displaying the second component object as an emissive element of the first user interface object In some embodiments, a set of configuration values for the first configurable property are established by a software developer that provided the first user interface object to the publisher of the operating system, where the set of configuration values correspond to different component objects of the first user interface object and is used to enable the operating system's display of the first user interface object with a preconfigured appearance (e.g., with some components as emissive elements and some components as non-emissive elements). In some embodiments, the configuration value for the first emissive element is also used by the operating system to generate the simulated light interactions with the surrounding objects and ambient environment when displaying a user interface including the first user interface object with the first emissive element. For example, as described with reference to FIG. 5B, the one or more emissive elements, including emissive element 526-1, of a user interface object are defined by a designer and/or developer of the user interface object.

It should be understood that the particular order in which the operations in FIG. 7 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 8000, 9000, 10000, 11000, 12000, 13000, 14000, 15000, 16000, 17000, 18000, 19000, and/or 20000) are also applicable in an analogous manner to method 7000 described above with respect to FIG. 7. For example, the buttons, user interfaces, controls, visual deemphasis, virtual effects, an/or animations described above with reference to method 7000 optionally have one or more of the characteristics of the buttons, user interfaces, controls, visual deemphasis, virtual effects, an/or animations described herein with reference to other methods described herein (e.g., methods 8000, 9000, 10000, 11000, 12000, 13000, 14000, 15000, 16000, 17000, 18000, 19000, and/or 20000). For brevity, these details are not repeated here.

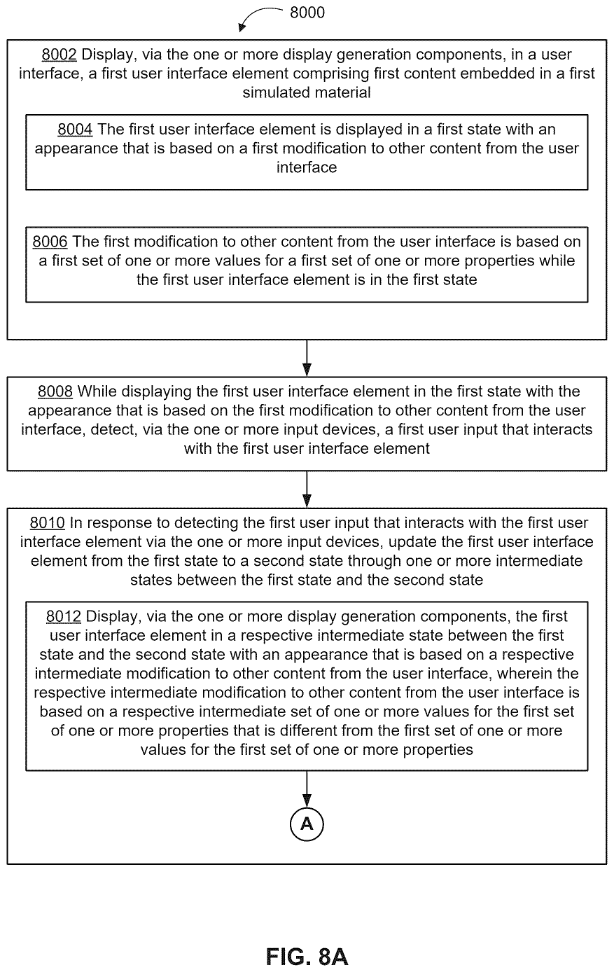

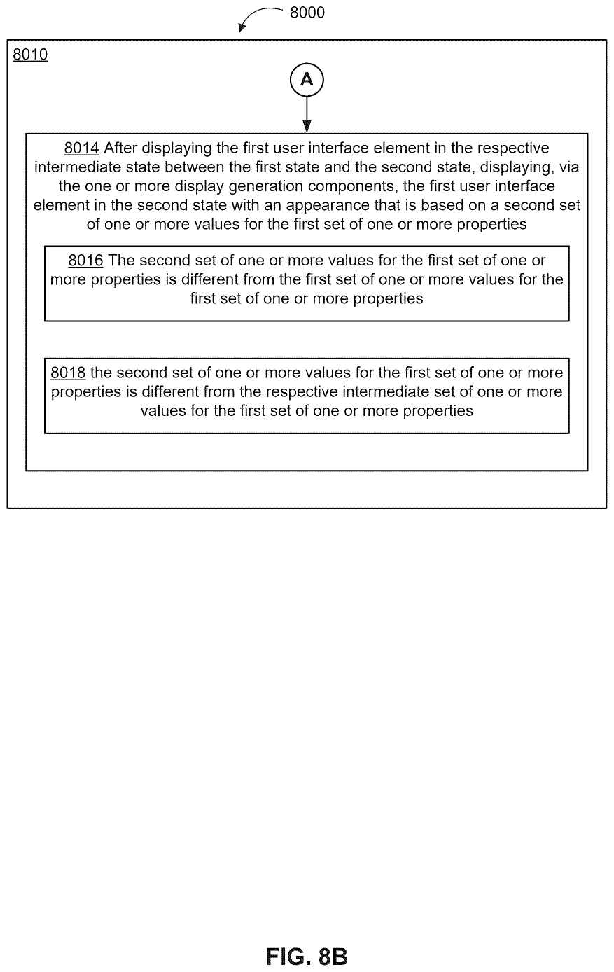

FIGS. 8A-8B are a flow diagrams illustrating a method 8000 of adjusting one or more visual properties responsive to user interaction in accordance with some embodiments. The method 8000 is performed at an electronic device (e.g., device 300, FIG. 3A, or portable multifunction device 100, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in method 8000 are, optionally, combined and/or the order of some operations is, optionally, changed. In some embodiments, the method 8000 is performed at a computer system that is in communication with one or more display generation components and one or more input devices: In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

Adjusting a simulated user interface material in response to detecting a user interaction provides information about the spatial relationships between the user interface elements, and provides visual feedback regarding the effect of user input, informs the user about the change in the state of the computer system and application, and guides the user about how to use his/her input to change the system state and/or application state. The appearance of the user interface material also provides visual feedback regarding the type of user interface object and its associated functions. Using responsive materials for user interface elements improves the responsiveness of user interface elements to inputs, which enables a user to use a device for shorter periods of time, which saves energy and improves battery life. Automatically changing an appearance of user interface elements (e.g., changing a simulated tilt of user interface elements and/or visual properties of underlying content) when one or more criteria are met reduces the number of inputs (e.g., navigating through settings user interfaces and menus to set the values for parameters to adjust the simulated tilt of user interface elements and/or visual properties of underlying content) that would otherwise be required to generate a similar effect, which saves energy and improves battery life.

The computer system displays, via the one or more display generation components, in a user interface, a first user interface element (e.g., icon, widget, window, graphic, symbol, selectable objects, control, user interface object, image, item, list, and/or an instance of another type of user interface components) comprising first content (e.g., text, icons, characters, symbols, imagery, and/or graphics) embedded in a first simulated material (e.g., the first user interface element is displayed as a user interface object made of a simulated material that has simulated interactions with virtual light, such as a simulated glass material and/or a simulated gel material that transmits, reflects, refracts, and/or otherwise changes the behavior of simulated light that propagates in the space occupied by the material). For example, as described with reference to FIG. 5F, the user interface element 604 is displayed as simulated glass material.

The first user interface element is displayed (8004) in a first state with an appearance that is based on a first modification to other content from the user interface (e.g., the first user interface element is displayed in the first state, or steady state, as first simulated glass having a first value of reflection, refraction, thickness and/or blurring). In some embodiments, displaying the first user interface element with an appearance based on the first modification to other content from the user interface includes using the original internal content of the first user interface element as a baseline appearance, and modifying the baseline appearance based on the appearances, emissive properties, and/or optical properties of content outside of the boundary of the first user interface element, such as other user interface elements and backgrounds in the user interface that are surrounding and/or spaced apart from the first user interface element, and, optionally, based on the appearances, emissive properties, and/or optical properties of content that is located behind the first user interface element in terms of visual depth and obscured by the first user interface element, and/or content that is part of the user interface but that is not currently within the field of view provided via the one or more display generation components.

The first modification to other content from the user interface is (8006) based on a first set of one or more values for a first set of one or more properties while the first user interface element is in the first state (e.g., the first user interface element is displayed in the first state, or steady state, as first simulated glass having a first value of reflection, refraction, thickness and/or blurring). In some embodiments, in a stead state, or before a user interacts with the first user interface element, the first user interface element made of the simulated glass material is displayed with a first set of simulated reflections, a first set of simulated refraction, and/or a first amount of blurring, that are determined based on the first set of values for the first set of visual properties, such as the size and geometry of the first user interface element and the simulated optical properties of the simulated glass material, and further based on the locations, geometries, and/or appearances of other objects and/or the background environment (e.g., whether currently in the field of view, or otherwise), and the emissive and/or optical properties of the simulated materials for the other properties and/or the background environment. For example, the underlying content displayed as star 606-1 is displayed with a first set of visual properties based on values of properties of the simulated glass material of the user interface element 604 in FIG. 6F.

While displaying the first user interface element in the first state with the appearance that is based on the first modification to other content from the user interface, the computer system detects (8008), via the one or more input devices, a first user input that interacts with (e.g., moves focus onto, selects, moves, expands, and/or activates; and/or changes the spatial relationship between the first user interface element with other elements of the user interface and/or the physical environment of the electronic device) the first user interface element. In some embodiments, the first user input includes gaze, attention, touch, air gesture, and/or other forms of user interface interaction that is directed toward the first user interface element based on the close proximity of the target location of the first user input and the location occupied by the first user interface element; and/or the first user input includes user actions that changes the physical orientation and/or location of the electronic device in the physical environment. For example, the device detects user input 610 in FIG. 6G.

In response to detecting the first user input that interacts with the first user interface element via the one or more input devices, the computer system updates (8010) (e.g., gradually over time) the first user interface element from the first state to a second state through one or more intermediate states between the first state and the second state.

In some embodiments, updating the first user interface element from the first state to the second state includes (8012) displaying, via the one or more display generation components, the first user interface element in a respective intermediate state between the first state and the second state with an appearance that is based on a respective intermediate modification to other content from the user interface, wherein the respective intermediate modification to other content from the user interface is based on a respective intermediate set of one or more values for the first set of one or more properties that is different from the first set of one or more values for the first set of one or more properties (e.g., the first user interface element is displayed in the respective intermediate state, or transient state, as modified first simulated glass having a respective intermediate value of reflection, refraction, thickness and/or blurring, different from the first value of reflection, refraction, thickness, and/or blurring).

In some embodiments, updating the first user interface element from the first state to the second state includes (8014), after displaying the first user interface element in the respective intermediate state between the first state and the second state (e.g., after the first user input has met the criteria for displaying the first user interface element in the second state, optionally, before the termination of the first user input, upon the termination of the first user input; and/or within a period of time after the termination of the first user input), displaying, via the one or more display generation components, the first user interface element in the second state with an appearance that is based on a second set of one or more values for the first set of one or more properties. The second set of one or more values for the first set of one or more properties is (8016) different from the first set of one or more values for the first set of one or more properties. The second set of one or more values for the first set of one or more properties is (8018) different from the respective intermediate set of one or more values for the first set of one or more properties. For example, as illustrated in FIG. 6G, the star 606-2 is displayed with a different set of visual properties than star 606-1 based on the updated values to properties of the simulated glass material of the user interface element 604.

In some embodiments, in an intermediate and/or transient state, and/or while the user interacts with the first user interface element, the first user interface element made of the simulated glass material is displayed with a respective intermediate set of simulated reflections, a respective intermediate set of simulated refraction, and/or a respective intermediate amount of blurring, that are determined based on the respective intermediate set of values for the first set of visual properties, such as the size and geometry of the first user interface element and the simulated optical properties of the simulated glass material, and further based on the locations, geometries, and/or appearances of other objects and/or the background environment (e.g., whether currently in the field of view, or otherwise), and the emissive and/or optical properties of the simulated materials for the other properties and/or the background environment. In some embodiments, during the user interaction with the first user interface element, and optionally, for a period of time after the termination of the interaction, the first user interface element is displayed in a sequence of multiple transient states with respective intermediate appearances that are based on respective intermediate modifications on other content in the user interface, where the respective intermediate modifications are based on respective intermediate sets of values of the first set of one or more properties. In some embodiments, the interactions cause some portions of the geometry of the first user interface element to expand, elongate, and/or flatten, while causing some other portions of the geometry of the first user interface element to shrink, shorten, and/or bulge out. In some embodiments, the interactions cause the values of the simulated optical properties, such as the simulated emissivity, transmissivity, reflectivity, refraction index, blur radius, translucency, opacity, and/or other simulated properties affecting light interactions, to be modified as well. In some embodiments, the direction and magnitude of the modifications to the values of the first set of one or more properties are based on one or more characteristics of the user input directed to the first user interface element, such as the duration, intensity, direction of movement, acceleration, and/or magnitude of the user input.

In some embodiments, the first user interface element displayed in the second state has an appearance that is based on a second modification to other content from the user interface (e.g., the first user interface element is displayed in the second state, or a second steady state, as second simulated glass having a second value of reflection, refraction, thickness and/or blurring. In some embodiments, displaying the first user interface element with an appearance based on the second modification to other content from the user interface includes using the original internal content of the first user interface element as a baseline appearance, and modifying the baseline appearance based on the appearances, emissive properties, and/or optical properties of content outside of the boundary of the first user interface element, such as other user interface elements and backgrounds in the user interface that are surrounding and/or spaced apart from the first user interface element, and, optionally, based on the appearances, emissive properties, and/or optical properties of content that is located behind the first user interface element in terms of visual depth and obscured by the first user interface element, and/or content that is part of the user interface but that is not currently within the field of view provided via the one or more display generation components.

In some embodiments, the other content from the user interface to which the first modification is made, to generate the appearance of the first user interface element in the first state includes, content in the user interface that is not currently visible (e.g., not concurrently visible with the first user interface element) via the one or more display generation components (e.g., including portions of user interface objects and background of the user interface that are located outside of the field of view provided via the one or more display generation components, and/or portions of user interface objects and background of the user interface that are located behind the first user interface element and obscured by the first user interface element). For example, in some embodiments, the original appearance of the first user interface element is altered (e.g., virtually illuminated, optionally causing virtual reflections on the edges and surface of the first user interface element, and/or optionally tinting the simulated glassy material and/or the edges of the first user interface element) based on the color and brightness of an emissive element that is located outside of the current field of view provided via the one or more display generation components. In some embodiments, the original appearance of the first user interface element is further altered (e.g., virtually illuminated, optionally causing virtual refractions within the simulated glassy material of the first user interface element, and/or optionally tinting the simulated glassy material and/or the edges of the first user interface element) based on the color, brightness, contours, and/or patterns of portions of the objects and background that are located behind the first user interface elements from the current viewpoint from which the user interface is displayed. For example, if a portion of a user interface object and/or a portion of a background are located behind the first user interface element, the first user interface element will take on a modified appearance that takes on some colors, shapes, and other visual characteristics of the obscured portions of the user interface object and background, as if the simulated glassy material of the first user interface element is partially translucent, refracts and/or blurs the appearance of the underlying user interface object and background. For example, as described with reference to FIG. 5F, the appearance of the user interface element 604 is based at least in part on content that is not visible to the user, such as content in the user interface 602 that is covered by the user interface element 604.

In some embodiments, while displaying the first user interface element in the first state with the appearance that is based on the first modification to other content from the user interface, the computer system detects, via the one or more input devices, movement of the computer system relative to a frame of reference (e.g., relative to a user, relative to a fixed point in an environment, and/or relative to gravity). In some embodiments, the movement of the computer system includes rotation and/or tilting of the computer system and/or the one or more display generation components, such as tilting around a horizontal axis with the top of the user interface tilting away from the user and the bottom of the user interface tiling toward the user, or vice versa; and/or rotating around a vertical axis with the left edge of the user interface moving away from the user and the right edge of the user interface moving toward the user, or vice versa. In some embodiments, the movement of the computer system includes linear movement of the computer system and/or the one or more display generation components, such as up and down movement and/or sideways movement relative to the viewpoint of the user, the environment, and/or the ground. In response to detecting the movement of the computer system relative to the frame of reference, the computer system updates (e.g., gradually over time) the first user interface element from the first state to a third state through one or more intermediate states between the first state and the third state, including displaying, via the one or more display generation components, the first user interface element in a respective intermediate state between the first state and the third state with an appearance that is based on a respective intermediate modification to other content from the user interface, wherein the respective intermediate modification to other content from the user interface is based on a respective intermediate set of one or more values for the first set of one or more properties that is different from the first set of one or more values for the first set of one or more properties. In some embodiments, the respective intermediate sets of values for the first set of one or more properties that are used to generate the appearances in the intermediate states between the first state and the third state (e.g., the transitions caused by the movement of the computer system), are different from the respective intermediate sets of values for the first set of one or more properties that are used to generate the appearances in the intermediate states between the first state and the second state (e.g., the transitions caused by the first user input that interacts with the first user interface element). In some embodiments, values for different subsets of the first set of one or more properties are modified depending on whether a user input interacting with the first user interface element is detected or the computer system is moved relative to the frame of reference. For example, in some embodiments, when the computer system is moved, the shape and size of the first user interface element does not change, but the values for the opacity, reflectivity, refractive index, blur radius, and/or other properties across the span of the first user interface element are changed gradually with the movement of the computer system. In contrast, when a user input interacts with the first user interface element, the values for the shape, size, thickness, and/or position of the first user interface element are also changed gradually with the user input, in addition to the changes made to the opacity, reflectivity, refractive index, blur radius, and/or other properties across the span of the first user interface element. In some embodiments, updating (e.g., gradually over time) the first user interface element from the first state to a third state through one or more intermediate states between the first state and the third state, includes, after displaying the first user interface element in the respective intermediate state between the first state and the third state, displaying, via the one or more display generation components, the first user interface element in the third state with an appearance that is based on a third set of one or more values for the first set of one or more properties, different from the first set of one or more values and the second set of one or more values for the first set of one or more properties (and different from the intermediate sets of values for the first set of one or more properties used to generate the intermediate states between the first state and the second state, and the intermediate states between the first state and the third state). For example, as described with reference to FIGS. 5J-5M, in response to detecting that the device 100 is physically moved with respect to the viewpoint of the user, the device 100 updates display of the application icons in accordance with the movement.

In some embodiments, the first set of one or more values for the first set of one or more properties includes a first gradient of a first property (e.g., a gradient of opacity values, a gradient of blur radius values, a gradient of simulated refractive indices, a gradient of dimming factors, and/or a gradient of other properties that affect how virtual and real light interacts with the simulated material of the first user interface element) from the first set of one or more properties that extends across the first user interface element in a first direction (and, optionally, an initial gradient in a second direction orthogonal or substantially orthogonal to the first direction). In some embodiments, the third set of one or more values for the first set of one or more properties includes a second gradient of the first property from the first set of one or more properties that extends across the first user interface element in the first direction (and, optionally, a final gradient in the second direction orthogonal or substantially orthogonal to the first direction). In some embodiments, the respective intermediate set of one or more values for the first set of one or more properties includes a respective intermediate gradient of the first property from the first set of one or more properties that extends across the first user interface element in the first direction (and, optionally, an intermediate gradient in the second direction orthogonal or substantially orthogonal to the first direction). In some embodiments, in the case of interacting with the first user interface element to transition to the second state of the first user interface element, the second set of one or more values for the first set of one or more properties includes a third gradient of the first property from the first set of one or more properties that extends across the first user interface element in the first direction (and, optionally, another final gradient in the second direction orthogonal or substantially orthogonal to the first direction); and the respective intermediate set of one or more values for the first set of one or more properties includes a respective intermediate gradient of the first property from the first set of one or more properties that extends across the first user interface element in the first direction (and, optionally, an intermediate gradient in the second direction orthogonal or substantially orthogonal to the first direction). For example, as described with reference to FIGS. 5J-5M, one or more application icons are displayed with a gradient that appears to shift as the device 100 is physically tilted.

In some embodiments, while displaying, via the one or more display generation components, the first user interface element in the third state, the computer system detects, via the one or more input devices, a termination of the movement of the computer system. In response to detecting the termination of the movement of the computer system, the computer system displays (e.g., redisplays), via the one or more display generation components, the first user interface element in the first state, restoring (e.g., gradually over time) the first user interface element from the third state to the first state through one or more intermediate states between the third state and the first state (e.g., the first user interface element returns to its steady state appearance after the movement of the computer system has stopped, and after going through a series of intermediate states from the third state to the first state, irrespective of the final orientation of the computer system at the time that the termination of the movement of the computer system is detected). For example, the application icons are displayed with the gradient illustrated in FIG. 5J regardless of a current orientation of the device 100 after detecting that movement of the device 100 has ceased for at least a threshold amount of time.

In some embodiments, displaying the first user interface element in the respective intermediate state with the appearance that is based on the respective intermediate modification to other content from the user interface includes, in accordance with a determination that the boundary of the first user interface element in the respective intermediate state has a first set of spatial properties (e.g., a first size, a first spatial relationship to other content, and/or a first shape, as a result of the user input interacting with the first user interface element), displaying the first user interface element with a first intermediate appearance that simulates light interactions between the first user interface element and other content from the user interface in a first manner (e.g., with a first amount of simulated reflection, transmission, and/or refraction, of a first subset of content, in accordance with the first set of spatial properties of the first user interface element). In some embodiments, displaying the first user interface element in the respective intermediate state with the appearance that is based on the respective intermediate modification to other content from the user interface includes, in accordance with a determination that the boundary of the first user interface element in the respective intermediate state has a second set of spatial properties (e.g., a second size, a second spatial relationship to other content, and/or a second shape), displaying the first user interface element with a second intermediate appearance that simulates light interactions between the first user interface element and other content from the user interface in a second manner (e.g., with a second amount of simulated reflection, transmission, and/or refraction, of a second subset of content, in accordance with the second set of spatial properties of the first user interface element) different from the first manner (e.g., differing in amount of simulated reflection, transmission, and/or refraction, differing in terms of the subset of content used in the simulated light interaction, and/or differing in terms of the spatial properties of the boundary and interior portions used in the simulated light interaction). In some embodiments, as the spatial properties of the boundary of the first user interface element changes in response to the user interaction with the first user interface element, the computer system displays different simulated light interactions between the first user interface element and other content in the user interface, resulting in different intermediate appearances for the first user interface element. As such, depending on the spatial properties of the first user interface elements in the first state, the intermediate states, and/or the second state, the appearance of the first user interface elements undergo different animated changes, based on the simulated light interactions with the first user interface elements according to the different spatial properties of the first user interface elements in the first state, the intermediate states, and the second state. In some embodiments, the first modification to other content from the user interface, and the respective intermediate modification to other content from the user interface (and, optionally, the appearance that is based on the second modification and/or the third modification to other content from the user interface), are constrained spatially based on a boundary of the first user interface element. For example, in some embodiments, the boundary of the first user interface element includes surfaces and/or edges of the simulated material that define the spatial extent of the first user interface element, and the simulated optical interactions (e.g., simulated illumination, light transmission, reflection, refraction, specular effects, blurring, dimming, tinting, and/or other simulated light interactions) between the simulated material of the first user interface element and its surrounding objects and background, including obscured portions of objects and background and portions of objects and background that are outside of the current field of view provided by the display generation components, exhibit discontinuities and/or abrupt changes at the surfaces and/or edges of the simulated material, ceases to exist or drastically diminishes outside of the surfaces and edges, but are relatively uniform, smooth, and continuous within the surfaces and/or edges of the simulated material. In some embodiments, the simulated light interactions move differently based on a size and/or shape of the boundaries of the first user interface element during the animated transition between the first state and the second state. It is to be noted that, not only the size and/or shape of the first user interface elements go through a plurality of intermediate states in response to the user input interacting with the first user interface element, but also the visual effect, including the simulated light interactions and resulting appearances of the first user interface element, change based on the changing shape and/or size of the boundaries of the first user interface element. For example, as described with reference to FIGS. 5J-5M, the virtual lighting effect is updated as changing position, brightness, size and/or other properties as the device 100 is physically tilted to simulate movement of the device 100 relative to the simulated external light source(s).

In some embodiments, the first set of one or more properties includes one or more simulated material properties for the first simulated material, including a blur radius of the first simulated material and/or a simulated refractive index of the first simulated material. For example, in some embodiments, when a user input that is directed to the first user interface element is detected, the values of the blur radius and/or the values of the simulated refractive index of the first simulated material are changed gradually through multiple intermediate states, and optionally by different amounts across different portions of the first user interface element; and as a result, the appearances of the first user interface element are changed in accordance with the changes in the blur radius and refractive index of the first simulated material. In some embodiments, other relevant material properties of the first simulated material include opacity, dimming, reflectivity, transmissivity, and/or other material properties affecting simulated light interactions. In some embodiments, the first set of one or more properties includes properties of the first user interface element, such as the position, shape, size, thickness, and/or geometries of the first user interface element, which may also change in accordance with the first user input, resulting in changes in its simulated optical behaviors, which in turn resulting in additional changes in the appearance of the first user interface element. For example, as described with reference to FIG. 5G, the amount of refraction, the amount of blurring, and/or other visual properties of the simulated glass material of user interface element 604 are updated.

In some embodiments, the appearance of the first user interface element that is based on the first modification to other content from the user interface is based on the first modification (e.g., simulated refraction and blurring, and/or other modifications based on the first set of one or more values for the simulated material properties of the first simulated material) to a portion of the other content from the user interface that is behind and obscured by the first user interface element, and the first modification (e.g., simulated refraction and blurring, and/or other modifications based on the first set of one or more values for the simulated material properties of the first simulated material) to a portion of the other content from the user interface that is spaced apart from and not obscured by the first user interface element (e.g., the content that is adjacent to the first user interface element above, below, to the left, and to the right of the first user interface element, where the content is concurrently visible with the first user interface element from the current viewpoint of the user). Similarly, in some embodiments, in the second state and the one or more intermediate states, the appearance of the first user interface element are based on the second modification (e.g., simulated refraction and blurring, and/or other modifications based on the second set of one or more values for the simulated material properties of the first simulated material) and the respective intermediate modifications (e.g., simulated refraction and blurring, and/or other modifications based on the intermediate set of one or more values for the simulated material properties of the first simulated material) to a portion of the other content from the user interface that is behind and obscured by the first user interface element (e.g., with the same spatial extent, greater spatial extent, and/or lesser spatial extent in various regions of the first user interface element, as compared to the first modification), and a portion of the other content from the user interface that is spaced apart from and not obscured by the first user interface element (e.g., the content that is adjacent to the first user interface element above, below, to the left, and to the right of the first user interface element, where the content is concurrently visible with the first user interface element from the current viewpoint of the user). In some embodiments, the spatial extent of the other content that is used to generate the appearance of the first user interface element may vary in different states of the first user interface element, as the shape, size, position, and geometries of the first user interface element may change in response to the user input that interacts with the first user interface element. For example, as described with reference to FIGS. 5F-5I, a distorted version of the star 608-3 included in the background layer is displayed under user interface element 604.

In some embodiments, in accordance with the first user input having a first value for a first characteristic of the first user input (e.g., a first duration, a first intensity, a first magnitude in distance, acceleration, and/or speed of the first user input), the second set of one or more values for the first set of one or more properties have a first set of magnitudes, and in accordance with the first user input having a second value for the first characteristic of the first user input (e.g., a first duration, a first intensity, a first magnitude in distance, acceleration, and/or speed of the first user input), the second value for the first characteristic of the first user input being different from the first value for the first characteristic of the first user input, the second set of one or more values for the first set of one or more properties have a second set of magnitudes different from the first set of magnitudes. In some embodiments, the amount of change in value for a respective property of the first set of one or more properties increases when the magnitude of the first characteristic of the first user input increases. In some embodiments, the amount of change in value for a respective property of the first set of one or more properties decreases when the magnitude of the first characteristic of the first user input increases. In some embodiments, multiple characteristics of the first user input (e.g., duration, intensity, distance, speed, acceleration, and/or other characteristics of the first user input) contribute to how the values for the first set of one or more properties are changed. In some embodiments, the transient and/or intermediate values of first set of one or more properties are selected based on the current values and/or accumulated values for one or more characteristics of the first user input at the current time. (e.g., as described with reference to FIGS. 5F-5G, a longer user input 610 causes a larger change in simulated angle, and a shorter user input 610 causes a smaller change in simulated angle, or vice versa).

In some embodiments, updating the first user interface element from the first state to the second state through one or more intermediate states between the first state and the second state includes, in accordance with a determination that the first characteristic of the first user input does not meet a first threshold (e.g., the duration of the first user input does not meet a first duration threshold, the intensity of the first user input does not meet a first intensity threshold, the distance of a movement of the first user input does not meet a first distance threshold, and/or the speed of the movement of the first user input does not meet a first speed threshold), updating the first user interface element based on a first rate of change (e.g., a higher rate of change, or a lower rate of change) in respective values of the first set of one or more properties. In some embodiments, updating the first user interface element from the first state to the second state through one or more intermediate states between the first state and the second state includes, in accordance with a determination that the first characteristic of the first user input meets the first threshold (e.g., the duration of the first user input does not meet a first duration threshold, the intensity of the first user input does not meet a first intensity threshold, the distance of a movement of the first user input does not meet a first distance threshold, and/or the speed of the movement of the first user input does not meet a first speed threshold), updating the first user interface element based on a second rate of change (e.g., a lower rate of change, or a higher rate of change) in respective values of the first set of one or more properties, wherein the second rate of change is different from (e.g., slower, or faster) the first rate of change. In some embodiments, the rate of change in the respective values of the first set of one or more properties is greater during a period of time that is below a first duration threshold, and as the first user input continues, the rate of change in the respective values of the first set of one or more properties gradually decreases as the duration of the first user input approaches the first duration threshold. In some embodiments, the rate of change in the respective values of the first set of one or more properties is smaller when an intensity of the user input remains below a first intensity threshold, and when the intensity of the first user input increases above the first intensity threshold, the rate of change in the respective values of the first set of one or more properties increases to a greater value (e.g., as described with reference to FIGS. 5F-5G, the user interface element 604 is gradually pushed backward at a different rate of change based on whether the user input 610 is a tap input or a long press input).

In some embodiments, the first characteristic includes a duration of the first user input, the first threshold includes a first duration threshold, the first rate of change is greater than the second rate of change, and updating the first user interface element from the first state to the second state through one or more intermediate states between the first state and the second state includes, in accordance with a determination that the duration of the first user input is approaching the first threshold window and is within a threshold window of the first duration threshold, gradually reducing a current rate of change from the first rate of change to the second rate of change. For example, in some embodiments, in the initial period of the first user input, the values of the simulated material properties and/or the values of the spatial properties of the first user interface element change quickly through a series of intermediate sets of values, resulting in conspicuous changes in the appearance of the first user interface object; and as the first user input continues to be maintained, the rate of changes in the values of the material and/or spatial properties of the first user interface element gradually reduces as the duration of the first user input approaches the first duration threshold. In some embodiments, in accordance with a determination that the termination of the first user input is detected before the first user input meets the first duration threshold, the computer system performs a first operation corresponding to the first user interface element; and in accordance with a determination that the termination of the first user input is not detected before the first user input meets the first duration threshold, and/or that the termination of the first user input is detected after the first user input meets the first duration threshold, the computer system performs a second operation, different from the first operation, corresponding to the first user interface element. For example, as described with reference to FIG. 5G, in response to detecting an initial portion of a user input (e.g., a user input that does not satisfy threshold input criteria), the device 100 displays a quick change in the simulated angle, and as the user input continues (e.g., makes progress towards satisfying the threshold input criteria), the simulated angle continues to change by a larger amount gradually over time.

In some embodiments, updating the first user interface element from the first state to the second state through one or more intermediate states between the first state and the second state includes, in accordance with the first user input having an intermediate value between the first value to the second value for the first characteristic of the first user input (e.g., an intermediate duration, an intermediate intensity, an intermediate magnitude in distance, acceleration, and/or speed of the first user input), the respective intermediate set of one or more values for the first set of one or more properties have a respective intermediate set of magnitudes between the first set of magnitudes and the second set of magnitudes. For example, in some embodiments, as the first user input persists, the duration of the first user input increases through a series of intermediate duration values, and as a result, the values of at least some of the first set of one or more properties also gradually increases or decreases with the increase of the duration, and as a result, the appearance of the first user interface element gradually changes as the duration of the first user input increases. For example, the user interface element 604 (e.g., in FIG. 5G) is gradually tilted by a greater amount, over time, across one or more intermediate states as the user input 610 continues to be detected.

In some embodiments, the first set of one or more properties of the first user interface element includes at least a first property of the first user interface element, and a second property of the first user interface element that is different from the first property of the first user interface element. In some embodiments, the first set of one or more values for the first set of one or more properties includes an initial value for the first property and an initial value for the second property. In some embodiments, the respective intermediate set of one or more values for the first set of one or more properties includes a respective intermediate value for the first property and a respective intermediate value for the second property. In some embodiments, the second set of one or more values for the first set of one or more properties includes an ending value for the first property and an ending value for the second property. In some embodiments, the respective intermediate value for the first property is different from the initial value and the ending value for the first property. In some embodiments, the respective intermediate value for the first property is different from the initial value and the ending value for the first property. For example, in some embodiments, at least one of the first property and the second property is a first simulated material property for the first simulated material (e.g., refractive index, reflectivity, transmissivity, blur radius, opacity, dimming, color, brightness, and/or other simulated material properties that affect light interactions), and/or a first spatial property (e.g., size, shape, thickness, length, width, geometries, position, curvature, angle, orientation, facing direction, and/or other spatial properties that affect light interactions) for the first user interface element. In some embodiments, the values for different properties (e.g., blur radius, refractive index, translucency, height, width, thickness, position, and/or curvature of corners) of the first user interface element, including its material properties and spatial properties, undergo different types of changes (e.g., increase, decrease, linearly, based on a gradient, based on a functional relationship, gradually, and/or abruptly) during the first user input, and, optionally, based on different characteristics of the first user input (e.g., duration, intensity, characteristic location, direction, movement distance, speed, acceleration, and other characteristics). For example, as described with reference to FIGS. 5F-5G, the user interface element 604 is displayed as simulated glass material such that a simulated change in thickness, size and/or shape of the user interface element 604 is achieved by altering levels of blur, refraction, and/or other visual properties (e.g., described with reference to FIGS. 6A-6B4) over time in response to detecting the user input 610.

In some embodiments, after the first user interface element has been displayed in the second state in response to detecting the first user input (and optionally, is still displayed in the second state, and/or in a later state due to continuation of the first user input), the computer system detects, via the one or more input devices, a termination of the first user input (e.g., liftoff of a contact of the first user input, reduction of an intensity below a threshold intensity, release of an air pinch gesture, release of a pressed button, and/or removal of attention such as a gaze on the first user interface element). In response to detecting the termination of the first user input, the computer system changes an appearance of the first user interface element to at least partially reverse one or more previous updates (e.g., gradually over time) made to the first user interface element from the first state to a final state of the first user interface element at the termination of the first user input (e.g., through one or more intermediate states from the second state to the first state, that is the same or different from the set of intermediate states from the first state to the second state). For example, in some embodiments, after the first user input ends, the values for the first set of one or more properties are restored gradually back to their original values prior to the detection of the first user input, and the appearance of the first user interface element is returned to the appearance in the first state. For example, after altering the user interface element 604 in FIG. 5G, in response to detecting an end of the user input 610, the changes to the visual properties of the user interface element 604 in FIG. 5G are reversed (e.g., to redisplay the user interface element 604 in FIG. 5F).

In some embodiments, changing the appearance of the first user interface element to at least partially reverse one or more of the previous updates (e.g., gradually over time) made to the first user interface element from the first state to the final state at the termination of the first user input is performed in a period of time that is shorter than a period of time it took to update the first user interface element from the first state to the final state. For example, in some embodiments, the reversal of the change in first user interface element caused by the first user input is faster than when the change initially took place. In some embodiments, the reversal of the changes to the first user input element in response to the termination of the first user input indicates that the first user input did not meet the criteria for triggering performance of an operation associated with the first user interface element, and the computer system forgoes performing an operation other than providing the visual feedback indicating the detection of the first user input. For example, in FIGS. 5F-5G, device transitions to the user interface element 604 to its state from FIG. 5F to FIG. 5G at a slower rate than returning the user interface element 604 in FIG. 5G back to its state in FIG. 5F.

In some embodiments, in accordance with a determination that the first user input is directed to a first portion of the first user interface element (e.g., a portion, less than all, of the spatial extent of the first user interface element), the respective intermediate set of one or more values for the first set of one or more properties includes a first set of changes from the first set of one or more values for the first set of one or more properties, and in accordance with a determination that the first user input is directed to a second portion of the first user interface element (e.g., a portion, less than all, of the spatial extent of the first user interface element), different from the first portion of the first user interface element, the respective intermediate set of one or more values for the first set of one or more properties includes a second set of changes from the first set of one or more values for the first set of one or more properties, wherein the second set of changes is different from the first set of changes (e.g., different in terms of spatial distribution of the changes, in terms of magnitudes of the changes, in terms of rate of the changes, and/or in terms of the order of the changes, in the values of the first set of one or more properties). For example, in some embodiments, when the first user input is directed to a top portion of the first user interface element, the top portion of the first user interface element exhibits a greater amount of change in the values of the first set of one or more properties (e.g., greater amounts of changes in thickness, spatial extent, refractive index, blur radius, opacity, color, and/or other properties that affect light interactions), which, optionally, results a greater amount of change in its appearance in the top portion of the first user interface element, as compared to the lower portions of the first user interface element. Similarly, when the first user input is directed to a lower portion of the first user interface element, the lower portion of the first user interface element exhibits a greater amount of change in the values of the first set of one or more properties (e.g., greater amounts of changes in thickness, spatial extent, refractive index, blur radius, opacity, color, and/or other properties that affect light interactions), which, optionally, results a greater amount of change in its appearance in the lower portion of the first user interface element, as compared to the upper portions of the first user interface element. In some embodiments, the portions of the first user interface element that is closer to the location of the first user input exhibit greater amounts of changes in their respective sets of values for the first set of one or more properties, which, optionally, results greater amounts of changes in its appearance in the portions of the first user interface element closer to the location of the first user input, as compared to other portions of the first user interface element that are farther away from the location of the first user input. In some embodiments, the amount of change to the value of a respective property of the first set of one or more properties for a respective portion of the first user interface element increases with an increasing distance from the target location of the first user input on the first user interface element (e.g., location of the contact, gaze, focus selector, and/or other indication of a target location of the first user input) to the respective portion of the first user interface element. In some embodiments, the amount of change to the value of a respective property of the first set of one or more properties for a respective portion of the first user interface element decreases with an increasing distance from the target location of the first user input on the first user interface element (e.g., location of the contact, gaze, focus selector, and/or other indication of a target location of the first user input) to the respective portion of the first user interface element. For example, as described with reference to FIG. 5F-5I, the user interface element 604 is simulated as being tilted forward and/or backward (e.g., by changing values of one or more properties of the simulated glass material) based on a location of the user input 610 or user input 612.

In some embodiments, in accordance with a determination that the first user input is directed to the first portion of the first user interface element (e.g., a portion, less than all, of the spatial extent of the first user interface element), the respective intermediate set of one or more values for the first set of one or more properties simulates a rotation (e.g., includes rotation or a change in one or more visual properties to simulate the appearance of rotation) of the first user interface element in a first direction relative to other content in the user interface (e.g., the first set of changes from the first set of one or more values for the first set of one or more properties includes a first set of changes in orientation of the first user interface element; tilting the first user interface element, such that the first portion of the first user interface element moves farther away from the viewpoint of the user, while another portion of the first user interface element moves closer toward the viewpoint of the user). In some embodiments, in accordance with a determination that the first user input is directed to the second portion, different from the first portion, of the first user interface element (e.g., a portion, less than all, of the spatial extent of the first user interface element), the respective intermediate set of one or more values for the first set of one or more properties simulates a rotation (e.g., includes rotation or a change in one or more visual properties to simulate the appearance of rotation) of the first user interface element in a second direction, different from the first direction, relative to other content in the user interface (e.g., the second set of changes from the first set of one or more values for the first set of one or more properties includes a second set of changes in orientation of the first user interface element; tilting the first user interface element, such that the second portion of the first user interface element moves farther away from the viewpoint of the user, while another portion of the first user interface element moves closer toward the viewpoint of the user). In some embodiments, when the first portion and the second portion of the first user interface element are on opposite sides of the first user interface element (e.g., a top portion vs. a bottom portion, a left portion vs. a right portion, a top left corner vs. a lower right corner, and/or other opposite sides of the first user interface element), the first user interface elements tilt in different directions relative to other content in the user interface in accordance with the action of the first user input. For example, as described with reference to FIG. 5F-5I, the user interface element 604 is simulated as being tilted forward and/or backward (e.g., by changing values of one or more properties of the simulated glass material) based on a detected location of the user input 610 or user input 612.

In some embodiments, the simulated rotation of the first user interface element in the first direction relative to other content in the user interface causes the first portion of the first user interface element to appear to move closer to a background (e.g., another user interface element, graphics, text, and/or wallpaper) behind the first user interface element (e.g., obscured by the first user interface element and not directly displayed to the viewer). In some embodiments, the simulated rotation of the first user interface element in the first direction relative to other content in the user interface causes another portion of the first user interface element opposite to the first portion of the first user interface element to appear to move farther away from the background. Similarly, in some embodiments, the simulated rotation of the first user interface element in the second direction relative to other content in the user interface causes the second portion of the first user interface element to appear to move closer to the background (e.g., another user interface element, graphics, text, and/or wallpaper) behind the first user interface element (e.g., obscured by the first user interface element and not directly displayed to the viewer), and another portion of the first user interface element opposite the second portion of the first user interface element to appear to move farther away from the background. For example, as described with reference to FIG. 5G, a top portion of the user interface element 604 is simulated as being tilted forward while the bottom portion of the user interface element 604 is simulated as being tilted backward.

In some embodiments, updating the first user interface element from the first state to the second state through one or more intermediate states between the first state and the second state in response to detecting the first user input, includes, in accordance with a determination that the first user input is directed to a first portion of the first user interface element (e.g., a portion, less than all, of the spatial extent of the first user interface element), simulating rotation (e.g., includes rotation or a change in one or more visual properties to simulate the appearance of rotation) of the first user interface element in a first direction relative to other content in the user interface (e.g., tilting the first user interface element, such that the first portion of the first user interface element moves farther away from the viewpoint of the user, while another portion of the first user interface element moves closer toward the viewpoint of the user). In some embodiments, updating the first user interface element from the first state to the second state through one or more intermediate states between the first state and the second state in response to detecting the first user input, includes, in accordance with the first user input being directed to the second portion, different from the first portion, of the first user interface element (e.g., a portion, less than all, of the spatial extent of the first user interface element), simulating rotation (e.g., includes rotation or a change in one or more visual properties to simulate the appearance of rotation) of the first user interface element in a second direction, different from the first direction, relative to other content in the user interface (e.g., simulating tilting of the first user interface element, such that the second portion of the first user interface element appears to move farther away from the viewpoint of the user, while another portion of the first user interface element appears to move closer toward the viewpoint of the user). In some embodiments, when the first portion and the second portion of the first user interface element are on opposite sides of the first user interface element (e.g., a top portion vs. a bottom portion, a left portion vs. a right portion, a top left corner vs. a lower right corner, and/or other opposite sides of the first user interface element), the first user interface elements appears to tilt in different directions relative to other content in the user interface in accordance with the action of the first user input. For example, as described with reference to FIG. 5F-5I, the user interface element 604 is simulated as being tilted forward and/or backward (e.g., by changing values of one or more properties of the simulated glass material) based on a detected location of the user input 610 or user input 612.

In some embodiments, the user interface (e.g., a system user interface, such as a home screen user interface, a wake screen user interface, a control user interface, and/or another type of user interface provided by the operating system or an application) concurrently includes a first set of one or more user interface elements, and a second set of one or more user interface elements (e.g., the first set of one or more user interface elements and the second set of one or more user interface elements are of the same user interface object type, or alternatively, of different user interface object types). In some embodiments, the first set of one or more user interface elements and the second set of one or more user interface elements both include application icons. In some embodiments, the first set of one or more user interface elements and the second set of one or more user interface elements both include widgets corresponding to applications and include application content from the corresponding applications. In some embodiments, the first set of user interface elements and the second set of user interface elements both include one or more application icons and one or more widgets corresponding to applications. In some embodiments, a respective user interface element from the first set of user interface elements has a respective appearance that transitions through multiple states in response to a user input directed to the respective user interface element from the first set of user interface elements (e.g., in the manner described with respect to the first user interface element). In some embodiments, a respective user interface element from the second set of user interface elements has a respective appearance that transitions through multiple states in response to movement of the computer system (e.g., having a gradient of values for a property from the first set of one or more properties, such as color, thickness, orientation, position, opacity, and/or other material and/or spatial properties of the respective user interface element from the second set of user interface elements, that changes in response to and in accordance with a movement of the computer system relative to the viewer). For example, as described with reference to FIGS. 5J-5M, application icons 424, 426, 428, and/or 430 are gradually updated to be displayed with a gradient that changes over time as an orientation of the device 100 continues to change.

In some embodiments, updating the first user interface element from the first state to the second state through one or more intermediate states between the first state and the second state includes changing a simulated thickness of the first user interface element from a first simulated thickness to a second simulated thickness through one or more intermediate simulated thicknesses (and, optionally, causing simulated optical interactions between the first user interface element and other content in the user interface to change accordingly). For example, as described with reference to FIGS. 5O-5Q, the computer system gradually increases a thickness when adding the user interface element (e.g., keyboard 734-3).

In some embodiments, updating the first user interface element from the first state to the second state through one or more intermediate states between the first state and the second state includes updating a simulated orientation of the first user interface element from a first orientation relative to a depth dimension of the user interface to a second orientation, different from the first orientation, relative to the depth dimension of the user interface, through one or more intermediate orientations between the first orientation and the second orientation (e.g., in response to detecting the first user input that interacts with the first user interface element, the first user interface elements tilts and/or pivots around an axis and/or anchor point in the user interface in a simulated depth direction of the user interface, optionally with one edge and/or corner of the first user interface element moving toward the viewer of the user interface element in a direction corresponding to reducing depth values and/or negative depth values, and an opposite edge and/or corner of the first user interface element moving away from the viewer of the user interface element in a direction corresponding to increasing depth values and/or positive depth values). In some embodiments, updating the simulated orientation of the first user interface element includes changing respective parameter values of one or more simulated material properties of the first simulated material from a first set of parameter values for the one or more simulated material properties of the first simulated material to a second set of parameter values for the one or more simulated material properties of the first simulated material, through one or more intermediate sets of parameter values for the one or more simulated material properties of the first simulated material (e.g., the intensities, directions, and/or other variables of the visual effects that simulate various material properties of the first simulated material are changed gradually from an initial set of values to another set of values, through one or more intermediate sets of values, that correspond to a gradual change in the orientation of the first user interface element under the influence of the first user input). In some embodiments, the second set of parameter values for the one or more simulated material properties is different from the first set of parameter values for the one or more simulated material properties of the first simulated material. In some embodiments, the one or more simulated material properties include simulated refraction of external content, simulated refraction of internal content, simulated sheen from nearby content, simulated specular reflection, simulated diffusion of nearby illumination, simulated transmissivity of nearby illumination, simulated material tint, simulated translucency to nearby content, and/or other simulated material properties that affect the appearance of the user interface element when the spatial relationship between the user interface element and its environment changes. For example, as described with reference to FIGS. 5I1-5I4, the specular highlights 5012 are updated based on the simulated tile of the user interface element 5002.

In some embodiments, the first set of one or more properties includes a set of one or more rules (e.g., a respective recipe or process characterized by a respective set of image processing procedures, a respective method for combining the respective set of image processing procedures, and/or respective sets of parameter values for the processing parameters of different image processing procedures of the respective set of image processing procedures, such as a vibrant color matrix filter that applies a color dodge and/or a saturation boost, optionally as described in more detail below with reference to method 14000) that are used in generating the appearance of the first simulated material based on the other content from the user interface that changes different portions of the first simulated material differently depending on the content that is underneath the different portions of the first simulated material. In some embodiments, the set of one or more rules that are used to generate a respective appearance of the first simulated material (e.g., one or more of the appearances in the first state, the second state, the intermediate states, and/or other states mentioned herein) is selected from a plurality of different sets of one or more rules, where a respective set of one or more rules is characterized by a respective set of image processing procedures (e.g., as indicated by the different layers 6003B-6003K in FIGS. 6A-6B4) and their corresponding sets of processing parameters. For example, in some embodiments, a first set of one or more rules is characterized by a first set of image processing procedures and corresponding sets of processing parameters, a second set of one or more rules is characterized by a second set of image processing procedures and corresponding sets of processing parameters, and the first set of image processing procedures differs from the second set of image processing procedures in terms of the types of image processing procedures that are employed (e.g., some of the layers 6003B-6003K are optionally omitted, and one or more additional layers are optionally added in a recipe for the respective set of one or more rules), and/or the order that the different image processing procedures are applied, to generate the appearance of the first simulated material from the other content in the user interface. In some embodiments, the first set of one or more rules and the second set of one or more rules that both uses a respective image processing procedure in their respective sets of image processing procedures, differ in the parameter values used for the set of processing parameters of the respective image processing procedure (e.g., blur radius in the blur layer 6003B, whether blur has spatial variations in the blur layer 6003B, strength of simulated internal refraction in the internal refraction layer 6003C-1, strength of simulated external refraction in the external refraction layer 6003C-2, intensity of simulated shadow in shadow layer 6003D, parameters of the vibrant color matrix in the VCM layer 6003E, whether VCM is adaptable to background content brightness in the VCM layer 6003E, whether the material appearance is responsive to mode change for the computer display, what color is applied by the tint vibrant color matrix 6003G, strength of the edge color matrix in layer 6003H, whether lensing effect should be applied in lens layer 6003J, strength of specular effects in specular layer 6003K, and/or other values for one or more processing parameters of other image processing procedures used in the respective lending mode that is selected for the first user interface element). Additional examples and details regarding the how a respective set of one or more rules can be varied based on different factors of consideration when generating the appearance of a user interface material based on background content, nearby content, and/or internal content of the user interface object that is visually associated with the user interface material, are provided in Table 1, in accordance with some embodiments. In some embodiments, applying the set of one or more rules pushes some portion of the first user interface material from being in an SDR range of brightness to being in an HDR range of brightness, optionally without pushing other portions of the user interface material to be in the HDR range of brightness (e.g., pushing one or more portions that were not in the HDR range of brightness into the HDR range of brightness), where the portions of the first user interface material that are pushed in the HDR range of brightness are determined based on the underlying content that the first user interface material is displayed over.

It should be understood that the particular order in which the operations in FIGS. 8A-8B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 9000, 10000, 11000, 12000, 13000, 14000, 15000, 16000, 17000, 18000, 19000, and/or 20000) are also applicable in an analogous manner to method 8000 described above with respect to FIGS. 8A-8B. For example, the buttons, user interfaces, controls, visual deemphasis, virtual effects, an/or animations described above with reference to method 8000 optionally have one or more of the characteristics of the buttons, user interfaces, controls, visual deemphasis, virtual effects, an/or animations described herein with reference to other methods described herein (e.g., methods 7000, 9000, 10000, 11000, 12000, 13000, 14000, 15000, 16000, 17000, 18000, 19000, and/or 20000). For brevity, these details are not repeated here.

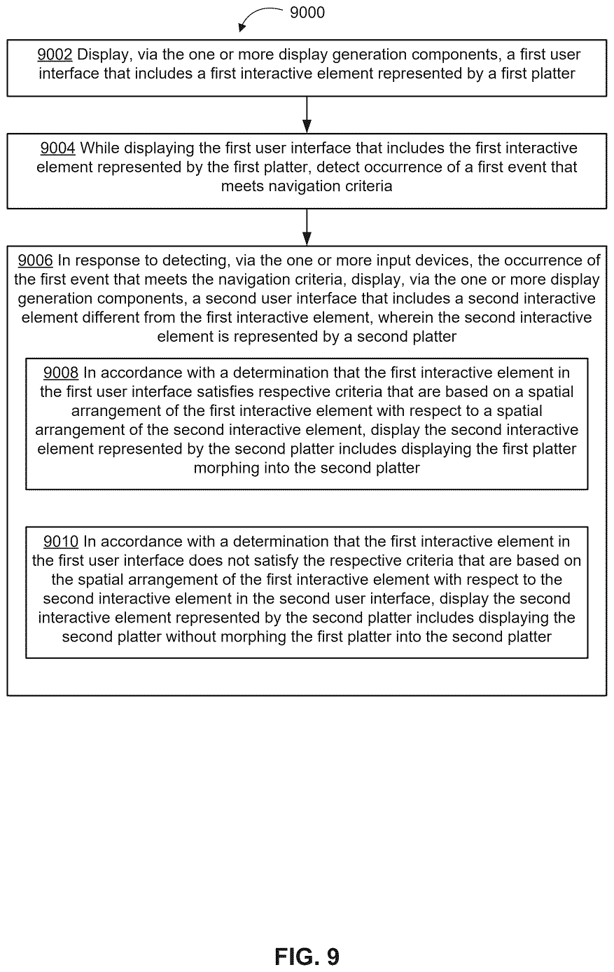

FIG. 9 is a flow diagram illustrating a method 9000 of transitioning between displaying a first set of controls and a second set of controls in accordance with some embodiments. The method 9000 is performed at an electronic device (e.g., device 300, FIG. 3A, or portable multifunction device 100, FIG. 1A) with a display, a touch-sensitive surface, and one or more sensors to detect intensity of contacts with the touch-sensitive surface. In some embodiments, the display is a touch-screen display and the touch-sensitive surface is on or integrated with the display. In some embodiments, the display is separate from the touch-sensitive surface. Some operations in method 9000 are, optionally, combined and/or the order of some operations is, optionally, changed. In some embodiments, the method 9000 is performed at a computer system in communication with one or more display generation components and one or more input devices: In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

Automatically determining whether or not to reuse a platter that displays one or more control options based on location criteria when updating a user interface from displaying a first set of control options to displaying a second set of control options causes the computer system to maintain the platter, or remove and/or replace the platter, while updating the user interface without requiring additional user input, which reduces a number of inputs required to perform an operation (e.g., including accessing the second set of controls), which enables a user to use a device for shorter periods of time, saves energy, and improves battery life. Providing a visual animation when the platter is reused provides improved feedback about a state of the computer system.

The computer system displays (9002), via the one or more display generation components, a first user interface that includes a first interactive element represented by a first platter (e.g., a respective user interface object of a first set of one or more user interface objects displayed in the first user interface that respond to user inputs directed toward them and in turn provide responses and/or other user interface feedback to the user inputs). In some embodiments, the first interactive element represented by the first platter includes a user interface object comprising a platter, optionally with textual and/or graphical content displayed on and/or embedded within the platter, wherein the platter comprises a simulated material with a boundary (e.g., edges and/or surfaces) that visually sets off the first interactive element from its surrounding content and environment. An example of this type of interactive elements includes a button comprising the simulated material confined by a boundary, with embedded text or symbol indicating the functionality of the button. Another example of this type of interactive elements includes a slider control, an input field for textual input, or a checkbox, that comprises the simulated material confined by a boundary, with internal structures indicating the functionality of the interactive element. In some embodiments, the simulated material has spatial properties and simulated optical properties, based on which simulated light interactions between the first interactive element and its surrounding environment (e.g., displayed content and/or the physical environment) can be generated. In some embodiments, the first interactive element represented by the first platter includes a user interface object comprising a platter with one or more user interface objects, and, optionally, textual and/or graphical content, displayed on and/or embedded within the platter, wherein the platter comprises a simulated material that visually sets off the first interactive element from its surrounding content and environment. An example of this type of interactive elements includes a menu of selectable options, where the menu platter includes multiple individually selectable portions that correspond to different operations. For example, this type of interactive elements includes a dock and/or a tool bar that supports multiple individually selectable portions that correspond to different user interface objects, such as controls, icons, and/or input fields. In some embodiments, the first user interface may concurrently include multiple interactive elements that are displayed within corresponding platters located in different regions of the first user interface (e.g., the multiple platters are separate from the background of the first user interface and spatially separated from one another in the first user interface). In some embodiments, the platters provide the background or substrate for respective subsets of the interactive elements in the first user interface, that visually sets off the different subsets of the interactive elements from the background and other content of the first user interface. In some embodiments, the regions of the first user interface that includes these platters include corners, top edge, bottom edge, left edge, right edge, and/or center regions of the first user interface and/or of the display area displaying at least a portion of the first user interface. For example, the user interface 722 in FIG. 5N includes a search button 725-1 and/or compose button 726-1.

While displaying the first user interface that includes the first interactive element represented by the first platter, the computer system detects (9004) occurrence of a first event that meets navigation criteria. In some embodiments, the first event that meets the navigation criteria includes a user input that is directed toward the first user interface, such as one or more touch inputs, gaze, attention, air gestures, and/or other user inputs, directed toward a control from the first set of controls, and/or other user interface object and/or content of the first user interface that is located outside of the first platters. In some embodiments, the first event that meets the navigation criteria includes an input activating one or more hardware controls of the electronic device, such as a power button, action button, and/or other hardware controls. In some embodiments, the first event that meets the navigation criteria includes an event generated by the operating system and/or an application based on satisfaction of one or more established conditions, such as an alert, a notification, and other automatic content updates to be displayed to the user. In some embodiments, the first event that meets the navigation criteria includes actuation of one or more hardware controls and/or change in hardware states and in the physical environment of the electronic device that trigger a change in the currently displayed user interface and/or display of another user interface in place of the currently displayed user interface. In some embodiments, the first event that meets the navigation criteria includes detection of a user input that interacts with the first interactive element (e.g., selects and/or activates the first interactive element or a constituent interactive element within the first interactive element). In some embodiments, the first event that meets the navigation criteria includes detection of a user input that interacts another portion of the first user interface that is not part of the first interactive element (e.g., selects and/or activates another interactive element that is concurrently displayed with the first interactive element). For example, as described with reference to FIG. 5N, the device detects a user input 730 corresponding to a request to replace display of user interface 722 with user interface 736 (e.g., in FIG. 5Q).

In response to detecting, via the one or more input devices, the occurrence of the first event that meets the navigation criteria, the computer system displays (9006), via the one or more display generation components, a second user interface that includes a second interactive element different from the first interactive element, wherein the second interactive element is represented by a second platter.

In some embodiments, in accordance with a determination that the first interactive element in the first user interface satisfies respective criteria that are based on a spatial arrangement of the first interactive element with respect to a spatial arrangement of the second interactive element (where the respective criteria include a criterion that is met based at least in part on the location of the first interactive element in the first user interface being within a threshold distance, in the same quadrant, in the same corner, on the same side, and/or in adjacent corners, of the display, relative to the location of the second interactive element to be displayed in the second user interface), displaying the second interactive element represented by the second platter includes (9008) displaying the first platter morphing into the second platter. In some embodiments, the first platter is updated in size, shape, and/or position to morph into the second platter, and the content displayed on and/or embedded within the simulated material of the first platter is replaced by (e.g., cross faded with, morphed into, and/or pushed out) the content displayed on and/or embedded within the simulated material of the second platter. In some embodiments, the simulated material of the first platter and the simulated material of the second platter have the same simulated material properties (e.g., simulated blur radius, opacity, refractive index, and/or color), even though the spatial properties of the first platter and the second platter (e.g., sizes, dimensions, aspect ratio, thickness, shapes, geometries, curvatures, and/or positions) are different. In some embodiments, morphing the first platter into the second platter includes displaying a plurality of intermediate platters that have respective intermediate sets of values for a set of properties of the platters, such as intermediate values for the shape, size, thickness, position, boundary, aspect ratio, and/or other spatial properties, and optionally, intermediate values for the simulated refractive index, opacity, blur radius, color, brightness, and/or other simulated material properties for the platters. In some embodiments, the intermediate values for a respective property are values between the values of the respective property used for the first platter and the values of the respective property used for the second platter, increasing departing from the values used for the first platter and approaching the values used for the second platter, in order to maintain the visual continuity of the transition from displaying the first platter representing the first interactive element to displaying the second platter representing the second interactive element. In some embodiments, morphing the first platter into the second platter includes stretching the first platter in one or more directions, shifting one or more edges of the first platter relative to one or more other edges of the first platter, rounding out sharp corners of the first platter, pulling two ends of the first platter apart to divide the first platter into two or more pieces, and/or expanding the first platter to swallow up or merge with another platter in the first user interface, optionally, while the content within the first platter transforms into and/or is otherwise replaced by the content in the second platter. For example, as described with reference to FIGS. 5N-5Q, search button 725-1 morphs into send button 742 based on the respective positions of the buttons in their respective user interfaces.

In some embodiments, in accordance with a determination that the first interactive element in the first user interface does not satisfy the respective criteria that are based on the spatial arrangement of the first interactive element with respect to the second interactive element in the second user interface (e.g., the second interactive element will be displayed outside of a threshold distance, in a different corner, different quadrant, and/or different side of the display region provided via the one or more display generation components, relative to a location at which the first interactive element is displayed), displaying the second interactive element represented by the second platter includes (9010) displaying the second platter without morphing the first platter into the second platter (e.g., the first platter representing the first interactive element is not reused for the second platter representing the second interactive element). For example, in some embodiments, the first platter ceases to be displayed by fading away, becoming more translucent, reducing in thickness, reducing in color saturation, while the second platter is displayed by fading in, becoming opaquer, increasing in thickness, expanding out from an origin, and/or increasing in color saturation, at a different location in the display area provided via the one or more display generation components. In some embodiments, if the second platter satisfy the respective criteria with respect to another existing platter in the first user interface, the second platter is displayed by morphing the other existing platter into the second platter. For example, as described with reference to FIGS. 5N-5Q, keyboard 7334-3 is displayed without morphing from the compose button 726-1.

In some embodiments, the first user interface includes a third interactive element represented by a third platter, the third interactive element is different from the first interactive element, and the third platter is different from the first platter (e.g., located at different locations in the first user interface, separated by a portion of the background of the first user interface and/or by other objects concurrently displayed in the first user interface). In some embodiments, some or all of the descriptions regarding the first interactive element also applies to the third interactive element, and some or all of the descriptions regarding the first platter also applies to the third platter, and these descriptions are not repeated herein in the interest of brevity. In some embodiments, in response to detecting the occurrence of the first event that meets the navigation criteria, the computer system ceases to display the third platter without morphing or merging the third platter into another platter (e.g., without morphing the third platter into another platter in the second user interface, merging the third platter with the first platter when the first platter is morphed into the second platter, splitting the third platter into two or more new platters representing two or more interactive elements that are spaced apart from one another in the second user interface, and/or morphing the third platter into a fourth platter representing a fourth interactive element in the second user interface). For example, in some embodiments, when navigating from the first user interface and the second user interface, the interactive elements displayed at different locations of the first user interface may undergo the same type of transformations, different types of transformations, a combined transformation, or cease to be displayed without going through a transformation into something displayed in the second user interface. In some embodiments, a respective type of transformation of the different types of transformations includes merging two or more platters into a single new platter, optionally by shifting, stretching, and/or deforming some or all of the two or more platters. In some embodiments, a respective type of transformation of the different types of transformations includes splitting a platter into two or more pieces, with one or more pieces morphing into respective new platters used in the second user interface, optionally by shifting, stretching, and/or deforming the platter and the one or more pieces, while optionally ceasing to display one or more other pieces that do not morph into new platters in the second user interface. In some embodiments, a respective type of transformation of the different types of transformations includes morphing a platter of the first user interface into a new platter in the second user interface, optionally by shifting, stretching, and/or deforming the platter without combining with another platter or a split piece of another platter. For example, as described with reference to FIGS. 5N-5Q, keyboard 734-3 materializes without reusing an existing platter from another user interface object.

In some embodiments, displaying the first platter morphing into the second platter includes merging the first platter with an additional platter that was displayed concurrently with the first platter in the first user interface. In some embodiments, the additional platter that was displayed concurrently with the first platter in the first user interface is a platter of another interactive element that was displayed in the first user interface, and that meets the respective criteria with respect to the first interactive element in the first user interface and/or with respect to the second interactive element in the second user interface. For example, the additional platter is located along the same edge, in the same quadrant, and/or in the same corner of the display region provided via the one or more display generation components, as the first platter and/or the second platter; sand/or is with a display location that is within a threshold distance of the display location of the first platter and/or the second platter. In some embodiments, before merging into the second platter, the first platter and the additional platter that was displayed concurrently with the first platter in the first user interface stretch toward each other and/or toward a common location (e.g., the location of the second platter in the second user interface), then, their boundaries touch and merge into the same continuous boundary of the second platter and their simulated materials merge into the same simulated material within the new boundary of the second platter. In some embodiments, the simulated material and the continuous boundary of the second platter continues to change through a plurality of intermediate states before setting into the steady state appearance of the second platter representing the second interactive element in the second user interface. For example, as described with reference to FIGS. 5N-5Q, in some embodiments, a reverse animation is performed that combines e.g., button 740 and button 742 via a reverse mitosis animation illustrated in FIG. 5P.

In some embodiments, merging the first platter with the additional platter that was displayed concurrently with the first platter in the first user interface includes displaying a boundary of the first platter and a boundary of the additional platter in a plurality of intermediate states in which the boundary of the first platter and the boundary of the second platter move closer to each other and connect into a single continuous boundary of the second platter. In some embodiments, the plurality of intermediates is displayed in sequence in a fluid animation that looks like two masses of fluid or gel coming into contact and merging into a larger mass of fluid of gel and eventually settling into the steady state shape of the second platter. In one example, in some embodiments, the platters representing two or three small buttons displayed along the same edge of the first user interface are merged into a single platter for a tool bar displayed along the same edge of the second user interface, or merged into a single platter and expanded into a big platter that is displayed in the center of the second user interface (e.g., as described with reference to transitional button 726-3, FIG. 5P).

In some embodiments, displaying the first platter morphing into the second platter includes splitting the first platter into two or more portions that are spaced apart from one another (e.g., with some space between the two portions that is not part of a platter), with at least one of the two or more portions morphing into the second platter. In some embodiments, when one of the two or more portions of the first platter morphs into the second platter, one or more other portions of the first platter may morph into other platters in the second user interface, and optionally, one or more other portions cease to be displayed and do not morph into a new platter in the second user interface. In some embodiments, before splitting into two or more portions, the first platter is stretched and deformed, such that the connective part between the portions become thinner and/or stretched, while the portions become shorter and start to bulge out. After the portions are separated from one another and have respective individual boundaries that are separate from one another, a respective portion that corresponds to the second platter (e.g., based on its proximity to the location of the second platter in the second user interface) will stretch and/or reshape into the steady state shape of the second platter (e.g., as described with reference to button 726-2, FIG. 5O).

In some embodiments, splitting the first platter into two or more portions, with at least one of the two or more portions morphing into the second platter, includes displaying a boundary of the first platter in a plurality of intermediate states in which the boundary of the first platter separates into respective boundaries of the two or more portions, where the respective boundaries of the two or more portions are connected in one or more of the plurality of intermediate states and are separated from one another in one or more of the plurality of intermediate states. In some embodiments, the plurality of intermediates is displayed in sequence in a fluid animation that looks like a single masses of fluid or gel stretching and reshaping into two or more clumps, and eventually separating into individual masses of fluid or gel, with one of the masses continues to morph into the second platter in the second user interface. In one example, in some embodiments, the first platter is the platter of a tool bar, and in response to selection of one of the affordances included in the tool bar, the simulated material of the tool bar morphs into several clumps of simulated material, with one of the clumps of simulated material continuing to morph into a button in the second user interface, and optionally other clumps of the simulated material continuing to morph into other buttons in the second user interface (e.g., as described with reference to transitional button 726-3, FIG. 5P).

In some embodiments, the first user interface includes a first plurality of interactive elements represented by respective platters from a first plurality of platters (e.g., including the first interactive element represented by the first platter and one or more other interactive elements represented by other platters). In some embodiments, the second user interface includes a second plurality of interactive elements represented by respective platters from a second plurality of platters (e.g., including the second interactive element represented by the second platter and one or more other interactive elements represented by other platters). In some embodiments, while displaying the first user interface that includes the first plurality interactive elements represented by the respective platters from the first plurality of platters, the computer system detects occurrence of a second event that meets the navigation criteria (e.g., same as the first event, an event analogous to the first event, and/or another event different from the first event). In response to detecting the occurrence of the second event, the computer system displays, via the one or more display generation components, a third user interface (e.g., same as the second user interface, another user interface that is analogous to the second user interface, another user interface that is different from the second user interface, depending on the context and the characteristics of the second event that met the navigation criteria) that includes a second plurality of interactive elements (e.g., including the second interactive element, the third interactive element, or other interactive elements). In some embodiments, displaying the third user interface includes merging a first set of two or more platters from the first plurality of platters into a respective platter in the second plurality of platters (e.g., merging platters into a new platter as described above with respect to the first platter and the second platter), and forgoing merging a second set of one or more platters from the first platters into a respective platter in the second plurality of platters (e.g., one or more platters from the first user interface cease to be displayed without being morphed into a new platter, one or more platters from the first user interface split into one or more new platters in the second user interface, and/or one or more platters transforms into respective new platters in the second user interface without splitting or merging with another platter). For example, as described with reference to FIGS. 5N-5Q, the platters corresponding to button 724-1 and button 725-1 from the user interface 722 are reused in the user interface 736, while the platter corresponding to compose button 726-1 in the user interface 722 is not reused in the user interface 736.

In some embodiments, forgoing merging the second set of two or more platters from the first plurality of platters into a respective platter in the second plurality of platters includes splitting a respective platter from the second set of two or more platters from the first plurality of platters into two or more portions, with at least one of the two or more portions of the respective platter morphing into a platter in the second plurality of platters. For example, as described with reference to FIG. 5Q, the button 725-1 is split into button 740 and button 742.

In some embodiments, while displaying the first user interface (e.g., a user interface that includes a first plurality interactive elements represented by the respective platters from the first plurality of platters), the computer system detects, via the one or more input devices, a first user input that is directed to the first interactive element (e.g., the user input is an example of an event that meets the navigation criteria). In some embodiments, the first user input includes a tap gesture, a light press gesture, or a touch-hold gesture performed by a contact with a touch-sensitive surface at a location corresponding to the first interactive element, an air pinch gesture, an air tap gesture, an air pinch and hold gesture detected while a gaze or attention is directed to the first interactive element, a click input with a focus selector at the location of the first interactive element, and/or another type of input that has a target location at the location of the first interactive element. In response to detecting the first user input, the computer system displays, via the one or more display generation components, a plurality of intermediate states in which the first platter splits into two or more portions, and the two or more portions morph into separate platters representing two or more interactive elements that were not displayed in the first user interface prior to detecting the first user input. In response to detecting the first user input, the computer system maintains display of the two or more interactive elements represented by the separate platters (e.g., the separate platters that morphed from the two or more portions of the first platter), after displaying the plurality of intermediate states. In some embodiments, the two or more interactive elements are displayed in a new user interface, such as the second user interface, another user interface analogous to the second user interface, and/or another user interface that is different from the second user interface. In some embodiments, the two or more interactive elements are displayed in the first user interface, replacing the first interactive elements represented by the first platter. For example, as described with reference to FIG. 5Q, the button 725-1 is split into button 740 and button 742 in response to detecting the user input 730.

In some embodiments, in response to detecting the first user input, the computer system displays, via the one or more display generation components, a plurality of intermediate states in which the two or more platters that were concurrently displayed with the first platter in the first user interface are merged into a single platter representing a new interactive element that was not displayed in the first user interface prior to detecting the first user input. In some embodiments, in response to detecting the first user input, the computer system maintains display of the new interactive element represented by the single platter formed by merging the two or more platters that were concurrently displayed with the first platter in the first user interface. In some embodiments, while one or more platters are merged into one or more new platters, one or more other platters are split into two or more new platters, as a result of the user input directed to an existing interactive element of a currently displayed user interface (e.g., the first interactive element in the first user interface, another interactive element in the first user interface, and/or another interactive element in a different user interface). For example, as described with reference to FIGS. 5Q1-5Q2, the button 740 and button 742 are merged into a single button 725-1.

In some embodiments, displaying the first platter morphing into the second platter includes displaying, via the one or more display generation components, a plurality intermediate states in which at least a portion of a boundary of the first platter stretches and/or morphs into at least a portion of a boundary of the second platter. For example, when the first platter is merged with another existing platter to form the second platter, the boundary of the first platter and the boundary of the other existing platter stretch and connect with each other, and a portion of the boundary of the first platter becomes a portion of the combined boundary of the merging platters, and eventually a portion of the second platter. In one example, when the first platter is split into multiple portions, portions of the boundary of the first platter become the individual boundaries of the different portions that are split from the first platter, and one of the portions split from the first platter morphs into the second platter and as a result a portion of the boundary of the first platter becomes at least a portion of the boundary of the second platter. For example, as described with reference to FIG. 5P, transitional button 725-3 is displayed by stretching and/or splitting the button 725-1.

In some embodiments, the first user interface includes a first plurality of interactive elements represented by respective platters from a first plurality of platters, and displaying the first platter morphing into the second platter includes displaying a plurality of intermediate states in which a boundary of the first platter and respective boundaries of one or more additional platters from the first plurality of platters stretch toward one another and morph into a single boundary of the second platter. For example, as described with reference to FIG. 5Q1, transitional button 725-4 is displayed by stretching button 740 and button 742 toward each other to merge into the button 725-1.

In some embodiments, in accordance with the determination that the first interactive element in the first user interface satisfies the respective criteria that are based on a spatial arrangement of the first interactive element with a spatial arrangement of the second interactive element, displaying the second interactive element represented by the second platter includes changing content displayed on the first platter into content displayed on the second platter (e.g., fading out the content of the first platter and fading in the content of the second platter with the content and their intermediate states confined within the simulated material of the first platter, the simulated material of the intermediate states, and the simulated material of the second platter). In some embodiments, instead of cross fading the content in the platters, the computer system generates intermediate states by interpolating the content from the first platter and the content from the second platter in accordance with the simulated material properties, shapes, sizes, and/or positions of the intermediate states of the two platters. For example, button 738 (e.g., in FIG. 5Q) includes different content than button 724-1 (e.g., in FIG. 5N).

In some embodiments, the first interactive element corresponds to a first operation (e.g., when activated by a selection input or a user input that meets activation criteria, causes the computer system to perform the first operation). While displaying the second interactive element represented by the second platter morphed from the first platter, the computer system detects, via the one or more input devices, a user input that interacts with the second interactive element. In some embodiments, the user input that interacts with the second interactive element includes a selection input or movement input such as a touch gesture with a contact at a location corresponding to the location of the second interactive element, an air gesture detected while a user's attention is directed toward a location of the second interactive element, a click input detected while a focus selector is at a location of the second interactive element, an activation of a button when the second interactive element has input focus, and/or another type of input with a target location corresponding to the second interactive element. In response to detecting the user input that interacts with the second interactive element, and in accordance with a determination that the user input meets activation criteria, the computer system performs a second operation that is different from the first operation (e.g., the second interactive element is mapped to a second operation even though the second interactive element reused the platter of the first interactive element). In some embodiments, the second operation includes changing a setting, changing an appearance of a user interface, and/or navigating to a different user interface. For example, as described with reference to FIGS. 5R-5V, the platter 816-1 includes different options than platter 810.

In some embodiments, in accordance with the determination that the first interactive element in the first user interface satisfies the respective criteria that are based on a spatial arrangement of the first interactive element with a spatial arrangement of the second interactive element, displaying the second interactive element represented by the second platter includes changing a value of a first visual property of the first platter when morphing the first platter into the second platter (e.g., changing a tint of the morphing platter from a first tint used in the first platter to a second tint used in the second platter). For example, as described with reference to FIGS. 5R-5V, the transitional platter 814-1 is displayed with one or more visual effects (e.g., a color or tinting).

In some embodiments, in accordance with the determination that the first interactive element in the first user interface satisfies the respective criteria that are based on a spatial arrangement of the first interactive element with a spatial arrangement of the second interactive element, displaying the second interactive element represented by the second platter includes changing a size of the first platter when morphing the first platter into the second platter (e.g., changing a size of the morphing platter from a first size used by the first platter to a second size used in the second platter). For example, as described with reference to FIGS. 5R-5V, the platter 816-1 is a different size than platter 810.

In some embodiments, detecting the occurrence of the event includes detecting a user input that corresponds to a request to scroll the first user interface (e.g., one or more swipe gestures, one or more air pinch and drag gestures, one or more click and drag input, that are directed to a portion of the first user interface and that has a direction corresponding to the requested direction of scrolling) and the second user interface is displayed as a result of scrolling the first user interface (e.g., shifting the content in the first user interface relative to the display region, to bring in the content of the second user interface). For example, in some embodiments, in response to one or more scroll inputs directed to a portion of the wake screen user interface displaying a plurality of notifications (e.g., an example of the first user interface including the first interactive element), the notifications displayed on the wake screen user interface are scrolled in the direction of the one or more scroll inputs, and when the end of the notifications are reached, a subsequent scroll input would cause a plurality of stored notifications in notification history to be pulled up and displayed in the wake screen user interface or replace the wake screen user interface with a notification history user interface (e.g., an example of the second user interface including the second interactive element). In one example, in some embodiments, a scroll input that is directed to a currently displayed portion of a multi-page user interface (e.g., an input that is not necessarily on a currently displayed interactive element, or an input that is on a currently displayed interactive element such as the first interactive element) causes the currently displayed portion of the multi-page user interface to scroll off the display area provided via the one or more display generation components, and causes a previously hidden portion of the multi-page user interface to enter the display region provided via the one or more display generation components, where the newly displayed portion of the multi-page user interface includes additional interactive elements, one or more of which may be morphed from the interactive elements from the previously displayed portion of the multi-page user interface. For example, as described with reference to FIGS. 5N-5Q, in some embodiments, the user input 730 is a scrolling user input for scrolling the displayed user interface.

In some embodiments, detecting the occurrence of the event includes detecting a user input that selects (e.g., in accordance with selection criteria, by a tap gesture, a press gesture, a double tap gesture, an air pinch gesture, a click input, and/or another type of selection input) a user interface object displayed in the first user interface (e.g., the first interactive element, a portion of the first interactive element, or an interactive element that is different from the first interactive element). In some embodiments, the second user interface is displayed as a result of the selection of user interface object displayed in the first user interface. In one example, the first interactive element is a “compose” button in a first user interface of an email or messages application, and a user input selecting the “compose” button causes the computer system to display a “composition” user interface that includes a message platter for a new message, and the message platter is transformed from the platter of the “compose” button. In one example, the first interactive element is a menu with multiple options corresponding to different operations, and a user input selecting one of the menu options causes the menu to split into multiple discrete portions corresponding to different menu options, with the portion corresponding to the selected menu option to morph into the second interactive element displayed in a new user interface that corresponds to the selected menu option, while other portions optionally morphing into other interactive elements or cease to be displayed in the new user interface. For example, as described with reference to FIGS. 5N-5Q, in some embodiments, the user input 730 selects the compose button 726-1.

In some embodiments, detecting the occurrence of the event includes detecting a user input that corresponds to a request to navigate back to a previously displayed user interface (e.g., a swipe gesture in a direction corresponding to a “back” direction of the user interface, a voice input for “go home” or “go back,” a selection input selecting a “Back” button in accordance with selection criteria, by a tap gesture, a press gesture, a double tap gesture, an air pinch gesture, a click input, and/or another type of selection input) and the second user interface is displayed as the previously displayed user interface (e.g., a home page, a home screen, a last displayed application, a different application that was previously displayed, a last displayed web page or user interface of a currently displayed application, and/or a different webpage or user interface of a currently displayed application that was previously displayed). For example, as described with reference to FIGS. 5N-5Q, in some embodiments, the user input 730 is a user input selecting a back button.

In some embodiments, displaying the second user interface that includes the second interactive element includes, in accordance with a determination that a display location of the first interactive element is within a threshold range (e.g., based on distance, proximity, and/or spatial relationship) of a display location of the second interactive element in a display region provided via the one or more display generation components (e.g., on the same side, in the same and/or adjacent quadrant(s), in the same and/or adjacent row(s), in the same and/or adjacent column(s), within a threshold distance of, and/adjacent to each other without another object in between), displaying, via the one or more display generation components, the first platter morphing into the second platter. In some embodiments, displaying the second user interface that includes the second interactive element includes, in accordance with a determination that the display location of the first interactive element is outside of the threshold range (e.g., based on distance, proximity, and/or spatial relationship) of the display location of the second interactive element in the display region provided via the one or more display generation components (e.g., not on the same side, not in the same and/or adjacent quadrant(s), not in the same and/or adjacent row(s), not in the same and/or adjacent column(s), outside a threshold distance of, and/spaced apart from each other with one or more other objects in between), ceasing to display the first platter, and displaying, via the one or more display generation components, the second platter without morphing the first platter into the second platter. For example, as described with reference to FIGS. 5N-5Q, the text size button 740 and the send button 742 satisfy distance criteria relative to compose search button 725-1 and thus the platter for the search button is reused for the text size button 740 and the send button 742.

In some embodiments, displaying the second user interface that includes the second interactive element includes, in accordance with a determination that an animation direction for transitioning from the first user interface to the second user interface (e.g., a requested scroll direction, an animation direction for navigating from the first user interface to the second user interface as determined by the operating system or the currently displayed application, and/or an animation direction for originating user interface changes from a selected user interface object in the first user interface to fully displaying the second user interface) is a first animation direction, displaying, via the one or more display generation components, the first platter morphing into the second platter. In some embodiments, displaying the second user interface that includes the second interactive element includes, in accordance with a determination that the animation direction for transitioning from the first user interface to the second user interface is a second animation direction, different from the first animation direction, ceasing to display the first platter, and displaying, via the one or more display generation components, the second platter without morphing the first platter into the second platter. In some embodiments, the computer system determines that the direction of morphing the first platter into the second platter agrees with (e.g., in substantially the same direction as, and/or along substantially the same axis as) the animation direction for transitioning from the first user interface to the second user interface, and as a result proceed to morph the first platter to the second platter. For example, as described with reference to FIG. 5Q, in some embodiments, the criteria for reusing the platter of the initial button for the destination button is based on a direction of the animated transition.

In some embodiments, the respective criteria that are based on a spatial arrangement of the first interactive element with respect to a spatial arrangement of the second interactive element includes a requirement that the first interactive element and the second interactive element are in a same display layer (e.g., both are in the foreground layer, both are in the top display layer, both are in a background layer, and/or both are in a display layer for a respective type of interactive elements) in order for the first interactive element to meet the respective criteria. For example, as described with reference to FIG. 5Q, the criteria for reusing the platter of the initial button (e.g., search button 725-1) for the destination button (e.g., text size button 740 and/or send button 742) is based on the buttons beings displayed within a same simulated layer.

In some embodiments, the first interactive element includes first content other than the first platter (e.g., text, graphics, glyphs, symbols, and/or colors displayed on or embedded within the simulated material of the first platter). In some embodiments, displaying the second interactive element represented by the second platter includes displaying, via the one or more display generation components, a visual effect that propagates across a spatial extent the first content (e.g., from top to bottom, from left to right, from center to peripheral regions, along the stroke direction of the textual and numeral content, in the direction of the animation and/or morphing of the first platter into the second platter) and that reduces visibility of the first content over time (e.g., gradually fading out, making it thinner, more translucent, more blurred, more refracted, more deformed, and/or otherwise less visible or intelligible). For example, as described with reference to FIG. 5P, content within a button transitions by changing in position to appear as sliding on and/or off the button.

In some embodiments, the first interactive content includes first content other than the first platter, the second interactive element includes second content other than the second platter, the first content is displayed with a greater range of brightness as compared to other content in the first user interface that are not interactive, and the second content is displayed with a greater range of brightness as compared to other content in the second user interface that are not interactive. For example, in some embodiments, the text and glyphs on interactive elements are displayed with a high dynamic range (HDR) effect to improve their visibility over other content in the user interface. For example in some embodiments, if the non-interactive content of the first user interface has a dynamic range corresponding to light colored content (e.g., as opposed to dark colored content), the first content has a dynamic range that includes brighter and lighter color values relative to the dynamic range of the non-interactive content of the first user interface (e.g., to make the first content stand out against the non-interactive content), and optionally, includes the same dark and dim color values compared to the dynamic range of the non-interactive content of the first user interface. Similarly, if the non-interactive content of the second user interface has a dynamic range corresponding to light colored content (e.g., as opposed to dark colored content), the second content has a dynamic range that includes brighter and lighter color values compared to the dynamic range of the non-interactive content of the second user interface (e.g., to make the first content stand out against the non-interactive content), and optionally, includes the same dark and dim color values compared to the dynamic range of the non-interactive content of the second user interface. For example, as described with reference to FIG. 5P, content within buttons displayed in the user interface 722 are displayed with an HDR effect.

It should be understood that the particular order in which the operations in FIG. 9 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 10000, 11000, 12000, 13000, 14000, 15000, 16000, 17000, 18000, 19000, and/or 20000) are also applicable in an analogous manner to method 9000 described above with respect to FIG. 9. For example, the buttons, user interfaces, controls, visual deemphasis, virtual effects, an/or animations described above with reference to method 9000 optionally have one or more of the characteristics of the buttons, user interfaces, controls, visual deemphasis, virtual effects, an/or animations described herein with reference to other methods described herein (e.g., methods 7000, 8000, 10000, 11000, 12000, 13000, 14000, 15000, 16000, 17000, 18000, 19000, and/or 20000). For brevity, these details are not repeated here.

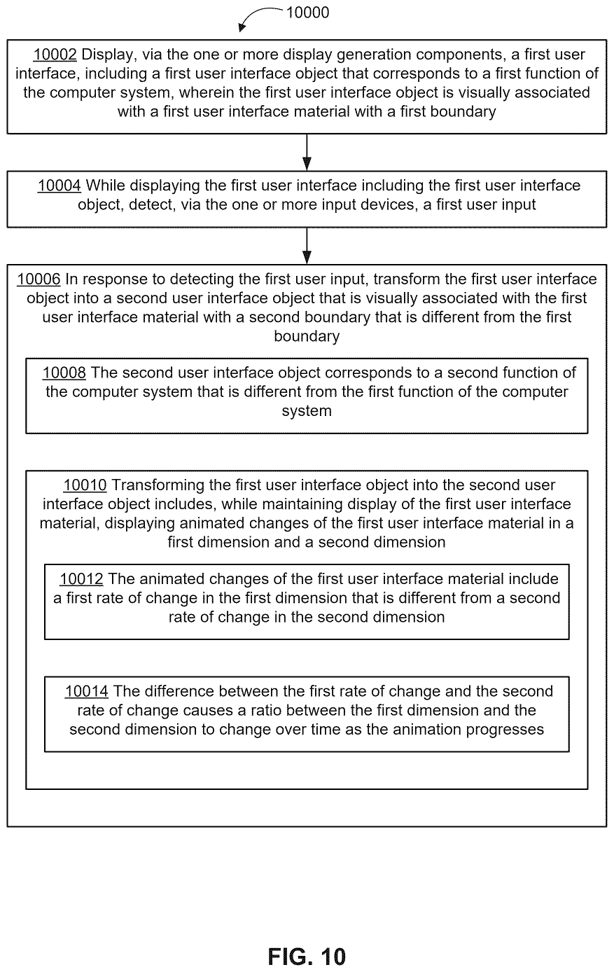

FIG. 10 is a flow diagram illustrating a method 10000 of morphing a user interface element in accordance with some embodiments. The method 10000 is performed at a computer system (e.g., device 300, FIG. 3A, or portable multifunction device 100, FIG. 1A) that is in communication with one or more input devices and one or more display generation components. In some embodiments, the one or more display generation components are touch-screen displays which optionally include one or more touch-sensitive surfaces integrated with one or more of the display generation components. In some embodiments, one or more of the display generation components are separate from one or more of the touch-sensitive surfaces. Some operations in method 10000 are, optionally, combined and/or the order of some operations is, optionally, changed.

Displaying an animated transition to morph a user interface element from a first user interface element into a second user interface element, where the animated transition includes displaying a plurality of transitional states that change in shape provides improved visual feedback to the user about a state of the computer system. Using responsive materials for user interface elements that transition to and/or from other user interface elements improves the responsiveness of user interface elements to inputs, which enables a user to use a device for shorter periods of time, which saves energy and improves battery life. Automatically changing an appearance of user interface elements (e.g., changing a size and/or shape of user interface elements) when one or more criteria are met reduces the number of inputs (e.g., navigating through settings user interfaces and menus to set the values for parameters to adjust the size and/or shape of user interface elements) that would otherwise be required to generate a similar effect, which saves energy and improves battery life

The computer system displays (10002), via the one or more display generation components, a first user interface, including a first user interface object that corresponds to a first function of the computer system (e.g., a first control corresponding to a first control function of the computer system, and/or a first user interface object that, in response to an input directed toward the first user interface object, causes the computer system to perform a first operation, such as displaying another user interface object, optionally, in a second user interface different from the first user interface), wherein the first user interface object is visually associated with (e.g., is, is part of, includes, is “made of” and/or is included in) a first user interface material with a first boundary (e.g., the first user interface object is a button, an affordance, a toggle, a slider, a tool bar, a dock, a popup, a window, and/or another type of user interface object that has content that is optionally embedded within and/or on the surface of a user interface material such as a background material, a texture, and/or a simulated glassy, translucent, and/or gelatinous material with a simulated three-dimensional volume defined by the first boundary, such as outlines and bounding surfaces of the simulated three-dimensional volume in two or more dimensions). In some embodiments, the first user interface material is defined by a respective set of visual properties (e.g., color, transparency, blur radius, gradient, luminance, and/or other visual properties) and/or simulated properties (e.g., shape, size, thickness, elasticity, simulated refractive index, surface texture, and/or other simulated physical properties and simulated material responses to user interactions). In some embodiments, the first user interface material is a user interface material that provides the background on which and/or the substance within which, content corresponding to a user interface object is located, where the first user interface material and the content constitute the user interface object that is distinguished from its surrounding environment. For example, in FIG. 5R, the platter 810 (e.g., displayed with simulated glass material) is contained within a first boundary.

While displaying the first user interface including the first user interface object, the computer system detects (10004), via the one or more input devices, a first user input (e.g., a touch gesture, an air gesture, a point and click input, an actuation and/or manipulation of a hardware control, and/or other types of input, that optionally, are directed toward the first user interface object based on a location of the first user interface object and/or the currently selected state of the first user interface object, and/or that optionally, are directed toward a location that corresponds to another portion of the first user interface other than the first user interface object). In some embodiments, a touch gesture targets an object based on a location of a contact on a touch-sensitive surface that corresponds to the display location of the object. In some embodiments, an air gesture targets an object based on a location of the user's attention, e.g., based on the location of the hand that provides the air gesture and/or a location of a gaze of the user, that corresponds to the location of the object. In some embodiments, a point and click input targets an object based on a location of a cursor that corresponds to the location of the object. In some embodiments, the first user interface object is the target of an input when the first user interface object is a currently selected object and has input focus at the time when the input is detected (e.g., when a hardware control is actuated and/or manipulated; and/or when another type of input device detects the first user input).

In response to detecting the first user input, the computer system transforms (10006) the first user interface object into a second user interface object that is visually associated with the first user interface material with a second boundary that is different from the first boundary (e.g., the second user interface object is a button, an affordance, a toggle, a slider, a tool bar, a dock, a popup, a window, and/or another type of user interface object that has content embedded within and/or on the surface of a user interface material such as a background material, a texture, and/or a simulated glassy, translucent, and/or gelatinous material with a simulated three-dimensional volume defined by the second boundary, such as outlines and bounding surfaces of the simulated three-dimensional volume in two or more dimensions). For example, in response to detecting user input 812 (e.g., in FIG. 5R), the platter 810 is updated to platter 816-1.

In some embodiments, the second user interface object corresponds to (10008) a second function of the computer system that is different from the first function of the computer system. In some embodiments, the second user interface object is a second control corresponding to a second control function of the computer system, and/or an object that, in response to an input directed toward the object, causes the computer system to perform a second operation, such as displaying another user interface object, optionally, in a another user interface different from the currently displayed user interface), and In some embodiments, the first function and the second function are functions other than the display of another user interface object, and such display of another user interface object and/or another user interface is performed in addition to and/or in conjunction with performing the respective functions associated with the first and second user interface objects. In some embodiments, the second user interface object is not associated with the first user interface object in the manner that a sub-menu is associated with a currently displayed menu that includes a menu item that corresponds to the sub-menu, but, optionally, is independent of the first user interface object in terms of functionality. In some embodiments, transforming the first user interface object into the second user interface object reuses the first simulated material that contained the content of the first user interface object to contain the content of the second user interface object after transforming the shape, size, and/or position of the first simulated material within a continuously displayed, albeit changing, boundary (e.g., with changing outlines and/or surfaces in two or more dimensions). For example, platter 816-1 includes different control options for performing one or more operations than the control options in platter 810.

In some embodiments, transforming the first user interface object into the second user interface object includes (10010), while maintaining display of the first user interface material (e.g., the first user interface material does not fade out during the transformation, and remains confined within a moving boundary that is continuously displayed during the transformation from the first boundary corresponding to the first user interface object to the second boundary corresponding to the second user interface object), displaying animated changes of the first user interface material in a first dimension (e.g., a respective dimension of width, height, thickness, radius, and/or other spatial dimensions) and a second dimension (e.g., another respective dimension of width, height, thickness, radius, and/or other spatial dimensions). In some embodiments, the animated changes of the first user interface material include (10012) a first rate of change in the first dimension that is different from a second rate of change in the second dimension. In some embodiments, the difference between the first rate of change and the second rate of change causes (10014) a ratio between the first dimension and the second dimension (e.g., the intermediate shapes of the first user interface material during the transformation from the first user interface object to the second user interface object have multiple different aspect ratios, and optionally, have irregular and/or non-geometric shapes, due to the variable differences in the first rate of change and the second rate of change over time) to change over time as the animation progresses. In some embodiments, the first rate of change is a first variable rate of change. In some embodiments, the second rate of change is a second variable rate of change. In some embodiments, a variable rate of change has different values at different points in time, is not constant and/or substantially constant, and/or is different from an interpolated rate of change in a respective dimension based on a total difference between the first boundary and the second boundary in the respective dimension and a total animation time. In some embodiments, the first rate of change is a first variable rate that changes over the total animation time, and/or the second rate of change is a second variable rate that changes over the total animation time, where for some portions of the total animation time, a respective variable rate of change is lower than the interpolated rate of change, and for other portions of the total animation time, the respective variable rate is higher than the interpolated rate of change. For example, as described with reference to FIGS. 5R-5V, transitioning the platter 810 into platter 816-1 includes animating the platter 810 as decreasing in size (e.g., in a first direction (e.g., along the x-axis) at a first rate of change, optionally without decreasing in size, or decreasing at a different rate of change, in a second direction (e.g., along the y-axis)).

In some embodiments, displaying the animated changes of the first user interface material in the first dimension and the second dimension includes displaying the first user interface material in an intermediate object that is different from the first user interface object and the second user interface object (e.g., the intermediate object is an object that has an intermediate shape and/or size between the first user interface object and the second user interface object). In some embodiments, the intermediate object has an appearance that corresponds to a first percentage change in the first dimension of the first user interface material and a second percentage change in the second dimension of the first user interface material, relative to the first user interface material in the first user interface object (e.g., the intermediate object is visually associated with the first user interface material that has changed sizes in the first dimension and the second dimension, as compared to the original sizes of the first user interface object in the first dimension and the second dimension). In some embodiments, the second percentage change in the second dimension is different from the first percentage change in the first dimension (e.g., the intermediate object has changed sizes in the first dimension and the second dimension by different percentage changes in a same amount of time, resulting in a changed aspect ratio from the first user interface object to the intermediate object). In some embodiments, during the animated transition, the computer system displays a sequence of intermediate objects visually associated with the first user interface material, where a currently displayed intermediate object has a different aspect ratio as compared to the intermediate object that was displayed immediately before, until the animated transition ends when the last intermediate object transforms into the second user interface object. For example, as described with reference to FIGS. 5R-5T, the animation includes decreasing the transitional platter 814-1 in size and changing a shape of the transitional platter 814-1 into a rounded shape, as illustrated by transitional platter 814-2.

In some embodiments, the intermediate object is smaller than the first user interface object in a first set of one or more dimensions (e.g., the first dimension, the second dimension, both the first and second dimension, a third dimension, and/or two out of three dimensions). In some embodiments, the intermediate object is smaller than the second user interface object in a second set of one or more dimensions (e.g., same as the first set of one or more dimensions, different from the first set of one or more dimensions, included in the first set of one or more dimensions, and/or including the first set of one or more dimensions). In some embodiments, the intermediate object displayed during the animated transition from the first user interface object to the second user interface object is smaller in width than the first user interface object (and, optionally greater in height than the first user interface object), and is smaller in height than the second user interface object (and, optionally, greater in width than the second user interface object). In some embodiments, the intermediate object displayed during the animated transition from the first user interface object to the second user interface object is smaller in height than the first user interface object (and, optionally greater in width than the first user interface object), and is smaller in width than the second user interface object (and, optionally, greater in height than the second user interface object). In some embodiments, the first user interface object and the second user interface object have dissimilar geometric or organic shapes (e.g., circle vs. squares, square vs. rectangles, an organic shape vs. a geometric shape, a pair of different organic shapes, and/or other pairs of different geometric or organic shapes), and the intermediate object between the first user interface object and the second user interface object has a geometric or organic shape that is different from the shapes of the first user interface object and the second user interface object, and has a smaller size in one or more dimensions, compared to the first user interface object and/or compared to the second user interface object. For example, as described with reference to FIGS. 5S-5T, transitional platter 814-1 and transitional platter 814-2 are displayed with a smaller size than platter 810.

In some embodiments, displaying the first user interface material in the intermediate object includes, displaying the intermediate object with an edge portion (e.g., including a respective portion of one or more corner portions, curved portions, and/or straight portions along a boundary of the first user interface material) that corresponds to a transition between a first edge portion of the first user interface object and a second edge portion of the second user interface object (e.g., an upper left corner of the intermediate object corresponds to a transition between an upper left corner of the first user interface object to an upper left corner of the second user interface object; a lower right corner of the intermediate object corresponds to a transition between a lower right corner of the first user interface object to a lower right corner of the second user interface object; and/or a top portion of the intermediate object corresponds to a transition between a top portion of the first user interface object and a top portion of the second user interface). In some embodiments, the first edge portion of the first user interface object has a first radius of curvature. In some embodiments, the second edge portion of the second user interface object has a second radius of curvature (e.g., that is different from the first radius of curvature or is the same as the first radius of curvature). In some embodiments, the edge portion of the intermediate object has a third radius of curvature that is greater than the first radius of curvature and the second radius curvature. In some embodiments, a sharp corner has a small radius of curvature, a straight portion of an edge has an infinite or a predefined maximum radius of curvature, a curved portion between a straight portion and a sharp corner has an intermediate radius of curvature. In some embodiments, the intermediate object has a more rounded shape or corners, compared to the first user interface object and the second user interface object, and thus has an intermediate radius of curvature between the radii of curvature for the corresponding corners and/or edges of the first and second user interface objects. For example, as described with reference to FIG. 5T, transitional platter 814-2 is displayed with a more rounded shape than platter 810.

In some embodiments, the first user interface object has a first set of values for a first display property (e.g., color, brightness, color temperature, and/or other display properties). In some embodiments, the second user interface object has a second set of values for the first display property that are different from the first set of values for the first display property (e.g., the second user interface object has a different set of colors, different brightness, different color temperatures compared to the first user interface object). In some embodiments, displaying the first user interface material in the intermediate object includes displaying the intermediate object with a set of intermediate values for the first display property that corresponds to a transition between the first set of values and the second set of values for the first display property. In some embodiments, the first user interface object has a black platter, the second user interface object has a white platter, and the intermediate object has a gray platter. In an example, the first user interface object has a set of warm colors (e.g., red, orange, and yellow hues), the second user interface object has a set of cool colors (e.g., blue, purple, and dark green), and the intermediate object has a set of neutral colors that corresponds to a transition between the set of warm colors and the set of cool colors (e.g., muted yellow green, blue green, and brown). In an example, the first user interface object has a red tone, the second user interface object has a brown tone, and the intermediate object has a red brown tone that corresponds to a transition between the red tone and the brown tone. For example, as described with reference to FIGS. 5R-5V, the transitional platters 914-1 through 814-3 are optionally displayed with a different color than platter 810 and/or platter 816-1.

In some embodiments, displaying the animated changes to the first user interface material in the first dimension and the second dimension includes increasing a size of the first user interface material in the first dimension, and decreasing a size of the first user interface material in the second dimension. In some embodiments, the animated changes of the first user interface material change the height and width of the first user interface material in different directions (e.g., enlarging the first user interface material in one direction, and shrinking the first user interface material in another direction), thereby changing an aspect ratio of the first user interface material during the animated transition from the first user interface object to the second user interface object. For example, transitional platter 814-3 (e.g., in FIG. 5U1) is stretched relative to transitional platter 814-2 by different amounts (and/or different directions) along the x-axis and the y-axis.

In some embodiments, displaying the animated changes to the first user interface material includes changing an appearance of the first user interface material (e.g., changing shape, size, length, width, thickness, height, translucency, blur, luminance, color, texture, simulated refraction, simulated reflection, simulated shadow, and/or other aspects of the appearance of the first user interface material) to simulate a first type of physical response of a material to external interaction (e.g., simulating physical deformation of a material in response to external force, physical vibration in response to external disturbance, and/or other types of physical responses to external interactions) based on a first simulated material property of the material (e.g., inertia, mass, weight, elasticity, stiffness, spring constant, plasticity, damping constant, and/or other types of material properties). For example, as described with reference to FIG. 5U1, the transitional platter 814-3 is stretched non-uniformly to display the transitional platter 814-3 with a simulated gel-like or amorphous appearance during the animation for transitioning platter 810 to platter 816-1.

In some embodiments, changing the appearance of the first user interface material to simulate the first type of physical response of a material to external interaction based on the first simulated material property of the material includes concurrently displaying, via the one or more display generation components, a first change to the appearance of the first user interface material (e.g., a first amount of change in size, a first rate of change in size, a first change in color, a first change in simulated reflection, a first change in simulated refraction, a first change in texture, a first change in blur radius, and/or a first change in other aspects of the appearance) to simulate a first amount of response for the first type of physical response in the first dimension, and a second change to the appearance of the first user interface material (e.g., a second amount of change in size, a second rate of change in size, a second change in color, a second change in simulated reflection, a second change in simulated refraction, a second change in texture, a second change in blur radius, and/or a second change in other aspects of the appearance) to simulate a second amount of response for the first type of physical response in the second dimension. In some embodiments, the second change to the appearance of the first user interface material is different from the first change to the appearance of the first user interface material. In some embodiments, a different between the first change to the appearance of the first user interface material and the second change to the appearance of the first user interface material, simulates a difference between the first amount of response in the first dimension and the second amount of response in the second dimension (e.g., a difference in inertia, mass, weight, elasticity, stiffness, spring constant, plasticity, damping constant, and/or other types of material properties in the first and second dimensions). In some embodiments, the first user interface material is shown to change differently (e.g., change by different amounts, in different directions, and/or change in different visual properties) in different dimensions of the first user interface material in response to the first user input, to simulate different material properties of the first user interface material (e.g., different values for inertia, mass, weight, elasticity, stiffness, spring constant, plasticity, damping constant, and/or other types of material properties, for the first user interface material) in the different dimensions. For example, as described with reference to FIGS. 5U2, a change in size (e.g., height and/or width) and/or shape of the platter causes a different amount of distortion of the background content.

In some embodiments, detecting the first user input includes detecting a user input that is directed to a portion of the first user interface outside of the first user interface object. In some embodiments, the first user input includes a tap gesture, an air pinch gesture, a click input, and/or another type of selection input directed to an indicator and/or precursor object that corresponds to the second user interface object and that is displayed concurrently with (e.g., adjacent to or spaced apart from) the first user interface object. In an example, the first user input is an input that is directed to a portion of the first user interface that corresponds to a control to navigate to another user interface that includes the second user interface object and that does not include the first user interface object. In a more specific example, when displaying a user interface that includes a platter (e.g., the first user interface object) containing content of a currently displayed email message, concurrently with a control for composing a reply to the currently displayed message, the computer system detects an input directed to the control; and in response, the computer system transforms the first user interface material of the platter into a new platter that includes a template of a reply message. For example, as described with reference to FIG. 5R, the device 100 detects an input directed outside of the platter 810 that causes the device 100 to update the user interface 802, including transitioning platter 810 to platter 816-1.

In some embodiments, detecting the first user input includes detecting, via the one or more input devices, a user input that is directed to a portion of the first user interface object. In some embodiments, the first user input includes a tap gesture, an air pinch gesture, a click input, and/or another type of selection input directed to the first user interface object. In an example, the first user input is an input that is directed to a portion of the first user interface object that corresponds to a control to navigate to another user interface that includes the second user interface object and/or to display the second user interface object in the first user interface. In a more specific example, when displaying a user interface that includes a menu (e.g., the first user interface object) containing one or more selectable options, the computer system detects an input directed to one of the selectable options, and in response, the computer system transforms the first user interface material of the menu into a new platter that includes content corresponding to the selected option. In some embodiments, in response to detecting the user input that is directed to the portion of the first user interface object, the computer system displays, via the one or more display generation components, a change in appearance (e.g., due to changes in simulated refraction, blur radius, and/or other simulated material and/or spatial properties) of the first user interface material (e.g., that simulates a response of the first user interface material to a physical interaction between the user input and the first user interface material, such simulated inertia, simulated flexibility, simulated spring constant, and/or simulated damping constant of the first user interface material; and/or other types of visual feedback to the user input), prior to transforming the first user interface object into the second user interface object (e.g., prior to displaying the animated changes of the first user interface material in the first dimension and the second dimension toward the second user interface object). For example, as described with reference to FIG. 5R, in some embodiments, in response to detecting a user input 812, one or more visual properties of the simulated glass material of platter 810 are updated such that the platter 810 appears reactive to the user input 812.

In some embodiments, displaying the first user interface object that is visually associated with the first user interface material with the first boundary includes displaying the first user interface material with an appearance that simulates refraction of content of the first user interface object (and, optionally, refraction of content that is near and/or adjacent the first user interface object) in accordance with one or more spatial properties of the first boundary. Similarly, in some embodiments, displaying the second user interface object that is visually associated with the first user interface material with the second boundary includes displaying the first user interface material with appearances that simulate refraction of content of the second user interface object (and, optionally, refraction of content that is near and/or adjacent the second user interface object) in accordance with one or more spatial properties of the second boundary. In some embodiments, displaying one or more intermediate objects that are visually associated with the first user interface material during the transformation from the first user interface object to the second user interface object) includes displaying the first user interface material with appearances that simulate refraction of intermediate content of the intermediate objects (and, optionally, refraction of content that is near and/or adjacent the intermediate objects) in accordance with one or more spatial properties of the boundaries of the intermediate objects. For example, as described with reference to FIG. 5V, platter 810 is displayed as a simulated glass material.

In some embodiments, displaying the first user interface material with the appearance that simulates refraction of the content of the first user interface object (and, optionally, refraction of the content that is near and/or adjacent the first user interface object) in accordance with one or more spatial properties of the first boundary, includes, displaying the first user interface material with an appearance that simulates a lensing effect of the first user interface material that is based on a visual distortion of the content of the first user interface object (and, optionally, that is based on a visual distortion of the content that is near and/or adjacent the first user interface object). Similarly, in some embodiments, displaying the first user interface material with the appearance that simulates refraction of the content of the second user interface object (and, optionally, refraction of the content that is near and/or adjacent the second user interface object) in accordance with one or more spatial properties of the second boundary, includes, displaying the first user interface material with an appearance that simulates a lensing effect of the first user interface material that is based on a visual distortion of the content of the second user interface object (and, optionally, that is based on a visual distortion of the content that is near and/or adjacent the second user interface object). Similarly, in some embodiments, displaying the first user interface material with the intermediate appearances that simulate refraction of the content of the intermediate objects (and, optionally, refraction of the content that is near and/or adjacent the intermediate objects) in accordance with one or more spatial properties of the boundaries of the intermediate objects, includes, displaying the first user interface material with appearances that simulate a lensing effect of the first user interface material that are based on visual distortions of the content of the intermediate objects (and, optionally, that include visual distortion of the content that is near and/or adjacent the intermediate objects). For example, as described with reference to FIGS. 6A-6B4, the simulated glass material includes a lensing effect.

In some embodiments, displaying the first user interface material with the appearance that simulates refraction of the content of the first user interface object (and, optionally, refraction of the content that is near and/or adjacent the first user interface object) in accordance with one or more spatial properties of the first boundary, includes, displaying the first user interface material with an appearance that is based on a blurring effect applied to the content of the first user interface object. Similarly, in some embodiments, displaying the first user interface material with the appearance that simulates refraction of the content of the second user interface object in accordance with one or more spatial properties of the second boundary, includes displaying the first user interface material with an appearance that is based on a blurring effect applied to the content of the second user interface object. Similarly, in some embodiments, displaying the first user interface material with the intermediate appearances that simulate refraction of the content of the intermediate objects in accordance with one or more spatial properties of the boundaries of the intermediate objects, includes displaying the first user interface material with appearances that are based on blurring effects applied to the content of the intermediate objects. For example, as described with reference to FIGS. 6A-6B4, the simulated glass material includes a blurring effect.

In some embodiments, transforming the first user interface object into the second user interface object includes displaying, via the one or more display generation components, the first user interface material with a first intermediate appearance followed by displaying, via the one or more display generation components, the first user interface material with a second intermediate appearance (e.g., and one or more additional intermediate appearances until the first user interface material has completed the transition into the shape of the second user interface object). In some embodiments, the first intermediate appearance has a first set of values for one or more simulated properties of the first user interface material (e.g., the first intermediate appearance has a first amount and/or spatial distribution of blur, a first amount and/or spatial distribution of simulated refraction, a first amount and/or spatial distribution of distortion applied to underlying content, a first amount and/or spatial distribution of simulated reflection, and/or a first amount and/or spatial distribution of values for another simulated property of the first user interface material). In some embodiments, the second intermediate appearance has a second set of values for the one or more simulated properties of the first user interface material (e.g., the second intermediate appearance has a second amount and/or spatial distribution of blur, a second amount and/or spatial distribution of simulated refraction, a second amount and/or spatial distribution of distortion applied to underlying content, a second amount and/or spatial distribution of simulated reflection, and/or a second amount and/or spatial distribution of values for another simulated property of the first user interface material). In some embodiments, the second set of values for the one or more simulated properties of the first user interface material is different from (e.g., differing in values and/or differing in spatial distribution of values) the first set of values for the one or more simulated properties of the first user interface material (and, optionally, differing in simulated properties that affect the appearance of the first user interface material). In some embodiments, during the animated transition from the first user interface object to the second user interface object, the first user interface material goes through a plurality different intermediate shapes with different intermediate appearances. In some embodiments, the different shapes (e.g., different simulated thickness, different geometric and/or organic shapes, and/or different sizes in one or more dimensions) of the first user interface material cause and/or are represented by different amounts, degrees, and/or spatial distributions of the visual changes (e.g., blur, content distortion, specular highlights, simulated chromatic aberration, simulated shadow, and/or other visual changes to the content embedded within the first user interface material, and, optionally to content near and/or adjacent to the first user interface material) to the first user interface material based on the simulated properties (e.g., simulated refraction, reflection, opacity, deformation, inertia, spring constant, damping and/or other simulated properties) of the first user interface material. For example, as described with reference to FIG. 5U2, the transitional platters 814-1 through 814-3 are updated to change values of one or more visual properties of the simulated glass material.

In some embodiments, displaying the first user interface object that is visually associated with the first user interface material with the first boundary includes displaying the first user interface material with an appearance that simulates refraction of content of the first user interface object in accordance with one or more spatial properties of the first boundary, and simulates refraction of content that is surrounding the first user interface object (e.g., content that is near and/or adjacent the first user interface object, and/or within a threshold distance from the first boundary of the first user interface object), in accordance with one or more spatial properties of the first boundary. Similarly, in some embodiments, displaying the second user interface object, and displaying the one or more intermediate objects during the transition from the first user interface object to the second user interface object includes displaying the first user interface material with appearances that simulate refraction of content of the currently displayed intermediate object or the second user interface object, and that simulate refraction of content that is surrounding (e.g., near and/or adjacent to, and/or within a threshold distance from the boundary of) the currently displayed intermediate object or the second user interface object. For example, as described with reference to FIGS. 6A-6B4, the simulated glass material is based on both internal refraction and external refraction.

In some embodiments, transforming the first user interface object into the second user interface object includes displaying, via the one or more display generation components, a first intermediate object that is visually associated with the first user interface material followed by displaying a second intermediate object that is visually associated with the first user interface material. In some embodiments, the first intermediate object has an appearance that indicates the first function. In some embodiments, the second intermediate object has an appearance that indicates the second function, different from the appearance that indicates the first function. In some embodiments, the intermediate objects displayed during the transformation of the first user interface object into the second user interface objects gradually changes appearance from indicating the first function associated with the first user interface object to indicating the second function associated with the second user interface object (e.g., in addition to changing the material appearance, the intermediate objects also change in content to indicate the change in function associated with the user interface object). In some embodiments, the changing appearance to indication the change in function of the user interface object can be based on a change in the size and/or shape of the user interface object, and/or a change in the tint, text, and/or glyph included within the user interface material of the user interface object. For example, the controls in platter 810 (e.g., in FIG. 5R) are different from the controls provided in platter 816-1 (e.g., in FIG. 5V).

In some embodiments, the first user interface object is of a first object type, and the second user interface object is of a second object type different from the first object type. For example, in some embodiments, the first user interface object and the second user interface object respectively correspond to different object types including application icon, widget, dock including multiple application icons, control, selectable option, menu including multiple selectable items, text input field, window, sheet, notification, alert, and/or other object types. In some embodiments, the first object type corresponds to a unitary object and the second object type corresponds to a container object that includes other objects, or vice versa. In some embodiments, the first object type corresponds to non-interactive content and the second object type corresponds to an interactive control, or vice versa. In some embodiments, the first object type corresponds to a tool bar and the second object type corresponds to a window, or vice versa. For example, in FIG. 5R, the platter 810 corresponds to a set of controls for the mail application, and in FIG. 5V, the platter 816-1 includes a menu of controls. In some embodiments, a first type of user interface object is optionally morphed into another type of user interface object (e.g., button 726-1 optionally morphs into keyboard 734-3 and/or into the compose region of composition user interface 736 (e.g., in FIG. 5Q).

In some embodiments, transforming the first user interface object into the second user interface object in response to detecting the first user input includes, in accordance with a determination that the first user input is a first type of input (e.g., the first type of input includes discrete inputs, inputs detected using a first input device, stationary inputs, inputs that that do not meet a duration threshold, input that does not meet an intensity threshold, and/or inputs that meet a first set of conditions), displaying, via the one or more display generation components, a first set of animated changes of the first user interface material in accordance with the first user input (e.g., animated changes that go through a first set of intermediate objects, animating in a first direction, animating with a first rate of changes in one or more display properties, and/or based on a first set of values for one or more simulated material properties). In some embodiments, transforming the first user interface object into the second user interface object in response to detecting the first user input includes, in accordance with a determination that the first user input is a second type of input, different from the first type of input (e.g., the second type of input includes continuous inputs, inputs detected using a second input device different from the first input device, movement inputs, inputs that that meet the duration threshold, input that meet the intensity threshold, and/or inputs that meet a second set of conditions different from the first set of conditions), displaying, via the one or more display generation components, a second set of animated changes of the first user interface material in accordance with the first user input, the second set of animated changes differing from the first set of animated changes (e.g., animated changes that go through a second set of intermediate objects different from the first set of intermediate objects, animating in a second direction different from the first direction, animating with a second rate of changes in one or more display properties that are different from the first rate of changes, and/or based on a second set of values for one or more simulated material properties that are different from the first set of values for the one or more simulated material properties). In some embodiments, in accordance with a determination that the first user input is a tap gesture, an air pinch gesture, a click input, and/or another type of input that are discrete inputs that are terminated before a threshold amount of time from the start of the first user input, the computer system displays a sequence of animated changes that transitions through a plurality of intermediate shapes with substantially uniform rates in respective dimensions of the first user interface material; and in accordance with a determination that the first user input is a touch and hold gesture, a swipe gesture, an air pinch and drag gesture, a click and hold input, a click and drag input, and/or another type of input that is continuous and that does not need to be terminated before a threshold amount of time from the start of the first user input (e.g., can be paused, continued, and/or terminated at a user-specified time independent of a duration threshold, and/or after the duration threshold for a discrete input), the computer system displays a sequence of animated changes that transitions through a plurality of intermediate shapes with varying rates in one or more dimensions, optionally, based on current and/or cumulated values of one or more characteristics of the first user input (e.g., current or average movement speed, movement distance, duration, current location of the first user input, and/or other variable parameters of the first user input); and/or based on a termination of the first user input (e.g., location, time, distance, speed, and/or other characteristics of the first user input at the termination of the first user input). For example, as described with reference to FIGS. 5R-5V, in some embodiments, the animation for reusing platter 810 as platter 816-1 is based at least in part on a type of input detected. In some embodiments, a first animation is displayed in accordance with a determination that the user input is a tap input, a touch input, or another first type of input and a second animation different from the first animation is displayed in accordance with a determination that the user input is a long press, a click input (e.g., via a mouse or other external input device), or another second type of input different from the first type of input.

In some embodiments, displaying the first set of animated changes of the first user interface material in accordance with the first user input includes displaying a first amount of changes (e.g., a first amount of changes in size, position, simulated thickness, simulated refraction, and/or other visual properties) in the first user interface material in accordance with the first user input. In some embodiments, displaying the second set of animated changes of the first user interface material in accordance with the first user input includes displaying a second amount of changes (e.g., a second amount of changes in size, position, simulated thickness, simulated refraction, and/or other visual properties), different from the first amount of changes, in the first user interface material in accordance with the first user input. In some embodiments, the computer system displays a response with different magnitudes for different types of inputs. In one example, the computer system displays a first amount of simulated deformation in a first dimension (e.g., optionally, causing and/or is represented by a first amount of changes in simulated refraction, blur, and/or other visual properties) for a touch input directed to the first user interface object, and displays a second amount of simulated deformation, different from the first amount of deformations, in the first dimension (e.g., optionally, causing and/or is represented by a second amount of changes, different from the first amount of change, in simulated refraction, blur, and/or other visual properties) for a click input directed to the first user interface object. For example, as described with reference to FIGS. 5R-5V, in some embodiments, the first animation includes modifying a shape and/or other properties of the simulated glass material of the transitional platters by a first amount and the second animation includes modifying a shape and/or other visual properties of the simulated glass material of the transitional platters by a second amount different from the first amount.

In some embodiments, displaying the first set of animated changes of the first user interface material in accordance with the first user input includes displaying the first set of animated changes with a first degree of correspondence (e.g., a first degree of damping, constraints, lag, and/or other types of correspondence in magnitude, timing, and/or location) to a first property of the first type of input (e.g., location, distance, magnitude, duration, and/or another property of the first type of input that is also associated with the second type of input). In some embodiments, displaying the second set of animated changes of the first user interface material in accordance with the first user input includes displaying the second set of animated changes with a second degree of correspondence (e.g., a second degree of damping, constraints, lag, and/or other types of correspondence in magnitude, timing, and/or location) to the first property of the second type of input (e.g., location, distance, magnitude, duration, and/or another property of the second type of input that is also associated with the first type of input), different from the first degree of correspondence. In some embodiments, the computer system displays a response with different amounts of damping for different types of inputs. In one example, the computer system displays an excess amount of simulated deformation in a first dimension (e.g., optionally, causing and/or is represented by an excess amount of changes in simulated refraction, blur, and/or other visual properties) beyond that required for the second user interface object before the termination of the first user input, and then reverses the excess amount of change in an animated transition (e.g., in a rubber banding effect, and/or damped oscillation effect) to arrive at the second user interface object in a steady state. In some embodiments, the second user interface object is displayed in the steady state within a first amount of time (e.g., longer than the first amount of time, or shorter than the first amount of time) after the termination of the first user input if the first user input is of the first input type (e.g., a click input, or a stationary input), and within a second amount of time after the termination of the first user input if the first user input of the second input type (e.g., a touch input as opposed to a click input, or a movement input as opposed to a stationary input). For example, as described with reference to FIGS. 5R-5V, in some embodiments, a timing and/or amount of damping of the transitional platters is different for the first animation and the second animation, based on the type of input.

In some embodiments, the first user interface includes a navigation control that is visually associated with the first user interface material (e.g., a “back” button, a “home” button, and/or an “level up” button that are visually associated with the first user interface material confined by a boundary of the navigation control), and two or more section headers (e.g., section headers for different letters of the alphabet in a contact list, section headers for different time periods in an email inbox, section headers for different senders or message threads in a message listing, and/or section headers for different notes categories in a listing of notes, optionally visually associated with other user interface materials different from the first user interface material). In some embodiments, the navigation control corresponds to a navigation operation from first content included the first user interface to second content different from the first content (e.g., selection of the navigation control causes the computer system to navigate from the first user interface displaying the first content to another user interface displaying the second content, and/or navigating to a higher level user interface in a hierarchy of user interfaces). In some embodiments, the first content includes two or more sections corresponding to the two or more section headers (e.g., sections for contacts that start with different letters of the alphabet, sections for emails received in different time periods in an email inbox, sections for messages from different senders or message threads in a message listing, and/or sections for different notes categories in a listing of notes). In some embodiments, detecting, via the one or more input devices, the first user input includes detecting a user input that corresponds to a request to scroll the first content (e.g., a swipe gesture directed to the first content, a click and hold input directed to a scroll control, and/or other types of user input that causes the first content in the first user interface to scroll relative to the display area provided via the one or more display generation components). In some embodiments, in response to detecting the user input that corresponds to the request to scroll the first content, and in accordance with a determination that a first section header of the two or more section headers is outside a threshold distance of the navigation control, moving the first section header (e.g., along with the content corresponding to the first section control) relative to the navigation control (e.g., while the computer system maintains display of the navigation control, moving the first section header toward the navigation control in accordance with the first user input). In response to detecting the user input that corresponds to the request to scroll the first content, and in accordance with a determination that the first section header of the two or more section headers has been moved to a location within the threshold distance of the navigation control, the computer system changes a boundary of the first user interface material of the navigation control to include the first section header (e.g., merging the navigation control and the first section header into an merged object that is visually associated with the first user interface material and, optionally, combining the visual indications corresponding to the navigation control and the first section header, such as the text, symbols, and/or graphics respectively contained in the navigation control and the first section header, and/or some variations thereof, into the first user interface material). In some embodiments, the first user interface includes a listing of contacts, with a navigation control at the top and one or more section headers corresponding to different sections of contact entries, and in response to a user input that scrolls the list of contacts, the computer system moves the different sections of contact entries toward the navigation control along with their corresponding sections of contact entries in accordance with the user input; and when a section header of a section of the contact entries reaches within a threshold distance of the navigation control due to the movement of the section headers and the corresponding contact entries, the computer system expands or shrinks the first user interface material of the navigation control to absorb the content of the first section header, such that a merged object that is visually associated with the first user interface material now corresponds to both the navigation control and the first section header (e.g., includes the indication of the navigation control and the indication of the first section header), while the contact entries corresponding to the first section header continues to scroll behind and/or underneath the first user interface material of the combined object. For example, as described with reference to FIGS. 5Q3-5Q6, in some embodiments, the back button 752 is resized to incorporate the “Camera” header 756 into the button 752.

In some embodiments, the first user interface object corresponds to the navigation control without corresponding to the first section header. In some embodiments, the second user interface object corresponds to the first user interface material encompassing the navigation control and the first section header (e.g., the navigation control and the first section header are optionally non-interactive when in the combined object that is visually associated with the first user interface material). In some embodiments, the navigation control and the first section header optionally still respond to user inputs to perform their corresponding functions when in the combined object that is visually associated with the first user interface material. In some embodiments, in response to detecting the user input that corresponds to the request to scroll the first content, and in accordance with a determination that the first section header is combined with the navigation control into the second user interface object that is visually associated with the first user interface material, the computer system displays, via the one or more display generation components, an animated optical distortion effect of the first content in a portion of the first user interface material corresponding to the first section header (e.g., displaying an animated optical distortion effect of the contact entries of a contact list, email entries of a listing of emails, and/or other types of content in the first user interface), as the first content is scrolled past the portion of the first user interface material corresponding to the first section header. In some embodiments, when the first section header is merged into the first user interface material of the navigation control, the portion of the first user interface material corresponding to the first section header is shown to produce simulated refraction of the content that is scrolling past the portion of the first user interface material (e.g., distorts the appearance of the contact entries that are scrolling underneath the first user interface material, past the portion of the first user interface material corresponding to the first section header). More details related to the merging of the navigation control and the first section header are provided with respect to FIGS. 6I-6T and method 15000. For example, as described with reference to FIG. 5Q3, an optical distortion of the text “camera” is displayed as the text is animated as being incorporated into the button 752″. In some embodiments, as described with reference to FIGS. 6H, incorporating the section header of “A” includes displaying optical distortion (e.g., blurring) background content that passes behind the section header.

In some embodiments, detecting the first user input includes detecting an increase in a value for a first characteristic of the first user input (e.g., detecting an increase in a movement distance of a swipe gesture, detecting an increase in movement distance of a click and drag input, detecting an increase in duration of a touch and hold gesture, detecting an increase in intensity of a press input, and/or detecting an increase in a characteristic value of an input that is the first type of input). In some embodiments, displaying the animated changes to the first user interface material in the first dimension and the second dimension includes, in accordance with a determination that the increase in the value for the first characteristic of the first user input is below a first threshold value (e.g., below a threshold movement distance, below a threshold movement speed, below a threshold magnitude, before reaching a threshold position, and/or before meeting another type of threshold), and that the value for the first characteristic of the first user input is a first value, changing an appearance of the first user interface object based on content near (e.g., under or adjacent to) the first user interface object without changing properties of the first user interface material (e.g., before value of the first characteristic of the first user input meets the first threshold value, and/or before the first user input meets the requirements for changing from the first user interface object to the second user interface object, the appearance of the first user interface object changes based on the changes in the underlying content, while the simulated optical and material properties of the first user interface material remain unchanged). In some embodiments, displaying the animated changes to the first user interface material in the first dimension and the second dimension includes, in accordance with a determination that the increase in the value for the first characteristic of the first user input is below the first threshold value, and that the value for the first characteristic of the first user input is a second value different from the first value, changing the appearance of the first user interface object based on content near (e.g., under or adjacent to) the first user interface object without changing properties of the first user interface material (e.g., before value of the first characteristic of the first user input meets the first threshold value, and/or before the first user input meets the requirements for changing the state of the first user interface object, the appearance of the first user interface object changes based on changes in the underlying content, while the simulated optical and material properties of the first user interface material remain unchanged). In some embodiments, displaying the animated changes to the first user interface material in the first dimension and the second dimension includes, in accordance with a determination that the increase in the value for the first characteristic of the first user input is at or above the first threshold value (e.g., above the threshold movement distance, above the threshold movement speed, above the threshold magnitude, after reaching the threshold position, and/or after meeting another type of threshold), changing the appearance of the first user interface object based on content near (e.g., under or adjacent to) the first user interface object and based on one or more changes to the first user interface material that transform the first user interface material into the second user interface object (e.g., the first user interface material snaps to the state corresponding to the shape of the second user interface object, independent of the exact value of the first characteristic of the first user input). In some embodiments, when navigating between states based on a gradual user input (e.g., a swipe gesture, a pinch and drag gesture, a click and drag input, a press input, and/or other types of gradual input that includes an increase in value for a first characteristic of the input), the user interface material of the first user interface object snaps between states (e.g., a larger state and a smaller state, and/or the state that corresponds to the first user interface object and the state that corresponds to the second user interface object) when a threshold is reached by the input (optionally, with hysteresis so that when the first user interface material has snapped from the first state to the second state (or vice versa), a greater change in the value of the first characteristic of the same type of input (e.g., more than a threshold amount of movement in the same or reverse direction, more than a threshold amount of intensity, and/or more than a threshold amount of time) is required to switch from the second state back to the first state (or vice versa). For example, as described with reference to FIGS. 5Z1-5Z3, in some embodiments, the swipe gesture (e.g., input 924-1) to move the selection indicator from “All” to “Months” requires less movement of the user input than a swipe gesture to move the selection back from “Months” to “All,” where the selection indicator snaps to a respective selection.

It should be understood that the particular order in which the operations in FIG. 10 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 11000, 12000, 13000, 14000, 15000, 16000, 17000, 18000, 19000, and/or 20000) are also applicable in an analogous manner to method 10000 described above with respect to FIG. 10. For example, the buttons, user interfaces, controls, visual deemphasis, virtual effects, an/or animations described above with reference to method 10000 optionally have one or more of the characteristics of the buttons, user interfaces, controls, visual deemphasis, virtual effects, an/or animations described herein with reference to other methods described herein (e.g., methods 7000, 8000, 9000, 11000, 12000, 13000, 14000, 15000, 16000, 17000, 18000, 19000, and/or 20000). For brevity, these details are not repeated here.

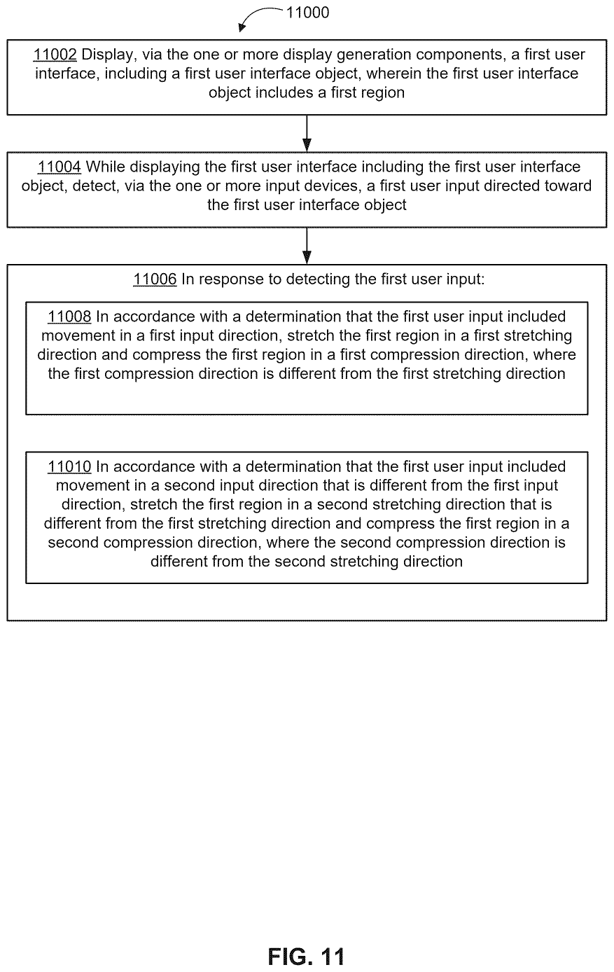

FIG. 11 is a flow diagram illustrating a method 11000 of stretching and/or smashing a user interface element in accordance with some embodiments. The method 11000 is performed at a computer system (e.g., device 300, FIG. 3A, or portable multifunction device 100, FIG. 1A) that is in communication with one or more input devices and one or more display generation components. In some embodiments, the one or more display generation components are touch-screen displays which optionally include one or more touch-sensitive surfaces integrated with one or more of the display generation components. In some embodiments, one or more of the display generation components are separate from one or more of the touch-sensitive surfaces. Some operations in method 11000 are, optionally, combined and/or the order of some operations is, optionally, changed.

Stretching and/or smashing at least a portion of a user interface object in response to detecting a user input directed to the user interface object leverages the user's real world experience by simulating physical responsiveness of the user interface object. Displaying responsiveness of the user interface object provides information about the spatial relationships between the user interface elements, provides visual feedback regarding the effect of user input, and guides the user about how to use his/her input to change the system state and/or application state. Using responsive materials for user interface elements improves the responsiveness of user interface elements to inputs, which enables a user to use a device for shorter periods of time, which saves energy and improves battery life. Automatically changing an appearance of user interface elements (e.g., changing a size and/or shape of user interface elements) when one or more criteria are met reduces the number of inputs (e.g., navigating through settings user interfaces and menus to set the values for parameters to adjust the size and/or shape of user interface elements) that would otherwise be required to generate a similar effect, which saves energy and improves battery life.

The computer system displays (11002), via the one or more display generation components, a first user interface, including a first user interface object (e.g., a first content object, a first indicator, a first control corresponding to a first control function of the computer system, and/or a first user interface object that, in response to an input directed toward the first user interface object, causes the computer system to perform a first operation, such as displaying another user interface object, optionally, in a second user interface different from the first user interface), wherein the first user interface object includes a first region (e.g., the first user interface object includes a region that is visually associated with or “made of” a user interface material and/or a simulated material). In some embodiments, the first user interface object is a button, an affordance, a toggle, a slider, a tool bar, a dock, a popup, a window, and/or another type of user interface object that has content embedded within and/or on the surface of a user interface material, such as a background material, a texture, and/or a simulated glassy, translucent, and/or gelatinous material, with a simulated three-dimensional volume defined by a first boundary, such as outlines and bounding surfaces of the simulated three-dimensional volume in two or more dimensions. In some embodiments, the first region corresponds to an area and/or volume of the user interface material that forms and/or is included in the first user interface object. For example, as described with reference to FIG. 5V, platter 816-1 is displayed.

While displaying the first user interface including the first user interface object (e.g., with the first user interface object including the first region), the computer system detects (11004), via the one or more input devices, a first user input directed toward the first user interface object (e.g., a touch gesture, an air gesture, a point and click input, an actuation and/or manipulation of a hardware control, and/or other types of input that targets the first user interface object based on a location of the first user interface object and/or the currently selected state of the first user interface object). In some embodiments, a touch gesture targets an object based on a location of a contact on a touch-sensitive surface that corresponds to the display location of the object. In some embodiments, an air gesture targets an object based on a location of the user's attention, e.g., based on the location of the hand that provides the air gesture and/or a location of a gaze of the user, that corresponds to the location of the object. In some embodiments, a point and click input targets an object based on a location of a cursor that corresponds to the location of the object. In some embodiments, the first user interface object is the target of an input when the first user interface object is a currently selected object and has input focus at the time when the input is detected (e.g., when a hardware control is actuated and/or manipulated; and/or when another type of input device detects the first user input). In some embodiments, the first user input includes a movement of the first user input. In some embodiments, the first user input is substantially stationary and does not include a movement of the first user input (e.g., the location of the input does not change by more than a threshold amount in a unit of time).

In response to detecting (11006) the first user input (e.g., while the first user input is ongoing and/or maintained, and optionally, within a threshold amount of time after detecting a termination of the first user input), and in accordance with a determination that the first user input included movement in a first input direction (e.g., the first user input targets a first portion of the first user interface object at the start of the first user input and/or is moving in a first direction relative to the first user interface object), the computer system stretches (11008) (e.g., increases a size of, and/or elongates) the first region in a first stretching direction and compresses (e.g., decreases a size of, and/or shrinks) the first region in a first compression direction, where the first compression direction is different from the first stretching direction (e.g., the first region is deformed in a first manner, with a first change in aspect ratio and/or shape, in accordance with the first input direction).

In response to detecting (11006) the first user input (e.g., while the first user input is ongoing and/or maintained, and optionally, within a threshold amount of time after detecting a termination of the first user input), and in accordance with a determination that the first user input included movement in a second input direction that is different from the first input direction (e.g., the first user input targets a second portion, different from the first portion, of the first user interface object at the start of the first user input and/or is moving in a second direction, different from the first direction, relative to the first user interface object), the computer system stretches (11010) (e.g., increases the size of, and/or elongates) the first region in a second stretching direction that is different from the first stretching direction and compresses (e.g., reduces a size of, and/or shrinks) the first region in a second compression direction, where the second compression direction is different from the second stretching direction (e.g., the first region is deformed in a second manner different from the first manner, with a second change in aspect ratio and/or shape different from the first change in aspect ratio and/or shape, in accordance with the second input direction). In some embodiments, in response to detecting the first user input, the computer system adjusts a first boundary of the first user interface object (e.g., changing the sizes and positions of the outlines and/or surfaces of the first user interface material of the first user interface object in two or more dimensions, without changing the first user interface object into another user interface object that corresponds to a different function), including displaying, via the one or more display generation components, animated changes in a size of the first user interface material in a first dimension (e.g., a respective dimension of width, height, thickness, radius, and/or other spatial dimensions) and animated changes in a size of the first user interface material in a second dimension (e.g., another respective dimension of width, height, thickness, radius, and/or other spatial dimensions). In some embodiments, displaying the animated changes in the size of the first user interface material in the first dimension includes: during a first period of time of adjusting the first boundary of the first user interface object (e.g., at a beginning period of time, an intermediate period of time, a final period of time, of a unit of time, and/or at a respective moment in time), changing a size of a first portion of the first user interface material along the first dimension by a first amount of change, and changing a second portion of the first user interface material along the first dimension by a second amount of change that is different from the first amount of change (e.g., the different amounts of change applied to different portions of the first user interface material during a respective period of time causes the first simulated material to stretch and/or compress by different amounts at different locations along the first user interface material in a first direction corresponding to the first dimension of the first user interface material). In some embodiments, displaying the animated changes in the size of the first user interface material in the second dimension includes, during the first period of time of adjusting the first boundary of the first user interface object, changing a size of a third portion of the first user interface material along the second dimension by a third amount of change, and changing a size of a fourth portion of the first user interface material along the second dimension by a fourth amount of change that is different from the third amount of change. In some embodiments, the different portions of the first user interface object stretch by different amounts along a respective dimension of the first user interface object, such as by greater amounts closer to the location of the input and smaller amounts farther away from the location of the input, to simulate a variable internal material structure of the first user interface object (e.g., variable modulo, variable density, and/or other simulated material properties) that affects the simulated stretchiness and/or squishiness of the first user interface material. For example, as described with reference to FIG. 5V, in response to detecting the user input 903 and/or the user input 902-1, that includes movement in a first direction, the platter 816-2 is stretched along the y-axis, as illustrated in FIG. 5W; and in response to detecting the user input 904-1 (e.g., in FIG. 5X) that includes movement in a second direction, the platter 816-3 is stretched along the x-axis.

In some embodiments, detecting the first user input directed toward the first user interface object includes detecting a drag input that includes movement in a respective direction while the first user interface object is selected as a target of the drag input (e.g., previously selected by a separate selection input and remains selected after the termination of the selection input, has current input focus, selected by an initial portion of the drag input based on a starting location of the drag input, and/or selected by an input indicating a location of a user's attention at the first user interface object). In some embodiments, a swipe gesture performed by a contact detected at a location of a touch-sensitive surface that corresponds to the first user interface object and/or a portion of the first user interface object (e.g., a grabber or a move handle of the first user interface object, a portion of the first user interface object that is not occupied by another user interface object, and/or an interior portion of the first user interface object), causes the computer system to stretch the first user interface material of the first user interface object in a first direction that corresponds to the input direction of the swipe gesture, and compress the first user interface material of the first user interface object in one or more directions that are substantially perpendicular to the first direction, where the first direction is a direction that changes based on the input direction of the swipe gesture, and/or that changes based on the portion of the first user interface material that corresponds to the start location of the swipe gesture (e.g., different first directions based whether the swipe gesture was directed to a first corner, a center, a second corner, a first edge, and/or other portions of the first user interface material). For example, as described with reference to FIG. 5V, the input 903 and/or the input 902-1 is a drag input that includes movement.

In some embodiments, detecting the drag input includes detecting, via the one or more input devices, a start of the drag input (e.g., touch down of a contact of a swipe gesture, an air pinch gesture of a pinch and drag air gesture, a click and hold input of a click and drag input) while a start location of the drag input corresponds to a first portion of the first user interface object (e.g., touch-down location of a swipe gesture, location of a gaze input detected with the air pinch gesture, and/or cursor location at the time of a click and drag input, correspond to a first corner, a first edge, a move handle, and/or another portion of the first user interface object). In some embodiments, in response to detecting the drag input, the computer system moves the first portion of the first user interface object in accordance with the movement of the drag input (e.g., with a direction based on a direction of the drag input and/or with an amount of movement based on an amount of movement of the drag input), to maintain a spatial arrangement between a current location of the drag input (e.g., a current location of the moving contact of the swipe gesture, a current location of the moving hand holding the air pinch posture, and/or the current location of the moving cursor controlled by the click and drag input) and the first portion of the first user interface object (e.g., the dragged portion of the first user interface object follows the movement of the drag input more closely in the input direction of the drag input, than other portions of the first user interface object). For example, as described with reference to FIG. 5W, the corner of the platter 816-2 appears pinned to the user input 902-2.

In some embodiments, the first user interface object includes first content (e.g., the first content corresponds to scrollable content in a window, scrollable entries in a listing of entries, and/or value indicator on a slider control), and detecting the first user input directed toward the first user interface object includes detecting a user input that corresponds to a request to move the first content within the first user interface object (e.g., a user input that corresponds to a request to scroll the first content within the first user interface object, and/or a request to move a value indicator along a slider control). In some embodiments, the first user interface object is a slider control that includes an elongated platter (and/or another slider shape) that is visually associated with a first user interface material, and a value indicator positioned along the elongated platter (e.g., first position for a first value of a controlled parameter, second position for a second value of the controlled parameter, and/or other positions for other values of the controlled parameter) to indicate the current value of a controlled parameter for the slider control. In some embodiments, in response to a first user input that corresponds to a request to move the value indictor along the slider control (e.g., a swipe gesture, a click and drag input, and/or another movement input directed to the value indicator and moving along the slider control), the computer system changes the value of the controlled parameter, moves the value indicator to another position along the slider control, and changes the aspect ratio of the first user interface material of the slider control in one or more dimensions (e.g., compressed in a first direction and expanded in a second direction, where the first direction is selected based on the input direction of the swipe gesture, click and drag input, and/or other types of movement input). For example, as described with reference to FIG. 5W, the content within platter 816-2 appears to move upward as platter 816-2 is stretched vertically.

In some embodiments, the first user interface object includes a plurality of selectable portions (e.g., selectable menu options, selectable text, selectable content items, selectable controls, other types of selectable objects, entries, and/or items) and an indication of selected state for a currently selected portion of the plurality of selectable options (e.g., the indication is a selection box enclosing the currently selected portion, and/or a highlight and/or other visual effect applied to the currently selected portion that increases a visual prominence of the currently selected portion relative to other selectable but unselected portions of the plurality of selectable options of the first user interface object). In some embodiments, detecting the first user input directed toward the first user interface object includes detecting a user input that corresponds to a request to moving the indication of selected state from a first selectable portion to a second selectable portion of the first user interface object. In some embodiments, the user input that corresponds to a request to move the indication of selected state includes a swipe gesture that selects and drags the selection box from one location to another location in the first user interface object, a select and drag gesture that drags a selection handle of a text selection box to change the boundary of text selection, a click and drag input that selects objects located in the first user interface object, a tap gesture that is directed to a selectable option other than a currently selected option in a menu or segmented controller, and/or other types of input that changes the currently selected portion within the first user interface object from a first portion of the first user interface object to a second portion of the first user interface object. In some embodiments, the first user interface object is a menu (e.g., a tool bar including a plurality of icons for different functions, a row of selectable tabs corresponding open webpages in a browser user interface, a segmented controller that includes multiple individually selectable controls, and/or a drop down menu including a listing of selectable menu options) that includes a platter that is visually associated with a first user interface material, and a selection indicator (e.g., a selection box and/or a visual effect) positioned in the platter (e.g., first position corresponding to a first selectable item of menu, second position for a second selectable item of the menu, and/or other positions for other selectable items of the menu) to indicate the currently selected item in the menu. In some embodiments, in response to a first user input that corresponds to a request to move the selection indicator from a first selectable item to a second selectable item in the menu (e.g., a swipe gesture, a click and drag input, and/or another movement input directed to the selection indicator and moving relative to the menu, and/or a selection input directed to another portion of the menu), the computer system moves the selection indicator, changes the currently selected item from a first item to a second item in the menu, and changes the aspect ratio of the first user interface material of the menu in one or more dimensions (e.g., compressed in a first direction and expanded in a second direction, where the first direction is selected based on the input direction of the swipe gesture). In some embodiments, the first user interface object is a multi-state control that includes a platter that is visually associated with a first user interface material, and a state indictor positioned in the platter (e.g., first position for a first state of the multi-state control, second position for a second state of the multi-state control, and/or other positions for other states of the multi-state control) to indicate the current state of the multi-state control. In some embodiments, in response to detecting a user input that corresponds to a request to change the state of the multi-state control (e.g., a swipe gesture, a click and drag input, and/or another movement input directed to the state indicator and moving relative to the platter of the multi-state control), the computer system changes the state of the multi-state control, moves the state indicator to another position relative to the platter of the multi-state control, and changes the aspect ratio of the first user interface material of the multi-state control in one or more dimensions (e.g., compressed in a first direction and expanded in a second direction, where the first direction is selected based on the input direction of the user input). For example, as described with reference to FIGS. 5Z1-5Z3, in response to detecting a user input 924-1, a selected object in segmented control 920 is updated.

In some embodiments, the first user interface object includes a selection object (e.g., a text selection object, and/or another type of selection object that can be dragged, resized, and/or repositioned, to capture selectable content and/or objects within the selection object to select the selectable content and/or objects). In some embodiments, detecting the first user input directed toward the first user interface object includes detecting a user input that corresponds to a request to move a first portion of the first user interface object relative to a second portion of the first user interface object (e.g., a swipe gesture that selects and drags a corner, edge, and/or resize handle of a selection box relative to another portion of the selection box, a select and drag gesture that drags a boundary of a text selection box to change the boundary of text selection, a click and drag input that selects a range of objects located in the first user interface object, and/or other types of input that change the spatial range of the first user interface object by moving a first portion of the first user interface object relative to a second portion of the first user interface object). In some embodiments, the first user interface object is a text selection (e.g., a bounding box that includes a start handle and an end handle of a text selection within selectable text, where the text selection is displayed in a first user interface material that distinguishes the text selection from unselected text). In response to a user input that moves a start hand or an end handle of the text selection relative to the unselected text, the text selection is expanded to include additional text, or shrunken to include less text, where the boundary of the text selection is indicated by the boundary of the first user interface material that stretches in a first direction and compresses in a second direction in accordance with the movement of the start hand or end handle, where the first direction is selected based on the input direction of the user input. For example, as described with reference to FIG. 5Z, the user input 910-3 includes movement of the cursor location within the displayed text.

In some embodiments, the first stretching direction corresponds to a first axis of the first user interface object (e.g., an axis with a direction that corresponds to the direction of the first user input). In some embodiments, the first compression direction corresponds to a second axis of the first user interface object, that is substantially perpendicular to the first axis of the first user interface object. In some embodiments, stretching the first region of the first user interface object in the first stretching direction includes moving a first end of the first user interface object relative to a second end of the first user interface object along the first axis of the first user interface object (e.g., moving opposite ends of the first user interface object away from each other along the first axis based on the direction of the first user input). In some embodiments, compressing the first region of the first user interface object in the first compression direction includes moving a third end of the first user interface object relative to a fourth end of the first user interface object along the second axis of the first user interface object (e.g., moving opposite ends of the first user interface object toward each other along the second axis). In some embodiments, the second stretching direction corresponds to a third axis of the first user interface object, different from the first and second axes of the first user interface object; the second compression direction corresponds to a fourth axis of the first user interface object, that is substantially perpendicular to the third axis of the first user interface object. In some embodiments, stretching the first region of the first user interface object in the second stretching direction includes moving a pair of opposite ends of the first user interface object away from each other along the third axis of the first user interface object; and compressing the first region of the first user interface object in the second compression direction includes moving another pair of opposite ends of the first user interface object toward each other along the fourth axis of the first user interface object. In one example, a user input in the upward direction (e.g., a drag input directed to a top edge of a square shaped user interface object) causes the square shaped user interface object to stretch in the vertical direction with the top portion and the bottom portion of the user interface object moving apart from each other along the vertical axis of the user interface object, and causes the user interface object to compress in the horizontal direction with the left portion and right portion of the user interface object moving toward each other along the horizontal axis of the user interface object. Furthermore, a user input in a first diagonal direction (e.g., a drag input directed to a upper right corner of the square shaped user interface object) causes the square shaped user interface object to stretch in the first diagonal direction with the upper right corner and the bottom left corner of the user interface object moving apart from each other along the first diagonal axis of the user interface object, and causes the user interface object to compress in a second diagonal direction with the upper left corner and lower right corner of the user interface object moving toward each other along the second diagonal axis of the user interface object. In some embodiments, internal content within the user interface material of the first user interface object is stretched and/or compressed with the user interface material of the first user interface object. In some embodiments, internal content within the user interface material of the first user interface object is not stretched and/or compressed with the user interface material of the first user interface object, but may appear with different distortion and chromatic aberration in the user interface material as the spatial characteristics (e.g., radii of curvature on the edges, simulated thicknesses, and/or shape and size of the outline) of the user interface material change. In some embodiments, internal content within the user interface material of the first user interface object are not stretched and/or compressed with the user interface material of the first user interface object, during the deformation of the user interface material under the influence of the user input. For example, as described with reference to FIG. 5Z, in the user interface 906-3, the user interface element 912-2 is stretched in the x-direction and compressed in the y-direction relative to the user interface element 912-1.

In some embodiments, stretching the first region of the first user interface object in the first stretching direction includes: in accordance with a determination that the movement of the first user input in the first input direction has a first movement distance, stretching the first region by a first amount of stretching in the first stretching direction (e.g., the first amount of stretching in the first stretching direction is proportional to the first movement distance and/or increases for an increasing value of the first movement direction); and in accordance with a determination that the movement of the first user input in the first input direction has a second movement distance, different from the first movement distance, stretching the first region by a second amount of stretching in the first stretching direction, different from the first amount of stretching in the first stretching direction (e.g., the second amount of stretching in the first stretching direction is proportional to the second movement distance and/or increases for an increasing value of the second movement distance). Similarly, in some embodiments, stretching the first region of the first user interface object in the second stretching direction includes: in accordance with a determination that the movement of the first user input in the second input direction has a third movement distance, stretching the first region by a third amount of stretching in the second stretching direction (e.g., the third amount of stretching in the second stretching direction is proportional to the third movement distance and/or increases for an increasing value of the third movement distance); and in accordance with a determination that the movement of the first user input in the second input direction has a fourth movement distance, different from the third movement distance, stretching the first region by a fourth amount of stretching in the second stretching direction, different from the third amount of stretching in the second stretching direction (e.g., the fourth amount of stretching in the second stretching direction is proportional to the fourth movement distance and/or increases for an increasing value of the fourth movement distance). In some embodiments, a greater amount of stretching in the first stretching direction is accompanied by a greater amount of compression in the first compression direction; and a greater amount of stretching in the second stretching direction is accompanied by a greater amount of compression in the second compression direction. Similarly, in some embodiments, a smaller movement distance in a respective input direction causes a smaller amount of stretching in a respective stretching direction corresponding to the respective input direction, and a smaller amount of stretching in the respective stretching direction is accompanied by a smaller amount of compression in a respective compression direction orthogonal to the respective stretching direction. For example, as described with reference to FIGS. 5V-5Y, the amount of stretching upwards of the platter 816-2 is based on a magnitude of movement (e.g., a distance of displacement) of the user input 903 and/or user input 902-1.

In some embodiments, stretching the first region of the first user interface object in the first stretching direction includes: in accordance with a determination that a first portion of the movement of the first user input in the first input direction includes a third movement distance within the first region, stretching the first region by a third amount of stretching in the first stretching direction (e.g., the third amount of stretching in the first stretching direction is proportional to the third movement distance within the first region and/or increases for an increasing value of the third movement direction); and in accordance with a determination that a second portion of the movement of the first user input in the first input direction includes the third movement distance outside of the first region, stretching the first region by a fourth amount of stretching in the first stretching direction, different from the third amount of stretching in the first stretching direction (e.g., the fourth amount of stretching in the first stretching direction is proportional to the third movement distance outside of the first region and/or increases for an increasing value of the third movement distance; and in addition, the same amount of movement distance within the first region and outside of the first region cause different amounts of stretching of the first region in the first stretching direction). In some embodiments, a respective amount of movement distance in the first input direction within the first region causes less stretching of the first region in the first stretching direction, as compared to the same amount of movement distance in the first input direction outside of the first region. Similarly, in some embodiments, compressing the first region of the first user interface object in the first compression direction includes: in accordance with a determination that the first portion of the movement of the first user input in the first input direction includes the third movement distance within the first region, compressing the first region by a third amount of compression in the first compression direction (e.g., the third amount of compression in the first compression direction is proportional to the third movement distance within the first region and/or increases for an increasing value of the third movement direction); and in accordance with a determination that the second portion of the movement of the first user input in the first input direction includes the third movement distance outside of the first region, compressing the first region by a fourth amount of compression in the first compression direction, different from the third amount of compression in the first compression direction (e.g., the fourth amount of compression in the first compression direction is proportional to the third movement distance outside of the first region and/or increases for an increasing value of the third movement distance; and in addition, the same amount of movement distance within the first region and outside of the first region cause different amounts of compression of the first region in the first compression direction). In some embodiments, the first user input includes movement that is entirely outside of the first region (e.g., first region is substantially stationary and/or lags behind the first user input after the movement of the first user input is started). In some embodiments, the first user input includes movement that is entirely within the first region (e.g., first region is substantially stationary and/or moves closely with the first user input after the movement of the first user input is started). In some embodiments, the first user input includes movement that is initially within the first region and leaves the first region after the initial portion of the movement (e.g., first region is substantially stationary and/or lags behind the first user input while moving with the movement of the first user input). In some embodiments, the first user input includes movement that is initially outside of the first region and enters the first region after the initial portion of the movement (e.g., first region is substantially stationary and/or is gradually propelled by the first user input into motion with the first user input). In some embodiments, the stretching of the first region in a respective stretching direction and/or the compression of the first region in a respective compression direction, corresponding to the first input direction of the first user input, are greater for movement of the input element (e.g., contacts of a drag gesture, hand of an air pinch and drag gesture, focus selector or pointer of a click and drag input, and/or another type of input element that moves during the first user input) executed within the first region than those for the same amount of movement executed outside of the first region. In some embodiments, the stretching of the first region in a respective stretching direction and/or the compression of the first region in a respective compression direction, corresponding to the first input direction of the first user input, are smaller for movement of the input element (e.g., contacts of a drag gesture, hand of an air pinch and drag gesture, focus selector or pointer of a click and drag input, and/or another type of input element that moves during the first user input) executed within the first region than those for the same amount of movement executed outside of the first region. In some embodiments, a movement of the first user input is defined by a change in a current location of the input element of the first user input that moves during the first user input. The location of the input element has a corresponding location in the user interface (e.g., the location of the contact, location of the focus selector, location of the cursor, and/or location of a pointer), the movement of the input element has a corresponding movement in the user interface, which may include a movement within the first region and/or a movement outside of the first region, during the course of the movement of the first user input. For example, as described with reference to FIG. 5X, the user input 904-1 is detected as moving within the boundary of the platter 816-2, and the amount of stretching is less than the amount of stretching applied to the platter 816-2 in response to detecting a user input that travels outside of the boundary of the platter 816-2 (e.g., user input 902-2 moves outside of the boundary of the platter 816-2 and thus a greater amount of stretching is applied to the platter 816-2).

In some embodiments, stretching the first region of the first user interface object in the first stretching direction includes: in accordance with a determination that a characteristic movement corresponding to an interaction between the first user input and the first user interface object (e.g., characteristic movement includes movement of the first user input, including movement of an input element of the first user input, and/or movement of the first user interface object) has a first movement speed (e.g., first set of values for individual speeds, average speeds, and/or combined speeds of the input element and/or the first user interface object) in a respective movement direction, stretching the first region by a first speed-dependent amount of stretching in a stretching direction corresponding to the respective movement direction (e.g., the first speed-dependent amount of stretching in the stretching direction corresponding to the respective movement direction is proportional to the first movement speed and/or increases for an increasing value of the first movement speed); and in accordance with a determination that the characteristic movement corresponding to the interaction between the first user input and the first user interface object has a second movement speed (e.g., second set of values for individual speeds, average speeds, and/or combined speeds of the input element and/or the first user interface object), different from the first movement speed, in the respective movement direction, stretching the first region by a second speed-dependent amount of stretching, different from the first speed-dependent amount of stretching in the stretching direction corresponding to the respective movement direction (e.g., the second speed-dependent amount of stretching in the stretching direction corresponding to the respective movement direction is proportional to the second movement speed and/or increases for an increasing value of the second movement speed). In some embodiments, a greater amount of stretching in the stretching direction corresponding to the respective movement direction is accompanied by a greater amount of compression in a compression direction, different from the stretching direction, corresponding to the respective movement direction. In some embodiments, a smaller amount of stretching in the stretching direction corresponding to the respective movement direction is accompanied by a smaller amount of compression in a compression direction, different from the stretching direction, corresponding to the respective movement direction. In some embodiments, velocity of the first user input (e.g., the velocity of the input element, contacts, focus selector, hand, pointer, and/or finger) and/or the velocity of the first user interface object, are both used as factors to determine the stretching amounts and stretching directions for stretching the first region of the first user interface object, resulting in a stretching direction that is based on both the velocity of the input and the velocity of the user interface object, and/or different stretching amounts for multiple stretching directions, respectively corresponding to the movement directions of the user input and the user interface object. In some embodiments, the effect of the movement velocity of the first user input and/or the effect of the movement velocity of the first user interface object, are combined with the effect of the movement distance of the first user input and/or the effect of the movement distance of the first user interface object. In some embodiments, the effect of the movement velocity of the first user input, the effect of the movement velocity of the first user interface object, the effect of the movement distance of the first user input, and the effect of the movement distance of the first user interface object, are used as alternatives, or used in different combinations, in various embodiments, to produce the change in appearance of the first region of the first user interface object. For example, as described with reference to FIGS. 5V-5Y, the movement of the platter 816-1 is based on a velocity of the user input 902-1 and/or a velocity of the movement of the platter 816-1, optionally without being based on an amount of movement (e.g., distance of movement) of the user input 902-1 and/or platter 816-1.

In some embodiments, stretching the first region of the first user interface object in the first stretching direction includes, in accordance with a determination that the movement of the first user input in the first input direction has a first movement speed, stretching the first region by a first amount of stretching in the first stretching direction (e.g., the first amount of stretching in the first stretching direction is proportional to the first movement speed and/or increases for an increasing value of the first movement speed). In some embodiments, stretching the first region of the first user interface object in the first stretching direction includes, in accordance with a determination that the movement of the first user input in the first input direction has a second movement speed, different from the first movement speed, stretching the first region by a second amount of stretching in the first stretching direction, different from the first amount of stretching in the first stretching direction (e.g., the second amount of stretching in the first stretching direction is proportional to the second movement speed and/or increases for an increasing value of the second movement speed). Similarly, in some embodiments, stretching the first region of the first user interface object in the second stretching direction includes: in accordance with a determination that the movement of the first user input in the second input direction has a third movement speed, stretching the first region by a third amount of stretching in the second stretching direction (e.g., the third amount of stretching in the second stretching direction is proportional to the third movement speed and/or increases for an increasing value of the third movement speed); and in accordance with a determination that the movement of the first user input in the second input direction has a fourth movement speed, different from the third movement speed, stretching the first region by a fourth amount of stretching in the second stretching direction, different from the third amount of stretching in the second stretching direction (e.g., the fourth amount of stretching in the second stretching direction is proportional to the fourth movement speed and/or increases for an increasing value of the fourth movement speed). In some embodiments, a greater amount of stretching in the first stretching direction is accompanied by a greater amount of compression in the first compression direction; and a greater amount of stretching in the second stretching direction is accompanied by a greater amount of compression in the second compression direction. Similarly, in some embodiments, a smaller movement speed in a respective input direction causes a smaller amount of stretching in a respective stretching direction corresponding to the respective input direction, and a smaller amount of stretching in the respective stretching direction is accompanied by a smaller amount of compression in a respective compression direction orthogonal to the respective stretching direction. For example, as described with reference to FIG. 5Z, the amount of distortion applied to the shape of user interface element 912 is based on a velocity of the user input 910.

In some embodiments, stretching the first region of the first user interface object in the first stretching direction includes: in accordance with a determination that a characteristic movement corresponding to an interaction between the first user input and the first user interface object (e.g., characteristic movement includes movement of the first user input, including movement of an input element of the first user input, and/or movement of the first user interface object) has a first rate of change in movement speed (e.g., a first set of values for a derivative of individual speeds, average speeds, and/or combined speeds of the input element and/or the first user interface object) in a respective movement direction, stretching the first region by a first acceleration-dependent amount of stretching in a stretching direction corresponding to the respective movement direction (e.g., the first acceleration-dependent amount of stretching in the stretching direction corresponding to the respective movement direction is proportional to the first rate of change in movement speed and/or increases for an increasing value of the rate of change in movement speed); and in accordance with a determination that the characteristic movement corresponding to the interaction between the first user input and the first user interface object (e.g., characteristic movement includes movement of the first user input, including movement of an input element of the first user input, and/or movement of the first user interface object) has a second rate of change in movement speed (e.g., a second set of values for a derivative of individual speeds, average speeds, and/or combined speeds of the input element and/or the first user interface object), different from the first rate of change in movement speed, in a respective movement direction, stretching the first region by a second acceleration-dependent amount of stretching, different from the first acceleration-dependent amount of stretching, in the stretching direction corresponding to the respective movement direction (e.g., the second acceleration-dependent amount of stretching in the stretching direction corresponding to the respective movement direction is proportional to the second rate of change in movement speed and/or increases for an increasing value of the rate of change in movement speed). In some embodiments, a greater amount of stretching in the stretching direction corresponding to the respective movement direction is accompanied by a greater amount of compression in a compression direction, different from the stretching direction, corresponding to the respective movement direction. In some embodiments, a smaller amount of stretching in the stretching direction corresponding to the respective movement direction is accompanied by a smaller amount of compression in a compression direction, different from the stretching direction, corresponding to the respective movement direction. In some embodiments, rate of change in velocity of the first user input (e.g., the rate of change in velocity of the input element, contacts, focus selector, hand, pointer, and/or finger) and/or the rate of change in velocity of the first user interface object, are both used as factors to determine the stretching amounts and stretching directions for stretching the first region of the first user interface object, resulting in a stretching direction that is based on both the rate of change in velocity of the input and the rate of change in velocity of the user interface object, and/or different stretching amounts for multiple stretching directions, respectively corresponding to the rates of change in velocities of the user input and the user interface object. In some embodiments, the effect of the rate of change in movement velocity of the first user input and/or the effect of the rate of change in movement velocity of the first user interface object, are combined with the effect of the movement speed of the first user input, the effect of the movement distance of the first user input, the effect of the movement speed of the first user interface object, and/or the effect of the movement distance of the first user interface object. In some embodiments, the effect of the rate of change in movement velocity of the first user input, the effect of the movement velocity of the first user input, the effect of the rate of change in the movement velocity of the first user interface object, the effect of the movement velocity of the first user interface object, the effect of the movement distance of the first user input, and the effect of the movement distance of the first user interface object, are used as alternatives, or used in different combinations, in various embodiments, to produce the change in appearance of the first region of the first user interface object. For example, as described with reference to FIGS. 5V-5Y, the amount of stretching of the platter 816-2 upwards in the y-direction is based on a rate of movement (e.g., speed, acceleration and/or jerk) of the user input 903 and/or user input 902-1 in the y-direction.

In some embodiments, stretching the first region of the first user interface object in the first stretching direction includes, in accordance with a determination that the movement of the first user input in the first input direction has a first rate of change in movement speed (e.g., acceleration from a lower speed and/or deceleration from a higher speed), stretching the first region by a first amount of stretching in the first stretching direction (e.g., the first amount of stretching in the first stretching direction is proportional to the first rate of change in movement speed and/or increases for an increasing value of the first rate of change in movement speed). In some embodiments, stretching the first region of the first user interface object in the first stretching direction includes, in accordance with a determination that the movement of the first user input in the first input direction has a second rate of change in movement speed, different from the first rate of change in movement speed, stretching the first region by a second amount of stretching in the first stretching direction, different from the first amount of stretching in the first stretching direction (e.g., the second amount of stretching in the first stretching direction is proportional to the second rate of change in movement speed and/or increases for an increasing value of the second rate of change in movement speed). Similarly, in some embodiments, stretching the first region of the first user interface object in the second stretching direction includes: in accordance with a determination that the movement of the first user input in the second input direction has a third rate of change in movement speed, stretching the first region by a third amount of stretching in the second stretching direction (e.g., the third amount of stretching in the second stretching direction is proportional to the third rate of change in movement speed and/or increases for an increasing value of the third rate of change in movement speed); and in accordance with a determination that the movement of the first user input in the second input direction has a fourth rate of change in movement speed, different from the third rate of change in movement speed, stretching the first region by a fourth amount of stretching in the second stretching direction, different from the third amount of stretching in the second stretching direction (e.g., the fourth amount of stretching in the second stretching direction is proportional to the fourth rate of change in movement speed and/or increases for an increasing value of the fourth rate of change in movement speed). In some embodiments, a greater amount of stretching in the first stretching direction is accompanied by a greater amount of compression in the first compression direction; and a greater amount of stretching in the second stretching direction is accompanied by a greater amount of compression in the second compression direction. Similarly, in some embodiments, a smaller rate of change in movement speed in a respective input direction causes a smaller amount of stretching in a respective stretching direction corresponding to the respective input direction, and a smaller amount of stretching in the respective stretching direction is accompanied by a smaller amount of compression in a respective compression direction orthogonal to the respective stretching direction. For example, as described with reference to FIG. 5Z, the amount of distortion applied to the shape of user interface element 912 is based on acceleration and/or jerk of the user input 910.

In some embodiments, after stretching the first region in a respective stretching direction and compressing the first region in a respective compression direction by respective amounts based on a first characteristic value (e.g., respective and/or combined movement speed, movement velocity, rate of change in movement velocity, and/or movement distance, of the input element of the first user input, and/or of the first user interface object) of a characteristic movement in an interaction between the first user input and the first user interface object (e.g., characteristic movement includes movement of the first user input, including movement of an input element of the first user input, and/or movement of the first user interface object), the computer system detects, via the one or more input devices, that the first characteristic value of the characteristic movement has reduced below a threshold level (e.g., reduced to zero, coming to a stop, and/or stabilized at a constant value for at least a threshold amount of time). In some embodiments, in response to detecting that the first characteristic value of the characteristic movement has reached below the threshold level, the computer system maintains a current shape (e.g., with a non-zero amounts of stretching and/or compression) of the first user interface object (e.g., even if the first user interface object is and/or remains displaced from an anchor position of the first user interface object). For example, as described with reference to FIG. 5W, in response to detecting user input 902-2 has ceased to continue moving (e.g., and/or a velocity of the user input 902-2 has stabilized), the platter 816-2 continues to be displayed with its stretched dimensions (e.g., without further stretching the platter 816-2), and is optionally maintained at a position away from anchor point 905 while the user input 902-2 is maintained.

In some embodiments, after stretching the first region in a respective stretching direction and compressing the first region in a respective compression direction (e.g., stretching in the first stretching direction and compressing in the first compression direction, stretching in the second stretching direction and compressing in the second compression direction, and/or stretching in another stretching direction based on the input direction of the first user input and compressing in another compression direction based on the input direction of the first user input) by respective amounts based on a first characteristic value of a movement in a respective input direction (e.g., based on movement speed, and/or rate of change in movement speed, in the first input direction, second input direction, and/or other input direction, of the first user input) of the first user input, the computer system detects, via the one or more input devices, that the first characteristic value of the movement in the respective input direction of the first user input has reduced below a threshold level (e.g., movement speed has reached below a threshold speed and/or stopped, and/or rate of change in movement speed has reached below a threshold rate of change and/or stabilized at a constant movement speed). In response to detecting that the first characteristic value of the movement in the respective input direction of the first user input has reached below the threshold level, the computer system maintains a current shape of the first user interface object (e.g., maintains a current location of the first user interface object without continuing the stretch and/or compress the first portion of the first user interface object in respective dimensions, optionally, even if the current location is different from an original location and/or anchor location of the first user interface object, and optionally before a termination of the first user input is detected). In some embodiments, the computer system detects a swipe gesture by a contact at a location that corresponds to a portion of the first user interface object; and in response to detecting the swipe gesture, the computer system stretches the portion of the first user interface object in a stretching direction that corresponds to the input direction of the swipe gesture, and compresses the portion of the first user interface object in a compression direction that is different from the stretching direction, wherein the computer system stretches the portion of the first user interface object by a greater amount in the stretching direction and compresses the portion of the first user interface object by a greater amount in the compression direction, in accordance with a determination that the swipe gesture has a greater movement speed and/or a greater rate of change in movement speed. In some embodiments, in the case where a greater movement speed of the swipe gesture causes a greater amount of stretching and compression of the portion of the first user interface object, the computer system stops stretching in the stretching direction and compressing the portion of the first user interface object in the compression direction, and maintains the current shape of the first user interface object, when the contact stops moving and the movement speed is below a threshold movement speed (e.g., while the contact is continuously maintained, and/or while the first user interface object has been moved and held away from its original location as a result of the movement of the contact). In some embodiments, in the case where a greater rate of change in movement speed of the swipe gesture causes a greater amount of stretching and a greater amount of compression of the portion of the first user interface object, the computer system stops stretching in the stretching direction and compressing in the compression direction of the portion of the first user interface object, and maintains the current shape of the first user interface object, when the contact moves at a substantially constant speed and the rate of change in movement speed is below a threshold rate of change in movement speed (e.g., while the contact is continuously maintained, while the contact continues to move, and/or while the first user interface object has been moved and held away from its original location as a result of the movement of the contact). For example, as described with reference to FIG. 5W, the dimensions of the platter 902-2 continue to change until the user input 902-2 ceases to move or reaches a threshold level of movement, velocity, or satisfies another movement threshold.

In some embodiments, stretching the first region of the first user interface object in the first stretching direction includes: in accordance with a determination that a characteristic movement parameter corresponding to an interaction between the first user input and the first user interface object has a first characteristic value, where the first characteristic value is based on one or more movement characteristics of the first user input and one or more movement characteristics of the first user interface object (e.g., the first characteristic value is a combination of the movement distance, movement speed, and/or rate of change in movement speed of the first user input in a respective input direction of the first user input, and the movement distance, movement speed, and/or rate of change in movement speed of the first user interface object in a respective movement direction of the first user interface object, where the magnitude and/or direction of the movement of the first user input are optionally different from the magnitude and/or direction of the movement of the first user interface object), stretching the first region by a first set of stretching amounts in a first set of stretching directions corresponding to the first characteristic value (e.g., the first set of stretching amounts in the first set of stretching directions takes into account of the cumulative and/or canceling effects of the movement of the first user input and the movement of the first user interface object); and in accordance with a determination that the characteristic movement parameter corresponding to the interaction between the first user input and the first user interface object has a second characteristic value, different from the first characteristic value (e.g., due to differences in direction and/or magnitude between the movement distances, movement velocities, and/or accelerations of the first user input and the first user interface object), where the second characteristic value is based on one or more movement characteristics of the first user input and one or more movement characteristics of the first user interface object, stretching the first region by a second set of stretching amounts in a second set of stretching directions corresponding to the second characteristic value (e.g., the second set of stretching amounts in the second set of stretching directions takes into account of the cumulative and/or canceling effects of the movement of the first user input and the movement of the first user interface object), the second set of stretching amounts is different from the first set of stretching amounts, and/or the second set of stretching directions is different from the first set of stretching directions. In some embodiments, the amount of changes in size of the first region (e.g., stretching and compression of the first region) is based on both the input movement (e.g., movement of the input element or finger, in terms of absolute amount and/or converted into movement in the user interface) and the object movement (e.g., movement of the first user interface object, in terms of absolute amount and/or percentage of the user interface and/or the first user interface object that is optionally caused at least in part by an amount, direction, speed, velocity, acceleration, and/or derivative of speed of the input element during a current and/or past input time periods), and the input movement and object movement may contribute (e.g., optionally, by different amounts) to the characteristic value of the characteristic movement parameter of the interaction between the first user input and the first user interface object in the same direction (e.g., causing an increase in the characteristic value in a respective direction of the characteristic movement parameter) or opposite directions (e.g., causing a decrease in the characteristic value in a respective direction of the characteristic movement parameter). In some embodiments, in accordance with a determination that the first user interface object is an object that is moveable in a respective direction, the movement of the first user interface object in the respective direction, causes a greater contribution to the stretching and/or compression of the first region in the respective direction, as compared to the case where the first user interface object is not movable and/or constrained in the respective direction, and as compared to the contribution of the movement of the first user input. For example, as described with reference to FIG. 5W, the amount of change in size of the platter 816-1 is based on the movement of the user input 902-1 and/or the movement of the platter 816-1.

In some embodiments, in response to detecting the first user input, in accordance with a determination that the first user input included movement in a respective input direction (e.g., the first input direction, the second input direction, and/or another input direction different from the first input direction and the second input direction), and in accordance with a determination that the first user interface object has moved less than a threshold amount of movement in a respective movement direction that corresponds to the respective input direction (e.g., if the first user interface object has not been moved away from its original and/or anchor location by a threshold distance) as a result of the first user input, the computer system continues to move the first user interface object in the respective movement direction in accordance with the movement in the respective input direction (e.g., the first user interface object follows the first user input to move farther away from its original and/or anchor location). In response to detecting the first user input, in accordance with a determination that the first user input included movement in a respective input direction (e.g., the first input direction, the second input direction, and/or another input direction different from the first input direction and the second input direction), and in accordance with a determination that the first user interface object has moved at least the threshold amount of movement in the respective movement direction that corresponds to the respective input direction (e.g., if the first user interface object has been moved away from its original and/or anchor location by more than the threshold distance) as a result of the first user input, ceasing to move the first user interface object in the respective movement direction in accordance with the movement in the respective input direction (e.g., the first user interface object resists from being moved farther away from its original and/or anchor location, despite of the continued movement of the first user input and/or the continued deformation of the first user interface material under the influence of the first user input). For example, as described with reference to FIG. 5W, platter 816-2 is dragged away from anchor point 905 by a first distance before resisting further movement away from the anchor point 905.

In some embodiments, after the first user interface object has moved in the respective movement direction as a result of the first user input (e.g., after the first user interface object has been moved away from its original and/or anchor location in the respective movement direction in response to the movement of the first user input in the respective input direction), the computer system detects, via the one or more input devices, a termination of the first user input (e.g., liftoff of a swipe gesture, release of a click and drag input, release of an air pinch gesture in an air pinch and drag gesture, and/or a termination of other types of inputs). In response to detecting the termination of the first user input, the computer system reverses at least a portion of a total amount of movement of the first user interface object in the respective movement direction (e.g., the first user interface object snaps back to its original and/or anchor location (and, optionally, restores to its original unstretched and uncompressed shape) when the termination of the first user input, such as liftoff of a contact for a swipe gesture, release of a pinched posture of an air pinch and drag gesture, and release of a click and drag input, is detected). For example, as described with reference to FIG. 5W and FIG. 5X, after detecting an end of the user input 902-2, the platter 816-2 is snapped back to its anchor point 905.

In some embodiments, in response to detecting the first user input and prior to detecting the termination of the first user input, and in accordance with a determination that the first user input included movement in a respective input direction (e.g., the first input direction, the second input direction, and/or another input direction different from the first input direction and the second input direction) of the first user input, the computer system stretches the first region in a respective stretching direction (e.g., the first stretching direction, the second stretching direction, and/or another stretching direction different from the first stretching direction and the second stretching direction) and compresses the first region in a respective compression direction (e.g., the first compression direction, the second compression direction, and/or another compression direction different from the first stretching direction and the second stretching direction), where the respective compression direction is different from the respective stretch direction (e.g., one of the respective stretch direction corresponds to the respective input direction, and the respective stretch direction and the respective compression direction are substantially orthogonal to each other). In response to detecting the termination of the first user input, the computer system reverses at least a portion of the stretching of the first region in the respective stretching direction and reversing at least a portion of the compression of the first region in the respective compression direction (e.g., in conjunction with moving back to its original and/or anchor location). For example, after the termination of the first user input, the computer system reverses the deformations of the first user interface object in two or more dimensions caused by the first user input, as the first user interface object snaps back to its original anchor location. For example, in FIG. 5W, in response to detecting an end of the user input 902-2, the platter 816-2 reverses the animation to return to the shape and/or position of the platter 816-1 (e.g., in FIG. 5V).

In some embodiments, the first user interface object has a first area prior to detecting the first user input. In some embodiments, the first user interface object has a second area while the first region is stretched in the first direction and compressed in the first compression direction. In some embodiments, the first user interface object has a third area while the first region is stretched in the second direction and compressed in the second compression direction. In some embodiments, the first area, the second area, and the third area differ by less than a threshold amount of area (e.g., the area of the first user interface object is substantially conserved as the first user interface object is deformed in two or more dimensions under the influence of the first user input). For example, as described with reference to FIG. 5W, the area of platter 816-2 is approximately conserved relative to the area of platter 816-1.

In some embodiments, while continuing to detect the first user input, the computer system detects, via the one or more input devices, that an input direction of the first user input has changed from the first input direction to a third input direction (e.g., the second input direction, and/or an input direction that is different from the first input direction and the second input direction). In response to detecting that the input direction of the first user input has changed from the first input direction to the third input direction, and in accordance with a determination that a difference between the third input direction and the first input direction meets first criteria (e.g., the difference is more than a threshold angle, such as 5 degrees, 10 degrees, 30 degrees, 60 degrees, 90 degrees, 120 degrees, 150 degrees, 180 degrees, and/or other angular values), the computer system changes from stretching the first region in the first stretching direction to stretching in a third stretching direction corresponding to the third input direction (e.g., third stretching direction is parallel to the third input direction, and/or within a threshold angular range of the third input direction), and the computer system changes from compressing the first region in the first compression direction to compressing in a third compression direction that is different from the third stretching direction (e.g., the third compression direction is substantially orthogonal to the third stretching direction). In some embodiments, the first user interface object changes size in a few discrete stretching directions and a few corresponding compression directions, based on the input direction of the first user input. In some embodiments, the allowed stretching directions include directions along two or more main axes of the first user interface object (e.g., two or more symmetric axes, two or more central axes, and/or a vertical axis and a horizontal axis), similarly, the allowed compression directions include directions along two or more main axes of the first user interface object (e.g., two or more symmetric axes, two or more central axes, and/or a vertical axis and a horizontal axis). In some embodiments, the allowed stretching directions and allowed compression directions are not constrained to the main axes of the first user interface object, and may be continuous and/or include a plurality of finely spaced angles depending on the input direction. In some embodiments, a change in direction of the first user input by more than a threshold amount causes the stretching direction to snap from the current stretching direction to an adjacent allowed stretching direction, and/or the compression direction to snap from the current compression direction to an adjacent allowed compression direction. In some embodiments, a change in direction of the first user input causes the stretching direction to gradually switch from the current stretching direction to another stretching direction based on the changed input direction, and/or causes the compression direction to gradually switch from the current compression direction to another compression direction based on the change input direction. For example, as described with reference to FIGS. 5W1-5W2, in response to detecting the user input 902-3 (e.g., optionally after detecting user input 902-1), the platter 816-4 is stretched in accordance with the diagonal direction of movement of the user input 902-3.

In some embodiments, the first user interface object that is visually associated with a first user interface material, and the first user interface material of the first user interface object has an appearance that simulates optical interaction between the first user interface material and content within and/or surrounding the first user interface material (e.g., simulated refraction, simulated shadow, simulated transmission, simulated color tinting, simulated chromatic aberration, and/or other simulated optical interactions, by visual distortion, color separation, tinting, blurring, darkening, changing opacity, and/or other visual changes to the appearance of the first user interface material, based on the shape, size, texture, and/or spatial relationship between the first user interface material and the content within and/or surrounding the first user interface material). For example, as described with reference to FIG. 5V, the platter 816-1 is displayed with a simulated glass material with properties described with reference to FIGS. 6A-6C.

In some embodiments, in response to detecting the first user input, the computer system changes the appearance of the first user interface material based on stretching and compression of the first region of the first user interface object that resulted from the first user input, to simulate changes in the optical interaction between the first user interface material and the content within and/or surrounding the first user interface material (e.g., the appearance of the first user interface material changes because the shape, size, boundary, thickness, and/or location of first user interface material are changed due to the first user input, which in turn changes the simulated optical interactions between the first user interface material and the content that is within and/or surrounding the first user interface material). For example, as described with reference to FIG. 5U2, changing a shape of the platter 814 causes simulated changes in the simulated glass material, including how underlying content is distorted based on changes to one or more values of one or more visual properties of the simulated glass material.

In some embodiments, stretching the first region of the first user interface object in the first stretching direction includes: moving a first edge of the first region in the first stretching direction by a first amount of edge movement; and moving a second edge of the first region in the first stretching direction by a second amount of edge movement, smaller than the first amount of edge movement (e.g., the second amount of edge movement is optionally zero movement, or a small amount of movement that keeps the second edge of the first user interface object anchored at or near its original location). In some embodiments, a difference between the first amount of edge movement by the first edge of the first region and the second amount of edge movement by the second edge of the first region corresponds to (e.g., is equal to, is substantially equal to, is less than 1%, 5%, 10%, or 25% different from) the first amount of stretching in the first stretching direction. In some embodiments, when resizing the first user interface object in response to the first user input, the computer system shifts the first user interface object in the direction of movement of the first user input, e.g., to keep one edge of the first user interface object that is opposite the direction of first user input near its original location, while moving the opposing edge with the movement of the first user input, resulting in the stretching of the first user interface object in the respective direction of the first user input. For example, as illustrated in FIGS. 5X-5Y, in response to detecting the user input 904-1, the platter 816-3 is stretched horizontally by moving a right edge of the platter 816-3 to the right while maintaining a position of the left edge of the platter 816-3 at or near its original position of the left edge of platter 816-2.

It should be understood that the particular order in which the operations in FIG. 11 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 12000, 13000, 14000, 15000, 16000, 17000, 18000, 19000, and/or 20000) are also applicable in an analogous manner to method 11000 described above with respect to FIG. 11. For example, the buttons, user interfaces, controls, visual deemphasis, virtual effects, an/or animations described above with reference to method 11000 optionally have one or more of the characteristics of the buttons, user interfaces, controls, visual deemphasis, virtual effects, an/or animations described herein with reference to other methods described herein (e.g., methods 7000, 8000, 9000, 10000, 12000, 13000, 14000, 15000, 16000, 17000, 18000, 19000, and/or 20000). For brevity, these details are not repeated here.

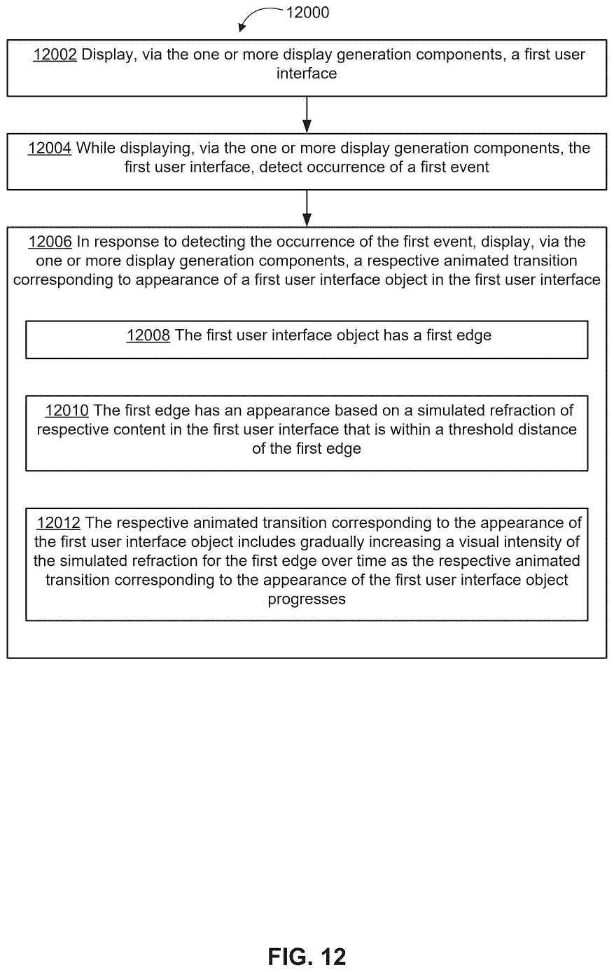

FIG. 12 is a flow diagram illustrating a method 12000 of displaying animated transitions for user interface objects in accordance with some embodiments. The method 12000 is performed at a computer system (e.g., device 300, FIG. 3A, or portable multifunction device 100, FIG. 1A) that is in communication with one or more input devices and one or more display generation components. In some embodiments, the one or more display generation components are touch-screen displays which optionally include one or more touch-sensitive surfaces integrated with one or more of the display generation components. In some embodiments, one or more of the display generation components are separate from one or more of the touch-sensitive surfaces. In some embodiments, the method 12000 is performed at a computer system that is in communication with one or more input devices and one or more display generation components. In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system. Some operations in method 12000 are, optionally, combined and/or the order of some operations is, optionally, changed.

Automatically animating the appearance and/or disappearance of a user interface object in response to detecting an event by gradually changing a simulated curvature of at least a portion of the edge of the user interface object informs the user about the change in the state of the computer system and application without requiring user input, thereby improving visual feedback about a state of the computer system. Using user interface materials with simulated optical properties for user interface elements, including animating the appearance and disappearance of user interface materials by changing values of the simulated optical properties over time, improves the legibility of content, which enables a user to use a device for shorter periods of time, which saves energy and improves battery life. Using user interface materials with simulated optical properties for user interface elements enables the user interface elements to be more transparent, and an increased transparency of user interface elements enables a user to use a device for shorter periods of time, which saves energy and improves battery life. Providing an appearance of user interface elements (e.g., changing material appearance to animate the appearance and/or disappearance of user interface elements) when one or more criteria are met reduces the number of inputs (e.g., navigating through settings user interfaces and menus to set the values for parameters to adjust the appearance of user interface elements) that would otherwise be required to generate a similar effect, which saves energy and improves battery life.

The computer system displays (12002), via the one or more display generation components, a first user interface (e.g., a system user interface, a wake screen user interface, a lock screen user interface, a home screen user interface, a control user interface, a browser application user interface, a messages application user interface, a media player user interface, a desktop user interface, an application window, and/or other system user interfaces and application user interfaces) (e.g., user interface 1126, FIG. 5AE).

While displaying, via the one or more display generation components, the first user interface, the computer system detects (12004) occurrence of a first event (e.g., elapse of time, a user input, a change in the context of the computer system, and/or a change in an internal state of the computer system).

In response to detecting the occurrence of the first event, the computer system displays (12006), via the one or more display generation components, a respective animated transition corresponding to appearance (e.g., emergence, a process of becoming visible, and/or a process of coming into being) of a first user interface object (e.g., a first content object, a first indicator, a first control corresponding to a first control function of the computer system, and/or a first user interface object that, in response to an input directed toward the first user interface object, causes the computer system to perform a first operation, such as displaying another user interface object, optionally, in a second user interface different from the first user interface) in the first user interface (e.g., the first user interface object emerges from the first user interface, and/or another user interface object in the first user interface transforms into the first user interface object, in the respective animated transition) (e.g., as described with reference to FIG. 5AB).

The first user interface object has (12008) a first edge (and, optionally one or more additional edges of the first user interface object). In some embodiments, the first user interface object is a two-dimensional object with a continuous outline that encloses a user interface material of the first user interface object. In some embodiments, the first user interface object is a simulated three-dimensional object with one or more simulated surfaces that define a simulated volume of a user interface material of the first user interface object. In some embodiments, the user interface material of the first user interface object includes a background material, a texture, and/or a simulated glassy, translucent, and/or gelatinous material with simulated optical properties. In some embodiments, the first edge, and, optionally one or more additional edges, of the first user interface object define a boundary of the first user interface object.

The first edge has (12010) an appearance based on a simulated refraction of respective content in the first user interface that is within a threshold distance of the first edge (e.g., the respective content includes content of the first user interface that is covered by a first portion of the first user interface object including the first edge, content of the first user interface that is located near the first edge but not directly under the first user interface object, and/or content within a first portion of the first user interface object corresponding to the first edge). In some embodiments, the appearance of the edge includes colors and pattern variations that are indicative of and/or based on the colors and lines of the content that is covered by the user interface material of the first user interface object, and at least some content that is adjacent to the first edge of the first user interface object and not covered by the user interface material of the first user interface object (e.g., simulating refraction of the content that is near, but not necessarily directly under the first user interface object and/or immediately adjacent the boundary of the first edge). For example, as described with reference to FIG. 5AB, an upper right edge of the “9” that is appearing in the time indication (e.g., displayed as the simulated glass material) is displayed with a first level of refraction (e.g., to simulate a first thickness of the simulated glass material) in step 1102-9, as described with reference to FIGS. 6A-6C.

The respective animated transition corresponding to the appearance of the first user interface object includes (12012) gradually increasing a visual intensity of the simulated refraction for the first edge (and, optionally one or more additional edges of the first user interface object) over time as the respective animated transition corresponding to the appearance of the first user interface object progresses (e.g., increasing the threshold distance from the first edge that content is used to generate the simulated refraction and/or increasing a degree of distortion applied to the content that is used to generate the simulated refraction, optionally, to illustrate a gradual change in the curvature of the first edge, e.g., decreasing curvature, as the first user interface object appears and settles into its steady state appearance in the first user interface). In some embodiments, the first user interface object has an appearance that simulates a volume of the first user interface material that has a first curvature in a first edge portion of the simulated volume of the first user interface material. In some embodiments, the first curvature is visually indicated by a simulated refraction of first content of the first user interface that is located adjacent to the first edge portion of the simulated volume of simulated material, the first content of the first user interface includes at least a first portion of the first content that underlies the first user interface object (e.g., is visually obscured by the first user interface object, and/or not directly visible to a user) and a second portion of the first content that is concurrently visible as the first user interface object (e.g., is not visually obscured by the first user interface object, and/or is directly visible to a user). In some embodiments, the first user interface object includes an object, an indicator, a button, an affordance, a toggle, a slider, a tool bar, a dock, a popup, a window, and/or another type of user interface object that has content embedded within and/or on the surface of a simulated glassy, translucent, and/or gelatinous material with a simulated three-dimensional volume defined by the first boundary, such as outlines and bounding surfaces in two or more dimensions. In some embodiments, at a first point in the respective animated transition, the first content is content drawn from a first portion of the first user interface that has a first spatial extent, and at a second point in the respective animated transition, the first content is drawn from a second portion of the first user interface that has a second spatial extent that is different from (e.g., encompassed by, encompassing, larger than, smaller than, offset from, and/or otherwise different in spatial extent) the first spatial extent. For example, as the “9” in FIG. 5AB is displayed as appearing, the simulated thickness of the material used to display the “9” is simulated as increasing over time (e.g., by changing a level of simulated refraction and/or other visual properties applied to the “9”), such that at step 1102-12, the simulated thickness of the “9” is greater than the simulated thickness at step 1102-9.

In some embodiments, while displaying, via the one or more display generation components, the first user interface, including the first user interface object (e.g., the first user interface object having the first edge with a steady state appearance based on the simulated refraction of respective content in the first user interface that is within a threshold distance of the first edge after the animated transition in response to the first event has been completed), the computer system detects occurrence of a second event (e.g., detecting the second event includes detecting elapse of time, detecting a user input, detecting a change in the context of the computer system, and/or detecting a change in an internal state of the computer system) different from the first event. In response to detecting the occurrence of the second event, the computer system displays, via the one or more display generation components, a respective animated transition corresponding to disappearance (e.g., removal from view, fading away, ceasing to be visible, ceasing to exist, and/or otherwise ceasing to be visible) of the first user interface object from the first user interface (e.g., the first user interface object recedes into the background of the first user interface, and/or transforms into another user interface object in the first user interface, in the respective animated transition), wherein the respective animated transition corresponding to the disappearance of the first user interface object includes gradually decreasing a visual intensity of the simulated refraction for the first edge (and, optionally one or more additional edges of the first user interface object) over time as the respective animated transition corresponding to the disappearance of the first user interface object progresses (e.g., decreasing the threshold distance from the first edge for the content that is used to generate the simulated refraction, and/or decreasing a degree of distortion applied to the content that is used to generate the simulated refraction, optionally, to illustrate a gradual change the curvature of the first edge, e.g., increasing curvature, as the first user interface object disappears from the first user interface). For example, as described with reference to FIG. 5AB, the “8” in the time indication is simulated as decreasing in simulated thickness by changing a level of simulated refraction and/or other visual properties of the top right portion of the “8” as the “8” disappears.

In some embodiments, the first edge of the first user interface object has a simulated thickness in a depth direction of the first user interface. In some embodiments, the respective animated transition corresponding to the appearance (and/or disappearance) of the first user interface object includes gradually changing (e.g., increasing, in the case of appearance of the first user interface object; and/or decreasing, in the case for disappearance of the first user interface object) the simulated thickness of the first edge that results in a gradual change in a simulated curvature of the first edge in the depth direction of the first user interface (e.g., increasing simulated curvature in the case of appearance of the first user interface object, and/or decreasing simulated curvature in the case of disappearance of the first user interface object). In some embodiments, the gradual change in the simulated curvature of the first edge is represented by a gradual change in the simulated refraction of the respective content in the first user interface (e.g., threshold distance within which content from the first user interface is used to generate the appearance of the first edge is gradually increased and/or decreased due to the gradual increase and/or decrease in the simulated curvature in the depth direction of the first user interface). For example, as described with reference to FIG. 5AB, the “9” in the time indication is simulated as increasing in simulated thickness by changing a level of simulated refraction and/or other visual properties of the “9” as the “9” appears.

In some embodiments, the first user interface object concurrently includes a first portion of the first user interface object that corresponds to the first edge, and a second portion of the first user interface object that is different from the first portion of the first user interface object (e.g., a second edge that is different from the first edge, and/or an interior portion other than an edge portion, an edge portion that is adjacent to the first edge). In some embodiments, the second portion of the first user interface object has an appearance based on simulated refraction of respective content in the first user interface that is within a threshold range of the second portion of the first user interface object (e.g., the respective content includes content of the first user interface that is covered by the second portion of the user interface object, content of the first user interface that is located near but not directly under the second portion of the first user interface object, and/or content embedded within the material of the second portion of the first user interface object). In some embodiments, the first portion of the first user interface object, including the first edge, has an appearance based on simulated refraction of respective content in the first user interface that is within a threshold range of the first edge (e.g., the respective content includes content of the first user interface that is covered by the first portion of the first user interface object, content of the first user interface that is located near but not directly under the first portion of the first user interface object, and/or content embedded within the material of the first portion of the first user interface object). In some embodiments, the respective animated transition corresponding to the appearance of the first user interface object includes gradually changing (e.g., increasing, and/or decreasing) a visual intensity of the simulated refraction (e.g., amounts of visual distortion, chromatic aberration, content displacement represented in the appearance of the user interface material and used to simulate refraction of interna and external content) for the second portion of the first user interface object over time as the respective animated transition corresponding to the appearance of the first user interface object progresses. Similarly, in some embodiments, the respective animated transition corresponding to the disappearance of the first user interface object includes gradually changing (e.g., increasing, and/or decreasing) the visual intensity of the simulated refraction for the second portion of the first user interface object over time as the respective animated transition corresponding to the disappearance of the first user interface object progresses. In some embodiments, a rate of change for the visual intensity of the simulated refraction for the second portion of the first user interface object (e.g., for the appearance of the first user interface object, and/or for disappearance of the first user interface object) differs from (e.g., is greater than, is smaller than, and/or is opposite in direction from) a rate of change for the visual intensity of the simulated refraction for the first edge (e.g., for the appearance of the first user interface object, and/or for disappearance of the first user interface object). For example, when displaying the animated transition for the appearance of the first user interface object and/or the animated transition for the disappearance of the first user interface object, the computer system gradually changes different portions of the first user interface object by different amounts (e.g., simulating one portion of the first user interface object getting thinner or thicker than other portions of the first user interface object), thereby causing different amounts of changes in simulated refraction by the different portions of the first user interface object (e.g., reducing the amounts of simulated refractions by different amounts for different portions of the first user interface object that are reducing in curvature and/or thickness in the depth direction; and/or increasing the amounts of simulated refractions by different amounts for different portions of the first user interface object that are increasing in curvature and/or thickness in the depth direction). In some embodiments, when one portion of the first user interface object is getting thinner or thicker than other portions of the first user interface object, the different portions of the first user interface object may be increasing in thickness by different rates at the same time, decreasing in thickness by different rates at the same time, and/or changing thickness in different directions at the same time. For example, as described with reference to FIG. 5AC, the simulated thickness (e.g., illustrated by z-direction in the simulated side view) of different portions of the 8 change by different amounts over time (e.g., from steps 1104-1 through 1104-4), including changing from a first uniform simulated thickness across the entire “8” along the y-axis, to a varying level of thickness (e.g., decreasing a simulated thickness of the lower and middle portions (along the y-axis) of the “8” compared to the top portion of the “8” (along the y-axis)).

In some embodiments, prior to detecting the occurrence of the first event, the first user interface includes a second user interface object that is different from the first user interface object (e.g., the first user interface does not include the first user interface object when the second user interface object is included in the first user interface). In some embodiments, displaying the respective animated transition corresponding to the appearance of the first user interface object includes replacing the second user interface object with the first user interface object. In some embodiments, displaying the respective animated transition corresponding to the appearance of the first user interface object includes replacing the second user interface object with the first user interface object includes gradually changing a first simulated property (e.g., reducing and/or increasing the simulated thicknesses, reducing and/or increasing simulated refraction, reducing and/or increasing blur, and/or changing one or more other simulated properties in one or more ways) of one or more portions of a user interface material of the second user interface object while maintaining display of the user interface material of the second user interface object (e.g., at least a portion of the second user interface object remains visible during the animated changes to remove the second user interface object from the first user interface). In some embodiments, displaying the respective animated transition corresponding to the appearance of the first user interface object includes replacing the second user interface object with the first user interface object includes gradually changing a first simulated property (e.g., increasing and/or decreasing the simulated thicknesses, increasing and/or decreasing simulated refraction, increasing and/or decreasing blur, and/or changing one or more other simulated properties in one or more ways) of one or more portions of a user interface material of the first user interface object (e.g., a user interface material that is the same as the user interface material used for the second user interface object, or a user interface material that is different from the user interface material used for the second user interface object) while maintaining display of the user interface material of the second user interface object (e.g., a portion of the first user interface object and a portion of the second user interface object are concurrently visible during at least a portion of the animated transition to replace the second user interface object with the first user interface object and/or transform the second user interface object into the first user interface object). In some embodiments, the first user interface includes an indication of the current time of day, and the indication of the current time of day includes two or more numerals representing different segments of a current time value (e.g., one or two numerals for the hour, one or two numerals for the minute, and one or two numerals for the second). In some embodiments, the user interface object that corresponds to a numeral of a time segment starts to change when it is time to switch to a different numeral for the time segment (e.g., the different numerals are displayed at the same location within the indication of the current time, and may overlap in position for at least portions of the different numerals). In some embodiments, the user interface object for the current numeral includes a user interface material (e.g., a simulated glassy and/or gelatinous material) that has an appearance based on simulated refraction of its nearby content (e.g., content underlying the numeral, within the numeral, and/or adjacent the numeral), and this appearance starts to change as the simulated thicknesses of the user interface object at different portions of the user interface object start to reduce (e.g., optionally, with higher rates of change in the upper portion of the numeral, and lower rates of change in the lower portion of the numeral), and as a result, some portions of the user interface object ceases to be displayed (e.g., with zero simulated thicknesses in the depth direction) while other portions remains visible (e.g., albeit with smaller thicknesses than before). In some embodiments, at the same time when the currently displayed numeral is disappearing, in at least a subset of the space previously occupied by disappeared portions of the currently displayed numeral, portions of the new numeral are increasing in simulated thicknesses (and showing changing appearances due to changes in simulated refraction of nearby content). Eventually, at the completion of the animated transition, the new numeral is completely displayed and completely replaces the previously displayed numeral. The process is repeated when it is time to change to yet another new numeral for the time segment. Additional details are described with respect to FIGS. 5AE-5AG and method 13000. It is also to be understood that the first user interface object and the second user interface object are not limited to numerals in an indication of current time of day, and may be other types of user interface objects such as indicators, controls, notifications, and/or other user interface objects that are replaced in location by user interface objects that are visually associated with similar user interface materials. For example, as described with reference to FIGS. 5AB-5AC, replacing the “8” with the “9” includes gradually over time decreasing a simulated thickness of the “8” as it disappears while gradually over time increasing a simulated thickness of the “9” as it appears.

In some embodiments, the occurrence of the first event corresponds to a condition for changing a first numeral in the indication of current time to a second numeral in the indication of current time being met (e.g., the current time value changes due to elapse of time, and/or based on manual adjustment of the current time). In some embodiments, the first user interface object corresponds to the second numeral in the indication of current time. In some embodiments, displaying the respective animated transition corresponding to the appearance of the first user interface object includes gradually changing one or more respective simulated thicknesses (e.g., reducing the simulated thickness) of one or more corresponding portions of a user interface material of the first numeral while maintaining display of the user interface material of the first numeral (e.g., at least a portion of the first numeral remains visible during the animated changes to remove the first numeral from the first user interface). In some embodiments, In some embodiments, displaying the respective animated transition corresponding to the appearance of the first user interface object includes gradually changing one or more respective simulated thicknesses (e.g., increasing the simulated thicknesses) of one or more corresponding portions of a user interface material of the second numeral (e.g., same as the user interface material used for the first numeral, or different from the user interface material used for the first numeral) while maintaining display of the user interface material of the first numeral (e.g., a portion of the second numeral and a portion of the first numeral are concurrently visible during at least a portion of the animated transition to replace the first numeral with the second numeral and/or transform the first numeral into the second numeral). In some embodiments, the first numeral includes a user interface material (e.g., a simulated glassy and/or gelatinous material) that has an appearance based on simulated refraction of its nearby content (e.g., content underlying the numeral, within the numeral, and/or adjacent the numeral), and this appearance starts to change as the simulated thicknesses of the first numeral at different portions of the first numeral start to reduce (e.g., optionally, with higher rates of change in the upper portion of the numeral, and lower rates of change in the lower portion of the numeral), and as a result, some portions of the first numeral cease to be displayed (e.g., with zero simulated thicknesses in the depth direction) while other portions remain visible (e.g., albeit with smaller thicknesses than before). In some embodiments, at the same time when the first numeral is disappearing, in at least a subset of the space previously occupied by disappeared portions of the first numeral, portions of the second numeral are increasing in simulated thicknesses (and showing changing appearances due to changes in simulated refraction of nearby content). Eventually, at the completion of the animated transition, the second numeral is completely displayed and completely replaces the first numeral. The process is repeated when it is time to change to yet another new numeral for the time segment. Additional details are described with respect to FIGS. 5AE-5AG and method 13000. It is also to be understood that the first numeral and the second numeral are not limited to numerals in an indication of current time of day, and may be other types of user interface objects such as indicators, controls, notifications, and/or other user interface objects that are replaced in location by user interface objects that are visually associated with similar user interface materials. For example, as described with reference to FIGS. 5AB-5AC, in accordance with a determination that there is a change in time (e.g., from 9:58 to 9:59), an animated transition of the changing numeral(s) is displayed.

In some embodiments, the occurrence of the first event corresponds to a condition for displaying a first control in the first user interface being met. In some embodiments, the first control was not displayed prior to the occurrence of the first event, and the location of the first control is optionally unoccupied by other user interface objects or occupied by another user interface object different from the first control. In some embodiments, the condition for displaying the first control includes the detection of a system event (e.g., activation of a hardware affordance corresponding to the first control, changed location of the computer system, a subscribed event generating displaying an event update on the first user interface, connection of a peripheral device, and/or other types of system events that trigger display of a control) and/or an application update (e.g., arrival of a new notification or alert, navigation to a new user interface, scrolling of content, selection of a selectable option in a menu, and/or other types of application events that trigger display of a control). In some embodiments, displaying the respective animated transition corresponding to appearance of the first user interface object includes gradually changing respective simulated thicknesses (e.g., increasing the simulated thicknesses from zero to one or more non-zero simulated thicknesses) of one or more portions of the first control, that includes gradually changing one or more respective intensities of simulated refractions for the one or more corresponding portions of the first control. For example, as described with reference to FIGS. 5N-5Q, a simulated thickness of the simulated glass material of keyboard 736 is animated to increase as the keyboard 736 appears. As described with reference to FIGS. 5AE-5AF, in some embodiments, in response to the occurrence of the appearance of notification 1124 (e.g., displayed with simulated glass material), a simulated thickness of the notification 1124 is simulated as increasing over time.

In some embodiments, displaying the respective animated transition corresponding to appearance of the first user interface object includes, in accordance with a determination that the first control replaces another user interface object at a location of the first control (e.g., the first control is transformed from the user interface material of another user interface object previously occupying the location of the first control, and/or is transformed from another user interface object through a series of animated changes), gradually changing one or more respective simulated thicknesses (e.g., increasing the simulated thicknesses from zero to one or more non-zero simulated thicknesses) of one or more corresponding portions of the first control. In some embodiments, displaying the respective animated transition corresponding to appearance of the first user interface object includes, in accordance with a determination that the first control does not replace another user interface object at the location of the first control (e.g., the first control is displayed in an unoccupied region of the first user interface, and is not transformed from another user interface object through a series of animated changes), forgoing gradually changing the one or more respective simulated thicknesses of one or more corresponding portions of the first control (e.g., the first control is displayed with its steady appearance immediately, and/or the first control is displayed with its steady state thicknesses right away without animated changes in the simulated thicknesses). For example, as described with reference to FIGS. 5R-5UV, the simulated thickness of platter 810, transitional platters 814-1 to 814-3, and platter 816-1 is maintained as the platter 816-1 replaces platter 810.

In some embodiments, the occurrence of the first event corresponds to detecting, via the one or more input devices, a user input directed to the first user interface. In some embodiments, the computer system displays the first user interface object in response to detecting user interaction with the first user interface, such as detecting a touch gesture, a click input, an air pinch gesture, and/or another type of input directed a portion of the first user interface, such as a background portion of the first user interface, or a user interface object displayed in the first user interface. In some embodiments, the user input directed to the first user interface includes a selection input directed to a control, an icon, an indicator, a menu option, and/or another type of user interface object that is associated with displaying the first user interface object. In some embodiments, the user input includes a stationary input (e.g., a touch and hold gesture, a click and hold input, and/or an air pinch and hold gesture) that meets a duration threshold, an intensity threshold, and/or other criteria, and/or a drag input (e.g., a swipe gesture, a click and drag input, and/or an air pinch and drag gesture) that meets distance threshold, duration threshold, and/or speed threshold. In some embodiments, displaying the respective animated transition corresponding to appearance of the first user interface object includes gradually changing one or more respective simulated thicknesses (e.g., increasing the simulated thicknesses from zero to one or more non-zero simulated thicknesses) of one or more corresponding portions of the first user interface object, that includes gradually changing one or more respective intensities of the one or more simulated refractions for the one or more corresponding portions of the first user interface object (e.g., the first user interface object is displayed in response to detecting the user input directed to the first user interface, and is displayed with animate changes in thickness of a simulated material for the first user interface object as the first user interface object appears in the first user interface). For example, as described with reference to FIG. 5Z4, a simulated change in thickness of user interface object 922-1 is displayed in response to detecting the user input 924-1 (e.g., in FIG. 5Z1).

In some embodiments, the first user interface object corresponds to a portion (e.g., a subset, less than all, or an entirety) of a second user interface object (e.g., a toggle control, and/or a multi-state control including a state indicator displayed relative to a platter of the multi-state control at a position indicating a current state of the multi-state control). In some embodiments, the second user interface object was displayed in the first user interface (e.g., optionally with a user interface material that does not have an appearance based on simulated refraction of nearby and/or embedded content) when the occurrence of the first event was detected. In some embodiments, detecting the user input directed to the first user interface includes detecting the user input directed to the second user interface object (e.g., detecting an input that corresponds to a user interaction and/or an intent of user interaction with the toggle control and/or multi-state control). In some embodiments, displaying the respective animated transition corresponding to appearance of the first user interface object includes gradually changing one or more respective simulated thicknesses (e.g., increasing the simulated thicknesses from zero to one or more non-zero simulated thicknesses) of one or more corresponding portions of the second user interface object (e.g., a subset, less than all, or an entirety of the second user interface object), that transform into the first user interface object (e.g., the first user interface object is displayed in response to detecting the user input directed to the second user interface object, and is displayed with animate changes in thickness of a simulated material for the second user interface object that eventually transforms into the first user interface object). In some embodiments, the second user interface object is a toggle control that includes a platter and a state indicator overlaying a portion of the platter to indicate a current state of the toggle control. In some embodiments, when the toggle control is displayed in a steady state, the toggle control is displayed with a uniform simulated thickness (e.g., a zero thickness or a uniform non-zero thickness). In some embodiments, in response to detecting an input directed to the toggle control (e.g., a tap gesture, an air pinch gesture, a click input, and/or another type of input, to change the toggle state or selecting the toggle control), the platter and/or the state indicator are shown to change in simulated thickness (e.g., raises from the surface of the toggle control) with a changed appearance due to changed simulated refraction by the user interface material of the platter and/or the state indicator. For example, as described with reference to FIG. 5AA, the switch 1104-1 (e.g., the first user interface object) of toggle 1002-1 (e.g., a second user interface object) appears to increase in simulated thickness in response to detecting the user input 1003-1.

In some embodiments, the first user interface includes a plurality of user interface objects that are responsive to user interaction (e.g., a photo library user interface that includes a plurality of images that can be individually selected, dragged, and/or resized in response to user inputs directed to respective images, a media player user interface that includes playback controls that can be respectively activated to perform different operations, and/or other types of user interfaces that includes different selectable and/or interactive elements). In some embodiments, the first user interface object corresponds to an indication that user interaction with a respective set of one or more user interface objects of the plurality of user interface objects is ongoing. In some embodiments, the first user interface object is a visual indication in the form of a bounding box, highlighting, visual effect, that is applied to a location corresponding to a currently selected control in a segmented controller that includes plurality of controls, and/or corresponding to another set of one or more objects in a user interface that include a plurality of other types of objects on a common platter and/or container. In some embodiments, when none of the plurality of controls and/or objects are selected and/or are the targets of ongoing user interaction (e.g., before the first event and/or user input directed to the first user interface was detected), the first user interface object is optionally not displayed and/or is displayed without an appearance that has a simulated non-zero thickness and/or that simulates refraction of content that is within and/or adjacent to the first user interface object. In some embodiments, detecting the user input directed to the first user interface includes detecting the user input directed to the respective set of one or more user interface objects of the plurality of user interface objects (e.g., detecting an input that corresponds to a user interaction and/or an intent of user interaction with one of the controls in a segmented controller and/or one or more of the objects in the first user interface that are responsive to the user input). In some embodiments, while the user input directed to the respective set of one or more user interface objects is ongoing (and, optionally, for a period of time after the termination of the user input), displaying the respective animated transition corresponding to appearance of the first user interface object includes displaying the first user interface object at a location corresponding to the respective set of one or more user interface objects (e.g., to indicate that the user interaction is ongoing with respect to the respective set of one or more user interface objects). In some embodiments, displaying the respective animated transition corresponding to appearance of the first user interface object includes gradually changing respective simulated thicknesses (e.g., increasing the simulated thicknesses from zero to one or more non-zero simulated thicknesses) of one or more portions of the first user interface object (e.g., the first user interface object is displayed in response to detecting the user input directed to the respective set of one or more user interface objects, and is displayed with animate changes in thickness of a simulated material of the first user interface object at the location of the respective set of one or more user interface objects). In some embodiments, the first user interface object includes a simulated three-dimensional volume of a user interface material, such as a simulated glassy and/or gelatinous material, that has an appearance that simulates refraction of content that is within and/or adjacent to the first user interface object. In some embodiments, the first user interface object encloses and/or overlays the respective set of one or more user interface objects with which user interaction is ongoing, without enclosing and/or overlaying other user interface objects that are not currently selected and/or that are not the targets of ongoing user interaction, to visually distinguishing the respective set of one or more user interface objects from other user interface objects in the first user interfaced. In some embodiments, the user input that interacts with a respective user interface object does not necessarily activates the respective user interface object, and the display of the first user interface object at the location of the respective sets of user interface objects indicates the location of the user input and provides a visual indication regarding the currently selected target of a subsequent user input. For example, as described with reference to FIGS. 5Z1-5Z4, the simulated thickness of the user interface object 922-1 is gradually increased as the user selects one of the options (e.g., “Years,” “Months,” or “All”) corresponding to a plurality of user interface objects.

In some embodiments, while the user input directed to the respective user interface object is ongoing (and, optionally, for a period of time after the termination of the user input), the computer system displays, within the first user interface object, an indication of a currently selected state of the respective set of one or more user interface objects (e.g., to indicate that the user interaction is ongoing with respect to the respective set of user interface objects) while gradually changing the respective simulated thicknesses (e.g., increasing the simulated thicknesses from zero to one or more non-zero simulated thicknesses) of the one or more portions of the first user interface object. In some embodiments, when a user input is directed to a segmented controller with multiple controls, the currently selected controls are shown with a glassy appearance as well as an indication of its selected state (e.g., an outline, a highlight, a different size, and/or other visual indications of the selected state that distinguish selected controls from unselected controls). For example, in FIG. 5Z2, the currently selected option (e.g., between “Months” and “All” in FIG. 5Z2) is indicated by visually emphasizing the content under the user interface object 922-2.

In some embodiments, prior to detecting the user input directed to the first user interface, the first user interface concurrently includes content of a first content page from a plurality of content pages, and a plurality of different tabs that correspond to different content pages of a plurality of content pages (e.g., a first tab that corresponds to a first content page and a second tab, different from the first tab, that corresponds to a second content page, different from the first content page). For example, the different tabs include respective tabs that correspond to different webpages in a browser user interface, respective bookmarks that correspond to different bookmarked pages in a document, respective tabs corresponding to different categories of stored notes, and/or other types of objects that correspond to different pages of content that are not concurrently displayed in the first user interface. In some embodiments, prior to detecting the user input directed to the first user interface, the first user interface also concurrently includes a second user interface object is displayed at a location of a first tab, the first tab corresponding to the first content page that is currently displayed in the first user interface. In some embodiments, the second user interface object is a visual indication in the form of a bounding box, highlighting, visual effect, that is applied to a location corresponding to the tab of a currently content page. In some embodiments, detecting the user input directed to the first user interface includes, detecting the user input that is directed toward a second tab and that corresponds to a request to display a second content page of the plurality of content pages in the first user interface (e.g., replacing the first content page as the currently displayed content page in the first user interface). In some embodiments, in response to detecting the user input that is directed toward the second tab, the computer system replaces display of the first content page with the second content page. In some embodiments, the user input includes a tap gesture at a location that corresponds to the second tab, a drag gesture that drags the second user interface object to the location of the second tab where the material of the second user interface object transforms into the first user interface object at the location of the second tab. In some embodiments, other types of user input, such as an air pinch gesture, an air pinch and drag gesture, a click input, a click and drag input, and/or other types of user input that are equivalent to the tap gesture and/or drag gesture described above are optionally used instead of the tap gesture and/or drag gesture. In some embodiments, displaying the respective animated transition corresponding to appearance of the first user interface object includes displaying the first user interface object at a location of the second tab (e.g., the first user interface object is displayed as a visual indication in the form of a bounding box, highlighting, visual effect, that is applied to a location corresponding to the second tab), and gradually changing respective simulated thicknesses (e.g., increasing the simulated thicknesses from zero to one or more non-zero simulated thicknesses) of one or more portions of the first user interface object (e.g., the first user interface object is displayed at the location of the second tab in response to detecting the user input directed to the second tab, and is displayed with animate changes in thickness of a simulated material for the first user interface object). In some embodiments, the animated transition also includes a user interface material of the second user interface object reducing in simulated thicknesses, moving from the location of the first tab toward the location of the second tab, before transforming into the user interface material of the first user interface object that is displayed at the location of the second tab. In some embodiments, the animated transition also includes a user interface material of the second user interface object reducing in simulated thicknesses and ceasing to be displayed at the location of the first tab, while the user interface material of the first user interface object is displayed at the location of the second tab and increases in simulated thicknesses before settling into the form of the first user interface object at the location of the second tab. For example, as described with reference to FIG. 6AC, the simulated thickness of the selection indicator 6730 is gradually increased as the user selects one of the tabs (e.g., corresponding to different pages) in page menu 6704.

In some embodiments, prior to detecting the user input directed to the first user interface, the first user interface concurrently includes: content of a first content page from a plurality of content pages (e.g., a plurality of user interfaces in a hierarchy of user interfaces, such as those in an application, file system, and/or operating system, and/or a plurality of content pages in a sequence of content pages and/or a hierarchy of content pages); and a first navigation control (e.g., a “back” button, optionally with internal text or glyphs indicating an identifier of a last displayed content page) that, when selected by a user input, causes navigation from the first content page to a previously displayed content page of the plurality of content pages (e.g., the last displayed content page and/or user interface that was displayed prior to the first content page and/or user interface). In some embodiments, detecting the user input directed to the first user interface includes, detecting the user input that corresponds to a request to navigate from the first content page to the previously displayed content page (e.g., detecting a user input that is directed to and/or selects the first navigation control, and/or detecting a user input that is directed to the first content page that corresponds to a request to navigate to the previously displayed content page). In some embodiments, the user input is an edge swipe gesture that includes movement across the user interface that meets navigation criteria (e.g., includes horizontal movement across a bottom edge portion of the user interface and/or from a right edge or left edge of the user interface, starts on a side edge of the user interface and moves across the user interface after having been kept substantially stationary at the side edge for at least a threshold amount of movement, and/or includes an upward edge swipe followed by a swipe to the side of the user interface). In some embodiments, the user input includes movement of an input element such as a mouse, stylus, hand, and/or controller that meets navigation criteria for navigating from the currently displayed user interface to a previously displayed user interface. In some embodiments, detecting the user input that corresponds to a request to navigate from the first content page to the previously displayed content page includes detecting a user input selecting the first navigation control (e.g., a tap gesture by a contact, a click input by a mouse, a double click input by a mouse, an air pinch gesture detected while the user's attention is directed to the first navigation control, and/or other types of selection input that targets the first navigation control). In some embodiments, displaying the respective animated transition corresponding to appearance of the first user interface object includes gradually changing respective simulated thicknesses of one or more portions of the first user interface object at the location of the first navigation control (e.g., the first navigation control becomes increasingly glassy with increasing simulated thickness, while the internal content of the first navigation control is gradually replaced by the text and/or glyphs corresponding to the last displayed content page). For example, as described with reference to FIGS. 5Q2-5Q2B, the mailboxes navigation button 5016 ceases to be displayed while transitioning from the user interface 722 to the user interface 5022, including displaying a simulated decrease in simulated thickness of the button 5016 as the button 5016 ceases to be displayed in the user interface 5022.

In some embodiments, in response to detecting the user input that corresponds to a request to navigate from the first content page to the previously displayed content page, the computer system: in accordance with a determination that the user input that corresponds to a request to navigate from the first content page to the previously displayed content page includes a first movement input (e.g., a swipe gesture, an air pinch and drag gesture, a click and drag input, and/or another type of movement input) and a termination of the first movement input (e.g., a liftoff of the contact that provides the swipe gesture, the release of the pinched posture of the hand that provides the air pinch and drag gesture, and/or a release of a mouse button that provides the click and drag input, that caused the navigation to the previously displayed content page): ceases to display the first content page (e.g., gradually and, optionally, reversibly, moving the first content page out of view, and/or fading out the first content page, in accordance with the progression of the first movement input); displays the previously displayed content page (e.g., gradually and, optionally, reversibly, moving the second content page into view, and/or fading in the second content page, in accordance with the progression of the first movement input); displays a first gradual change in the respective simulated thicknesses of one or more portions of the first user interface object at the location of the first navigation control during the first movement input (e.g., gradually and, optionally, reversibly, increasing the simulated thicknesses of one or more portions of the first user interface object, in accordance with the progression of the first movement input); and completes the respective animated transition corresponding to appearance of the first user interface object in response to detecting the termination of the first movement input (e.g., the animated transition arrives at the final thickness of the first user interface object after the termination of the first movement input is detected, at which point the navigation to the second content page and the appearance of the first user interface object is no longer reversible by a continuation of the movement of the first movement input). For example, as described with reference to FIGS. 5Q2-5Q2B, the animated transition that simulates a decrease in simulated thickness of button 5016 completes in response to detecting an end of the user input 5020′.

In some embodiments, in response to detecting the user input that corresponds to a request to navigate from the first content page to the previously displayed content page, the computer system: in accordance with a determination that the user input that corresponds to a request to navigate from the first content page to the previously displayed content page includes a first discrete input (e.g., a tap gesture, an air pinch gesture, a click input, and/or another type of discrete input, that selects the first navigation control) that includes less than a threshold amount of movement in a unit of time and terminates within a threshold amount of time from a start of the first discrete input (e.g., the first discrete input is not an extended input and/or does not have an indefinite termination time and/or termination location): ceases to display the first content page (e.g., moving the first content page out of view, and/or fading out the first content page, in a fixed amount of animation time after detecting the first discrete input); displays the previously displayed content page (e.g., moving the second content page into view, and/or fading in the second content page, in the fixed amount of animation time after detecting the first discrete input); and displays a second gradual change in the respective simulated thicknesses of one or more portions of the first user interface object at the location of the first navigation control, wherein the second gradual change is different from the first gradual change. In some embodiments, the second gradual change is different from the first gradual change because the second gradual change occurs over a fixed amount of animation time (e.g., increasing the simulated thicknesses of one or more portions of the first user interface object, in the fixed amount of animation time for the appearance of the first user interface object) to complete the respective animated transition corresponding to appearance of the first user interface object, while the first gradual change occurs over an amount of time that is dependent on how far the transition had progressed before the detecting termination of the first movement input. For example, the animated transition that includes the second gradual change arrives at the final thickness of the first user interface object after a fixed amount of animation time, at which point the navigation to the second content page and the appearance of the first user interface object is also completed). In some embodiments, the internal content of the first user interface object also changes from indicating the previously displayed content page to indicating another earlier displayed content page (e.g., navigating to another level up the content page and/or user interface hierarchy). For example, as described with reference to FIGS. 5Q2B-5Q2F, in response to detecting a user input 5024, the button 5016″ is displayed as gradually increasing in simulated thickness while transitioning to display the user interface 722 that includes button 5016.

In some embodiments, the first user interface includes textual content (e.g., editable text, and/or non-editable text, optionally including graphics and other types of content among the textual content, such as in a document, a webpage, a canvas, a poster, and/or other types of textual and/or mixed media content). In some embodiments, the textual content includes insertion locations between characters and paragraphs for defining boundaries of a portion of textual content for selection, deletion, and/or applying other text editing operations. In some embodiments, detecting the occurrence of the first event includes detecting, via the one or more input devices, a user input that is directed to a first portion of the textual content and that corresponds to a request to interact with the textual content (e.g., a tap and hold gesture by a contact at a location in the textual content, a click input, a touch hold and swipe gesture, a light press input, and/or another type of user input that interacts with the textual content). In some embodiments, displaying the respective animated transition corresponding to appearance of the first user interface object includes gradually changing respective simulated thicknesses (e.g., increasing the simulated thicknesses from zero to one or more non-zero simulated thicknesses) of one or more portions of the first user interface object (e.g., that includes gradually changing respective intensities of simulated refractions of the first portion of the textual content, optionally, while the first user interface object is displayed at a location that is offset from the location of the first portion of the textual content). In some embodiments, the computer system detects a touch gesture, a click input, and/or another type of user input directed to a location that corresponds to a first portion of the textual content; and in response to detecting the user input, the computer system moves a cursor to and/or displays the cursor at an insertion point in the first portion of the textual content (e.g., displaying a cursor at the begging of the first portion of the textual content and/or highlighting a word in the first portion of the textual content), and displays a magnifying loupe at a location that is offset from the first portion of the textual content (e.g., shifted upward, and/or shift in other directions, to avoid obscuring the cursor and the first portion of the textual content), wherein the magnifying loupe has a simulated three-dimensional shape that increases in simulated thickness and changes curvatures of its bounding surface during the animated transition (e.g., like a drop of liquid glass or gelatinous material forming on a sheet of paper with surface tension), and wherein the magnifying loupe has an appearance that simulates fraction of the first portion of the textual content (e.g., including distortion, tinting, color aberration, and/or other visual effects). In some embodiments, instead of displaying the magnifying loupe and/or in addition to displaying the magnifying loupe, the computer system optionally displays a menu with editing options (e.g., a menu that is visually associated with a user interface material with non-zero thickness and that has simulated optical interaction with its internal content and/or external content). For example, as described with reference to FIG. 5Z, in response to detecting the user input 910-1, a loupe 909-2 gradually appears, including animating a gradual increase in simulated thickness of the loupe 909-2 (e.g., as compared to the simulated thickness of loupe 909-1).

In some embodiments, detecting the user input that is directed to the first portion of the textual content and that corresponds to the request to interact with the textual content, includes a user input (e.g., tap gesture, click input, air pinch gesture, tap and hold gesture, touch-hold and drag gesture, air pinch and drag gesture, click and drag input, and/or other types of input) that corresponds to a request to move a cursor relative to the textual content (e.g., to the location of the first portion of the textual content). In some embodiments, detecting the user input includes detecting a contact at a location that corresponds to the first portion of the textual content, and detecting that the contact is maintained at the location for at least a threshold amount of time with less than a threshold amount of movement per unit of time. In some embodiments, in response to detecting that the contact is maintained at the location for at least the threshold amount of time with less than the threshold amount of movement per unit of time, the computer system displays a cursor at the location of the first portion of the textual content and displays the magnifying loupe. In some embodiments, detecting the user input includes detecting a click and drag input when a focus selector is at a location of the first portion of the textual input; and in response to detecting the click and drag input, the computer system displays a text selection object (e.g., corresponding to the first user interface object that has the non-zero thicknesses) defining the start and end of a textual selection at a location of the first portion of the textual input, and displays a menu of editing options for the selected text. For example, as described with reference to FIG. 5Z, the user input 910-1 corresponds to a request to move a cursor position within the text.

In some embodiments, detecting the user input that is directed to the first portion of the textual content and that corresponds to a request to interact with the textual content includes a user input (e.g., tap gesture, click input, air pinch gesture, tap and hold gesture, touch-hold and drag gesture, air pinch and drag gesture, click and drag input, and/or other types of input) that corresponds to a request to select the first portion of the textual content. In some embodiments, detecting the user input includes detecting a contact at a location that corresponds to the first portion of the textual content, and detecting that the contact is maintained at the location for at least a threshold amount of time with less than a threshold amount of movement per unit of time. In some embodiments, in response to detecting that the contact is maintained at the location for at least the threshold amount of time with less than the threshold amount of movement per unit of time, the computer system selects the first portion of the textual content and displays the text selection (e.g., corresponding to the first user interface object) with a simulated material with non-zero thickness. In some embodiments, detecting the user input includes detecting a click and drag input when a focus selector is at a location of the first portion of the textual input, and in response to detecting the click and drag input, the computer system displays a text selection object (e.g., corresponding to the first user interface object that has the non-zero thicknesses) defining the start and end of a textual selection at a location of the first portion of the textual input. For example, as described with reference to FIG. 5Z, in some embodiments, the user input 910-1 corresponds to a request to select and/or highlight a portion of the text.

In some embodiments, displaying the respective animated transition corresponding to appearance of the first user interface object (e.g., a magnifying loupe, and/or a text selection object that has a spatial extent corresponding to a spatial extent of the selected textual content) includes displaying the first user interface object with an appearance that simulates refraction of at least a subset of the textual content (e.g., optionally gradually changing the intensities of the simulated refraction in accordance with changing the simulated thicknesses of the first user interface object, and maintaining a steady state appearance of the first user interface object that simulates refraction of the first portion of the textual content and/or at least a subset of the first portion of the contextual content). In some embodiments, when the first user interface object is a text selection object, the first user interface object expands and/or contracts when the user input moves a boundary of the first user interface object, and as the boundary of the first user interface object moves, the portions of the first user interface object at the boundary have appearances that simulate refraction of nearby content at a higher intensity than content that are farther away from the boundary (e.g., simulated refractions of different portions of the content are shown at the boundary region of the first user interface object as the boundary of the first user interface object moves relative to the textual content in accordance with the user input). For example, as described with reference to FIG. 5Z, the user interface element 912 is displayed with a simulated glass material that refracts background content (e.g., text and indicator 908).

In some embodiments, displaying the first user interface object with the appearance that simulates refraction of at least the subset of the textual content includes displaying the first user interface object at a location that is different from a location of the first portion of the textual content (e.g., the magnifying loupe is displayed at a location away from the location of the user input and/or the location of the textual content that is the target of the user input). In some embodiments, displaying the first user interface object with an appearance that simulates refraction of at least a subset of the first portion of the textual content (e.g., even though the magnifying loupe is displayed away from the first portion of the textual content, the appearance of the magnifying loupe is based on simulated refraction of the first portion of the textual content, optionally obscuring the textual content that was displayed at the location of the loupe). For example, as described with reference to FIG. 5Z, the user interface element 912 is displayed with a simulated glass material that refracts background content (e.g., text and indicator 908) that is positioned under the user input 910-2.

In some embodiments, gradually changing respective simulated thicknesses (e.g., increasing the simulated thicknesses from zero to one or more non-zero simulated thicknesses) of one or more portions of the first user interface object includes displaying the first user interface object with an appearance that simulates optical interaction between a user interface material (e.g., a glassy material, a gelatinous material, a translucent material, and/or other types of user interface material with simulated spatial properties and simulated material properties) of the first user interface object and at least the subset of the textual content (e.g., as if the user interface material were located at the location of the subset of textual content, overlaying at least a portion of the subset of textual content and/or is adjacent to at least a portion of the subset of textual content). In some embodiments, the simulated refraction is shown in the appearance of the first user interface object, which is generated based on content distortion, blurring, darkening, tinting, chromatic aberration, and/or other visual effects applied to the subset of the textual content). For example, as described with reference to FIGS. 5Z and 6A-6C, the simulated glass material of the user interface element 912-1 refracts underlying content (e.g., external refraction 6003C2).

In some embodiments, the first user interface object corresponds to a text selection object displayed at a location of the first portion of the textual content (e.g., the first user interface object is a glassy material enclosing the first portion of the textual content, visually highlighting the selected text relative to unselected text, and/or the first user interface object serves as indicators of boundaries of the text selection). For example, as described with reference to FIG. 5Z, the user interface element 912 is displayed with a simulated glass material that refracts indicator 908, highlighted portions of text and/or selection endpoint pins.

In some embodiments, displaying the respective animated transition that corresponds to appearance of the first user interface object includes gradually changing simulated thicknesses of one or more portions of the first user interface object, and gradually changing a visual appearance of the first user interface object (e.g., how the first user interface object looks when it is emerging and eventually reaching a stead state in the first user interface) that simulates refraction of content in the first user interface (e.g., content that is underlying the first user interface object, and/or adjacent to the first user interface object) according to the changes in simulated thicknesses of the one or more portions of the first user interface object (e.g., the thicknesses, locations, and/or curvatures of various edges, corners, and/or surfaces of the user interface material of the first user interface object are used as parameters to generate the simulated refraction of content within and near the user interface material, and displayed as part of the visual appearance of the first user interface object). For example, as described with reference to FIGS. 6A-6B4, changing a simulated thickness of a user interface element displayed with the simulated user interface material includes changing values of one or more visual properties of the simulated user interface materials, including a level of refraction of underlying content (6003C2).

In some embodiments, displaying the respective animated transition that corresponds to appearance of the first user interface object includes gradually changing simulated thicknesses of one or more portions of the first user interface object, and gradually changing a visual appearance of the first user interface object (e.g., how the first user interface object looks when it is emerging and eventually reaching a stead state in the first user interface) by applying an amount of blur to content in the first user interface (e.g., content that is underlying the first user interface object, and/or adjacent to the first user interface object) according to the changes in one or more simulated thicknesses of the one or more corresponding portions of the first user interface object (e.g., the thicknesses, locations, and/or curvatures of various edges, corners, and/or surfaces of the user interface material of the first user interface object are used as parameters to generate a blurred version of the content within and near the user interface material, and displayed as part of the visual appearance of the first user interface object). For example, as described with reference to FIGS. 6A-6B4, changing a simulated thickness of a user interface element displayed with the simulated user interface material includes changing values of one or more visual properties of the simulated user interface materials, including a level of blurring of underlying content (6003B).

In some embodiments, displaying the respective animated transition that corresponds to appearance of the first user interface object includes gradually changing one or more simulated thicknesses of one or more corresponding portions of the first user interface object, and gradually changing a visual appearance of the first user interface object (e.g., how the first user interface object looks when it is emerging and eventually reaching a stead state in the first user interface) by changing a position and/or appearance of one or more simulated specular highlights according to the changes in simulated thicknesses of the one or more portions of the first user interface object (e.g., the thicknesses, locations, and/or curvatures of various edges, corners, and/or surfaces of the user interface material of the first user interface object are used as parameters to generate specular highlights that are displayed as part of the visual appearance of the first user interface object). For example, as described with reference to FIGS. 6A-6B4, changing a simulated thickness of a user interface element displayed with the simulated user interface material includes changing values of one or more visual properties of the simulated user interface materials, including changing virtual lighting effects such as specular highlighting (6003K).

In some embodiments, displaying the respective animated transition that corresponds to appearance of the first user interface object includes displaying a simulated shadow (e.g., simulated shadow cast by the first user interface object, that has positions, shapes, and/or sizes that are based on the changing thicknesses of the first user interface object) overlaying a portion of the first user interface that is outside of the first user interface object (e.g., content that is adjacent to, and not underlying the first user interface object). In some embodiments, displaying the respective animated transition that corresponds to appearance of the first user interface object includes displaying at least a portion of the first user interface object (e.g., an edge portion, such as the portion including the first edge and/or another edge of the first user interface object) with a visual appearance that simulates refraction of content in the portion of the first user interface that is overlaid by the simulated shadow (e.g., without simulating refraction of the simulated shadow itself), and that simulates refraction of content that is overlaid by the first user interface object. In some embodiments, the appearance that simulates refraction of underlying content and refraction of nearby content, where the simulated refraction is based on the appearance of the content that is not modified by the simulated shadow, even though the simulated shadow overlays the content adjacent to the first user interface object when it is displayed concurrently with the first user interface object. For example, as described with reference to FIGS. 6A-6B4, changing a simulated thickness of a user interface element displayed with the simulated user interface material includes changing values of one or more visual properties of the simulated user interface materials, including a level of shadow cast on underlying content (6003D).

In some embodiments, displaying the respective animated transition that corresponds to appearance of the first user interface object includes gradually increasing one or more simulated thicknesses of one or more corresponding portions of the first user interface object in a depth direction of the first user interface, and reversing at least a portion of the increases in the one or more simulated thicknesses of the one or more corresponding portions of the first user interface object before displaying a steady state appearance of the first user interface object. In some embodiments, when initially displaying the first user interface object that is visually associated with the user interface material, the computer system increases the simulated size and/or thicknesses of the user interface material beyond the steady state size and/or thicknesses of the user interface material (e.g., overshooting slightly) and then return to the final steady state of the simulated sizes and/or thickness. For example, as described with reference to FIGS. 5AE-5AF, the simulated thickness of the simulated glass material of notification 1124 is increased to a simulated thickness that is thicker than the steady-state (e.g., final) simulated thickness of the notification 1124′.

In some embodiments, while displaying the first user interface object in the first user interface, including displaying the first user interface object with an appearance that simulates refraction of content in the first user interface, the computer system detects, via the one or more input devices, a user input that interacts with the first user interface object. In some embodiments, the user input that interacts with the first user interface object includes a tap gesture by a contact detected at a location corresponding to the first user interface object, an air pinch gesture detected while a gaze is directed at a location corresponding to the first user interface object, a click input detected while a pointer or focus selector is located at the first user interface object, and/or another type of selection input that is detected while a target location of the selection input corresponds to the first user interface object. In some embodiments, the user input is a swipe gesture, an air pinch and drag gesture, a click and drag input, and/or another type of movement input that has a starting location corresponding to the location of the first user interface object. In some embodiments, the user input is a tap and hold gesture by a contact at the location of the first user interface object, an air pinch and hold gesture that is started while a gaze is directed to the first user interface object, a click and hold input detected while the pointer or focus selector is located at the first user interface object, and/or another type of select and hold input that is started with a target location corresponding to the first user interface object. In response to detecting the user input that interacts with the first ser interface object, the computer system changes a size of the first user interface object in a first direction and in a second direction different from the first direction, including in accordance with a determination that the user input that interacts with the first user interface object has a first set of spatial characteristics (e.g., is in a first direction and/or directed to a first portion of the first user interface object), stretching a first portion of the first user interface object in a first stretching direction and compressing the first portion of the first user interface object in a first compression direction different from the first stretching direction. Changing a size of the first user interface object in a first direction and in a second direction different from the first direction includes, in accordance with a determination that the user input that interacts with the first user interface object has a second set of spatial characteristics (e.g., is in a second direction and/or directed to a second portion of the first user interface object), different from the first set of spatial characteristics, stretching the first portion of the first user interface object in a second stretching direction, different from the first stretching direction, compressing the first portion of the first user interface object in a second compression direction, different from the first compression direction and different from the second stretching direction. In some embodiments, the user interface material of the first user interface object responds to inputs with a squishy and stretchy reaction that is based on approximated or simulated physics that is based on the direction and/or point of action of the user inputs. More details of this simulated property of the user interface material are described with respect to FIGS. 5W-5Z and method 11000. For example, as described with reference to FIG. 5AE, in some embodiments, the time indication 1120 behaves with the stretching and/or squishing behavior described with reference to FIGS. 5V-5Z4.

It should be understood that the particular order in which the operations in FIG. 12 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 13000, 14000, 15000, 16000, 17000, 18000, 19000, and/or 20000) are also applicable in an analogous manner to method 12000 described above with respect to FIG. 9. For example, the buttons, user interfaces, controls, visual deemphasis, virtual effects, an/or animations described above with reference to method 12000 optionally have one or more of the characteristics of the buttons, user interfaces, controls, visual deemphasis, virtual effects, an/or animations described herein with reference to other methods described herein (e.g., methods 7000, 8000, 9000, 10000, 11000, 13000, 14000, 15000, 16000, 17000, 18000, 19000, and/or 20000). For brevity, these details are not repeated here.

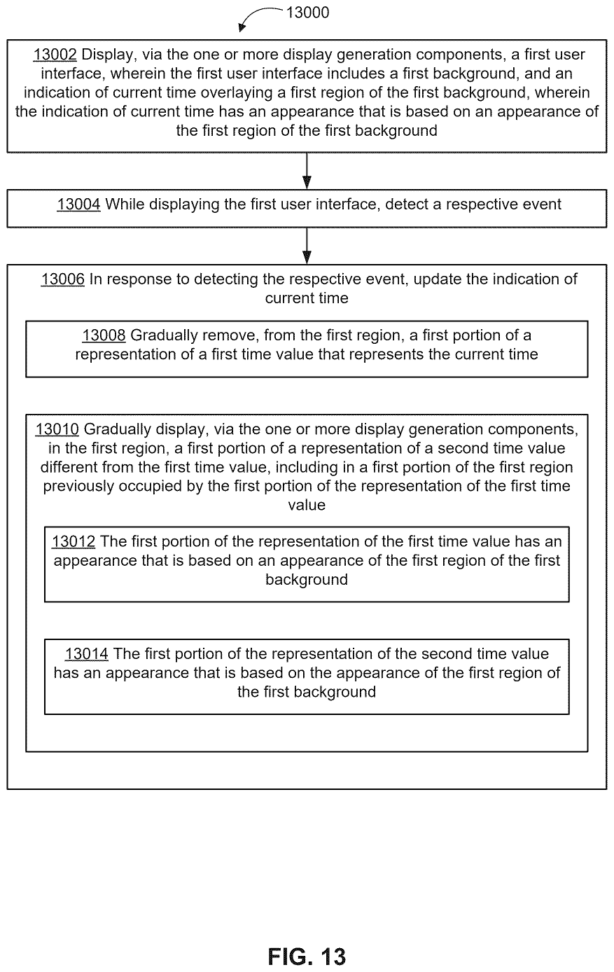

FIG. 13 is a flow diagram illustrating a method 13000 of updating numerals displayed with a simulated user interface appearance in accordance with some embodiments. The method 13000 is performed at a computer system (e.g., device 300, FIG. 3A, or portable multifunction device 100, FIG. 1A) that is in communication with one or more input devices and one or more display generation components. In some embodiments, the one or more display generation components are touch-screen displays which optionally include one or more touch-sensitive surfaces integrated with one or more of the display generation components. In some embodiments, one or more of the display generation components are separate from one or more of the touch-sensitive surfaces. Some operations in method 13000 are, optionally, combined and/or the order of some operations is, optionally, changed. In some embodiments, the method 13000 is performed at a computer system that is in communication with one or more input devices and one or more display generation components. In some embodiments, the one or more input devices include one or more touch-sensitive surfaces such as touch-sensitive buttons, touch pads, touch screens, and/or other touch-sensitive input regions located on the computer system and/or are coupled to the computer system via one or more wired or wireless connections that detect user inputs based on contacts. In some embodiments, the one or more input devices includes one or more cameras that capture movement and/or gestures inputs of the user. In some embodiments, the one or more input devices include one or more microphones that detect voice inputs from the user. In some embodiments, the one or more input devices include sensors for detecting changes in position, lighting, noise, temperature, proximity of objects, activation of hardware controls, intensity of inputs, duration of inputs, and/or changes thereof, instead of and/or in addition to other input devices and/or sensors. In some embodiments, the one or more display generation components include one or more touch screen displays, head-mounted displays, heads-up displays, integrated displays, and/or standalone displays, that are used to display content and information generated by the computer system.

Automatically updating a time numeral in response to detecting occurrence of a change in a time boundary, without requiring further user input, such that the time numeral is displayed with a simulated user interface material that is based at least in part on background content provides information about the spatial relationships between the user interface elements and informs the user about the change in the state of the computer system and application. The appearance of the user interface material is used to balance the need for visual saliency of the user interface objects against the background and reduces visual distraction of the underlying content. Using user interface materials with simulated optical properties for the time numerals improves the legibility of content, which enables a user to use a device for shorter periods of time, which saves energy and improves battery life. Using user interface materials with simulated optical properties for time numerals enables time numerals to be more transparent, and an increased transparency of time numerals enables a user to use a device for shorter periods of time, which saves energy and improves battery life. Providing an appearance of time numerals (e.g., changing material appearance of the time numerals based on underlying content) when one or more criteria are met reduces the number of inputs (e.g., navigating through settings user interfaces and menus to set the values for parameters to adjust the appearance of the time numerals) that would otherwise be required to generate a similar effect, which saves energy and improves battery life.

The computer system displays (13002), via the one or more display generation components, a first user interface (e.g., a wake screen user interface, a lock screen user interface, a standby user interface, a coversheet user interface, a clock user interface, a timer user interface, an alarm clock user interface, a countdown user interface, and/or a user interface corresponding to an idle state, a sleep state, and/or a power saving state of the computer system), wherein the first user interface includes a first background (e.g., a texture, a pattern, an image, a photograph, a gradient, and/or another type of background material with varying values for one or more display properties across the spatial extent of the first background), and an indication of current time (e.g., numerals representing different segments of the current time, such as numerals for the hour, minute, and/or second values of the current time) overlaying a first region of the first background (e.g., the first region is, optionally, a substantially stationary region in the first user interface, and is, optionally, adjustable and/or movable relative to the display region provided via the one or more display generation components, the background material, and/or other elements of the first user interface, under various conditions, such as in response to user inputs and/or in response to movement of the computer system), wherein the indication of current time has an appearance that is based on an appearance of the first region of the first background (e.g., the first region includes content that is overlaid and covered by the indication of current time, and includes content that is located near and/or within a threshold distance from the indication of current time but not directly covered by the indication of current time). In some embodiments, the indication of current time is a digital time value, e.g., digits for hour, minute, and/or second values included in and/or on the surfaces of one or more volumes of a first user interface material with a continuous boundary and/or several separated boundaries, overlaying different portions of the first region of the first user interface. In some embodiments, the first region is a rectangular region or a region of another geometric shape, that fully encloses the indication of current time, and at least some portions of the first region are visually obscured by the elements of the indication of current time, while some portions of the first region remain visible with the elements of the indication of current time. As the elements of the indication of current time are updated with the passage of time, different portions of the first region may be obscured and/or revealed by the updates to the elements of the indication of current time. In some embodiments, the appearance of the elements of current time in the indication of current time have colors and pattern variations that are indicative of and/or based on the colors and lines of the content that is covered by the elements of the indication of current time, and at least some content that is adjacent to edges of the elements of the indication of current time and not covered by the elements of the indication of current time (e.g., simulating refraction of the content that is near, but not necessarily directly under the elements of the indication of current time and/or immediately adjacent the boundary of the elements of the indication of current time). In some embodiments, the indication of current time and the time values of the current time refer to a current time of day, an elapsed time of a stopwatch, a time remaining of a countdown timer, and/or other indications of time that updates its time value in response to occurrences of events over time. For example, in FIG. 5AE, the user interface 1126 includes time indication 1122-1 that is displayed as simulated glass material that refracts, blurs, and/or otherwise distorts underlying content from the background (e.g., as described with reference to FIGS. 6A-6B4).

While displaying the first user interface, the computer system detects (13004) a respective event (e.g., a user input or an event such as the passage of time from a first time value to a second time value that corresponds to a change in the elements of the indication of current time). In response to detecting the respective event, the computer system updates (13006) the indication of current time. The computer system gradually removes (13008), from the first region, a first portion (e.g., one or more numerals or clock hands) of a representation of a first time value (e.g., 12:30, 5:14, 0:0:15, 1:59, 2:00 and/or other time values) that represents the current time (e.g., by gradually reducing the thickness of the volume of first user interface material corresponding to the representation of the first time value, and/or submerging the volume of first user interface material corresponding to the representation of the first time value into the first background, optionally from a first side to an opposing side of the representation of the first time value, and/or along a stroke tracking the representation of the first time value, the user interface material is, optionally, a simulated material such as a simulated glass material described in greater detail elsewhere in this application). The computer system gradually displays (13010), via the one or more display generation components, in the first region, a first portion (e.g., one or more numerals or clock hands) of a representation of a second time value (e.g., 12:31, 12:29, 5:15, 5:13, 0:0:16, 0:0:14, 2:00, 1:58, 2:01, 1:59, and/or other time values that immediately precede or follow the first time value) different from the first time value, including in a first portion of the first region previously occupied by the first portion of the representation of the first time value (e.g., the first portion of the representation of the second time value is displayed in a portion of the first region that corresponds to, is, overlaps with, and/or includes, a portion of the first region from which the first portion of the representation of the first time value is removed). For example, as described with reference to FIG. 5AB, the time indication 1122-1 is updated to gradually remove the “8” and gradually display the “9” according to steps 1102-1 through 1102-12.

The first portion of the representation of the first time value has (13012) an appearance that is based on an appearance of the first region of the first background (e.g., including an appearance of the first portion of the first region, and appearance of one or more other portions of the first region). The first portion of the representation of the second time value has (13014) an appearance that is based on the appearance of the first region of the first background (e.g., including the appearance of the first portion of the first region, and appearance of one or more other portions of the first region). In some embodiments, even though the representation of the first time value and the representation of the second time value are both located in the first portion of the first region of the first background, due to the differences in the boundaries of the two representations, the same content from the first portion of the first region cause different visual changes in the user interface material of the two representations. For example, the first portion of the first region that is overlaid, albeit at different times, by both the representation of the first time value and the representation of the second time value, the appearance of the first portion of the first region is used in generating the appearance of the first portion of the representation of the first time value and the appearance of the second portion of the representation of the second time value, but the resulting appearances of the representations overlaying the first portion of the first region are different, due to the difference in the boundaries and optionally other animated changes in the boundaries of the representations near the first portion of the first region. For example, the time indication 1122-1 is displayed as simulated glass material that refracts, blurs, and/or otherwise distorts underlying content from the background, such that both the “8” and the “9” have an appearance that is based on content in the background.

In some embodiments, the indication of current time is visually associated with a first user interface material (e.g., a simulated glassy material and/or other simulated material with simulated material properties) that has a first boundary (e.g., a first set of one or more edges, corners, outlines, and/or simulated bounding surfaces) when the indication of current time includes the representation of the first time value. In some embodiments, the indication of current time is visually associated with the first user interface material (e.g., a simulated glassy material and/or other simulated material with simulated material properties) that has a second boundary (e.g., a second set of one or more edges, corners, outlines, and/or simulated bounding surfaces) different from the first boundary, when the indication of current time includes the representation of the second time value. In some embodiments, the representation of the first time value has an appearance (e.g., a glassy and/or gelatinous look) that is based on the appearance of the first region of the first background (e.g., based on the appearance of the portion of the first region that is underlying and/or that is not underlying but is within a threshold distance from the first boundary of the first user interface material corresponding to the first time value) and that simulates optical interactions (e.g., simulates refractions, reflections, transmissions, specular highlights, blurring, shadows, tinting, and/or other optical interactions) between the first user interface material (e.g., with the first boundary corresponding to the first time value) and content of the first region of the first background (e.g., text, images, lines, colors, and/or other variations of display properties in the portion of the first region that is underlying and/or that is not underlying but is within a threshold distance from the first boundary of the first user interface material corresponding to the first time value). In some embodiments, the representation of the second time value has an appearance (e.g., a glassy and/or gelatinous look) that is based on the appearance of the first region of the first background (e.g., based on the appearance of the portion of the first region that is underlying and/or that is not underlying but is within a threshold distance from the second boundary of the first user interface material corresponding to the second time value) and that simulates optical interactions (e.g., simulates refractions, reflections, transmissions, specular highlights, blurring, shadows, tinting, and/or other optical interactions) between the first user interface material (e.g., with the second boundary corresponding to the second time value) and the content of the first region of the first background (e.g., text, images, lines, colors, and/or other variations of display properties in the portion of the first region that is underlying and/or that is not underlying but is within a threshold distance from the second boundary of the first user interface material corresponding to the second time value). For example, time indication 1122-1 is displayed as simulated glass material that simulates optical interaction (e.g., as described with reference to FIGS. 6A-6B4).

In some embodiments, while displaying the indication of current time overlaying the first region of the first background, the computer system detects one or more changes (e.g., a discrete change from a first state to a second state, and/or a sequence of animated changes through a plurality of intermediate states) in the appearance of the first region of the first background (e.g., due to changes in the content of the first background as a result of an occurrence of a system event, arrival of a notification or alert, satisfaction of a set of conditions to change a wallpaper of the first user interface, an input scrolling content in the first user interface, ongoing playback and/or animated changes of the content in the first background, an input dragging the first background, an input dragging the indication of current time, and/or other types of events that trigger changes in the first user interface). In some embodiments, the first region of the first background, which is a region of the first background that underlies the indication of current time, changes appearance because the content in a stationary region underlying the indication of current time changes, and/or because a different portion of the first user interface now underlies the indication of current time as a result of relative movement between the indication of current time and the first user interface. In some embodiments, the first region of the first background, which is a region of the first background that is within a threshold distance of the boundary of the indication of the current time, changes appearance because the boundary of the representation of the current time value changes due to the change in the current time value represented by the indication of current time (e.g., due to elapse of time, resizing and/or repositioning of the indication of current time relative to the first user interface). In response to detecting the one or more changes in the appearance of the first region of the first background, and in accordance with a determination that the indication of current time includes the representation of the first time value, and the first region of the first background has a first background appearance after the one or more changes in the appearance of the first region of the first background, the computer system updates the appearance of the indication of the current time to a first indication appearance based on the first background appearance (e.g., the first indication appearance simulates optical interaction between the first user interface material with the first boundary, and the portion of the first background with the first background appearance that is underlying and/or is within a threshold distance from the first boundary). In response to detecting the one or more changes in the appearance of the first region of the first background, and in accordance with a determination that the indication of current time includes the representation of the first time value, and the first region of the first background has a second background appearance, different from the first background appearance, after the one or more changes in the appearance of the first region of the first background, the computer system updates the appearance of the indication of the current time to a second indication appearance based on the second background appearance (e.g., the second indication appearance simulates optical interaction between the first user interface material with the first boundary, and the portion of the first background with the second background appearance that is underlying and/or is within the threshold distance from the first boundary), where the second indication appearance is different from the first indication appearance. Similarly, in some embodiments, in response to detecting the one or more changes in the appearance of the first region of the first background: in accordance with a determination that the indication of current time includes the representation of the second time value, and the first region of the first background has the first background appearance after the one or more changes in the appearance of the first region of the first background, the computer system updating the appearance of the indication of the current time to a third indication appearance based on the first background appearance (e.g., the third indication appearance is different from the first indication appearance); and in accordance with a determination that the indication of current time includes the representation of the second time value, and the first region of the first background has the second background appearance, different from the first background appearance, after the one or more changes in the appearance of the first region of the first background, the computer system updating the appearance of the indication of the current time to a fourth indication appearance based on the second background appearance, where the fourth indication appearance is different from the second indication appearance (e.g., due to difference in boundary of the first user interface material) and different from the third indication appearance (e.g., due to difference in background appearance). In some embodiments, even though the first user interface material has the same boundary for a given time value represented in the indication of current time, the resulting appearances of the indication of current time can be different when the appearance of the first region of the first background changes. For example, as described with reference to FIG. 5AG, as the background changes (e.g., by resizing, rescaling, and/or changing to a different image), a different portion of the clouds that are distorted by the simulated glass material of the time indication 1122-3 than the portion of the clouds distorted by the simulated glass material of the time indication 1122-4.

In some embodiments, the indication of current time includes a first user interface material (e.g., a simulated glassy material and/or gelatinous material) with a respective boundary (e.g., a respective set of edges, corners, outlines, and bounding surfaces) that corresponds to a respective time value currently represented by the indication of current time (e.g., the first boundary corresponding to the first time value, the second boundary corresponding to the second time value, and/or another boundary corresponding to another time value). In some embodiments, the appearance of the first portion of the representation of the first time value is based on a simulated optical property of the first user interface material with the first boundary. In some embodiments, gradually removing, from the first region, the first portion of the representation of the first time value includes changing an appearance of the first boundary of the first user interface material (e.g., reducing one or more simulated thicknesses in one or more portions of the indication of current time and/or increasing one or more simulated thicknesses in one or more portions of the indication of current time, in a depth direction of the first user interface, and/or moving the respective boundary in the lateral directions of the first user interface, in a manner consistent with removing the currently displayed time value). In some embodiments, gradually removing, from the first region, the first portion of the representation of the first time value includes changing a simulated optical interaction of the first user interface material (e.g., increasing and/or reducing the amounts of, and/or shifting the locations of, simulated refraction, simulated shadow, simulated specular highlight, tinting, blurring, and/or other visual effects applied to the indication of current time and surrounding content) in accordance with changes in the appearance of the first boundary of the first user interface material. In some embodiments, when the time value represented in the indication of current time is being updated, the computer system changes the spatial characteristics of the first user interface material enclosed in the boundary of the currently displayed time value to reduce its spatial volume from the first user interface, in turn changes the simulated optical property of the first user interface material enclosed in the boundary of the currently displayed time value, and in turn changes the visibility of the representation of the currently displayed time value in the first user interface, in preparation for the display of the updated time value. For example, as described with reference to FIGS. 5AB-5AC, removing the “8” from the time indication includes simulating a change in thickness (e.g., and/or modifying one or more other visual properties) of at least a portion of the boundary of the “8” (e.g., until the portion ceases to be displayed completely).

In some embodiments, changing the first boundary of the first user interface material includes, in accordance with a determination that a first portion of the first boundary has a first spatial relationship to the indication of current time, changing the first portion of the first boundary in a first manner (e.g., with a first rate of change and/or with a first starting time for the change). In some embodiments, changing the first boundary of the first user interface material includes, in accordance with a determination that a second portion, different from the first portion, of the first boundary has a second spatial relationship, different from the first spatial relationship to the indication of current time (e.g., differ in position, distance, direction, and/or other aspects of spatial relationship, relative to the indication of current time), changing the second portion of the first boundary in a second manner different from the first manner (e.g., with a second rate of change, different from the first rate of change; and/or with a second starting time different from the first starting time). In some embodiments, changing the simulated optical interaction of the first user interface material (e.g., increasing and/or reducing the amounts of, and/or shifting the locations of, simulated refraction, simulated shadow, simulated specular highlight, tinting, blurring, and/or other visual effects applied to the indication of current time and surrounding content) in accordance with the changes in the first boundary of the first user interface material includes changing the simulated optical interaction of the first user interface material by a first amount of change for the first portion of the first boundary and by a second amount of change for the second portion of the first boundary (e.g., changing the simulated optical interaction asymmetrically, so that, during the transition, some parts of a numeral or segment of the indication of current time have a greater change than other parts). In some embodiments, the edges of the simulated volume of a numeral in the indication of current time undergoes greater changes in curvature during the transition to update the numeral, and thus have stronger visual changes due to greater changes in simulated refraction and/or other simulated optical effects, as compared to the interior portions of the numeral. In some embodiments, the top portion of the numeral (or another portion along the stroke path or body of the numeral) starts to change sooner than the middle and lower portions of the numeral, and thus shows a greater difference from its original appearance at a given moment in time, as compared to the middle and lower portions of the numeral. For example, as described with reference to FIG. 5AC, the level of simulated thickness of the time indication is changed differently for different portions of the “8”.

In some embodiments, changing the first boundary of the first user interface material includes changing a simulated thickness of the first user interface material in a depth direction of the first user interface. In some embodiments, changing the simulated optical interaction of the first user interface material in accordance with changes in the first boundary of the first user interface material includes changing the simulated optical interaction in accordance with the change in the simulated thickness of the first user interface material and change in simulated curvature of the first user interface material along the boundary of the first user interface material that resulted from the change in thickness. For example, as described with reference to FIG. 5AC, the level of simulated thickness of the time indication is changed differently for different portions of the “8”.

In some embodiments, the representation of the first time value has an appearance that is based on a blurred appearance of the first region of the first background (e.g., the representation of the first time value has an appearance that simulates refraction of a blurred version of the first region of the first background by the first user interface material). In some embodiments, changing the simulated optical interaction of the first user interface material in accordance with changes in the first boundary of the first user interface material includes changing an amount of blur used in the blurred appearance of the first portion of the first background from a first amount of blur to a second amount of blur that is different from the first amount of blur (e.g., more blur and/or less blur in various portions of the blurred appearance in accordance with the change in the simulated thickness and/or curvature of the first user interface material in the various portions of the first user interface material corresponding to the various portions of the blurred appearance). For example, as described with reference to FIG. 5AC, the level of blurring applied to the simulated glass material of the time indication changes over time as the “8” gradually disappears.

In some embodiments, the representation of the first time value has an appearance that includes one or more simulated specular highlights (e.g., the representation of the first time value has an appearance that simulates high reflection along certain portions of the edges of the first user interface material based on a spatial relationship between the edges and nearby virtual and/or physical light sources). In some embodiments, changing the simulated optical interaction of the first user interface material in accordance with changes in the first boundary of the first user interface material includes changing one or more visual properties (e.g., position, shape, size, length, intensity, tint, and/or other spatial properties and/or display properties) of the one or more simulated specular highlight in accordance with the changes in the first boundary of the first user interface material (e.g., the specular highlight moves along the edges of the first user interface material, and/optionally hops to different locations on the edges of the first user interface material, elongates and/or shrinks along the edges of the first user interface material, and/or picks up different colors from the nearby content and/or environment, when the first user interface material changes shape, size, simulated thickness, and/or position relative to the first background). For example, as described with reference to FIG. 5AB, the specular highlights 1108-1 through 1108-12 are updated in size, position, brightness and/or other visual properties as the “8” disappears and the “9” appears.

In some embodiments, the first portion of the representation of the first time value corresponds to a first numeral in the representation of the first time value. In some embodiments, the first numeral extends in a first direction relative to the indication of current time (e.g., in a vertical direction, a horizontal direction, a variable direction that runs along a stroke path of the first numeral, a variable direction that zigzags down the vertical direction of the numeral, and/or other constant or variable directions relative to the indication of current time, the first background, the first user interface, a direction of gravity, a direction of a support surface, a user, and/or other frames of references). In some embodiments, gradually removing, from the first region, the first portion of the representation of the first time value includes, in accordance with a determination that a first portion of the first numeral precedes a second portion of the first numeral in the first direction, removing the first portion of the first numeral before removing the second portion of the first numeral (e.g., removing the top portion of the first numeral with an earlier start time than the middle and lower portions of the first numeral, and/or reducing the simulated thickness with a greater rate in the earlier portion along the stroke path of the first numeral than the later portions along the stroke path of the first numeral). Similarly, in some embodiments, gradually removing, from the first region, the first portion of the representation of the first time value includes, in accordance with a determination that a third portion of the first numeral precedes the first portion of the first numeral in the first direction, removing the third portion of the first numeral before removing the first portion of the first numeral. Similarly, in some embodiments, gradually removing, from the first region, the first portion of the representation of the first time value includes, in accordance with a determination that a fourth portion of the first numeral follows the second portion of the first numeral in the first direction, removing the fourth portion of the first numeral after removing the second portion of the first numeral. In some embodiments, the reduction in thickness for the first user interface material spreads across the first numeral in a respective direction, to gradually remove the first numeral from the first user interface. For example, as described with reference to FIG. 5AB, in some embodiments, the “8” gradually disappears starting from a top right portion of the “8” and gradually traveling across the numeral, including to the left and downward.

In some embodiments, the first direction relative to the indication of current time includes a direction (e.g., a variable direction that changes along the stroke path, and varies from numeral to numeral) along a stroke path of the first numeral. For example, the stroke path of a respective numeral is a path traversed by a pen when the respective numeral is written by the pen. In some embodiments, the stroke path for a respective numeral is determined by the computer system based on the font and style chosen for the indication of current time. For example, as described with reference to FIG. 5AB, in some embodiments, the “8” is gradually removed along a path that follows a stroke path (e.g., in reverse of how an “8” would be drawn).

In some embodiments, the first direction relative to the indication of current time includes a direction that has a first spatial relationship (e.g., a fixed direction that is based on a chosen frame of reference) to a first frame of reference first user interface (e.g., a vertical direction, a horizontal direction, a diagonal direction, a radial direction, and/or other directions that is based on the orientation of the first user interface, the indication of current time, and/or other frames of reference). For example, as described with reference to FIG. 5AD, in some embodiments, the minute time numerals are removed starting from a bottom portion that moves in the upward direction and the hour time numerals are removed from a top portion that moves in the downward direction.

In some embodiments, in accordance with a determination that the first numeral is a first type of numeral (e.g., numeral for a first segment in the time value) in the indication of current time, the first direction relative to the indication of current time is chosen based on first criteria (e.g., the first direction is the direction that the removal of the first numeral proceeds, and is chosen based on a first starting point, and/or a first progress direction relative to the indication of current time). In some embodiments, in accordance with a determination that the first numeral is a second type of numeral (e.g., numeral for a second segment in the time value), different from the first type of numeral (e.g., numeral for an hour value vs. numeral for a minute value, numeral for a minute value vs. numeral for a second value, the first numeral in an hour value vs. the second numeral in the hour value, the first numeral in a minute value vs. the second numeral in the second value, and/or other pairs of numerals in different segments of the time value), in the indication of current time, the first direction relative to the indication of current time is chosen based on second criteria, different from the first criteria (e.g., the first direction is the direction that the removal of the first numeral proceeds, and is chosen based on a second starting point different from the first starting point, and/or a second progress direction different from the first progress direction relative to the indication of current time). For example, as described with reference to FIG. 5AD, in some embodiments, the minute time numerals are removed starting from a bottom portion that moves in the upward direction and the hour time numerals are removed from a top portion that moves in the downward direction.

In some embodiments, in accordance with a determination that a time value represented by the indication of current time increases over time (e.g., the second time value is greater than the first time value, and/or the time counts upward), the first direction relative to the indication of current time is chosen based on third criteria (e.g., the first direction is the direction that the removal of the first numeral proceeds, and is chosen based on a third starting point, and/or a third progress direction relative to the indication of current time). In some embodiments, in accordance with a determination that the time value represented by the indication of current time decreases over time (e.g., the second time value is lower than the first time value, and/or the time counts downward), the first direction relative to the indication of current time is chosen based on fourth criteria, different from the third criteria (e.g., the first direction is the direction that the removal of the first numeral proceeds, and is chosen based on a second starting point different from the first starting point, and/or a second progress direction different from the first progress direction relative to the indication of current time). For example, as described with reference to FIG. 5AD, in some embodiments, the time numeral(s) that counts up (e.g., from 9 to 10) are removed starting from a bottom portion that moves in the upward direction and the time numeral(s) counting down (e.g., from 59 to 00) are removed from a top portion that moves in the downward direction.

In some embodiments, updating the indication of current time includes, in accordance with a determination that a difference between the first time value and the second time value includes a single numeral change, gradually removing the first portion of the representation of the first time value includes gradually removing a first numeral of the first time value that is not part of the second time value (and, gradually adding a numeral of the second time value at the location of the first numeral). In some embodiments, updating the indication of current time includes, in accordance with a determination that a difference between the first time value and the second time value includes two or more numeral changes, gradually removing the first portion of the representation of the first time value includes removing two or more numerals of the first time value that are not part of the second time value (and, gradually adding two or more numerals of the second time value at the locations of the two or more numerals of the first time value). For example, as described with reference to FIG. 5AD, in some embodiments, a plurality of numerals in the time indication are concurrently changed.

In some embodiments, removing the two or more numerals of the first time value that are not part of the second time value includes starting gradual removal of a first numeral of the two or more numerals of the first time value that are not part of the second time value before starting gradual removal of a second numeral of the two or more numerals of the first time value that are not part of the second time value (e.g., removal of the second numeral is started after the removal of the first numeral has completed halfway, offset the start times of the removal for different numerals by a first amount of time, such as 50 milliseconds, 0.1 second, 0.5 seconds). For example, as described with reference to FIG. 5AB, in some embodiments, the steps for adding the “9” numeral (e.g., step 1108-8) overlaps with the steps for removing the “8” numeral (e.g., step 1108-7), wherein initiating the steps for adding the “9” numeral begins after a threshold amount of time has passed during which the “8” numeral has been removed.

In some embodiments, the indication of current time includes a first time separator (e.g., a separator between different segments of the current time, such as the separator between the hour value and the minute value, the separator between the minute value and the second value, the separator between the second value and the millisecond value, and/or the separator between other pairs of adjacent time segments). In some embodiments, the first time separator is located between a first set of one or more numerals (e.g., the numerals for the hour value) in the indication of current time and a second set of one or more numerals (e.g., the numerals for the minute value) in the indication of current time. In some embodiments, updating the indication of current time includes, in accordance with a determination that a change from the first time value to the second time value includes a first type of time transition (e.g., minute transition, second transition, and/or transition that includes change in numeral on only one side of the first time separator), maintaining display of the first time separator when gradually removing the first portion of the representation of the first time value and gradually displaying the first portion of the representation of the second time value. In some embodiments, updating the indication of current time includes, in accordance with a determination that the change from the first time value to the second time value includes a second type of time transition, different from the first type of time transition (e.g., hour transition as opposed to minute transition, minute transition as opposed to second transition, transition that includes changes in numeral on both sides of the first time separator as opposed to only one side of the first time separator), ceasing to display the first time separator while updating the indication of current time is in progress, and displaying (e.g., redisplaying), via the one or more display generation components, the first time indicator before updating the indication of current time is completed. In some embodiments, the computer system ceases to display the first time separator when gradually removing the first portion of the representation of the first time value. In some embodiments, the first time separator is not displayed during at least part of the time when the first portion of the representation of the first time value is gradually removed and/or at least part of the time when the first portion of the representation of the second time value is gradually displayed. In some embodiments, the first time separator ceases to be displayed when the representation of the first time value is fully removed. In some embodiments, the first time separator is redisplayed after the representation of the second time value is fully displayed. For example, as described with reference to FIGS. 5AC-5AD, for a minute-based time transition, the time separator (“:”) continues to be displayed (e.g., in FIG. 5AC), whereas, for an hour-based time transition, the time separator is removed during the transition.

In some embodiments, the indication of current time includes a first time separator that is located between a first type of numerals (e.g., the numerals for the hour value) and a second type of numerals (e.g., the numerals for the minute value) in the indication of current time. In some embodiments, updating the indication of current time includes, in accordance with a determination that a change from the first time value to the second time value includes a change in the first type of numeral and a change in the second type of numeral (e.g., change in both the hour value and the minute value, and/or change in both minute value and second value), ceasing to display the first time separator while gradually removing one or more numerals of the first type of numerals, and displaying (e.g., redisplaying), via the one or more display generation components, the first time separator while gradually displaying one or more numerals of the second type of numerals (e.g., redisplaying the time separator when displaying the hour numerals, after the time separator was removed when removing the minute numerals; and/or redisplaying the time separator when displaying the minute numerals, after the time separator was removed when removing the second numerals). For example, as described with reference to FIGS. 5AC-5AD, for a minute-based time transition, the time separator (“:”) continues to be displayed (e.g., in FIG. 5AC), whereas, for an hour-based time transition, the time separator is removed during the transition before reappearing with the updated time indication.

In some embodiments, the indication of current time includes a first time separator that is located between a first type of numerals (e.g., the numerals for the hour value) and a second type of numerals (e.g., the numerals for the minute value) in the indication of current time. In some embodiments, updating the indication of current time includes maintaining display of the first time separator while gradually removing (e.g., over time) one or more numerals and gradually displaying (e.g., over time) one or more numerals of the indication of current time. In some embodiments, the time separator continues to be displayed when numerals of the indication of current time are updated, whether the numerals are located on a first side of the time separator, on a second side of the time separator, and/or on both sides of the time separator. For example, as described with reference to FIG. 5AD, in some embodiments, the time separator (“:”) continues to be displayed for a minute-based time transition and/or for an hour-based time transition.

In some embodiments, while displaying the first user interface, including the indication of current time overlaying the first region of the first background, the computer system detects, via the one or more input devices, a user input that is directed toward the indication of current time. In some embodiments, the user input includes a user input that corresponds to a request to resize the indication of current time, and/or move the indication of current time, relative to the first user interface. In some embodiments, the user input is directed toward a portion of the indication of current time, such as a numeral in the indication of current time as opposed to other numerals in the indication of current time, a portion of a numeral in the indication of current time as to other portions of the numeral, a first side of the indication of current time as opposed to a second side of the indication of current time, and as a result, the first user interface material of the indication of current time is deformed, moved as a whole, and/or otherwise changed in appearance and/or spatial relationship to the first user interface based on the location targeted by the user input, a direction of the user input, a duration of the user input, a magnitude of the user input, and/or other characteristics of the user input. In some embodiments, the target location of the user input is based on a location of a contact in a swipe gesture directed to the indication of current time. In some embodiments, the target location of the user input is based on a location of a cursor in a click and drag input directed to the indication of current time. In some embodiments, the target location of the user input is based on a location of user's attention (e.g., based on gaze) in an air pinch and drag gesture directed to the indication of current time. In response to detecting the user input that is directed toward the indication of current time, and in accordance with a determination that the user input is directed to a first numeral in the indication of current time, the computer system changes an appearance of the first numeral in the indication of current time (e.g., without changing the appearance of other numerals and/or changing the appearance of other numerals to a lesser degree) . . . . In response to detecting the user input that is directed toward the indication of current time, and in accordance with a determination that the user input is directed to a second numeral, different from the first numeral, in the indication of current time, changing an appearance of the second numeral in the indication of current time (e.g., without changing the appearance of other numerals and/or changing the appearance of other numerals to a lesser degree). For example, as described with reference to FIG. 5AE-5AF, in response to detecting the user input 1120, the time indication 1122-1 is updated, for example, to reduce a simulated thickness of a portion of the time indication 1122-1.

In some embodiments, in response to detecting the user input that is directed toward the indication of current time, and in accordance with the determination that the user input is directed to the first numeral in the indication of current time, the computer system changes the appearance of the first numeral in the indication of current time by a greater amount than changing the appearance of the second numeral in the indication of current time. In some embodiments, in response to detecting the user input that is directed toward the indication of current time, and in accordance with a determination that the user input is directed to the second numeral in the indication of current time, the computer system changes the appearance of the first numeral in the indication of current time by a less amount than changing the appearance of the second numeral in the indication of current time. In some embodiments, when a user input is directed toward a portion of the indication of current time, the numerals that are closer to the target location of the user input undergoes a greater amount of change as compared to the numerals that are located farther away from the target location of the user input. In some embodiments, when a user input is directed toward a portion of a numeral in the indication of current time, the portion of the numeral that is closer to the target location of the user input undergoes a greater amount of change as compared to the other portions of the numeral and/or other numerals that are located farther away from the target location of the user input. For example, as described with reference to FIG. 5AE-5AF, in response to detecting the user input 1120, the time indication 1122-1 is updated, for example, to reduce a simulated thickness of a portion of the time indication 1122-1 corresponding to a position of the detected user input 1120.

In some embodiments, changing the appearance of the first numeral in the indication of current time includes changing a simulated thickness of the first numeral. In some embodiments, changing the appearance of the second numeral in the indication of current time includes changing a simulated thickness of the second numeral. In some embodiments, changing a simulated thickness of a respective numeral and/or changing a simulated thickness of a portion of a respective numeral includes changing a respective boundary (e.g., edges, corners, and/or simulated surfaces) of the respective numeral and/or the portion thereof, which in turn changes the simulated reflection, simulated refraction, blur, and/or other simulated optical interactions represented in the appearance of the respective numeral. Additional details regarding the effect of changing simulated thickness of an object and/or its user interface material are provided with respect to FIGS. 5W-5Z, 5AB-5AD and methods 12000 and 13000. For example, as described with reference to FIG. 5AE-5AF, in response to detecting the user input 1120, the time indication 1122-1 is updated, for example, to reduce a simulated thickness of the simulated glass material of at least a portion of the time indication by changing a level of refraction, reflection, blur and/or other visual properties of the simulated glass material.

In some embodiments, in response to detecting the user input that is directed toward the indication of current time, and in accordance with the determination that the user input is directed to the first numeral in the indication of current time, the computer system changes the appearance of the first numeral in the indication of current time without changing the appearance of the second numeral in the indication of current time. In response to detecting the user input that is directed toward the indication of current time, and in accordance with a determination that the user input is directed to the second numeral in the indication of current time, the computer system changes the appearance of the second numeral in the indication of current time without changing the appearance of the first numeral in the indication of current time. For example, as described with reference to FIGS. 5AE-5AF, the “8” of the time indication is updated while the “9:5” is not updated in response to the user input 1120.

In some embodiments, the computer system detects, via the one or more input devices, a termination of the user input that is directed toward the indication of current time. In some embodiments, the user input includes a touch gesture (e.g., light press gesture, touch and hold gesture, pinch, reverse pinch gesture, and/or swipe gesture) performed by one or more contacts with starting location(s) corresponding to at least a portion of the indication of current time, and the termination of the user input includes a liftoff of the one or more contacts. In some embodiments, the user input includes an air gesture (e.g., an air pinch gesture, air pinch and hold gesture, two-handed air pinch gesture to expand or shrink a distance between the two hands while maintaining the pinched postures of the hands, and/or an air pinch and drag gesture) performed by one or more hands with a user's attention (e.g., as determined based on gaze) directed toward at least a portion of the indication of current time, and the termination of the user input includes release of the pinched posture of the hand(s). In some embodiments, the user input includes a click input (e.g., a click input, a click and hold input, a click and drag input, and/or a click input with a modifier key press) performed by a pointing device with a location of a cursor corresponding to at least a portion of the indication of current time, and the termination of the user input includes release of the click input. In response to detecting the termination of the user input that is directed toward the indication of current time, and in accordance with a determination that the user input was directed to the first numeral in the indication of current time and caused first changes to the appearance of the first numeral, the computer system reverses (e.g., gradually, over a period of time and/or through a plurality of intermediate states) at least a portion of the first changes to the appearance of the first numeral. In response to detecting the termination of the user input that is directed toward the indication of current time, and in accordance with a determination that the user input was directed to the second numeral in the indication of current time and caused second changes to the appearance of the second numeral, the computer system reverses (e.g., gradually, over a period of time and/or through a plurality of intermediate states) at least a portion of the second changes to the appearance of the second numeral. In some embodiments, the computer system restores all or a subset of changes to the appearance of the indication of current time after the user input that caused the changes is terminated. For example, as described with reference to FIG. 5AF, in response to detecting an end of the user input 1120′, the time indication 1122-2 gradually animates back to time indication 1122-1.

In some embodiments, in response to detecting the user input that is directed toward the indication of current time and while the user input that is directed toward the indication of current time is maintained, and in accordance with a determination that the user input was directed to the first numeral in the indication of current time and caused first changes to the appearance of the first numeral, the computer system maintains at least the first changes to the appearance of the first numeral. In response to detecting the user input that is directed toward the indication of current time and while the user input that is directed toward the indication of current time is maintained, and in accordance with a determination that the user input was directed to the second numeral in the indication of current time and caused second changes to the appearance of the second numeral, the computer system maintains at least the second changes to the appearance of the first numeral. In some embodiments, the computer system maintains all or a subset of changes to the appearance of the indication of current time while the user input that caused the changes is still maintained and not terminated. For example, as described with reference to FIG. 5AF, while the user input 1120′ continues to be detected, the time indication 1122-2 maintains its updated appearance (e.g., as simulated glass material with reduced simulated thickness).

In some embodiments, the first user interface includes a first foreground element (e.g., a notification, an alert, a main subject of a photo that is used in the wallpaper of the first user interface, a media player controller, and/or other foreground elements of the first user interface) that overlays at least a portion of the indication of current time, while the indication of current time overlays at least a portion of a first background element (e.g., a background of the image used in the wallpaper of the first user interface, one or more widgets, application icons, controls, and/or other objects in a display layer underlying the indication of current time). In some embodiments, updating the indication of current time includes gradually removing the first portion of the representation of the first time value (e.g., one or more numerals of the first time value), while a portion of the indication of current time (e.g., at least a portion of the one or more numerals of the first time value, and/or other numerals of the first time value) is overlaid by the first foreground element, and/or gradually displaying the first portion of the representation of the second time value (e.g., one or more numerals of the second time value that replaces the one or more numerals of the first time value), while a portion of the indication of current time is overlaid by the first foreground element (e.g., at least a portion of the one or more numerals of the second time value, and/or other numerals of the second time value). In some embodiments, while changing an appearance of one or more numerals in the indication of current time, the computer system maintains a placement of the one or more numerals behind a foreground element and in front of a background element (e.g., the first portion of the first background). For example, as illustrated in FIG. 5AE-5AF, the palm tree of the background is maintained in front of (e.g., as partially occluding) a portion of time indication 1122-1, while the cloud of the background is displayed as being behind the time indication (e.g., and is thus refracted as underlying content by the simulated glass material of the time indication 1122-1).

In some embodiments, displaying the first user interface, including displaying the indication of current time overlaying the first region of the first background, includes displaying the first user interface with a first layout (e.g., with a first orientation, and/or with a first arrangement of user interface objects in the first user interface), and displaying the indication of current time with a first orientation relative to the first user interface with the first layout (e.g., the indication of current time has the same up and down direction as the first user interface in the first orientation, and has the first spatial relationship relative to the first arrangement of user interface objects in the first user interface). While displaying the first user interface with the first layout (e.g., when the display generation components have a first orientation relative to the physical environment, and before the first arrangement of the user interface objects are adjusted by the computer system and/or in response to user inputs), the computer system detects an event that corresponds to a request to change a layout of the first user interface from the first layout to a second layout different from the first layout (e.g., detecting a rotation of the display generation components that causes the first user interface to switch between landscape orientation and portrait orientation, and/or between another pairs of layouts; and/or changing the arrangement of the user interface objects in the first user interface based on a set of conditions being met and/or in response to user inputs). In response to detecting the event that corresponds to a request to change the layout of the first user interface from the first layout to the second layout, the computer system changes the layout of the first user interface from the first layout to the second layout. Changing the layout of the first user interface from the first layout to the second layout includes changing a shape of the indication of current time from a first shape to a second shape different from the first shape (e.g., elongating and/or shrinking the indication of current time in a vertical direction of the indication of current time, expanding and/or shrinking the indication of current time in the horizontal direction of the indication of current time, changing a simulated thickness of the indication of current time in one or more portions of the indication of current time; and/or moving the boundaries of the user interface material of the numerals in the indication of current time in one or more portions of the indication of current time). Changing the layout of the first user interface from the first layout to the second layout includes, in accordance with a determination that the changing the layout of the first user interface includes a rotation of the first user interface relative to a housing of the computer system (e.g., relative to a display of the computer system on which the first user interface is displayed), rotating the indication of current time such that the indication of current time has the first orientation relative to the first user interface with the second layout (e.g., the indication of current time is rotated around an anchor point within the indication of current time, such as a center or bottom center of the indication of current time). In some embodiments, the indication of current time is shifted relative to the first user interface when it is reshaped and/or rotated in response to the change in the layout of the first user interface. In some embodiments, the indication of current time overlays a different portion of the first user interface when it is reshaped, resized, shifted in position, and/or rotated relative to the first user interface, which in turn changes the appearance of the indication of current time that simulates optical interaction between the user interface material of the indication of current time and the content underlying and/or is within a threshold distance from the boundaries of the user interface material of the indication of current time. In some embodiments, changing the layout of the first user interface from the first layout to the second layout includes, in accordance with a determination that the changing the layout of the first user interface does not include a rotation of the first user interface, the computer system forgoes rotating the indication of current time, such that the indication of current time has the first orientation relative to the first user interface with the second layout. For example, as described with reference to FIG. 5AG, in response to detecting a change in orientation of the device 100, the time indication 1122-3 is stretched (e.g., to change an aspect ratio of the time indication, as illustrated by time indication 1122-4).

In some embodiments, displaying the first user interface, including displaying the indication of current time overlaying the first region of the first background, includes displaying the indication of current time underlying at least a portion of a first foreground element of the first user interface (e.g., a main subject of a photo used as wallpaper of the first user interface, a media player controller, an alert, and/or other types of user interface objects) and/or overlaying at least a portion of a first background element of the first user interface (e.g., background elements of a photo that is used as wallpaper, application icons, widgets, notifications, and other types of user interface objects). In some embodiments, changing a shape of the indication of current time from a first shape to a second shape different from the first shape includes changing the shape of the indication of current time from the first shape to the second shape, while the indication of current time underlies at least a portion of the first foreground element of the first user interface and/or overlays at least a portion of the first background element of the first user interface (e.g., when changing the layout of the first user interface and stretching and/or compressing the indication of current time, the computer system maintains the relative positions of display layers for the indication of current time, the foreground elements, and the background elements). For example, as described with reference to FIG. 5AG, after changing a size and/or aspect ratio of the time indication 1122-4, the cloud from the background continues to be displayed as behind the time indication (e.g., with a portion of the cloud refracted, blurred, and/or distorted according to the simulated glass material of the time indication 1122-4) and the palm tree continues to be displayed in front of the time indication 1122-4.

In some embodiments, the first user interface concurrently includes a first element, a second element, and the indication of current time, in the first layout and in the second layout. In some embodiments, changing the layout of the first user interface from the first layout to the second layout includes maintaining a spatial relationship between the first element and the indication of current time (e.g., maintain a spatial relationship between the indication of current time and a widget displayed below the indication of current time). In some embodiments, changing the layout of the first user interface from the first layout to the second layout includes maintaining a spatial relationship between the second element and the indication of current time (e.g., maintain a spatial relationship between the indication of current time and a top edge of the first user interface and/or a date element displayed above the indication of current time). In some embodiments, changing the layout of the first user interface from the first layout to the second layout includes changing a spatial relationship between the first element and the second element from a first spatial relationship to a second spatial relationship different from the first spatial relationship (e.g., due to the change in shape and size of the indication of current time, the spatial relationship between the first element that is anchored to the bottom edge of the indication of current time and the second element that is anchored to the top edge of the indication of current time is changed, when the layout of the first user interface is changed). For example, as described with reference to FIG. 5AG, the time indication 1122-4 continues to be displayed with a same relative position relative to the horizon line of the background.

In some embodiments, changing the shape of the indication of current time from the first shape to the second shape includes stretching the indication of current time in a first stretching direction based on a simulated physical property (e.g., simulated inertia, deformation, simulated elasticity, and/or other simulated physical properties) of a user interface material of the indication of current time that changes with a changing shape of the indication of current time. In some embodiments, the stretching is slowed down and/or constrained, as the size of the indication of current time continues to increase in the first stretching direction. In some embodiments, a portion of the stretching is restored and/or reversed before the indication of current time settles into a steady state size in the second layout. In some embodiments, the stretching of the indication of current time is shown in an animated transition that has an ease in and/or ease out effect where the animated transition starts out slowly and speeds up and/or moves more quickly, and/or slows down at the end of the animated transition. For example, as described with reference to FIG. 5AG, in some embodiments, the time indication 1122-4 is stretched gradually, over time, in a manner that simulates physical properties, such as stretching with some resistance, inertia, deformation, and/or elasticity.

It should be understood that the particular order in which the operations in FIG. 13 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 14000, 15000, 16000, 17000, 18000, 19000, and/or 20000) are also applicable in an analogous manner to method 13000 described above with respect to FIG. 13. For example, the buttons, user interfaces, controls, visual deemphasis, virtual effects, an/or animations described above with reference to method 13000 optionally have one or more of the characteristics of the buttons, user interfaces, controls, visual deemphasis, virtual effects, an/or animations described herein with reference to other methods described herein (e.g., methods 7000, 8000, 9000, 10000, 11000, 12000, 14000, 15000, 16000, 17000, 18000, 19000, and/or 20000). For brevity, these details are not repeated here.

FIGS. 14A-14B are flow diagrams illustrating a method 14000 of adjusting visual properties used to generate a simulated user interface appearance of a user interface object in accordance with some embodiments. In some embodiments, the method 14000 is performed at a computer system (e.g., portable multifunction device 100, device 300 in FIGS. 1A-6AP) that is in communication with one or more input devices (e.g., touch-sensitive surfaces, optical sensors, motion sensors, proximity sensors, gyros, accelerometers, ambient light sensors, joysticks, buttons, keyboards, handheld controllers, pointer devices, and/or other types of input devices) and one or more display generation components (e.g., touch-screen displays, standalone displays, LED displays, LCD displays, head-mounted displays, heads-up displays, foldable displays, flexible displays, and/or other types of display generation components that provides one or more display areas in which content, user interfaces, and/or controls can be made visible to a user). Some operations in method 14000 are, optionally, combined and/or the order of some operations is, optionally, changed.

Displaying a user interface object with a simulated user interface material leverages the user's real world experience to provide information about the spatial relationships between the user interface elements, and to provide visual feedback regarding the effect of user inputs, inform the user about the change in the state of the computer system and application, and guide the user about how to use his/her input to change the system state and/or application state. The appearance of the user interface material also provides visual feedback regarding the type of user interface object and its associated functions. Some of the appearance characteristics are used to balance the need for visual saliency of the user interface objects against the background, visual saliency of the internal content of the user interface objects, and reduce visual distraction of the underlying content, and the efficiency in generating these appearances. Using user interface materials with simulated optical properties for user interface elements improves the legibility of content, which enables a user to use a device for shorter periods of time, which saves energy and improves battery life. Using user interface materials with simulated optical properties for user interface elements enables the user interface elements to be more transparent, and an increased transparency of user interface elements enables a user to use a device for shorter periods of time, which saves energy and improves battery life. Providing an appearance of user interface elements (e.g., changing material appearance based on underlying content) when one or more criteria are met reduces the number of inputs (e.g., navigating through settings user interfaces and menus to set the values for parameters to adjust the appearance of user interface elements) that would otherwise be required to generate a similar effect, which saves energy and improves battery life. In some embodiments, the user interface material can be made adaptive to changing conditions in the user interface and/or different usage scenarios. Additional details regarding the adaptive aspects of how material appearance can change based on various conditions and properties of the underlying content and various usage cases are provided with respect to method 19000 and Tables 3A-3F. For example, the method 14000 is described with respect to FIGS. 6A-6B4, 6B4-a, and 6C, and additional details regarding the adaptive parameters of the processes for generating material appearances of various types of user interface materials are provided with respect to FIGS. 6B5-6B13, method 19000, and Tables 3A-3F.

The computer system displays (14002), via the one or more display generation components, a first user interface (e.g., a system user interface, such as a home screen user interface, a notification history user interface, a widget user interface, a wake screen user interface, a lock screen user interface, a standby user interface, a coversheet user interface, and/or a user interface corresponding to an idle state, a sleep state, and/or a power saving state of the computer system; and/or an application user interface corresponding to an application), including a background (e.g., text, a video, an animation, one or more user interface elements, one or more windows, one or more platters, one or more controls, a pattern, an image, a photograph, a gradient, a color distribution, and/or another type of background with varying values for one or more display properties across the spatial extent of the first background), and a first user interface object (e.g., a control, a window, a notification, a pop-up, a banner, a toggle, a slider, a button, a menu, a toolbar, a platter, an icon, a dock, a live activity, a mini media player, a widget, and/or another type of user interface object) overlaying a portion of the background that has a first spatial arrangement relative to the first user interface object (e.g., overlaying the portion of the background that lies behind and/or underneath the first user interface object, at a first depth, at a first angle, and/or with a first amount of lateral offset, from the first user interface object) while the background has a first background appearance (e.g., the first background appearance is based on first content included in the first user interface, a first visible portion of a scrollable user interface, a first zoom level of the content in the first user interface, and/or a current state of the background).

In the first user interface, the first user interface object is displayed (14004) concurrently with a first simulated shadow (e.g., a simulated shadow that, optionally, takes into account a spatial relationship between the first user interface object and a virtual light source, a real light source, and/or other real or simulated lighting conditions) that is cast on a first portion of the background that has a second spatial arrangement relative to the first user interface object (e.g., a portion of the background that is near and/or adjacent to the first user interface object without being underneath and/or behind the first user interface object, and that is different from the portion of the background that has the first spatial arrangement relative to the first user interface object). For example, in some embodiments, the portion of the background that has the first spatial arrangement relative to the first user interface object is visually obscured by the first user interface object, while the portion of the background that has the second spatial interface object is concurrently displayed with the first user interface object (e.g., near, proximate to, adjacent to, next to, and/or surrounding a boundary of the first user interface object).

In the first user interface, the first simulated shadow is cast (14006) on the background based on a spatial arrangement (e.g., size, shape, orientation, and/or position) of the first user interface object relative to the background. In some embodiments, the simulated shadow (and/or the portion of the background on which the simulated shadow is cast) has a shape, size, and/or position that are based on the shape, size, and/or position of the first user interface object relative to the background, and, is, optionally, based on a spatial relationship (e.g., relative position, and/or relative direction) between the first user interface object and some virtual or real light source present in the environment of the first user interface. In some embodiments, the simulated shadow reduces the color saturation and/or luminance values of the portion of the background on which it is cast, in the first user interface. In some embodiments, the simulated shadow changes its position, size, and/or shape, based on a change in the appearance of the first user interface object (e.g., shape, size, orientation, and/or position) and/or the movement of the first user interface object relative to the virtual or real light source in the environment. In some embodiments, as an example, a greater thickness or height of the first user interface object and/or a greater distance between the first user interface object from the background, optionally cause a thicker shadow; while a larger size of the first user interface object and/or a more oblique angle between the first user interface object and the light source, optionally cause a longer shadow.

In the first user interface, the first user interface object is displayed (14008) with an appearance that simulates refraction of the portion of the background, with the first background appearance, that has the second spatial arrangement relative to the first user interface object (e.g., the portion of the background that has the second spatial relationship relative to the first user interface object includes a portion of the background that is next to, adjacent to, proximate to, and/or surrounding the first user interface object, without being behind and/or underneath the first user interface object), by a first portion of the first user interface object (e.g., an edge, a corner, and/or a peripheral portion of the first user interface object), without simulating refraction of the first simulated shadow cast on the first portion of the background that has the second spatial arrangement relative to the first user interface object (e.g., even though the first simulated shadow affects the appearance of the portion of the background on which it is cast, it does not affect the appearance of the simulated refraction in the first user interface object that is generated at least in part based on the portion of the background on which the first simulated shadow is cast), and In some embodiments, the first user interface object is displayed with an appearance that simulates refraction of its surrounding environment, such as a portion of the background behind and/or underlying the first user interface object, and/or a portion of the background that is near and/or adjacent to the first user interface object, as if the first user interface object was made of a glassy material, a gelatinous material and/or another material that has refractive properties. In some embodiments, the simulated refraction is shown within the boundary of the first user interface object as a variation of colors, patterns, lines, and brightness, across the surface and/or spatial extent of the first user interface object, based on the spatial arrangement (e.g., shape, curvature, surface texture, size, position, and/or orientation) of the first user interface object relative to the background, and based on the appearance of the portion of the background that is behind and/or underlying the first user interface object, and/or the portion of the background that is near and/or adjacent to the first user interface object. In some embodiments, the relevant characteristics of the appearance of the portions of the background that affect the simulated refractions displayed in the first user interface object include the colors, patterns, lines, and/or brightness, of the portions of the background. In some embodiments, the characteristics of the appearance of the portions of the background change, when the text, image, user interface objects, and/or content in the portions of the background are changed due to content navigation, content playback, scrolling, resizing, and/or other user interface responses to user inputs and/or system events. In some embodiments, simulated refraction of background content includes blurring, changing curvature, distortion of lines and shapes, color decomposition, darkening, brightening, and/or other visual effects mimicking the refraction of the content of the portions of the background. In some embodiments, the simulated refraction varies by intensity or degrees based on the simulated shape of the first user interface object, and is stronger in regions of the first user interface object that have smaller radii of curvature (e.g., sharper corners, sharper edges, and/or pointier and rounder shapes, as opposed to straight edges, and/or flatter and more gradual curves), and weaker in regions of the first user interface object that are flat or larger radii of curvature (e.g., along straight edges, and/or in the flat central and interior regions and/or under planner surfaces). It is to be noted that, in some embodiments, the simulated shadow and the simulated refraction are concurrently displayed, with the simulated shadow located outside of the boundary of the first user interface object, with the simulated refraction within the boundary of the first user interface object, and with the first user interface object having an appearance that simulates refraction of at least a respective portion of the background (e.g., a portion of the background that is near, proximate to, and/or adjacent to the boundary of the first user interface object), without simulating refraction of the simulated shadow overlaying the respective portion of the background. In some embodiments, the simulated shadow changes the appearance of the respective portion of the background by dimming, blurring, and reducing color saturation of the respective portion of the background, but the simulated refraction is generated based on the appearance of the respective portion of the background absent the effect of the simulated shadow.

While displaying the first user interface including the background and the first user interface object, the computer system detects (14010) occurrence of an event that corresponds to a change in appearance of the background from the first background appearance to a second background appearance that is different from the first background appearance (e.g., due to content automatically changing such as a playing video or animation, due to display of new user interface elements and/or dismissal of existing user interface elements from the first user interface in response to user input and/or system event, due to content shifting such as automatic scrolling or scrolling in response to detected user input, and/or due to content resizing such as automatic resizing or resizing in response to detected user input); and

In response to detecting the occurrence of the event that corresponds to the change in appearance of the background from the first background appearance to the second background appearance, the computer system displays (14012) an updated first user interface (e.g., the updated first user interface is based on the first user interface, with a visual change in the portion of the background underlying the first user interface object and/or the portion of the background adjacent to and/or surrounding the first user interface object, and/or with a change in the shape, size, orientation, and/or position of the first user interface object relative to the background), in which the first user interface object overlays a portion of the background that has the first spatial arrangement relative to the first user interface object (e.g., a portion of the background that is underlying and/or behind the first user interface object).

In the updated first user interface, the first user interface object is displayed (14014) concurrently with a second simulated shadow (e.g., the same as the first simulated shadow, or different from the first simulated shadow due to change in the spatial arrangement between the first user interface object relative to the background, and/or due to change in the light source) that is cast on a portion of the background that has the second spatial arrangement relative to the first user interface object. For example, in some embodiments, the first simulated shadow and the second simulated shadow are cast over the same portion of the background that has the second spatial arrangement relative to the first user interface object (e.g., near, next to, adjacent to, proximate to, and/or surrounding the boundary of the first user interface object), before and after the change in appearance of the background. In one example, in some embodiments, the first simulated shadow and the second simulated shadow are cast over different portions of the background that, respectively, have the second spatial arrangement relative to the first user interface object (e.g., near, next to, adjacent to, proximate to, and/or surrounding the boundary of the first user interface object), before and after the change in appearance of the background. In some embodiments, the first user interface object maintains its spatial arrangement to the background before and after the change in the appearance of the background from the first background appearance to the second background appearance. In some embodiments, the first user interface object changes its spatial arrangement to the background when the appearance of the background changes from the first background appearance to the second background appearance; but at least a portion of the background after the change in appearance of the background still has the second spatial relationship relative to the first user interface object.

In the updated first user interface, the second simulated shadow is cast (14016) on the background based on a spatial arrangement (e.g., size, shape, orientation, and/or position) of the first user interface object relative to the background. In the updated first user interface, the first user interface object is displayed (!4018) with an appearance that simulates refraction of the portion of the background, with the second background appearance, that has the second spatial arrangement relative to the first user interface object (e.g., the portion of the background that has the second spatial relationship relative to the first user interface object includes a portion of the background that is next to, adjacent to, proximate to, and/or surrounding the first user interface object, without being behind and/or underneath the first user interface object), by the first portion of the first user interface object (e.g., an edge, a corner, and/or a peripheral portion of the first user interface object), without simulating refraction of the second simulated shadow cast on the portion of the first background that has the second spatial arrangement relative to the first user interface object (e.g., even though the second simulated shadow affects the appearance of the portion of the background on which it is cast, it does not affect the appearance of the simulated refraction in the first user interface object that is generated based on the portion of the background on which the second simulated shadow is cast). For example, in some embodiments, as the appearance of the background is changed from the first background appearance and the second background appearance, the simulated shadow is cast over a portion of the background that is near a boundary of the first user interface object and changes the appearance of that portion of the background (e.g., making that portion of the background darker and more blurred, and/or adding an outline of the shadow over that portion of the background), and if that portion of the background is also near the boundary of the first user interface object, the first user interface object is displayed with simulated refraction that is based at least in part on the appearance of that portion of the background (e.g., the simulated refraction changes due to the changed appearance of that portion of the background), without being based on the simulated shadow cast on that portion of the background. In some embodiments, only a subset of the portion of the background that is overlaid by a simulated shadow is used in the simulated refraction displayed within the first user interface object (e.g., the simulated shadow may extend to a region relatively far away from the immediate surrounding region of the first user interface object, and not all regions of the background that are overlaid by the simulated shadow are used to generate the simulated refraction within the first user interface object). In some embodiments, the simulated refraction within the first user interface object is based on portions of the background that is overlaid by the simulated shadow, and portions of the background that are not overlaid by the simulated shadow. In some embodiments, the first user interface object is displayed concurrently with simulated shadow, simulated refraction, and, optionally, simulated specular highlights that are based on virtual light and/or real light surrounding the first user interface object.

This process is illustrated in FIG. 6C, where the user interface object 6004 is used as a representative of the first user interface object, and the content underlying the user interface object 6004 (e.g., underlying content or background 6048 including the triangle 6040 and the circle 6042) is used as a representative of the background that is overlaid by the first user interface object. FIG. 6C shows a portion of the first user interface (e.g., represented by a portion of the user interface 6050) that includes the first user interface object and a portion of the background, and it is understood that the first user interface can include various types of content, user interface objects, text, glyphs, images, wallpaper, textures, and images, that may correspond to a respective system state of a number of system states, a respective state of an application of a number of states of the application, and/or a respective application of a number of applications. In the example shown in FIG. 6C, the portion of the background that has the first spatial arrangement relative to the first user interface object is shown as the portion of the background 6048 that directly underlies the user interface object 6004, and is fully enclosed within the outline of the user interface object 6004. For example, in state 1, the portion of the background that has the first spatial arrangement relative to the user interface object 6004 includes the portion of the background 6048 (e.g., denoted as 6048-1) that is fully enclosed within the dashed outline of the user interface object 6004, and includes the top portion of the triangle 6040, without including the two lines 6044 and 6046. In state 2, the portion of the portion of the background that has the first spatial arrangement relative to the user interface object 6004 includes the portion of the background 6048 (e.g., denoted as 6048-2) that is fully enclosed within the dashed outline of the user interface object 6004, and includes the top portion of the circle 6042 and the top and middle portions of the triangle 6040, without including the lower line 6046. In state 3, the portion of the background that has the first spatial arrangement relative to the user interface object 6004 includes the portion of the background 6048 (e.g., denoted as 6048-3) that is fully enclosed within the dashed outline of the user interface object 6004, and includes the top portion of the circle 6042, and the top and middle portions of the triangle 6040 rotated to the right, without including the lower line 6046. The different states shown in FIG. 6C correspond to different background appearances of the background 6048, in accordance with some embodiments. In the right column of FIG. 6C, the user interface object 6004 is displayed with a respective simulated shadow 6052 (e.g., denoted as 6052-1, 6052-2, and 6052-3 for state 1, state 2, and state 3, respectively). The respective simulated shadow 6052 is shown as being cast on the background 6048 on a first portion of the background 6048 (e.g., the same portion of the background 6048 with different background appearances, or different portions of the background 6048 that has the second spatial relationship to the user interface object 6004 if the background moved relative to the user interface object 6004, as represented in states 1-3 in FIG. 6C). As shown in FIG. 6C, the first portion of the background on which the simulated shadow 6052 is cast has the second spatial relationship relative to the user interface object 6004 (e.g., is a thin strip that is offset from the outline of the user interface object). In some embodiments, the shape and location of the simulated shadow 6052 are determined based on the spatial arrangement of the user interface object 6004 relative to the background 6048. As described with respect to FIG. 6C, the user interface object 6004 is displayed with an object appearance that simulates refraction of a portion of the underlying content 6048 that is directly behind the user interface object 6004 and a portion of the underlying content 6048 that is adjacent to and within a refraction-threshold distance from the outline of the user interface object 6004. As also described with respect to FIG. 6C, the simulated shadow overlays a portion of the underlying content 6048 that is within a shadow-threshold distance from the outline of the user interface object 6004. Therefore, there is non-zero overlap between the portion of the underlying content 6048 that is used to generate the object appearance of the user interface object 6004 and the portion of the underlying content 6048 that is overlaid by the simulated shadow 6052 of the user interface object 6004. As described in FIGS. 6A-6B, the simulated shadow (e.g., in a simulated shadow layer 6003D) and the simulated refraction (e.g., in simulated refraction layers 6003C) are both generated from blurred underlying content (e.g., in blur layer 6003B generated from underlying content 6003A), and thus, the object appearance of the user interface object 6004 simulates refraction of the portion of the background 6048 that has the second spatial relationship relative to the user interface object 6004, without simulating refraction of the simulated shadow cast on the first portion of the background that has the second spatial arrangement relative to the user interface object 6004 (e.g., without simulating refraction of the portion of the simulated shadow 6052-1, which includes darkened representations of a portion of the triangle 6040 and line 6044 in state 1, which includes darkened representations of a portion of the circle 6042, a portion of the triangle 6040, and line 6046 in state 2, and which includes darkened representations of a portion of the circle 6042, a portion of the triangle 6040, and line 6046). It is illustrative in FIG. 6C, that, in state 1, the object appearance of the user interface object 6004 includes a refracted representation of a portion of the triangle 6040 (e.g., the portion including the line 6044) that is not darkened but is distorted (e.g., elongated to simulate refraction) in the user interface object 6004 (e.g., refracted representation of line 6044 is shown as dashed line 6044′), but is shown as darkened in the simulated shadow 6052-1 (e.g., shadow representation of line 6044 is shown as darkened line 6044′). It is illustrative in FIG. 6C, that, in state 2, the object appearance of the user interface object 6004 includes a refracted representation of a portion of the triangle 6040 (e.g., the portion including the line 6046) that is not darkened but is distorted (e.g., elongated to simulate refraction) in the user interface object 6004 (e.g., refracted representation of line 6046 is shown as dashed line 6046′), but is shown as darkened in the simulated shadow 6052-2 (e.g., shadow representation of line 6046 is shown as darkened line 6046″). It is illustrated in FIG. 6C, that, in state 3, the object appearance of the user interface object 6004 includes a refracted representation of a portion of the triangle 6040 (e.g., the portion including the line 6046) that is not darkened but is distorted (e.g., elongated to simulate refraction) in the user interface object 6004 (e.g., refracted representation of line 6046 is shown as dashed line 6046′), but is shown as darkened in the simulated shadow 6052-2 (e.g., shadow representation of line 6046 is shown as darkened line 6046″). As described with respect to FIG. 6C, the different states (e.g., state 1, state 2, and state 3) correspond to different background appearances of the portion of the background 6048 relative to the user interface object 6004. In some embodiments, the occurrence of an event that corresponds to a change in appearance of the background from one background appearance to another background appearance includes detection of a user input and/or a change in the state of the computer system (e.g., system state, or state within a currently displayed user interface or a currently displayed application) that causes the appearance of the underlying content behind and/or near the user interface object 6004 to change (e.g., between the states shown in FIG. 6C). As illustrated in FIG. 6C, the change in appearance of the underlying content behind causes the change in the appearance of the user interface object 6004 and change in the appearance of the simulated shadow 6052, however, the process of generating the simulated shadow 6004 and the object appearance of the user interface object 6004 are as described with respect to FIG. 6A-6B, and the object appearance of the user interface object 6004 do not include simulated refraction of the simulated shadow in the area of overlap between the portion of the underlying content overlaid by the simulated shadow and the portion of the underlying content that is used to generate the simulated refraction.

In some embodiments, detecting the occurrence of the event that corresponds to the change in appearance of the background from the first background appearance to the second background appearance includes detecting that content in the background (e.g., one or more animated objects, a media player window with a video playing, and/or other automatically changing content) is automatically updated (e.g., continuously changing appearance over an extended period of time) without detecting a user input (e.g., without requiring a user input to maintain the continuous changes after a visual change has been initiated). In some embodiments, the background is automatically updated by the computer system when the background includes animated content that automatically changes appearance over time (e.g., when an animated wallpaper or music video is displayed on a wake screen during playback of a media item, and/or when an animated image is used in a wallpaper of the first user interface). In some embodiments, the first user interface includes a content playback window, a game, a webpage with animated content, and/or other automatically changing content. In some embodiments, a change in wallpaper and/or a change in configuration of a wake screen are automatically carried out due to a change in time of day and/or other preconfigured conditions being met. As illustrated in and described with respect to FIG. 6C, in some embodiments, the event that corresponds to the change in appearance of the background 6048 includes the background 6048 automatically updating (e.g., between state 1 and state 2, between state 2 and state 3, and/or between state 1 and state 3) without detecting a user input, such as when the background 6048 changes appearance in accordance with a change in system state and/or a change in a state of the currently displayed user interface 6050 (e.g., as part of an animated transition, content playback, and/or other automatic updates).

In some embodiments, detecting the occurrence of the event that corresponds to the change in appearance of the background from the first background appearance to the second background appearance includes detecting a user input that corresponds to a request to change the appearance of the background. In some embodiments, the user input is a user input directed to the first user interface object that causes the update to the background. In some embodiments, the user input is a user input directed to a portion of the background (e.g., an unoccupied portion of the first user interface, and/or a user interface object that is concurrently displayed with the first user interface object in the first user interface) that causes the update to the background. In some embodiments, the user input that corresponds to a request to change the appearance of the background includes one or more user inputs that reconfigure the first user interface, such as adding user interface objects, removing user interface objects, and/or repositioning user interface objects in the first user interface (e.g., adding, removing, and/or repositioning application icons, controls, notifications, live activities, and/or other user interface objects that can be added, removed, and/or repositioned in the first user interface in a configuration process of the first user interface. In some embodiments, the user input that corresponds to a request to change the appearance of the background includes one or more user inputs that adjust a control (e.g., a slider control, a button, a toggle, and/or other types of controls), and/or interact with a user interface object (e.g., a menu, an icon, a text input field) displayed in the first user interface, that trigger changes in the first user interface and in the background. In some embodiments, the user input that corresponds to the request to change the appearance of the background includes one or more user inputs that scroll, resize, and/or otherwise interact with content in the first user interface, and/or content in the background. In some embodiments, the user input that corresponds to the request to change the appearance of the background includes one or more touch gestures such as one or more tap gestures, swipe gestures, touch and hold gestures, and/or light press gestures, with one or more contacts at locations corresponding to the first user interface object and/or the background. In some embodiments, the user input that corresponds to the request to change the appearance of the background includes one or more mouse inputs such as one or more click inputs, click and drag inputs, click and hold inputs, right-click inputs, and/or double click inputs, with a focus selector at locations corresponding to the first user interface object and/or the background. In some embodiments, the user input that corresponds to the request to change the appearance of the background includes one or more air gestures such as one or more air pinch gestures, air pinch and drag gestures, air pinch and hold gestures, air pinch and drag gestures, with user's attention directed to the first user interface object and/or the background. As illustrated in and described with respect to FIG. 6C, in some embodiments, the event that corresponds to the change in appearance of the background 6048 includes detection of one or more user inputs that change the background 6048 and/or that change the spatial arrangement of the background 6048 and the user interface object 6004 (e.g., between state 1 and state 2, between state 2 and state 3, and/or between state 1 and state 3).

In some embodiments, in the first user interface (e.g., before the detection of the event), the appearance of the first user interface object is based, at least in part, on a blurred appearance of the portion of the background, with the first background appearance, that has the first spatial arrangement relative to the first user interface object (e.g., including and/or is part of the portion of the background that directly underlies the first user interface object). In some embodiments, the blurred appearance is also based, at least in part, on the portion of the background, with the first background appearance, that has the second spatial arrangement relative to the first user interface object (e.g., including and/or is part of the portion of the background that is adjacent to the first user interface object that is within a threshold distance from the edges of the first user interface object). In some embodiments, in the updated first user interface (e.g., after the detection of the event), the first user interface object is displayed with an appearance that is based, at least in part, on a blurred appearance of the portion of the background, with the second background appearance, that has the first spatial arrangement relative to the first user interface object, and the portion of the background, with the second background appearance, that has the second spatial arrangement relative to the first user interface object. In some embodiments, the blurred appearance of the portion of the background, with the first background appearance, that has the first spatial arrangement relative to the first user interface object includes a greater amount of blur (e.g., with greater blur radius, greater opacity, and/or other techniques for increasing blur) in an edge portion of the blurred appearance, than an interior portion of the blurred appearance away from the edge portion of the blurred appearance. For example, in some embodiments, when generating the appearance of the first user interface object based on the portion of the background that underlies the first user interface object and the portion of the background that is adjacent to the first user interface object, the computer system generate an blurred appearance for these portions of the background (e.g., in a blur layer), and use the blurred appearance as basis for subsequent visual effects that simulate optical interactions between the first user interface object and its nearby content in the background. In some embodiments, the blurred appearance for these portions of the background is generated by applying a greater degree of blurring (e.g., with a greater blur radius, greater opacity, and/or other blurring methods with increasing blurring strengths) closer to the edges of the first user interface object, and a lesser degree of blurring farther away from the edges of the first user interface object. In some embodiments, the shape of the blurred appearance has the same or similar shape to the shape of the first user interface object (e.g., the footprint or outline of the first user interface object against the background). In some embodiments, the blur is heavier around the outline of the first user interface object on the background, and lighter away from the outline toward the interior of the first user interface object and/or away from the first user interface object. In some embodiments, the blurred appearance is also used as basis for the appearance of the simulated shadow overlaying the background, and/or simulated color bleed into the first user interface object. As illustrated in FIGS. 6A-6B3, in some embodiments, the object appearance of the user interface object 6004 is generated based on a blurred appearance of the underlying content 6003A (e.g., in the blur layer 6003B), where the blurred appearance has different magnitudes of blur (e.g., changes in opacity and/or blur radius) in different portions of the underlying content 6003A that have different distances from the outline of the user interface object 6004 (e.g., the different distances corresponding to contours 6006-1, 6002-2, and 6002-3 correspond to different intensity of blur applied to the underlying content 6003A). In some embodiments, the blur radius is increased (e.g., obfuscating the details of the underlying content by increasing degrees to simulate increasing simulated thickness of the user interface material) with increasing distance from the outline of the user interface object 6004 within the outline of the user interface object, and decreased (e.g., obfuscating the details of the underlying content by decreasing degrees to simulate decreasing simulated thickness of the user interface material) with increasing distance from the outline of the user interface object 6004 outside the outline of the user interface object. In some embodiments, the opacity of the blur layer 6003B is increased (e.g., letting through less of the underlying content to simulate increasing simulated thickness of the user interface material) with increasing distance from the outline of the user interface object 6004 within the outline of the user interface object, and decreased (e.g., letting through more of the underlying content to simulate decreasing simulated thickness of the user interface material) with increasing distance from the outline of the user interface object 6004 outside the outline of the user interface object.

In some embodiments, the blurred appearance of the portion of the background, with the first background appearance, that has the first spatial arrangement relative to the first user interface object includes a first distribution of blurring (e.g., first distribution of blur radii, opacities, and/or other blur parameters) from the edge portion of the blurred appearance to the interior portion of the blurred appearance, based on the first user interface object having a first spatial relationship to a physical environment of the computer system (e.g., as detected by a gyro, accelerometer, ambient light sensor, motion sensor, and/or other sensors), and a second distribution of blurring (e.g., first distribution of blur radii, opacities, and/or other blur parameters) from the edge portion of the blurred appearance to the interior portion of the blurred appearance, based on the first user interface object having a second spatial relationship to the physical environment of the computer system (e.g., as detected by a gyro, accelerometer, ambient light sensor, motion sensor, and/or other sensors). In some embodiments, the first distribution of blurring is different from the second distribution of blurring. In some embodiments, the first spatial relationship is different from the second spatial relationship. For example, in some embodiments, the computer system also changes the simulated refraction and simulated shadow, by changing the blurred appearance of the portions of the background underlying and adjacent the first user interface object based on changes in the lighting in the physical environment, before using the blurred appearance to generate the simulated refraction and/or simulated shadow of the first user interface object. As illustrated in and described with respect to FIGS. 6A-6B3, in some embodiments, the opacity and blur radius used in the blur layer 6003B changes depending on the external lighting and/or the changes in the device orientation relative to the environment. In some embodiments, the object appearance of the user interface object 6004 is generated based on a blurred appearance of the underlying content 6003A (e.g., in the blur layer 6003B), where the blurred appearance has different magnitudes of blur (e.g., changes in opacity and/or blur radius) in different portions of the underlying content 6003A that have different distances from the outline of the user interface object 6004 (e.g., the different distances corresponding to contours 6006-1, 6002-2, and 6002-3 correspond to different intensity of blur applied to the underlying content 6003A). In some embodiments, the overall range of blur radii used in the blur layer is shifted toward greater degrees of blur to simulate a reduction of ambient light (e.g., obfuscating the details of the underlying content by increasing degrees to simulate a reduction of ambient light), and is shifted toward smaller degrees of blur to simulate an increase in ambient light (e.g., obfuscating the details of the underlying content by decreasing degrees to simulate an increase in ambient light). In some embodiments, the overall range of opacities used in the blur layer is shifted toward greater degrees of opacity to simulate a reduction of ambient light (e.g., less of the underlying content is let through to simulate a reduction of ambient light), and is shifted toward smaller degrees of opacity to simulate an increase in ambient light (e.g., more of the underlying content is let through to simulate an increase in ambient light).

In some embodiments, displaying the first user interface (and/or displaying the updated first user interface) includes displaying, via the one or more display generation components, the first user interface object with an appearance that simulates refraction of one or more portions of the background (e.g., with the first background appearance, and/or with the second background appearance) by a user interface material within a boundary of the first user interface object. In some embodiments, the one or more portions of the background includes the portion of the background that has the first spatial arrangement relative to the background, the portion of the background that has the second spatial arrangement relative to the background, and/or other portions of the background that directly underly the first user interface object and/or is within a threshold distance from the first user interface object. In some embodiments, the appearance that simulates refraction of the one or more portions of the background (e.g., with the first background appearance, and/or with the second background appearance) by the user interface material within the boundary of the first user interface object includes the appearance that simulates refection of the portion of the background that has the second spatial arrangement relative to the first user interface object, and other portions of the background that does not have the second spatial arrangement relative to the first user interface object. In some embodiments, the appearance that simulates refraction of the one or more portions of the background simulates a first amount of simulated refraction (e.g., a first amount of distortion, color separation, chromatic aberration, and/or other simulated effects of refraction) in a first portion of the user interface object. In some embodiments, the appearance that simulates refraction of the one or more portions of the background simulates a second amount of simulated refraction (e.g., a second amount of distortion, color separation, chromatic aberration, and/or other simulated effects of refraction), different from the simulated refraction, for a second portion of the first user interface object, different from the first portion of the first user interface object. For example, in some embodiments, the simulated refraction varies in intensity spatially across the first user interface object (e.g., more refraction near the edges of the first user interfaced object and less refraction toward the center or interior of the first user interface object; and/or with more refraction in areas that corresponds to less blurring in the blurred appearance of the background). In some embodiments, the spatial variation in the amount and/or intensity of simulated refraction across the spatial extent of the first user interface object simulates the varying thickness of the first user interface object in a depth direction of the first user interface, and/or varying curvature across an outline of the first user interface object against the background. In some embodiments, the spatial variations of the intensity of the simulated refraction includes varying intensity of simulated internal refraction in the edge portion of the first user interface material where the simulated thicknesses of the first user interface material vary spatially (e.g., as described with respect to the simulated internal refraction layer 6003C-1, simulated external refraction layer 6003C-2, and the combined refraction layer 6003C-3 in FIGS. 6A-6C). In some embodiments, displaying the first user interface (and/or displaying the updated first user interface) includes displaying, via the one or more display generation components, the first user interface object with an appearance that simulates refraction of internal content of the first user interface object (e.g., refraction of “internal content” is different from “internal refraction” of underlying content) by the user interface material within the boundary of the first user interface object. In some embodiments, the appearance that simulates refraction of the internal content simulates a third amount of simulated refraction (e.g., a third amount of distortion, color separation, chromatic aberration, and/or other simulated effects of refraction) in the first portion of the user interface object; and the appearance that simulates refraction of the internal content simulates a fourth amount of simulated refraction (e.g., a fourth amount of distortion, color separation, chromatic aberration, and/or other simulated effects of refraction), different from the third amount of simulated refraction, for the second portion of the first user interface object (e.g., as described with respect to the lensing layer 6003J in FIGS. 6A-6C).

In some embodiments, displaying the first simulated shadow includes displaying the first simulated shadow with an appearance (e.g., with one or more values of one or more visual properties) that is based, at least in part, on one or more visual properties (e.g., colors, luminance, and/or a blurred appearance) of the portion of the background that has the second spatial arrangement relative to the first user interface object (e.g., and/or, optionally, portions of the background that are within a threshold distance from an outline of the first user interface object on the background). In some embodiments, a blur layer is generated by applying a blur treatment (e.g., optionally with stronger blur near the edge of the first user interface object, and weaker blur away from the edge of the first user interface object) to the appearance of one or more portions of the background, including the portion of the background that underlies the first user interface object and the portion and/or the portion of the background that is within a threshold distance from the first user interface object. The blur layer is used as the basis for generating the appearance of the simulated shadow of the first user interface object. For example, in some embodiments, the first simulated shadow is displayed overlaying a portion of the background (e.g., including the portion that has the second spatial arrangement relative to the first user interface object, and possibly other portions near the edge of the first user interface object), and has an appearance that is based on a darkened and/or further blurred version of the portion of the blur layer that corresponds to the location of the first simulated shadow. In some embodiments, a stronger blur treatment is used to generate the simulated shadow from the portion of the background that has the second spatial arrangement relative to the first user interface object, as compared to the blur treatment used to generate the appearance of the first user interface object based on the portion of the background that has the first spatial arrangement relative to the first user interface object (e.g., blur treatment in the blur layer has a higher blur radius outside the outline of the first user interface object, as compared to inside of the outline of the first user interface object). As illustrated in and described with respect to FIGS. 6A-6B2, in some embodiments, the simulated shadow 6018 of the user interface object 6004 includes a thin region of pixel values in the simulated shadow layer 6003D, and the simulated shadow layer 6003D is generated based on the blur layer 6003B that has different degrees of blur and/or opacity in different regions of the blur layer relative to the outline of the user interface object 6004. In some embodiments, the portion of the underlying content 6003A that is used to generate the simulated shadow 6018 is within a shadow-threshold distance (e.g., optionally, greater than the refraction-threshold distance used in identifying the portion of the underlying content used to generate the simulated refraction within the user interface object) from the outline of the user interface object 6004.

In some embodiments, displaying the first simulated shadow includes displaying the first simulated shadow with an appearance that is based on one or more visual properties (e.g., colors, luminance, and/or a blurred version) of the portion of the background that has the second spatial arrangement relative to the first user interface object, and one or more visual properties (e.g., colors, luminance, and/or a blurred version) of a portion of the background that has a third spatial arrangement, different from the first spatial arrangement and the second spatial arrangement, relative to the first user interface object (e.g., the first simulated shadow is cast over a larger region of the background that includes the first portion of the background and additional portions of the background that has the third spatial arrangement relative to the first user interface object). In some embodiments, the portion of the background that has the third spatial arrangement relative to the first user interface object is farther away from the first user interface object than the portion of the background that has the second spatial arrangement relative to the first user interface object. In some embodiments, the appearance of the first user interface object that simulates refraction of the portion of the background that has the second spatial arrangement relative to the first user interface object (and that simulates refraction of the portion of the background that has the first spatial arrangement relative to the first user interface object) does not simulate refraction of the portion of the background that has the third spatial arrangement relative to the first user interface object (e.g., the portion of the background that is overlaid by the first simulated shadow and that is used to generate the appearance of the first simulated shadow spans beyond and is not fully included within the portion of the background that is used in generating the simulated refraction in the first user interface object). In some embodiments, the spatial range of the blur layer used to generate simulated shadows of the first user interface object fully encloses the spatial range of the blur layer used to generate simulated refraction of the first user interface object, and is larger than the spatial range of the blur layer used to generate the simulated refraction of the first user interface object, in one or more directions (e.g., width and/or height). As illustrated in and described with respect to FIGS. 6A-6B2, in some embodiments, the simulated shadow 6018 of the user interface object 6004 includes a thin region of pixel values in the simulated shadow layer 6003D, and the simulated shadow layer 6003D is generated based on the blur layer 6003B that has different degrees of blur and/or opacity in different regions of the blur layer relative to the outline of the user interface object 6004. In some embodiments, the portion of the underlying content 6003A that is used to generate the simulated shadow 6018 is within a shadow-threshold distance (e.g., optionally, greater than the refraction-threshold distance used in identifying the portion of the underlying content used to generate the simulated refraction within the user interface object) from the outline of the user interface object 6004. As illustrated in and described with respect to FIG. 6C, at least a portion of the underlying content 6048 that is used to generate the simulated shadow 6052 is not used to generate the simulated refraction within the outline of the user interface object 6004. For example, in FIG. 6C, in state 2, the portion of the underlying content 6048 that includes the lower portion of the slanted line 6046 has the third spatial relationship to the outline of the user interface object (e.g., is within the shadow-threshold distance, but not within the refraction-threshold distance, from the outline of the user interface object 6004), and the simulated refraction within the user interface object is not based on the lower portion of the slanted line 6046 (e.g., represented as line 6046′ that does not include a representation of the lower portion of the slanted line 6046). In state 2, the portion of the underlying content 6048 that includes the upper portion of the slanted line 6046 has the second spatial arrangement relative to the user interface object 6004, and is used in both the simulated refraction within the user interface object 6004 (e.g., represented by the dashed upper portion of the slanted line 6046′) and the simulated shadow outside the user interface object 6004 (e.g., represented by the darkened upper portion of the slanted line 6046″).

In some embodiments, displaying the first user interface object includes applying a simulated sheen (e.g., a color overlay) on a user interface material of the first user interface object, and the simulated sheen includes one or more colors that are selected based on one or more colors sampled from a portion of the background that is outside of a boundary of the first user interface object (e.g., a portion of the background that surrounds the outline of the first user interface object on the background, and that is, optionally, spaced apart from the boundary of the first user interface object by more than a threshold distance away from the boundary). In some embodiments, the computer system displays a simulated sheen on the simulated surface of the first user interface object, optionally with colors sampled from the content that is farther away from the simulated surface of the first user interface object than the content used to generate the simulated shadows and/or simulated refraction of the first user interface object. In some embodiments, the colors of the simulated sheen are more saturated than the colors sampled from the surrounding content of the background. In some embodiments, the colors of the simulated sheen are distributed across the spatial extent of the first user interface object with greater intensities near the sources of the colors, and weaker intensities going farther away from the sources of the colors. In some embodiments, the sheen is added on top of the simulated refraction of the underlying content and the internal content. As illustrated in and described with respect to FIGS. 6A and 6B1-6B2, in some embodiments, the user interface object 6004 is displayed with an object appearance that includes the effects of a simulated edge bleed and sheen layer 6003F added to the simulated refraction layers 6003C, where the simulated sheen in the simulated edge bleed and sheen layer 6003F is based on the blur layer 6003B, which is further based on the underlying content 6003A, and as such the simulated sheen on the user interface material of the user interface object includes one or more colors that are selected based on one or more colors sampled from a portion of the underlying content 6003A that is outside of a boundary of the user interface object 6004.

In some embodiments, the first simulated shadow (and, optionally, the second simulated shadow, and/or other simulated shadow of the first user interface object in the first user interface) is based on a portion of the background that is less than a shadow-threshold distance (e.g., 20 pixels, 10 pixels, or another distance threshold set for the spatial extent of the blur layer used to generate the simulated shadows for the first user interface object) from a boundary of the first user interface object (e.g., the outline of the first user interface object against the background). In some embodiments, the simulated sheen is based on a portion of the background that is less than a sheen-threshold distance (e.g., 200 pixels, 100 pixels, or another distance threshold set for the spatial extent of the blur layer used to generate the simulated sheen on the first user interface object) from the boundary of the first user interface object. /In some embodiments, the sheen-threshold distance is greater than the shadow-threshold distance. For example, in some embodiments, the simulated sheen overlaying the first user interface object is based on a portion of the background content that is further away from the first user interface object than the portion of the background content that is used to color the simulated shadow of the first user interface object. As illustrated in and described with respect to FIGS. 6A and 6B1-6B2, in some embodiments, the user interface object 6004 is displayed with an object appearance that includes the effects of a simulated edge bleed and sheen layer 6003F added to the simulated refraction layers 6003C, where the simulated sheen in the simulated edge bleed and sheen layer 6003F is based on the blur layer 6003B, which is further based on the underlying content 6003A, and the simulated sheen takes into account of pixels that are within a sheen-threshold distance that is greater than the shadow-threshold distance used to identify the portion of the underlying content that is used to generate the simulated shadow of the user interface object 6004.

In some embodiments, the simulated sheen is based on a portion of the background that is less than a sheen-threshold distance (e.g., 200 pixels, 100 pixels, or another distance threshold set for the spatial extent of the blur layer used to generate the simulated sheen on the first user interface object) from a boundary of the first user interface object (e.g., the outline of the first user interface object against the background). In some embodiments, the appearance of the first user interface object simulates refraction of a portion of the background that is less than a refraction-threshold distance (e.g., 5 pixels, 7 pixels, or another distance threshold set for the spatial extent of the blur layer used to generate the simulated refraction within the first user interface object) from the boundary of the first user interface object. In some embodiments, the refraction-threshold distance is smaller than the sheen-threshold distance. For example, in some embodiments, the simulated sheen can take on colors and spatial extent of an adjacent user interface object that is spaced apart from the first user interface object, while the simulated refraction and/or the simulated shadow are based on background content that is within respective threshold distances from the boundary of the first user interface object, wherein the respective threshold distances are smaller than the distance between the boundary of the first user interface object and the adjacent user interface object. As illustrated in and described with respect to FIGS. 6A and 6B1-6B2, in some embodiments, the user interface object 6004 is displayed with an object appearance that includes the effects of a simulated edge bleed and sheen layer 6003F added to the simulated refraction layers 6003C, where the simulated sheen in the simulated edge bleed and sheen layer 6003F is based on the blur layer 6003B, which is further based on the underlying content 6003A, and the simulated sheen takes into account of pixels that are within a sheen-threshold distance that is greater than the refraction-threshold distance used to identify the portion of the underlying content that is used to generate the simulated refraction of the user interface object 6004.

In some embodiments, the first simulated shadow is generated using a first color blending process, and the simulated sheen is generated using a second color blending process that is different from the first color blending process. For example, in some embodiments, the color blending process used to generate the simulated sheen over the first user interface object is more additive than the color blending process used to generate the simulated shadow over the background, e.g., to be less influenced by the darker colors in the nearby content of the background as compared to how the simulated shadow is influenced by the darker colors in the nearby content of the background. In a more specific example, a dark colored object near the first user interface object does not influence the simulated sheen on the first user interface object very much, in contrast to a bright colored object near the first user interface object. However, the dark colored background near the edge of the first user interface object would influence the color of the simulated shadow cast on the dark colored background, as much as light colored background near the edge of the first user interface object. As illustrated in and described with respect to FIGS. 6A and 6B1-6B2, in some embodiments, the user interface object 6004 is displayed with an object appearance that includes the effects of a simulated edge bleed and sheen layer 6003F added to the simulated refraction layers 6003C, where the simulated sheen is blended with its underlying layers (e.g., the simulated refraction layers 6003C, optionally modified by color matrices 6003E) in a manner that is more additive (e.g., resulting in an object appearance that is less influence by dark colors of the underlying layers), as compared to how the simulated shadow is blended with its underlying layers (e.g., the blur layer 6003B, optionally modified by color matrices 6003E).

In some embodiments, the simulated sheen includes one or more colors that correspond to a first amount of increase in color saturation from the one or more colors sampled from the portion of the background that is outside of the boundary of the first user interface object (e.g., the simulated sheen has a color that is more saturated than a corresponding color of a nearby object, to simulate the sheen caused by the nearby object). In some embodiments, the first simulated shadow one or more colors that correspond to a second amount of increase in color saturation from one or more colors sampled from the portion of the background that has the second spatial arrangement of the background (and, optionally, other portions of the background that is within the shadow-threshold distance from the boundary of the first user interface object). In some embodiments, the first amount of increase in color saturation is greater than the second amount of increase in color saturation (e.g., the first and second amounts of increase in color saturation are both non-zero amounts of increases, and/or the second amount of increase includes no increase in color saturation). As illustrated in and described with respect to FIGS. 6A and 6B1-6B2, in some embodiments, the user interface object 6004 is displayed with an object appearance that includes the effects of a simulated edge bleed and sheen layer 6003F added to the simulated refraction layers 6003C, where the simulated sheen includes a boost in color saturation for colors sampled from the underlying layers (e.g., the refraction layers 6003C, optionally modified by color matrices 6003E), while the simulated shadow includes a reduction in color saturation for colors sampled from its underlying layers (e.g., the blur layer 6003B, optionally modified by the one or more color matrices 6003D).

In some embodiments, displaying the first user interface object includes displaying a first color layer over the simulated sheen. For example, in some embodiments, the color layer includes the color of the user interface material of the first user interface object, and simulates an intrinsic color of the user interface material, as opposed to colors caused by simulated optical interactions with the surrounding content and/or the physical environment. In some embodiments, the color of the color layer is also referred to as a “tint” of the first user interface material. In some embodiments, the first color layer includes a gradient of a respective color, or gradients of more than one color. In some embodiments, when the user interface material of a first object is transformed into the user interface material of a second object, the tint of the user interface material used for the first object is also transformed into the tint of the user interface material used for the second object through a sequence of animated intermediate tints, where the intermediate tints show a gradient between the tint for the first object and the tint for the second object that changes over time (e.g., distribution of the tint moves within the user interface material during the animated transition). As illustrated in and described with respect to FIGS. 6A-6B3, in some embodiments, the user interface material of the user interface object 6004 includes a simulated tint, and the simulated tint is implemented in a tint layer 6003G that is added to its underlying layers (the edge bleed and sheen layer 6003F, the refraction layers 6003C, optionally modified by the color matrices 6003E, or the composite of the underlying layers 6003B, 6003C, 6003E, and/or 6003F).

In some embodiments, while displaying the first user interface including the first user interface object, the computer system detects an event that corresponds to a request to display a second user interface object different from the first user interface object. In response to detecting the event that corresponds to a request to display the second user interface object different from the first user interface object, and in accordance with a determination that the first user interface object and the second user interface object meet transformation criteria (e.g., the first user interface object and the second user interface object are located within a threshold distance of each other, and/or are related to each other), the computer system displays an animated transition that transforms the first user interface object into the second user interface object. Displaying the animated transition includes transforming a user interface material of the first user interface object through a plurality of intermediate states into a user interface material of the second user interface object (e.g., the shape of the user interface material of the first user interface object is transformed into the shape of the user interface material of the second user interface object through a plurality of intermediate shapes). In some embodiments, the user interface material of the first user interface object has a first color layer (e.g., corresponding to a first tint, and/or material color). In some embodiments, the user interface material of the second user interface object has a second color layer different from the first color layer (e.g., corresponding to a second tint, and/or material color, different from the first tint and/or material color). In some embodiments, the plurality of intermediate states includes a first intermediate state in which a user interface material of the first intermediate state includes a first intermediate color layer, followed by a second intermediate state in which a user interface material of the second intermediate state includes a second intermediate color layer that is different from the first intermediate color layer (e.g., the intermediate color layers correspond to transitional tints and material colors). In some embodiments, the first intermediate color layer has a first color gradient between a color of the first color layer and a color of the second color layer (e.g., the first intermediate color layer has a gradient that shows a first gradual transition between the first tint and/or material color to the second tint and/or material color). In some embodiments, the second intermediate color layer has a second color gradient between the color of the first color layer and the color of the second color layer (e.g., the second intermediate color layer has a gradient that shows a second gradual transition between the first tint and/or material color to the second tint and/or material color). In some embodiments, the first color gradient is different from (e.g., has different positions for a respective color value than) the second color gradient (e.g., when merging or splitting two user interface objects with different color layers, the intermediate color layer has multiple gradient color points that change in location as the animation progresses). As illustrated in and described with respect to FIGS. 6A-6B3, in some embodiments, the user interface material of the user interface object 6004 includes a simulated tint, and the simulated tint is implemented in a tint layer 6003G that is added to its underlying layers (the edge bleed and sheen layer 6003F, the refraction layers 6003C, optionally modified by the color matrices 6003E, or the composite of the underlying layers 6003B, 6003C, 6003E, and/or 6003F). In some embodiments, when the user interface material of the user interface object is transitioned into the user interface material of another user interface object (e.g., through a morphing animation, “mitosis” animation, and/or “merging” animation), the tint layer of the user interface object is changed to show animated movement of a gradient from the tint of the user interface object to the tint of the other user interface object in a plurality of intermediate tint layers of a plurality of intermediate appearances of the user interface material (e.g., based on intermediate shapes and sizes, intermediate positions, and/or intermediate simulated thicknesses of the user interface material during the animated transition), where the movement of the gradient between the two tints have different positions for a respective intermediate tint value during the animated transition. Additional details related to the transformation of the user interface object into a different user interface object are provided with respect to FIGS. 5R-5V and method 10000 and accompanying descriptions.

In some embodiments, displaying the first user interface object includes displaying a user interface material of the first user interface object with an appearance that is based on a first adjustment (e.g., luminance clamping, application of one or more color matrices) to a current background appearance of the portion of the background that has the first spatial arrangement relative to the first user interface object (e.g., the user interface material has an appearance based on its underlying content and content that is nearby within a refraction-threshold-distance from the outline of the first user interface object on the background). In some embodiments, the first adjustment includes constraining respective values for a first visual property (e.g., luminance, brightness, gray value, and/or other display properties) in the portion of the background that has the first spatial arrangement relative to the first user interface object, within a respective range of values for the first visual property (e.g., the luminance values of pixels that exceed a first threshold luminance are reduced by different amounts to respective luminance values below the first threshold luminance; and luminance values of pixels that are below a second threshold luminance is increased by different amounts to respective luminance values above the second threshold luminance). In some embodiments, the first visual property is luminance of the pixels, and the first range of values is a range between a first threshold luminance (e.g., an upper bound for the adjusted luminance values) and a second threshold luminance value (e.g., a lower bound for the adjusted luminance values). In some embodiments, different luminance values are adjusted by different amounts to their respective adjusted values within the first range of values, without changing relative magnitudes of the luminance values. In some embodiments, higher luminance values are adjusted by smaller amounts than lower luminance values, to bias the adjusted background content appearance toward the higher luminance values after the adjustment. In some embodiments, the respective range of values for the first visual property changes in accordance with the current background appearance (e.g., an average luminance value as compared to one or more threshold luminance values) of the portion of the background that has the first spatial arrangement relative to the first user interface object. More details are described with respect to method 19000. As illustrated in and described with respect to FIGS. 6A-6B2, in some embodiments, the appearance of the user interface material of the user interface object 6004 is adjusted by one or more color matrices 6003E, where the one or more color matrices 6003E have parameters that shift the luminance values of the pixel values of the input layer (e.g., the simulated refraction layer 6003C and/or the blur layer 6003B), toward a darker appearance or a light appearance, depending on the characteristic luminance of the underlying content 6003A (and/or the blur layer 6003B), where the one or more color matrices 6003E have parameters that adjust the cutoff or clamping thresholds for the luminance values of the pixel values of the input layer, and/or where the one or more matrices 6003E have parameters that change the mapping relationships between the luminance of the pixel values of the input layer and the luminance of the pixel value of the user interface material.

In some embodiments, constraining the respective values for the first visual property in the portion of the background that has the first spatial arrangement relative to the first user interface object, within the respective range of values for the first visual property includes, in accordance with a determination that a first subset of the portion of the background that has the first spatial arrangement relative to the first user interface object has respective first values above an upper threshold value for the first range of values, reducing the respective first values to respective adjusted first values below the upper threshold value (e.g., using a first color matrix to push high luminance values that are above the upper clamping value toward corresponding lighter colors within the first luminance range). In some embodiments, constraining the respective values for the first visual property in the portion of the background that has the first spatial arrangement relative to the first user interface object, within the respective range of values for the first visual property includes, in accordance with a determination that a second subset of the portion of the background that has the first spatial arrangement relative to the first user interface object has respective second values below a lower threshold value for the first range of values, increasing the respective second values to respective adjusted second values above the lower threshold value (e.g., using a second color matrix to push low luminance values that are below the lower clamping value toward corresponding darker colors within the first luminance range, where these “darker” colors are lighter than the luminance values below the lower clamping value, but are still darker than the “lighter” colors in the first luminance range). As illustrated in and described with respect to FIGS. 6A-6B2, in some embodiments, the appearance of the user interface material of the user interface object 6004 is adjusted by one or more color matrices 6003E, where the one or more color matrices 6003E have parameters that shift the luminance values of the pixel values of the input layer (e.g., the simulated refraction layer 6003C and/or the blur layer 6003B), toward a darker appearance or a light appearance, depending on the characteristic luminance of the underlying content 6003A (and/or the blur layer 6003B), where the one or more color matrices 6003E have parameters that adjust the cutoff or clamping thresholds for the luminance values of the pixel values of the input layer, and/or where the one or more matrices 6003E have parameters that change the mapping relationships between the luminance of the pixel values of the input layer and the luminance of the pixel value of the user interface material. In some embodiments, for high luminosity portions of the underlying content, the luminance of the user interface material is shift toward lighter colors (e.g., pushing the white boundary of the luminance range lower toward lighter colors and/or pushing the black boundary of the luminance range higher toward lighter colors); and/or for low luminosity portions of the underlying content, the luminance of the user interface material is shift toward darker colors (e.g., pushing the black boundary of the luminance range higher toward lighter colors and/or pushing the white boundary of the luminance range lower toward darker colors).

In some embodiments, displaying the first user interface object includes displaying an edge effect along an outline of the first user interface object against the background (e.g., to set off the first user interface object against the background). In some embodiments, the edge effect displayed along a first portion of the outline has a first set of values for a first visual property (e.g., based on an inversion of the values of the first visual property of the portion of the background near the first portion of the outline, to create visual contrast against the portion of the background). In some embodiments, the edge effect displayed along a second portion of the outline has a second set of values for the first visual property (e.g., based on an inversion of the values of the first visual property of the portion of the background near the second portion of the outline, to create visual contrast against the portion of the background). In some embodiments, the first set of values for the first visual property is selected to create visual contrast (e.g., with inversion of colors and/or luminance values) to a portion of the background within a threshold distance of the first portion of the outline (e.g., creasing a lighter edge for the portion of the first user interface material that overlays darker content). In some embodiments, the second set of values for the first visual property is selected to create visual contrast (e.g., with inversion of colors and/or luminance values) relative to a portion of the background within the threshold distance of the second portion of the outline (e.g., creasing a darker edge for the portion of the first user interface material that overlays lighter content). For example, in some embodiments, the first user interface object has an edge effect that is lighter on darker colors and darker on lighter colors, to set off the outline of the first user interface object against the background. In some embodiments, the values of the first visual property are clamped to avoid extreme light and dark values, despite of existence of extreme light and/or extreme dark background colors. In some embodiments, the clamping of the extreme values is artificially set and is not dependent on the actual luminance values of the background content. As illustrated in and described with respect to FIGS. 6A-6B3, in some embodiments, the outline of the user interface object 6004 against the underlying content 6003A is defined by applying an edge effect to a thin region along the outline of the user interface object 6004, where the edge effect is based on an edge color matrix 6003H that modifies the pixel values of the pixels within a thin region along the outline of the user interface object 6004. In some embodiments, the edge color matrix 6003H invert the pixel values of the pixels in the thin region along the outline of the user interface object to create visual contrast between the outline of the user interface object and the underlying content (e.g., optionally including the portions overlaid by simulated shadow 6003D). In some embodiments, the edge color matrix is not used to modify the appearance of the outline of the user interface object 6004 against the underlying content 6003A.

In some embodiments, displaying the first user interface object includes displaying one or more simulated specular highlights along the outline of the first user interface object, wherein the simulated specular highlights have one or more visual properties (e.g., color, intensity, and/or luminance) and/or one or more spatial properties (e.g., position, shape, size, length, and/or other spatial properties) that are based on a simulated light in an environment of the computer system. In some embodiments, the simulated light intensity and direction are based on sensor data, such as ambient light sensor, motion sensor, and/or other sensors. In some embodiments, the simulated light intensity and direction are based on a time of day. In some embodiments, the simulated light intensity and direction are based on a simulated light source that is not based on a physical light source. In some embodiments, the one or more simulated specular highlights change visual properties and/or spatial properties based on changes in the simulated light in the environment of the computer system (e.g., due to change in ambient lighting, and/or movement of the computer system in the physical environment). As illustrated in and described with respect to FIGS. 6A-6B4, in some embodiments, the user interface object 6004 is displayed with one or more specular highlights that optionally change visual appearance and/or spatial locations based on changes in the ambient light in the environment and/or changes in the virtual light in the underlying content. In some embodiments, the specular highlights are generated in the specular highlights layer 6003K and overlaid on the underlying layers (e.g., the tint layer 6003G, the lens layer 6003J, and/or a composite of all or a subset of the underlying layers including layers 6003A-6003J).

In some embodiments, the first user interface object includes internal content within a boundary of the first user interface object (e.g., internal content, such as text, labels, glyphs, and/or graphics, that indicates an identity or function of the first user interface object). In some embodiments, the first user interface object is displayed with an appearance that simulates refraction of the internal content in a first manner and that simulates refraction of the background (e.g., the portion of the background that underlies the first user interface object and that is within the refraction-threshold distance from the boundary of the first user interface object) in a second manner different from the first manner. For example, in some embodiments, the simulated refraction of the background is based on blurring the background content and distorting the background content based on changing simulated thickness of the first user interface material near the edge of the first user interface object; and the simulated refraction of the internal content includes a lensing effect that creates distortion and separation of colors based on changing radius of curvature along the outline of the first user interface object. As illustrated in FIGS. 6A-6B3, in some embodiments, the user interface object 6004 includes internal content 6030 and 6030′ (in the internal content layer 6003I) within the outline of the user interface object, and the appearance of the user interface object 6004 simulates refraction of the internal content 6003I, via the lensing layer 6003J. In some embodiments, the lensing layer 6003J includes spatial distortion and/or color separation of the pixel values in an input layer (e.g., the internal content layer 6003I or a blurred version thereof) to the lensing layer. The lensing layer 6003J modifies the pixel values of the internal content in the internal content layer 6003I in a manner that is different from and/or independently from the manner that the simulated refraction layer 6003C modifies the pixel values of the underlying content 6003A (and/or the blur layer 6003B). Additional details regarding the lensing effect and the treatment of internal content in the first user interface material are provided with respect to FIGS. 6AO-6AO and method 18000 and accompanying descriptions.

In some embodiments, displaying the first user interface objects includes displaying the first user interface object with a respective object appearance that is based on a first set of visual effects applied to a background appearance of the background. In some embodiments, the first set of visual effects (e.g., blur, simulated refraction of external content, simulated sheen, simulated edge effect, luminance clamping, simulated color bleed, and/or other visual effects based on external content) is applied with a first set of parameters that is selected based on a first set of values for a set of spatial properties of the first user interface object (e.g., first position, first shape, first size, first radii of curvatures, first simulate thickness, and/or other first values for one or more spatial properties). In some embodiments, the respective object appearance is further based on a second set of visual effects applied to the internal content of the first user interface object (e.g., lensing effect, simulated chromatic aberration, simulated color bleed, and/or other visual effects based on internal content), where the second set of visual effects is applied with a second set of parameters that is selected based on the first set of values for the set of spatial properties of the first user interface object (e.g., first position, first shape, first size, first radii of curvatures, first simulate thickness, and/or other first values for one or more spatial properties). In some embodiments, when the values of the set of spatial properties change (e.g., automatically and/or in response to user inputs), the first and/or second sets of visual effects are updated using the updated values for the set of spatial properties, and change the object appearance of the first user interface object accordingly. As described with respect to FIGS. 6A-6B4, in some embodiments, the appearance of the user interface object 6004 is generated based on a plurality of visual effects that are implemented in a plurality of processes represented by visual effect layers 6003B-6003H and 6003J-6003K, where the parameters (e.g., blur radius, opacity, dimming, translucency, injection of white or black, shifting in luminance range, clamping values of luminance range, tint color, saturation of color, scaling, boost or reduction of value, and/or other change in effective parameters and/or parameter values) used in these visual effect layers are adjustable to achieve different goals, such as simulating a change in the spatial characteristics of the user interface material, including a change in the curvature and/or simulated thickness of the user interface material, and/or a change in a spatial relationship between the outline of the user interface material and the underlying content.

In some embodiments, displaying the first user interface objects includes displaying the first user interface object with a respective object appearance that is based on one or more visual effects applied to a background appearance of the background (and/or a content appearance of internal content of the first user interface object). In some embodiments, displaying the first user interface object with a respective object appearance that is based on one or more visual effects applied to a background appearance of the background (and/or a content appearance of internal content of the first user interface object) includes, in accordance with a determination that the first user interface object has a third set of values for a set of spatial properties (e.g., first position, first shape, first size, first radii of curvatures, first simulate thickness, and/or other first values for one or more spatial properties), applying the one or more visual effects (e.g., blur, simulated refraction of external content, simulated sheen, simulated edge effect, luminance clamping, simulated color bleed, and/or other visual effects based on external content) with a first set of values for one or more parameters of the one or more visual effects (e.g., blur radius, color matrix, spatial range, rate of change, and/or other parameters). In some embodiments, displaying the first user interface object with a respective object appearance that is based on one or more visual effects applied to a background appearance of the background (and/or a content appearance of internal content of the first user interface object) includes, in accordance with a determination that the first user interface object has a fourth set of values, different from the third set of values, for the set of spatial properties (e.g., second position, second shape, second size, second radii of curvatures, second simulate thickness, and/or other second values for one or more spatial properties), applying the one or more visual effects (e.g., blur, simulated refraction of external content, simulated sheen, simulated edge effect, luminance clamping, simulated color bleed, and/or other visual effects based on external content) with a second set of values for the one or more parameters of the one or more of visual effects (e.g., blur radius, color matrix, spatial range, rate of change, and/or other parameters), different from the first set of values for the one or more parameters of the one or more visual effects. In some embodiments, when the values of the set of spatial properties change (e.g., automatically and/or in response to user inputs), the one or more visual effects are updated using the different sets of parameters, and change the object appearance of the first user interface object accordingly. As described with respect to FIGS. 6A-6B4, in some embodiments, the appearance of the user interface object 6004 is generated based on a plurality of visual effects that are implemented in a plurality of processes represented by visual effect layers 6003B-6003H and 6003J-6003K, where the values of one or more parameters (e.g., blur radius, opacity, dimming, translucency, injection of white or black, shifting in luminance range, clamping values of luminance range, tint color, saturation of color, scaling, boost or reduction of value, and/or other change in effective parameters and/or parameter values) used in these visual effect layers are adjustable to achieve different goals, such as simulating a change in the spatial characteristics of the user interface material, including a change in the curvature and/or simulated thickness of the user interface material, and/or a change in a spatial relationship between the outline of the user interface material and the underlying content.

In some embodiments, displaying the first user interface objects includes displaying the first user interface object with a respective object appearance that is based on a plurality of visual effects applied to a background appearance of the background (and/or a content appearance of internal content of the first user interface object). In some embodiments, displaying the first user interface object with a respective object appearance that is based on a plurality of visual effects applied to a background appearance of the background (and/or a content appearance of internal content of the first user interface object) includes, in accordance with a determination that the first user interface object is of a first object type (e.g., a first object type from the respective object types corresponding to icons, platters, selection objects, slider controls, toggle controls, buttons, tool bars, and/or other object types), applying the plurality of visual effects (e.g., blur, simulated refraction of external content, simulated sheen, simulated edge effect, luminance clamping, simulated color bleed, and/or other visual effects based on external content) with a third set of values for one or more parameters of the plurality of visual effects (e.g., blur radius, color matrix, spatial range, rate of change, and/or other parameters). In some embodiments, displaying the first user interface object with a respective object appearance that is based on a plurality of visual effects applied to a background appearance of the background (and/or a content appearance of internal content of the first user interface object) includes, in accordance with a determination that the first user interface object is of a second object type different from the first object type (e.g., a second object type from the respective object types corresponding to icons, platters, selection objects, slider controls, toggle controls, buttons, tool bars, and/or other object types), applying the plurality of visual effects (e.g., blur, simulated refraction of external content, simulated sheen, simulated edge effect, luminance clamping, simulated color bleed, and/or other visual effects based on external content) with a fourth set of values for the one or more parameters of the plurality of visual effects (e.g., blur radius, color matrix, spatial range, rate of change, and/or other parameters), different from the third set of values for the one or more parameters of the plurality of visual effects. Additional details related to the types of user interface objects and the different sets of parameter values for various parameters of the visual effects, that correspond to the different types of user interface objects are provided in Tables 1 and 2 and corresponding descriptions, in accordance with various embodiments. For example, as described with reference to FIG. 5Y1, platter 816a is a small size platter where parameters for simulating the reactivity of platter 816a are adjusted differently from how the parameters for simulating the reactivity of platter 816c as a large size platter are adjusted. As described with respect to FIGS. 6A-6B4, in some embodiments, the appearance of the user interface object 6004 is generated based on a plurality of visual effects that are implemented in a plurality of processes represented by visual effect layers 6003B-6003H and 6003J-6003K, where the parameters and/or the values of the parameters (e.g., blur radius, opacity, dimming, translucency, injection of white or black, shifting in luminance range, clamping values of luminance range, tint color, saturation of color, scaling, boost or reduction of value, and/or other change in effective parameters and/or parameter values) used in these visual effect layers are adjustable to achieve different goals, such as differentiating different types of objects. In some embodiments, different types of objects are represented by different variants of the user interface material that have different baseline visual properties such as different baseline opacity, different baseline clarity, different simulated thicknesses, different curvatures, different simulated surface textures, and/or different material colors, that are reflected based on the parameters used in generating the simulated refraction, simulated shadow, simulated sheen, simulated color bleed, simulated tint, simulated color aberration, simulated light transmission, and/or other aspects of the appearance of the user interface material.

In some embodiments, displaying the first user interface objects includes displaying the first user interface object with a respective object appearance that is based on a plurality of visual effects applied to a background appearance of the background, including: in accordance with a determination that the first user interface object is in a selected state (e.g., as a result of a user input directed to the first user interface object and/or while the user input remains directed to the first user interface object), applying the plurality of visual effects (e.g., blur, simulated refraction of external content, simulated sheen, simulated edge effect, luminance clamping, simulated color bleed, and/or other visual effects based on external content) with a fifth set of values for one or more parameters of the plurality of visual effects (e.g., blur radius, color matrix, spatial range, rate of change, and/or other parameters); and in accordance with a determination that the first user interface object is not in the selected state (e.g., as a result of another user input directed to another object different from the first user interface object and/or after the user input is terminated or no longer directed to the first user interface object), applying the plurality of visual effects (e.g., blur, simulated refraction of external content, simulated sheen, simulated edge effect, luminance clamping, simulated color bleed, and/or other visual effects based on external content) with a sixth set of values for the one or more parameters of the plurality of visual effects (e.g., blur radius, color matrix, spatial range, rate of change, and/or other parameters), different from the fifth set of values for the one or more parameters of the plurality of visual effects. As described with respect to FIGS. 6A-6B4, in some embodiments, the appearance of the user interface object 6004 is generated based on a plurality of visual effects that are implemented in a plurality of processes represented by visual effect layers 6003B-6003H and 6003J-6003K, where the parameters and/or the values of the parameters (e.g., blur radius, opacity, dimming, translucency, injection of white or black, shifting in luminance range, clamping values of luminance range, tint color, saturation of color, scaling, boost or reduction of value, and/or other change in effective parameters and/or parameter values) used in these visual effect layers are adjustable to achieve different goals, such as differentiating different types of objects. In some embodiments, object with a selected state and an unselected state, with input focus and without input focus, and/or subject to an ongoing input and not subject to an ongoing input, are represented by different variants of the user interface material that have different baseline visual properties such as different baseline opacity, different baseline clarity, different simulated thicknesses, different curvatures, different simulated surface textures, and/or different material colors, that are reflected based on the parameters used in generating the simulated refraction, simulated shadow, simulated sheen, simulated color bleed, simulated tint, simulated color aberration, simulated light transmission, and/or other aspects of the appearance of the user interface material. For example, as described with reference to Table 1 and FIGS. 5I1-5I4, in some embodiments, an opacity of a user interface element 5002 is updated while the user interface element 5002 is currently selected to indicate the selection state of the user interface element 5002.

In some embodiments, applying the plurality of visual effects with the fifth set of values for one or more parameters of the plurality of visual effects corresponds to using a first set of one or more rules to generate the appearance of the first user interface object; applying the plurality of visual effects with the sixth set of values for one or more parameters of the plurality of visual effects corresponds to using a second set of one or more rules (such as a vibrant color matrix filter that applies a color dodge and/or a saturation boost), different from the first set of one or more rules, to generate the appearance of the first user interface object; and the second set of one or more rules produces an increased visual prominence of the first user interface object, as compared to the first set of one or more rules (e.g., the selected state of the first user interface object, optionally caused by an ongoing selection input, has a greater visual prominence, as compared to the first user interface object in the unselected state, optionally caused by termination and/or removal of the selection input from the first user interface object). In some embodiments, the reduced visual prominence corresponds to a reduction in simulated material thickness, reduced intensity of simulated refraction, simulated reflection, simulated sheen, simulated translucency, simulate opacity, color saturation, simulated emissivity, and/or other visual effects. In some embodiments, applying the second set of one or more rules pushes some portion of the first user interface material from being in an SDR range of brightness (when displayed using the first set of one or more rules) to being in an HDR range of brightness (when displayed using the second set of one or more rules), optionally without pushing other portions of the user interface material to be in the HDR range of brightness (e.g., pushing one or more portions that were not in the HDR range of brightness into the HDR range of brightness), where the portions of the first user interface material that are pushed in the HDR range of brightness are determined based on the underlying content that the first user interface material is displayed over. For example, as described with reference to FIGS. 6A-6B13, Tables 3A-3F, and method 19000.

It should be understood that the particular order in which the operations in FIGS. 14A-14B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 13000, 15000, 16000, 17000, 18000, 19000, and/or 20000) are also applicable in an analogous manner to method 14000 described above with respect to FIGS. 14A-14B. For example, the buttons, user interfaces, controls, visual deemphasis, virtual effects, an/or animations described above with reference to method 14000 optionally have one or more of the characteristics of the buttons, user interfaces, controls, visual deemphasis, virtual effects, an/or animations described herein with reference to other methods described herein (e.g., methods 7000, 8000, 9000, 10000, 11000, 12000, 13000, 15000, 16000, 17000, 18000, 19000, and/or 20000). For brevity, these details are not repeated here.

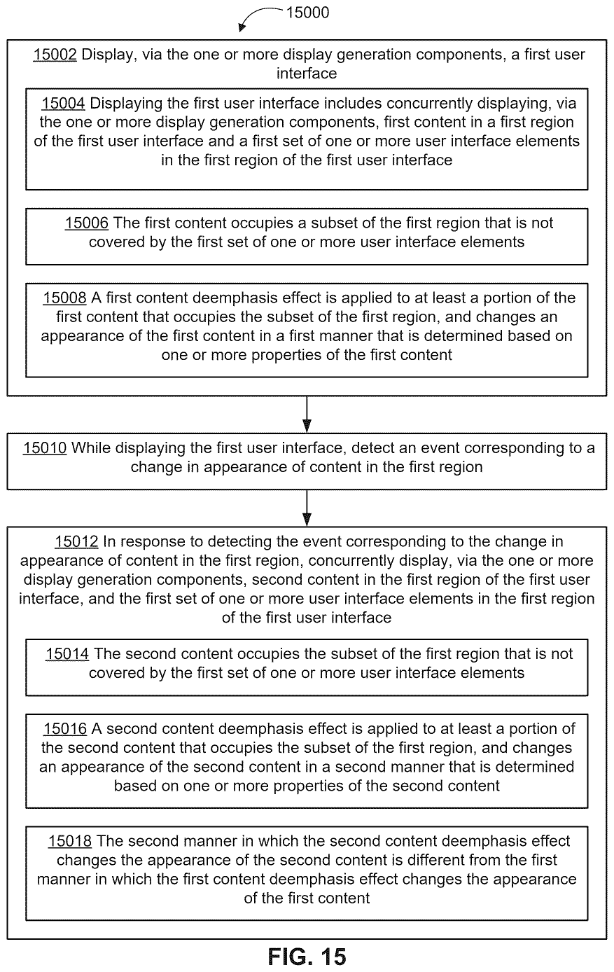

FIG. 15 is a flow diagram illustrating a method 15000 of applying various levels of deemphasis to user interface objects while changing underlying content in accordance with some embodiments. In some embodiments, the method 15000 is performed at a computer system (e.g., portable multifunction device 100, device 300 in FIGS. 1A-6AP) that is in communication with one or more input devices (e.g., touch-sensitive surfaces, optical sensors, motion sensors, proximity sensors, gyros, accelerometers, ambient light sensors, joysticks, buttons, keyboards, handheld controllers, pointer devices, and/or other types of input devices) and one or more display generation components (e.g., touch-screen displays, standalone displays, LED displays, LCD displays, head-mounted displays, heads-up displays, foldable displays, flexible displays, and/or other types of display generation components that provides one or more display areas in which content, user interfaces, and/or controls can be made visible to a user). Some operations in method 15000 are, optionally, combined and/or the order of some operations is, optionally, changed.

Automatically applying a visual deemphasis effect to underlying content that is positioned within a region of the user interface, while maintaining display of one or more user interface elements within the region even as the underlying content is updated, provides improved visual feedback to the user by informing the user about a change in state of the computer system, including feedback that the underlying content is updated, while improving the legibility and visibility of the user interface elements that are displayed within the region. Applying the visual deemphasis effect to underlying content below headers and/or text within the region and displaying user interface elements within the region with simulated optical properties improves the legibility of content (e.g., headers, text and/or the user interface elements), which enables a user to use a device for shorter periods of time, which saves energy and improves battery life. Using user interface materials with simulated optical properties for user interface elements enables the user interface elements to be more transparent, and an increased transparency of user interface elements enables a user to use a device for shorter periods of time, which saves energy and improves battery life. Providing an appearance of user interface elements (e.g., changing material appearance based on underlying content) when one or more criteria are met reduces the number of inputs (e.g., navigating through settings user interfaces and menus to set the values for parameters to adjust the appearance of user interface elements) that would otherwise be required to generate a similar effect, which saves energy and improves battery life.

The computer system displays (15002), via the one or more display generation components, a first user interface (e.g., a system user interface, such as a home screen user interface, a notification history user interface, a widget user interface, a wake screen user interface, a lock screen user interface, a standby user interface, a coversheet user interface, and/or a user interface corresponding to an idle state, a sleep state, and/or a power saving state of the computer system; and/or an application user interface corresponding to an application), wherein displaying the first user interface includes (15004) concurrently displaying, via the one or more display generation components: first content in a first region of the first user interface (e.g., the first region is the “magic pocket” region in which the visual effect described herein is applied) (e.g., a header portion of the user interface described with reference to FIGS. 6D-6H); and a first set of one or more user interface elements (e.g., including one or more user interface elements that, optionally, include a user interface material that has simulated optical properties as described herein) in the first region of the first user interface, In some embodiments, the first region of the first user interface includes a top portion, a bottom portion, a left edge portion, a right edge portion, and/or another portion of a displayed portion of the first user interface that has a specified spatial location and/or a specified size relative to the first user interface, relative to a display area provided via the one or more display generation components, and/or relative to the window corresponding to the first user interface. In some embodiments, the first region of the first user interface includes first content in a first layer, and a first set of one or more user interface elements in a second layer different from the first layer (e.g., the second layer is between the viewpoint of a user and the first layer, and/or the first layer underlies the second layer), where at least some portion of the first content is not covered by (e.g., outside of the boundaries of) the first set of one or more user interface elements, in the first region of the first user interface. For example, as described with reference to FIG. 6D, control 6200 and control 6204 are displayed in a header portion of the user interface.

The first content occupies (15006) a subset of the first region that is not covered by the first set of one or more user interface elements; and In some embodiments, the subset of the first region that is not covered by the first set of one or more user interface elements includes at least part of the respective gap(s) between one or more adjacent pairs of user interface elements from the first set of one or more user interface elements, and/or the unoccupied area(s) above, below, to the left, and/or to the right of the first set of one or more user interface elements. In some embodiments, the first content is part of the first user interface that can be scrolled relative to the first set of one or more user interface elements and/or relative to the first region of the first user interface. In some embodiments, the first content includes a part of the first user interface that can be scrolled, moved, resized, and/or otherwise changed, relative to the first set of one or more user interface elements and/or relative to the first region of the first user interface.

A first content deemphasis effect is applied (15008) to at least a portion of the first content that occupies the subset of the first region (e.g., the first content deemphasis effect is applied to at least a portion of content that occupies at least a portion of the first region and that is not covered by the first set of one or more user interface elements), and changes an appearance of the first content (e.g., blurring, refracting, dimming, distorting, and/or otherwise reducing the saliency and clarity of the first content) in a first manner that is determined based on one or more properties of the first content (e.g., the one or more properties of the first content include color, complexity, difference in appearance between foreground and background elements in the first region, and/or speed of movement of the first content). In some embodiments, the first content deemphasis effect has a first set of one or more values for one or more parameters that determine how (e.g., by which varying which visual properties, and/or by how much variations for respective visual properties) the first content deemphasis effect deemphasizes the first content in the subset of the first region, the first set of one or more values being selected based on one or more properties of the first content that occupies the subset of the first region. In some embodiments, the first content deemphasis effect is not applied to at least a portion of the first user interface that is outside of the first region of first user interface, and that portion of the first user interface is displayed with its original unmodified appearance. In some embodiments, portions of the first content that directly underly and/or are within a refraction-threshold distance from a boundary of a respective user interface element in the first region is used to generate the appearance of the respective user interface element in the manners described in other parts of this disclosure. For example, as described with reference to FIGS. 6F1-6F3, underlying content is visually obscured by the blur regions 6210a-6210c as the underlying content travels within the header portion of the user interface.

While displaying the first user interface, the computer system detects (15010) an event corresponding to a change in appearance of content in the first region (e.g., due to content automatically changing such as a playing video or animation, due to content shifting such as automatic scrolling or scrolling in response to detected user input, and/or due to content resizing such as automatic resizing or resizing in response to detected user input).

In response to detecting the event corresponding to the change in appearance of content in the first region, the computer system concurrently displays (15012), via the one or more display generation components: second content in the first region of the first user interface (e.g., the second content includes content that is located in the “magic pocket region” and that is not overlaid by the first set of one or more user interface elements), and the first set of one or more user interface elements in the first region of the first user interface, In some embodiments, after the detection of the event, the first region of the first user interface includes the second content in the first layer, and the first set of one or more user interface elements in the second layer different from the first layer, where at least some portion of the second content is not covered by (e.g., outside of the boundaries of) the first set of one or more user interface elements, in the first region of the first user interface.

The second content (e.g., content 6208, FIG. 6F1) occupies (15014) the subset of the first region that is not covered by the first set of one or more user interface elements. In some embodiments, the second content is part of the first user interface that has been scrolled into the first region of the first user interface, relative to the first set of one or more user interface elements and/or relative to the first region of the first user interface. In some embodiments, the second content includes a part of the first user interface that is displayed in the first portion of the first user interface, as a result of the first content being scrolled, moved, resized, and/or otherwise changed, relative to the first set of one or more user interface elements and/or relative to the first region of the first user interface. In some embodiments, the first content and the second content represent different sets of content that occupy the same subset of the first region of the first user interface at different times, e.g., before and after the occurrence of the event corresponding to the change in appearance of content in the first region.

A second content deemphasis effect is applied (15016) to at least a portion of the second content that occupies the subset of the first region (e.g., the second content deemphasis effect is applied to at least a portion of content that occupies at least a portion of the first region and that is not covered by the first set of one or more user interface elements), and changes an appearance of the second content (e.g., blurring, refracting, dimming, distorting, and/or otherwise reducing the saliency and clarity of the second content) in a second manner that is determined based on one or more properties of the second content (e.g., the one or more properties of the second content include color, complexity, difference in appearance between foreground and background elements, and/or speed of movement of the second content). In some embodiments, the second content deemphasis effect has a second set of one or more values for the one or more parameters that determine how (e.g., a manner by which and/or a degree to which) the second content deemphasis effect deemphasizes the second content in the subset of the first region, the second set of one or more values being selected based on one or more properties of the second content that occupies the subset of the first region. In some embodiments, the second content deemphasis effect is not applied to at least a portion of the first user interface that is outside of the first region of first user interface, and that portion of the first user interface is displayed with its original unmodified appearance. In some embodiments, portions of the second content that directly underly and/or are within a refraction-threshold distance from a boundary of a respective user interface element in the first region is used to generate the appearance of the respective user interface element in the manners described in other parts of this disclosure.

The second manner in which the second content deemphasis effect changes the appearance of the second content is (15018) different (e.g., in size, shape, degree of deemphasis, blur radius, opacity, degree of fading of content, and/or degree of dimming of content) from the first manner in which the first content deemphasis effect changes the appearance of the first content. For example, a portion of the content 6208 is visually deemphasized by the blur effect 6210 is while another portion of the content 6208 (e.g., that is not affected by the blur effect 6210) is visually deemphasized by the gradient of visual deemphasis applied to the header portion overall (e.g., as illustrated in FIG. 6H). In some embodiments, the second set of one or more values for the one or more parameters is different from the first set of one or more values for the one or more parameters. For example, in some embodiments, in the same subset of the first region (e.g., a gap between a first user interface element and a second user interface element from the first set of one or more user interface elements, a region to the left of the first set of one or more user interface elements, and/or another sub-region of the first region that is occupied by content but not occupied by the first set of one or more user interface elements), different types and/or amounts of deemphasizing effects are applied to the content outside the area occupied by the first set of one or more user interface elements, as the content outside the area occupied by the first set of one or more user interface elements change appearance due to movement, scrolling, resizing, animation, media playback, and/or other automatic and/or input-triggered content changing mechanisms of the first user interface.

In some embodiments, applying the first deemphasis effect to at least the portion of the first content that occupies the subset of the first region includes: in accordance with a determination that a rate of change in appearance of the first content (e.g., the rate of change in appearance within the first region) is a first rate of change in appearance, applying the first content deemphasis effect with a first set of deemphasis parameters (e.g., a first set of values for blur radii, darkening, dimming, and/or other deemphasis parameters that corresponds to a first degree of deemphasis); and in accordance with a determination that a rate of change in appearance of the second content is a second rate of change in appearance, different from the first rate of change in appearance, applying the second content deemphasis effect with a second set of deemphasis parameters (e.g., a second set of values for blur radii, darkening, dimming, and/or other deemphasis parameters that corresponds to a second degree of deemphasis different from the first degree of deemphasis), different from the first set of deemphasis parameters. In some embodiments, a rate of change in appearance of respective content is a measure of how quickly and/or how much the appearance of the respective content changes in a unit of time, absent a respective content deemphasis effect. In some embodiments, the rate of change in appearance of respective content is determined based on the number of pixels that change at a given moment in time in the respective content within the first region that is not covered by the one or more user interface elements, absent a respective content deemphasis effect. In some embodiments, the rate of change in appearance of respective content is determined based on how quickly a portion of the respective content (e.g., a pixel, a character, an element of the text or image in the respective content) moves in a respective direction (e.g., in the user interface, on the display, and/or within the first region when scrolling and/or animating the respective content). For example, as described with reference to FIG. 6G, a blur level (e.g., or level of other distortion) applied to an underlying object is based on an amount of change to the underlying object.

In some embodiments, the first rate of change in appearance of the first content includes a scroll speed of the first content (e.g., the first content is moved in a scroll direction relative to the first set of one or more user interface elements in the first region with a scroll speed). Similarly, in some embodiments, the second rate of change in appearance of the second content includes a scroll speed of the second content (e.g., the second content is moved in a scroll direction relative to the one or more user interface elements in the first region with a scroll speed). In some embodiments, the second rate of change in appearance includes changes in appearance caused by factors other than a scroll speed of the second content (e.g., optionally, the second content is not scrolled relative to the first region, but changes due to animation, resizing, and/or other causes). For example, as described with reference to FIGS. 6F1-6F3, a blur level is adjusted based on a scrolling speed of the user input 6206′, user input 6206′″, and/or user input 6206″.

In some embodiments, while displaying respective content in the first region, the computer system detects a change in a rate of change in appearance (e.g., first rate of change in appearance, second rate of change in appearance, and/or another rate of change in appearance) of the respective content (e.g., the first content, the second content, and/or other content in the first region that is not covered by the one or more user interface elements in the first region); and in response to detecting the rate of change in appearance of the respective content: in accordance with a determination that the rate of change in appearance of the respective content has increased from a respective rate of change in appearance (e.g., the first rate of change in appearance, the second rate of change in appearance, and/or another rate of change in appearance for content in the first region that is not covered by the one or more user interface elements) to a first increased rate of change in appearance, the computer system reduces an intensity of a respective content deemphasis effect that is applied to at least a portion of the respective content that occupies the subset of the first region (e.g., by changing a respective set of deemphasis parameters in a first way); and in accordance with a determination that the rate of change in appearance of the respective content has decreased from the respective rate of change in appearance (e.g., the first rate of change in appearance, the second rate of change in appearance, and/or another rate of change in appearance for content in the first region that is not covered by the one or more user interface elements) to a first decreased rate of change in appearance, the computer system increases the intensity of the respective content deemphasis effect that is applied to at least a portion of the respective content that occupies the subset of the first region (e.g., by changing the respective set of deemphasis parameters in a second way different from the first way). For example, in some embodiments, the computer system reduces the deemphasis effect if content in the first region is changing more quickly and increases the deemphasis effect if content in the first region is changing more slowly. For example, when the content is stationary relative to the first region, the deemphasis effect is applied with a maximum amount of blurring to the content that is in the first region; and when the content starts to move quickly relative to the first region, the deemphasis effect is applied with a small amount of blurring or no blurring to the content that is in and/or scrolling through the first region. In some embodiments, when the content moves quickly through the first region, the user's eyes still may not capture the details of the content even with the reduction of the deemphasis effect, because the natural motion blur response of the user's eyes has increased with the faster movement of the content. For example, as described with reference to FIGS. 6F1-6F3, the level of blur in the header portion is increased for a slower rate of the movement of user input 6206″ and the level of blur in the header portion is decreased for a faster rate of the movement of the user input 6206′″″.

In some embodiments, in response to detecting the event corresponding to the change in appearance of content in the first region, the computer system displays, via the one or more display generation components, intermediate content in the first region, wherein: the intermediate content corresponds to a transition from the first content to the second content in the first region (e.g., a temporal transition, a visual transition, and/or a spatial transition of displayed content that occurs in the first region); the intermediate content occupies the subset of the first region that is not covered by the first set of one or more user interface elements; an intermediate content deemphasis effect is applied to at least a portion of the intermediate content that occupies the subset of the first region; and the intermediate content deemphasis effect changes an appearance of the intermediate content in an intermediate manner that is determined based on the one or more properties of the intermediate content (e.g., has an intermediate intensity that is between a first intensity by which the first content deemphasis effect changes the appearance of the first content and a second intensity by which the second content deemphasis effect changes the appearance of the second content). In some embodiments, the content deemphasis effect increases intensity, or decreases intensity during the transition between first content and the second content, based on the changes in the one or more properties of the intermediate content between the first content and the second content. For example, in some embodiments, as the rate of change in appearance of the content in the first region increases over time, the deemphasis effect is applied with increasing intensity over time; and, as the rate of change in appearance of the content in the first region decreases over time, the deemphasis effect is applied with decreasing intensity over time. In some embodiments, the increase and decrease in the intensity of the deemphasis effect is gradual over time, as the rate of change in appearance of the content changes gradually over time. For example, as described with reference to FIG. 6G, the blur level is gradually changed over time as the amount of change in the underlying object changes over time.

In some embodiments, in response to detecting the event corresponding to the change in appearance of content in the first region, the computer system gradually increases visual prominence (e.g., gradually appearing as a floating header element) of a first user interface object (e.g., text, image, an indicator, a menu item, a control, an icon, a text input field, a data entry, a content item, and/or other types of user interface objects) in the first region of the first user interface, overlaying current underlying content (e.g., first content, second content, other intermediate content between the transition between the first content and the second content) in the first region of the first user interface (e.g., the first user interface object is a floating header that is displayed when content is scrolled into the first region of the first user interface), wherein: the first content deemphasis effect is applied to at least the portion of the first content that occupies the subset of the first region that is not covered by the first set of one or more user interface elements, while the first user interface object was not included in the first region of the first user interface (e.g., the first user interface object has not been displayed in the “magic pocket” or “header portion”); the second content deemphasis effect is applied to at least a portion of the second content that occupies a subset of the first region that is not covered by the first user interface object and that is not covered by the first set of one or more user interface elements (e.g., the first user interface object becomes part of the first set of one or more user interface elements in the “magic pocket” or “header portion”); and gradually increasing the visual prominence of the first user interface object in the first region includes: in accordance with a determination that the event corresponds to a first rate of change in appearance of the current underlying content, increasing the visual prominence of the first user interface object with a first rate of increase in visual prominence (e.g., as reflected in how quickly the first user interface object appears and reaches its highest visibility at its location in the first region); and in accordance with a determination that the event corresponds to a second rate of change in appearance of the current underlying content, different from the first rate of change in appearance of the current underlying content, increasing the visual prominence of the first user interface object with a second rate of increase in visual prominence, different from the first rate of increase in visual prominence (e.g., more quickly than the first rate of increase or more slowly than the first rate of increase). In some embodiments, in response to detecting a second event corresponding to the change in appearance of content in the first region (e.g., scrolling the content in a reverse direction), the computer system gradually decreases visual prominence (e.g., gradually removing the floating header element) of the first user interface object in the first region of the first user interface, gradually decreasing the visual prominence of the first user interface object in the first region includes: in accordance with a determination that the second event corresponds to a third rate of change in appearance of the current underlying content, decreasing the visual prominence of the first user interface object with a first rate of decrease in visual prominence (e.g., as reflected in how quickly the first user interface object disappears from the first region); and in accordance with a determination that the second event corresponds to a fourth rate of change in appearance of the current underlying content, different from the third rate of change in appearance of the current underlying content, decreasing the visual prominence of the first user interface object with a second rate of decrease in visual prominence, different from the first rate of decrease in visual prominence (e.g., more quickly than the first rate of decrease or more slowly than the first rate of decrease). In some embodiments, the first user interface object is a header and/or sub-header for a currently displayed user interface (e.g., a subject heading, title, and/or section header of the currently displayed portion of the content). For example, as described with reference to FIGS. 6D-6E2, the header 6202 is animated as scrolling off the screen while the header 6202′ is animated as sliding into position in the center of the header portion between the control 6200 and control 6204, where the rate of the animated transition for displaying header 6202′ is based at least in part on a scrolling speed that causes change to the underlying content.

In some embodiments, gradually increasing the visual prominence of the first user interface object in the first region includes: in accordance with the determination that the event corresponds to the first rate of change in appearance of the current underlying content, transitioning to a respective point in an animated transition (e.g., completing the animated transition) for displaying the first user interface object in the first region of the first user interface in a first animation duration (e.g., higher rate of change in appearance in the underlying content leads to faster appearance of the first user interface object in the first region); and in accordance with the determination that the event corresponds to the second rate of change in appearance of the current underlying content, transitioning to the respective point in the animated transition (e.g., completing the animated transition) for displaying the first user interface object in the first region of the first user interface in a second animation duration, different from the first animation duration (e.g., lower rate of change in appearance in the underlying content leads to slower appearance of the first user interface object in the first region). For example, in some embodiments, the computer system adjusts animation duration for fading in and/or fading out a header object in the first region based on the rate of change in appearance of the underlying content in the first region (e.g., shorter animation duration for a faster rate of change in appearance, and/or longer animation duration for a slower rate of change in appearance). In some embodiments, the faster rate of change in appearance of the underlying content in the first region corresponds to a faster scrolling speed for the underlying content and/or faster movement speed for the underlying content; and the slower rate of change in appearance of the underlying content in the first region corresponds to a slower scrolling speed for the underlying content and/or slower movement speed for the underlying content. In some embodiments, the animation time for fading out an object in the first region and the animation for fading in the object are different for the same rate of change in appearance of the underlying content. For example, as described with reference to FIGS. 6D-6E2, the header 6202′ is animated as sliding into position in the center of the header portion between the control 6200 and control 6204, where the duration of the animated transition for displaying header 6202′ is based at least in part on a scrolling speed that causes change to the underlying content.

In some embodiments, gradually increasing the visual prominence of the first user interface object in the first region includes: in accordance with the determination the first rate of change in appearance of the current underlying content corresponds to a first movement speed of the current underlying content, moving the first user interface object in the first region of the first user interface by a first amount of translation in the first region (e.g., higher scroll or movement speed of the underlying content leads to smaller amount of translation by the first user interface object in the first region before settling into a steady state position in the first region); and in accordance with the determination the second rate of change in appearance of the current underlying content corresponds to a second movement speed of the current underlying content, different from the first movement speed of the current underlying content, moving the first user interface object in the first region of the first user interface by a second amount of translation in the first region, different from the first amount of translation in the first region (e.g., slower scroll or movement speed of the underlying content leads to greater amount of translation by the first user interface object in the first region before settling into a steady state position in the first region). For example, in some embodiments, the computer system adjusts the amount of movement in a content movement direction needed for fading in and/or fading out an object (e.g., a floating header object) in the first region, based on the rate of change in appearance of the current underlying content in the first region (e.g., shorter movement distance for a faster rate of change in appearance, and/or longer movement distance for a slower rate of change in appearance). In some embodiments, the faster rate of change in appearance of the underlying content in the first region corresponds to a faster scrolling speed for the underlying content and/or faster movement speed for the underlying content; and the slower rate of change in appearance of the underlying content in the first region corresponds to a slower scrolling speed for the underlying content and/or slower movement speed for the underlying content. For example, as described with reference to FIGS. 6D-6E, the header 6202′ is animated as sliding into position in the center of the header portion between the control 6200 and control 6204, where the amount of y-travel of the header 6202′ during the animated transition for displaying header 6202′ is based at least in part on a scrolling speed that causes change to the underlying content.

In some embodiments, detecting the event corresponding to the change in appearance of content in the first region includes detecting movement of content in a first movement direction relative to the first region of the first user interface (e.g., scrolling in a direction toward or away from the first region, zooming in a direction toward or away the first region, shifting in a direction toward or away the first region, and/or other types of movement of content relative to the first region). In some embodiments, in response to detecting the event corresponding to the change in appearance of content in the first region, the computer system moves an edge of the first region (e.g., the “magic pocket” region that applies the content deemphasis effect on underlying content) relative to a first edge (e.g., a top edge, a bottom edge, a left edge, and/or a right edge) of the first user interface in a direction corresponding to the first movement direction (e.g., shifting the “magic pocket” in the first movement direction, as if the boundary of the magic pocket is pushed by or pulled by the movement of the content in the first movement direction, toward or away from the first edge of the first user interface), In some embodiments, the first set of one or more user interface elements and the first user interface object (e.g., if currently displayed) in the first region of the first user interface are also moved with the edge of the first region relative to the first user interface. In some embodiments, moving the edge of the first region relative to the first edge of the first user interface includes: in accordance with a determination that the movement of content in the first movement direction has a first set of one or more values for one or more movement characteristics (e.g., speed, acceleration, and/or distance), moving the edge of the first region by a first amount of movement (e.g., before starting to reverse at least some of the first amount of movement); and in accordance with a determination that the movement of content in the first movement direction has a second set of one or more values, different from the first set of one or more values (e.g., smaller for at least some of the values, and/or greater for at least some of the values), for the one or more movement characteristics (e.g., speed, acceleration, and/or distance), moving the edge of the first region by a second amount of movement (e.g., before reversing at least a portion of the second amount of movement), different from the first amount of movement (e.g., a smaller amount of movement for a smaller value for a movement characteristic, and/or a smaller amount of movement for a greater value for a second movement characteristic). In some embodiments, the movement of the edge of the first region simulates a rubber-banding effect that is displayed when the content has reached an end in the movement direction of the content. In some embodiments, the movement of the edge ceases when a threshold amount of movement away from the first edge of the first user interface has been achieved, and the edge of the first region reverses at least some of the movement to reach a steady state position. For example, as described with reference to FIGS. 6D-6E, the header 6202′ is animated as sliding into position in the center of the header portion between the control 6200 and control 6204, where the amount of bounce of the header 6202′ during the animated transition for displaying header 6202′ is based at least in part on a scrolling speed that causes change to the underlying content.

In some embodiments, displaying the first user interface includes concurrently displaying a first scrollable region and a second scrollable region (e.g., concurrently displayed scrollable content panes that include different types of content of the first user interface). In some embodiments, the first user interface is a user interface of a mail application, and the first scrollable region corresponds to a region displaying a listing of mail boxes, and the second scrollable region corresponds to a region displaying a listing of mail messages for a currently selected mail box. In some embodiments, the first user interface is a user interface of a mail application, and the first scrollable region corresponds to a region displaying a listing of mail messages, and the second scrollable region corresponds to a region displaying a currently selected message from the listing of mail messages. In some embodiments, the first user interface is a user interface of a file management application, and the first scrollable region corresponds to a region displaying a listing of folders, and the second scrollable region corresponds to a region displaying a listing of documents in a currently selected folder from the listing of folders. In some embodiments, the first user interface is a user interface of a media player application, and the first scrollable region corresponds to a region displaying a listing of media folders or playlists, and the second scrollable region corresponds to a region displaying a listing of media items of a selected media folder, or a currently selected media item in a currently selected playlist. In some embodiments, displaying the first scrollable region includes concurrently displaying the first region of the first user interface and the first set of one or more user interface elements in the first region of the first user interface (e.g., with the first content in the first region of the first user interface, with the second content in the first region of the first user interface, or with other content of the first scrollable region in the first region of the first user interface); displaying the second scrollable region includes concurrently displaying: a second region of the first user interface (e.g., a second “magic pocket” into which the second content can be moved and visually deemphasized, and moved out of the visible portion of the first user interface), different from the first region of the first user interface, and a second set of one or more user interface elements in the second region of the first user interface (e.g., the second scrollable region has its own set of one or more user interface elements in its own “magic pocket” region), while the first content occupies the subset of the first region of the first user interface, first adjacent content that is different from the first content occupies a subset of the second region of the first user interface that is not covered by the second set of one or more user interface elements (e.g., the first adjacent content is content that is displayed in the second scrollable region and that is concurrently visible with the first content and independently scrollable from the first content, but may be spaced part from the first content and/or scrollable in an orthogonal direction relative to the first content), and while the first adjacent content occupies the subset of the second region that is not covered by the second set of one more user interface elements, a first concurrent content deemphasis effect is applied to at least a portion of the first adjacent content that occupies the subset of the second region (e.g., the first concurrent content deemphasis effect is applied to at least a portion of content that occupies at least a portion of the second region and that is not covered by the second set of one or more user interface elements), and changes an appearance of the first adjacent content (e.g., blurring, refracting, dimming, distorting, and/or otherwise reducing the saliency and clarity of the first content) in a third manner that is determined based on one or more properties of the first adjacent content. In some embodiments, similar to the first region and how content deemphasis effects can be applied to content that underlies the first region and/or within the first region of the first user interface based on the properties of the first content (e.g., in the various manners as described herein), additional and different content deemphasis effects can be analogously applied to content that underlies the second region and/or within the second region of the first user interface based on the properties of the first adjacent content. In some embodiments, since the pertinent properties of the first content and the first adjacent content that are respectively displayed in the first scrollable region and the second scrollable region can be different and/or changing in different manners due to different causes, sometimes at the same time, different amounts of deemphasis effects are applied to the first region and the second region, independently of each other. For example, in some embodiments, if there are multiple scrolling views in a user interface, each scrollable view has its own “magic pocket” that responds to the scrolling velocity of the underlying scrolling content. In some embodiments, the different scrollable views can have different scrollable directions (e.g., vertical vs. horizontal), and/or have different adjacent edges of the first user interface (e.g., top edge vs. bottom edge, left edge vs. right edge, top edge vs. right edge, and/or other pairs of different edges of the first user interface). For example, as described with reference to FIG. 6D, in some embodiments, two or more header portions are concurrently maintained in a same user interface such that content associated with each respective header portion is independently scrollable.

In some embodiments, the first user interface includes a first scrollable region that is scrollable in a first scroll direction and that is scrollable in a second scroll direction different from (e.g., substantially perpendicular, or opposite) to the first scroll direction (e.g., vertical scrolling and horizontal scrolling in the same scrollable region, upward scrolling vs. downward scrolling, or leftward scrolling vs. rightward scrolling). In some embodiments, the first scrollable region includes a grid of documents or items and/or other types of scrollable content, that span more than a single screen or window width, and span more than a single screen or window height, and are scrollable in both the vertical direction and the horizontal direction of the screen or window containing the scrollable region. In some embodiments, the first scrollable region includes scrollable content that span more than a single screen or window height, and is scrollable upward into a header region that includes the first set of user interface elements, and scrollable downward into a footer region that includes the first additional set of user interface elements. In some embodiments, the first scrollable region concurrently includes the first region of the first user interface, and an additional region (e.g., an additional “magic pocket” into which the first content can be moved and visually deemphasized, and moved out of the visible portion of the first user interface) that is different from the first region; the additional region includes a first additional set of one or more user interface elements in the additional region of the first scrollable region (e.g., the additional “magic pocket” has its own set of user interface elements that are concurrently displayed with the first set of one or more user interface elements); before the first content is displayed in the first region of the first user interface, the first content was displayed as part of scrollable content in the first scrollable region, outside of the first region and the additional region of the first user interface (e.g., optionally, a portion of the scrollable content is in the first region and/or a different portion of the scrollable content is in the additional region, while the first content is located outside of the first region and the additional region); while the first content was displayed outside of the first region and the additional region of the first user interface, detecting a user input that scrolls the scrollable content in the first scrollable region; and in response to detecting the user input that scrolls the scrollable content in the first scrollable region: in accordance with a determination that the scrollable content is scrolled in the first scroll direction and that the first content is scrolled into the first region, the first content deemphasis effect is applied to the first content in the first region based on the one or more properties of the first content; and in accordance with a determination that the scrollable content is scrolled in the second scroll direction and that the first content is scrolled into the additional region, an additional content deemphasis effect is applied to at least a portion of the first content that occupies a subset of the additional region that is not covered by the first additional set of one or more user interface elements (e.g., a content deemphasis effect is applied to at least a portion of the scrollable content that is moved into the additional “magic pocket”), and changes an appearance of the portion of the first content that occupies the subset of the additional region (e.g., blurring, refracting, dimming, distorting, and/or otherwise reducing the saliency and clarity of the first content) in an additional manner that is determined based the one or more properties of the first content. In some embodiments, similar to the first region and how content deemphasis effects can be applied to content that underlies the first region and/or within the first region of the first user interface based on the properties of the first content (e.g., in the various manners as described herein), additional and different content deemphasis effects can be analogously applied to first content that underlies the additional region and/or within the additional region of the first user interface based on the properties of the first content, as the first content is scrolled into the additional region. For example, in some embodiments, separate “magic pockets” can exist for the same scrollable view (e.g., for horizontal and vertical scrolling, for upward and downward scroll, and/or scroll in other pairs of scrolling directions, into different regions with user interface elements), and movement of content in a first direction affects the deemphasis effect in one pocket but not another, while movement of the content in a second direction affects the deemphasis effect in a different pocket. For example, as described with reference to FIGS. 6D-6E2, horizontal scrolling causes the scrolled content to be affected by a different header portion than vertical scrolling.

In some embodiments, applying the first content deemphasis effect to at least the portion of the first content that occupies the subset of the first region includes applying an amount of blur to at least the portion of the first content that occupies the subset of the first region, wherein the amount of blur is based on at least some of the one or more properties of the first content (e.g., increasing the amount of blur, such as increasing blur radius and/or opacity, based on a slower and/or a reduction of the scroll speed of the first content, and decreasing the amount of blur based on a greater and/or an increase in the scroll speed of the first content). Similarly, in some embodiments, applying the second content deemphasis effect to at least a portion of the second content that occupies the subset of the first region includes applying an amount of blur to at least the portion of the second content that occupies the subset of the first region, wherein the amount of blur is based on at least some of the one or more properties of the second content (e.g., increasing the amount of blur, such as increasing blur radius and/or opacity, based on a slower and/or a reduction of the scroll speed of the second content, and decreasing the amount of blur based on a greater and/or an increase in the scroll speed of the second content). For example, as described with reference to FIG. 6D, the visual deemphasis includes applying a blur effect to the underlying content that appears beneath the header portion.

In some embodiments, applying the first content deemphasis effect to at least the portion of the first content that occupies the subset of the first region includes fading out foreground content of the portion of the first content that occupies the subset of the first region relative to a background of the portion of the first content (e.g., transforming the color and/or luminance of the foreground elements to that of the background, to reduce visibility of the foreground elements against the background), wherein the amount of fading is based on at least some of the one or more properties of the first content (e.g., starting and/or completing fade out sooner and/or shortening a fadeout duration, based on a slower and/or a reduction of the scroll speed of the first content, and starting and/or completing fade out later and/or lengthening a fadeout duration, based on a greater and/or an increase in the scroll speed of the first content). Similarly, in some embodiments, applying the second content deemphasis effect to at least a portion of the second content that occupies the subset of the first region includes fading out foreground content of the portion of the second content that occupies the subset of the first region relative to a background of the portion of the second content, wherein the amount of fading is based on one or more properties of the second content. For example, as described with reference to FIG. 6D, the visual deemphasis includes fading the underlying content that appears beneath the header portion.

In some embodiments, applying the first content deemphasis effect to at least the portion of the first content that occupies the subset of the first region includes dimming (e.g., reducing luminance, brightness, color saturation, and/or internal visual contrast of) the portion of the first content that occupies the subset of the first region, wherein the amount of dimming is based on at least some of the one or more properties of the first content (e.g., reducing the luminance, brightness, and/or color saturation by a greater amount for a slower scroll speed and/or a reduction of scroll speed, and/or reducing the luminance and/or color saturation by a smaller amount for a higher scroll speed and/or an increase in scroll speed). Similarly, in some embodiments, applying the second content deemphasis effect to at least a portion of the second content that occupies the subset of the first region includes dimming the portion of the second content that occupies the subset of the first region, wherein the amount of dimming is based on at least some of the one or more properties of the second content. For example, as described with reference to FIG. 6D, the visual deemphasis includes dimming the underlying content that appears beneath the header portion.

In some embodiments, applying the first content deemphasis effect to at least the portion of the first content that occupies the subset of the first region includes: in accordance with a determination that the first content meets first content criteria (e.g., first criteria based on luminance and/or color saturation of the underlying content, and/or first criteria based on contrast between foreground luminance and background luminance of the underlying content), applying a first type of content deemphasis effect (e.g., a first combination of a first set of one or more content deemphasis effects, based on a first set of content deemphasis parameters, and/or based on a first set of relationships between the first set of content deemphasis parameters and the one or more properties of the first content) to at least the portion of the first content that occupies the subset of the first region; and in accordance with a determination that the first content meets second content criteria (e.g., second criteria based on luminance and/or color saturation of the underlying content, and/or second criteria based on contrast between foreground luminance and background luminance of the underlying content), different from the first content criteria, applying a second type of content deemphasis effect (e.g., a second combination of a second set of one or more content deemphasis effects, based on a second set of content deemphasis parameters, and/or based on a second set of relationships between the second set of content deemphasis parameters and the one or more properties of the first content), different from the first type of content deemphasis effect, to at least the portion of the first content that occupies the subset of the first region. Similarly, in some embodiments, applying the second content deemphasis effect to at least a portion of the second content that occupies the subset of the first region includes: in accordance with a determination that the second content meets the first content criteria, applying the first type of content deemphasis effect to at least the portion of the second content that occupies the subset of the first region; and in accordance with a determination that the second content meets the second content criteria, applying the second type of content deemphasis effect to at least the portion of the second content that occupies the subset of the first region. In some embodiments, applying a respective content deemphasis effect to at least a portion of the first content that occupies the subset of the first region includes adjusting one or more parameters of a user interface material overlaying the first content that occupies the subset of the first region, wherein the parameter values and the set of parameters (e.g., blur radius to adjust the clarity and/or transparency of the user interface material, dimming layer to adjust the opacity and simulated transmissivity of the user interface material, one or more color matrices to adjust the frostiness, visual saliency and/or tint of the user interface material, clamping values, simulated sheen, simulated refraction, and/or other sets of parameters) used in one or more visual effect applied to the first content are adjusted in accordance with the one or more properties of the first content. For example, as described with reference to FIG. 6D, the visual deemphasis is changed based on a detected luminance of the underlying content that is being scrolled beneath the header portion.

In some embodiments, the first content criteria include a first criterion that is used to evaluate the portion of the first content based on a comparison between foreground luminance of the portion of the first content and background luminance of the portion of the first content; the second content criteria include a second criterion that is used to evaluate the portion of the first content based on the comparison between the foreground luminance of the portion of the first content and the background luminance of the portion of the first content; and the second criterion is different from the first criterion (e.g., the first criterion is met when the comparison meets first threshold difference, and the second criterion is met when the comparison does not meet the first threshold difference; and/or the first criterion is met when the comparison meets the first threshold difference, and the second criterion is met when the comparison meets a second threshold difference greater than the first threshold difference). Similarly, in some embodiments, the first content criteria include the first criterion that is used to evaluate the portion of the second content based on a comparison between foreground luminance and background luminance of the portion of the second content; and the second content criteria include the second criterion that is used to evaluate the portion of the second content based on the comparison between the foreground luminance of the portion of the second content and the background luminance of the portion of the second content. For example, as described with reference to FIG. 6D, the visual deemphasis is changed based on a comparison of a foreground luminance and a background luminance of the underlying content that is being scrolled beneath the header portion.

In some embodiments, the first criterion is met by the portion of the first content when a difference between the foreground luminance of the portion of the first content and the background luminance of the portion of the first content exceeds a threshold difference; and the second criterion is met by the portion of the first content when the difference between the foreground luminance of the portion of the first content and the background luminance of the portion of the first content is below the threshold difference; applying the first type of content deemphasis effect to at least the portion of the first content that occupies the subset of the first region includes prioritizing fading foreground content in the portion of the first content into a background in the portion of the first content, over dimming the portion of the first content (e.g., when the first content has a large difference in luminance between the foreground and the background, applying more fading than dimming to the first content, resulting in an appearance that is close to the background of the portion of the first content with a slight overall dimming effect); and applying the second type of content deemphasis effect to at least the portion of the first content that occupies the subset of the first region includes prioritizing dimming the portion of the first content over fading the foreground content in the portion of the first content into the background in the portion of the first content (e.g., when the first content has a small difference in luminance between the foreground and the background, applying more dimming to the first content than fading out the foreground content in the first content, resulting in an appearance that is close to the portion of the first content with a stronger overall dimming effect). For example, in some embodiments, for higher contrast content, the visual deemphasis effect causes the content to lose more visual details without changing the overall luminance difference too much; and in some embodiments, for lower contrast content, the visual deemphasis effect causes the content to retain more visual details but with reduced overall luminance. For example, as described with reference to FIG. 6D, for a greater amount of difference between the foreground luminance and the background luminance, the visual deemphasis includes a higher level of fading the content (e.g., and/or a lower level of dimming the content)

In some embodiments, applying the first content deemphasis effect to at least the portion of the first content that occupies the subset of the first region includes gradually varying an intensity of the first content deemphasis effect (e.g., varying the amounts of blur, dimming, and/or fading applied to the first content) across a spatial extent of the portion of the first content that occupies the subset of the first region; the intensity of the first content deemphasis effect has a first intensity (e.g., first amounts of blur, dimming, and/or fading) at a first location relative to the first set of one or more user interface elements; and the intensity of the first content deemphasis effect has a second intensity (e.g., second amounts of blur, dimming, and/or fading), different from the first intensity, at a second location, different from the first location, relative to the first set of one or more user interface elements. Similarly, in some embodiments, applying the second content deemphasis effect to at least the portion of the second content that occupies the subset of the first region includes gradually varying an intensity of the second content deemphasis effect across a spatial extent of the portion of the second content that occupies the subset of the first region; the intensity of the second content deemphasis effect has a third intensity at the first location relative to the first set of one or more user interface elements; and the intensity of the second content deemphasis effect has a fourth intensity, different from the third intensity, at the second location relative to the first set of one or more user interface elements. For example, in some embodiments, the deemphasis effect in the first region varies spatially (e.g., a gradually changing opacity and/or blur radius) and has a shape that follows contours of multiple different user interface elements of the first set of one or more user interface elements. In some embodiments, the spatial variations in the intensities of the deemphasis effect are based on the spatial locations relative to the locations of the first set of user interface elements in the first region of the first user interface, and are, optionally, independent of the spatial variations in the one or more properties of the first content within the first region. For example, as described with reference to FIG. 6D, the visual deemphasis is applied non-uniformly in the header portion, for example, along a gradient that is defined according to contours of the shape(s) of control 6200 and/or control 6204.

In some embodiments, the first location is on a first intensity contour (e.g., a contour on which the deemphasis effect are applied with the same intensity for a respective set of values for the one or more properties of the first content) around a first user interface element and a second user interface elements of the first set of one or more user interface elements, the second location is on a second intensity contour (e.g., a contour on which the deemphasis effect are applied with the same intensity for the respective set of values for the one or more properties of the first content), different from the first intensity contour, around the first user interface element and the second user interface element of the first set of one or more user interface elements, and at least one of the first intensity contour and the second intensity contour includes: a first curved portion and a second curved portion that curve outward away from the first user interface element and the second user interface element, and a third curved portion between the first curved portion and the second curved portion, that curves inward toward a location between the first user interface element and the second user interface element (e.g., at least one of the first intensity contour and the second intensity contour around the first user interface element and the second user interface element is concave, and curves toward the space between the first user interface element and the second user interface element). For example, as described with reference to FIG. 6D, in some embodiments, the gradient of visual deemphasis of the header portion follows a concave shape.

In some embodiments, the first location is on a first intensity contour (e.g., a contour on which the deemphasis effect are applied with the same intensity for a respective set of values for the one or more properties of the first content) around a first user interface element and a second user interface elements of the first set of one or more user interface elements; the second location is on a second intensity contour (e.g., a contour on which the deemphasis effect are applied with the same intensity for the respective set of values for the one or more properties of the first content), different from the first intensity contour, around the first user interface element and the second user interface element of the first set of one or more user interface elements; the first intensity contour of the first deemphasis effect has a first shape and/or size that is based on a set of spatial characteristics of the first set of one or more user interface elements (e.g., the first intensity contour has a shape and size that enclose the first set of user interface elements and are spaced apart from the first set of user interface elements by a first distance); and the second intensity contour of the first deemphasis effect has a second shape and/or size that is based on the set of spatial characteristics of the first set of one or more user interface elements (e.g., the second intensity contour has a shape and size that enclose the first set of user interface elements and are spaced apart from the first set of user interface elements by a second distance, different from the first distance). For example, as described with reference to FIGS. 6D and 6H, in some embodiments, the shape of the gradient of visual deemphasis is different for a different shaped control 6300 as compared to control 6200 (e.g., the contours follow a pill/oval shape instead of a round shape).

In some embodiments, displaying the first user interface concurrently including the first content and the first set of one or more user interface elements, includes displaying, via the one or more display generation components, at least a first user interface element of the first set of one or more user interface elements with a user interface material (e.g., a simulated glassy material, and/or other types of user interface material) that has an appearance that simulates optical interactions (e.g., simulated refraction, simulated shadow, simulated reflection, and/or other simulated optical interactions that alter the appearance of at least a portion of the user interface material based on the appearance of the first content that underlies and/or is adjacent to the user interface material) between the user interface material and at least a portion of the first content that is within an interaction distance (e.g., a refraction-threshold distance, a shadow-threshold distance, and/or a sheen-threshold distance) from a boundary of the first user interface element (e.g., the portion of the first content that is within the interaction distance from the boundary of the first user interface element includes a portion of the first content that directly underlies the first user interface element and/or a portion of the first content that is adjacent to the first user interface element); and the portion of the first content that is within the interaction distance of the first user interface element is subject to the first content deemphasis effect (e.g., the first content deemphasis effect is applied to the portion of the first content that is within the first region and that is covered by the first user interface element of the first set of one or more user interface elements, where the portion of the first content is also used in generating the appearance of the user interface material of the first user interface element that simulates optical interaction between the user interface material and its surrounding content). In some embodiments, the parameters of the first content deemphasis effect is different within the interaction distance of the first user interface element, as compared to the parameters of the first content deemphasis effect outside of the interaction distance of the first user interface element, even though both sets of parameters are based on the one or more properties of the first content. For example, as described with reference to FIG. 6D, the visual deemphasis of the header portion is applied over one or more virtual lighting effects, such as refraction and/or reflection, that are applied to content that is optionally displayed with a simulated glass appearance, such that the simulated refraction and/or reflection appear blurred, dimmed, faded, or otherwise visually deemphasized in the header portion.

In some embodiments, applying the first content deemphasis effect on the subset of the portion of the first content includes: applying the first content deemphasis effect to the portion of the first content that occupies the subset of the first region that is not covered by the first set of one or more user interface elements, with a first set of one or more intensities; and applying the first content deemphasis effect to respective portion of the first content that are covered by respective user interface elements of the first set of one or more user interface elements, with a second set of one or more intensities, that are less than the first set of intensities (e.g., the deemphasis effect is reduced under the first user interface element, as compared to the area outside of the outline of the first user interface element). For example, as described with reference to FIGS. 6D-6E, the control 6200 and/or control 6204 appear to be punched out of the header portion such that the visual deemphasis of the header portion is not applied to control 6200 and/or control 6204.

In some embodiments, the first set of one or more user interface elements includes a first user interface element that is designated for inclusion in the first region of the first user interface (e.g., a button or text in the original header of the first user interface, that is persistently displayed at the same location in the first user interface, and/or that includes a user interface material that has simulated optical interactions with its internal content and nearby external content), and the first set of one or more user interface elements includes a second user interface element, different from the first user interface element, that is part of the first content before the first content is moved into the first region of the first user interface, and that becomes included in the first set of one or more user interface elements and in the first region of the first user interface, based on a spatial proximity of the second user interface element to the first user interface element when the first content moves relative to the first user interface (e.g., the second user interface element is merged into the first region of the first user interface, with the “magic pocket” region optionally expanding to include the second user interface element, when the second user interface element is scrolled with the first content to a location right below the first user interface element). In some embodiments, the first region takes into account both system user interface elements designated for the header region, and application user interface elements that are part of the content in the application user interface (e.g., buttons or text designated by a currently displayed application as belonging to the “glass layer” or simply floating on top of the first content just under the glass layer). For example, as described with reference to FIG. 6H, in some embodiments, header portion includes application content (e.g., control 6300 and control 6304) and system user interface content for one or more system functions, such as header 6306, that is moved into the header portion in response to a scroll user input.

In some embodiments, the first set of one or more user interface elements includes: at least one user interface element that is a system user interface element that, when selected, causes the computer system to perform a system function (e.g., displaying a system user interface such as a control user interface, a settings user interface, or a sharing user interface); and at least one user interface element that is an application user interface element that, when selected, causes the computer system to perform a function determined by an application to which the application user interface element corresponds. (e.g., switching views within the application or causing performance of an application-specific content creation, modification, or deletion operation). For example, as described with reference to FIG. 6H, in some embodiments, header portion includes application content (e.g., control 6300 and control 6304) and system user interface content for one or more system functions, such as header 6306.

In some embodiments, the first user interface element is an element (e.g., a control or a text label) in a header region of the first user interface (e.g., a persistently displayed header region, usually at the top of the first user interface adjacent a top edge of the first user interface, but can also be a “header” region displayed adjacent to another edge of the first user interface) that has an appearance that simulates optical interaction with content in the first user interface (e.g., the element includes user interface material that has the simulated optical interactions with nearby content). Additional details related to how the simulated optical interaction is visually represented in the appearance of the first user interface element through a user interface material of the first user interface element are provided with respect to FIGS. 6A-6C and FIGS. 6AO-6AP and accompanying descriptions, including method 14000 and method 18000. In some embodiments, for at least a first period of time when the second user interface element is not included in the first set of one or more user interface elements, the second user interface element is a sub-header of the content in the first user interface, moving relative to the header region of the first user interface (e.g., the second user interface element is a letter header for a plurality of contact entries starting with the letter corresponding to the letter header), and not subject to the simulated optical interaction and not subject to the first content deemphasis effect (e.g., the sub-header is scrolling outside of the magic pocket region and outside of the header region) and for at least a second period of time when the second user interface element is included in the first set of one or more user interface elements based on the spatial proximity of the second user interface element to the first user interface element, the first second user interface element changes a spatial extent of the first content deemphasis effect on the content in the first user interface (e.g., the second user interface element temporarily stops moving with the content, becomes a glassy element and/or merges into the glassy header region, and changes the overall shape and size of the “magic pocket”). In some embodiments, for at least a third period of time when the second user interface element is not included in the first set of one or more user interface elements, the second user interface element is a sub-header of the content in the first user interface, moving relative to the header region of the first user interface (e.g., the second user interface element is a letter header for a plurality of contact entries starting with the letter corresponding to the letter header), and is subject to the simulated optical interaction and the first content deemphasis effect (e.g., as the letter header moves again, within the header region, it is subject to both the simulate optical interaction with the glassy header and subject to the first content deemphasis effect of the header region). For example, in some embodiments, a second header, like the letters headers in the contacts app, changes the first region of the first deemphasis effect when it gets to right below the current header and stays right below the header. In some embodiments, the letter header becomes part of the first region, and affects the spatial extent of the first deemphasis effect when it paused right below the current header as the contact entries for the letter header is scrolled under the original header and the paused letter header; and when the letter header starts moving again to make way for the next letter header, the letter of the moving letter header is refracted in the glass layer of original header when it moves past the glass material of the original header, and is subject to the content deemphasis effect as part of the content moving in the first region. In some embodiments, the second user interface element (e.g., a letter header of a group of entries, a section header of a section of displayed content, or a folder name or title of a currently displayed content page) is initially displayed as part of the currently displayed content, and scrolls relative to the first region with the currently displayed content; and when the second user interface element reaches within a threshold distance of the first region, the second user interface element fades out at its current location and fades in at a different location within the first region (e.g., in the middle of the header region, and/or at another location in the first region or expanded first region) and becomes one of the plurality of user interface elements in the first region and affect how the deemphasis effect is applied in the first region. In some embodiments, the second user interface element becomes an element that includes the user interface material (e.g., the same user interface material used in other user interface elements in the plurality of user interface elements), and as the currently displayed content scrolls past the first region, the second user interface element is displayed with an appearance that simulates refraction of a portion of the scrolling content that underlies the second user interface element and/or is adjacent to the second user interface element. For example, as described with reference to FIG. 6H, in some embodiments, header portion includes application content (e.g., control 6300 and control 6304) and system user interface content, such as header 6306.

In some embodiments, displaying the first user interface includes maintaining a position of the first region of the first user interface relative to a display area provided via the one or more display generation components (e.g., the first region remains in a respective portion of the display area provided by the display generation components, such as a top portion, a left edge portion, an interior portion, a bottom portion, a right edge portion, and/or one or more other portion of the display area, optionally within a container object such as a window and/or platter displayed within the display area that remains substantially stationary relative to the display area during the changes in the content in the first user interface), when the first content occupies the subset of the first region that is not covered by the first set of one or more user interface elements, and when the second content occupies the subset of the first region that is not covered by the first set of one or more user interface elements. In some embodiments, the computer system maintains respective locations of the one or more user interface elements in the first region and the first region, when the content displayed in the first region changes. For example, as described with reference to FIG. 6D, the header portion is maintained in its respective position in the user interface without scrolling the header portion while scrolling the content displayed in the user interface in response to the user input 6206.

It should be understood that the particular order in which the operations in FIG. 15 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 13000, 14000, 16000, 17000, 18000, 19000, and/or 20000) are also applicable in an analogous manner to method 15000 described above with respect to FIG. 15. For example, the buttons, user interfaces, controls, visual deemphasis, virtual effects, an/or animations described above with reference to method 15000 optionally have one or more of the characteristics of the buttons, user interfaces, controls, visual deemphasis, virtual effects, an/or animations described herein with reference to other methods described herein (e.g., methods 7000, 8000, 9000, 10000, 11000, 12000, 13000, 14000, 16000, 17000, 18000, 19000, and/or 20000). For brevity, these details are not repeated here.

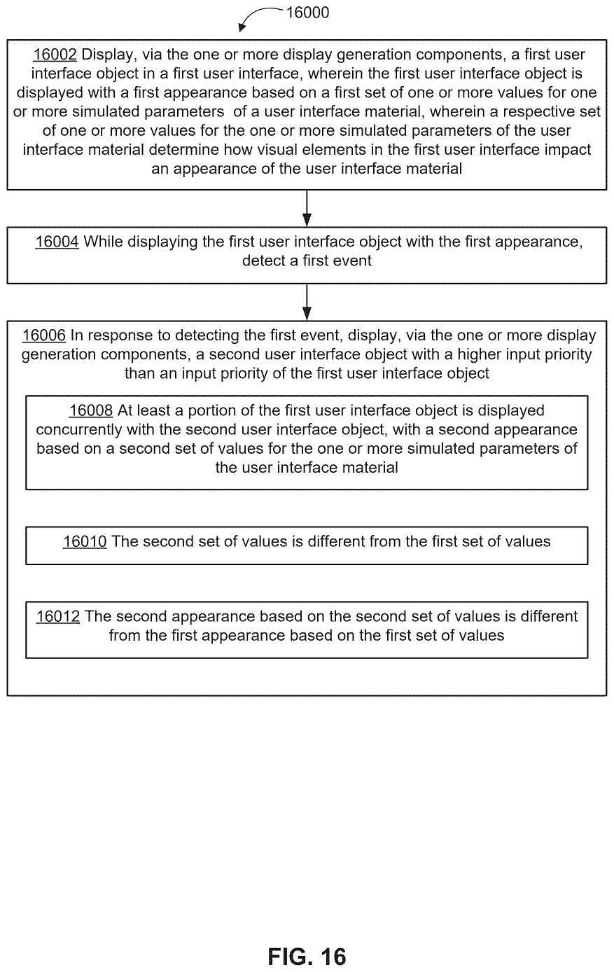

FIG. 16 is a flow diagram illustrating a method 16000 of visually emphasizing user interface objects that at least partially overlay one or more other user interface objects in accordance with some embodiments. In some embodiments, the method 16000 is performed at a computer system (e.g., portable multifunction device 100, device 300 in FIGS. 1A-6AP) that is in communication with one or more input devices (e.g., touch-sensitive surfaces, optical sensors, motion sensors, proximity sensors, gyros, accelerometers, ambient light sensors, joysticks, buttons, keyboards, handheld controllers, pointer devices, and/or other types of input devices) and one or more display generation components (e.g., touch-screen displays, standalone displays, LED displays, LCD displays, head-mounted displays, heads-up displays, foldable displays, flexible displays, and/or other types of display generation components that provides one or more display areas in which content, user interfaces, and/or controls can be made visible to a user). In some embodiments, one or more of the display generation components are separate from one or more of the touch-sensitive surfaces. Some operations in method 16000 are, optionally, combined and/or the order of some operations is, optionally, changed.

Automatically visually deemphasizing content that is at least partially obscured by a user interface object displayed with a simulated user interface material improves the visibility and legibility of the user interface object while maintaining display of the content that is at least partially obscured by the user interface object, without requiring additional user input. Displaying the user interface object with the simulated user interface material provides information about the spatial relationships between the user interface elements, provides visual feedback regarding the effect of user input, informs the user about the change in the state of the computer system and application, and guides the user about how to use his/her input to change the system state and/or application state. The appearance of the user interface material also provides visual feedback regarding the type of user interface object and its associated functions. Some of the appearance characteristics are used to balance the need for visual saliency of the user interface objects against the background, visual saliency of the internal content of the user interface objects, and reduce visual distraction of the underlying content, and the efficiency in generating these appearances. Using user interface materials with simulated optical properties for user interface elements improves the legibility of content, which enables a user to use a device for shorter periods of time, which saves energy and improves battery life. Using user interface materials with simulated optical properties for user interface elements enables the user interface elements to be more transparent, and an increased transparency of user interface elements enables a user to use a device for shorter periods of time, which saves energy and improves battery life. Providing an appearance of user interface elements (e.g., changing material appearance based on underlying content) when one or more criteria are met reduces the number of inputs (e.g., navigating through settings user interfaces and menus to set the values for parameters to adjust the appearance of user interface elements) that would otherwise be required to generate a similar effect, which saves energy and improves battery life.

The computer system displays (16002) via the one or more display generation components, a first user interface object (e.g., a window, a dock, a toolbar, a control, an application icon, and/or a user interface object that includes content and optionally responds to user inputs) in a first user interface (e.g., a full-screen user interface, a user interface displayed in a window, a system user interface, and/or an application user interface), wherein the first user interface object is displayed with a first appearance based on a first set of one or more values for one or more simulated parameters (e.g., simulated size, length, thickness, flexibility, translucency, refractivity, reflectivity, stiffness, elasticity, luminance, and/or another simulated parameter that, optionally, has a counterpart in the physical world and/or that, optionally, mimics one or more characteristics of the counterpart in the physical world) of a user interface material (e.g., a simulated material that simulates a physical and/or fictional material, such as a background material, a two-dimensional substrate, a three-dimensional volume or substrate, a glassy material, a liquid material, a gaseous material, a gelatinous material, and/or other types of simulated materials, and is used to provide visual definition to one or more user interface objects relative to its surrounding regions), wherein a respective set of one or more values (e.g., the first set of one or more values, or another set of one or more values) for the one or more simulated parameters of the user interface material determine how (e.g., a manner in which and/or a degree to which) visual elements in the first user interface impact (e.g., are used to determine) an appearance (e.g., the first appearance, or another appearance) of the user interface material (e.g., in the portion of the user interface material overlapping and/or adjacent to the visual elements, and/or optionally, in portions of the user interface material that are spaced apart from the visual elements). In some embodiments, the first user interface object is displayed among a plurality of user interface objects that are of the same object type as the first user interface objects, and/or a plurality of user interface objects that are of other objects types different from the object type of the first user interface object. In some embodiments, the first user interface is a home screen user interface, a wake screen user interface, a control user interface, and/or other system user interfaces. For example, as described with reference to FIGS. 6I-6J, application icons displayed in a system user interface are displayed with a simulated glass material. In some embodiments, as described with reference to FIGS. 6K-6L, controls in a control user interface 6401 are displayed with a simulated glass material.

While displaying the first user interface object with the first appearance (e.g., a glassy appearance that simulates optical interactions with content internal and/or external to the first user interface object), the computer system detects (16004) a first event (e.g., detection of a user input directed to the first user interface object, detection of a user input directed to another user interface object other than the first user interface object, generation of a system alert or notification, display of another object or user interface overlaying a portion of the first user interface, and/or other event that changes the input priority of the first user interface object).

In response to detecting the first event, the computer system displays (16006), via the one or more display generation components, a second user interface object (e.g., a user interface object that was already displayed in the first user interface and/or a user interface object that is displayed in response to the first event) with a higher input priority than an input priority of the first user interface object (e.g., the first event caused input priority to shift to the second user interface object, to take input priority away from the first user interface object, and/or deprioritized the first user interface object to allow the user to directly interact with the second user interface object) For example, as described with reference to FIGS. 6K-6L, in response to a user input 6406, a control user interface 6401 is displayed. In some embodiments, as described with reference to FIG. 6L-6M, in response to detecting a user input 6410, an expanded platter 6414 is displayed.

At least a portion of the first user interface object is displayed (16008) concurrently with the second user interface object (e.g., with the first user interface object spaced apart from the second user interface object, or with the second user interface object overlaying a portion of and/or partially obscuring the first user interface object from the current viewpoint of the user), with a second appearance based on a second set of values for the one or more simulated parameters of the user interface material, the second set of values is (16010) different from the first set of values (e.g., the second set of values includes at least a greater value for a first simulated parameter of the user interface material, and/or at least a less value for a second simulated parameter of the user interface material, as compared to the first set of values), For example, the platter 6414 is displayed with the simulated glass material concurrently with at least one or more controls displayed in the control user interface 6401, where the at least one or more controls are displayed with a modified simulated glass material, such as with a reduced simulated thickness.

The second appearance based on the second set of values is (16012) different from the first appearance based on the first set of values (e.g., the visible portion of the first user interface object is visually deemphasized and/or shown with a reduced glassy appearance, when it is concurrently displayed with the second user interface object, optionally along with other user interface objects of the first user interface). For example, in some embodiments, when the first user interface object is initially displayed before the detection of the first event, the first user interface object is displayed with an appearance that simulates refraction of content in the first user interface that indicates a first set of simulated thicknesses and/or edge curvatures of the user interface material of the first user interface object. This appearance is, optionally used to indicate a higher input priority of the first user interface object at this time, as compared to another user interface object, such as the second user interface object or a third user interface object. In some embodiments, when the second user interface object gains a higher input priority compared to the first user interface object, the first user interface object is displayed with a different appearance from before, where this new appearance optionally still simulates refraction by the user interface material, but to a different degree as compared to before the decrease in input priority of the first user interface object. In some embodiments, the new appearance with the simulated refraction indicates a second set of simulated thicknesses and/or edge curvatures of the user interface material of the first user interface object (e.g., smaller simulated thicknesses and/or larger radii of curvatures). This new appearance is, optionally, used to indicate the lower input priority of the first user interface object, compared to another user interface object, such as the second user interface object. In some embodiments, after the second user interface object is displayed with at least a portion of the first user interface object in response to detection of the first event, the computer system detects a second event; and in response to detecting the second event, the computer system reverses the changes to the first user interface object and the second user interface object, such that the first user interface object is redisplayed with the first set of values for the one or more simulated parameters of the user interface material.

In some embodiments, displaying the second user interface object with the higher input priority than the input priority of the first user interface object includes: displaying the second user interface object with a third appearance (e.g., a glassy appearance that indicates the high input priority) based on the first set of one or more values for the one or more simulated parameters (e.g., the first appearance and the third appearance are based on the same set of simulated spatial properties, simulated optical properties, and/or simulated material properties, of the same user interface material). In one example, in some embodiments, if the first user interface object was displayed with the first appearance that is based on a first set of simulated thicknesses for the user interface material in a depth direction of the first user interface, the second user interface object is displayed with the third appearance that is based on the first set of simulated thicknesses for the user interface material in the depth direction of the first user interface. In one example, in some embodiments, if the first user interface object was displayed with the first appearance that is based on a first set of radii of curvature for the corners and edges of the user interface material of the first user interface object, the second user interface object is displayed with the third appearance that is based on the first set of radii of curvature for the corners and edges of the user interface material of the second user interface object. In one example, if the first user interface object was displayed with the first appearance that is based on a first set of values for simulated optical and/or material properties (e.g., simulated refractive index, simulated lensing effect, simulated opacity, simulated transmissivity, simulated damping factor, and/or other simulated optical and/or material properties) of the user interface material of the first user interface object, the second user interface object is displayed with the third appearance that is based on the first set of values for the simulated optical and/or material properties of the user interface material of the second user interface object. For example, as described with reference to FIG. 6M, the platter 6414 is displayed with a simulated glass material having the same or similar levels of visual properties as the simulated glass material of the controls in control user interface 6401 (e.g., in FIG. 6L).

In some embodiments, a change from the first appearance based on the first set of values for the one or more simulated parameters of the user interface material to the second appearance based on the second set of values for the one or more simulated parameters of the user interface material corresponds to a reduction of a simulated optical interaction with the user interface material (e.g., reduction of a glassy appearance of the user interface material, based on a reduction of simulated refraction, a reduction of simulated lensing effect, a reduction of simulated transmissivity, and/or a reduction in simulated thickness of the user interface material). In some embodiments, reduction of a simulated refraction effect for a user interface element optionally includes reducing an extent of the background content that is used to generate the simulated refraction effect (e.g., ceasing to use content more than a threshold distance away from an edge of the user interface element to determine an appearance of the user interface material). In some embodiments, the reduction of the simulated optical interaction includes reducing the blur radius used in a blur layer applied to the underlying content to increase clarity of the user interface material, reducing displacement of pixel values in the blur layer used in a simulated refraction layer, reducing distortion and/or color separation of internal content in a lensing layer applied to the internal content, reducing the interaction distance of simulated sheen and/or simulated color bleed caused by nearby content, reducing the size and shadow threshold distance of simulated shadow of the user interface object, and/or reducing other visual effects that are used to simulate optical interaction between the user interface material and nearby content. In some embodiments, reducing a type of simulated optical interaction includes removing the visual effect associated with the type of optical interaction completely. Additional details related to how the simulated optical interaction is visually represented in the appearance of a user interface element through a user interface material of the user interface element are provided with respect to FIGS. 6A-6C and FIGS. 6AO-6AP and accompanying descriptions, including method 14000 and method 18000. For example, the one or more controls in the control user interface 6401 are displayed with a simulated reduced thickness while displaying the platter 6414.

In some embodiments, prior to detecting the first event, the first user interface object is a first control (e.g., a toggle control, a slider control, an application icon, a widget, and/or other types of controls) displayed in the first user interface. In some embodiments, the first user interface object is a control that causes performance of a corresponding function when the control is activated in response to an input that meets control activation criteria (e.g., a tap gesture, an air pinch gesture, a light press input, a click input, and/or other types of activation input). In some embodiments, detecting the first event includes detecting a user input that corresponds to a request to expand an expandable control in the first user interface, including the first control or another expandable control other than the first control (e.g., a request to expand the first control or another control concurrently displayed with the first control, into a control module including a set of related controls, and/or a request to expand the first control or another control concurrently displayed with the first control, into a control user interface that overlays or replaces display of the first user interface); and the second user interface object is a second control (e.g., a toggle control, a slider control, an application icon, a widget, and/or other types of controls; optionally, different from the first control, related to the first control, and/or corresponds to a function of the first control) that is displayed in response to the user input that corresponds to the request to expand the expandable control (e.g., the second control is a part of an expanded control module that includes the second control, and/or the second control is a control among a set of two or more controls that is displayed as a result of the expansion of the first control or the other control concurrently displayed with the first control). In some embodiments, the first user interface object is a control in a control user interface, such as a Focus Mode control, and detecting the event includes detecting a touch and hold gesture directed to the Focus Mode control to expand the Focus Mode control into a platter than includes a plurality of controls for triggering different focus modes on the computer system. In some embodiments, selection of the focus mode control toggles a default focus mode or a currently active focus mode ON or OFF. In some embodiments, different focus modes corresponds to different sets of rules for delivering notifications and alerts (e.g., delivering immediately upon receipt, delivering in a notification summary, delivering at a later time, forgoing delivering and saving to notification history directly, and/or other delivery-related constraints and/or conditions), different sets of display and wallpaper settings, different sets of screentime restrictions, and/or other rules related to different operation modes of the computer system, that are optionally turned on/off manually or based on satisfaction of corresponding contextual conditions (e.g., time of day, location, user identity, user profile, settings, and/or other conditions). In some embodiments, the other controls displayed concurrently with the Focus Mode control are displayed with respective user interface materials having respective glassy appearances (e.g., these are examples of the first user interface object with the first appearance) before the expansion of the Focus Mode control, and after the expansion of the Focus Mode control into a glassy platter that includes the plurality of controls with respective glassy appearances to indicate their higher input priorities, while the other controls in the control user interface (e.g., these are examples of the first user interface object with the second appearance) that are not covered by the glassy platter are displayed without a glassy appearance to indicate their reduced input priority relative to the controls for the different focus modes (e.g., these are the examples of the second user interface object that has the higher input priority). In some embodiments, controls corresponding to other control functions, such as WiFi, airplane mode, screen brightness, volume, media playback have characteristics and behaviors analogous to those described above with respect to the Focus Mode control. For example, as described with reference to FIGS. 6I-6J, the user input 6402 is a request to expand menu 6404. In some embodiments, as described with reference to FIGS. 6L-6M, the user input 6410 corresponds to a request to display platter 6414 for connectivity controls.

In some embodiments, displaying the second control in response to detecting the user input that corresponds to a request to expand the expandable control, includes: expanding the user interface material of the expandable control from a first size to a second size larger than the first size; and displaying the second control overlaying the user interface material displayed with the second size. For example, in some embodiments, in response to detecting a touch and hold input directed toward an expandable control (e.g., a toggle control, a slider control, an application icon, a widget, and/or another type of control) that is displayed with a steady state appearance with a first size and a first simulated thickness, the computer system expands the user interface material of the expandable control from a first size to a second size to serve as a background platter of a control module, and displays a plurality of controls overlaying the background platter, where the background platter optionally still has a glassy appearance but has a smaller simulated thickness and less simulated refraction as compared to the appearance prior to the expansion of the expandable control. In some embodiments, the plurality of controls overlaying the background platter have the glassy appearances that are similar to the glassy appearance of the expandable control before the expansion of the expandable control, which are based on a greater simulated thickness and/or greater simulated refraction, as compared to those of the background platter, as described in more detail with reference to methods 9000 and 1000. For example, as illustrated in FIG. 6J, the menu 6404 is displayed with the simulated glass material that is expanded from the simulated glass material of application icon 440.

[In some embodiments, while displaying the expandable control prior to expanding the expandable control, the computer system detects a user input that is directed to a portion of the expandable control (e.g., a swipe gesture, a click and drag input, an air pinch and drag gesture, a tap and hold gesture, and/or other types of user inputs that has a target location that corresponds a portion of the expandable control). In some embodiments, the user input that is directed to a portion of the expandable control is different from the user input that corresponds to a request to expand the expandable control. In some embodiments, the user input that is directed to a portion of the expandable control is a starting portion of the user input that corresponds to a request to expand the expandable control, and becomes the user input that corresponds to a request to expand the expandable control after the user input meets control expansion criteria (e.g., criteria based on a duration, speed, distance, and/or other thresholds being met by the user input). In some embodiments, in response to detecting the user input that is directed to a portion of the expandable control, the computer system displays, via the one or more display generation components, a respective sequence of animated changes in the user interface material of the expandable control, including: in accordance with a determination that the user input that is directed to a portion of the expandable control has a first set of values for one or more spatial characteristics of the user input (e.g., has a first target location relative to the expandable control, includes a first amount of movement in a respective direction relative to the expandable control, has movement in a first direction relative to the expandable control, and/or has a first intensity or duration while directed to a respective portion of the expandable control), stretching the user interface material by a first amount of stretching in a first stretching direction, and compressing the user interface material by a first amount of compression in a first compression direction, wherein the first stretching direction and the first compression direction are selected based on the first set of values for the one or more spatial characteristics; and in accordance with a determination that the user input that is directed to the portion of the expandable control has a second set of values, different from the first set of values, for the one or more spatial characteristics of the user input (e.g., has a second target location relative to the expandable control, includes a second amount of movement in a respective direction relative to the expandable control, has movement in a second direction relative to the expandable control, and/or has a second intensity or duration while directed to a respective portion of the expandable control), stretching the user interface material by a second amount of stretching in a second stretching direction, and compressing the user interface material by a second amount of compression in a second compression direction, wherein the second stretching direction and the second compression direction are selected based on the second set of values for the one or more spatial characteristics. For example, in some embodiments, the expandable control (and, analogously, other controls that include the same type of user interface material as the expandable control) resizes (e.g., expands and/or compresses in one or more lateral dimensions) dynamically based on changing spatial characteristics of a user input (e.g., the location of the targeted portion of the expandable control relative to the expandable control, the direction of the user input, the distance of movement of the user input, the speed of the user input, and/or the rate of change in the speed of the user input) that is directed toward the expandable control. In some embodiments, in response to the user input, the visual changes in the user interface material of the expandable control start prior to the user input meets the criteria to trigger performance of an operations, such as activation of the expandable control to perform a control function of the expandable control, pulling additional controls out of the expandable control, and/or adjusting a control value of the expandable control. Additional details are provided with respect to the descriptions for method 11000 and FIGS. 5V-5Z3.

In some embodiments, in response to detecting the first event, displaying an animated transition that includes displaying the user interface material (e.g., the user interface material of the first user interface object, the user interface material of the second user interface object, a user interface material of other user interface objects, and/or the user interface material of a platter of the first user interface object, the second user interface object, and/or other user interface objects) changing through a sequence of intermediate shapes that corresponds a simulated oscillation of the user interface material (e.g., including expansion in a respective dimension and reversing at least a portion of the expansion in the respective dimension before settling into a steady state size in the respective dimension; and/or including compression in a respective dimension and reversing at least a portion of the compression in the respective dimension before settling into a steady state size in the respective dimension) relative to the first user interface. For example, in some embodiments, an expandable control (and, analogously, other controls that include the same type of user interface material as the expandable control) are displayed with an oscillating animation when the expandable control is expanded into a control platter for a control module including multiple related controls, an expanded version of the expandable control, and/or a control user interface that includes a plurality of controls and/or control modules. Similarly, the computer system displays an oscillating animation of the user interface material when the control module and/or control user interface are collapsed back to the expandable control in response to other events. For example, when the second user interface object is a control in a control user interface, while the first user interface object is an application icon in a home screen user interface, the computer system displays the control user interface overlaying a portion of the home screen user interface in response to a swipe gesture directed to an edge portion of the home screen user interface (e.g., a downward swipe from an upper right corner of the home screen user interface, an upward swipe from a bottom edge of the home screen user interface, and/or other swipe gestures directed to other portions of the home screen user interface). In some embodiments, when displaying the control user interface, the application icons of the home screen user interface cease to be displayed with the glassy appearances, and the control user interface overlaying a portion of the home screen user interface are displayed with an animated transition showing the controls in the control user interface with glassy appearances and oscillations settling into their respective steady state appearances. For example, as described with reference to FIGS. 6L-6M, in some embodiments, in response to detecting the user input 6410, the platter 6412 is initially decreased in size before increasing in size into platter 6414, thereby generating an oscillating animation. In some embodiments, the animation for morphing platter 6412 into platter 6414 includes increasing a size (e.g., in dimensions along the x-axis and γ-axis and/or in simulated thickness) of the platter 6414 before decreasing the size of platter 6414 to its final size (e.g., illustrated in FIG. 6M).

In some embodiments, the first user interface object is concurrently displayed with a third user interface object in the first user interface (e.g., an adjacent application icon in the home screen user interface, an adjacent control in the control user interface, prior to detecting the first event, and/or while the first user interface object is displayed with the first appearance); the third user interface object has a first object appearance (e.g., with a first set of one or more colors, shape, and/or size) and a first spatial relationship to the first user interface object (e.g., is at a first distance from and/or on a first side of the first user interface object); and the first appearance based on the first set of the one or more simulated parameters of the user interface material (and/or, analogously, with other appearances based on other sets of values for the one or more simulated parameters of the user interface material) is further based on the first object appearance of the third user interface object (e.g., simulating refraction, reflection, virtual illumination, and/or shadowing, between at least a portion of the third user interface object with the first object appearance, and the user interface material of the first user interface object). Additional details of how nearby objects affect the appearance of the first user interface object via simulated optical interactions between the user interface material of the first user interface object and the content of the nearby objects are provided with respect to FIGS. 5A-5E and accompanying descriptions, including method 7000. For example, as described with reference to FIGS. 6O-6P, changing a level of the brightness control 6438′ causes the device 100 to simulate a change in virtual lighting effects (e.g., via elements 6440, 6440′, and/or 6440a-6440c) applied to one or more surrounding controls.

In some embodiments, the first object appearance of the third user interface object indicates a current state of a control function associated with the third user interface object (e.g., ON/OFF state, first state vs. second state); while displaying the first user interface object with the first appearance and displaying the third user interface object with the first object appearance, the computer system detects, via the one or more input devices, a user input that is directed toward the third user interface object and that meets first criteria (e.g., selection criteria, toggle criteria, and/or other criteria for changing a state of the first user interface object from a first state to a second state); and in response to detecting the user input that meets the first criteria: the computer system performs an operation corresponding to the third user interface object (e.g., changing a state of the control function from a first state to a second state) that changes the current state of the control function from a first state to a second state (e.g., from ON to OFF, from OFF to ON, and/or from a first discrete value to a second discrete value); the computer system updates the first object appearance of the third user interface object, from a first emissive state to a second emissive state, different from the first emissive state (e.g., from emitting virtual light to not emitting virtual light, or vice versa; from emitting virtual light with a first intensity to emitting light with a second intensity; from emitting virtual light in a first direction to emitting light in a second direction; from emitting light with a first color to emitting light with a second color; and/or other changes in emissive state of one or more emissive elements of the third user interface object), in accordance with the change in the current state of the control function from the first state to the second state; and updates the first appearance of the first user interface object (e.g., updating the color, luminance, simulated sheen, simulated refraction, simulated shadow, and/or simulated specular highlights, and/or other visual properties) based on the update to the first object appearance of the third user interface object from the first emissive state to the second emissive state. In some embodiments, the first user interface object is a first control, and the third user interface object is an adjacent control of the first control in a control user interface. In some embodiments, the first control includes a glassy material that has an appearance based on a simulated illuminance by the virtual light emitted from the third control. In some embodiments, an input directed to the third control causes the third control to changes state and change appearance to reflect the change in appearance (e.g., from emitting a blue light to emitting yellow light, or vice versa; and/or from emitting virtual light to not emitting virtual light, or vice versa). In some embodiments, in response to the change in the virtual illumination from the third control, the glassy appearance of the first control changes (e.g., showing changes in the color, spatial extent, and/or intensity of the virtual illumination from the adjacent control) based on the change in the virtual illumination from the third control (e.g., from taking on a blue hue to taking on a yellow hue, or vice versa; and/or from displaying a simulated surface illuminance by the virtual light from the third control to forgoing displaying the simulated surface illumination, or vice versa). In some embodiments, the first control can be the control that includes an emissive element, and causes the simulated optical property of the emissive element to change and in turn causes the appearance of the third control and/or other controls including the user interface material to change, when a user input is directed to the first control, in a manner analogous to those described above with respect to the third control. Additional details related to how an emissive element can change the appearance of the object containing the emissive element and/or objects nearby are provided with respect to FIGS. 5A-5E and accompanying descriptions, including method 7000. For example, as described with reference to FIG. 6N, in response to detecting user input 6420 to activate the flashlight control 6418, the flashlight control 6418 is toggled into an emissive element, and in response to detecting a user input 6432 deactivating the flashlight control 6418, the flashlight control 6418 ceases to be displayed as an emissive element.

In some embodiments, the first user interface object is concurrently displayed with a fourth user interface object in the first user interface (e.g., prior to detecting the first event, and/or while the first user interface object is displayed with the first appearance); the fourth user interface object (e.g., comprising content and the user interface material that is the same type of user interface material as the first user interface object) is displayed with a simulated optical effect (e.g., simulated reflection of the first user interface object, simulated refraction of content of the first user interface object, and/or simulated illumination caused by the emissive element of the first user interface object) that is based on the first appearance of the first user interface object; and Additional details of how nearby objects affect the appearance of the fourth user interface object via simulated optical interactions between the user interface material of the fourth user interface object and the content of the nearby objects are provided with respect to FIGS. 5A-5E and accompanying descriptions, including method 7000. In some embodiments, while displaying the first user interface object and the fourth user interface object, with the simulated optical effect applied to the fourth user interface object, the computer system detects a user input that corresponds to a request to adjust the first user interface object (e.g., change a size, shape, aspect ratio, position, control state of a control function controlled by the first user interface object, a value of a parameter controlled by the first user interface object, and/or value of a display property of the first user interface object). In some embodiments, the user input includes a selection input such as a tap gesture, a click input, an air pinch gesture, and/or other types of selection input with a target location corresponding to the first user interface object. In some embodiments, the user input includes a movement input such as a swipe gesture, a click and drag input, an air pinch and drag gesture, and/or another type of movement input with a target location corresponding to the first user interface object. In some embodiments, the user input includes a select and hold input such as a touch and hold gesture, a light press input, a click and hold input, an air pinch and hold gesture, and/or another type of select and hold input with a target location corresponding to the first user interface object. In some embodiments, in response to detecting the user input that corresponds to the request to adjust the first user interface object, the computer system: adjusts one or more visual properties of the first user interface object (e.g., changing the color, simulated emissivity, simulated translucency, size, shape, position, simulated thickness, and/or other visual properties of the first user interface object based on the user input, optionally, in conjunction with changing a control function associated with the first user interface object); and updates the simulated optical effect applied to the fourth user interface object based on an adjusted appearance of the first user interface object resulted from adjusting the one or more visual properties of the first user interface object (e.g., the simulated reflection, simulated refraction, and/or simulated shadow on the fourth user interface object are adjusted based on the change in appearance of the first user interface object resulted from the user input adjusting the first user interface object). In some embodiments, the first user interface object can be displayed with a simulated optical effect that is based on the appearance the fourth user interface object and/or another adjacent user interface object, and when the fourth user interface object and/or adjacent user interface object is adjusted by a user input, the simulated optical effect is updated based on the visual changes in the fourth user interface object and/or adjacent user interface object that are caused by the user input. For example, as described with reference to FIG. 6N, activation of flashlight control 6418 causes the device 100 to simulate that the flashlight control 6418 emits virtual lighting effects that reflection and/or refraction (e.g., via elements 6428a-6428c) applied to one or more surrounding controls.

In some embodiments, while displaying the first user interface object in the first user interface (e.g., prior to detecting the first event, and while the first user interface object is displayed with the first appearance), wherein the first user interface object is displayed with a first simulated gap (e.g., zero spacing and/or non-zero spacing) between the first user interface object and a background of the first user interface (e.g., the platter for a container object of the first user interface object and one or more other user interface objects, and/or a wallpaper of the first user interface), the computer system detects, via the one or more input devices, a user input that is directed to the first user interface object and that meets interaction criteria (e.g., a tap gesture, a tap and hold gesture, a light press gesture, a swipe gesture, and/or another type of gesture by one or more contacts at a location corresponding to the first user interface object; an air pinch gesture, an air pinch and drag gesture, an air pinch and hold gesture detected while a user's attention is directed toward the first user interface object; a click input, a click and hold input, a click and drag input, detected while a focus selector is at the location of the first user interface object; and/or another type of user input that has a target location corresponding to the first user interface object and meets the criteria for a type of input recognized by the first user interface object). In some embodiments, the user input that meets the interaction criteria is an initial portion of a user input that corresponds to a request to expand the first user interface object, and becomes the user input that corresponds to a request to expand the first user interface object that meets one or more thresholds. In some embodiments, the user input that meets the interaction criteria is the user input that corresponds to a request to expand the first user interface object. In some embodiments, the user input that meets the interaction criteria is the user input that adjusts the first user interface object. In some embodiments, the user input that meets the interaction criteria is the user input that selects the first user interface object. In some embodiments, the user input that meets the interaction criteria is a user input that meets one of multiple sets of criteria corresponding to different types of operations associated with the first user interface object. In some embodiments, in response to detecting the user input that meets the interaction criteria, the computer system increases a simulated gap between the first user interface object and the background of the first user interface from the first simulated gap to a second simulated gap greater than the first simulated gap (e.g., the first user interface object appears to lift off from the background of the first user interface in response to detecting the user input that meets interaction criteria with respect to the first user interface object). In some embodiments, changing the simulated gap from the first simulated gap to the second simulated gap includes changing a spatial extent and/or intensity of a visual effect, such as a simulated refraction, simulated lensing effect, blur, simulated opacity, simulated color aberration, simulated shadow, and/or other simulated optical effects that are affected by the size of the simulated gap between the first user interface object and the background of the first user interface. In some embodiments, in response to detecting the user input that meets the interaction criteria, the computer system increases the simulated thickness of the user interface material of the first user interface object (e.g., by changing the simulated refraction, simulated shadow, and/or simulated specular highlight of the user interface material). Additional details regarding how the appearance of a user interface object changes in response to user input directed to the user interface object are provided with respect to FIGS. 5F-5M and accompanying descriptions, including method 8000 and method 14000. For example, as described with reference to FIG. 6N, in some embodiments, in response to detecting user input 6420 to activate flashlight control 6418, the flashlight control 6418 is displayed as lifting away from the background (e.g., by changing one or more visual properties to simulate increasing a gap between flashlight control 6418 and the background of control user interface 6401).

In some embodiments, while displaying the first user interface object in the first user interface (e.g., prior to detecting the first event, and while the first user interface object is displayed with the first appearance), the computer system detects, via the one or more input devices, a user input that is directed to the first user interface object and that meets adjustment criteria. In some embodiments, the user input that meets the adjustment criteria includes a user input that changes a state of a multi-state control that corresponds to the first user interface object. In some embodiments, the user input that meets the adjustment criteria includes a user input that changes a value of a parameter of a slider control that corresponds to the first user interface object. In one example, in some embodiments, the first user interface object is a WiFi control, a flight mode control, an orientation lock control, a flashlight control, a screen recording control, and/or other multi-state controls that changes from a first state to a second state in response to a selection input, such as a tap gesture, a click input, and/or an air pinch gesture, directed to the first user interface object. In one example, in some embodiments, the first user interface object is a volume control, a media player scrubber, a brightness control, a temperature control, and/or other adjustable controls that changes value gradually in response to a movement input, such as a swipe gesture, a click and drag input, and/or an air pinch and drag gesture, directed to a value indicator of the first user interface object. In some embodiments, in response to detecting the user input that meets the adjustment criteria, the computer system changes content included within the first user interface object from initial content to adjusted content different from the initial content (e.g., the first user interface object changes color, graphic, brightness, indicator position, and/or other visual aspects of the first user interface object to indicate a change in state and/or value of the first user interface object caused by the user input that meets the adjustment criteria, optionally, in conjunction with changing the state and/or value of the control function associated with the first user interface object). For example, as described with reference to FIGS. 6O-6P, adjusting a level of the brightness control 6438′ via user input 6442 causes the device 100 to simulate a change in virtual lighting effects (e.g., via elements 6440, 6440′, and/or 6440a-6440c) applied to one or more surrounding controls.

In some embodiments, changing the content included within the first user interface object from initial content to adjusted content, includes: in accordance the user input that meets the adjustment criteria is ongoing, displaying a first portion of the adjusted content with a first curvature; and in accordance the user input that meets the adjustment criteria has been terminated, displaying the first portion of the adjusted content with a second curvature, different from the first curvature. In some embodiments, the first user interface object is a slider control, such as a brightness control, a volume control, a scrubber, a progress bar, and/or another type of adjustable control with a value indicator that moves along a length of the slider control. In some embodiments, the user input that meets the adjustment criteria moves the value indicator along the length of the slider control, such that the value indicator indicates an adjusted value of a controlled parameter of the slider control. In some embodiments, the end portion of the value indicator is displayed with a curved edge (e.g., bulging toward the direction of movement of the value indicator and/or the direction of movement of the user input) while the user input is maintained and/or moving the value indicator; and the end portion of the value indicator is displayed with a less curved edge or straight edge when the user input is no longer maintained and/or terminated (e.g., liftoff of a contact that provides a swipe gesture, release of a pinched posture of a hand that provides an air pinch and drag gesture, release of a click input that provides a click and drag input, and/or termination of another type of user input that moves the value indicator and adjust the value of the slider control). For example, as described with reference to FIGS. 6P-6P2, the curvature of the value bar in the brightness control 6438″ is more curved while the user input 6442″ is ongoing.

In some embodiments, while displaying the first user interface object with the adjusted content, including displaying the adjusted content with a first set of values for one or more visual properties (e.g., a first set of values for the brightness, color saturation, opacity, simulated thickness, and/or other visual properties that affect the visual prominence of the adjusted content of the first user interface object) of the adjusted content (e.g., is response to the user input that meets the adjustment criteria), the computer system detects, via the one or more input devices, a termination of the user input that meets the adjustment criteria (e.g., lift off of a contact of a tap gesture, tap and hold gesture and/or swipe gesture; release of a click input and/or click and drag input; release of an air pinch gesture and/or air pinch and drag gesture; and/or termination of another type of user input); and in response to detecting the termination of the user input that meets the adjustment criteria, maintains display of the first user interface object with the adjusted content (e.g., the adjusted state and adjusted value of a parameter remain in the first user interface object), including displaying the adjusted content with a second set of values for the one or more visual properties of the adjusted content (e.g., a second set of values for the brightness, color saturation, opacity, simulated thickness, and/or other visual properties that affect the visual prominence of the adjusted content of the first user interface object), wherein the second set of values for the one or more visual properties is different from the first set of values for the one or more visual properties (e.g., even though the change in state and/or value of the parameter for the first user interface object are maintained after the termination of the user input, the enhanced visual prominence of the adjusted content in the first user interface object is reduced after the termination of the user input). For example, as described with reference to FIGS. 6O-6P, in some embodiments, while user input 6442 is maintained, a greater level of simulated virtual lighting effects is displayed as being applied to the one or more surrounding controls and after detecting an end user input 6442, the level of change in the virtual lighting effects reduces, while still maintaining display of the virtual lighting effects on the one or more surrounding controls.

In some embodiments, the first user interface includes a plurality of controls corresponding to a plurality of control functions of the computer system (e.g., the first user interface is a control user interface, or a page of a multi-page control user interface, that includes a plurality of controls); the first user interface object displayed with the first appearance is a first control among the plurality of controls displayed in the first user interface; displaying the second user interface object in response to detecting the first event includes displaying, via the one or more display generation components, a second control overlaying a platter that includes representations of at least a subset of the plurality of controls, including a representation of the first control (e.g., the first user interface is flattened into a platter that includes flattened representations of the plurality of controls, and the second control is displayed on top of the flattened platter, by itself or in a newly displayed control module). For example, initially, the first control and one or more other controls are displayed with respective simulated volumes of user interface material in a control user interface; and in response to detecting a user input directed to the control user interface (e.g., directed to the first control and/or directed another control that is concurrently displayed with the first control in the control user interface), in accordance with a determination that the user input corresponds to a request to display an expanded control module including one or more additional controls, the computer system, optionally expands the user interface material of a respective control, to display a control module or an expanded control, overlaying a platter optionally comprising the user interface material and to display representations of a plurality of controls, including the first control, on the platter without their simulated volumes of user interface material, and the computer system displays one or more controls, including the second control, that are related to the first control, with higher input priorities than the controls in the platter, and with respective simulated volumes of user interface material. For example, as described with reference to FIG. 6M, the platter 6414 is displayed as overlaying controls in the control user interface 6401.

In some embodiments, the first user interface includes a plurality of application objects (e.g., application icons, and/or application widgets) corresponding to a plurality of applications (e.g., the first user interface is a home screen user interface, a widget screen user interface, a wake screen user interface, an application library user interface, and/or another system user interface that includes application icons and/or application widgets). In some embodiments, the first user interface is a control user interface that includes a plurality of application icons corresponding to a subset of applications and a plurality of controls that corresponds to control functions of the computer system. In some embodiments, the first user interface object displayed with the first appearance is a first application icon among the plurality of application objects displayed in the first user interface. For example, when the second user interface object, such as a pop-up, an alert, a control user interface, a menu, and/or other types of user interface object, is displayed with higher input priority than the first application icon, the second user interface object overlays a portion of the first user interface, and the exposed portion of the first user interface includes one or more of the plurality of application objects, including the first application icon, where the appearance of the first application icon is changed, e.g., to have a reduced glassy appearance as compared to before the display of the second user interface object. For example, as described with reference to FIGS. 6I-6J, menu 6404 is displayed as overlaying application icon 442 and the application icon for App Store.

In some embodiments, the first user interface includes a plurality of application windows corresponding to a plurality of applications (e.g., the first user interface is a desktop that concurrently displays two or more application windows, optionally corresponding to two or more different applications); and the first user interface object displayed with the first appearance is a first application window among the plurality of application windows in the first user interface. For example, when the second user interface object, such as a second application window, is displayed with higher input priority than the first application window, the second user interface object overlays a portion of the first user interface, and the exposed portion of the first user interface includes one or more of the plurality of application windows, including the first application window, where the appearance of the first application window is changed, e.g., to have a reduced glassy appearance as compared to before the display of the second user interface object. For example, as described with reference to FIGS. 6S-6T, application window 6606′ is displayed as overlaying application window 6604′.

In some embodiments, displaying the first user interface object in the first user interface with the first appearance includes displaying, via the one or more display generation components, the first user interface object overlaying a first background of the first user interface (e.g., wallpaper of a desktop, wallpaper of the first user interface, windows and objects located behind the first user interface object in a depth direction of the first user interface, and/or other content in the first user interface); and in response to detecting the first event, the computer system modifies one or more display properties of the first background (e.g., applying a blur, fade, and/or dimming effect to the first background) to deemphasize the first background relative to the second user interface object (and, optionally, relative to the first user interface object). For example, in some embodiments, displaying at least a portion of the first user interface object in the first user interface with the second appearance, concurrently with the second user interface object, includes displaying at least the portion of the first user interface object overlaying a modified first background, where the modified first background has a reduced visibility compared to the first background. For example, as described with reference to FIG. 6M, a blur area 6422 and/or a dimmed area 6424 is displayed over portions of the background relative to the platter 6414.

In some embodiments, before detecting the first event, the computer system concurrently displays, via the one or more display generation components, the first user interface object and a plurality of user interface objects in the first user interface, the plurality of user interface objects including a first subset of one or more user interface objects and a second subset of one or more user interface objects (e.g., the first user interface includes a plurality of user interface objects, including the first user interface object, a first subset of user interface objects near the location where the second user interface object will be displayed, and a second subset of user interface objects farther away from the location where the second user interface object will be displayed), wherein, while the first user interface object is displayed with the first appearance, the plurality of user interface objects are displayed with respective first appearances based the first set of one or more values for the one or more simulated parameters of the user interface material (e.g., the plurality of user interface objects are displayed with glassy appearances to indicate that they have the same input priority as the first user interface object before the first event). In some embodiments, in response to detecting the first event, while displaying the first user interface object with the second appearance, the computer system: maintains the respective first appearances of the first subset of one or more user interface objects; and changes the respective first appearances of the second subset of one or more user interface objects to respective second appearances based on the second set of one or more values for the one or more simulated parameters of the user interface material (e.g., deemphasized relative to the first appearance of the first user interface object, and deemphasized relative to the currently appearance of the second user interface object) different from the first set of one or more values for the one or more simulated parameters of the user interface material. In some embodiments, in response to detecting the first event, while displaying the first user interface object with the second appearance, the computer system changes the respective first appearances of the second subset of one or more user interface objects to respective third appearances based on a third set of one or more values, different from the first set of one or more values and the second set of one or more values, for the one or more simulated parameters of the user interface material (e.g., less deemphasized than the first user interface object or more deemphasized than the first user interface object). For example, in some embodiments, some of the user interface elements in the first user interface that are close to the second user interface object are deemphasize (e.g., darkened, blurred and/or have a reduced glassy appearance) by a greater amount, while some of the user interface elements in the first user interface that are farther away from the second user interface object are deemphasized by a lesser amount (e.g., less darkened, less blurred, and/or have a more prominent glassy appearance). For example, as described with reference to FIGS. 6Q-6R, in some embodiments, the blur area 6422′ is applied to a portion of the underlying application icons closer to the control center overlay, without being applied (e.g., or being applied to a lesser degree) to application icons that are father from the control center overlay.

In some embodiments, while concurrently displaying the second user interface object, the first user interface object with the second appearance, the first subset of one or more user interface objects with the respective first appearances, and the second subset of one or more user interface objects with the respective second appearances (e.g., while displaying the first user interface with first user interface object and the second subset of user interface objects deemphasized relative to the second user interface object, but with the first subset of user interface objects not deemphasized relative to the second user interface object), the computer system detects, via the one or more input devices, a first user input directed toward a location corresponding to the first subset of one or more user interface objects (e.g., a location of a user interface object among the first subset of one or more user interface objects or an area between an adjacent pair of user interface objects among the first subset of one or more user interface objects, where the first subset of one or more user interface objects are not deemphasized relative to the second user interface object); and in response to detecting the first user input, ceases to display the second user interface object with the higher input priority. In some embodiments, the computer system, in response to detecting the first user input, redisplays the first user interface object with the first appearance, and, optionally, redisplays the first subset of one or more user interface objects and the second subset of one or more user interface objects with their respective first appearances, without performing an operation corresponding to the any of the first subset of one or more user interface objects. For example, in some embodiments, user interaction (e.g., tap, selection, swipe, and/or other types of user input) directed to the region that is less deemphasized (e.g., the region occupied by the first subset of one or more user interface objects) causes the computer system to dismiss the second user interface object and/or put the second user interface object into the background of the first user interface object. For example, as described with reference to FIG. 6M, in response to detecting a user input 6426 directed to an area outside of blur area 6422, the platter 6414 is dismissed.

In some embodiments, while concurrently displaying the second user interface object, the first user interface object with the second appearance, the first subset of one or more user interface objects with the respective first appearances, and the second subset of one or more user interface objects with the respective second appearances (e.g., while displaying the first user interface with first user interface object and the second subset of user interface objects deemphasized relative to the second user interface object, but with the first subset of user interface objects not deemphasized relative to the second user interface object), the computer system detects, via the one or more input devices, a second user input; and in response to detecting the second user input, in accordance with a determination that the second user input is directed toward a location corresponding to a user interface object from the first subset of one or more user interface objects (e.g., while displaying the first user interface with first user interface object and the second subset of user interface objects deemphasized relative to the second user interface object, but with the first subset of user interface objects not deemphasized relative to the second user interface object), performs an operation corresponding to the user interface object from the first subset of one or more user interface objects. In some embodiments, the computer system, in response to detecting the second user input and in accordance with a determination that the second user input is directed toward a location corresponding to a user interface object from the first subset of one or more user interface objects, ceases to display the second user interface object with the higher input priority. In some embodiments, the computer system, in response to detecting the second user input and in accordance with a determination that the second user input is directed toward a location corresponding to a user interface object from the first subset of one or more user interface objects, forgoes displaying the first user interface object with the first appearance (and, optionally, forgoing displaying the first subset of one or more user interface objects and the second subset of one or more user interface objects with their respective first appearances). For example, in some embodiments, user interaction (e.g., tap, selection, swipe, and/or other types of user input) directed to the region that is less deemphasized (e.g., the region occupied by the first subset of one or more user interface objects) causes the computer system to perform an operation corresponding to a user interface object that is the target of the user interaction. For example, as described with reference to FIG. 6Q, in response to detecting a user input directed outside of blur area 6422′ that is directed to application icon 416, the computer system performs an operation associated with the application icon 416, such as displaying a user interface for a phone application.

In some embodiments, in response to detecting the second user input, in accordance with a determination that the second user input is directed toward a location corresponding to the first user interface object or the second subset of one or more user interface objects, the computer system forgoes performing an operation corresponding to the first user interface object or a user interface object from the second subset of one or more user interface objects. In some embodiments, the computer system, in response to detecting the second user input and in accordance with the determination that the second user input is directed toward a location corresponding to the first user interface object or the second subset of one or more user interface objects, ceases to display the second user interface object with the higher input priority. In some embodiments, the computer system, in response to detecting the second user input and in accordance with a determination that the second user input is directed toward a location corresponding to the first user interface object or the second subset of one or more user interface objects, performs an operation corresponding to the second user interface object. For example, in some embodiments, user interaction (e.g., tap, selection, swipe, and/or other types of user input) directed to the region that is more deemphasized (e.g., the region occupied by the first user interface object and the second subset of one or more user interface objects) causes the computer system to perform an operation corresponding to a second user interface object, and/or dismisses the second user interface object. For example, as described with reference to FIG. 6M, in response to detecting a user input 6420′ directed to the flashlight control 6418, while the flashlight control 6418 is included in blur area 6422, the device 100 forgoes toggling the flashlight control 6418 on and/or off (e.g., forgoes performing an operation associated with the flashlight control 6418).

In some embodiments, while the first user interface object is displayed with the second appearance, the second subset of one or more user interface objects includes at least one user interface object that is displayed with a respective third appearance based on the third set of one or more values, different from the first set of one or more values and the second set of one or more values, for the one or more simulated parameters of the user interface material (e.g., the first user interface object and at least one user interface objects from the second subset of user interface objects are displayed with different amounts of deemphasis relative to their original appearances). For example, in some embodiments, the deemphasizing applied to the user interface objects in the first user interface is non-uniform (e.g., less blurring, less darkening, and/or less reduction in glassy appearance on one portion of the first user interface than other portions of the first user interface that are further from the second user interface object). For example, as described with reference to FIG. 6M and FIG. 6Q, the blur area 6422 and blur area 6422′ is a variable blur area that optionally does not cover the entire display area, such that a subset of the one or more controls and/or application icons are less blurred, or not blurred that other controls and/or application icons.

In some embodiments, the second appearance of the first user interface object that is based on the second set of values for the one or more simulated parameters of the user interface material corresponds to a first amount of blur and a first amount of dimming applied to the first appearance of the first user interface object; and the respective third appearance of the at least one user interface object from the second set of user interface objects, that is based on the third set of one or more values for the one or more simulated parameters of the user interface material, corresponds to: a second amount of blur different from the first amount of blur, and a respective amount of dimming, applied to the respective first appearance of the at least one user interface object from the second set of user interface objects that varies from the first amount of dimming by an amount that is less than the amount of variation between the first amount of blur and the second amount of blur. In some embodiments, the respective amount of dimming is the same as the first amount of dimming. For example, in some embodiments, the deemphasis applied to the user interface objects that are concurrently displayed with the second user interface object but with lower input priority, includes a dimming effect and a blur effect applied to the user interface objects, where dimming effect is uniformly (or substantially uniformly) applied across the user interface objects and their surrounding regions, but the blur effect is spatially variable (e.g., more blurred closer to where the second user interface object is located). For example, as described with reference to FIG. 6M, the blur area 6422 is a variable blur area, such as a gradient, while the dimmed area 6424 is applied uniformly to the background.

In some embodiments, the first user interface includes the first user interface object, the plurality of user interface objects, and a plurality of object placement locations that are currently vacant (e.g., not currently occupied by any user interface object, but can be occupied by a user interface object that is inserted into the first user interface and/or moved from another occupied placement location, in the editing mode of the first user interface). In some embodiments, while the first user interface object is displayed with the second appearance (and, optionally, the second subset of one or more user interface objects are displayed to the same amount of deemphasis as the first user interface object, less deemphasized than the first user interface object, and/or more deemphasized than the first user interface object), the computer system detects, via the one or more input devices, a user input that corresponds to a request to enter an editing mode of the first user interface (e.g., a touch and hold gesture directed to the first user interface, a tap gesture selecting an option to edit the first user interface from a menu, and/or other types of inputs that corresponds to a request to enter the editing mode of the first user interface); and in response to detecting the user input that corresponds to the request to enter the editing mode of the first user interface, displays, via the one or more display generation components, the plurality of object placement locations that are currently vacant with a deemphasis effect (e.g., when in the editing mode, the plurality of object placement locations are visually indicated by an outline or with a glass material, and the placement locations are blurred and dimmed when the second user interface object is displayed with higher input priority). For example, in some embodiments, the computer system increases the extent of the deemphasized region when entering an edit mode (e.g., to encompass additional placement locations that do not yet include a user interface object). In some embodiments, the first user interface in the editing mode allows the user to move, delete, and/or add user interface objects to the first user interface (e.g., application icons and application widgets in the home screen user interface, and/or controls, application icons, and shortcuts in the control user interface), in the object placement locations in the first user interface. For example, as described with reference to FIG. 6R, while displaying an edit mode for the control center overlay, the blur area 6422″ is increased in size compared to blur area 6422′ (e.g., in FIG. 6Q).

In some embodiments, prior to displaying the first user interface including the first user interface object with the first appearance (e.g., prior to displaying the control user interface including a first control with the glassy appearance), the computer system displays, via the one or more display generation components, a second user interface different from the first user interface (e.g., the second user interface is a home screen user interface, or another system user interface such as a widget user interface, a wake screen user interface, or an application library user interface); while displaying the second user interface, detects, via the one or more input devices, a user input that corresponds to a request to display the first user interface (e.g., a downward swipe gesture directed to an upper right corner of the second user interface, an upward swipe gesture directed to a bottom edge of the display area displaying the second user interface, and/or other types of user inputs that correspond to a request to display the first user interface); and in response to detecting the user input that corresponds to the request to display the first user interface, displays, via the one or more display generation components, the first user interface overlaying the second user interface (e.g., the user interface elements in the second user interface are deemphasized, e.g., dimmed, blurred, and with the user interface elements having reduced glassy appearances, when the first user interface is displayed with its user interface elements having the higher input priority relative to the user interface elements of the second user interface). For example, in some embodiments, the first user interface including the first user interface object and the plurality of user interface objects with their respective first appearances that are not deemphasized, is displayed in response to a user input (e.g., an edge swipe gesture, an edge press input, a click and drag input directed to a predefined portion of the display area, and/or other types of system gestures and/or inputs) directed to a system user interface (e.g., a home screen user interface, a wake screen user interface, an application library user interface, and/or other types of system user interfaces), and/or an application user interface. In some embodiments, the first user interface is a control user interface that includes a plurality of controls, and is displayed overlaid on the system user interface and/or application user interface. For example, as described with reference to FIGS. 6I-6L, the control user interface 6410 is displayed in response to detecting user input 6406 as overlaying the system user interface illustrated in FIG. 6I.

In some embodiments, the first user interface including the first user interface object with the first appearance is a system user interface (e.g., a home screen user interface including application icons with glassy appearances); displaying the second user interface object with the higher input priority than the input priority of the first user interface object includes displaying, via the one or more display generation components, a control user interface including the second user interface object, overlaying the first user interface including the first user interface object with the second appearance (e.g., the control user interface is overlaid on the home screen user interface, and the controls in the control user interface are displayed with glassy appearances and higher input priority than the application icons in the home screen user interface); and detecting the first event includes detecting a system gesture directed to the system user interface (e.g., a downward edge swipe gesture directed to a corner of the home screen user interface, an upward edge swipe gesture directed to the bottom edge of the home screen user interface, and/or other types of system gesture that corresponds to a request to display the control user interface). For example, as described with reference to FIG. 6K, the control user interface 6410 is displayed in response to detecting user input 6406 and the application icons displayed in the system user interface are visually deemphasized (e.g., with a reduced simulated glassy appearance).

In some embodiments, the second user interface object is displayed with an appearance based on the first set of values for the one or more simulated parameters of a user interface material. For example, the control user interface 6410 includes controls that are displayed with a simulated glass material, including having values for parameters described with reference to the simulated user interface material in FIGS. 6A-6C.

In some embodiments, the first user interface includes a plurality of controls corresponding to a plurality of control functions of the computer system; the first user interface object displayed with the first appearance is a first control among the plurality of controls displayed in the first user interface. In some embodiments, the computer system detects a user input directed to the first control that corresponds to a request to resize the first control in the first user interface; and In some embodiments, the user input is a drag gesture (e.g., by one or more contacts) directed to a resize handle, a corner, and/or edge of the first control and moving toward or away from a current location of the first control, while the first control is in a reconfiguration mode (e.g., when the control user interface is in the reconfiguration mode). In some embodiments, other types of resizing input, such as an air pinch and drag gesture, a click and drag input, and/or another type of movement input that is directed to a resize handle, corner, and/or edge of the first control, are, optionally, used as alternatives to the drag gesture. In some embodiments, in response to detecting the user input directed to the first control that corresponds to a request to resize the first control in the first user interface, the computer system: in accordance with a determination that a size of the first control is increased by more than a threshold amount of increase (e.g., more than 20%, 50%, 100%, 120%, or another amount, above the original size of the first control), displays two or more placement locations (e.g., two placement locations in the same row, and/or two placement locations in the next row; a whole row of placement locations; and/or another group of placement locations of the original size of the first control or a unit placement location size) near (e.g., adjacent to and/or partially underneath) the first control merging (e.g., displaying the merging with a first animated transition that progresses over time); and in accordance with a determination that the size of the first control is decreased by more than a threshold amount of decrease, displaying a placement location (e.g., a large placement location of the original size of the first control) near (e.g., adjacent to the first control and/or partially underneath the first control) splits (e.g., displays the splitting with an a second animated transition, different from the first animated transition that progresses over time) into two or more placement locations (e.g., two smaller placement locations in the same row, and/or two smaller placement locations in the next row; a whole row of smaller placement locations; and/or another group of smaller placement locations that make up the original size of the first control) that are near (e.g., adjacent to and/or at least partially underneath) the first control. In some embodiments, the user interface material of the first control is expanded or split into multiple portions, with reduced simulated thickness and/or glassy appearance of the user interface material during the expansion and/or splitting of the user interface material. For example, as described with reference to FIGS. 6R-6R2, the calculator control is expanded, including displaying an animated transition that merges the placeholders 6431 that are adjacent to the calculator control, in response to detecting the user input 6435. In some embodiments, decreasing a size of the calculator control includes displaying a reverse of the animation described with reference to FIGS. 6R-6R2, including splitting or dividing the large calculator control into placeholders 6431.

In some embodiments, while the first user interface object has current input focus, the first user interface object is displayed with the first appearance based on the first set of one or more values for the one or more simulated parameters of the user interface material; the first set of one or more values for the one or more simulated parameters of the user interface material corresponds to a first variant of the user interface material associated with objects with current input focus (e.g., a type of active glass material, with higher visual prominence and used to distinguish an object with current input focus from other user interface objects that are concurrently displayed without current input focus). In some embodiments, in response to detecting the first event, the second user interface object has current input focus, and the first user interface object does not have current input focus; while the second user interface object has current input focus and the first user interface object does not have current input focus, at least a portion of the first user interface object is displayed with the second appearance based on the second set of values for the one or more simulated parameters of the user interface material (and, optionally, the second user interface object is displayed with a respective appearance based on the first set of one or more values for the one or more simulated parameters of the user interface material); and the second set of one or more values for the one or more simulated parameters of the user interface material corresponds to a second variant of the user interface material associated with objects without current input focus (e.g., a type of inactive and/or subdued glass material, with lower visual prominence and used to distinguish objects without current input focus from an object with current input focus). Additional details regarding the difference between the parameters of the first variant of the user interface material for objects with current input focus, and the parameters of the second variant of the user interface material for objects without current input focus are provided in rows 2-3 of Table 1, in accordance with some embodiments. For example, as described with reference to FIGS. 5I1-5I4, the user interface element 5002 is displayed with a simulated glass material while the user interface element 5002 is currently selected, and the other user interface elements that are not currently selected are displayed without the simulated glass material (e.g., or with values of parameters to appear less glassy than the selected user interface element 5002). In some embodiments, the parameters of the simulated glass material while the user interface element 5002 is selected are modified according to the properties (e.g., size and/or type) of the user interface element 5002, as indicated in Table 1 (e.g., opacity of selection state and/or opacity of indication of attention in selection state.

It should be understood that the particular order in which the operations in FIG. 16 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 13000, 14000, 15000, 17000, 18000, 19000, and/or 20000) are also applicable in an analogous manner to method 16000 described above with respect to FIG. 16. For example, the buttons, user interfaces, controls, visual deemphasis, virtual effects, described above with reference to method 16000 optionally have one or more of the characteristics of the buttons, user interfaces, controls, visual deemphasis, virtual effects, described herein with reference to other methods described herein (e.g., methods 7000, 8000, 9000, 10000, 11000, 12000, 13000, 14000, 15000, 17000, 18000, 19000, and/or 20000). For brevity, these details are not repeated here.

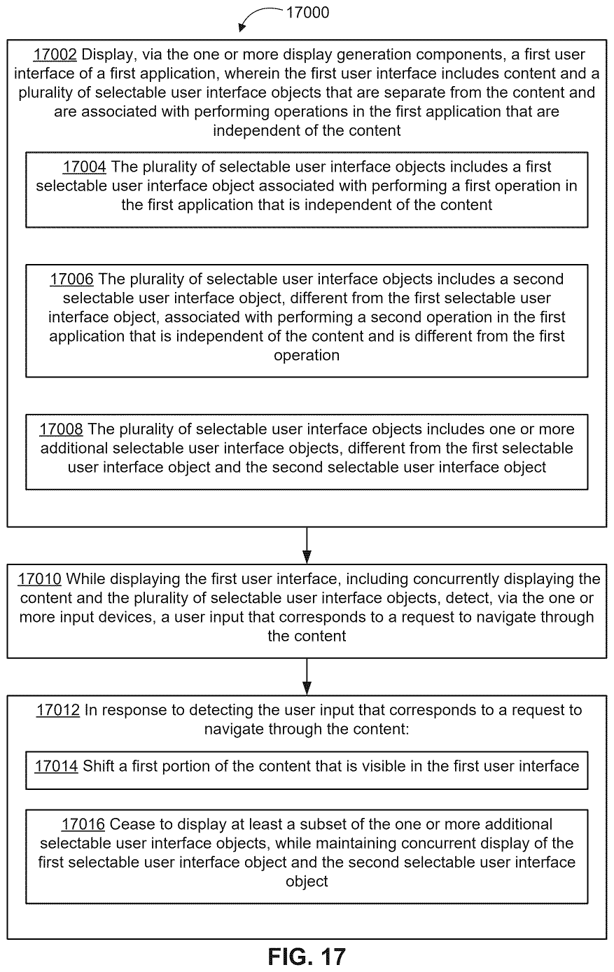

FIG. 17 is a flow diagram illustrating a method 17000 of displaying and/or condensing sets of controls in accordance with some embodiments. In some embodiments, the method 17000 is performed at a computer system (e.g., portable multifunction device 100, device 300 in FIGS. 1A-6AP) that is in communication with one or more input devices (e.g., touch-sensitive surfaces, optical sensors, motion sensors, proximity sensors, gyros, accelerometers, ambient light sensors, joysticks, buttons, keyboards, handheld controllers, pointer devices, and/or other types of input devices) and one or more display generation components (e.g., touch-screen displays, standalone displays, LED displays, LCD displays, head-mounted displays, heads-up displays, foldable displays, flexible displays, and/or other types of display generation components that provides one or more display areas in which content, user interfaces, and/or controls can be made visible to a user). Some operations in method 14000 are, optionally, combined and/or the order of some operations is, optionally, changed.

Automatically updating a set of selectable elements displayed in a user interface in response to a user input to navigate content of the user interface, including ceasing to display one or more selectable elements of the set of selectable elements while maintaining display of other selectable elements provides improved visual feedback to the user by increasing available display area to view the content of the user interface while continuing to provide control options (e.g., via the maintained selectable elements) to the user. Maintaining the selectable elements as a collapsed version and enabling a user to expand collapsed version to access additional selectable elements provides additional control options that are accessible even as the user scrolls through content, without requiring additional user inputs to navigate elsewhere (e.g., to another user interface and/or to an originally displayed user interface that displayed the set of selectable elements) in order to access the additional selectable elements options, which saves energy and improves battery life.

The computer system displays (17002), via the one or more display generation components, a first user interface of a first application (e.g., a full-screen user interface, a user interface displayed in a window, a user interface of a system application, and/or a user interface of a user application), wherein the first user interface includes content (e.g., a first media content, second media content, a first listing of content items, a second listing of content items, first document, a second document, a first webpage, a second webpage, a first listing of communications, a second listing of communications, a first written communication, a second written communication, a first image, a second image, a first map, a second map, and/or other instances of content of a respective content type associated with the application) and a plurality of selectable user interface objects that are separate from the content (e.g., at least some of the selectable user interface objects overlaying portions of the content, and/or at least some of the selectable user interface objects do not overlap with the content) and are associated with performing operations in the first application that are independent of the content, In some embodiments, the plurality of selectable user interface objects are objects provided by the first application and that are displayed in the user interface independent of the exact content that is currently displayed in the first user interface, and/or are displayed concurrently with any instance of content of a plurality of instances of content of different content types and/or a plurality of instances of content of a respective content type associated with the first application (e.g., as the instance of content is displayed in response to a user input that corresponds to a request to display the instance of content in the first user interface. In some embodiments, the plurality of selectable user interface objects optionally includes one or more user interface objects that include textual and/or graphic labels that identify the currently displayed content. In some embodiments, the first application is a media player application. In some embodiments, the first application is a web browser application. In some embodiments, the first application is a file management application. In some embodiments, the first application is a media library application. In some embodiments, the first application is a communication application. For example, as described with reference to FIGS. 6U-6AN, a user interface 6700 for a music application is displayed that includes a first set of media player control options and content that includes representations of a plurality of content items.

The plurality of selectable user interface objects includes: a first selectable user interface object (17004) associated with performing a first operation in the first application that is independent of the content (e.g., selection of the first selectable user interface object by a user input that meets selection criteria, causes the computer system to perform the first operation in the application, based on the programming instructions of the application, and independent of the subject matter included in the content and/or independent of which portion of the content is currently visible in the first user interface); For example, as described with reference to FIG. 6U, the first set of media player control options includes media playback bar 6702.

The plurality of selectable user interface objects includes: a second selectable user interface object, (17006) different from the first selectable user interface object, associated with performing a second operation in the first application that is independent of the content and is different from the first operation (e.g., selection of the second selectable user interface object by a user input that meets selection criteria, causes the computer system to perform the second operation in the first application, based on the programming instructions of the first application, and independent of the subject matter included in the content and/or independent of which portion of the content is currently visible in the first user interface). In some embodiments, a respective operation that is independent of the content includes an operation that is performed in the same manner on the content independent of what the content includes and which portion of the content is currently visible (e.g., bookmark operation, search operation, navigation operation, close operation, and/or other types of operations that may or may not affect the display of the content but is consistently applied independent of what the content currently includes and/or which portion of the content is currently visible), and/or includes an operation that is unrelated to the content (e.g., navigating to a home page, navigate to a respective folder of content, navigate to a media library user interface, navigating to a search user interface, entering search criteria for a search, composing a new message, and/or other operations that is performed independent of the content). For example, as described with reference to FIG. 6U, the first set of media player control options includes a page menu 6704.

The plurality of selectable user interface objects includes: one or more additional selectable user interface objects (17008), different from the first selectable user interface object and the second selectable user interface object (e.g., the one or more additional user interface objects are associated with performing one or more additional operations in the first application that are independent of the content). In some embodiments, the first application displays a plurality of selectable user interface objects as part of the first user interface when content is displayed in the first user interface, and the plurality of selectable user interface objects are displayed independent of what content is displayed in the first user interface and/or which portion of the content is currently visible. In some embodiments, the plurality of selectable user interface objects includes controls and affordances for controlling navigation between content and user interfaces, performing system and/or application functions, adjusting parameters of how operations are performed by the computer system, and/or other controls and/or affordances that correspond to functions that are triggered by user inputs directed toward the controls and affordances. In some embodiments, the content displayed in the first user interface occupies all or portions of the first user interface and all or portions of the display area provided via the one or more display generation components, and is not directly visible at the locations where the plurality of selectable user interface objects are displayed. In some embodiments, the content displayed in the first user interface corresponds to different regions or subsets of a single piece of content (e.g., different pages of a scrollable document, different sections of a scrollable listing of messages, and/or different portions of a zoomable and scrollable map). In some embodiments, the plurality of selectable user interface objects (e.g., including the first selectable user interface object, the second selectable user interface object, and the one or more additional selectable user interface objects) includes user interface objects arranged in one or more container objects with a respective container object containing a respective subset of two or more of the plurality of user interface objects. In one example, the container objects include a tool bar that includes a row or two adjacent rows of icons corresponding to different tool functions. In some embodiments, a group of user interface objects may be displayed with a shared set of visual characteristics and/or background material, but does not allow the group to be manipulated as a whole by a user input directed to one of the user interface objects of the group. In some embodiments, a group of user interface objects from the plurality of user interface objects includes user interface objects that are arranged on a shared background platter, such as a title bar that includes a title of displayed content, a search input field, and/or other controls related to the displayed content and/or user interface (e.g., close affordance, minimize affordance, application icon associated with the displayed content and/or user interface). In some embodiments, a group of user interface objects from the plurality of user interface objects include a plurality of section headers and/or section controls that are located in different portions of the first user interface separating different sections of the first content, where the section headers and/or section controls are identified as belonging to the same group based on their consistent appearance and/or visual characteristics. In some embodiments, the plurality of user interface objects includes user interface objects that are arranged into respective groups with respective group layouts (e.g., a group of objects arranged in a single row with consistent spacing in between, a group of objects arranged in a grid with consistent spacing in between, and/or a group arrangement in another group layout that is visually distinguished from regions that do not belong to the group layout). In one example, a group of user interface objects is a row of tabs that correspond to different categories and/or pages of content that are not all concurrently displayed at a given time, where the row of tabs is displayed with a consistent arrangement that visually distinguishes the tabs from other types of content and/or other types of objects in the first user interface. For example, as described with reference to FIG. 6U, the first set of media player control options includes a search control 6706.

While displaying the first user interface, including concurrently displaying the content (e.g., first content, second content, or third content different from the first content and the second content) and the plurality of selectable user interface objects, the computer system detects (17010), via the one or more input devices, a user input that corresponds to a request to navigate through the content (e.g., a request to navigate to other portions within the content, as opposed to navigate away from the content to another user interface different from the first user interface, or navigate to other content that is different from the currently displayed content). In some embodiments, the user input that corresponds to a request to navigate through the content includes a user input that scrolls the content in the first user interface, including moving a portion of the content out of the visible area of the first user interface, and moving another portion of the content into the visible area of the first user interface, optionally in a scroll direction that corresponds to a movement direction of the user input. In some embodiments, the user input that corresponds to a request to navigate through the content includes a user input that changes a zoom level of the content in the first user interface, and/or shift a center of focus of the content in the first user interface, including zooming into a portion of the content that was already displayed in the visible area of the first user interface, zooming out to bring in additional portions of the content that was outside of the visible area of the first user interface, and/or shifting the content to move some portions of the content out of the visible area and move some portions of the content into the visible area of the first user interface. In some embodiments, the user input that corresponds to a request to navigate through the content includes: a selection input that is directed to a navigation control (e.g., a tap input on an up arrow or down arrow on a scroll bar), a drag input that drags a scrubber on the scroll bar, a drag input directed to a portion of the content that scrolls the content in a scroll direction of the content (e.g., vertical direction, horizontal direction, upward, downward, leftward, and/or rightward) that corresponds to the movement direction of the drag input, a selection input on a zoom control and/or a pinch/depinch gesture on the respective content to zoom into or zoom out of the currently visible portion of the content, and/or other types of inputs that corresponds to requests to navigate through the content, as opposed to navigate to other content different from the currently displayed content. For example, as described with reference to FIG. 6V, the device 100 detects user input 6712.

In response to detecting the user input that corresponds to a request to navigate through the content (17012), the computer system: shifts (17014) a first portion of the content (e.g., shifting a first portion of the first content when first content is the currently displayed content, shifting a first portion of the second content when the second content is the currently displayed content, shifting a first portion of the third content when the third content is the currently displayed content) that is visible in the first user interface (e.g., shifting the first portion of the content due to scrolling and/or zooming). In some embodiments, the computer system also moves a second portion of the content adjacent the first portion of the content out of a visible region of the first user interface (e.g., due to scrolling and/or zooming), and/or moves a third portion of the content adjacent the first portion of the content into the visible region of the first user interface (e.g., due to scrolling and/or zooming). For example, as described with reference to FIG. 6V, the representations of content items are scrolled upward in the user interface 6700 in response to detecting the user input 6712.

In response to detecting the user input that corresponds to a request to navigate through the content (17012), the computer system ceases (17016) to display at least a subset of the one or more additional selectable user interface objects (e.g., ceasing to display one or more selectable user interface objects from a first group of selectable user interface objects and ceasing to display one or more selectable user interface objects from a second group of selected user interface objects), while maintaining concurrent display of the first selectable user interface object and the second selectable user interface object (e.g., concurrently displayed with the content, resulted from the shifting of the first portion of the content due to scrolling and/or zooming the content, and/or concurrently displayed with one or more selectable user interface objects from the one or more additional selectable user interface objects that are not removed from display). In some embodiments, the selectable user interface objects that are maintained in the first user interface after ceasing to display at least the subset of the one or more additional selectable user interface objects include at least some user interface objects that were included in the same group before the detection of the user input. For example, in some embodiments, the first selectable user interface object and the second selectable user interface objects are objects in the same group (e.g., arranged in the same row, included in the same container, and/or are of the same object type). In some embodiments, the selectable user interface objects that are maintained in the first user interface after ceasing to display at least the subset of the one or more additional selectable user interface objects include selectable user interface objects that were included in different groups before the detection of the user input (e.g., included in different rows, included in different containers, and/or are of different object types). For example, in some embodiments, the first selectable user interface object and the second selectable user interface objects were objects in different groups (e.g., included in different rows, included in different containers, and/or are of different object types) prior to detecting the user input. In some embodiments, the selectable user interface objects that remain in the first user interface after ceasing to display at least the subset of the one or more selectable user interface objects optionally move and/or change appearance in the first user interface to form a new group of user interface objects in the first user interface. For example, in some embodiments, the first selectable user interface object, the second selectable user interface object, and/or one or more selectable user interface objects from the additional selectable user interface objects that remain displayed in the first user interface, move and rearrange in the first user interface to form a new group in the first user interface in response to the user input (e.g., arranged into a single row and/or a cluster that has a smaller and more consolidated footprint than their previous positions and appearances). In some embodiments, at least a subset of the selectable user interface objects displayed in the first user interface cease to be displayed and/or are rearranged into a more consolidated state, in response to a user input that corresponds to a request to navigate through the content, in order to increase the display area available for displaying the content and allow the user to view the content with reduced visual clutter in the display area. For example, as described with reference to FIG. 6V, the device 100 ceases display of the media playback bar 6702, the expanded page menu 6704, and/or the expanded version of search control 6706.

In some embodiments, the plurality of selectable user interface objects includes one or more content navigation objects (e.g., a “back” button to navigate a previously displayed document or webpage in a backward direction, a “forward” button to navigate to a previously displayed document in a forward direction, a first section header to navigate to a first section corresponding to the first section header, a second section header to navigate to a second section corresponding to the second section header, a first tab to navigate to a first document, folder, and/or content page, a second tab for navigating to a second document, folder, and/or content page). In some embodiments, the first user interface is a user interface of a media player application, and the plurality of selectable user interface objects includes a “home” control for navigating to a start page of media items, a “new” control for navigating to a recommendation page of media items, a “radio” control for navigating to a radio program page, a “library” control for navigating to a media library page, a search control for invoking a search input field and a media search page, a media playback controller including one or more media playback controls and now-playing information. The content that is currently displayed in the first user interface includes a page of media content that corresponds to a currently selected user interface object among the plurality of selectable user interface object (e.g., home page for currently selected “home” control, recommendation page for currently selected “new” control, radio program page for currently selected “radio” control, library page for currently selected “library” control, and search page for currently selected “search” control). In some embodiments, while displaying the first user interface, including the content and the plurality of selectable user interface objects, the computer system detects, via the one or more input devices, a first user input that is directed toward a respective content navigation object of the one or more navigation objects (e.g., a user input that corresponds to a request to navigate away from the currently displayed content to other content; and/or a user input that is different from the user input that corresponds to a request to navigate through the content). In some embodiments, the first user input includes a tap gesture, a tap and hold gesture, a light press gesture, a swipe gesture performed with one or more contacts detected at a location corresponding to the respective content navigation object. In some embodiments, the first user input includes an air pinch gesture, an air pinch and hold gesture, an air pinch and drag gesture detected while a user's attention (e.g., determined based on gaze, location of input focus, and/or location of focus selector) is directed to the respective content navigation object. In some embodiments, the first user input includes a click input, a click and hold input, a click and drag input, and/or an alternative click input, detected while a pointer or focus selector is at a location corresponding to the respective content navigation object. In some embodiments, in response to detecting the first user input that is directed toward the respective content navigation object of the one or more content navigation objects, the computer system: replaces display of the content with first alternative content (e.g., another document, another webpage, another section, another folder, and/or other alternative content that replaces display of the currently displayed content in the first user interface, as active content and/or foreground content of the first user interface) that is different from the content (e.g., the first alternative content is content corresponding to the respective content navigation object, and/or content that is selected based on the respective content navigation object), and concurrently displays the first alternative content and the plurality of user interface objects in the first user interface (e.g., the plurality of selectable user interface objects do not change when the content switches out to other alternative content). In some embodiments, there are two or more content navigation objects; and in accordance with a determination that the respective content navigation object is a first navigation object, the computer system replaces the currently displayed content with content that corresponds to the first navigation object (e.g., a first webpage corresponding to a first tab or section header, communications in a first mailbox, messages in a first communication chain, and/or a first document or note), and in accordance with a determination that the respective content navigation object is a second navigation object, the computer system replaces the currently displayed content with content that corresponds to the second navigation object (e.g., a second webpage corresponding to a second tab or section header different from the first webpage, communications in a second mailbox different from the communications in the first mailbox, messages in a first communication chain different from the messages in the second communication chain, and/or a second document or note different from the first document or note). In some embodiments, for the case where the plurality of selectable user interface objects includes navigation controls such as the “home” control, the “new” control, the “radio” control, the “library control,” and the “search” control, selection of a respective navigation control causes the computer system to navigate to the content page corresponding to the selected control, while continuing the maintain display of the plurality of selectable user interface objects (and optionally, changes the selection states of the previously selected control and the newly selected control). For example, as described with reference to FIGS. 6AB-6AD, in response to detecting user input 6726, the device 100 navigates to other pages of the media player application (e.g., from a home user interface to a library user interface).

In some embodiments, displaying the plurality of selectable user interface objects includes concurrently displaying an indication of currently displayed content (e.g., a header, text, icon, URL, glyph, and/or other types of indication that identifies the currently displayed content) with the one or more content navigation objects (e.g., tabs and headers of alternative content that are not currently displayed but can be displayed in the first user interface when selected). In some embodiments, the indication of currently displayed content and the one or more content navigation objects are displayed in the same container object or in the same group of objects with consistent appearances, but with the object corresponding to the content with a selected appearance while the objects corresponding to other alternative content with an unselected appearance. In some embodiments, the indication of current displayed content remains displayed (e.g., optionally, with a changed appearance and/or a transformed appearance) when at least the subset of the one or more additional selectable user interface object, including the one or more content navigation objects, ceases to be displayed in response to detecting the user input that corresponds to the request to navigate through the content. In some embodiments, the indication of currently displayed content corresponds to the content when the content is displayed in the first user interface (e.g., the tab or header of the content is displayed with a selected appearance and/or position, to indicate the identity of the content as the currently displayed content); and the indication of currently displayed content corresponds to the first alternative content (e.g., the tab or header of the first alternative content is displayed with a selected appearance and/or position, to indicate the identity of the first alternative content as the currently displayed content) when the first alternative content is displayed in the first user interface (e.g., in response to the first user input that is directed toward the respective content navigation object of the one or more content navigation objects). In some embodiments, when replacing display of the content with the first alternative content, the navigation object corresponding to the content ceases to be displayed with a selected appearance (e.g., reducing visual prominence of the section header or tab of the content, by repositioning, shrinking, darkening, making more translucent, and/or removing a visual emphasis on, the section header or tab of the content), the navigation object corresponding to the first alternative content becomes displayed with the selected appearance (e.g., increasing visual prominence of the section header or tab of the first alternative content, by repositioning, enlarging, brightening, making more opaque, and/or adding a visual emphasis on, the section header or tab of the first alternative content). In one example, in some embodiments, the content includes a first webpage or first document, and the plurality of user interface objects include at least a plurality of tabs corresponding to different webpages or documents, including a first tab corresponding to the first webpage or document and one or more other tabs corresponding to other webpages or documents. In response to detecting the user input that scrolls the first webpage or document, the computer system ceases to display the one or more other tabs corresponding to the other webpages or documents, scrolls the first webpage, and displays an indication of the first tab to indicate that the first webpage or document is the currently displayed web page or document. In one example, in some embodiments, the content includes a content page of a media player, and the plurality of user interface objects include at least a plurality of navigation controls corresponding to different content pages of the media player, including a “home” control corresponding to the home page, a “radio” control corresponding to a radio program page, a “new” control corresponding to a recommendation page, and a “podcast” page corresponding to a podcast page. In response to detecting the user input that scrolls the currently displayed home page, the computer system ceases to display the one or more other controls corresponding to the other pages, scrolls the home page, and displays an indication of the home page to indicate that the home page is the currently displayed page. For example, as described with reference to FIG. 6V, the page menu 6704 that includes selection indicator 6708 is collapsed into page menu 6704′ that continues to display a representation of the currently selected page (e.g., the home user interface in FIG. 6V and the library user interface in FIG. 6AD).

In some embodiments, while displaying the indication of the currently displayed content (e.g., the indication that corresponds to the content, concurrently with the content, optionally with a different portion of the content being currently visible in the first user interface), without displaying the one or more content navigation objects (e.g., without displaying the content navigation object that corresponds to the first alternative content that is not currently displayed in the first user interface, and, without displaying one or more other user interface objects that ceased to be displayed in response to the first user input), the computer system detects, via the one or more input devices, a second user input directed toward the indication of the currently displayed content. In some embodiments, the second user input includes a tap gesture, an air pinch gesture, a swipe gesture, a click input, and/or other types of selection input that targets the indication of the indication of the currently displayed content (e.g., in contrast to a user input that targets the content, e.g., to scroll, resize, reposition the content relative to the first user interface, and/or to otherwise facilitate visual inspection of the content by the user). In some embodiments, in response to detecting the second user input, in accordance with a determination that the second user input meets selection criteria with respect to the indication of the currently displayed content (e.g., the second user input is substantially stationary with respect to the indication of the currently displayed content, and does not include more than a threshold amount of movement relative to the indication of the currently displayed content), the computer system displays (e.g., redisplays), via the one or more display generation components, the one or more content navigation objects (e.g., optionally, along with one or more other user interface objects that ceased to be displayed in response to the first user input, and optionally restoring the configurations and layouts of the plurality of user interface objects to a state prior to the detection of the first user input). In some embodiments, in response to detecting the second user input that is directed toward the indication of the currently displayed content, the indication of the currently displayed content is transformed back to the group of content navigation objects that was displayed prior to the detection of the first user input. In some embodiments, in response to detecting the second user input, in accordance with a determination that the second user input does not meet the selection criteria with respect to the indication of the currently displayed content, the computer system forgoes displaying (e.g., redisplaying), via the one or more display generation components, the one or more content navigation objects (e.g., optionally, along with one or more other user interface objects that ceased to be displayed in response to the first user input, and optionally restoring the configurations and layouts of the plurality of user interface objects to a state prior to the detection of the first user input). For example, as described with reference to FIGS. 6AB-6AC, in response to detecting the user input 6726, the collapsed page menu 6704′ is expanded to display the other page options in FIG. 6AC.

In some embodiments, while displaying the indication of the currently displayed content (e.g., the indication that corresponds to the content, concurrently with the content, optionally with a different portion of the content being currently visible in the first user interface), without displaying the one or more content navigation objects (e.g., without displaying the content navigation object that corresponds to the first alternative content that is not currently displayed in the first user interface, and, without displaying one or more other user interface objects that ceased to be displayed in response to the first user input), the computer system detects, via the one or more input devices, a third user input (e.g., same as the second user input, or other than the second user input) directed toward the indication of the currently displayed content. In some embodiments, the third user input includes a swipe gesture, an air pinch and drag gesture, a click and drag input, and/or other types of drag input that targets the indication of the first section header (e.g., in contrast to a user input that targets the content, e.g., to scroll, resize, reposition the content relative to the first user interface, and/or to otherwise facilitate visual inspection of the content by the user). In some embodiments, in response to detecting the third user input, in accordance with a determination that the third user input meets movement criteria with respect to the indication of the currently displayed content (e.g., the third user input starts at a location that corresponds to the indication of the currently displayed content, and includes more than a threshold amount of movement relative to the indication of the currently displayed content), wherein the movement criteria includes a requirement that is met when the third user input includes more than a threshold amount of movement from a location corresponding to the indication of the currently displayed content, the computer system: ceases display of the content, and displaying, via the one or more display generation components, respective alternative content in the first user interface (e.g., the first alternative content, or other alternative content, becomes the currently displayed content in the first user interface); and updates the indication of the currently displayed content to correspond to the respective alternative content that is currently displayed in the first user interface (e.g., text, glyph, and/or other indication of the identity of the currently displayed content changes in the indication of the currently displayed content, or the selection highlight is moved from the navigation object of the content to the navigation object of the respective alternative content). In some embodiments, the computer system displays an animated transition that shows the indication of the currently displayed content morphs into the container object including the different navigation objects corresponding to different content pages, a selection object (e.g., a glassy object as described with respect to FIGS. 6A-6C and other objects that includes a user interface material with simulated optical interactions with surrounding content and environment) emerging from the object corresponding to the content and moving with the third user input to the object corresponding to the respective alternative content, to change the object corresponding to the respective alternative content into a selected state. In some embodiments, depending on whether the movement direction of the third user input is a first direction or a second direction relative to the indication of the currently displayed content, either first alternative content or second alternative content would replace the currently displayed content, and either the object corresponding to the first alternative content or the object corresponding to the second alternative content would become selected and used as the indication of the currently selected content. In some embodiments, in response to detecting the third user input, in accordance with a determination that the third user input does not meet the movement criteria with respect to the indication of the currently displayed content, the computer system maintains display of the content, and forgoes displaying the respective alternative content in the first user interface; and the computer system forgoes updating the indication of the currently displayed content to correspond to the respective alternative content that is currently displayed in the first user interface. For example, as described with reference to FIGS. 6AB-6AD, the user input 6726′ moves to select another available page of the music application, and in response to the user input 6726′ ending with selection of the library user interface, the library user interface 6703 is displayed.

In some embodiments, while displaying the indication of the currently displayed content (e.g., the indication that corresponds to the content, concurrently with the content, optionally with a different portion of the content being currently visible in the first user interface), without displaying the one or more content navigation objects (e.g., without displaying the content navigation object that corresponds to the first alternative content that is not currently displayed in the first user interface, and, without displaying one or more other user interface objects that ceased to be displayed in response to the first user input), the computer system detects, via the one or more input devices, a fourth user input (e.g., same as the second user input, or other than the second user input; same as the third user input, or other than the third user input)) that is directed toward the indication of the first section header that corresponds to the content, and that includes more than a threshold amount of movement in a respective direction. In some embodiments, the fourth user input includes a swipe gesture, an air pinch and drag gesture, a click and drag input, and/or other types of drag input that targets the indication of the first section header (e.g., in contrast to a user input that targets the content, e.g., to scroll, resize, reposition the content relative to the first user interface, and/or to otherwise facilitate visual inspection of the content by the user). In some embodiments, in response to detecting the fourth user input, the computer system: ceases to display the content in the first user interface; in accordance with a determination that the fourth user input includes first movement that has a first set of movement characteristics (e.g., first movement distance, first movement speed, and/or first movement direction), displays second alternative content in the first user interface (e.g., the second alternative content becomes the currently displayed content in the first user interface). In some embodiments, in response to detecting the fourth user input, in accordance with the determination that the fourth user input includes the first movement that has the first set of movement characteristics, the computer system also updates the indication of currently displayed content to correspond to the second alternative content that is currently displayed in the first user interface (e.g., the navigation object corresponding second alternative content is displayed at the location of the indication of currently displayed content, or is displayed in a selected state). In some embodiments, updating the indication of the currently displayed content to correspond to the second alternative content includes scrolling the text or glyph within the object corresponding to the indication of the currently displayed content (e.g., scrolling the text or glyph within the glassy material of the object, optionally with changes in the appearance of the glassy material based on the movement of the text and/or glyphs within the glassy material to the text and/or glyph corresponding to the second alternative content). Additional details related to simulating refraction of moving and/or changing internal content in a user interface material are provided with respect to FIGS. 6A-6C and FIGS. 6AO-6AP and accompanying descriptions. In some embodiments, in accordance with a determination that the fourth user input includes second movement that has a second set of movement characteristics different from the first set of movement characteristics (e.g., second movement distance different from the first movement distance, second movement speed different from the first movement speed, and/or second movement direction different from the first movement direction), the computer system displays third alternative content, different from the second alternative content, in the first user interface (e.g., the third alternative content becomes the currently displayed content in the first user interface). In some embodiments, in response to detecting the fourth user input, in accordance with a determination that the fourth user input includes second movement that has a second set of movement characteristics different from the first set of movement characteristics, the computer system also updates the indication of currently displayed content to correspond to the third alternative content that is currently displayed in the first user interface (e.g., the navigation object corresponding third alternative content is displayed at the location of the indication of currently displayed content, or is displayed in a selected state). In some embodiments, updating the indication of the currently displayed content to correspond to the third alternative content includes scrolling the text or glyph within the object corresponding to the indication of the currently displayed content (e.g., scrolling the text or glyph within the glassy material of the object, optionally with changes in the appearance of the glassy material based on the movement of the text and/or glyphs within the glassy material to the text and glyph corresponding to the third alternative content). Additional details related to simulating refraction of moving and/or changing internal content in a user interface material are provided with respect to FIGS. 6A-6C and FIGS. 6AO-6AP and accompanying descriptions. In some embodiments, depending on whether the movement direction of the fourth user input is a first movement speed, or a second movement speed, relative to the indication of the currently displayed content, different alternative content would replace the currently displayed content, and the indication of the currently displayed content will be updated accordingly to indicate the newly displayed content. In some embodiments, depending on whether the movement distance of the fourth user input is a first movement distance or a second movement distance relative to the indication of the currently displayed content, different alternative content would replace the currently displayed content, and the indication of the currently displayed content will be updated accordingly to indicate the newly displayed content. In some embodiments, the fourth user input may continue to scrub through a number of navigation objects corresponding to different alternative content, until a termination of the fourth user input is detected; and depending on the movement distances and/or movement speed, different alternative content would be displayed in the first user interface after the termination of the fourth user input. For example, as described with reference to FIG. 6AC, the selected page is based on the movement, including a magnitude and/or direction, of the user input 6726′.

In some embodiments, after ceasing to display at least the subset of the one or more additional selectable user interface objects, while maintaining concurrent display of the first selectable user interface object and the second selectable user interface object, the computer system detects, via the one or more input devices, a sequence of one or more user inputs that corresponds to one or more additional requests to navigate through the content (e.g., one or more additional swipe gestures, pinch gestures, air pinch and drag gestures, click and drag inputs in the same direction, and/or tap gestures, click inputs, and/or air pinch gestures directed to one or more resize, scroll, zoom affordances); and in response to detecting a respective user input of the sequence of one or more user inputs that corresponds the one or more additional requests to navigate through the content: in accordance with a determination that a first edge portion of the content (e.g., a top edge for a downward navigation through the content, a bottom edge for an upward navigation through the content, a left edge for a rightward navigation through the content, a right edge for a leftward navigation through the content, and/or another edge of the content for a navigation direction that pulls the edge into the visible portion of the first user interface) has not been reached (and/or is not currently displayed in the first user interface), the computer system shifts a currently displayed portion of the content in accordance with the respective user input (e.g., scroll, resize, and zoom the content, in accordance with the direction and magnitude of the respective user input). In some embodiments, the first edge portion of the content is optionally displayed as a result of shifting the currently displayed portion of the content in accordance with the currently detected portion of the respective user input. In some embodiments, in accordance with a determination that the first edge portion of the content has been reached (and/or is currently displayed in the first user interface, optionally in response to an earlier portion of the respective user input, or in response to a user input preceding the respective user input in the sequence of one or more user inputs), the computer system redisplays, via the one or more display generation components, the plurality of selectable user interface objects, including at least the subset of the one or more additional selectable user interface objects, the first selectable user interface object, and the second selectable user interface object. In some embodiments, the plurality of user interface objects is redisplayed with their original appearances and positions in the first user interface prior to the detection of the initial user input that caused at least the subset of the one or more additional selectable user interface objects to be removed from the first user interface. In some embodiments, the redisplay of the plurality of selectable user interface object in response to the respective user input occurs after the termination of the respective user input. For example, in some embodiments, the content is displayed with simulated inertia, and may continue to shift in response to the movement of the respective user input after the respective user input has ceased to be detected; and as the content continues to shift in the first user interface, if the first edge portion of the content is reached, the plurality of selectable user interface objects is redisplayed in the first user interface with the content (e.g., after the termination of the respective user input). For example, as described with reference to FIG. 6W, in response to determining that the bottom of the user interface 6700 has been reached (e.g., via a scrolling input), the first set of media player control options is redisplayed (e.g., in their expanded versions) to replace display of the collapsed second set of media player control options (e.g., in FIG. 6V).

In some embodiments, the first user interface of the first application is a user interface of a media player application (e.g., a video player application, a music player application, and/or other media player application for playing back multimedia content); the content that is displayed with the plurality of selectable user interface objects includes content that corresponds to one or more media items that are playable in the media player application (e.g., content pages corresponding to a home page of content items, recommendation page of content items, radio program page, podcast program page, other content pages including selectable links to playable media content, album art, video, movie, animation, images, track number, lyrics, closed caption, and/or album and track information corresponding to a song, music, video, movie, and/or animation that is currently playing in the user interface of the media player application). In some embodiments, the content that is displayed in the first user interface includes selectable links that causes the media player application to start playing back a content item corresponding to the selected link in the media player application. In some embodiments, the content that is displayed in the first user interface includes content corresponding to a currently playing media item. In some embodiments, the plurality of selectable user interface objects includes at least a plurality of selectable controls for controlling playback of a currently playing media item (e.g., play/pause control, fast forward control, playback progress scrubber, rewind control, closed caption on/off control, playlist of recommended or related media items, routing control, navigation controls for navigating to a different album or playlist, and/or other controls that are configured to modify the playback of media items in the user interface). In some embodiments, the content that is currently displayed includes content corresponds to the currently playing media item. In some embodiments, the content that is currently displayed is independent of the currently playing media item, and does not change when the currently playing media item changes. In some embodiments, the content that is currently displayed is updated based on changes in the currently playing media item. In some embodiments, changing the content that is currently displayed does not affect the currently playing media item, or vice versa. For example, as described with reference to 6U, the media playback bar 6702 includes one or more media playback controls, such as a pause/play control, a skip control, a volume control and/or other controls for the media player.

In some embodiments, while displaying the plurality of selectable controls for controlling playback of the currently playing media item (e.g., in a mini player object in the plurality of selectable user interface objects, and/or in a reduced mini player object after ceasing to display at least a subset of the plurality of selectable user interface objects), the computer system detects, via the one or more input devices, detecting a user input that is directed toward a respective control of the plurality of selectable controls. In some embodiments, the user input includes a swipe gesture, an air pinch and drag gesture, and/or a click and drag input directed to the playback control or album art in the mini player object, and/or a tap gesture, an air pinch gesture, and/or a click input directed to a playback control in the mini player object. In some embodiments, in response to detecting the user input that is directed toward a portion of the plurality of selectable controls (e.g., the album art, a playback control, or another portion in the platter containing the playback controls), the computer system displays, via the one or more display generation components, the plurality of selectable controls with additional content corresponding to the currently playing media item (e.g., playlist, related media items, enlarged album art, lyrics, and/or social media content related to the currently playing media content, different from the alternative content that can be navigated to using the content navigation objects). For example, in some embodiments, in response to the user input, the content is replaced by alternative content corresponding to the currently displayed media item, while the mini player object becomes enlarged playback controls in the first user interface, the first user interface becomes the media player detail view of the media player application. For example, as described with reference to FIG. 6U, in response to detecting a user input 6770, a currently playing user interface is displayed.

In some embodiments, while displaying the content and the plurality of selectable controls for controlling playback of the currently playing media item, the computer system detects, via the one or more input devices, a user input that corresponds to a request to activate a first control of the plurality of controls. In some embodiments, the user input that corresponds to a request to activate the first control a tap gesture, an air pinch gesture, and/or a click input directed to the first control. In some embodiments, in response to detecting the user input that corresponds to the request to activate the first control, the computer system performs a first operation corresponding to the first control, including changing playback of the currently playing media item in accordance with the first operation. In some embodiments, in accordance with a determination that the first control is a skip forward or skip backward control, performing the first operation corresponding to the first control includes navigating to another media item in a playlist of the currently playing media item, and maintaining display of the plurality of selectable controls in the user interface. In some embodiments, in accordance with a determination that the first control is a play/pause control, performing the first operation corresponding to the first control includes pausing the currently playing media item and maintaining display of the plurality of selectable controls in the first user interface. For example, as described with reference to FIG. 6X, in response to detecting a user input 6718 directed to the pause control, the device 100 pauses the currently playing media item and in response to detecting user input 6720 directed to a skip control, the device 100 skips to a next media item.

In some embodiments, the plurality of selectable controls includes status information related to the currently playing media item (e.g., displaying playback progress, title, album art, playback history, playback frequency, statistics, and/or other status information that changes over time based on the status of the currently playing media item, optionally in a container object including the play/pause and other playback controls). In some embodiments, the plurality of selectable controls is part of a mini media player object. For example, as described with reference to 6U, the media playback bar 6702 includes information about the currently playing media item (e.g., song title, artist, cover art and/or other information).

In some embodiments, in response to detecting the user input that corresponds to the request to navigate through the content, the computer system rearranges at least a subset of the plurality of selectable user interface objects that remain displayed with the content, including the first selectable user interface object, the second selectable user interface object, in the first user interface of the first application. For example, in some embodiments, two or more selectable user interface objects that are not removed from the first user interface are moved closer to one another in the first user interface to reduce an overall footprint of the remaining selectable user interface objects. In some embodiments, two or more of the remaining selectable user interface objects are moved to an edge region or corner region of the first user interface to avoid interfering with the user's visual inspection of the content in the first user interface. For example, as described with reference to FIG. 6V, the second set of media player control options are rearranged relative to the first set of media player control options, including shifting the collapsed page menu 6704′ to the left (e.g., to make space for the collapsed media playback bar 6702′ that is repositioned to be arranged in a same row).

In some embodiments, the plurality of selectable user interface objects includes: a first group of two or more selectable user interface objects arranged in a first spatial grouping of a multi-group arrangement (e.g., a first row in a multi-row arrangement, a first column in a multi-column arrangement); and a second set of two or more selectable user interface objects arranged in a second spatial grouping of the multi-group arrangement (e.g., a second row in a multi-row arrangement, a second column in a multi-column arrangement). In some embodiments, the multi-group arrangement includes additional sets of two or more selectable user interface objects arranged in additional spatial groupings of the multi-row arrangement. In some embodiments, the plurality of selectable user interface objects includes one or more selectable user interface objects in other arrangements outside of the multi-group arrangement. In some embodiments, rearranging at least the subset of the plurality of selectable user interface objects that remain displayed with the content, includes: ceasing to display one or more selectable user interface objects from one or more spatial groupings (e.g., one or more rows, and/or one or more columns) of the multi-group arrangement (e.g., multi-row arrangement, and/or multi-column arrangement); and consolidating a plurality (or, optionally all) of the remaining selectable user interface objects (e.g., including the first selectable user interface object, the second selectable user interface object, and/or one or more other selectable user interface objects among the additional selectable user interface objects that are still displayed) in the multi-group arrangement into a reduced arrangement that includes fewer spatial groupings than the multi-group arrangement (e.g., reducing a two-row arrangement or a three-row arrangement into a single row arrangement, and consolidating the remaining selectable user interface objects into the single row arrangement; and/or reducing a four-column arrangement or a three-column arrangement into a single column arrangement or a double-column arrangement, and consolidating the remaining selectable user interface objects into the single-column arrangement or the double-column arrangement). For example, as described with reference to FIG. 5V, the row in the stacked layout of FIG. 5U that includes media playback bar 6702 is removed such that only the single row of the second set of media player control options is displayed in FIG. 5V.

In some embodiments, in response to detecting the user input that corresponds to the request to navigate through the content, the computer system: maintains display of at least a first subset of the plurality of selectable user interface objects (e.g., including the first selectable user interface object, the second selectable user interface object, and one or more of the additional selectable user interface objects that are not removed) with the content; and reduces respective sizes of one or more of the first subset of the plurality of selectable user interface objects (e.g., reducing the size of the first selectable user interface object, the size of the second selectable user interface object, and/or reducing the size of one of the additional selectable user interface objects that remains displayed in the first user interface). For example, as described with reference to FIG. 6V, the size of collapsed search control 6706′ is smaller than the size of search control 6706 and the size of collapse page menu 6704′ is smaller than the size of page menu 6704.

In some embodiments, in response to detecting the user input that corresponds to the request to navigate through the content, the computer system: maintains display of at least a second subset of the plurality of selectable user interface objects (e.g., including the first selectable user interface object, the second selectable user interface object, and one or more of the additional selectable user interface objects that are not removed) with the content; and removes respective labels of one or more of the second subset of the plurality of selectable user interface objects (e.g., removing the label of the first selectable user interface object, removing the label of the second selectable user interface object, and/or removing the label of one of the additional selectable user interface object that remains displayed in the first user interface). For example, as described with reference to FIG. 5V, the text labels displayed in FIG. 5U in the page menu 6704 cease to be displayed in the collapsed page menu 6704′.

In some embodiments, in response to detecting the user input that corresponds to the request to navigate through the content, the computer system displays, via the one or more display generation components, a new selectable user interface object, with the content in the first user interface, wherein the new selectable user interface object was not displayed with the plurality of selectable user interface objects and the content prior to detecting the user input that corresponds to the request to navigate through the content. For example, in some embodiments, the new selectable user interface object is a selectable user interface object that facilitate efficient navigation through the content, such as a scroll object, that when selected allow faster scrolling of the content. In some embodiments, the new selectable user interface object includes an annotation tool for annotating the content. For example, as described with reference to FIGS. 6V, in response to detecting user input 6712, a collapsed media playback bar 6702′ (e.g., which was not previously displayed) is displayed. In some embodiments, as described with reference to FIGS. 6AD-6AE, in response to detecting a user input 6732 (e.g., corresponding to a request to initiate a search session), a search bar 6706″ and/or an option to cancel 6736 is displayed.

In some embodiments, after navigating through the content in the first direction and ceasing to display the first subset of selectable elements (e.g., in response to the user input that corresponds to the request to navigate through the content in the first navigation direction), the computer system: while displaying the content and after at least the subset of the one or more additional selectable user interface objects has ceased to be displayed as a result of the user input that corresponds to the request for navigating through the content, detects, via the one or more input devices, an additional user input that corresponds to an additional request to navigate through the content. In some embodiments, the additional user input is of the same input type as the user input that corresponds to the request to navigate through the content, optionally with different values for one or more input parameters (e.g., direction, magnitude, speed, and/or other input characteristics). In some embodiments, the additional user input includes a user input that scrolls the content in the first user interface. In some embodiments, the additional user input includes a user input that changes a zoom level of the content in the first user interface, and/or shift a center of focus of the content in the first user interface. In some embodiments, the additional user input includes a selection input that is directed to a navigation control (e.g., a tap input on an up arrow or down arrow on a scroll bar), a drag input that drags a scrubber on the scroll bar, a drag input directed to a portion of the content that scrolls the content in a scroll direction of the content, a selection input on a zoom control and/or a pinch/depinch gesture on the respective content to zoom into or zoom out of the currently visible portion of the content, and/or other types of inputs that corresponds to requests to navigate through the content, as opposed to navigate to other content different from the currently displayed content. In some embodiments, in response to detecting the additional user input that corresponds to the additional request to navigate through the content, the computer system: in accordance with a determination that the additional user input corresponds to a request to continue to navigate through the content in the first navigation direction, shifts a currently displayed portion of the content in the first navigation direction (e.g., without restoring the subset of the one or more additional selectable user interface objects that have been removed from the first user interface); and in accordance with a determination that the additional user input corresponds to a request to navigate through the content in a second navigation direction different from the first navigation direction (e.g., opposite or substantially opposite the first navigation direction): shifts the currently displayed portion of the content in the second navigation direction; and displays (e.g., redisplays), via the one or more display generation components, the plurality of selectable user interface objects with the content, in the first user interface. For example, in some embodiments, after navigating in a first direction and ceasing to display the first subset of selectable user interface objects, if the computer system detects an input to navigate in a second, opposite, direction, the computer system navigates the content in the second direction and redisplay the subset of selectable user interface objects with the content. For example, the plurality of selectable user interface objects is redisplayed with their original spatial layout as before the detection of the user input that corresponds to the request to navigate through the content. For example, as described with reference to FIG. 6AB, in response to detecting a user input 6724, such as an input corresponding to a request to scroll upward, the first set of media player control options continues to be displayed (e.g., without replacing display of the first set of media player control options with the second set of media player control options).

In some embodiments, while displaying the content and after at least the subset of the one or more additional selectable user interface objects has ceased to be displayed as a result of the user input that corresponds to the request for navigating through the content, the computer system detects, via the one or more input devices, a user input that selects the first selectable user interface object (e.g., as a representative of at least a subset of the selectable user interface objects that remain displayed with the content). In some embodiments, the first selectable user interface object has been resized, repositioned, and optionally reduced in visual prominence in the first user interface when the user input selects the first selectable user interface object. In some embodiments, the first user interface object is a search control for triggering display of a search input field and a search page with recommended content (e.g., replacing the content that is currently displayed in the first user interface). In some embodiments, selection of the search control causes the computer system to enter a search mode and displays the search page in the first user interface as the currently displayed content. In some embodiments, the indication of the currently displayed content now is used as an indication of last-displayed content prior to displaying the search page. In some embodiments, the user input that selects the first selectable user interface object includes a tap gesture, a tap and hold gesture, a light press gesture, and/or a double tap gesture performed by one or more contacts at a location corresponding to the first selectable user interface object. In some embodiments, the user input that selects the first selectable user interface object includes an air pinch gesture and/or an air pinch and hold gesture that is detected while a user's attention (e.g., as determined based on gaze and/or a location of the input focus or focus selector) is directed toward the first selectable user interface object. In some embodiments, the user input that selects the first selectable user interface object includes a click input, a click and hold input, and/or a double click input, that is detected while the focus selector is at the location of the first selectable user interface object. In some embodiments, the user input that selects the first selectable user interface object includes other types of user input that meets selection criteria (e.g., time-based and/or intensity-based criteria) while a target location of the user input corresponds to the first selectable user interface object. In some embodiments, in response to detecting the user input that selects the first selectable user interface object, the computer system: displays (e.g., redisplays), via the one or more display generation components, the subset of the one or more additional user interface objects (e.g., redisplaying the subset of one or more additional selectable user interface objects and restoring the appearances and positions of the selectable user interface objects that have remained in the first user interface); and displays, via the one or more display generation components, a new user interface object (e.g., a search input field, or another type of selectable user interface object) that was not displayed with the plurality of selectable user interface object and the content, prior to detecting the user input that corresponds to the request to navigate through the content. In some embodiments, the first selectable user interface object (e.g., the “search” control) is transformed into a close affordance for terminating the search mode, and removal of the search page, in response to the user input selecting the first user interface object. For example, as described with reference to FIG. 6AD, in response to detecting user input 6732, a search bar 6706′ (e.g., in FIG. 6AE) and an option to cancel 6736 is displayed.

In some embodiments, while displaying the new user interface object with the plurality of selectable user interface objects and the content, the computer system detects, via the one or more input devices, a user input that corresponds to a request to navigate away from currently displayed content (e.g., the content, or the search page). In some embodiments, the user input is a request to navigate to alternative content that is different from the currently displayed content. In some embodiments, the user input is performing a search by putting search criteria into the search input field and entering to see search results. In some embodiments, the user input that corresponds to a request to navigate away from the currently displayed content includes a user input that selects the tab or section header of another content page or document, and/or a selection of a “back” or “forward” button to navigate to a previously displayed content page or document. In some embodiments, the user input that corresponds to a request to navigate away from the currently displayed content includes a selection input (e.g., a tap gesture, a light press gesture, an air pinch gesture, a click input, a double click input, and/or other types of selection input) that meets selection criteria with respect to a navigation control, an indication of alternative content, and/or other controls that causes replacement of the currently displayed content with other alternative content, without ceasing to display the currently displayed application and/or the currently displayed user interface. In some embodiments, the user input that corresponds to a request to navigate away from the currently displayed content includes a movement input (e.g., a swipe gesture, a click and drag input, an air pinch and drag gesture, and/or other types of movement input) that meets movement criteria with respect to an adjustable navigation control (e.g., a scrollable multi-state control, a navigation bar, and/or other adjustable navigation controls that change the destination of the navigation request based on the movement input) that causes replacement of the currently displayed content with other alternative content, without ceasing to display the currently displayed application and/or the currently displayed user interface. In some embodiments, in response to detecting the user input that corresponds to the request to navigate away from the currently displayed content, the computer system: ceases to display the currently displayed content in the first user interface; and displays, via the one or more display generation components, alternative content (e.g., search results corresponding to search criteria entered in the search input field, and/or other content that specified by the request to navigate away from the currently displayed content), with the plurality of selectable user interface objects and the new user interface object, in the first user interface. For example, in some embodiments, navigating to alternative content does not cause the computer system to remove selectable user interface objects from display in the first user interface. For example, as described with reference to FIGS. 6AE-6AF, while in the search session, including displaying search bar 6706″, the device 100 detects user input 6734 corresponding to a request to scroll the user interface 6705 downward, and in response to detecting the user input 6734, the device 100 maintains display of the search bar 6706′ (e.g., and the third set of control options) without collapsing the stack of control options.

In some embodiments, the plurality of selectable user interface objects includes two or more content navigation objects (e.g., tabs, and/or headers), including: a first content navigation object corresponding to the content (e.g., the currently displayed content); and a second navigation object that corresponds to first alternative content that is not currently displayed in the first user interface (and, optionally, a third content navigation object that corresponds to second alternative content that is not currently displayed in the first user interface); and For example, in some embodiments, the plurality of selectable user interface objects includes a group of content navigation objects, such as the “home” control corresponding to a home page, a “new” control corresponding to a recommendation page, a “radio” control corresponding to a radio program page, and a “podcast” control for a podcast page, and/or other content navigation objects corresponding to other alternative content that can replace the currently displayed content. In some embodiments, in response to detecting the user input that selects the first selectable user interface object, the computer system: ceases to display the two or more content navigation objects; and displays, via the one or more display generation components, an indication of last-displayed content (e.g., transforming the two or more content navigation objects into the indication of last-displayed content, which optionally looks the same as the indication of currently displayed content when content other than the search page was displayed in the first user interface) concurrently with the new user interface object (e.g., in the same row). In some embodiments, when displaying the search input field in response to selection of the search control, the computer system also replaces currently displayed content with a search page with recommended searches or past search results, and the computer system also transforms the group of content navigation objects into a single indication displayed adjacent the search input field, where the indication indicates the identity of the content that was displayed prior to the display of the search page. For example, as described with reference to FIG. 6AE, in response to detecting the user input 6732, the search bar 6706″ is displayed while displaying collapsed page menu 6704″ indicating the most recently displayed user interface (e.g., the library user interface).

In some embodiments, respective selectable user interface objects of the plurality of selectable user interface objects include a first user interface material and have respective object appearances that simulate refraction of at least a portion of the content, one or more of the plurality of selectable user interface objects, and/or internal content of the respective selectable user interface objects, in the first user interface, by the first user interface material. More details related to the first user interface material and its simulated interactions with surrounding content and internal content of the first user interface material are provided with respect to FIGS. 6A-6B4 and accompanying descriptions. For example, as described with reference to FIG. 6U, the media player control options are displayed with a simulated glass material, with the properties described with reference to FIGS. 6A-6B4.

In some embodiments, at least a first subset of the plurality of user interface objects collectively occupies a first portion of the first user interface (e.g., a top portion, a left side portion, a right side portion, and/or a bottom portion, of the first user interface), before detecting the user input that corresponds to the request to navigate through the content; a portion of the content located within the first portion of the first user interface has a first deemphasized appearance (e.g., a blurred overlay is applied on the portion of the content that underlies the first portion of the first user interface, and at least the first subset of the plurality of selectable user interface objects are displayed on top of the blurred overlay), before detecting the user input that corresponds to the request to navigate through the content; at least a second subset of the plurality of user interface objects that remains displayed in the first user interface after detecting the user input that corresponds to the request to navigate through the content, collectively occupies a second portion of the first user interface (e.g., a smaller and/or narrower portion than the first portion of the first user interface); a portion of the content located within the second portion of the first user interface (e.g., a smaller and/or narrower portion than the first portion of the first user interface) has a second deemphasized appearance, after detecting the user input that corresponds to the request to navigate through the content; the first portion of the first user interface has a first set of values for a set of spatial properties; the second portion of the first user interface has a second set of values for the set of spatial properties; and the first set of values is different from the second set of values (e.g., the deemphasized area changes shape, size, and/or position, in response to the user input that causes some of the selectable user interface object to be removed from the first user interface and/or other remaining selectable user interface objects to change spatial arrangement and individual sizes and shapes). Additional details regarding deemphasizing content in certain portions of the user interface in response to navigation of content are provided with respect to FIGS. 6D-6H and accompanying descriptions. For example, in some embodiments, the media player control options described with reference to FIGS. 6U-6AN are displayed in a header portion (e.g., described with reference to FIGS. 6D-6H) at a bottom of the user interfaces of the media player application, including home user interface 6700, radio user interface 6701, library user interface 6703, search user interface 6705 and/or other application user interfaces for the application.

It should be understood that the particular order in which the operations in FIG. 17 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 13000, 14000, 15000, 16000, 18000, 19000, and/or 20000) are also applicable in an analogous manner to method 17000 described above with respect to FIG. 17. For example, the buttons, user interfaces, controls, visual deemphasis, virtual effects, described above with reference to method 17000 optionally have one or more of the characteristics of the buttons, user interfaces, controls, visual deemphasis, virtual effects, described herein with reference to other methods described herein (e.g., methods 7000, 8000, 9000, 10000, 11000, 12000, 13000, 14000, 15000, 16000, 18000, 19000, and/or 20000). For brevity, these details are not repeated here.

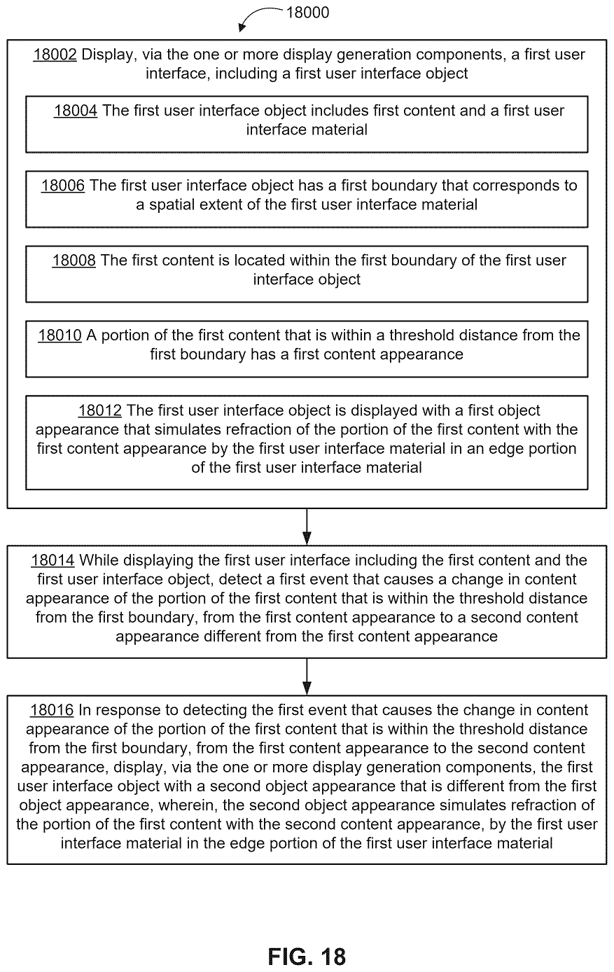

FIG. 18 is a flow diagram illustrating a method 18000 of modifying internal content that is displayed in a user interface object in accordance with some embodiments. In some embodiments, the method 18000 is performed at a computer system (e.g., portable multifunction device 100, device 300 in FIGS. 1A-6AP) that is in communication with one or more input devices (e.g., touch-sensitive surfaces, optical sensors, motion sensors, proximity sensors, gyros, accelerometers, ambient light sensors, joysticks, buttons, keyboards, handheld controllers, pointer devices, and/or other types of input devices) and one or more display generation components (e.g., touch-screen displays, standalone displays, LED displays, LCD displays, head-mounted displays, heads-up displays, foldable displays, flexible displays, and/or other types of display generation components that provides one or more display areas in which content, user interfaces, and/or controls can be made visible to a user). Some operations in method 18000 are, optionally, combined and/or the order of some operations is, optionally, changed.

Changing one or more visual properties at an edge region of a user interface object that is displayed with simulated user interface material, such that internal content within the edge region simulates a different level of refraction and/or other visual properties than internal content outside of the edge region provides improved visual feedback to the user by visually distinguishing a boundary of the user interface object. Providing a distinguished boundary of a user interface object improves the legibility of content, which enables a user to use a device for shorter periods of time, which saves energy and improves battery life. Displaying the user interface object with simulated user interface material leverages the user's real world experience to provide information about the spatial relationships between the user interface elements, and to provide visual feedback regarding the effect of user input, inform the user about the change in the state of the computer system and application, guide the user about how to use his/her input to change the system state and/or application state. The appearance of the user interface material also provides visual feedback regarding the type of user interface object and its associated functions. Some of the appearance characteristics are used to balance the need for visual saliency of the user interface objects against the background, visual saliency of the internal content of the user interface objects, and reduce visual distraction of the underlying content, and the efficiency in generating these appearances. Updating an appearance of user interface elements (e.g., by changing the visual properties of one or more edge regions) that display internal content within user interface elements when one or more criteria are met (e.g., by the user scrolling through internal content) reduces the number of inputs (e.g., navigating through settings user interfaces and menus to set the values for parameters to adjust the appearance of user interface elements) that would otherwise be required to generate a similar effect, which saves energy and improves battery life.

The computer system displays (18002), via the one or more display generation components, a first user interface (e.g., a full-screen user interface, a user interface displayed in a window, a user interface of a system application, and/or a user interface of a user application), including a first user interface object (e.g., a button that includes graphics indication the function of the button, a text selection object including selected text, a widget that includes application content, a tool bar including representations of different tools, a dock including application icons, a toggle control that includes graphics indicating a state of the control, and/or another type of user interface objects that include content that may change content appearance under various conditions). For example, as described with reference to FIG. 6AP, the user interface 6810 includes user interface object 6800.

The first user interface object includes (18004) first content (e.g., icons, graphics, text, selectable objects, lines, and/or patterns) and a first user interface material (e.g., a simulated glassy material, gelatinous material, and/or other types of simulated material with simulated material properties). The first user interface object has (18006) a first boundary that corresponds to a spatial extent of the first user interface material (e.g., the first user interface object has one or more edges, corners, and/or simulated surfaces that visually confine the first user interface material, and/or set it apart from surrounding content and background of the first user interface material). In some embodiments, spatial characteristics (e.g., location, shape, size, radius of curvature, change in simulated thickness, and/or other spatial characteristics) of the first boundary of the first user interface object are used to as basis for determining the spatial extent in which simulated optical interactions between the first user interface material and its surrounding environment and/or in which simulated material interactions between the first user interface material and user inputs should be applied. In some embodiments, the first boundary also defines the spatial extent of the first user interface object and provides the basis for determine how to implement the simulated optical interactions between the internal content of the first user interface object and the first user interface material. In some embodiments, the spatial extent of the first user interface material is defined by an outline of the first user interface object against the background of the first user interface. In some embodiments, the spatial extent of the first user interface material is further defined by simulated thickness of the first user interface material in a depth direction of the first user interface, e.g., with smaller thicknesses in the peripheral region of the first user interface object closer to the outline of the first user interface object (e.g., also referred to as an “edge portion” of the first user interface object), and substantially uniform thicknesses in the interior region of the first user interface object farther away from the outline of the first user interface object (e.g., also referred to as an “interior portion” of the first user interface object).

The first content is located (18008) within the first boundary of the first user interface object (e.g., the first content is internal content of the first user interface object, as opposed to content outside of the boundary of the first user interface material, and subject to different implementations of simulated refraction as compared to content outside of the boundary of the first user interface material); a portion of the first content that is within a threshold distance from the first boundary has (18010) a first content appearance (e.g., the portion of the first content that is within the threshold distance from the first boundary refers to a portion of the internal content that is near the edge of the first user interface material, and/or a portion of the internal content that is in a portion of the first user interface material that has changing radii of curvature and/or simulated thicknesses). In some embodiments, the first content appearance of the portion of the first content that is within the threshold distance from the first boundary refers to the appearance of the portion of the internal content without alternations by simulated optical and/or material interactions (e.g., the first content appearance is not directly visible and is “virtually refracted” by the user interface material to produce the first object appearance of the first user interface object that is displayed).

The first user interface object is displayed (18012) with a first object appearance that simulates refraction of the portion of the first content with the first content appearance by the first user interface material in an edge portion of the first user interface material (e.g., the edge portion of the first user interface material is, corresponds to, and/or is based on the portion of the first user interface material that is within the threshold distance from the first boundary of the first user interface object, and/or the outline of the first user interface material against the background of the first user interface). For example, in some embodiments, the portion of the first user interface object that includes the edge portion of the first user interface material includes a representation of the portion of the first content that includes a visual distortion and/or chromatic aberration of the portion of the first content, with the first content appearance, to simulate a lensing effect that the first user interface material has on the portion of the first content. For example, as described with reference to FIG. 6AO, the portion of internal content within simulated area 6801 defined within an outer boundary of the user interface object 6800 is displayed with the first content appearance that simulates refraction.

While displaying the first user interface including the first content and the first user interface object, the computer system detects (18014) a first event (e.g., a set of one or more inputs detected via one or more input devices that changes the location, size, and/or content appearance of the content and/or the location, shape, and/or size of the boundary, an automatically occurring event such as playing media or a timer elapsing, and/or a triggered event such as an incoming notification or a change in state of the computer system) that causes a change in content appearance of the portion of the first content that is within the threshold distance from the first boundary, from the first content appearance to a second content appearance different from the first content appearance (e.g., due to scrolling of the first content within the first user interface object, animated changes of the first content within the first user interface object, and/or other interaction with the first user interface object, such as interactions that are described with respect to method 11000 that changes the boundary and material properties of the first user interface material). For example, as described with reference to FIG. 6AO, in response to detecting user input 6806, the internal content is scrolled.

In response to detecting the first event that causes the change in content appearance of the portion of the first content that is within the threshold distance from the first boundary, from the first content appearance to the second content appearance, the computer system displays (18016), via the one or more display generation components, the first user interface object with a second object appearance that is different from the first object appearance, wherein, the second object appearance simulates refraction of the portion of the first content with the second content appearance, by the first user interface material in the edge portion of the first user interface material (e.g., the second content appearance is not directly visible and is “virtually refracted” by the user interface material to produce the second object appearance of the first user interface object that is displayed). For example, in some embodiments, the portion of the first user interface object that includes the edge portion of the first user interface material displays a representation of the portion of the first content that includes a visual distortion and/or chromatic aberration of the portion of the first content to simulate a lensing effect that the first user interface material has on the portion of the first content; and as the portion of the first content changes content appearance from the first content appearance to the second content appearance, the representation of the portion of the first content in the edge portion of the first user interface material also changes appearance by simulating the lensing effect applied on the changed content appearance (e.g., different color separation, and/or visual distortions resulted from the simulated lensing effect). In some embodiments, the strength of the simulated lensing effect gets stronger for content that is closer to the first boundary (e.g., as the rate of change in the simulated thickness of the first user interface material increases in the direction pointing toward the outline of the first user interface material on the first user interface), and gradually decreases within the threshold distance from the first boundary for content that is farther away from the first boundary (e.g., as the rate of change in the simulated thickness of the first user interface material decreases in the direction pointing away from the outline of the first user interface material on the first user interface toward an interior of the first user interface object). In some embodiments, the strength of the lensing effect remains substantially constant along a curved portion of the outline of the first user interface material on the first user interface in a portion of edge portion that has substantially constant distance from the outline, if the radius of curvature of the outline remains substantially constant in the curved portion of the outline. In some embodiments, the strength of the lensing effect increases monotonically along a curved portion of the outline in a portion of edge portion that has substantially constant distance from the outline, if the radius of curvature of the outline decreases monotonically in the curved portion of the outline. In some embodiments, the strength of the lensing effect decreases monotonically along a curved portion of the outline in a portion of edge portion that has substantially constant distance from the outline, if the radius of curvature of the outline increases monotonically in the curved portion of the outline. For example, as described with reference to FIG. 6AO, in response to detecting user input 6806, the internal content of user interface object 6800 along the curved edge of the user interface object 6800 that is within simulated area 6801 is displayed with distortion.

In some embodiments, detecting the first event that causes the change in content appearance of the portion of the first content that is within the threshold distance from the first boundary, from the first content appearance to the second content appearance, includes: detecting an event (e.g., a user input that changes the appearance of the first content and/or an automatic change in the state of the first content) that corresponds to a change in a spatial arrangement of the first content (e.g., due to scrolling, resizing, reflow, repositioning, and/or zooming of the first content) in the first user interface object, relative to the first boundary of the first user interface object (e.g., optionally, while the first boundary is maintained and unchanged relative to the first user interface), that changes the content appearance of the portion of the first content that is within the threshold distance from the first boundary. For example, in some embodiments, the first content that is visible within the first user interface object changes, when the first content is scrolled, resized, and/or otherwise rearranged in the first user interface object in response to a user input directed toward the first user interface object (e.g., a scroll input, a tap input, and/or a select and drag input). In some embodiments, the first user interface object itself does not experience a change in spatial arrangement relative to the first user interface, and/or does not have a change in the position, size, and/or shape of the first boundary relative to the first user interface, when the spatial arrangement of the first content changes relative to the first boundary of the first user interface object. In some embodiments, the first user interface object itself experiences a change in spatial arrangement relative to the first user interface, and/or changes in the position, size, and/or shape of the first boundary relative to the first user interface, when the spatial arrangement of the first content changes relative to the first boundary of the first user interface object. For example, as described with reference to FIG. 6AO, in response to detecting the user input 6806, the internal content (e.g., object a through f) are displayed as shifting in position within the user interface object 6800.

In some embodiments, detecting the event that corresponds to change in the spatial arrangement of the first content in the first user interface object, relative to the first boundary of the first user interface object, includes detecting an event that corresponds to movement of the first content (e.g., a user input that moves the first content and/or an automatic movement of the first content) in a first direction relative to the first boundary of the first user interface object toward a first portion of the first boundary of the first user interface object. For example, in some embodiments, when the first content is moved in a direction toward a portion of the first boundary that is on a first side of the first user interface object, the lensing effect is applied to a portion of the first content entering and/or existing the edge portion of the first user interface material as a result of the movement of the first content in the first direction, and/or stronger lensing effect is applied to the portion of the first content that is moving closer to the first boundary of the first user interface material, and weaker lensing effect is applied to the portion of the first content that is moving away from the first boundary of the first user interface material. In some embodiments, the change in the strength of the lensing effect is due to a change in simulated thickness in the first user interface material, in the movement direction of the first content. In some embodiments, the change in content appearance of the portion of the first content that is within the threshold distance from the first boundary, from the first content appearance to the second content appearance, includes a change in content appearance in a portion of the first content that is within the threshold distance from the first portion of the first boundary (e.g., as opposed to another portion of the first boundary that is on an opposite end of the first user interface object from the portion of the first boundary). In some embodiments, movement of the first content in a reverse direction (e.g., a direction substantially opposite of the first direction) relative to the first boundary, causes a reversal of the change in object appearance in the portion of the first user interface material within the threshold distance of the first portion of the first boundary. In some embodiments, while displaying the first user interface object including the first content with respective content appearance (e.g., the first content appearance, the second content appearance, or another content appearance different from the first and second content appearances), the computer system detects an event that corresponds to movement of the first content (e.g., a user input that moves the first content and/or an automatic movement of the first content) in a second direction, different from the first direction (e.g., substantially perpendicular to the first direction, and/or another direction toward a portion of the first boundary other than the first portion of the first boundary), relative to the first boundary of the first user interface object, toward a second portion of the first boundary of the first user interface object, different from the first portion of the first boundary (e.g., on a side of the first user interface object adjacent to and/or substantially perpendicular to the first portion of the first boundary). In some embodiments, the first user interface material has a simulated curved surface near the first portion of the first boundary (e.g., gradually changing simulated thickness in the depth direction of the first user interface in a direction toward and/or away from the first portion of the first boundary), and a simulated flat surface near the second portion of the first boundary (e.g., constant simulated thickness in the depth direction of the first user interface in a direction toward and/or away from the second portion of the first boundary). In some embodiments, the first user interface material changes material property near the second portion of the first boundary, and the first content is fully blurred out before the first content reaches within a threshold distance from the second portion of the first boundary, and is therefore not simulating refraction of the first content near the second portion of the first boundary. In some embodiments, in response to detecting the event that corresponds to movement of the first content in the second direction relative to the first boundary of the first user interface object, toward the second portion of the first boundary of the first user interface object (e.g., a straight edge of the first user interface object, where the first user interface material has a constant simulated thickness in the direction toward and away from the straight edge of the first user interface object, and/or a curved edge that is subject to an visual effect different from the simulated refractive effect), the computer system forgoes displaying, via the one or more display generation components, a change in object appearance in a portion of the first user interface object that is within the threshold distance from the second portion of the first boundary, to an object appearance that simulates refraction of the first content by the first user interface material in the portion of the first user interface object. For example, in some embodiments, there is no change in simulated thickness and/or curvature of the first user interface material near the second portion of the first boundary, and therefore, no change in the strength of lensing effect on the content appearance when a portion of the first content moves into and/or changes content appearance within the portion of the first user interface material near the second portion of the first boundary. In some embodiments, because there is no changing simulated thickness and no change in curvature in the first user interface material, the lensing effect is not applied and/or does not change the content appearance in the edge portion of the first user interface material. In some embodiments, the first content is subject to a blur effect that blurs out the first content completely before the first content reaches the other end of the first user interface object. In some embodiments, the change (and/or rate of change) in simulated thickness near the second portion of the first boundary is smaller than the change (and/or rate of change) in simulated thickness near the first edge portion of the first boundary, and as a result, the strength of lensing effect on the content appearance is weaker when a portion of the first content moves into and/or changes content appearance within the portion of the first user interface material near the second portion of the first boundary, as compared to when a portion of the first content moves into and/or changes content appearance within the portion of the first user interface material near the first portion of the first boundary. For example, as described with reference to FIG. 6AO, in response to detecting the user input 6806, such as a scroll input to the left and/or right, the internal content (e.g., object a through f) are displayed as shifting in position within the user interface object 6800, whereas in response to detecting a user input in the vertical direction (e.g., up and/or down), the internal content (e.g., objects a through f) are not distorted within the simulated area 6801 (e.g., along a straight edge of the user interface object 6800).

In some embodiments, in response to detecting the movement of the first content in the second direction relative to the first boundary of the first user interface object, toward the second portion of the first boundary of the first user interface object (e.g., toward a straight edge of the first user interface object, and/or another curved edge of the first user interface object, through a portion of the first user interface material that has uniform simulated thickness in a depth direction of the first user interface), the computer system gradually reduces visibility of a respective portion of the first content that is outside of the threshold distance from the second portion of the first boundary, as the respective portion of the first content moves toward the second portion of the first boundary (e.g., the respective portion of the first content is blurred and/or faded out before entering into the edge portion of the first user interface material near the second portion of the first boundary, and as a result, the edge portion of the first user interface material near the second portion of the first boundary does not change its appearance, and the first content moving toward the second portion of the first boundary does not appear distorted and/or exhibits color separation). For example, as described with reference to FIG. 6AO, internal content is visually deemphasized and/or disappears in area 6804 without reaching a right side of the simulated area 6801.

In some embodiments, detecting the first event that causes the change in appearance of the portion of the first content that is within the threshold distance from the first boundary, from the first content appearance to the second content appearance, includes: detecting an event (e.g., a user input that causes the computer system to change the appearance of the content and/or an automatic change in the appearance of the first content) that corresponds to a visual change of the first content (e.g., due to a change in state in a system and/or application function corresponding to the first user interface object, produced automatically, in response to a system event, and/or in response to a user input directed to the first user interface object) that changes the content appearance of the first content (e.g., changing content appearance of the first content as a whole), including changing content appearance of the portion of the first content that is within the threshold distance from the first boundary (and, optionally, changing content appearance of other portions of the first content that is outside of the threshold distance from the first boundary). For example, in some embodiments, the first content within the first user interface object changes its visual appearance because the text, graphics, and/or glyphs included in the first user interface object changes (e.g., from first text to second text, from a first set of controls to a second set of controls, from a first icon to a second icon, from a first indicator graphic to a second indicator graphic, and/or from a first glyph to a second glyph), independent of a change in the location and/or size of the first user interface object in the first user interface, and/or independent of changes in the position and/or size of the first content relative to the first boundary. For example, as described with reference to FIGS. 5Q3-5Q5, in some embodiments, the text included in button 752 is updated, where the text crossing an edge of the button 752″ is displayed with an optical effect, such as a lensing effect, and/or in accordance with the distortion described with reference to FIG. 6AO.

In some embodiments, detecting the first event that causes the change in appearance of the portion of the first content that is within the threshold distance from the first boundary, from the first content appearance to the second content appearance, includes: detecting, via the one or more input devices, a first user input that is directed toward the first user interface object (e.g., a tap gesture, a swipe gesture, and/or a light press gesture by a contact at a location corresponding to a portion of the first user interface object, an air pinch gesture, an air pinch and drag gesture, a click input, a click and hold input, a click hold and drag input that targets a portion of the first user interface object); and in response to detecting the first user input, moving the first boundary in the first user interface to change the spatial extent of the first user interface material from a first spatial extent to a second spatial extent (e.g., stretching the first user interface material in a first stretching direction, and/or compressing the first user interface material in a first compression direction, where the first stretching direction and/or the first compression direction are selected based on a direction of the user input), including moving at least a portion of the first boundary relative to the first content (e.g., movement of at least a portion of the first boundary in the first user interface changes content appearance of the portion of the first content that is included within the threshold distance from the first boundary, while the first content optionally does not move relative to the first user interface or moves by a different amount than the first boundary relative to the first user interface). For example, in some embodiments, when a user input is directed toward the first user interface object, such as a respective portion of the first boundary, the first boundary changes, and the first user interface material enclosed by the first boundary changes simulated thicknesses and/or positions near the respective portion of the first boundary; and as a result, the simulated refraction of the first content in the edge portion of the first boundary changes to lead to an altered object appearance in the edge portion of the first user interface object, optionally, independent of any change in the visual appearance of the first content, and/or in dependent of changes in the position and/or size of the first content. For example, as described with reference to FIGS. 5Q-5Q2, the internal content displayed within button 725-4 is distorted as the boundary of the buttons 740 and 742 are updated by merging into a single button 725-1 (e.g., and vice versa as the button 725-1 is split into buttons 740 and 742 such that the content that overlaps with the changing boundary appears distorted). In some embodiments, the distortion of the internal content described with reference to FIGS. 5Q-5Q2 is performed in accordance with the distortion described with reference to FIG. 6AO (e.g., including distorting internal content that is proximate to a rounded edge without distorting internal content that is proximate to a straight edge).

In some embodiments, detecting the first event that causes the change in content appearance of the portion of the first content that is within the threshold distance from the first boundary, from the first content appearance to the second content appearance, includes: detecting an event that corresponds to a request to change a user interface state of the first user interface object, from a first user interface state to a second user interface state (e.g., from an ON state to an OFF state, or vice versa, from indicating a first content type to indicating a second content type, from indicating a first control function to indicating a second control function, and/or from indicating a first operation to indicating a second operation); and in response to detecting the event that corresponds to the request to change the user interface state of the first user interface object (e.g., detecting a user input, generation of a system event, generation of an application event, and/or other conditions being met), changing a visual indication (e.g., text, color, graphics, glyphs, and/or other types of visual indications) displayed in the first user interface object from a first visual indication corresponding to the first user interface state to a second visual indication corresponding to the second user interface state (e.g., from blue to orange, from a circle glyph to a square glyph, from a “Back” button to a “Home” button, from a first slider value to a second slider value, from a first application icon to a second application icon). In some embodiments, the second visual indication is different from the first visual indication (e.g., differing in text, graphics, color, glyphs, and/or other types of visual indications); and a portion of the second visual indication that is within the threshold distance from the first boundary is different (e.g., differing in distributions of lines, colors, and/or other visual parameters) from a portion of the first visual indication that is within the threshold distance from the first boundary (and thus, the first object appearance that simulates refraction of the portion of the first visual indication and the second object appearance that simulates refraction of the portion of the second visual indication are different from each other). In some embodiments, in response to detecting the event that corresponds to the request to change the user interface state of the first user interface object, the computer system also performs an operation that corresponds to the change in the user interface state of the first user interface object (e.g., toggling a control function associated with the first user interface object, navigating to a user interface that corresponds to the second user interface state, and/or adjusting a value of a control parameter associated with the first user interface object), in conjunction with changing the visual indication in the first user interface object. For example, as described with reference to FIGS. 5Q3-5Q5, in some embodiments, the text included in button 752 is updated in response to detecting a user input 758 corresponding to a request to replace the user interface 750 with the user interface 754, where the text crossing an edge of the button 752″ is displayed with an optical effect, such as a lensing effect, and/or in accordance with the distortion described with reference to FIG. 6AO.

In some embodiments, displaying the first user interface object with the first object appearance that simulates refraction of the portion of the first content with the first content appearance by the first user interface material in the edge portion of the first user interface material includes: generating a portion of the first object appearance corresponding to the edge portion of the first user interface material by applying a first amount of visual distortion (e.g., warping the lines and/or changing the spatial distributions of colors) on the portion of the first content, with the first content appearance, that is within the threshold distance from the first boundary. Similarly, in some embodiments, displaying the first user interface object with the second object appearance that simulates refraction of the portion of the first content with the second content appearance by the first user interface material in the edge portion of the first user interface material includes: generating a portion of the second object appearance corresponding to the edge portion of the first user interface material by applying a second amount of visual distortion (e.g., warping the lines and/or changing the spatial distributions of colors) on the portion of the first content, with the second content appearance, that is within the threshold distance from the first boundary. In some embodiments, the second amount of visual distortions is the same amount as the first amount of visual distortion (e.g., is an amount based on the spatial properties of the edge portion). In some embodiments, the second amount of visual distortions is a different amount from the first amount of visual distortion (e.g., is an amount that is based on both the spatial properties of the edge portion and the visual properties of the content appearance). In some embodiments, the simulated refraction by the first user interface material in the edge portion of the first user interface material includes applying a lensing effect that displaces content along an edge of the first user interface object (e.g., displacing the lines and colors of the first content along the curved portions of the outline of the first user interface object on the first user interface). For example, as described with reference to FIG. 6AO, the distortion effect that is applied in simulated area 6801 includes a lensing effect (e.g., optionally corresponding to the lensing effect as described with reference to lens effect 6003J in FIG. 6B4).

In some embodiments, displaying the first user interface object with the first object appearance that simulates refraction of the portion of the first content with the first content appearance by the first user interface material in the edge portion of the first user interface material includes: generating a portion of the first object appearance corresponding to the edge portion of the first user interface material by separately displaying color components (e.g., RGB color components, and/or other types of color components of a respective color) corresponding to the portion of the first content, with the first content appearance, that is within the threshold distance from the first boundary. Similarly, in some embodiments, displaying the first user interface object with the second object appearance that simulates refraction of the portion of the first content with the second content appearance by the first user interface material in the edge portion of the first user interface material includes: generating a portion of the second object appearance corresponding to the edge portion of the first user interface material by separately displaying color components of one or more colors of the portion of the first content, with the second content appearance, that is within the threshold distance from the first boundary. In some embodiments, the simulated refraction by the first user interface material in the edge portion of the first user interface material includes a lensing effect that splits colors of the first content along an edge of the first user interface object to simulate color aberration along the edge of the first user interface object (e.g., splitting colors in the first content and spreading the color components of the colors out along the curved portions of the outline of the first user interface object on the first user interface). In some embodiments, the color components of a respective color (e.g., a primary color, secondary color, tertiary color, black, white, gray, and/or other tints and shades of a color) are determined based on preconfigured rules related to the user interface material (e.g., the parameters and implementations of simulated refraction of internal content, such as the lensing layer described with respect to FIGS. 6A-6C). In some embodiments, separately displaying the color components includes displaying a simulated chromatic aberration or chromatic dispersion effect that simulates the failure of a lens to focus different colors at the same point, causing components of dark (e.g., black, dark grey, brown, or purple) content to be split into different component colors such as green, red, and yellow. As a result, in some embodiments, the color components can include one or more colors that are not included in the portion of the first content. For example, as described with reference to FIG. 6AO, in some embodiments, the distorting the internal content includes causing chromatic aberration of internal object a (e.g., by separating color channels of object a).

In some embodiments, separately displaying the color components (e.g., RGB color components, and/or other types of color components of a respective color) of one or more colors of the portion of the first content (e.g., with the first content appearance, with the second content appearance, and/or with another content appearance), that is within the threshold distance from the first boundary, includes: in accordance with a determination that a first subset of the one or more colors (e.g., the set of colors of a first pixel and/or a set of pixels in a first unit area in the portion of the first content) has a first distance from the first boundary, within the threshold distance from the first boundary, displaying a first plurality of color components (e.g., color components of the colors in the second subset of colors) with a first spatial extent (e.g., a first spread width) in the edge portion of the first user interface material; and in accordance with a determination that a second subset of the one or more colors (e.g., the set of colors of a second pixel and/or a set of pixels in a second unit area in the portion of the first content) has a second distance, different from the first distance (e.g., smaller than the first distance), from the first boundary, within the threshold distance from the first boundary, displaying a second plurality of color components (e.g., color components of the colors in the second subset of colors) with a second spatial extent (e.g., a first spread width) in the edge portion of the first user interface material. In some embodiments, the second plurality of color components includes a greater number of color components than the first plurality of color components (e.g., more finely differentiated color components are displayed closer to the first boundary, if the rate of change in simulated thickness is larger for the first user interface material closer to the first boundary); and/or the second spatial extent is greater than the first spatial extent (e.g., color components are more spread out with greater spread widths closer to the first boundary, if the rate of change in simulated thickness is larger for the first user interface material closer to the first boundary), in the edge portion of the first user interface material. For example, as described with reference to FIG. 6AO, a level of chromatic aberration increases as the internal content moves closer to the boundary of user interface object 6800.

In some embodiments, separately displaying the color components (e.g., RGB color components, and/or other types of color components of a respective color) of one or more colors of the portion of the first content (e.g., with the first content appearance, with the second content appearance, and/or with another content appearance), that is within the threshold distance from the first boundary, includes: generating a first spatial distribution of the color components of the one or more colors of the portion of the first content that is within the threshold distance from the first boundary, based on a first blurred version of the first content appearance (e.g., unmodified content appearance without any blur, or with a first amount of blur corresponding to a first non-zero blur radius); and generating a second spatial distribution of the color components of the one or more colors of the portion of the first content that is within the threshold distance from the first boundary, based on a first blurred version of the first spatial distribution of the color components (e.g., the color components are further blurred in the edge portion of the first user interface material). In some embodiments, the first blurred version of the first content appearance is also used in generating the spatial distortion of the first content appearance, in simulating the refraction of the first content by the edge portion of the first user interface material. In some embodiments, the first blurred version of the first spatial distribution of the color components has a greater blur radius than the first blurred version of the first content appearance (e.g., the simulated chromatic aberration is generated with a greater blur radius than the blur radius used to generate the color splitting of the portion of the content near the edge of the first user interface material). In some embodiments, when the colors are split into color components near the edge of the first user interface object, the outlines of respective color components are clearly defined, giving rise to an artificial look, and applying an additional blurring to the color components generates a more realistic looking chromatic aberration on the edge of the first user interface object. For example, as described with reference to FIG. 6AO, a blur effect is applied over the chromatic aberration of the internal content in the simulated area 6801.

In some embodiments, displaying the first user interface object with the first object appearance that simulates refraction of the portion of the first content with the first content appearance by the first user interface material in the edge portion of the first user interface material includes: displaying, via the one or more display generation components, a first subregion of the first user interface object with a first regional object appearance that simulates a first amount of refraction of a portion of the first content that is within the threshold distance from a first portion of the first boundary (e.g., a portion of the outline of the first user interface object on the first user interface, that has a first radius of curvature, or a first range of monotonically changing radii of curvatures), by the first user interface material in the first subregion of the first user interface object; and displaying, via the one or more display generation components, a second subregion of the first user interface object with a second regional object appearance that simulates a second amount of refraction of a portion of the first content that is within the threshold distance from a second portion of the first boundary (e.g., a portion of the outline of the first user interface object on the first user interface, that has a second radius of curvature, or a second range of monotonically changing radii of curvatures), by the first user interface material in the second subregion of the first user interface object. In some embodiments, the first subregion of the first user interface object (e.g., corresponding to the first portion of the first boundary) is different from the second subregion of the first user interface object (e.g., corresponding to the second portion of the first boundary); the first regional object appearance is different from the second regional object appearance (e.g., differing in regional object appearance due to difference in the portions of first content that is used as basis for the simulated refraction, and/or due to simulated thicknesses and radii of curvature of the first user interface material in the first and second subregions of the first user interface object); the first amount of refraction is different from the second amount of refraction (e.g., greater amount of refraction for smaller radius of curvature and/or greater rate of change in simulated thicknesses); and the first portion of the first boundary is different from the second portion of the first boundary (e.g., straighter portions vs. curved portions, and/or portions with greater radius of curvature vs. portions with smaller radius of curvature). For example, in some embodiments, the simulated refraction (e.g., visual distortion and color separation) has different magnitudes along different portions of an edge of the first user interface object, e.g., depending on the local radii of curvature of the outline and/or the rate of change in simulated thicknesses of the first user interface material. For example, as described with reference to FIG. 6AO, the levels of distortion of the internal content are based on a curvature of the boundary at a respective position.

In some embodiments, the first portion of the first boundary has a first degree of curvature (e.g., the first portion is a straight portion of the first boundary). For example, the first portion of the first boundary is a straight edge on the outline of the first user interface object against the first user interface. In some embodiments, the second portion of the first boundary has a second degree of curvature that is greater than the first degree of curvature (e.g., the second portion is a curved portion of the first boundary). For example, the second portion of the first boundary is a curved edge on the outline of the first user interface object against the first user interface. In some embodiments, the first amount of refraction is smaller than the second amount of refraction (e.g., smaller amount of refraction for greater radius of curvature and/or smaller changes in simulated thicknesses). For example, in some embodiments, the simulated refraction is weaker or not shown along a straight edge, and is stronger along a curved edge of the first user interface object. For example, as described with reference to FIG. 6AO, a greater amount of distortion is applied to a curved edge with a greater amount of curvature than an amount of distortion applied to a relatively straight edge with a lesser amount of curvature.

In some embodiments, the first portion of the first boundary is adjacent to the second portion of the first boundary in a continuous curved portion of the first boundary (e.g., the simulated refraction gradually changes in intensity along the edge, such as a curved portion of the edge of the first user interface object that has monotonically increasing radii of curvature, monotonically decreasing radii of curvature, or otherwise changing radii of curvature). For example, as described with reference to FIG. 6AO, the simulated area 6801 is created or enclosed by a boundary that gradually changes in curvature.

In some embodiments, displaying the first user interface object with the first object appearance that simulates refraction of the portion of the first content with the first content appearance by the first user interface material in the edge portion of the first user interface material includes: in accordance with a determination that a degree of curvature increases along the continuous portion of the first boundary, in a direction from the first portion of the first boundary to the second portion of the first boundary, increasing an amount of simulated refraction applied in the first subregion and the second subregion of the edge portion of the first user interface material, along the direction from the first portion of the first boundary to the second portion of the first boundary (e.g., continuously increasing intensity of simulated refraction with gradually increasing radii of curvature along the curved outline of the first user interface object); and in accordance with a determination that the degree of curvature decreases along the continuous portion of the first boundary, in the direction from the first portion of the first boundary to the second portion of the first boundary, decreasing the amount of simulated refraction applied in the first subregion and the second subregion of the edge portion of the first user interface material, along the direction from the first portion of the first boundary to the second portion of the first boundary (e.g., continuously decreasing intensity of simulated refraction with gradually decreasing radii of curvature along the curved outline of the first user interface object). For example, in some embodiments, the simulated refraction changes monotonically as a degree of curvature of the edge increases (e.g., the simulated refraction is larger for greater degree of curvature and smaller for lesser degree of curvature in the first user interface material). For example, in some embodiments, for a sharper corner of the first user interface object, the regional object appearance is generated based on a larger amount or intensity of simulated refraction of internal content in the corner portion of the first user interface object; and for a straight edge or curved side of the first user interface object, the region object appearance is generated based on a smaller amount or intensity of simulated refraction of the internal content in the edge portion of the first user interface object corresponding to the straight edge or curved side of the first user interface object. In some embodiments, a greater radius of curvature corresponds to a greater degree of curvature of a curve, and is less flat, while a flat edge has zero curvature and zero radius of curvature. For example, as described with reference to FIG. 6AO, a greater amount of distortion is applied to a curved edge with a greater amount of curvature than an amount of distortion applied to a relatively straight edge with a lesser amount of curvature.

In some embodiments, the first user interface includes second content that is located outside of the first boundary of the first user interface object (e.g., the second content is external to the first user interface object, and includes content in the first user interface that underlies the first user interface object and/or that is located near the first user interface object); a portion of the second content is within a second threshold distance from the first boundary, outside the first boundary of the first user interface object (e.g., the portion of the second content includes at least a portion of another user interface object or at least a portion of background content that underlies the first user interface object and/or is adjacent to the outline of the first user interface object on the first user interface); the portion of the second content has first external content appearance (e.g., including images, icons, text, colors, lines, and/or patterns, and optionally, other user interface objects that include the user interface material analogous to the first user interface material of the first user interface object), and the first object appearance simulates refraction of the portion of the second content, with the first external content appearance, by the first user interface material in the edge portion of the first user interface material, without differentiating an intensity of simulated refraction in the first subregion of the first user interface object and the second subregion of the first user interface object (e.g., using the same degree of external refraction (e.g., distortion and blur) for portions of the edge region that have a different internal refractions). For example, in some embodiments, a portion of the edge portion of the first user interface material has uniform simulated thickness, but changing radius of curvature, along an outline of the first user interface object on the first user interface, and the simulated refraction of the internal content has different strengths in different subregions of the edge portion of the first user interface material in a direction along the outline of the first user interface object, depending on the radii of curvature in the different subregions of the edge portion of the first user interface material; however, the simulated refraction of the external content in these subregions have the same strength because the simulated thicknesses of the first user interface material are substantially constant in these different subregions (e.g., because they are at substantially the same distances from the outline of the first user interface object). For example, as described with reference to FIGS. 6A-6B4, in some embodiments a user interface object displayed with the simulated glass material is displayed with external refraction and internal refraction (e.g., including internal refraction as described with respect to the distortion in FIG. 6AO). In some embodiments, the user interface object 6800 is displayed with external refraction that includes distorting external and/or background content.

In some embodiments, while displaying the first user interface including the first user interface object, the computer system detects, via the one or more input devices, an input that corresponds to a request to interact with a respective portion of the first user interface object (e.g., a tap, an air tap, an air pinch, a button press input or another selection input detected while attention of the user is directed to the respective portion of the user interface object); and in response to detecting the input that corresponds to the request to interact with the respective portion of the first user interface object, performs an operation in accordance with the respective portion of the first user interface object (e.g., a respective selectable option and/or control among a plurality of selectable options and/or controls in the first user interface object) and the user input that corresponds to the request to interact with the respective portion of the first user interface object (e.g., in accordance with one or more characteristics of the user input, such as movement speed, movement direction, location, duration, input type, intensity, and/or other input characteristics). For example, as described with reference to FIG. 6AP, in some embodiments, user inputs directed to the user interface object 6800 cause the device 100 to perform one or more operations associated with the user interface object 6800.

In some embodiments, the first user interface object is a menu (e.g., a share sheet, a drop down menu, and/or other types of menu); the first content includes a plurality of selectable options that is located within a platter comprising the first user interface material; and performing the operation in accordance with the respective portion of the first user interface object and the user input that corresponds to the request to interact with the respective portion of the first user interface object includes: in accordance with a determination that the respective portion of the first user interface object corresponds to a first selectable option among the plurality of selectable options, performing an operation that corresponds to the first selectable option (e.g., displaying a user interface of a first communication application that corresponds to the first selectable option, displaying a communication with a first destination corresponding to the first selectable option, and/or performing an operation to share the content in accordance with the first selectable option); and in accordance with a determination that the respective portion of the first user interface object corresponds to a second selectable option, different from the first selectable option, among the plurality of selectable options, performing an operation that corresponds to the second selectable option, different from performing the operation corresponding to the first selectable option (e.g., displaying a user interface of a second communication application that corresponds to the second selectable option, displaying a communication with a second destination corresponding to the second selectable option, and/or performing an operation to share the content in accordance with the second selectable option). For example, in some embodiments, the first user interface object is an affordance such as a share button that transforms into a share sheet with multiple selectable share options. In some embodiments, the first user interface material of the share button is transformed into the first user interface material of the share sheet, and has an object appearance that initially includes simulated refraction of the icon of the share button, that subsequently includes simulated refraction of the selectable share options of the share sheet. In some embodiments, the first user interface object is a share sheet that includes the first user interface material, and the first content includes the icons and/or text corresponding to different selectable options within the share sheet. For example, in some embodiments, scrolling the plurality of selectable options in the share sheet, and/or selecting a selectable option in the share sheet, causes a change in the content appearance of the plurality of selectable options relative to the edge of the first user interface material, which in turn causes a change in the object appearance of the share sheet that simulates a change in simulated refraction of the plurality of selectable options in the edge region of the first user interface material. For example, as described with reference to FIG. 6AP, in some embodiments, the user interface object 6800 is a platter with a plurality of selectable options.

In some embodiments, the first user interface object is a tool bar; the first content includes a plurality of icons that correspond to a plurality of tools that is within a platter comprising the first user interface material; and performing the operation in accordance with the respective portion of the first user interface object and the user input that corresponds to the request to interact with the respective portion of the first user interface object includes: in accordance with a determination that the respective portion of the first user interface object corresponds to a first icon among the plurality of icons, enabling a first tool that corresponds to the first icon (e.g., enabling or switching to a first drawing tool for drawing, displaying a first set of options corresponding to the first tool, and/or performing an operation to enable or use the first tool in accordance with selection of the first icon); and in accordance with a determination that the respective portion of the first user interface object corresponds to a second icon, different from the first icon, among the plurality of icons, enabling a second tool that corresponds to the second icon (e.g., enabling or switching to a second drawing tool for drawing, displaying a second set of options corresponding to the second tool, and/or performing an operation to enable or use the second tool in accordance with selection of the second icon). For example, in some embodiments, scrolling the plurality of tools in the tool bar, and/or selecting a selectable icon in the tool bar, causes a change in the appearance of the content in the edge portion of the tool bar, which in turn causes changes in the simulated refraction of the tools in the edge region of the first user interface material. For example, as described with reference to FIG. 6AP, in some embodiments, the user interface object 6800 is displayed for a writing toolkit.

In some embodiments, the first user interface object is a control; the first content includes a visual indication of a state of the control; and performing the operation in accordance with the respective portion of the first user interface object and the user input that corresponds to the request to interact with the respective portion of the first user interface object includes: in accordance with a determination that the visual indication of the state of the control corresponds to a first state of the control, performing an operation that corresponds to the first state of the control (e.g., when the visual indication includes first text or a first glyph corresponding to navigating to a higher level user interface, the computer system navigates to the higher level user interface); and in accordance with a determination that the visual indication of the state of the control corresponds to a second state of the control, different from the first state of the control, performing an operation that corresponds to the second state of the control, different from the operation that corresponds to the first state of the control (e.g., when the visual indication includes second text or a first glyph corresponding to navigating to a root-level user interface, the computer system navigates to the root-level user interface). For example, in some embodiments, changing the state of the control causes a visual indication in the control to change in appearance, which results in a change in the object appearance in the edge portion of the first user interface material (e.g., the size of the user interface material changes, the text within the user interface material changes, and the simulated refraction of the text near the edge of the user interface material changes as well, in response to the detection of the first event). For example, as described with reference to FIG. 6AP, in some embodiments, the user interface object 6800 is a button or other control that, when selected by a user input, causes the device 100 to perform an operation associated with the button.

In some embodiments, the first user interface is a content sharing user interface; the content includes one or more icons associated with sharing content (e.g., representations of one or more users with which content can be shared, one or more devices with which content can be shared, and/or one or more applications with which content can be shared); the first event that causes the change in content appearance includes an input (e.g., a drag input, a swipe input, an air pinch and drag input, and/or a click and drag input) directed to the one or more icons that causes the one or more icons to be scrolled relative to the first boundary; and the second object appearance includes simulated refraction of one of the icons in the one or more icon associated with sharing content (e.g., the object appearance of the first user interface object includes distortion and color separation of pixel values within and/or near the edge portion of the user interface material to simulate refraction of one or more icons as the one or more icons moves relative to and/or into the edge portion of the user interface material). For example, as described with reference to FIG. 6AP, in some embodiments, the user interface object 6800 is a share sheet platter with scrollable options (e.g., including recommended contacts and/or recommended applications) for sharing content.

In some embodiments, the first user interface is a drawing tool user interface; the content includes one or more user interface elements corresponding to drawing tools (e.g., representations of one or more pens, pencils, crayons, paintbrushes, erasers, and/or other drawing tools); the first event that causes the change in content appearance includes an input (e.g., a drag input, a swipe input, an air pinch and drag input, and/or a click and drag input) directed to the one or more user interface elements corresponding to drawing tools that causes the one or more user interface elements corresponding to drawing tools to be scrolled relative to the first boundary; and the second object appearance includes simulated refraction of a respective user interface element, of the one or more user interface elements, wherein the respective user interface element corresponds to a respective drawing tool (e.g., the object appearance of the first user interface object includes distortion and color separation of pixel values within and/or near the edge portion of the user interface material to simulate refraction of one or more user interface elements corresponding to drawing tools as the one or more user interface elements moves relative to and/or into the edge portion of the user interface material). For example, as described with reference to FIG. 6AP, in some embodiments, the user interface object 6800 is a writing toolkit for drawing content in the user interface 6810 in which a user selects which tool to be used to add content to the user interface 6810.

In some embodiments, the first user interface is a button that corresponds to a first function; the content includes one or more characters indicating the first function of the button (e.g., one or more letters, numbers, and/or glyphs that indicate a function of a button, such as “back,” “mailboxes,” “inbox,” or “<”); the first event that causes the change in content appearance includes an input corresponding to a request to switch from a first view of a user interface to a second view of a user interface. In some embodiments, the first event corresponds to selection of the button (e.g., a tap input, air tap input, air pinch input or other selection input while attention is directed to the button). In some embodiments, the first event corresponds to selection of a respective user interface object (e.g., an object displayed within the first view) that corresponds to the second view (e.g., a tap input, air tap input, air pinch input or other selection input while attention is directed to the respective user interface object). In some embodiments, first event corresponds to a navigation input for navigating between views such as a drag input, a swipe input, an air pinch and drag input, and/or a click and drag input directed to an edge of a user interface that indicates navigation backward to a previous view or forward to a next view. In some embodiments, the first event corresponds to detecting an end of an input (e.g., a liftoff of a contact from a touch-sensitive surface, an up-click of a button, and/or an end of an air pinch gesture), optionally following detection of the input and/or after detection of motion of an input element that performed the input (e.g., a lift off of a contact after detecting movement of the contact). In some embodiments, the second object appearance includes simulated refraction of the one or more characters indicating the first function of the button (e.g., refraction of the one or more characters as the function of the button changes to a second function that is different from the first function while the characters indicating the first function of the button are removed from the button). In some embodiments, the event also causes a change in function of the button from a first function to a second function and in addition to (or instead of) displaying simulated refraction of the one or more characters indicating the first function of the button (e.g., as the button ceases to have the first function), the computer system displays simulated refraction of one or more characters indicating the second function as the button changes to have the second function. For example, as described with reference to FIG. 6AP, in some embodiments, the user interface object 6800 is a button, such as button 738, button 740 and button 742 (e.g., in FIG. 5Q), where the text in the button 738 indicate the button 738 is for canceling preparation of a new message draft, the text and/or symbols in the button 740 indicates the button 740 is for performing an operation for changing a text size and the symbol in button 742 indicates the button 742 is for performing an operation for sending a message.

It should be understood that the particular order in which the operations in FIG. 18 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 13000, 14000, 15000, 16000, and/or 17000) are also applicable in an analogous manner to method 18000 described above with respect to FIG. 18. For example, the buttons, user interfaces, controls, visual deemphasis, virtual effects, described above with reference to method 18000 optionally have one or more of the characteristics of the buttons, user interfaces, controls, visual deemphasis, virtual effects, described herein with reference to other methods described herein (e.g., methods 7000, 8000, 9000, 10000, 11000, 12000, 13000, 14000, 15000, 16000, and/or 17000). For brevity, these details are not repeated here.

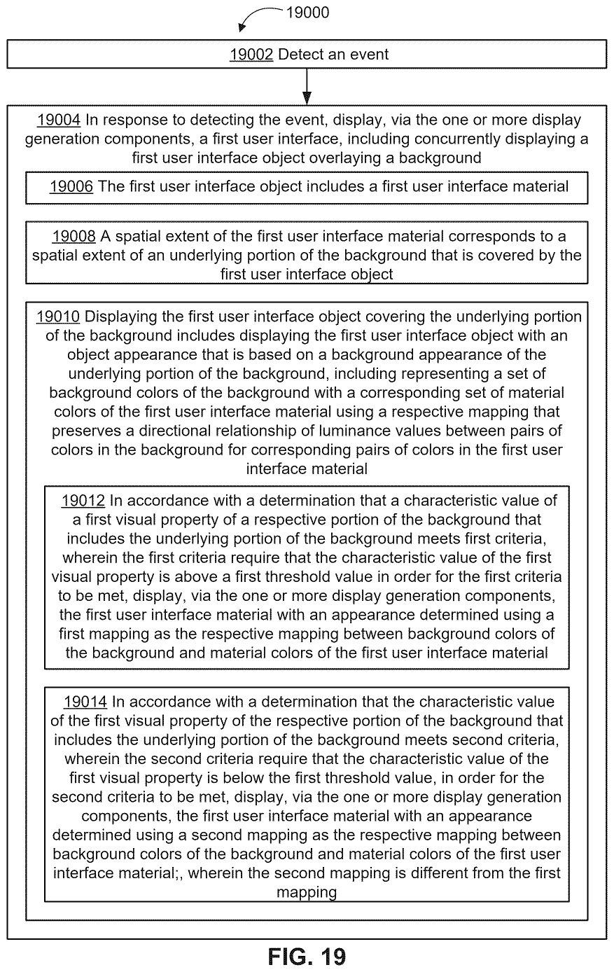

FIG. 19 is a flow diagram illustrating a method 19000 of modifying internal content that is displayed in a user interface object in accordance with some embodiments. In some embodiments, the method 19000 is performed at a computer system (e.g., portable multifunction device 100, device 300 in FIGS. 1A-6AP) that is in communication with one or more input devices (e.g., touch-sensitive surfaces, optical sensors, motion sensors, proximity sensors, gyros, accelerometers, ambient light sensors, joysticks, buttons, keyboards, handheld controllers, pointer devices, and/or other types of input devices) and one or more display generation components (e.g., touch-screen displays, standalone displays, LED displays, LCD displays, head-mounted displays, heads-up displays, foldable displays, flexible displays, and/or other types of display generation components that provides one or more display areas in which content, user interfaces, and/or controls can be made visible to a user). Some operations in method 19000 are, optionally, combined and/or the order of some operations is, optionally, changed. It will be understood that in the examples described with reference to method 19000 below, specific values are provided as examples of a range of possible values, and any specific value could be replaced with a value that is +/−33% of the specific value listed.

Displaying a user interface object with a simulated user interface material that adapts based on underlying content leverages the user's real world experience to provide information about the spatial relationships between the user interface elements, and to provide visual feedback regarding the effect of user inputs, inform the user about the change in the state of the computer system and application, and guide the user about how to use his/her input to change the system state and/or application state. The appearance of the user interface material also provides visual feedback regarding the type of user interface object and its associated functions. Some of the appearance characteristics are used to balance the need for visual saliency of the user interface objects against the background, visual saliency of the internal content of the user interface objects, and reduce visual distraction of the underlying content, and the efficiency in generating these appearances. Using adaptive materials for user interface elements improves the legibility of content even when the content can have varying levels of luminance, brightness, and/or contrast, which enables a user to use a device for shorter periods of time, which saves energy and improves battery life. Using adaptive materials for user interface elements enables the user interface elements to be more transparent over a wider range of content, and an increased transparency of user interface elements enables a user to use a device for shorter periods of time, which saves energy and improves battery life. Automatically changing an appearance of user interface elements (e.g., adapting to a luminance of underlying content) when one or more criteria are met reduces the number of inputs (e.g., navigating through settings user interfaces and menus to set the values for parameters to adjust the appearance of user interface elements) that would otherwise be required to generate a similar effect, which saves energy and improves battery life.

A computer system detects (19002) an event (e.g., including detecting a user input, detecting a change in system or application state, detecting a change in contextual conditions that meets criteria for displaying a user interface, moving a user interface, moving an object, displaying an object, and/or changing a user interface and/or object). In some embodiments, detecting the event causes display of an application, moving a background under an object, moving an object over a background, displaying an object, and/or updating a background and/or object of a currently displayed user interface.

In response to detecting the event, the computer system displays (19004), via the one or more display generation components, a first user interface, including concurrently displaying a first user interface object (e.g., a button, a control, a platter, a header, a dock, a container object, and/or other types of user interface objects that relies on an outline and/or visual properties of a user interface material to establish a boundary and/or spatial extent of the user interface objects against its surrounding content) overlaying a background (e.g., an underlying wallpaper, other user interface objects, another platter, another window, text, images, and/or other types of visual content that are distinguished from the first user interface object in the first user interface, that are external to the first user interface object, and/or that are at least partially obscured by the first user interface object from the viewpoint of the user.

The first user interface object includes (19006) (and/or is visually associated with) a first user interface material (e.g., the first user interface object includes the first user interface material, and the spatial extent of the first user interface material is used to indicate the spatial extent of the first user interface object). A spatial extent of the first user interface material (e.g., a glassy material, and/or a user interface material with some or all of the properties as described in the present disclosure) corresponds (19008) to a spatial extent of an underlying portion of the background that is covered by the first user interface object (e.g., the outline, shape, and size of the first user interface material against the background is used to determine which portion of the background is overlaid, covered, and/or visually obscured by the first user interface object). Displaying the first user interface object covering the underlying portion of the background includes (19010) displaying the first user interface object with an object appearance (e.g., an object appearance based on a “light user interface material” appearance or a “dark user interface material” appearance, an object appearance based on a “light” variant of the user interface material or a “dark” variant of the user interface material) that is based on a background appearance of the underlying portion of the background, including representing a set of background colors of the background with a corresponding set of material colors of the first user interface material using a respective mapping that preserves a directional relationship of luminance values between pairs of colors in the background (e.g., monotonically increasing input background luminance values correspond to monotonically increasing output material luminance values, and monotonically decreasing input background luminance values correspond to monotonically decreasing output material luminance values) for corresponding pairs of colors in the first user interface material (e.g., a first material color mapped to the respective first background color and a second material color mapped to the respective second background color); In FIG. 6B5, the mappings 6104a-6104h are representatives of mappings used for light user interface materials, and the mappings 6106a-6105h are representatives of mappings used for dark user interface materials, and these mappings have positive slopes in the direction of monotonically increasing background point luminance values, which correspond to monotonically increasing material point luminance values. In some embodiments, colors that are progressively darker in the background are represented by colors that are progressively darker in the first user interface material, and colors that are progressively lighter in the background are represented by colors that are progressively lighter in the first user interface material. As such, the object appearance is based on the background appearance of the portion of the background without having a luminance that is inverted relative to a luminance of the portion of the background.

Displaying the first user interface object with an object appearance that is based on a background appearance of the underlying portion of the background includes (19012), in accordance with a determination that a characteristic value (e.g., static average value, running average value, and/or other average or cumulative values) of a first visual property (e.g., luminance, gray value, brightness, and/or other measures of brightness and/or contrast) of a respective portion of the background that includes the underlying portion of the background (e.g., the respective portion of the background includes the underlying portion of the background and, optionally, a surrounding portion that is within a threshold distance from the outline of the first user interface object, a surrounding portion that corresponds to the first user interface object and one or more related user interface objects, and/or a surrounding portion that corresponds to another user interface object including the first user interface object) meets first criteria (e.g., criteria used for identifying a “light” background and/or background condition for using a “light” user interface material for the first user interface object), wherein the first criteria require that the characteristic value of the first visual property is above a first threshold value (e.g., a first luminance threshold value, 0.7 luminance, 0.3 luminance, and/or another threshold value for the first visual property that corresponds to a “light” or high luminance background) in order for the first criteria to be met, displaying, via the one or more display generation components, the first user interface material with an appearance determined using a first mapping as the respective mapping between background colors of the background and material colors of the first user interface material (e.g., the appearance simulates refraction of the underlying portion of the background and/or includes other visual effects associated with the first user interface material, such as the visual effects described with respect to FIGS. 6A-6C). In some embodiments, the first mapping is a mapping for the “light” variant of the user interface material. In some embodiments, the respective portion of the background that includes the underlying portion of the background covered by the user interface object includes the portion of the background 6128 covered by the user interface object 6136, and optionally additional portions outside of the outline of the user interface object 6136, in FIG. 6B8. In some embodiments, the characteristic value of the first visual property is an average input luminance (AIL) of the respective portion of the background, which is used as an example in FIGS. 6B5-6B13. In some embodiments, as shown in FIG. 6B5, the mappings 6104a-6104h are respective mappings that have corresponding average input luminance values for a relevant portion of the user interface object exceeding a threshold luminance value of 0.7 (e.g., an example of the characteristic value of the first display property meeting the first criteria), and/or that have corresponding average luminance for the relevant portion of the user interface object exceeding a threshold luminance of 0.3 and meeting one or more other conditions for choosing the “light” variant of the user interface material (e.g., another example of the characteristic value of the first display property meeting the first criteria), and the material appearance of the user interface material is generated based on a respective mapping selected from the set of mappings 6104a-6104h, based on the average input luminance of the relevant portion of the background. In FIG. 6B9, the appearance 6122a is an example of a “light” material appearance for a background appearance 6124a that meets the first criteria and does not meet the second criteria below.

Displaying the first user interface object with an object appearance that is based on a background appearance of the underlying portion of the background includes (19014), in accordance with a determination that the characteristic value of the first visual property of the respective portion of the background that includes the underlying portion of the background meets second criteria (e.g., criteria used for identifying a “dark” background and/or background condition for using a “dark” user interface material for the first user interface object), wherein the second criteria require that the characteristic value of the first visual property is below the first threshold value (e.g., the first threshold value is optionally selected based on a current state or settings of the computer system, and may be a constant value or a value currently selected from of a plurality of constant values), in order for the second criteria to be met (e.g., if the portion of the background does not meet the criteria to be a “light” background, it is considered a “dark” background), displaying, via the one or more display generation components, the first user interface material with an appearance determined using a second mapping as the respective mapping between background colors of the background and material colors of the first user interface material (e.g., the second mapping is a mapping for the “dark” user interface material); In some embodiments, the appearance simulates refraction of the underlying portion of the background and/or includes other visual effects associated with the first user interface material, as described with respect to FIGS. 6A-6C), wherein the second mapping is different from the first mapping. In some embodiments, as shown in FIG. 6B5, the mappings 6106a-6106h are respective mappings that have corresponding average input luminance values for a relevant portion of the user interface object below the threshold luminance value of 0.7 and meeting other conditions for choosing the “dark” variant of the user interface material (e.g., an example of the characteristic value of the first display property meeting the second criteria), and/or that have corresponding average luminance for the relevant portion of the user interface object below the threshold luminance of 0.3 (e.g., another example of the characteristic value of the first display property meeting the second criteria), and the material appearance of the user interface material is generated based on a respective mapping selected from the set of mappings 6106a-6106h, based on the average input luminance of the relevant portion of the background. In FIG. 6B9, the appearance 6126d is an example of a “dark” material appearance for a background appearance 6124e that meets the second criteria and does not meet the first criteria. In some embodiments, the “light” user interface material and the “dark” user interface material are both substantially transparent to the underlying content, and do not invert the underlying content to create an artificial contrast between the appearance value of the first user interface object and the characteristic value of the background content. In some embodiments, the first mapping and/or the second mapping map respective input background colors in a first background luminance range (e.g., a full range [0-1], or a subrange [0, a value smaller than 1]) to respective output material colors that have higher respective luminance values than the respective luminance values of the corresponding input colors. In some embodiments, the first mapping and/or the second mapping map respective input background colors in a second background luminance range (e.g., a subrange [a value smaller than 1, 1]) to respective output material colors that have lower respective luminance values than the respective luminance values of the corresponding input colors. In some embodiments, both the first mapping and the second mapping corresponds to the “light” user interface material, but corresponding to different mapping parameters (e.g., different mappings that correspond to different average input luminance values in the “light user interface material” average input luminance range [0.3-1] or [0.7-1]). In some embodiments, both the first mapping and the second mapping corresponds to the “dark” user interface material, but corresponding to different mapping parameters (e.g., different mappings that correspond to different average input luminance values in the “dark user interface material” average input luminance range [0-0.7] or [0-0.3]).

In some embodiments, the respective mapping (e.g., the first mapping and/or the second mapping) includes at least a first parameter (e.g., a multiplier, a boost, a reduction, a transformation matrix, a functional relationship, a slope, and/or other types of one or more parameters) that affects how background colors of the background are mapped to material colors of the first user interface material. In some embodiments, a parameter value of the first parameter changes in accordance with one or more changes in the characteristic value of the first visual property of the respective portion of the background that includes the underlying portion of the background. For example, in some embodiments, the first mapping changes (e.g., increases, or decreases) a respective luminance value of a respective background color by a first respective amount that is based on the respective luminance value of the respective background color, and the second mapping changes (e.g., increases or decreases) the respective luminance value of the respective background color by a second respective amount that is based on the respective luminance value of the respective background color, where the second respective amount is, optionally, different from the first respective amount, depending on the respective luminance value of the respective background color (e.g., for different respective luminance values of different background colors, the respective luminance values of the different background colors are changed (e.g., increased or decreased) by different amounts in the first mapping and the second mapping, to arrive at the respective luminance values of the corresponding material colors). For example, as illustrated in FIG. 6B5, if the AIL of the respective portion of the background is 0.9, which is above the threshold luminance of 0.7 for choosing the “light” variant of the user interface material corresponding to mapping 6104b, when converting an input background color for a respective point (e.g., pixel location, or a small unit area larger than a single pixel) in the background to its corresponding output material color in a corresponding point (e.g., pixel location, or a small unit area larger than a single pixel, and optionally different from the size of the input background point) of the user interface material, the luminance of the output material color observes and/or obeys the constraint imposed by the mapping 6104b and the luminance of the input background color. In contrast, if the AIL of the respective portion of the background is 0.1, which is below the threshold luminance of 0.7 and meets the conditions for choosing the “dark” variant of the user interface material corresponding to mapping 6106b, when converting an input background color for a respective point (e.g., pixel location, or a small unit area larger than a single pixel) in the background to its corresponding output material color in a corresponding point (e.g., pixel location, or a small unit area larger than a single pixel, and optionally different from the size of the input background point) of the user interface material, the luminance of the output material color observes and/or obeys the constraint imposed by the mapping 6106b and the luminance of the input background color. Since the mapping 6104b and the mapping 6106b are on different curves (e.g., curves with different upper and lower output luminance thresholds, for the same input luminance range) and do not overlap, they represent a difference in at least one parameter that changes in value as the average in luminance in the relevant portion of the background (e.g., including the portion covered by the user interface object 6136) changes within the corresponding input value range.

In some embodiments, the first mapping includes at least the first parameter (e.g., a multiplier, a boost, a reduction, a functional relationship, a slope, a transformation matrix, and/or other types of one or more parameters) that affects how background colors of the background are mapped to material colors of the first user interface material. In some embodiments, the second mapping includes at least the first parameter (e.g., a multiplier, a boost, a reduction, a functional relationship, a slope, a transformation matrix, and/or other types of one or more parameters) that affects how background colors of the background are mapped to material colors of the first user interface material. In some embodiments, the parameter value of the first parameter changes in the first mapping and in the second mapping (e.g., optionally by different amounts of changes), in accordance with one or more changes in the characteristic value of the first visual property of the respective portion of the background that includes the underlying portion of the background. For example, in some embodiments, the first mapping changes (e.g., increases, or decreases) a respective luminance value of a respective background color by a first respective amount that is based on the respective luminance value of the respective background color, and the second mapping changes (e.g., increases or decreases) the respective luminance value of the respective background color by a second respective amount that is based on the respective luminance value of the respective background color, where the second respective amount is different from the first respective amount, depending on the respective luminance value of the respective background color (e.g., for different respective luminance values of different background colors, the respective luminance values of the different background colors are changed (e.g., increased or decreased) by different amounts in the first mapping and the second mapping, to arrive at the respective luminance values of the corresponding material colors). As shown in FIG. 6B5, the mapping that is used for converting background colors to corresponding material colors is selected from a plurality of available mappings that are associated with light user interface materials, based on the value of the AIL of the relevant portion of the background, when the AIL meets the criteria for selecting a light user interface material. The plurality of available mappings for different AIL values are on different curves 6104a-6104h (e.g., have different slopes and mapping relationships between input background point luminance and output material point luminance), correspond to different parameter values for a respective parameter or different sets of parameters values for a respective set of parameters, that are used in the conversion from the background colors to the material colors. Therefore, when the AIL changes value, a different mapping from the plurality of mappings 6104a-6104h is selected to govern the conversion from the background colors to the material colors. This is illustrated in FIG. 6B9, for example, where for the light variants 6122a-6122d of the user interface material, different mappings are used to convert the same set of background colors to different sets of corresponding material colors in the user interface object 6136, in accordance with some embodiments. Similarly, as shown in FIG. 6B5, the mapping that is used for converting background colors to corresponding material colors is selected from a plurality of available mappings that are associated with dark user interface materials, based on the value of the AIL of the relevant portion of the background, when the AIL meets the criteria for selecting a dark user interface material. The plurality of available mappings for different AIL values are on different curves 6106a-6106h (e.g., have different slopes and mapping relationships between input background point luminance and output material point luminance), correspond to different parameter values for a respective parameter or different sets of parameters values for a respective set of parameters, that are used in the conversion from the background colors to the material colors. Therefore, when the AIL changes value, a different mapping from the plurality of mappings 6106a-6106h is selected to govern the conversion from the background colors to the material colors. This is illustrated in FIG. 6B9, for example, where for the dark variants 6126a-6126d of the user interface material, different mappings are used to convert the same set of background colors to different sets of corresponding material colors in the user interface object 6136, in accordance with some embodiments.

In some embodiments, the respective mapping has a respective value range for the material colors (e.g., a respective output luminance range) of the first user interface material. In some embodiments, a first end value (e.g., an upper boundary, or a lower boundary) of the respective value range for the material colors of the first user interface material is based on a first offset from the characteristic value of the first visual property of the respective portion of the background that includes the underlying portion of the background. In some embodiments, the upper boundary of the respective value range for the material colors is equal to the average input luminance of the respective portion of the background plus the first offset (e.g., a positive value for the upper boundary). In some embodiments, the first offset has a first offset value in accordance with a determination that the characteristic value of the first visual property meets the first criteria; and the first offset has a second offset value, different from the first offset value, in accordance with a determination that the characteristic value of the first visual property meets the second criteria. For example, in some embodiments, the first offset value is +0.45 or another positive value less than 1, for average input luminance (AIL) that meets the criteria for “light user interface material.” In some embodiments, the second offset value is 0.25 or another positive value less than 1 and smaller than the first offset value, for average input luminance (AIL) that meets the criteria for “dark user interface material.” For example, in some embodiments, the first offset value is −0.15 or another negative value greater than −1, for average input luminance (AIL) that meets the criteria for “light user interface material.” In some embodiments, the second offset value is −0.2 or another negative value greater than −1 and smaller than the first offset value, for average input luminance (AIL) that meets the criteria for “dark user interface material.” This is illustrated in FIG. 6B5, where the upper end value of the range of the material point luminance values (e.g., on the vertical axis) for the light user interface material is calculated by increasing the AIL of the relevant portion of the background by an offset of 0.45 (optionally, subject to capping from above at 1.03), and a lower end value of the range of the material point luminance values is calculated by decreasing the AIL by an offset of 0.15, in some embodiments. As a result, the ranges of the material point luminance values for a pair of different AIL values differ, optionally by the amount of difference between the pair of AIL values, in accordance with some embodiments. In some embodiments, the upper end value of the range of the material point luminance values (e.g., on the vertical axis) for the dark user interface material is calculated by increasing the AIL of the relevant portion of the background by an offset of 0.25 (optionally, subject to capping from above at 0.8), and a lower end value of the range of the material point luminance values is calculated by decreasing the AIL by an offset of 0.2 (optionally, subject to capping from below at 0.1), in some embodiments. As a result, the ranges of the material point luminance values for a pair of different AIL values differ, optionally by the amount of difference between the pair of AIL values, in accordance with some embodiments.

In some embodiments, a second end value, different from the first end value of the respective value range (e.g., the first end value and the second end value are the upper boundary and lower boundary of the respective value range) for the material colors of the first user interface material is based on a second offset from the characteristic value of the first visual property of the respective portion of the background that includes the underlying portion of the background. In some embodiments, the lower boundary of the respective value range for the material colors is equal to the average input luminance of the respective portion of the background plus the second offset (e.g., a negative value for the lower boundary). In some embodiments, the second offset is different from the first offset (e.g., different from the first offset value when the first offset has the first offset value, and/or different from the second offset value when the first offset has the second offset value). For example, in some embodiments, for the first mapping, the first end value is an upper boundary of the output luminance range that is the average input luminance plus the first offset (e.g., AIL+0.25 for dark user interface material, or AIL+0.45 for light user interface material), and the second end value is the lower boundary of the output luminance range that is the average input luminance plus the second offset (e.g., AIL−0.2 for dark user interface material, or AIL−0.15 for light user interface material). This is illustrated in FIG. 6B5, where the upper end value of the range of the material point luminance values (e.g., on the vertical axis) for the light user interface material is calculated by increasing the AIL of the relevant portion of the background by an offset of 0.45 (optionally, subject to capping from above at 1.03), and a lower end value of the range of the material point luminance values is calculated by decreasing the AIL by an offset of 0.15, in some embodiments. As a result, the upper end value and the lower end value of the range of the material point luminance values for a respective AIL value are offset by different amounts from the respective AIL value, in accordance with some embodiments. In some embodiments, the upper end value of the range of the material point luminance values (e.g., on the vertical axis) for the dark user interface material is calculated by increasing the AIL of the relevant portion of the background by an offset of 0.25 (optionally, subject to capping from above at 0.8), and a lower end value of the range of the material point luminance values is calculated by decreasing the AIL by an offset of 0.2 (optionally, subject to capping from below at 0.1), in some embodiments. As a result, the upper end value and the lower end value of the range of the material point luminance values for a respective AIL value are offset by different amounts from the respective AIL value.

In some embodiments, the characteristic value of the first visual property has a first corresponding value in the respective value range for the material colors in the first mapping. In some embodiments, the characteristic value of the first visual property has a second corresponding value in the respective value range for the material colors in the second mapping. In some embodiments, a difference between a center value in the respective value range for the material colors in the first mapping and the first corresponding value in the first mapping is greater than a difference between a center value in the respective value range for the material colors in the second mapping and the second corresponding value in the second mapping (e.g., the respective value range for the material colors is smaller for the second mapping than the respective value range for the material colors in the first mapping). For example, the vertical value range for the dark user interface material (e.g., a range of 0.45 or another value) is smaller than the vertical value range for the light user interface material (e.g., a range of 0.6 or another value), for a given average input luminance, in accordance with some embodiments. This is illustrated in FIG. 6B5, where the upper end value of the range of the material point luminance values (e.g., on the vertical axis) for the light user interface material is calculated by increasing the AIL of the relevant portion of the background by an offset of 0.45 (optionally, subject to capping from above at 1.03), and a lower end value of the range of the material point luminance values is calculated by decreasing the AIL by an offset of 0.15, in some embodiments. In contrast, the upper end value of the range of the material point luminance values (e.g., on the vertical axis) for the dark user interface material is calculated by increasing the AIL of the relevant portion of the background by an offset of 0.25 (optionally, subject to capping from above at 0.8), and a lower end value of the range of the material point luminance values is calculated by decreasing the AIL by an offset of 0.2 (optionally, subject to capping from below at 0.1), in some embodiments. In an example, for a respective AIL value, e.g., an AIL value of 0.5, the center of the material point luminance range (e.g., center of the range [0.35−0.95]=0.3+0.5=0.8) for the light user interface material (e.g., mapping 6104f) is farther away from the AIL of 0.5, as compared to the center of the material point luminance range (e.g., center of the range [0.3-0.75]=0.225+0.5=0.725) for the dark user interface material (e.g., mapping 6106f). In another example, for a respective AIL value, e.g., an AIL value of 0.4, the center of the material point luminance range (e.g., center of the range [0.25−0.85]=0.3+0.4=0.7) for the light user interface material (e.g., mapping 6104g) is farther away from the AIL of 0.4, as compared to the center of the material point luminance range (e.g., center of the range [0.2−0.65]=0.225+0.4=0.625) for the dark user interface material (e.g., mapping 6106e).

In some embodiments, the first criteria require that the characteristic value of the first visual property is in a first range of values in order for the first criteria to be met. In some embodiments, the second criteria require that the characteristic value of the first visual property is in a second range of values in order for the first criteria to be met. In some embodiments, the first range of values and the second range of values are separated by a third range of values different from the first range of values and the second range of values (e.g., the first range of values is [0, 0.3], the second range of values is [0.7, 1], and the third range of values is [0.3, 0.7]); and In some embodiments, the boundaries that separate the first range of values, the second range of values, and the third range of values may be different from the examples shown above. In some embodiments, displaying the first user interface object covering the underlying portion of the background includes, in accordance with a determination that the characteristic value of the first visual property of the respective portion of the background that includes the underlying portion of the background meets third criteria (e.g., criteria used for identifying a “medium” background and/or background condition for choosing between using a “light” or “dark” user interface material for the first user interface object based on one or more additional factors), wherein the third criteria require that the characteristic value of the first visual property is in the third range of values, in order for the third criteria to be met, and in accordance with a determination that fourth criteria are met, wherein the fourth criteria are evaluated based on one or more factors other than the characteristic value of the first visual property of the respective portion of the background, displaying, via the one or more display generation components, the first user interface material with an appearance determined using the first mapping. In some embodiments, In some embodiments, displaying the first user interface object covering the underlying portion of the background includes, in accordance with a determination that the characteristic value of the first visual property of the respective portion of the background that includes the underlying portion of the background meets third criteria (e.g., criteria used for identifying a “medium” background and/or background condition for choosing between using a “light” or “dark” user interface material for the first user interface object based on one or more additional factors), wherein the third criteria require that the characteristic value of the first visual property is in the third range of values, in order for the third criteria to be met, and in accordance with a determination that the fourth criteria are not met, displaying, via the one or more display generation components, the first user interface material with an appearance determined using the second mapping. For example, when the average input luminance of the respective portion of the background is in the range of [0.3, 0.7], the computer system determines whether to use the first mapping for the light user interface material or the second mapping for the dark user interface material to determine the material colors of the user interface object, based on additional factors other than the average luminance value of the respective portion of the background. This is illustrated in FIG. 6B5, where the mapping 6104a, 6104b, 6104c are representatives of mappings for variants of a light user interface material corresponding to different AIL values (e.g., AIL of 0.95, 0.9, and 0.8, respectively) above a threshold value of 0.7, the mapping 6106a, 6106b, 6106c are representatives of mappings for variants of a dark user interface material corresponding to different AIL values (e.g., AIL of 0.05, 0.1, and 0.2, respectively) below a threshold value of 0.3. In addition, the mappings 6104d-6104h are for variants of the light user interface material with AIL in the range between 0.3-0.7, and the mappings 6106d-6016h are for variants of the dark user interface material with AIL in the range between 0.3-0.7. For a respective AIL value in the AIL range of [0.3-0.7], the computer chooses to use the corresponding mapping for the light user interface material or the corresponding mapping for the dark user interface material based on factors other than the respective AIL value. In FIGS. 6B9, 6B11, 6B12, and 6B13, pairs of material appearances 6122 and 6126, for the same background appearance 6024 (in the second row, third row, and fourth row of FIG. 6B9, and in FIGS. 6B11, 6B12, and 6B13), use different mappings of the same AIL value (e.g., different pairs of mappings for a respective AIL of 0.3, 0.4, 0.5, 0.6, or 0.7) respectively corresponding to the light user interface material and dark user interface material for the same AIL value.

In some embodiments, the fourth criteria are met when the first criteria were most recently met by the characteristic value of the first visual property of the respective portion of the background. In some embodiments, the fourth criteria are not met when the second criteria were most recently met by the characteristic value of the first visual property of the respective portion of the background. For example, if the object appearance is currently based on a mapping for the “light user interface material,” the computer system continues to use a mapping for the “light user interface material” if the third criteria are met; and if the object appearance is currently based on a mapping for the “dark user interface material,” the computer system continues to use a mapping for the “dark user interface material” if the third criteria are met. For example, for a respective range of average luminance values of the respective portion of the background, the computer system maintains the user interface material in a current mode of display (e.g., as a light user interface material or a dark user interface material) until the average luminance of the respective portion of the background moves outside of the respective range of average luminance values. For example, if the computer system is using a light user interface material for AIL of [0.3-1] in a current mode of the display, the computer system continues to use the light user interface material (e.g., optionally switching between different mappings associated with different variants of the light user interface material) as the AIL of the relevant portion of the background changes within the range of [0.3-1]; and switches to using the mappings for a dark user interface material when the AIL of the relevant portion of the background goes beyond the range of [0.3-1] (e.g., goes below 0.3), in accordance with some embodiments. Similarly, in some embodiments, if the computer system is using a dark user interface material for AIL of [0-0.7] in a current mode of the display, the computer system continues to use the dark user interface material (e.g., optionally switching between different mappings associated with different variants of the dark user interface material) as the AIL of the relevant portion of the background changes within the range of [0-0.7]; and switches to using the mappings for a light user interface material when the AIL of the relevant portion of the background goes beyond the range of [0-0.7] (e.g., goes above 0.7), in accordance with some embodiments. In some embodiments, the end values of the above AIL ranges are adjusted for the different operating mode of the computer system, and may be different from 0.3, 0.7, 0, and 1, used in the above examples. In one example, in FIG. 6B9, when the background 6124 changes from that of 6124a through that of 6124b and that of 6124c, the computer system will change the material appearance 6122 from that of 6122a (e.g., with AIL of 0.9) through that of 6122b and that of 6122c (e.g., light material appearances for AIL of 0.7 and 0.5), even though the AIL values of 0.7 and 0.5 also have corresponding dark material appearances 6126a and 6126b. In one example, in FIG. 6B9, when the background 6124 changes from that of 6124e (e.g., with AIL of 0.1) through that of 6124d and that of 6124c, the computer system will change the material appearance 6122 from that of 6126d through that of 6126c and that of 6126b (e.g., dark material appearances for AIL of 0.3 and 0.5), even though the AIL values of 0.3 and 0.5 also have corresponding light material appearances 6122d and 6122c.

In some embodiments, the first user interface corresponds to a first application. In some embodiments, the fourth criteria are met when the first application has a first color scheme. In some embodiments, the fourth criteria are not met when the first application has a second color scheme different from the first color scheme. For example, if the first application has a light color scheme (e.g., mostly with light colors and high luminance colors, and/or operating in a “light” mode corresponding to light colored user interfaces), the fourth criteria are met; and if the first application has a dark color scheme (e.g., mostly with dark colors and low luminance colors, and/or operating in a “dark” mode corresponding to dark colored user interfaces), the fourth criteria are not met. In some embodiments, the computer system switches between displaying the first application in the light mode or dark mode based on user input, and/or based on application-specific settings of the first application (e.g., changing the mode of the first application based on time of day and/or other contextual conditions). In some embodiments, different applications optionally have different color schemes at a given time. For example, the user interface material is biased toward matching a color scheme of the application (e.g., using the dark user interface material for a larger range of values of average luminance of the respective portion of the background when the application is in a dark mode than when the application is in a light mode of operation, and/or using the light user interface material for a larger range of values of average luminance of the respective portion of the background when the application is in a light mode than when the application is in a dark mode of operation). For example, in some embodiments, if the application has a light color scheme, the threshold for switching from light material to dark material is set to be AIL of 0.2 (e.g., lowered from a standard value of 0.3), and the computer system continues to use the light user interface material (e.g., optionally switching between different mappings associated with different variants of the light user interface material) as the AIL of the relevant portion of the background changes within the range of [0.2-1]; and switches to using the mappings for a dark user interface material when the AIL of the relevant portion of the background goes beyond the range of [0.2-1] (e.g., goes below 0.2), in accordance with some embodiments. In some embodiments, if the application has a light color scheme, the threshold for switching from dark material to light material is set to be AIL of 0.6 (e.g., lowered from a standard value of 0.7), and the computer system continues to use the dark user interface material (e.g., optionally switching between different mappings associated with different variants of the dark user interface material) as the AIL of the relevant portion of the background changes within the range of [0-0.6]; and switches to using the mappings for a dark user interface material when the AIL of the relevant portion of the background goes beyond the range of [0-0.6] (e.g., goes above 0.6), in accordance with some embodiments. Similarly, in some embodiments, if the application has a dark color scheme, the threshold for switching from dark material to light material is set to be AIL of 0.8 (e.g., raised from a standard value of 0.7), and the computer system continues to use the dark user interface material (e.g., optionally switching between different mappings associated with different variants of the dark user interface material) as the AIL of the relevant portion of the background changes within the range of [0-0.8]; and switches to using the mappings for a light user interface material when the AIL of the relevant portion of the background goes beyond the range of [0-0.8] (e.g., goes above 0.8), in accordance with some embodiments. In some embodiments, if the application has a dark color scheme, the threshold for switching from light material to dark material is set to be AIL of 0.4 (e.g., raised from a standard value of 0.3), and the computer system continues to use the light user interface material (e.g., optionally switching between different mappings associated with different variants of the light user interface material) as the AIL of the relevant portion of the background changes within the range of [0.4-1]; and switches to using the mappings for a dark user interface material when the AIL of the relevant portion of the background goes beyond the range of [0.4-1] (e.g., goes below 0.4), in accordance with some embodiments. In some embodiments, the color scheme of the application and the type of the most recently used material of the computer system (e.g., whether the most recently used material is a light material or a dark material) are used in combination to determine whether to switch the material between a light material and a dark material or vice versa. For example, if the computer system has a light color scheme, the computer system uses a dark material when the AIL of the relevant portion of the background is in the range [0-0.2], and uses a light material when the AIL of the relevant portion of the background is in the range [0.6-1], irrespective of whether the most recently used material is light or dark; however, in the range of [0.2-0.6], the computer system chooses the light material or the dark material depending on whether the most recently used material is light or dark (e.g., continues to remain with the light mode or the dark mode). Similarly, if the computer system has a dark color scheme, the computer system uses a dark material when the AIL of the relevant portion of the background is in the range [0-0.4], and uses a light material when the AIL of the relevant portion of the background is in the range [0.8-1], irrespective of whether the most recently used material is light or dark; however, in the range of [0.4-0.8], the computer system chooses the light material or the dark material depending on whether the most recently used material is light or dark (e.g., continues to remain with the light mode or the dark mode). In a more specific example, in FIG. 6B9, if the currently displayed application has a light color scheme, as the background changes appearance from 6124a through 6124b, 6124c, 6124d, and 6124e, the computer system switches from using a light material to using a dark material (e.g., in dark material appearance 6126d) when the background changes to appearance 6124e (e.g., with AIL of 0.1, below threshold AIL of 0.2); and, as the background changes appearance from 6124e through 6124d, 6124c, 6124b, and 6124a, the computer system switches from using a dark material to using a light material (e.g., in light material appearance 6122b) when the background changes to appearance 6124b (e.g., with AIL of 0.7, above threshold AIL of 0.6). If the currently displayed application has a dark color scheme, as the background changes appearance from 6124a through 6124b, 6124c, 6124d, and 6124e, the computer system switches to using the dark material appearances when the background changes to appearance 6124d (with AIL of 0.3, below the threshold of 0.4); and, as the background changes appearance from 6124e through 6124d, 6124c, 6124b, and 6124a, the computer system switches from using a dark material to using a light material (e.g., in light material appearance 6122a) when the background changes to appearance 6124a (e.g., with AIL of 0.9, above threshold AIL of 0.8).

In some embodiments, the fourth criteria are met when the computer system is operating in a first mode. In some embodiments, the fourth criteria are not met when the computer system is operating in a second mode different from the first mode, wherein the first mode and the second mode correspond to different display settings of the computer system (e.g., darkened display vs. regular display). For example, if the computer system is operating in the first mode (e.g., displaying user interfaces and/or applications mostly with light colors and high luminance colors, and/or using a regular display), the fourth criteria are met; and if the computer system is operating in the second mode (e.g., displaying user interfaces and/or applications mostly with dark colors and low luminance colors, and/or using a darkened display), the fourth criteria are not met. In some embodiments, the computer system switches between operating in the first mode or the second mode, based on user input, and/or based on settings based on time of day and/or other contextual conditions. For example, the user interface material is biased toward matching a color scheme of the computer system or an operating system of the computer system (e.g., using the dark user interface material for a larger range of values of average luminance of the respective portion of the background when the computer system or operating system is in a dark mode than when the application is in a light mode of operation, and/or using the light user interface material for a larger range of values of average luminance of the respective portion of the background when the computer system or operating system is in a light mode than when the application is in a dark mode of operation). For example, in some embodiments, if the computer system is operating in a light mode, the threshold for switching from light material to dark material is set to be AIL of 0.25 (e.g., lowered from a standard value of 0.3, and raised from the threshold 0.2 set based on a light application color scheme), and the computer system continues to use the light user interface material (e.g., optionally switching between different mappings associated with different variants of the light user interface material) as the AIL of the relevant portion of the background changes within the range of [0.25-1]; and switches to using the mappings for a dark user interface material when the AIL of the relevant portion of the background goes beyond the range of [0.25-1] (e.g., goes below 0.25), in accordance with some embodiments. In some embodiments, if the computer system is operating in a light mode, the threshold for switching from dark material to light material is set to be AIL of 0.65 (e.g., lowered from a standard value of 0.7, raised from the threshold 0.6 set based on the light application color scheme), and the computer system continues to use the dark user interface material (e.g., optionally switching between different mappings associated with different variants of the dark user interface material) as the AIL of the relevant portion of the background changes within the range of [0-0.65]; and switches to using the mappings for a dark user interface material when the AIL of the relevant portion of the background goes beyond the range of [0-0.65] (e.g., goes above 0.65), in accordance with some embodiments. Similarly, in some embodiments, if the computer system is operating in the dark mode, the threshold for switching from dark material to light material is set to be AIL of 0.75 (e.g., raised from a standard value of 0.7, and lowered from the threshold of 0.8 set based on the dark application color scheme), and the computer system continues to use the dark user interface material (e.g., optionally switching between different mappings associated with different variants of the dark user interface material) as the AIL of the relevant portion of the background changes within the range of [0-0.85]; and switches to using the mappings for a light user interface material when the AIL of the relevant portion of the background goes beyond the range of [0-0.85] (e.g., goes above 0.85), in accordance with some embodiments. In some embodiments, if the application has a dark color scheme, the threshold for switching from light material to dark material is set to be AIL of 0.35 (e.g., raised from a standard value of 0.3, and lowered from the threshold of 0.4 set based on a dark application color scheme), and the computer system continues to use the light user interface material (e.g., optionally switching between different mappings associated with different variants of the light user interface material) as the AIL of the relevant portion of the background changes within the range of [0.35-1]; and switches to using the mappings for a dark user interface material when the AIL of the relevant portion of the background goes beyond the range of [0.35-1] (e.g., goes below 0.35), in accordance with some embodiments. In some embodiments, the color scheme of the application and the display mode of the computer system (e.g., dark mode vs. light mode) are used in combination (e.g., in the examples above) in determining when to switch from using a light material to using a dark material as the AIL of the respective portion of the background changes. In some embodiments, whether the most recently used material is a light material or a dark material) is used in combination with the color scheme of the application and/or the display mode of the computer system to determine whether to switch the material between a light material and a dark material or vice versa. For example, if the computer system is in a light mode and the currently displayed application has a light color scheme, the computer system uses a dark material when the AIL of the relevant portion of the background is in the range [0-0.25], and uses a light material when the AIL of the relevant portion of the background is in the range [0.65-1], irrespective of whether the most recently used material is light or dark; however, in the range of [0.25-0.65], the computer system chooses the light material or the dark material depending on whether the most recently used material is light or dark (e.g., continues to remain with the light mode or the dark mode). Similarly, if the computer system is operating in the dark mode and displaying an application with a dark color scheme, the computer system uses a dark material when the AIL of the relevant portion of the background is in the range [0-0.35], and uses a light material when the AIL of the relevant portion of the background is in the range [0.85-1], irrespective of whether the most recently used material is light or dark; however, in the range of [0.35-0.85], the computer system chooses the light material or the dark material depending on whether the most recently used material is light or dark (e.g., continues to remain with the light mode or the dark mode). In a more specific example, in FIG. 6B9, if the computer system is operating in a light mode, as the background changes appearance from 6124a through 6124b, 6124c, 6124d, and 6124e, the computer system switches from using a light material to using a dark material (e.g., in dark material appearance 6126d) when the background changes to appearance 6124e (e.g., with AIL of 0.1, below threshold AIL of 0.25); and as the background changes appearance from 6124e through 6124d, 6124c, 6124b, and 6124a, the computer system switches from using a dark material to using a light material (e.g., in light material appearance 6122b) when the background changes to appearance 6124b (e.g., with AIL of 0.7, above threshold AIL of 0.65). If the computer system is operating in a dark mode, as the background changes appearance from 6124a through 6124b, 6124c, 6124d, and 6124e, the computer system switches to using the dark material appearances when the background changes to appearance 6124d (with AIL of 0.3, below the threshold of 0.45); and, as the background changes appearance from 6124e through 6124d, 6124c, 6124b, and 6124a, the computer system switches from using a dark material to using a light material (e.g., in light material appearance 6122a) when the background changes to appearance 6124a (e.g., with AIL of 0.9, above threshold AIL of 0.85). It is to be understood that, even though only a few combinations of display mode, application color scheme, and/or most recently used material type are used to determine whether light material or dark material should be used, and/or whether to switch between using a light material or dark material and/or vice versa, there is no restriction of how the different factors may be combined and/or used in the fourth criteria. In some embodiments, the different factors and/or rules are combined by giving them different priorities and/or by combining the rules in a weighted average to determine whether to use the light user interface material or the dark user interface material in a respective situation.

In some embodiments, while the computer system is operating in the first mode, the computer system detects a change in device context (e.g. change in time of day, change in location, change in notification mode, change in device casing, and/or other changes in the external environment of the computer system that affects the operation mode of the computer system). In response to detecting the change in device context, and in accordance with a determination that the change in device context meets mode switching criteria, the computer system ceases to operate in the first mode, and the computer system operates in the second mode (e.g., switching the operating mode between the light mode and the dark mode of the computer system). In response to detecting the change in device context, and in accordance with a determination that the change in device context does not meet the mode switching criteria, the computer system continues to operate in the first mode. In some embodiments, while the computer system is operating in the second mode, the computer system detects a change in device context; and in response to detecting the change in device context: in accordance with a determination that the change in device context meets the mode switching criteria, the computer system ceases to operating in the second mode, and operates in the first mode; and in accordance with a determination that the change in device context does not meet the mode switching criteria, the computer system continues to operate in the second mode. In some embodiments, when the computer system switches operating mode, the computer system changes the appearance of the currently displayed user interface, including the background, and in turn, the appearance of the first user interface object, based on the mapping that is selected based on the updated appearance of the background. In the examples shown in FIG. 6B9, the background 6124a-6124e may be displayed in both the first mode and the second mode in different contexts, in accordance with some embodiments. If the user interface object 6136 is be displayed with a light material appearance (e.g., an appearance 6122 in the left column), the computer system switches to displaying the user interface object 6136 with a corresponding dark material appearance (e.g., an appearance 6124 in the right column, in the same row and corresponding to the same AIL value as the light material appearance), in response to a change in device context that meets mode switching criteria and in response to the device switching from the light mode to the dark mode. Similarly, if the user interface object 6136 is be displayed with a dark material appearance (e.g., an appearance 6126 in the right column), the computer system switches to displaying the user interface object 6136 with a corresponding light material appearance (e.g., an appearance 6122 in the left column, in the same row and corresponding to the same AIL value as the dark material appearance), in response to a change in device context that meets mode switching criteria and in response to the device switching from the dark mode to the light mode.

In some embodiments, the first mapping has a first value range for the material colors. In some embodiments, the second mapping has a second value range for the material colors. In some embodiments, the first value range for the material colors spans a greater range of luminance values than the second value range for the material colors. For example, the first mapping spans an output luminance range of 0.6, and the second mapping spans an output luminance range of 0.45, in accordance with some embodiments. For example, as shown in FIG. 6B5, the material point luminance ranges of the light material mappings 6104d-6104h are (1.03−0.55)=0.48 for AIL of 0.7, (0.95−0.35)=0.6 for AIL of 0.6, (0.85−0.25)=0.6 for AIL of 0.5, (0.75−0.15)=0.6 for AIL of 0.4, and (0.75−0.15)=0.6 for AIL of 0.3; the material point luminance ranges of the dark material mappings 6106h-6106a are (0.8−0.5)=0.3 for AIL of 0.7, (0.8−0.4)=0.4 for AIL of 0.6, (0.75−0.3)=0.45 for AIL of 0.5, (0.65−0.2)=0.45 for AIL of 0.4, and (0.55−0.1)=0.45 for AIL of 0.3. Therefore, in some embodiments, the light material mappings have larger output luminance ranges (e.g., 0.48 and 0.6 in these examples) than the dark material mappings (e.g., 0.3, 0.4, and 0.45 in these examples), in accordance with some embodiments.

In some embodiments, the first user interface object includes internal content. In some embodiments, displaying the first user interface object with the object appearance (e.g., a “light user interface material” appearance or a “dark user interface material” appearance) that is based on the background appearance of the underlying portion of the background includes, in accordance with a determination that the characteristic value of the first visual property of the respective portion of the background that includes the underlying portion of the background meets the first criteria, displaying, via the one or more display generation components, the internal content with a first content appearance (e.g., in conjunction with displaying the first user interface material with an appearance determined using the first mapping). In some embodiments, displaying the first user interface object with the object appearance (e.g., a “light user interface material” appearance or a “dark user interface material” appearance) that is based on the background appearance of the underlying portion of the background includes, in accordance with a determination that the characteristic value of the first visual property of the respective portion of the background that includes the underlying portion of the background does not meet the first criteria (e.g., meets the second criteria different from the first criteria), displaying, via the one or more display generation components, the internal content with a second content appearance of the internal content that is different from the second content appearance (e.g., in conjunction with displaying the first user interface material with an appearance determined using the second mapping). In some embodiments, displaying the internal content with the first content appearance includes using a first set of content colors for the internal content, and displaying the internal content with the second content appearance includes using a second set of content colors for the internal content, different from the first set of content colors, optionally creating higher contrast to the material colors of the first user interface material. In some embodiments, the internal content of the first user interface object (e.g., text and/or glyphs indicating the function of the first user interface object) has light colors or dark colors depending on whether the first user interface material is using the first mapping or the second mapping. In some embodiments, when the first user interface material switches from using the first remapping (e.g., for the light user interface material) to using the second remapping (e.g., for the dark user interface material), the computer system switches a content appearance used for the internal content (e.g., text or glyphs) in the first user interface material from a first content appearance to a second content appearance (e.g., from a dark content appearance for the light user interface material or to a light content appearance for the dark user interface material). For example, as shown in FIG. 6B8, the user interface object 6136 that is overlaid on the background 6128 includes internal content 6137, such as application icons for sharing content and/or avatars of contacts that are potential recipients of the content sharing, and the internal content 6137 is displayed with a set of colors that are selected to provide better visual contrast to the material of the user interface object 6136 (e.g., darker colors for light materials, and lighter colors for darker materials). In some embodiments, the content colors of the internal content are relatively stable and do not change when the user interface material of the user interface object 6136 remains a light user interface material (e.g., optionally with different light material mappings corresponding to different current AIL values), or remains a dark user interface material (e.g., optionally with different dark material mappings corresponding to different current AIL values), and the change in content colors of the internal content is triggered when the material switches from light to dark or vice versa (e.g., based on the switching criteria being met).

In some embodiments, the respective portion of the background includes at least a first background color. In some embodiments, the first user interface material of the first user interface object includes at least a first material color corresponding to the first background color based on the respective mapping. In some embodiments, a luminance value of the first material color is greater than a luminance value of the first background color. In some embodiments, the background content that is made visible through the first user interface material (e.g., the refracted appearance of the background content) can have a brightness (e.g., measured by a luminance value of the material color of the refracted appearance of the background content) that is boosted to be brighter than the content in the underlying region of the background]. For example, as shown in FIG. 6B5, the mappings 6104a-6104h and 6106a-6106h and/or portions of the mappings 6104a-6104h and 6106a-6106h that are located above the reference mapping 6105 (e.g., diagonal line across the graph for background point luminance range of 0 to 1 and material point luminance range of 0 to 1), correspond to scenarios where a material color has a greater luminance than its corresponding background color, and where the luminance value of the material color is boosted to be brighter than its corresponding background color. In FIG. 6B10, for the example of AIL=0.9, all of the background colors (e.g., the black color of the bars 6132, the gray (or another non-black and non-white color) color of the outlines of the windows 6130a-6130f, and the white color of the windows 6130a-6130f) are boosted in luminance when converted to their corresponding material colors (e.g., dark gray color in regions 6132*, light gray in regions 6134*, and ultra white color in regions 6130a*-6130f*) within the user interface object 6136a. In FIG. 6B11, for the example of AIL=0.7, in the light variant of the material appearance 6124b, all of the background colors (e.g., the black color of the bars 6132, the various shades of gray (or another set of non-black and non-white color with different luminance values) colors of the windows 6130b-6130e, and the white color of the windows 6130a and 6130f) are boosted in luminance when converted to their corresponding material colors (e.g., dark gray color in regions 6132*, various lighter shades of grays (or other non-black and non-white colors that are boosted in luminance) in regions 6130b*-6130e*, and ultra white color in regions 6130a*-6130f*) within the user interface object 6136a. In FIG. 6B11, for the example of AIL=0.7, in the dark variant of the material appearance 6126a, some of the background colors (e.g., the black color of the bars 6132, the very dark shade of gray (or another non-black and non-white color with lower luminance values) color of the windows 6130e are boosted in luminance when converted to their corresponding material colors (e.g., dark gray color in regions 6132*, slightly lighter shade of gray (or another non-black and non-white color that is boosted in luminance) in region 6130e*. While the white windows 6130a and 6130f are not boosted, and appear darker in the regions 6130a* and 6130f* within the user interface object 6136a.

In some embodiments, the first background color corresponds to a maximum available luminance for the background, and the first material color corresponds to a luminance value that is greater than the maximum available luminance for the background. In some embodiments, the background content visible through the first user interface material (e.g., the refracted appearance of the background content) can have a maximum brightness (e.g., measured by material luminance) that exceeds a maximum available brightness (e.g., measured by background luminance) for the background content (e.g., background with luminance value of 1 can be displayed at luminance value of 1.03 in the first user interface material), optionally using a high dynamic range (HDR) display brightness range that is outside of a standard range of brightness or luminance that is available for content (e.g., for SDR content or standard dynamic range content). For example, as illustrated in FIG. 6B5, the maximum material point luminance is capped at 1.03 for the light material mappings 6104a-6104e for the AIL of 0.95-0.6, respectively. In these mappings, when the background point luminance is 1, the material point luminance is 1.03, and for some background point luminance values below 1 but close to 1, the material point luminance can still be above 1 (e.g., in the upper right corner of the graph 6102-1 in FIG. 6B5). In FIGS. 6B10 and 6B11, the white windows 6130a and 6130f have corresponding material appearances (e.g., in the regions 6130a* and 6130f* in light appearance 6124a in FIG. 6B10, and light appearance 6124b in FIG. 6B11) that have material colors that are in the ultra-white range, outside of the standard range of brightness or luminance that is available for content (e.g., the white windows 6130a and 6130f).

In some embodiments, displaying the first user interface object with the object appearance that is based on the background appearance of the underlying portion of the background, includes, in accordance with a determination that the background appearance includes a first color (e.g., a first set of values for a set of different color parameters, such as RGB (red, green, blue), HSB (hue, saturation, brightness), and/or CMYK (Cyan, Magenta, Yellow, Black) color parameters), displaying the first user interface object with the first color in the object appearance (and/or in accordance with a determination that the background appearance does not include the first color, displaying the first user interface object without the first color in the object appearance). In some embodiments, displaying the first user interface object with the object appearance that is based on the background appearance of the underlying portion of the background, includes, in accordance with a determination that the background appearance includes a second color, different from the first color (e.g., a second set of values, different from the first set of values, for the set of different color parameters, such as RGB (red, green, blue), HSB (hue, saturation, brightness), and/or CMYK (Cyan, Magenta, Yellow, Black) color parameters), displaying the first user interface object with the second color in the object appearance (and/or in accordance with a determination that the background appearance does not include the second color, displaying the first user interface object without the second color in the object appearance). For example, if the underlying background content has a first color, the first color is visible through the first user interface material in the refracted appearance of the underlying background content; and if the underlying background content has a second color, the second color is visible through the first user interface material in the refracted appearance of the underlying background content. In one example, in FIG. 6B8, the colors of the windows 6130b-6130e may be four different colors with different luminance values, such as a yellow color for window 6130b, an orange color for window 6130c, a green color for window 6130d, and a blue color for window 6130e, corresponding to decreasing luminance values; and correspondingly, the regions 6130b* has a yellow color (optionally a slightly different yellow from that of window 6130b), regions 6130c* has an orange color (optionally a slightly different orange from that of window 6130c), regions 6130d* has a green color (optionally a lightly different green from that of window 6130d), and region 6130e* has a blue color (optionally a slightly different blue from that of window 6130e), with respective luminance values (e.g., greater or smaller luminance values compared to their corresponding background colors) that are determined from a corresponding mapping selected based on the AIL of the relevant portion of the background and, optionally, other factors for determining which mapping to use. The respective luminance values of the material colors for the regions 6130b-6130e still maintain their relative orders (e.g., decreasing monotonically, in this example), as the respective luminance values of the background colors for the windows 6130b-6130e, in accordance with some embodiments.

In some embodiments, the respective portion of the background includes one or more portions of the background that are outside of the underlying portion of the background, in addition to the underlying portion of the background (e.g., the respective portion of the background that has a corresponding refracted appearance in the first user interface material includes portions of the background that are slightly outside of the outline of the first user interface object). For example, in FIG. 6B8, the user interface object 6136 is overlaid on the background 6128, and the appearance of the user interface object 6136 includes regions 6130a*-6130f* that correspond to six columns of windows 6130a-6130f, and the regions 6130a*-6130f* show three rows of windows in each column of windows, and the top edge of the first row of windows are represented in the object appearance of the user interface object 6136, even though the top edges of the first row of windows are displayed and not covered by the user interface material. This is because, the portion of the background that is used to generate the simulated external refraction within the user interface object, includes not only the portion that directly underlies the user interface object but also a portion that is slightly outside of the outline of the user interface object 6136 (e.g., within the refraction-threshold distance from the outline of the user interface object 6136), and in this example, encompasses the entirety of the fix columns and three rows of windows 6130.

In some embodiments, the computer system displays, via the one or more display generation components, a simulated shadow of the first user interface object, wherein the simulated shadow of the first user interface object is displayed concurrently with the first user interface object, wherein the simulated shadow covers at least a first portion of the background, the first portion of the background is within the respective portion of the background and outside of the underlying portion of the background, and the object appearance of first user interface object is based on (e.g., simulates refraction of) a background appearance of the first portion of the background, and not based on (e.g., without simulating refraction of) an appearance of the simulated shadow. This is illustrated in FIG. 6C, where the object appearance of the user interface object 6004 is based on the background appearance of a first portion of the background 6048 that is partially overlaid by a simulated shadow 6052, but the object appearance of the user interface object 6004 is not influenced by the appearance of the simulated shadow. In some embodiments, the user interface object 6130 in FIG. 6B8 can be an example of user interface object 6004, and is displayed with a simulated shadow overlaying a first portion of the background 6128, where the first portion of the background 6128 is used in generating the refracted appearance of the first portion of the background within the user interface object 6136, but is not influenced by the simulated shadow that is overlaid on the first portion of the background 6128, in accordance with some embodiments.

In some embodiments, displaying the simulated shadow includes displaying a shadowed appearance of the first portion of the background by darkening a set of background colors of the first portion of the background. In some embodiments, darkening the set of background colors of the first portion of the background includes, in accordance with a determination that the characteristic value of the first visual property of the respective portion of the background that includes the underlying portion of the background is a first luminance value, darkening a portion of the background that is near the first user interface object by a first amount (e.g., by displaying a shadow near or around with first user interface object with a first level of opacity). In some embodiments, darkening the set of background colors of the first portion of the background includes, in accordance with a determination that the characteristic value of the first visual property of the respective portion of the background that includes the underlying portion of the background is a second luminance value, different from the first luminance value, darkening the portion of the background that is near the first user interface object by a second amount that is different from the first amount (e.g., displaying the shadow near or around the first user interface object with a second level of opacity, different from the first level of opacity). For example, in some embodiments, the fill opacity of the simulated shadow decreases in the range of [0.4-0.95] average input luminance of the respective portion of the background, making the simulated shadow being more translucent for lighter colors. In some embodiments, the darkening effect gradually decreases as a distance from the first user interface object increases (e.g., a darkness and/or opacity of the shadow gradually decreases based on a distance from the first user interface object). For example, in some embodiments, in FIG. 6B2, the simulated shadow 6108 is generated by darkening the portion of the background 6036 that is covered by the simulated shadow 6108, and the darkening is accomplished by applying a black fill with an opacity that varies based on the AIL of the relevant portion of the background 6008 (e.g., the respective portion of the background that includes both the portion that underlies the user interface object 6004, and additional portions that are outside of the outline of the user interface object 6004). For example, the additional portions include portions that are within a refraction-threshold distance from the outline of the user interface object and/or portions that correspond to one or more other related user interface objects or portions that correspond to a container object of the user interface object 6004. In some embodiments, the additional portions optionally include the portions that are overlaid by the simulated shadow and/or are used to generate the simulated shadow (e.g., within a shadow-threshold distance from the outline of the user interface object 6004). In FIG. 6B7, the graph 6112 shows the fill opacity values that are used to darken the background to create the appearance of the simulated shadow 6118 overlaying the background 6008, in accordance with some embodiments. In some embodiments, the user interface object 6136 in FIGS. 6B8-6B11 is an example of the user interface object 6004 in FIGS. 6A-6B4 and 6C, and is displayed with a simulated shadow. In some embodiments, the simulated shadow is omitted for average input luminance less than 0.4 (e.g., as shown in FIG. 6B7, 0% fill opacity for AIL<=0.4). In some embodiments, the simulated shadow has a fixed darkness for average input luminance greater than 0.95 (e.g., as shown in FIG. 6B7, 5% fill opacity for AIL>=0.95). In some embodiments, the simulated shadow is less dark for lighter backgrounds, when average input luminance is between 0.4 and 0.95 (e.g., as shown in FIG. 6B7, decreasing fill opacity between 40% and 18%, for increasing AIL between 0.4 and 0.95). In some embodiments, a threshold value other than 0.95 (e.g., 0.8, or 0.85) is used instead of the threshold 0.95. In some embodiments, a threshold value other than 0.4 (e.g., 0.3, 0.35, or 0.45) is used instead of the threshold 0.4.

In some embodiments, darkening the set of background colors of the first portion of the background includes, in accordance with a determination that the characteristic value of the first visual property of the respective portion of the background that includes the underlying portion of the background is above a first threshold characteristic value (e.g., 0.95 luminance value or another high luminance threshold value), darkening the portion of the background that is near the first user interface object by a third amount, lower than the first amount and the second amount (e.g., displaying the shadow near or around the first user interface object with a third level of opacity, different from the first level of opacity and the second level of opacity). For example, in some embodiments, the third amount of darkening is an abrupt decrease from a continuous change in darkening (e.g., change in fill opacity) for characteristic values below the first threshold characteristic value, and the third level darkening (e.g., the third level of opacity) remains constant for characteristic values above the first threshold characteristic value. In some embodiments, the simulated shadow has a fixed darkness for average input luminance greater than 0.95 (e.g., as shown in FIG. 6B7, 5% fill opacity for AIL>=0.95). In some embodiments, the simulated shadow is less dark for lighter backgrounds, when average input luminance is between 0.4 and 0.95 (e.g., as shown in FIG. 6B7, decreasing fill opacity between 40% and 18%, for increasing AIL between 0.4 and 0.95), where there is an abrupt change between 18% for AIL less than 0.95, and 5% for AIL greater than 0.95. In some embodiments, a threshold value other than 0.95 (e.g., 0.8, or 0.85) is used instead of the threshold 0.95. In some embodiments, a threshold value other than 0.4 (e.g., 0.3, 0.35, or 0.45) is used instead of the threshold 0.4.

In some embodiments, in accordance with a determination that the characteristic value of the first visual property of the respective portion of the background that includes the underlying portion of the background is below a second threshold characteristic value (e.g., 0.4 luminance value or another low luminance threshold value), the computer system forgoes displaying the simulated shadow. In some embodiments, the simulated shadow is omitted for average input luminance less than 0.4 (e.g., as shown in FIG. 6B7, 0% fill opacity for AIL<=0.4). In some embodiments, a different threshold other than 0.4 is used instead of the threshold 0.4.

In some embodiments, displaying the first user interface object with an object appearance (e.g., a “light user interface material” appearance or a “dark user interface material” appearance) that is based on the background appearance of the underlying portion of the background includes, in accordance with a determination that the characteristic value of the first visual property of the respective portion of the background that includes the underlying portion of the background meets the first criteria, modifying the corresponding set of material colors of the first user interface material with an additional color (e.g., an injection of white color with an opacity value between 20-40%). In some embodiments, displaying the first user interface object with an object appearance (e.g., a “light user interface material” appearance or a “dark user interface material” appearance) that is based on the background appearance of the underlying portion of the background includes, in accordance with a determination that the characteristic value of the first visual property of the respective portion of the background that includes the underlying portion of the background does not meet the first criteria, forgoing modifying the corresponding set of material colors of the first user interface material with the additional color. For example, when the first user interface material is using the first remapping (e.g., for the light material), the computer system adds an additional color (e.g., 20% to 40% white) to the colors of the first user interface material; and when the first user interface material is using the second remapping (e.g., for the dark material), the computer system does not add an additional color to the colors of the first user interface material. It is noted that, in some embodiments, the additional color will also decrease the opacity of the user interface material and make the material appearance more uniform across the spatial extent of the user interface object (e.g., because an additional color is being added). In FIG. 6B6, the additional color is added with varying opacity depending on the average input luminance of the relevant portion of the background, if the average input luminance is above a threshold value of 0.45, and when the user interface material is a light user interface material. In FIGS. 6B10, 6B11, and 6B12, the indication 6139a, 6139b, and 6139c indicates decreasing values of fill opacity for the additional color, with decreasing average input luminance values (e.g., from 0.9 to 0.7, and then to 0.5). In some embodiments, if the average input luminance is below the threshold value of 0.45, and/or the user interface material is a dark user interface material, the additional color is not added. In some embodiments, a threshold value other than 0.45 (e.g., 0.4, 0.5, or 0.55) is used instead of the threshold 0.45.

In some embodiments, in accordance with a determination that the characteristic value of the first visual property of the respective portion of the background is a first characteristic value, the additional color has a first level of opacity (e.g., an injection of white color with an opacity value between 20-40%) that is based on the first characteristic value. In some embodiments, in accordance with a determination that the characteristic value of the first visual property of the respective portion of the background is a second characteristic value, different from the first characteristic value, the additional color has a second level of opacity (e.g., an injection of white color with an opacity value between 20-40%) that is based on the second characteristic value, different from the first level of opacity that is based on the first characteristic value. In some embodiments, the additional color (e.g., white) that is added to the material colors has an opacity that varies based on the average input luminance of the respective portion of the background (e.g., the underlying portion of the background). As shown in FIG. 6B6, the fill opacity of the additional color increases from 20% to 40% with increasing average input luminance from 0.35 to 1, in accordance with some embodiments. In some embodiments, the injection of the additional color affects the brightness of the material appearance in the user interface object, even though the mapping that is used to generate the material appearance has not changed (e.g., the AIL has not changed). In some embodiments, the injection of the additional color with less than 100% opacity affects the opacity of the user interface material and makes the material more translucent to the background underlying the user interface object.

In some embodiments, the first user interface object is displayed concurrently with a second user interface object that includes a second user interface material. In some embodiments, a spatial extent of the second user interface material corresponds to a spatial extent of an underlying portion of the background that is covered by the second user interface object. In some embodiments, the characteristics and/or behaviors of the second user interface material are optionally identical or analogous to the characteristics and/or behaviors of the first user interface material, and/or, optionally with different sets of parameter values (e.g., static and/or variable parameter values) from those used for the first user interface material. In some embodiments, displaying a user interface that includes the first user interface object and the second user interface object includes displaying the first user interface object with the object appearance that is based on the background appearance of the underlying portion of the background covered by the first user interface object. In some embodiments, displaying a user interface that includes the first user interface object and the second user interface object includes displaying the second user interface object with an object appearance that is based on a background appearance of an underlying portion of the background covered by the second user interface object. In some embodiments, the object appearance of the first user interface object is based on the first mapping and the object appearance of the second user interface object is based on the second mapping. In some embodiments, the first user interface object and the second user interface object are both components of a same user interface object group. The user interface object group is, optionally, a contiguous user interface object group (e.g., a single platter of a user interface material that is divided between the light user interface material and the dark user interface material). The user interface object group is, optionally, a group of related but separate user interface objects (e.g., the user interface objects are selectable elements of a navigation bar, tab bar, or other control user interface). In some embodiments, the first user interface object and the second user interface object are part of separate control regions (e.g., a navigation bar at one side of the user interface such as a top of the user interface and a tab bar at a different side of the user interface such as a bottom of the user interface) that use different user interface materials (e.g., the light user interface material and the dark user interface material).

It should be understood that the particular order in which the operations in FIG. 19 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 13000, 14000, 15000, 16000, 17000, 18000 and/or 20000) are also applicable in an analogous manner to method 19000 described above with respect to FIG. 19. For example, the buttons, user interfaces, controls, visual deemphasis, virtual effects, described above with reference to method 19000 optionally have one or more of the characteristics of the buttons, user interfaces, controls, visual deemphasis, virtual effects, described herein with reference to other methods described herein (e.g., methods 7000, 8000, 9000, 10000, 11000, 12000, 13000, 14000, 15000, 16000, 17000, 18000 and/or 20000). For brevity, these details are not repeated here.

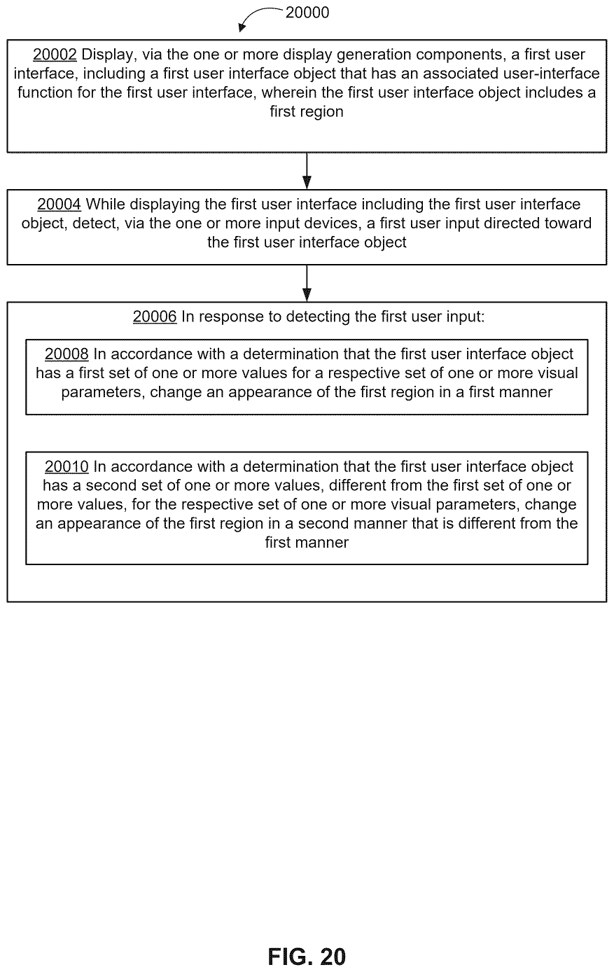

FIG. 20 is a flow diagram illustrating a method 20000 of stretching, compressing and/or changing a user interface object responsive to one or more user inputs based on properties of the user interface object in accordance with some embodiments. In some embodiments, the method 20000 is performed at a computer system (e.g., portable multifunction device 100, device 300 in FIGS. 1A-6AP) that is in communication with one or more input devices (e.g., touch-sensitive surfaces, optical sensors, motion sensors, proximity sensors, gyros, accelerometers, ambient light sensors, joysticks, buttons, keyboards, handheld controllers, pointer devices, and/or other types of input devices) and one or more display generation components (e.g., touch-screen displays, standalone displays, LED displays, LCD displays, head-mounted displays, heads-up displays, foldable displays, flexible displays, and/or other types of display generation components that provides one or more display areas in which content, user interfaces, and/or controls can be made visible to a user). Some operations in method 20000 are, optionally, combined and/or the order of some operations is, optionally, changed.

Displaying at least a portion of a user interface object as reactive, including stretching, compressing, animating, and/or otherwise simulating a reaction of the user interface object that is based on approximated or simulated physics, where different types and sizes of user interface objects are simulated as reacting differently, in response to detecting a user input directed to the user interface object leverages the user's real world experience by simulating physical responsiveness of the user interface object. Displaying responsiveness of the user interface object provides information about the spatial relationships between the user interface elements, provides visual feedback regarding the effect of user input, and guides the user about how to use his/her input to change the system state and/or application state. Using responsive materials for user interface elements improves the responsiveness of user interface elements to inputs, which enables a user to use a device for shorter periods of time, which saves energy and improves battery life. Automatically changing an appearance of user interface elements (e.g., changing a size and/or shape of user interface elements) when one or more criteria are met reduces the number of inputs (e.g., navigating through settings user interfaces and menus to set the values for parameters to adjust the size and/or shape of user interface elements) that would otherwise be required to generate a similar effect, which saves energy and improves battery life.

The computer system displays (20002), via the one or more display generation components, a first user interface, including a first user interface object that has an associated user-interface function for the first user interface (e.g., the first user interface object is a first button, a first slider, a first selector, a first control corresponding to a first control function of the computer system, and/or a first user interface object that, in response to an input directed toward the first user interface object, causes the computer system to perform a first operation, such as adjusting a system state of the computer system, adjusting an application state of a currently displayed application, and/or displaying another user interface object, optionally, in a second user interface different from the first user interface), wherein the first user interface object includes a first region (e.g., the first user interface object comprises a region that is made of and/or is visually associated with a user interface material and/or a simulated material). In some embodiments, the first user interface object is a button, an affordance, a toggle, a slider, a tool bar, a dock, a popup, a window, and/or another type of user interface object that has content embedded within and/or on the surface of a user interface material, such as a background material, a texture, and/or a simulated glassy, translucent, and/or gelatinous material, with a simulated three-dimensional volume defined by a first boundary, such as outlines and bounding surfaces of the simulated three-dimensional volume in two or more dimensions. In some embodiments, the first region corresponds to an area and/or volume of the user interface material that forms and/or is included in the first user interface object.

While displaying the first user interface including the first user interface object (e.g., with the first user interface object including the first region), the computer system detects (20004), via the one or more input devices, a first user input directed toward the first user interface object (e.g., a touch gesture, an air gesture, a point and click input, an actuation and/or manipulation of a hardware control, and/or other types of input that targets the first user interface object based on a location of the first user interface object and/or the currently selected state of the first user interface object). In some embodiments, a touch gesture targets an object based on a location of a contact on a touch-sensitive surface that corresponds to the display location of the object. In some embodiments, an air gesture targets an object based on a location of the user's attention, e.g., based on the location of the hand that provides the air gesture and/or a location of a gaze of the user, that corresponds to the location of the object. In some embodiments, a point and click input targets an object based on a location of a cursor that corresponds to the location of the object. In some embodiments, the first user interface object is the target of an input when the first user interface object is a currently selected object and has input focus at the time when the input is detected (e.g., when a hardware control is actuated and/or manipulated; and/or when another type of input device detects the first user input). In some embodiments, the first user input includes a movement of the first user input. In some embodiments, the first user input is substantially stationary and does not include a movement of the first user input (e.g., the location of the input does not change by more than a threshold amount in a unit of time). In some embodiments, the target location of the first user input is substantially stationary relative to the first user interface object (e.g., both the first user input and the first user interface object are substantially stationary to their respective environments, and/or the first user interface object moves in accordance with the movement of the first user input such that their spatial relationship remains substantially unchanged during the first user input). In some embodiments, the target location of the first user input is moves relative to the first user interface object (e.g., the first user input moves while the first user interface object remains substantially stationary, and/or both the first user input and the first user interface object move relative to their respective environment, but with different movement characteristics, resulting in a change in their spatial relationship during the first user input, and/or a change in their spatial relationship before and after the first user input). For example, as described with reference to FIGS. 5X-5Y, a user input 904-1 is detected.

In response to detecting the first user input (20006) (e.g., while the first user input is ongoing and/or maintained, and optionally, within a threshold amount of time after detecting a termination of the first user input), the computer system: in accordance with a determination that the first user interface object has a first set of one or more values for a respective set of one or more visual parameters (e.g., a first set of values for one or more dimensions and/or size of the first user interface object, a first material type of a plurality of available user interface material types, and/or a first set of values for another set of one or more visual parameters), changes (20008) an appearance of the first region in a first manner (e.g., changes the appearance of the user interface material in accordance with a first set of rules and relationships between one or more parameters corresponding to the first user input and one or more appearance parameters of the first user interface object and/or the first region). For example, as described with reference to FIGS. 5X-5Y, in response to detecting the user input 904-1, the platter 816-1 is modified to, for example, stretch in response to detecting the user input 904-1.

In response to detecting the first user input (20006) (e.g., while the first user input is ongoing and/or maintained, and optionally, within a threshold amount of time after detecting a termination of the first user input), the computer system: in accordance with a determination that the first user interface object has a second set of one or more values, different from the first set of one or more values, for the respective set of one or more visual parameters (e.g., a second set of values for the one or more dimensions and/or size of the first user interface object, a second material type of the plurality of available user interface material types, and/or a second set of values for said another set of one or more visual parameters), changes (20010) an appearance of the first region in a second manner that is different from the first manner (e.g., changes the appearance of the user interface material in accordance with a second set of rules and relationships between one or more parameters corresponding to the first user input and one or more appearance parameters of the first user interface object and/or the first region, the second set of rules and relationships being different from the first set of rules and relationships). In some embodiments, in response to detecting the first user input, the computer system adjusts a first boundary of the first user interface object (e.g., changing the sizes and positions of the outlines and/or surfaces of the first user interface material of the first user interface object in two or more dimensions, without changing the first user interface object into another user interface object that corresponds to a different function). In some embodiments, adjusting the boundary of the first user interface object includes displaying, via the one or more display generation components, animated changes in a size of the first user interface material in a first dimension (e.g., a respective dimension of width, height, thickness, radius, and/or other spatial dimensions) and animated changes in a size of the first user interface material in a second dimension (e.g., another respective dimension of width, height, thickness, radius, and/or other spatial dimensions). In some embodiments, displaying the animated changes in the size of the first user interface material in the first dimension includes: during a first period of time of adjusting the first boundary of the first user interface object (e.g., at a beginning period of time, an intermediate period of time, a final period of time, of a unit of time, and/or at a respective moment in time), changing a size of a first portion of the first user interface material along the first dimension by a first amount of change, and changing a second portion of the first user interface material along the first dimension by a second amount of change that is different from the first amount of change (e.g., the different amounts of change applied to different portions of the first user interface material during a respective period of time causes the first simulated material to stretch and/or compress by different amounts at different locations along the first user interface material in a first direction corresponding to the first dimension of the first user interface material). In some embodiments, displaying the animated changes in the size of the first user interface material in the second dimension includes, during the first period of time of adjusting the first boundary of the first user interface object, changing a size of a third portion of the first user interface material along the second dimension by a third amount of change, and changing a size of a fourth portion of the first user interface material along the second dimension by a fourth amount of change that is different from the third amount of change. In some embodiments, the different portions of the first user interface object stretch by different amounts along a respective dimension of the first user interface object, such as by greater amounts closer to the location of the input and smaller amounts farther away from the location of the input, to simulate a variable internal material structure of the first user interface object (e.g., variable modulo, variable density, and/or other simulated material properties) that affects the simulated stretchiness and/or squishiness of the first user interface material. For example, as described with reference to FIG. 5Y1 and Tables 2-3, in some embodiments, a different amount of stretching, shrinking or otherwise animating (e.g., to display simulated reactive behavior of) a respective user interface object is based at least in part on the size and/or type of user interface object, such that platter 816b is displayed with a different amount and/or type of reactivity than platter 816c.

In some embodiments, the respective set of one or more parameters includes a size parameter (e.g., a width parameter, a height parameter, a radius parameter, a thickness parameter, a simulated thickness parameter, a length parameter, and/or other types of parameters that specify an absolute size and/or a relative size of a user interface object); the first set of one or more values includes a first size value for the size parameter (e.g., a first size out of a plurality of discrete sizes and/or size ranges, a first size value out of a continuous range of size values); and the second set of one or more values includes a second size value (e.g., a second size out of a plurality of discrete sizes and/or size ranges, a second size value out of a continuous range of size values) for the size parameter that is different from the first size value. In some embodiments, the size parameter is based on a width of the first user interface object or the first region. In some embodiments, the size parameter is based on a height of the first user interface object or the first region. In some embodiments, the size parameter is based on a minimum of the height of the first user interface object or the first region and a width of the first user interface object or the first region. In some embodiments, the size parameter includes a set of two or more size parameters for different dimensions (e.g., horizontal dimension, vertical dimension, depth dimension, radial dimension, and/or other types of dimensions) and/or different aspects (e.g., width, height, thickness, depth, inner radius, outer radius, and/or other aspects) of the size of a user interface object. In some embodiments, the first size value for the size parameter and the second size value for the size parameter includes different categories of sizes, discrete sizes, and/or ranges of sizes, such as those corresponding to “extra-large” size, “large” size, “medium” size, “small” size, and/or “extra-small” size; and/or such as those corresponding to “button” size, “tool bar” size, “menu” size, and/or “sheet” size. In some embodiments, the first size value for the size parameter and the second size value for the size parameter includes different size values along a continuous range of size values (e.g., a continuous range of width values, a continuous range of height values, a continuous range of thickness values, and/or a continuous range of radius values). In some embodiments, one or more dimensions of the first user interface object have size values that are selected from a set of two or more discrete size values, while one or more other dimensions of the first user interface object have size values from a continuous range of size values. For example, as described with reference to FIG. 5Y1 and Table 1, in some embodiments, platter 816a is a different size than platter 816b and the amount of stretching, shrinking, or otherwise animating that is displayed for platter 816a is different than the amount of stretching shrinking, or otherwise animating that is displayed for (e.g., to display simulated reactive behavior of) platter 816b in response to a user input.

In some embodiments, the respective set of one or more parameters includes a user interface material parameter (e.g., optionally, in addition to the size parameter, optionally independent of the size parameter, and/or optionally constrained by the size parameter); the first set of one or more values includes a first material value for the user interface material parameter (e.g., a first material type selected from a set of two or more material types, such as “clear glass,” “frosted glass,” “liquid glass,” and/or other material types with associated behavior and appearance characteristics; and/or a first variant of a respective material type that corresponds to a first characteristic value in a range of characteristic values, such as a respective “light” variant of a light user interface material corresponding to a first average input luminance of a relevant portion of the background underlying the user interface object); and the second set of one or more values includes a second material value for the user interface material parameter that is different from the first material value (e.g., a second material type, different from the first material type, selected from the set of two or more material types, such as “clear glass,” “frosted glass,” “liquid glass,” and/or other material types with associated behavior and appearance characteristics; and/or a second variant of a respective material type that corresponds to a second characteristic value in the range of characteristic values, such as a different “light” variant of the light user interface material corresponding to a second average input luminance, different from the first average input luminance, of the relevant portion of the background underlying the user interface object). In some embodiments, the computer system provides the respective set of rules and/or relationships between one or more input parameters of a user input and one or more appearance parameters of a user interface object that is visually associated with a respective type of user interface material. In some embodiments, the material type of the user interface material that is visually associated with a respective user interface object (e.g., the first user interface object and/or another user interface object described herein) is specified by a respective material value for the user interface material parameter of the respective user interface object. In some embodiments, the user interface material parameter can have a material value selected from a plurality of available material values, such as two or more discrete material types (e.g., “frosted” glassy material, “clear” glass material, “dark” glass material, “reflective” material, “overlay” material, “button” material, “loupe” material, and/or other discrete material types with respective sets of rules and relationships that govern their respective material appearances), and/or a material value selected from a continuous range of material values (e.g., a respective “light” variant of a “light” user interface material corresponding to a respective average input luminance value of a continuous range of average input luminance values corresponding to the “light” user interface material, a respective “dark” variant of a “dark” user interface material corresponding to a respective average input luminance value of a continuous range of average input luminance values corresponding to the “dark user interface material; and/or a respective “frosted” variant of a “frosted” user interface material corresponding to a respective opacity value in a continuous range of opacity values). In some embodiments, a user interface material includes a set of one or more properties that determine an appearance of the user interface material (e.g., the one or more properties discussed in greater detail with respect to the layers described with respect to and illustrated in FIGS. 6A-6C. In some embodiments, the first material value indicates that the first region has a first visual appearance that is based on a modification of underlying and/or nearby content that is near the first user interface object. In some embodiments, the second material value indicates that the first region has a second visual appearance, different from the first visual appearance, that is based on a modification of the underlying and/or nearby content that is near the first user interface object. In some embodiments, a type of user interface object is used to determine both a user interface material used for the user interface object and one or more dynamic behaviors of the user interface object (as described in the method 20000). For example, in FIG. 5Y, the amount of stretching, shrinking, and/or otherwise animating of (e.g., to display simulated reactive behavior of) the platter 816c is based on whether the platter 816c is displayed as a first type of simulated glass material, such as frosted glass, or a second type of simulated glass material, such as liquid lens glass (e.g., and/or different values of other visual parameters of the simulated glass materials described with reference to FIG. 6A).

In some embodiments, the first user interface object includes a second region in addition to the first region (e.g., the first region underlies the second region, the second region overlays at least a portion of the first region, the first region and the second region overlap in the first user interface object, and/or the first region and the second region are displayed in nonoverlapping portions of the first user interface object); the first region is displayed concurrently with the second region (e.g., before the first user input is detect, after the first user input is detected, after the first user input is terminated, in response to detecting the start and/or end of the first user input, in response to detecting that the first user input meets first criteria, while the first user input is maintained, and/or while the first user input meets the first criteria); the first region has the first material value (e.g., the first region is of a first material type of a plurality of material types, and/or the first region is a first variant of a respective material type corresponding to a first characteristic value of a range of characteristic values); and the second region has the second material value (e.g., the second region is of a second material type, different from the first material type, of the plurality of material types; and/or the second region is a second variant of the respective material type corresponding to a second characteristic value, different from the first characteristic value, of the range of characteristic values). In some embodiments, the first region is an option region (e.g., a tab bar or navigation bar as describe in greater detail with reference to method 17000) and the second region is a selector that moves to indicate a currently selected option from the option region (e.g., a selector element in a tab bar or navigation bar as described in greater detail with reference to method 17000). In some embodiments, the first region and the second region have different dynamic behaviors and/or different user interface material properties (e.g., different strengths for simulated refraction, simulated shadow, simulated internal refraction, specular highlighting, simulated opacity, mapping from background colors to material colors, spatial and distortion relationships between background features and material features, simulated deformation, simulated bounciness, simulated damping factor, simulated inertia, simulated acceleration under external influence, and/or other user interface material properties). For example, in FIG. 6U, the page menu 6704 is a tab bar (e.g., where, according to Table 2, the background of the tab bar follows the parameters for small, intermediate or large size user interface object in Table 1A based on the size of the page menu 6704) displayed with a different user interface material (e.g., having different values of one or more visual properties of the user interface material) than the user interface material of the selection indicator 6708 (e.g., where, according to Table 2, the selector of the tab bar follows the parameters for a liquid lens user interface object in Table 1B).

In some embodiments, the first user input includes movement (e.g., movement of an input element such as a contact with a touch-sensitive surface, a hand performing an air gesture, a mouse pointer or another focus selector of a pointing device, a moveable affordance, and/or other types of input elements) in a respective direction (e.g., relative to the computer system, a physical environment, a reference portion of an input device, the user providing the first user input, and/or other reference frames). In some embodiments, the first user input includes a swipe gesture that includes movement of one or more contacts in a respective direction. In some embodiments, the first user input includes an air pinch and drag gesture that includes movement of the hand in a respective direction. In some embodiments, the first user input includes a click and drag input that includes movement of a focus selector or cursor in a respective direction. In some embodiments, the first user input includes actuation of an affordance, such as a joystick, dial, push button, level, toggle, and/or slider control, that includes movement of the affordance in a respective direction. In some embodiments, changing the appearance of the first region in the first manner includes: in accordance with a determination that the first user interface object is associated with a directional preference (e.g., is an object that is attached to one edge of a respective display region and is not attached to an opposite edge of the respective display region and/or corresponds to a value that increases in one direction and decreases in another direction such as a slider or scrubbing user interface) and the movement is in a first direction, changing the appearance of the first region based on a first input parameter (e.g., movement vector, velocity, and/or acceleration of the input element and/or first user interface object) having a first sign (e.g., a positive sign, a direction of increasing output value, a standard reading direction, a negative sign, a direction of decreasing output value, and/or a reverse reading direction) associated with the first direction; and in accordance with a determination that the first user interface object is associated with the directional preference (e.g., is an object that is attached to one edge of a respective display region and is not attached to an opposite edge of the respective display region and/or corresponds to a value that increases in one direction and decreases in another direction such as a slider or scrubbing user interface) and the movement is in a second direction different from the first direction (e.g., substantially opposite to the first direction, and/or having a non-zero angle to and/or more than a threshold angle from the first direction), changing the appearance of the first region based on a second input parameter (e.g., movement vector, velocity, and/or acceleration of the input element and/or first object) having a second sign associated with the second direction (e.g., a positive sign, a direction of increasing output value, a standard reading direction, a negative sign, a direction of decreasing output value, and/or a reverse reading direction), different from the first sign associated with the first direction. For example, a region of the first user interface object (e.g., a menu, scrubbing indicator, and/or text loupe) stretches when moved in one direction (e.g., because it is being moved in the “positive” direction, such as away from an edge of the user interface that a menu is attached to, because it is being moved toward higher values for a scrubber, and/or because it is being moved with the typical reading direction for text being selected using a text loupe, as described with reference to FIG. 5Z) and the region of the first user interface object compresses when moved in an opposite direction (e.g., because it is being moved in the “negative” direction, such as toward an edge of the user interface that a menu is attached to, because it is being moved toward lower values for the scrubber, and/or because it is being moved against the typical reading direction for text being selected using a text loupe). In some embodiments, changing the appearance of the first region in the second manner includes, in accordance with a determination that the first user interface object is not associated with a directional preference (e.g., is not an object that is attached to one edge of a respective display region and is not attached to an opposite edge of the respective display region and/or does not corresponds to a value that increases in one direction and decreases in another direction such as a slider or scrubbing user interface of the input element and/or first object), changing the appearance of the first user interface object based on a third input parameter (e.g., displacement amount, speed, and/or rate of change of speed) without regard to the respective direction of the movement. For example, a region of the first user interface object (e.g., a button, notification, tab bar, or video player control) stretches (and/or is compressed) when moved in one direction and also stretches (and/or is compressed) when moving in an opposite direction, if the first user interface object is not associated with a directional preference, in accordance with some embodiments. For example, in FIG. 5Y1, the slider is directional such that in response to detecting an input to move the slider to the right, at least a portion of the slider (e.g., indicator 5050′) is displayed as stretching and in response to detecting an input corresponding to a request to move the slider to the left, at least a portion of the slider (e.g., indicator 5050″) is displayed as compressing.

In some embodiments, the respective set of one or more parameters includes an object type parameter (e.g., the object type parameter can have values corresponding to different object types, and correspondingly different sets of rules and relationships relating the first user input and the appearance of the first user interface object); the first set of one or more values includes an indication (e.g., a flag, a constant, a reference number, and/or other types indications) that the first user interface object is a first type of object (e.g., a first object type selected from a plurality of object types, such as a “menu” type, a “button” type, a “tab bar” type, a “tool bar” type, a “sheet” type, a “passcode user interface” type, a “selector” type, and/or other object types listed in Table 2 and/or described in the present disclosure); and the second set of one or more values includes an indication (e.g., a flag, a constant, a reference number, and/or other types indications) that the first user interface object is a second type of object (e.g., a second object type selected from the plurality of object types, such as a “menu” type, a “button” type, a “tab bar” type, a “tool bar” type, a “sheet” type, a “passcode user interface” type, a “selector” type, and/or other object types listed in Table 2 and/or described in the present disclosure) different from the first type of object. For example, one or more of the different types of objects listed below have different behaviors than other objects due to the object type of the user interface object, including: a segmented control, a button, a navigation bar, a toolbar, a sidebar, a tab bar, a menu, an edit menu, a sheet with information and one or more user interactive controls, a popover, an alert, a text loupe, a slider, a switch, a passcode entry user interface, a system control user interface, a phone dial, and/or a media control player user interface. These different types of objects are optionally specified by an API that provides a quick way for application developers to specify a standard control while providing information about content to be displayed in the control and operations to be performed based on inputs directed to the control. For example, Table 2 displays a plurality of different types of user interface objects that update parameters according to the values presented in Table 1.

In some embodiments, the first region is a translucent material that is displayed over background content (e.g., a glassy, transparent, and/or frosted user interface material that has an appearance simulating optical interactions with the background content, such as transmission, refraction, filtering, and/or reflection of the background content by the material; and/or a translucent material that has an appearance based on other types of transformations of the appearance of the background content). In some embodiments, the appearance of the translucent material is also adjusted based on changes in the ambient lighting and the content displayed adjacent to the first user interface object and/or away from the first user interface object (e.g., such as via simulated sheen, specular highlights, and/or other visual effects described in this disclosure). In some embodiments, the first user input is a selection input (e.g., a touch and hold input, a click and hold input, activation of a hardware affordance while a focus selector is at the first user interface object that is a selectable object, an air pinch input while attention is directed to the first user interface object, and/or another type of selection input directed to the first user interface object) and the change in appearance in the first manner includes displaying a selection state of the first user interface object by changing the appearance of the first region by brightening a representation of the background content that is visible through the translucent material by a first amount. In some embodiments, the brightening uses a vibrant color matrix to adjust the brightness of different colors (e.g., as described with respect to and illustrated in FIGS. 6A-6B13). In some embodiments, different colors are brightened differently (e.g., as described with respect to and illustrated in FIGS. 6B5-6B13). In some embodiments, the brightening is uniform or substantially uniform across the first region. In some embodiments, the brightening includes brightening some colors and/or portions of the first region from a color that is in an SDR range of brightness (e.g., from 1 to 1000 nits) to an HDR brightness (e.g., a brightness above 1000 nits for a display with an SDR range that goes up to 1000 nits). In some embodiments, the brightening has a different effect when the first region is displayed with a light user interface material than when the first region is displayed with a dark user interface material (e.g., as described in greater detail with reference to FIGS. 6B5-6B13 and method 19000). In some embodiments, the change in appearance in the second manner includes displaying the selection state of the user interface object without changing the appearance of the first region by brightening the representation of the background content that is visible through the translucent material by the first amount (e.g., by changing the appearance of the first region by brightening a representation of the background content that is visible through the translucent material by a second amount that is less than the first amount). In some embodiments, the brightening uses a different vibrant color matrix or vibrant color matrix with different coefficients to adjust the brightness of different colors (e.g., as described with respect to and illustrated in FIGS. 6A-6B13). In some embodiments, different colors are brightened differently (e.g., as described with respect to and illustrated in FIGS. 6B5-6B13). In some embodiments, the brightening is uniform or substantially uniform across the first region. In some embodiments, the brightening includes brightening some colors and/or portions of the first region from a color that is in an SDR range of brightness (e.g., from 1 to 1000 nits) to an HDR brightness (e.g., a brightness above 1000 nits for a display with an SDR range that goes up to 1000 nits). In some embodiments, the brightening has a different effect when the first region is displayed with a light user interface material than when the first region is displayed with a dark user interface material (e.g., as described in greater detail with reference to FIGS. 6B5-6B13 and method 19000). In some embodiments, the change in appearance in the first manner and the change in appearance in the second manner respectively use background-material luminance mappings for the light user interface material and background-material luminance mappings for the dark user interface material, as described with respect to FIGS. 6B5-6B13 and method 19000. In some embodiments, the change in appearance in the first manner and the change in appearance in the second manner respectively use different background-material luminance mappings for either a light user interface material and/or a dark user interface material, as described with respect to FIGS. 6B5-6B13 and method 19000. For example, in FIG. 5Y1, the platter 816a that is a small size user interface object, when selected, is updated to be displayed with a higher opacity such that underlying content that appears below the platter 816a appears less visible, while the platter 816c that is a large size user interface object, when selected, is updated to be displayed with a lower opacity (e.g., relative to the amount of increased opacity of the small user interface object), such that underlying content that appears below the platter 816c is more visible than the content below platter 816a when platter 816a is in the selected state but less visible than the underlying content below platter 816c while the platter 816c is not in the selected state. It will be understood that in some embodiments, the opacity of the selected user interface object increases (or decreases) relative to the opacity of the user interface object while the user interface object is not selected, and Table 1 indicates whether the opacity increases by a greater amount (e.g., for a small user interface object) or increases by a lesser amount (e.g., for a large user interface object).

In some embodiments, in response to detecting the first user input, the computer system displays, via the display generation component, an indication of a location of attention of a user on the first region (e.g., an indication of a location of a touch, gaze, cursor, or other indication of a location of user attention that changes in position as the attention of the user shifts relative to the first region). In some embodiments, the indication of a location of user attention includes a filter that brightening a portion of a representation of the background content that is visible through the translucent material by a first amount, a second amount, or another amount that is selected based on various parameter values associated with the appearance of the background content and/or various parameter values associated with one or more parameters of the first user interface material. In some embodiments, the brightening uses a vibrant color matrix to adjust the brightness of different material colors in the first region. In some embodiments, different colors are brightened differently (e.g., by different amounts and/or using different blending methods). In some embodiments, the brightening is uniform or substantially uniform across the first region. In some embodiments, the brightening includes brightening some colors and/or portions of the first region from a color that is in an SDR range of brightness (e.g., from 1 to 1000 nits) to an HDR brightness (e.g., a brightness above 1000 nits for a display with an SDR range that goes up to 1000 nits). In some embodiments, the brightening has a different effect when the first region is displayed with a light user interface material than when the first region is displayed with a dark user interface material (e.g., as described in greater detail with reference to method 19000 and illustrated in FIGS. 6B5-6B13). In some embodiments, changing the appearance of the first region in the first manner includes displaying the indication of the location of attention of the user with a first visual intensity (e.g., a first brightness boost and/or first opacity); and changing the appearance of the first region in the second manner includes displaying the indication of the location of attention of the user with a second visual intensity (e.g., a second brightness boost and/or second opacity) that is different from the first visual intensity. For example, as described with reference to FIGS. 5I1-5I4, a currently selected user interface element 5002 is displayed with a first set of values of simulated glass material (e.g., including displaying the user interface element 5002 with a first level of brightness and/or opacity), where the first set of values is selected based on one or more properties of the user interface element 5002 (e.g., a size of the user interface element 5002 and/or the type of user interface element, as described with reference to Table 1) and, after selecting the second user interface element 5004 as the currently selected object, the user interface element 5004 is displayed with a second set of values of simulated glass material (e.g., or without the simulated glass material), where the second set of values of simulated glass material is selected based on one or more properties of the user interface element 5004 (e.g., a size of the user interface element, as described with reference to Table 1). For example, if user interface element 5002 is a small size user interface element and user interface element 5004 is a large size user interface element, the opacity of the selection state is higher for the user interface element 5002 than the opacity for the user interface element 5004.

In some embodiments, in response to detecting at least a portion of the first user input (e.g., in response to detecting a touch down of one or more contacts, an air pinch, and/or a mouse down event, and/or a movement input such as a drag gesture, air drag gesture, and/or a mouse movement input), the computer system changes one or more current dimensions (e.g., a size and/or shape, a width, a height, a radius, a thickness or simulated thickness, a length, and/or other types of dimensions and spatial features) of the first region based on the first user input (e.g., by a fixed amount and/or by a percentage based on one or more dimensions of the first region, optionally different fixed amounts and/or percentage for different dimensions of the first region). In some embodiments, the dimensions of the first region are changed symmetrically (e.g., in response to a touch down of one or more contacts, an air pinch, and/or a mouse down event, and/or a movement input such as a drag gesture, an air drag gesture, and/or a mouse movement input). In some embodiments the dimensions of the first region are changed asymmetrically (e.g., based on a direction of movement of the first user input such as a drag gesture, air drag gesture, and/or mouse movement input, as described in greater detail above with reference to method 11000). In some embodiments, changing the appearance of the first region in the first manner includes changing the one or more current dimensions of the first region with a first amount of scaling (e.g., a first multiplier, a first scaling factor, a first scaling matrix, and/or a first mapping relationship, relative to one or more dimensions of the first region before the first user input was detected and/or relative to an amount of movement of the first user input); and changing the appearance of the first region in the second manner includes changing the current dimensions of the first region by a second amount of scaling, different from the first amount of scaling, (e.g., a second multiplier different from the first multiplier, a second scaling factor different from the first scaling factor, a second scaling matrix different from the first scaling matrix, and/or a second mapping relationship different from the first mapping relationship, relative to the one or more dimensions of the first region before the first user input was detected and/or relative to the amount of movement of the first user input). In some embodiments, the first amount of scaling is larger than the second amount of scaling, e.g., for a respective portion of the first user input. In some embodiments, the second amount of scaling is larger than the first amount of scaling, e.g., for a respective portion of the first user input. For example, as described with reference to FIGS. 5V-5Y, in response to detecting a user input 902-2, the dimensions of platter 816-2 are changed in accordance with one or more properties of the user input 902-2 (e.g., an amount and/or direction of movement of the user input 902-2) and in response to a user input 904-1, the dimensions of platter 816-3 are changed in accordance with one or more properties of the user input 904-1 (e.g., an amount and/or direction of movement of the user input 904-1).

In some embodiments, in response to detecting at least a portion of the first user input (e.g., in response to a touch down of one or more contacts, an air pinch, and/or a mouse down event, and/or a movement input such as a drag gesture, an air drag gesture, and/or a mouse movement input), the computer system moves the first user interface object based on the first user input (e.g., based on an amount and/or direction of a movement parameter of the first user input) and changes one or more current dimensions (e.g., a size and/or shape, a width, a height, a radius, a thickness or simulated thickness, a length, and/or other types of dimensions and spatial features) of the first region (e.g., by a fixed amount and/or by a percentage based on one or more dimensions of the first region, optionally different fixed amounts and/or percentage for different dimensions of the first region), based on a movement parameter of movement of the first user interface object (e.g., based on a direction of movement of the first user interface object, a distance of movement of the first user interface object, a speed of movement of the first user interface object, a velocity of movement of the first user interface object, an acceleration of movement of the first user interface object, and/or a rate of change of speed of the first user interface object). In some embodiments, the size of the first region is changed symmetrically based on the movement parameter of movement of the first user interface object (e.g., in response to a touch down of one or more contacts, an air pinch, and/or a mouse down event, and/or a movement input such as a drag gesture, an air drag gesture, and/or a mouse movement input). In some embodiments the one or more dimensions of the first region are changed asymmetrically based on the movement parameter of movement of the first user interface object (e.g., based on a direction of movement of the first user interface object, such as described in greater detail above with reference to method 11000). In some embodiments, changing the appearance of the first region in the first manner includes changing the one or more current dimensions of the first region with a third amount of scaling (e.g., a third multiplier, a third scaling factor, a third scaling matrix, and/or a third mapping relationship) relative to the movement of the first user interface object (e.g., movement that has a direction, magnitude, speed, velocity, acceleration, and/or rate of change of speed based on movement of the first user input); and changing the appearance of the first region in the second manner includes changing the current dimensions of the first region with a fourth amount of scaling (e.g., a fourth multiplier, a fourth scaling factor, a fourth scaling matrix, and/or a fourth mapping relationship) relative to the movement of the first user interface object, different from the third amount of scaling. In some embodiments, the third amount of scaling is larger than the second amount of scaling, e.g., for a respective portion of the movement of the first user interface object. In some embodiments, the fourth amount of scaling is larger than the first amount of scaling e.g., for a respective portion of the movement of the first user interface object. In some embodiments, the amount of scaling for a larger user interface object for a respective amount of movement is smaller (e.g., as a percentage of the size of the larger user interface object) than the amount of scaling for a smaller user interface object (e.g., as a percentage of the size of the smaller user interface object). For example, in FIGS. 5V-5W, the amount of stretching of the platter 816-2 is based on a magnitude of movement of the platter 816-2 that is determined based at least in part on a magnitude (e.g., including amount and/or direction) of movement of the user input 902-2. In some embodiments, the scaling applied to stretch the platter 816-2 is based on a determined size of the platter 816-2, as indicated in Table 1A (e.g., if the platter 816-2 is a small variant, the scaling based on the user input is greater to illustrate more movement than if the platter 816-2 is a large variant). As such, smaller user interface objects appear more reactive than larger user interface objects.

In some embodiments, in response to detecting at least a portion of the first user input (e.g., in response to a touch down of one or more contacts, an air pinch, and/or a mouse down event, and/or a movement input such as a drag gesture, an air drag gesture, and/or a mouse movement input), the computer system moves the first user interface object based on the first user input (e.g., based on an amount and/or direction of a movement parameter of the first user input) and changes one or more current dimensions (e.g., a size and/or shape, a width, a height, a radius, a thickness or simulated thickness, a length, and/or other types of dimensions and spatial features) of the first region (e.g., by a fixed amount and/or by a percentage based on one or more dimensions of the first region, optionally different fixed amounts and/or percentage for different dimensions of the first region), based on a movement parameter associated with the first user input (e.g., based on a movement parameter of the first user input and/or a movement parameter of the first user interface object that moves in response to the movement of the first user input). In some embodiments, the movement parameter is based on one or more of: a direction of movement of the first user interface object, a distance of movement of the first user interface object, a speed of movement of the first user interface object, a velocity of movement of the first user interface object, an acceleration of movement of the first user interface object, and/or a rate of change of speed of the first user interface object. In some embodiments, the size of the first region is changed symmetrically based on the movement parameter of movement of the first user interface object and/or the movement parameter of a movement of the first user input. In some embodiments the one or more dimensions of the first region are changed asymmetrically based on the movement parameter of movement of the first user interface object and/or the movement parameter of the movement of the first user input (e.g., based on a direction of movement of the first user interface object and/or a direction of movement of the first user input, such as described in greater detail above with reference to method 11000). In some embodiments, changing the appearance of the first region in the first manner includes changing a first dimension of the first region with a fifth amount of scaling relative to the movement of the first user interface object in a direction corresponding to movement along the first dimension; and changing the appearance of the first region in the first manner includes changing a second dimension, different from the first dimension, of the first region, with a sixth amount of scaling (e.g., optionally, different from the fifth amount of scaling) relative to the movement of the first user interface object in a direction corresponding to movement along the second dimension. In some embodiments, for a respective magnitude of movement, the first user interface object responds more to the respective amount of movement along a first dimension than the same respective amount of movement along a second dimension (e.g., the object responds more to horizontal movement than to vertical movement or responds more to vertical movement than to horizontal movement). In some embodiments, changing the appearance of the first region in the second manner includes changing the first dimension of the first region with a seventh amount of scaling, different from the fifth amount of scaling, relative to the movement of the first user interface object in a direction corresponding to movement along the first dimension; and changing the appearance of the first region in the second manner includes changing the second dimension of the first region with an eighth amount of scaling, different from the sixth amount of scaling, and different from the seventh amount of scaling, relative to the movement of the first user interface object in a direction corresponding to movement along the second dimension (e.g., an object with the second set of one or more values for the respective set of one or more visual parameters has a different asymmetrical response to movement along different dimensions than an object with the first set of one or more values for the respective set of one or more visual parameters). For example, in FIGS. 5V-5Y, the amount of stretching of platter 816-2 in a vertical direction in response to detecting the user input 902-2 (e.g., including movement in a first direction) is different from the amount of stretching of platter 816-3 in a horizontal direction in response to detecting the user input 904-2 (e.g., including movement in a second direction), even if the amount of movement of the user input 902-2 and user input 904-2 is the same.

In some embodiments, in response to detecting at least a portion of the first user input (e.g., in response to a touch down of one or more contacts, an air pinch, and/or a mouse down event, and/or a movement input such as a drag gesture, an air drag gesture, and/or a mouse movement input), the computer system moves the first user interface object based on the first user input (e.g., based on an amount and/or direction of a movement parameter of the first user input) and changes one or more current dimensions (e.g., a size and/or shape, a width, a height, a radius, a thickness or simulated thickness, a length, and/or other types of dimensions and spatial features) of the first region (e.g., by a fixed amount and/or by a percentage based on one or more dimensions of the first region), based on a movement parameter of movement of the first user interface object (e.g., based on a direction of movement of the first user interface object, a distance of movement of the first user interface object, a speed of movement of the first user interface object, a velocity of movement of the first user interface object, an acceleration of movement of the first user interface object, and/or a rate of change of speed of the first user interface object). In some embodiments, the size of the first region is changed symmetrically based on the movement parameter of movement of the first user interface object (e.g., in response to a touch down of one or more contacts, an air pinch, and/or a mouse down event, and/or a movement input such as a drag gesture, an air drag gesture, and/or a mouse movement input). In some embodiments the one or more dimensions of the first region are changed asymmetrically based on the movement parameter of movement of the first user interface object (e.g., based on a direction of movement of the first user interface object, such as described in greater detail above with reference to method 11000). In some embodiments, changing the appearance of the first region in the first manner includes changing the one or more current dimensions of the first region with a first set of one or more limits on a degree of change of the one or more current dimensions (e.g., a first upper limit and/or a first lower limit, optionally expressed in terms of a percentage change in size of the one or more of the current dimensions of the first region); and changing the appearance of the first region in the second manner includes changing the one or more current dimensions of the first region with a second set of one or more limits on the degree of change of the one or more current dimensions, wherein the second set of one or more limits are different from the first set of one or more limits (e.g., a second upper limit different from the first upper limit, and/or a second lower limit different from the first lower limit, optionally expressed in terms of a percentage change in size of the one or more of the current dimensions of the first region). In some embodiments, the limits for a larger user interface object are smaller (e.g., as a percentage of the size of the user interface object) than the limits for a smaller user interface object (e.g., as a percentage of the size of the user interface object). For example, as illustrated in Table 1, the maximum scaling parameter that is updated is different for different sizes and/or types of user interface objects (e.g., more scaling for a small user interface object and less scaling for a large user interface object). For example, in FIG. 5Y1, the small platter 816a has a larger maximum scale and a smaller minimum scale (e.g., can be changed by a larger amount relative to its original size) than the large platter 816c.

In some embodiments, in response to detecting at least a portion of the first user input (e.g., in response to a touch down of one or more contacts, an air pinch, and/or a mouse down event, and/or a movement input such as a drag gesture, an air drag gesture, and/or a mouse movement input), the computer system moves the first user interface object based on the first user input (e.g., based on an amount and/or direction of a movement parameter of the first user input) and changes one or more current dimensions (e.g., a size and/or shape, a width, a height, a radius, a thickness or simulated thickness, a length, and/or other types of dimensions and spatial features) of the first region (e.g., by a fixed amount and/or by a percentage based on one or more dimensions of the first region), based on a movement parameter of movement of the first user interface object (e.g., based on a direction of movement of the first user interface object, a distance of movement of the first user interface object, a speed of movement of the first user interface object, a velocity of movement of the first user interface object, an acceleration of movement of the first user interface object, and/or a rate of change of speed of the first user interface object). In some embodiments, the size of the first region is changed symmetrically based on the movement parameter of movement of the first user interface object (e.g., during and/or after the termination of the first user input). In some embodiments the one or more dimensions of the first region are changed asymmetrically based on the movement parameter of movement of the first user interface object (e.g., based on a direction of movement of the first user interface object, such as described in greater detail above with reference to method 11000), during and/or after the termination of the first user input. In some embodiments, changing the appearance of the first region in the first manner includes changing the one or more current dimensions of the first region with a first degree of settling in a change of the one or more current dimensions over time (e.g., a first speed or rate at which one or more of the dimensions of the first region settle into a stable or fixed set of dimensions after changing based on movement of the first user input and/or movement of the first user interface object, optionally expressed as a degree of damping such as via simulated friction, magnetic and/or viscous forces and/or a system with some degree of oscillation due to simulated physical properties such as simulated spring oscillation, magnetic oscillation, and/or gravitational oscillation); and changing the appearance of the first region in the second manner includes changing the one or more current dimensions of the first region with a second degree of settling in a change of the one or more current dimensions over time, different from the first degree of settling (e.g., a second speed or rate at which one or more of the dimensions of the first region settle into a stable or fixed set of dimensions after changing based on movement of the first user input and/or movement of the first user interface object, optionally expressed as a degree of damping such as via simulated friction, magnetic and/or viscous forces and/or a system with some degree of oscillation due to simulated physical properties such as simulated spring oscillation, magnetic oscillation, and/or gravitational oscillation). For example, as illustrated in Table 1, the rate of settling is different for different sizes and/or types of user interface objects. For example, in FIG. 5Y1, the platter 816a settles faster than the platter 816c after detecting an end of the user input (e.g., where platters 816a and 816c correspond to use cases in Table 2 that follow the small/large variant), while the platter 816a and the platter 816c both have an intermediate degree of settling during the user input and/or interaction. The rate of settling differs for different types of use cases (e.g., loupe, liquid lens, menu), as indicated by Tables 2-3.

In some embodiments, in response to detecting at least a portion of the first user input (e.g., in response to a touch down of one or more contacts, an air pinch, and/or a mouse down event, and/or a movement input such as a drag gesture, an air drag gesture, and/or a mouse movement input), the computer system moves the first user interface object based on the first user input (e.g., based on an amount and/or direction of a movement parameter of the first user input) and changes one or more current dimensions (e.g., a size and/or shape, a width, a height, a radius, a thickness or simulated thickness, a length, and/or other types of dimensions and spatial features) of the first region (e.g., by a fixed amount and/or by a percentage based on one or more dimensions of the first region), based on a movement parameter of movement of the first user interface object (e.g., based on a direction of movement of the first user interface object, a distance of movement of the first user interface object, a speed of movement of the first user interface object, a velocity of movement of the first user interface object, an acceleration of movement of the first user interface object, and/or a rate of change of speed of the first user interface object), wherein: In some embodiments, the size of the first region is changed symmetrically based on the movement parameter of movement of the first user interface object (e.g., in response to a touch down of one or more contacts, an air pinch, and/or a mouse down event, and/or a movement input such as a drag gesture, an air drag gesture, and/or a mouse movement input). In some embodiments the one or more dimensions of the first region are changed asymmetrically based on the movement parameter of movement of the first user interface object (e.g., based on a direction of movement of the first user interface object, such as described in greater detail above with reference to method 11000). In some embodiments, changing the appearance of the first region in the first manner includes changing the one or more current dimensions of the first region with a first degree of bounciness in a change of the one or more current dimensions over time (e.g., a first amount of oscillation of one or more of the dimensions of the first region after changing based on movement of the first user input and/or movement of the first user interface object, optionally expressed as a degree of inertially driven oscillation due to the perturbation of a simulated physical system that stores kinetic energy as potential energy and then converts the potential energy back into kinetic energy in an opposite direction such as via simulated spring oscillation, magnetic oscillation, and/or gravitational oscillation); and changing the appearance of the first region in the first manner includes changing the one or more current dimensions of the first region with a second degree of bounciness in a change of the one or more current dimensions over time, different from the first degree of bounciness (e.g., a second amount of oscillation of one or more of the dimensions of the first region after changing based on movement of the first user input and/or movement of the first user interface object, optionally expressed as a degree of inertially driven oscillation due to the perturbation of a simulated physical system that stores kinetic energy as potential energy and then converts the potential energy back into kinetic energy in an opposite direction such as via simulated spring oscillation, magnetic oscillation, and/or gravitational oscillation). For example, as illustrated in Table 1, bounciness that is displayed before the end of an input and/or during user interaction and/or bounciness after detecting an end of an input is different for different sizes and/or types of user interface objects.

In some embodiments, in response to detecting at least a portion of the first user input (e.g., in response to a touch down of one or more contacts, an air pinch, and/or a mouse down event, and/or a movement input such as a drag gesture, an air drag gesture, and/or a mouse movement input), the computer system changes the appearance (e.g., moving a boundary and/or changing one or more current dimensions of the first region) of the first region based on a magnitude of movement of the first user input (e.g., based on a direction, distance, speed, velocity, acceleration and/or rate of change of speed of the movement of the first user input). For example, changing the appearance by a fixed amount and/or by a percentage based on one or more dimensions of the first region, that is determined based on a magnitude of movement and/or displacement of the first user input. In some embodiments, the size of the first region is changed symmetrically (e.g., in response to a touch down of one or more contacts, an air pinch, and/or a mouse down event and/or a movement input such as a drag gesture, an air drag gesture, and/or a mouse movement input). In some embodiments the one or more dimensions of the first region are changed asymmetrically (e.g., based on a direction of movement of the first user input a movement input such as a drag gesture, air drag gesture, and/or mouse movement input as described in greater detail above with reference to method 11000). For example, as described with reference to FIGS. 5V-5W, in some embodiments, the platter 816-2 is stretched in accordance with a magnitude (e.g., an amount and/or distance of movement) of the detected user input 902-2.

In some embodiments, changing the appearance (e.g., moving a boundary and/or changing one or more current dimensions of the first region) of the first region based on the magnitude of movement of the first user input includes: in accordance with a determination that the first user input includes first movement within a boundary of the first user interface object (e.g., locations of the one or more contacts, locations of user's attention, and/or location of the focus selector, correspond to locations within the boundary of the first user interface object, during the first movement of the first user input), changing the appearance (e.g., brightness, blur, simulated refraction, simulated reflection, simulated light emission, and/or a size of one or more dimensions) of the first region based on a magnitude of the first movement of the first input within the boundary of the first user interface object as modified with a first scaling value for a respective scaling factor (e.g., a scaling factor that changes how much one unit of movement of the first user input affects a change in one or more dimensions of the first region); and in accordance with a determination that the first user input includes second movement outside of the boundary of the first user interface object (e.g., locations of the one or more contacts, locations of user's attention, and/or location of the focus selector, correspond to locations outside of the boundary of the first user interface object, during the second movement of the first user input), changing the appearance of the first region based on a magnitude of the second movement of the first user input outside of the boundary of the first user interface object with a second scaling value for the respective scaling factor that is different from the first scaling value (e.g., a scaling factor that changes how much one unit of movement of the input affects a change in one or more dimensions of the first region). In some embodiments, movement of the first user input (e.g., a change in distance, direction speed, velocity, acceleration, and/or rate of change of speed) causes a different amount of change in the appearance of the first region depending on whether the movement of the input is (and/or corresponds to locations) outside of the boundary of the user interface object or inside of the boundary of the first user interface object, optionally with the portion of the first user input outside of the boundary of the first user interface object causing more change than the portion of the first user input inside of the boundary of the first user interface object. In some embodiments, movement (and/or a location corresponding to the movement input) starts within a boundary of the first user interface object, moves within the boundary of the first user interface object, and then moves outside of the boundary of the first user interface object and continues moving further outside of the boundary of the first user interface object (e.g., due to the object moving more slowly than the input moves, optionally due to the object resisting movement of the input based on a simulated physical property such as friction, inertia, a repulsive force, an attractive force, and/or an elastic force). In some embodiments, during the different portions of the movement input (e.g., with locations within, and outside of the boundary of the first user interface object), the appearance of the user interface object responds to a respective amount of change in the magnitude of a movement parameter by different amounts of changes, e.g., due to the different scaling values for a respective scaling factor based on the movement parameter of the movement input. For example, in FIG. 5X, in some embodiments, the user input 904-1 is a user input that includes movement within the platter 816-2, and in response to detecting the user input 904-1, the platter 816-2 is scaled (e.g., stretched and/or compressed in one or more directions) by a first amount while continuing to detect the user input 904-1, whereas a user input that is directed to the platter 816-2 that includes movement that moves outside of the boundary of the platter 816-2 (e.g., user input 902-2 in FIG. 5W initially begins within the platter 816-2 before moving outside of the boundary of the platter 816-2), the platter 816-2 is scaled by a second amount that is different from the first amount.

In some embodiments, changing the appearance (e.g., moving a boundary and/or changing one or more current dimensions of the first region) of the first region based on a magnitude of movement of the first user input includes: in accordance with a determination that the first user input includes movement that is a first distance from a starting point associated with the movement (e.g., a starting point of the first user input and/or a starting point of the first region), changing the appearance of the first region with a first amount of resistance, wherein changing an appearance of a respective region with resistance in response to a respective movement input includes changing the appearance of the respective region by an amount that decreases progressively (e.g., with simulated resistance such as simulated spring resistance) as the respective movement input progresses further from a starting point associated with the respective movement input (e.g., the movement of the first user input, and/or the movement of another movement input that causes changes in the appearance of the respective region with resistance); and in accordance with a determination that the first user input includes movement that is a second distance, different from the first distance, from the starting point associated with the movement (e.g., a starting point of the first user input and/or a starting point the first region), changing the appearance of the first region with a second amount of resistance that is different from the first amount of resistance (e.g., with a higher or lower simulated resistive force from a simulated spring, for example when a simulated spring with a respective spring coefficient is deformed further from an equilibrium position the simulated force of the simulated spring seeking to return to the equilibrium position is greater, resulting in greater resistance to further movement). In some embodiments, the change in appearance of the first region is based on the resistance described above separately from the scaling factor described above). In some embodiments, the change in appearance of the first region is based on the resistance described above in combination with the scaling factor described above (e.g., the resistance progressively resists change in appearance as the movement moves further away from the starting point, while movement of the input that is outside of the boundary of the first user interface object has a greater impact on a change in appearance of the object than movement of the input that is within the boundary of the first user interface object, even though the impact of movement away from the starting point has progressively smaller effects on a change in appearance of the object due to increased resistance). For example, in FIG. 5W, as the user input 902-2 moves away from the platter 816-2, the platter 816-2 is displayed with a greater amount of simulated resistance (e.g., by stretching the platter 816-2 more slowly and/or by a lesser amount as the user input 902-2 travels farther away from the boundary of the platter 816-2).

In some embodiments, the first user input corresponds to movement in a respective direction (e.g., movement of the first input and/or movement of the first user interface object); and changing the appearance of the first region in the first manner includes: in accordance with a determination that the movement in the respective direction is a movement in a first movement direction, stretching the first region in a respective dimension associated with the first movement direction; and in accordance with a determination that the movement in the respective direction is a movement in a second movement direction, different from the first movement direction (e.g., opposite to the first movement direction), compressing the first region in the respective dimension. In some embodiments, changing the appearance of the first region in the second manner includes: in accordance with a determination that the movement in the respective direction is a movement in the first movement direction, stretching the first region in a respective dimension associated with the first movement direction; and in accordance with a determination that the movement in the respective direction is a movement in the second movement direction, different from the first movement direction (e.g., opposite to the first movement direction), compressing the first region in the respective dimension. For example, as described with reference to FIG. 5Y1, the indicator 5050 of the slider 5052 is stretched as indicator 5050′ in response to a user input moving to the right and the indicator 5050 is compressed (e.g., or stretched by a smaller amount) as indicator 5050″ in response to a user input moving to the left.

In some embodiments, changing the appearance of the first region in the first manner (e.g., changing an appearance of a selection object for selecting text or a text selection loupe for enlarging text that is being selected) includes: in accordance with a determination that the movement in the respective direction is a movement in the first movement direction, and a language setting of the computer system is a first language setting (e.g., a language setting for a first language that is a left to right reading language), stretching the first region in the respective dimension associated with the first movement direction (e.g., by an amount based on a magnitude of the movement); and in accordance with a determination that the movement in the respective direction is a movement in the first movement direction, and the language setting of the computer system is a second language setting different from the first language setting (e.g., a language setting for a second language that is a right to left reading language), compressing the first region in the respective dimension (e.g., by an amount based on a magnitude of the movement). In some embodiments, the first user interface object is associated with text selection (e.g., a text selection indicator and/or text selection loupe for visually emphasizing text that is available for selection or being selected). In some embodiments, stretching or compressing the first region includes changing an aspect ratio of the first region as described in greater detail above with reference to method 11000. In some embodiments, changing the appearance of the first region in the first manner includes, in accordance with a determination that the movement in the respective direction is a movement in the second movement direction different from the first movement direction, and the language setting of the computer system is the first language setting (e.g., a language setting for a first language that is a left to right reading language) compressing the first region in the respective dimension associated with the first movement direction (e.g., by an amount based on a magnitude of the movement); and in accordance with a determination that the movement in the respective direction is a movement in the second movement direction, and the language setting of the computer system is the second language setting (e.g., a language setting for a second language that is a right to left reading language), stretching the first region in the respective dimension (e.g., by an amount based on a magnitude of the movement). In some embodiments, changing the appearance of the second region in the first manner includes: in accordance with a determination that the movement in the respective direction is a movement in the first movement direction, and the language setting of the computer system is the first language setting (e.g., a language setting for a first language that is a left to right reading language), stretching the second region in a respective dimension associated with the first movement direction (e.g., by an amount based on a magnitude of the movement); and in accordance with a determination that the movement in the respective direction is a movement in the first direction, and the language setting of the computer system is the second language setting different from the first language setting (e.g., a language setting for a second language that is a right to left reading language), compressing the second region in the respective dimension (e.g., by an amount based on a magnitude of the movement). In some embodiments, changing the appearance of the second region in the first manner includes: in accordance with a determination that the movement in the respective direction is a movement in the second movement direction different from the first movement direction, and the language setting of the computer system is the first language setting (e.g., a language setting for a first language that is a left to right reading language), compressing the second region in a respective dimension associated with the first movement direction (e.g., by an amount based on a magnitude of the movement); and in accordance with a determination that the movement in the respective direction is a movement in the second movement direction, and the language setting of the computer system is the second language setting (e.g., a language setting for a second language that is a right to left reading language), stretching the second region in the respective dimension (e.g., by an amount based on a magnitude of the movement). For example, as described with reference to FIG. 5Z, in some embodiments, the user interface element 912-1 is stretched by a first amount in response to detecting a user input 910-3 from right to left (e.g., opposite the direction of the English language setting of left to right reading) if the language setting is set to a language that reads from right to left, and the user interface element 912-1 is compressed in response to detecting a user input 910-3 if the language setting is set to a different language that reads from left to right.

In some embodiments, changing the appearance of the first region in the first manner includes changing an aspect ratio of the first region by a first amount; and changing the appearance of the first region in the second manner includes changing the aspect ratio of the first region by a second amount that is different from the first amount. Changing an aspect ratio of a region of a user interface object based on an input is described in greater detail above with reference to method 11000. For example, as described with reference to FIGS. 5V-5Y, the aspect ratio of platter 816-2 is updated in a first manner (e.g., vertical stretching and horizontal shrinking) in response to detecting the user input 902-1 and the platter 816-3 is updated in a second manner (e.g., horizonal stretching and vertical shrinking) in response to detecting the user input 904-1.

It should be understood that the particular order in which the operations in FIG. 20 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 7000, 8000, 9000, 10000, 11000, 12000, 13000, 14000, 15000, 16000, 17000, 18000, and/or 19000) are also applicable in an analogous manner to method 19000 described above with respect to FIG. 20. For example, the buttons, user interfaces, controls, visual deemphasis, virtual effects, described above with reference to method 20000 optionally have one or more of the characteristics of the buttons, user interfaces, controls, visual deemphasis, virtual effects, described herein with reference to other methods described herein (e.g., methods 7000, 8000, 9000, 10000, 11000, 12000, 13000, 14000, 15000, 16000, 17000, 18000, and/or 19000). For brevity, these details are not repeated here.

It should be understood that the particular order in which the operations have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein. For brevity, these details are not repeated here.

The operations described above are, optionally, implemented by components depicted in FIGS. 1A-1B. For example, the operations are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at a computer system in communication with one or more display generation components and one or more input devices:
displaying, via the one or more display generation components, a first user interface that includes a first interactive element represented by a first platter;
while displaying the first user interface that includes the first interactive element represented by the first platter, detecting occurrence of a first event that meets navigation criteria;
in response to detecting, via the one or more input devices, the occurrence of the first event that meets the navigation criteria, displaying, via the one or more display generation components, a second user interface that includes a second interactive element different from the first interactive element, wherein the second interactive element is represented by a second platter, and wherein:
in accordance with a determination that the first interactive element in the first user interface satisfies respective criteria that are based on a spatial arrangement of the first interactive element with respect to a spatial arrangement of the second interactive element, displaying the second interactive element represented by the second platter includes displaying the first platter morphing into the second platter; and
in accordance with a determination that the first interactive element in the first user interface does not satisfy the respective criteria that are based on the spatial arrangement of the first interactive element with respect to the second interactive element in the second user interface, displaying the second interactive element represented by the second platter includes displaying the second platter without morphing the first platter into the second platter.

2. The method of claim 1, wherein:
the first user interface includes a third interactive element represented by a third platter;
the third interactive element is different from the first interactive element;
the third platter is different from the first platter; and
the method includes, in response to detecting the occurrence of the first event that meets the navigation criteria, ceasing to display the third platter without morphing or merging the third platter into another platter.

3. The method of claim 1, wherein displaying the first platter morphing into the second platter includes merging the first platter with an additional platter that was displayed concurrently with the first platter in the first user interface.

4. The method of claim 3, wherein merging the first platter with the additional platter that was displayed concurrently with the first platter in the first user interface includes displaying a boundary of the first platter and a boundary of the additional platter in a plurality of intermediate states in which the boundary of the first platter and the boundary of the second platter move closer to each other and connect into a single continuous boundary of the second platter.

5. The method of claim 1, wherein displaying the first platter morphing into the second platter includes splitting the first platter into two or more portions that are spaced apart from one another, with at least one of the two or more portions morphing into the second platter.

6. The method of claim 5, wherein splitting the first platter into two or more portions, with at least one of the two or more portions morphing into the second platter, includes displaying a boundary of the first platter in a plurality of intermediate states in which the boundary of the first platter separates into respective boundaries of the two or more portions, where the respective boundaries of the two or more portions are connected in one or more of the plurality of intermediate states and are separated from one another in one or more of the plurality of intermediate states.

7. The method of claim 1, wherein:
the first user interface includes a first plurality of interactive elements represented by respective platters from a first plurality of platters; and
the method includes:
while displaying the first user interface that includes the first plurality interactive elements represented by the respective platters from the first plurality of platters, detecting occurrence of a second event that meets the navigation criteria; and
in response to detecting the occurrence of the second event, displaying, via the one or more display generation components, a third user interface that includes a second plurality of interactive elements, wherein displaying the third user interface includes:
merging a first set of two or more platters from the first plurality of platters into a respective platter in the second plurality of platters; and
forgoing merging a second set of one or more platters from the first platters into a respective platter in the second plurality of platters.

8. The method of claim 7 wherein forgoing merging the second set of two or more platters from the first plurality of platters into a respective platter in the second plurality of platters includes:
splitting a respective platter from the second set of two or more platters from the first plurality of platters into two or more portions, with at least one of the two or more portions of the respective platter morphing into a platter in the second plurality of platters.

9. The method of claim 1, including:
while displaying the first user interface, detecting, via the one or more input devices, a first user input that is directed to the first interactive element; and
in response to detecting the first user input:
displaying, via the one or more display generation components, a plurality of intermediate states in which the first platter splits into two or more portions, and the two or more portions morph into separate platters representing two or more interactive elements that were not displayed in the first user interface prior to detecting the first user input; and
maintaining display of the two or more interactive elements represented by the separate platters, after displaying the plurality of intermediate states.

10. The method of claim 9, including:
in response to detecting the first user input:
displaying, via the one or more display generation components, a plurality of intermediate states in which the two or more platters that were concurrently displayed with the first platter in the first user interface are merged into a single platter representing a new interactive element that was not displayed in the first user interface prior to detecting the first user input; and
maintaining display of the new interactive element represented by the single platter formed by merging the two or more platters that were concurrently displayed with the first platter in the first user interface.

11. The method of claim 1, wherein displaying the first platter morphing into the second platter includes displaying, via the one or more display generation components, a plurality intermediate states in which at least a portion of a boundary of the first platter stretches and/or morphs into at least a portion of a boundary of the second platter.

12. The method of claim 11, wherein:
the first user interface includes a first plurality of interactive elements represented by respective platters from a first plurality of platters; and
displaying the first platter morphing into the second platter includes displaying a plurality of intermediate states in which a boundary of the first platter and respective boundaries of one or more additional platters from the first plurality of platters stretch toward one another and morph into a single boundary of the second platter.

13. The method of claim 1, wherein, in accordance with the determination that the first interactive element in the first user interface satisfies the respective criteria that are based on a spatial arrangement of the first interactive element with a spatial arrangement of the second interactive element, displaying the second interactive element represented by the second platter includes changing content displayed on the first platter into content displayed on the second platter.

14. The method of claim 1, wherein:
the first interactive element corresponds to a first operation; and
the method includes:
while displaying the second interactive element represented by the second platter morphed from the first platter, detecting, via the one or more input devices, a user input that interacts with the second interactive element; and
in response to detecting the user input that interacts with the second interactive element, in accordance with a determination that the user input meets activation criteria, performing a second operation that is different from the first operation.

15. The method of claim 1, wherein, in accordance with the determination that the first interactive element in the first user interface satisfies the respective criteria that are based on a spatial arrangement of the first interactive element with a spatial arrangement of the second interactive element, displaying the second interactive element represented by the second platter includes changing a value of a first visual property of the first platter when morphing the first platter into the second platter.

16. The method of claim 1, wherein, in accordance with the determination that the first interactive element in the first user interface satisfies the respective criteria that are based on a spatial arrangement of the first interactive element with a spatial arrangement of the second interactive element, displaying the second interactive element represented by the second platter includes changing a size of the first platter when morphing the first platter into the second platter.

17. The method of claim 1, wherein detecting the occurrence of the event includes detecting a user input that corresponds to a request to scroll the first user interface and the second user interface is displayed as a result of scrolling the first user interface.

18. The method of claim 1, wherein:
detecting the occurrence of the event includes detecting a user input that selects a user interface object displayed in the first user interface; and
the second user interface is displayed as a result of the selection of user interface object displayed in the first user interface.

19. The method of claim 1, wherein detecting the occurrence of the event includes detecting a user input that corresponds to a request to navigate back to a previously displayed user interface and the second user interface is displayed as the previously displayed user interface.

20. The method of claim 1, wherein displaying the second user interface that includes the second interactive element includes:
in accordance with a determination that a display location of the first interactive element is within a threshold range of a display location of the second interactive element in a display region provided via the one or more display generation components, displaying, via the one or more display generation components, the first platter morphing into the second platter; and
in accordance with a determination that the display location of the first interactive element is outside of the threshold range of the display location of the second interactive element in the display region provided via the one or more display generation components, ceasing to display the first platter, and displaying, via the one or more display generation components, the second platter without morphing the first platter into the second platter.

21. The method of claim 1, wherein displaying the second user interface that includes the second interactive element includes:
in accordance with a determination that an animation direction for transitioning from the first user interface to the second user interface is a first animation direction, displaying, via the one or more display generation components, the first platter morphing into the second platter; and
in accordance with a determination that the animation direction for transitioning from the first user interface to the second user interface is a second animation direction, different from the first animation direction, ceasing to display the first platter, and displaying, via the one or more display generation components, the second platter without morphing the first platter into the second platter.

22. The method of claim 1, wherein the respective criteria that are based on a spatial arrangement of the first interactive element with respect to a spatial arrangement of the second interactive element includes a requirement that the first interactive element and the second interactive element are in a same display layer in order for the first interactive element to meet the respective criteria.

23. The method of claim 1, wherein:
the first interactive element includes first content other than the first platter; and
displaying the second interactive element represented by the second platter includes displaying, via the one or more display generation components, a visual effect that propagates across a spatial extent the first content and that reduces visibility of the first content over time.

24. The method of claim 1, wherein:
the first interactive content includes first content other than the first platter;
the second interactive element includes second content other than the second platter;
the first content is displayed with a greater range of brightness as compared to other content in the first user interface that are not interactive; and
the second content is displayed with a greater range of brightness as compared to other content in the second user interface that are not interactive.

25. A computer system that is in communication with one or more input devices and one or more display generation components, comprising:
one or more processors; and
memory storing one or more programs, wherein the one or more programs are configured to be executed by the one or more processors, the one or more programs including instructions for:
displaying, via the one or more display generation components, a first user interface that includes a first interactive element represented by a first platter;
while displaying the first user interface that includes the first interactive element represented by the first platter, detecting occurrence of a first event that meets navigation criteria;
in response to detecting, via the one or more input devices, the occurrence of the first event that meets the navigation criteria, displaying, via the one or more display generation components, a second user interface that includes a second interactive element different from the first interactive element, wherein the second interactive element is represented by a second platter, and wherein:
in accordance with a determination that the first interactive element in the first user interface satisfies respective criteria that are based on a spatial arrangement of the first interactive element with respect to a spatial arrangement of the second interactive element, displaying the second interactive element represented by the second platter includes displaying the first platter morphing into the second platter; and
in accordance with a determination that the first interactive element in the first user interface does not satisfy the respective criteria that are based on the spatial arrangement of the first interactive element with respect to the second interactive element in the second user interface, displaying the second interactive element represented by the second platter includes displaying the second platter without morphing the first platter into the second platter.

26. A computer readable storage medium storing one or more programs, the one or more programs comprising instructions that, when executed by a computer system that is in communication with one or more input devices and one or more display generation components, cause the computer system to:
display, via the one or more display generation components, a first user interface that includes a first interactive element represented by a first platter;
while displaying the first user interface that includes the first interactive element represented by the first platter, detect occurrence of a first event that meets navigation criteria;
in response to detecting, via the one or more input devices, the occurrence of the first event that meets the navigation criteria, display, via the one or more display generation components, a second user interface that includes a second interactive element different from the first interactive element, wherein the second interactive element is represented by a second platter, and wherein:
in accordance with a determination that the first interactive element in the first user interface satisfies respective criteria that are based on a spatial arrangement of the first interactive element with respect to a spatial arrangement of the second interactive element, displaying the second interactive element represented by the second platter includes displaying the first platter morphing into the second platter; and
in accordance with a determination that the first interactive element in the first user interface does not satisfy the respective criteria that are based on the spatial arrangement of the first interactive element with respect to the second interactive element in the second user interface, displaying the second interactive element represented by the second platter includes displaying the second platter without morphing the first platter into the second platter.

27-369. (canceled)
